(19) United States
(12) Patent Application Publication
(10) Pub. No.: US 2023/0000123 A1
(43) Pub. Date: Jan. 5, 2023

(54) SWEETENER AND FLAVOR COMPOSITIONS CONTAINING TERPENE GLYCOSIDES

(71) Applicant: EPC Natural Products Co., Ltd., Beijing (CN)

(72) Inventors: Jingang SHI, Beijing (CN); Hansheng WANG, Beijing (CH); Thomas EIDENBERGER, Wels (AT); Weiyao SHI, New York, NY (US); Xiaorui ZHANG, Beijing (CN)

(21) Appl. No.: 17/302,995

(22) Filed: May 18, 2021

Related U.S. Application Data
(60) Provisional application No. 63/026,910, filed on May 19, 2020.
(60) Provisional application No. 63/062,645, filed on Aug. 7, 2020.
(60) Provisional application No. 63/144,025, filed on Feb. 1, 2021.

(51) Int. Cl. A23L 27/30; A23L 27/00; A23L 2/60; A23L 2/56

(52) U.S. Cl. CPC A23L 27/36; A23L 27/86; A23L 2/56; A23L 2/60; A23L 27/88

(57) ABSTRACT

Sweet tea-derived compositions, including glycosylated compositions thereof, and Maillard reaction products thereof are described. These compositions provide improved taste profiles and can be used as sweeteners or a flavorants in consumable products.

### RELATED APPLICATIONS

This application claims the benefit of priority to U.S. Provisional Application No. 63/026,910, filed on May 19, 2020, U.S. Provisional Application No. 63/062,645, filed on Aug. 7, 2020 and U.S. Provisional Application No. 63/144,025, filed on Feb. 1, 2021, all of which are herein incorporated by reference in their entirety.

### FIELD

The present disclosure relates generally to sweeteners and flavoring agents, and their use in food and beverage products.

### BACKGROUND

Caloric sugars are widely used in the food and beverage industry. However, there is a growing trend toward use of more healthy alternatives, including non-caloric or low caloric sweeteners. Popular non-caloric sweeteners include high intensity synthetic sweeteners, such as aspartame (e.g., NutraSweet, Equal), sucralose (Splenda), and acesulfame potassium (also known as acesulfame K, or Ace-K), as well as high intensity natural sweeteners, which are typically derived from plants such as Stevia plants, sweet tea plants and monk fruit plants.

Despite the widespread use of non-caloric sweeteners, which are gaining in popularity, many consumers are reluctant to use these products, since their taste properties are often considered to insufficiently mimic the taste profile of caloric sugars, such as sucrose. Therefore, there is a need in further developing and enhancing the taste properties of natural and synthetic sweeteners to better reproduce the taste properties associated with conventional sugar products, so as to provide increased consumer satisfaction.

Rubus suavissimus S. Lee or Rubus chingii is a perennial shrub naturally abundant in Southern China. Due to its intensely sweet taste, leaves from Rubus suavissimus, commonly referred to as the Chinese sweet leaf tea plant, Chinese blackberry, or sweet blackberry have been used in making leaf tea beverage (Chinese sweet tea) by local residents. Rubusoside is the dominant sweetener or steviol glycoside found in the Chinese sweet leaf tea plant. Rubusoside is 115 times sweeter than sucrose at a concentration of 0.025%, making it a good candidate for a natural sweetener. A hot water extract from the Chinese sweet tea leaves, called the tenryocha extract or Tien Cha in Japan has been previously used as a natural sweetener. In addition, the dried Chinese sweet tea leaves have been used as an ingredient in tea/herbal infusions in Europe.

Sweet tea plant extracts contain rubusoside (RU), a steviol glycoside, and kaurane-type diterpene glycosides, such as suaviosides B, G, H, I and J, constitute a variety of natural sweeteners. However, sweet tea extract and purified RU are often associated with a bitter and astringent taste when used at higher concentration, thereby limiting its application in consumer products. Accordingly, there is need to find a method to overcome disadvantage of these products and make them use widely in food, beverage, pharmaceutical and cosmetic industry.

### SUMMARY

The present application relates to compositions that comprise rubusoside (RU), one or more sweet tea components (STCs), sweet tea extracts (STEs), glycosylated rubusoside (GRU), glycosylated sweet tea components (GSTCs), glycosylated sweet tea extracts (GSTEs), Maillard reaction products (MRPs) of RU, GRU, STCs, GSTCs, STEs or GSTEs (collectively ST-MRPs), glycosylated products of ST-MRPs (collectively G-ST-MRP), as well as methods of making and using such compositions to improve the taste and/or flavor of a consumable product.

In one aspect, the present application is directed to a composition that comprises one or more components selected from the group consisting of RU, GRU, STEs, GSTEs, STCs, GSTCs, ST-MRPs and G-ST-MRPs in a total amount of 0.1-99.9 wt %.

In some embodiments, the composition is a sweetening composition.

In some embodiments, the composition is a flavoring composition.

In some embodiments, the sweetener or flavoring composition comprises a STE containing enriched rubusoside (RU).

In some embodiments, the sweetener or flavoring composition comprises a STE containing enriched diterpene glycoside.

In some embodiments, the sweetener or flavoring composition comprises a STE that comprises one or more sweet tea derived components (STC) selected from the group consisting of rubusoside (RU), suavioside (SU), steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin.

In some embodiments, the sweetener or flavoring composition comprises a STE that comprises one or more suaviosides selected from the group consisting of SU-A, SU-B, SU-C1, SU-D1, SU-D2, SU-E, SU-F, SU-G, SU-H, SU-I, and SU-J.

In some embodiments, the sweetener or flavoring composition comprises a STE wherein the STE is purified RU.

In some embodiments, the sweetener or flavoring composition comprises a GSTE.

In some embodiments, the sweetener or flavoring composition comprises a GSTE containing enriched glycosylated rubusoside (RU).

In some embodiments, the sweetener or flavoring composition comprises a GSTE containing enriched glycosylated diterpene glycoside.

In some embodiments, the sweetener or flavoring composition comprises a GSTE, wherein the GSTE is glycosylated RU.

In some embodiments, the sweetener or flavoring composition comprises a MRP.

In some embodiments, the sweetener or flavoring composition comprises a ST-MRP. In some related embodiments, the ST-MRP comprises (a) a glycosylation product of a MRP of a STE, or (b) a glycosylation product of a MRP of a GSTE, or both (a) and (b).

In some embodiments, the sweetener or flavoring composition comprises a MRP of STE. In some related embodiments, the STE comprises enriched RU. In some related embodiments, the STE comprises enriched diterpene glycoside. In some related embodiments, the STE comprises one or more STCs selected from the group consisting of RU, SU, steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin. In some related embodiments, the STE comprises one or more suaviosides selected from the group consisting of SU-A, SU-B, SU-C1, SU-D1, SU-D2, SU-E, SU-F, SU-G, SU-H, SU-I, and SU-J.

In some embodiments, the sweetener or flavoring composition comprises a MRP of GSTE. In some related embodiments, the GSTE is a glycosylation product of an STE that comprises enriched RU. In some related embodiments, the GSTE is a glycosylation product of a STE that comprises enriched diterpene glycoside. In some related embodiments, the GSTE is a glycosylation product of a STE that comprises one or more STCs selected from the group consisting of RU, SU, steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin. In some related embodiments, the GSTE is a glycosylation product of a STE that comprises one or more suaviosides selected from the group consisting of SU-A, SU-B, SU-C1, SU-D1, SU-D2, SU-E, SU-F, SU-G, SU-H, SU-I, and SU-J.

Another aspect of the present application relates to a consumable product comprising one or more components selected from the group consisting of RU, GRU, STEs, GSTEs, STCs, GSTCs, ST-MRPs and/or G-ST-MRPs in a total amount of 0.00001-99.9 wt %.

In some embodiments, the consumable product is selected from the group consisting of beverage products, confections, condiments, dairy products, cereal compositions, chewing compositions, tabletop sweetener compositions, medicinal compositions, oral hygiene compositions, cosmetic compositions, and smokable compositions.

In some embodiments, the consumable product is a beverage and the beverage comprises the one or more components in an amount of 0.01-5000 ppm.

In some embodiments, the present application provides a consumable product comprising one or more components selected from the group consisting of RU, GRU, STEs, GSTEs, STCs, GSTCs, ST-MRPs and G-ST-MRPs of the present application. In certain particular embodiments, the one or more components are present in the consumable product in a concentration ranging from 0.0001 wt % to 99.9999 wt %, 0.0001 wt % to 75 wt %, 0.0001 wt % to 50 wt %, 0.0001 wt % to 25 wt %, 0.0001 wt % to 10 wt %, 0.0001 wt % to 5 wt %, 0.0001 wt % to 1 wt %, 0.0001 wt % to 0.5 wt %, 0.0001 wt % to 0.2 wt %, 0.0001 wt % to 0.05 wt %, 0.0001 wt % to 0.01 wt %, 0.0001 wt % to 0.005 wt %, or any range derived from any two of these values.

In certain particular embodiments, the consumable product is a beverage product in which the one or more components are present in a final concentration range of 1-15,000 ppm.

In another aspect, the present application provides a method for modifying a consumable product, comprising adding to the consumable product one or more components selected from the group consisting of RU, GRU, STEs, GSTEs, STCs, GSTCs, ST-MRPs and G-ST-MRPs of the present application. In certain particular embodiments, the one or more components are added to the consumable product at a final concentration ranging from 0.0001 wt % to 99.9999 wt %, 0.0001 wt % to 75 wt %, 0.0001 wt % to 50 wt %, 0.0001 wt % to 25 wt %, 0.0001 wt % to 10 wt %, 0.0001 wt % to 5 wt %, 0.0001 wt % to 1 wt %, 0.0001 wt % to 0.5 wt %, 0.0001 wt % to 0.2 wt %, 0.0001 wt % to 0.05 wt %, 0.0001 wt % to 0.01 wt %, 0.0001 wt % to 0.005 wt %, or any range derived from any two of these values. In a more particular embodiment, the consumable product is a beverage product, wherein the one or more components are added in a final concentration range of 1-15,000 ppm.

Another aspect of the present application relates to compositions comprising non-RA20 s and glycosylated product of non-RA20 s, including RU and GRU, other smaller stevia glycosides, GSGs from stevioside, etc. In some embodiments, the RU is obtained from either Sweet Tea or Stevia.

Another aspect of the present application relates to stevia extracts comprising rubusoside.

Another aspect of the present application relates to stevioside compositions that are used for production of rubusoside. In some embodiments, the rubusosides obtained from Stevia extracts are used for glycosylation to generate GRU.

Another aspect of the present application relates to a method of modifying the taste of a Stevia extract or steviol glycosides with GRU.

Another aspect of the present application relates to GRU compositions comprising mono-glucosylated RU, di-glucosylated RU, tri-glucosylated RU or mixtures thereof.

Another aspect of the present application relates to GSG or GRU compositions with low levels of dextrin (left over from the glycosylation reaction).

### BRIEF DESCRIPTION OF THE DRAWINGS

FIG. 1 shows a schematic diagram of an exemplary time-intensity curve for illustrative purposes, as described in Ex 5.

FIGS. 2A to 2D show the SugarE of different concentrations of RU20, GTRU20, GTRU20-MRP-CA and GTRU20-MRP-HO in Table 5-12 to 5-14 of Ex. 5, respectively. FIG. 2E shows the overall likability of different SugarE of RU20, GTRU20, GTRU20-MRP-CA and GTRU20-MRP-HO.

FIG. 3A shows the relationship between the sensory evaluation results to the ratio of sucralose to GTRU20 in Ex. 12. FIG. 3B shows the overall likability results to the ratio of sucralose to GTRU20 in Ex. 12.

FIG. 4A shows the relationship between the sensory evaluation results to the ratio of RA97 to GTRU20 in Ex. 13. FIG. 4B shows the relationship between the overall likability results to the ratio of RA97 to GTRU20 in Ex. 13.

FIG. 5A shows the relationship between the sensory evaluation results to the ratio of acesulfame-K to GTRU20-MRP-HO in Ex. 14. FIG. 5B shows the relationship between the overall likability results to the ratio of acesulfame-K to GTRU20-MRP-HO in Ex. 14.

FIGS. 6A-6E show the SugarE evaluations for different concentrations of RU90, GRU90, GRU90-MRP-TA, GRU90-MRP-CA and GTRU20-MRP-HO in Ex. 15, respectively. FIG. 6F shows the overall likability evaluations of different concentrations of RU90, GRU90, GRU90-MRP-TA, GRU90-MRP-CA and GTRU20-MRP-HO in Ex. 15.

FIG. 7A shows the relationship between the sensory evaluation results to the ratio of acesulfame-K to GRU90 in Ex. 16. FIG. 7B shows the relationship between the overall likability results to the ratio of acesulfame-K to GRU90 in Ex. 16.

FIG. 8A shows the relationship between the sensory evaluation results to the ratio of sucralose to GRU90-MRP-TA in Ex. 17. FIG. 8B shows the relationship between the overall likability results to the ratio of sucralose to GRU90-MRP-TA in Ex. 17.

FIG. 9A shows the relationship between the sensory evaluation results to the ratio of RA97 to GRU90-MRP-CA in Ex. 18. FIG. 9B shows the relationship between the overall likability results to the ratio of RA97 to GRU90-MRP-CA in Ex. 18.

FIG. 10A shows the sensory evaluation of products in Ex. 19. FIG. 10B shows the corresponding time-intensity curves in Ex. 19.

FIG. 11A shows the sensory evaluation of products in Ex. 20. FIG. 11B shows the corresponding time-intensity curves in Ex. 20.

FIG. 12A shows time-intensity curves for three representative ratios of RM to GRU90-MRP-FTA in Ex. 21. FIG. 12B shows the relationship between the overall likability results to the ratio of RM to GRU90-MRP-FTA in Ex. 21.

FIG. 13A shows time-intensity curves for three representative ratios of RM to GRU90-MRP-FTA in Ex. 22. FIG. 13B shows the relationship between the overall likability results to the ratio of RM to GRU90-MRP-FTA in Ex. 22.

FIG. 14A shows time-intensity curves for three representative ratios of thaumatin to GRU90-MRP-FTA in Ex. 23. FIG. 14B shows the relationship between the overall likability results to the ratio of thaumatin to GRU90-MRP-FTA in Ex. 23.

FIG. 15A shows the relationship between the sensory evaluation results to the ratio of allulose to GRU90-MRP-CA in Ex. 24. FIG. 15B shows the relationship between the overall likability results to the ratio of allulose to GRU90-MRP-CA in Ex. 24.

FIG. 16A shows the relationship between the sensory evaluation results to the ratio of polydextrose to GRU90-MRP-CA in Ex. 25. FIG. 16B shows the relationship between the overall likability results to the ratio of polydextrose to GRU90-MRP-CA in Ex. 25.

FIG. 17A shows time-intensity curves for three representative ratios of the RM/RD mixture to GRU90-MRP-FTA in Ex. 26. FIG. 17B shows the relationship between the overall likability results to the ratio of the RM/RD mixture to GRU90-MRP-FTA in Ex. 26.

FIG. 18A shows time-intensity curves for three representative ratios of the RM/RD/RA97 mixture to GRU90-MRP-FTA in Ex. 27. FIG. 18B shows the relationship between the overall likability results to the ratio of the RM/RD/RA97 mixture to GRU90-MRP-FTA in Ex. 27.

FIG. 19 shows a comparison of theoretically calculated and experimentally determined SEs of GRU90-MRP-FTA per ppm in Ex. 28.

FIG. 20 shows a comparison of theoretically calculated and experimentally determined SEs of GRU90-MRP-FTA per ppm in Ex. 29.

FIG. 21 shows a graphical depiction of stable dissolution times for various ratios of GRU90-MRP-FTA to RD as a function of time in Ex. 30.

FIG. 22 shows a graphical depiction of stable dissolution times for various ratios of GRU90-MRP-FTA to RM as a function of time in Ex. 31.

FIG. 23A shows time-intensity curves for three representative ratios of GSG-MRP-CA to GRU90-MRP-FTA in Ex. 32. FIG. 23B shows the relationship between the overall likability results to the ratio of GSG-MRP-CA to GRU90-MRP-FTA in Ex. 32.

FIG. 24A shows the relationship between the sensory evaluation results to the ratio of GSG-MRP-CA to GRU90-MRP-FTA in sucralose in Ex. 33. FIG. 24B shows the relationship between the overall likability results to the ratio of GSG-MRP-CA to GRU90-MRP-FTA in sucralose in Ex. 33.

FIGS. 25A-25F show the results of sensory analyses in Ex. 46. FIG. 25A shows a sweetness/time-intensity profile of thaumatin. FIG. 25B shows a sweetness/time-intensity profile of thaumatin with RU20. FIG. 25C shows a sweetness/time-intensity profile of thaumatin with RU90. FIG. 25D shows a sweetness/time-intensity profile of thaumatin with GRU20. FIG. 25E shows a sweetness/time-intensity profile of thaumatin with GRU90. FIG. 25F shows a sweetness/time-intensity profile of thaumatin with TRU20.

FIG. 26 shows the design of the steam distillation process performed for GC/MS analysis in Ex. 47.

FIGS. 27A-27C show Chromatogram 1, including RU90 in the upper trace (FIG. 27A), GRU90 in the middle trace (FIG. 27B), and GRU90-MRP-TA in the lower trace (FIG. 27C); MS-TIC Mode and MS-spectra are indicated at each peak.

FIGS. 28A-28C show Chromatogram 2, including RU20 in the Upper Trace (FIG. 28A), GRU20 in the middle trace (FIG. 28B), and GRU20-MRP-TA in the lower trace; MS-TIC Mode and MS-spectra are indicated at each peak.

FIG. 29 shows Chromatogram 3, where the MS-Trace is indicative for molar masses 966 or less and where GRU20 shows Rub-1Glc (2 isomers) and Rub-2Glc (2 isomers).

FIG. 30 shows Chromatogram 4, where UV-254 nm and the upper trace shows RU20, while the lower trace shows GRU20 (indicative for phenolic acids, polyphenols).

FIGS. 31A-31C show representative chromatograms of RU20.

FIGS. 32A-32D show representative chromatograms of GRU20.

FIGS. 33A-33D show representative chromatograms of GRU20-MRP-TA.

FIGS. 34A-34D show representative chromatograms of GRU20-MRP-CA.

FIGS. 35A-35C show representative chromatograms of RU90.

FIGS. 36A-36D show representative chromatograms of GRU90.

FIGS. 37A-37D show representative chromatograms of GRU90-MRP-TA.

FIGS. 38A-38D show representative chromatograms of GRU90-MRP-CA.

FIGS. 39A-39D show representative chromatograms of GRU90-MRP-HO.

FIG. 40 shows representative chromatograms of RU20 SIM neg. MS 497, 335, 317 (indicative for suaviosides with isosteviol as skeleton).

FIG. 41 shows representative chromatograms of TRU20, SIM neg. MS 497, 335, 317 (indicative for suaviosides with isosteviol as skeleton).

FIG. 42 shows representative chromatograms of GRU20, SIM neg. MS 497, 335, 317 (indicative for suaviosides with isosteviol as skeleton).

FIG. 43 shows representative chromatograms of TRU20, SIM neg. MS 497, 335, 317 (indicative for suaviosides with isosteviol as skeleton).

FIG. 44 shows a representative chromatogram of RU20, Positive MS 439.

FIG. 45 shows the time intensity profiling in Ex. 48 being separated into 3 phases to evaluate the acidity/sweetness perception.

FIG. 46 shows time-intensity profiles for sweetness/acidity perception of TRU20 and GTRU20 in lemonade in Ex. 48.

FIG. 47 shows time-intensity profiles for sweetness/acidity perception of RU 90 and GRU90 in lemonade in Ex. 48.

FIG. 48 shows time-intensity profiles for sweetness/acidity perception of GRU20-MRP-CA, GRU20-MRP-TA and GTRU20-MRP-CA lemonade in Ex. 48.

FIG. 49 shows time-intensity profiles for sweetness/acidity perception of GRU90-MRP-CA and GRU90-MRP-TA lemonade in Ex. 48.

FIG. 50 shows time-intensity profiles for sweetness/acidity perception of stevia (GSGs+SGs)-MRP Caramel, stevia (GSGs+SGs)-MRP Tangerine, and stevia (GSGs+SGs)-MRP Caramel+Thaumatin lemonade in Ex. 48.

FIG. 51 shows time-intensity profiles from Ex. 48 for sweetness/acidity perception of TRU20 and GTRU20 in Fanta Orange zero added sugar.

FIG. 52 shows time-intensity profiles from Ex. 48 for sweetness/acidity perception of RU 90 and GRU90 in Fanta Orange zero added sugar.

FIG. 53 shows time-intensity profiles from Ex. 48 for sweetness/acidity perception of GRU20-MRP-CA, GRU20-MRP-TA and GTRU20-MRP-CA in Fanta Orange zero added sugar.

FIG. 54 shows time-intensity profiles from Ex. 48 for sweetness/acidity perception of GRU90-MRP-CA and GRU90-MRP-TA in Fanta Orange zero added sugar.

FIG. 55 shows time-intensity profile for sweetness/acidity perception of stevia(GSGs+SGs)-MRP Caramel, stevia(GSGs+SGs)-MRP Tangerine, and stevia (GSGs+SGs)-MRP Caramel+Thaumatin.

FIG. 56 shows time-intensity profiles from Ex. 49 of Red Bull sugar free without/with GTRU20-MRP-HO and GRU90-MRP-HO.

FIG. 57 shows time-intensity profiles from Ex. 49 for vanilla curcuma drink without/with RU90, GRU90, GTRU20-MRP-CA and GRU90-MRP-CA.

FIG. 58 shows time-intensity profiles from Ex. 49 for chocolate milk drink without/with RU90, GRU90, GTRU20-MRP-CA and GRU90-MRP-CA.

FIG. 59 shows time-intensity profiles from Ex. 49 for chocolate drink without/with GTRU20-MRP-CA and GRU90-MRP-CA.

FIG. 60 shows time-intensity profiles from Ex. 49 for chocolate milk drink without/with GRU90, GRU20-MRP-CA, GTRU20-MRP-CA and GRU90-MRP-CA.

FIG. 61 shows time-intensity profiles from Ex. 49 for sugar reduced cappuccino without/with RU90, GRU90, GRU20-MRP-CA, GTRU20-MRP-CA and GRU90-MRP-CA.

FIG. 62 shows time-intensity profiles from Ex. 49 for sugar free cappuccino without/with RU90, GRU90, GRU20-MRP-CA, GTRU20-MRP-CA and GRU90-MRP-CA.

FIG. 63 shows time-sweet intensity profiles from Ex. 53 for RU10, GRU10-MRP-CA (51-01, 51-02) based on the sweetness profile data in Table 53-3.

FIG. 64 shows time-sweetness intensity profiles from Ex. 53 for RU10, GRU10-MRP-FTA (52-01, 52-02) in sugar reduction system.

FIGS. 65A and 65B shows the appearance of the GSG-MRP/hemp seed oil/CBD final product described in Ex. 55.

FIG. 66A shows tasting samples from Ex. 55 with various amounts of GSG-MRP/hemp seed oil/CBD final product dissolved in water for tasting. FIG. 66B depicts solubility samples from Ex. 55 with various amounts of GSG-MRP/hemp seed oil/CBD final product in water.

FIG. 67A shows the resulting GSG-MRP reaction products formed in Ex. 56. FIG. 67B shows the appearance of tasting samples with various concentrations of the final GSG-MRP product formed in Ex. 56.

FIG. 68 shows the appearance of the GSG-MRP product in oil formed in Ex. 57.

FIG. 69 shows the overall likability of a commercial dairy product (67-01) containing GRU90-MRP-FTAs based on the sensory evaluation results in Table 68-3 of Ex. 68.

FIG. 70 shows the overall likability of the samples based on the sensory evaluation results in Table 69-3 of Ex. 69.

FIG. 71 shows the overall likability of the tested samples based on the sensory evaluation results in Table 70-3 of Ex. 70.

FIG. 72 shows the overall likability of the GRU90-MRP-FTAs in two commercial tea drinks, based on the sensory evaluation results in Table 71-3 of Ex. 71.

FIG. 73 shows the overall likability of the tested samples based on the sensory evaluation results in Table 72-3 of Ex. 72.

FIG. 74A shows the relationship between the sensory evaluation results as a function of the weight ratio of Luo Han Guo extract to GRU90-MRP-FTA in Ex. 73. FIG. 74B shows the overall likability of the sample compositions, based on the sensory evaluation results in Table 73-2 of Ex 73. FIG. 74C shows time-intensity curves as a function of the weight ratio of Luo Han Guo extract to GRU90-MRP-FTA based on the data in Table 73-3 of Ex. 73.

FIG. 75A shows the relationship between the sensory evaluation results as a function of the weight ratio of Luo Han Guo extract to GRU90-MRP-FTA in Ex. 74. FIG. 75B shows the relationship between the overall likability as a function of the weight ratio of Luo Han Guo extract to GRU90-MRP-FTA based on the sensory evaluation results in Table 74-2 of Ex. 74. FIG. 75C shows time-intensity curves as a function of the weight ratio of Luo Han Guo extract to GRU90-MRP-FTA, based on the results in Table 74-3 of Ex. 74.

FIGS. 76A-76C show total ion chromatograms (TIC) of the RU10, GRU10 and GRU10-MRP-FTA samples detected in Ex. 75 by SPME-GCxGC-TOF-MS, respectively.

FIGS. 77A-77C show 3D surface plots of the RU10, GRU10 and GRU10-MRP-FTA samples detected in Ex. 75 by SPME-GCxGC-TOF-MS, respectively.

FIGS. 78A-78C and 79A-79C show total ion chromatograms (TIC) of the RU40, GRU40 and GRU40-MRP-FTA samples in Ex. 75 detected by SPME-GCxGC-TOF-MS.

FIGS. 80A-80C show total ion chromatograms (TICs) of the RU90, GRU90 and GRU90-MRA-FTA samples detected by SPME-GCxGC-TOF-MS, respectively.

FIGS. 81A-81C show 3D surface plots of the RU90, GRU90 and GRU90-MRA-FTA samples detected by SPME-GCxGC-TOF-MS, respectively.

FIG. 82 shows the overall likability of GSG-MRP-CA, GSG-MRP-TN, and GSG-MRP-HO in commercial carbonated beverages, based on the sensory evaluation results in Table 84-3 of Ex. 84.

FIG. 83 shows the overall likability of GSG-MRP-CA, GSG-MRP-TN, and GSG-MRP-HO in commercial flavored water beverages, based on the sensory evaluation results in Table 85-3 of Ex. 85.

FIG. 84 shows the overall likability of GSG-MRP-CA, GSG-MRP-TN and GSG-MRP-HO in commercial fruit and vegetable juice based on the sensory evaluation results in Table 86-3 of Ex. 86.

FIG. 85 shows the overall likability of GSG-MRP-CA, GSG-MRP-TN and GSG-MRP-HO in a functional Gatorade beverage based on the sensory evaluation results in Table 87-3 of Ex. 87.

FIG. 86A shows a chromatogram from the Head Space GC/MS Analysis of Ref. Y0034434 Lemon Juice Volatiles Conc. Extract in Ex. 94. FIG. 86B shows a chromatogram from the Liquid Injection GC/MS Analysis of Ref. Y0034434 Lemon Juice Volatiles Conc. Extract in Ex. 94.

FIG. 87A shows a chromatogram from the Head Space GC/MS Ref analysis of 71025597 Orange Juice Volatiles Conc. Extract in Ex. 94. FIG. 87B shows a chromatogram from the liquid injection GC/MS analysis of Ref 71025597 Orange Juice Volatiles Conc. Extract in Ex. 94.

FIG. 88 shows the sensory evaluation results of GRU90-MRPs prepared with different sugar donors in Ex. 101.

FIG. 89 shows the overall likability of GRU40-MRPs prepared with different weight of sugar donors, amino acids and GRU40 s in Ex. 105.

FIG. 90A shows the sensory evaluation results to the ratio of sucralose to GRU40-MRP-FTA in Ex. 116. FIG. 90B shows the overall likability to the ratio of sucralose to GRU40-MRP-FTA in Ex. 116.

FIG. 91A shows the sensory evaluation results to the ratio of GSG-MRP-CA to GRU40-MRP-FTA in Ex. 117. FIG. 91B shows the overall likability to the ratio of GSG-MRP-CA to GRU40-MRP-FTA in Ex. 117.

FIG. 92A shows the overall likability as a function of the weight ratio of thaumatin in GRU40-MRP-CA in Ex. 118. FIG. 92B shows the time-intensity curves as a function of the weight ratio of thaumatin in GRU40-MRP-CA in Ex. 118.

FIG. 93A shows the sensory evaluation results to the ratio of acesulfame-K to GRU40-MRP-CA in Ex. 119. FIG. 93B shows the overall likability to the ratio of acesulfame-K to GRU40-MRP-CA in Ex. 119.

FIG. 94A shows the sensory evaluation results to the ratio of RA97 to GRU40-MRP-CA in Ex. 120. FIG. 94B shows the overall likability to the ratio of RA97 to GRU40-MRP-CA in Ex. 120.

FIG. 95A shows the sensory evaluation results as a function of the weight ratio of the mixture solution (sucralose and acesulfame-k) to the ratio of GRU90-MRP-FTA in Ex. 126. FIG. 95B shows the time-intensity curves as a function of the weight ratio of the mixture solution (sucralose and acesulfame-k) to the ratio of GRU90-MRP-FTA in Ex. 126. FIG. 95C shows the overall likability as a function of the weight ratio of the mixture solution (sucralose and acesulfame-k) to the ratio of GRU90-MRP-FTA in Ex. 126.

FIGS. 96A-96E in Ex. 133 show differences in perception of various sensory characteristics in sugar free ice tea lemon with or without GSG-MRP-FTA (product of Ex. 39-05) as a function of storage duration at 2-4° C., including perception of sweetness (FIG. 96B), perception of artificial taste (FIG. 96C), perception of flavor intensity (FIG. 96D), perception of mouth-feeling (FIG. 96E) and all of the foregoing sensory characteristics (FIG. 96A).

FIGS. 97A-97E in Ex. 133 show differences in perception of various sensory characteristics in sugar free ice tea lemon with or without GSG-MRP-FTA (product of Ex. 39-05) as a function of storage duration at 20-22° C., including perception of sweetness (FIG. 97B), perception of artificial taste (FIG. 97C), perception of flavor intensity (FIG. 97D), perception of mouth-feeling (FIG. 97E) and all of the foregoing sensory characteristics (FIG. 97A).

FIGS. 98A-98E in Ex. 134 show differences in perception of various sensory characteristics in sugar free ice tea lemon with or without GRU90-MRP-FTA (product of Ex. 39-10) as a function of storage duration at 2-4° C., including perception of sweetness (FIG. 98B), perception of artificial taste (FIG. 98C), perception of flavor intensity (FIG. 98D), perception of mouth-feeling (FIG. 98E) and all of the foregoing sensory characteristics (FIG. 98A).

FIGS. 99A-99E in Ex. 134 show differences in perception of various sensory characteristics in sugar free ice tea lemon with or without GRU90-MRP-FTA (product of Ex. 39-10) as a function of storage duration at 20-22° C., including perception of sweetness (FIG. 99B), perception of artificial taste (FIG. 99C), perception of flavor intensity (FIG. 99D), perception of mouth-feeling (FIG. 99E) and all of the foregoing sensory characteristics (FIG. 99A).

FIGS. 100A-100E in Ex. 135 show differences in perception of various sensory characteristics in sugar free soft drink with orange flavor with or without GSG-MRP-FTA (product of Ex. 39-5) as a function of storage duration at 2-4° C., including perception of sweetness (FIG. 100B), perception of artificial taste (FIG. 100C), perception of flavor intensity (FIG. 100D), perception of mouth-feeling (FIG. 100E) and all of the foregoing sensory characteristics (FIG. 100A).

FIGS. 101A-101E in Ex. 135 show differences in perception of various sensory characteristics in sugar free soft drink with orange flavor with or without GSG-MRP-FTA (product of Ex. 39-5) as a function of storage duration at 20-22° C., including perception of sweetness (FIG. 101B), perception of artificial taste (FIG. 101C), perception of flavor intensity (FIG. 101D), perception of mouth-feeling (FIG. 101E) and all of the foregoing sensory characteristics (FIG. 101A)

FIGS. 102A-102E in Ex. 136 show differences in perception of various sensory characteristics in sugar free soft drink with orange flavor with or without GRU90-MRP-FTA (product of Ex. 39-10) as a function of storage duration at 2-4° C., including perception of sweetness (FIG. 102B), perception of artificial taste (FIG. 102C), perception of flavor intensity (FIG. 102D), perception of mouth-feeling (FIG. 102E) and all of the foregoing sensory characteristics (FIG. 102A).

FIGS. 103A-103E in Ex. 136 show differences in perception of various sensory characteristics in sugar free soft drink with orange flavor with or without GRU90-MRP-FTA (product of Ex. 39-10) as a function of storage duration at 20-22° C., including perception of sweetness (FIG. 103B), perception of artificial taste (FIG. 103C), perception of flavor intensity (FIG. 103D), perception of mouth-feeling (FIG. 103E) and all of the foregoing sensory characteristics (FIG. 103A).

FIGS. 104A-104E in Ex. 137 show differences in perception of various sensory characteristics in sugar reduced soft drink with raspberry-elderflower flavor with or without GSG-MRP-FTA (product of Ex. 39-5) as a function of storage duration at 2-4° C., including perception of sweetness (FIG. 104B), perception of artificial taste (FIG. 104C), perception of flavor intensity (FIG. 104D), perception of mouth-feeling (FIG. 104E) and all of the foregoing sensory characteristics (FIG. 104A).

FIGS. 105A-105E in Ex. 137 show differences in perception of various sensory characteristics in sugar reduced soft drink with raspberry-elderflower flavor with or without GSG-MRP-FTA (product of Ex. 39-5) as a function of storage duration at 20-22° C., including perception of sweetness (FIG. 105B), perception of artificial taste (FIG. 105C), perception of flavor intensity (FIG. 105D), perception of mouth-feeling (FIG. 105E) and all of the foregoing sensory characteristics (FIG. 105A).

FIGS. 106A-106E in Ex. 138 show differences in perception of various sensory characteristics in sugar reduced soft drink with raspberry-elderflower flavor with or without GRU90-MRP-FTA (product of Ex. 39-10) as a function of storage duration at 2-4° C., including perception of sweetness (FIG. 106B), perception of artificial taste (FIG. 106C), perception of flavor intensity (FIG. 106D), perception of mouth-feeling (FIG. 106E) and all of the foregoing sensory characteristics (FIG. 106A).

FIGS. 107A-107E in Ex. 138 show differences in perception of various sensory characteristics in sugar reduced soft drink with raspberry-elderflower flavor with or without GRU90-MRP-FTA (product of Ex. 39-10) as a function of storage duration at 20-22° C., including perception of sweetness (FIG. 107B), perception of artificial taste (FIG. 107C), perception of flavor intensity (FIG. 107D), perception of mouth-feeling (FIG. 107E) and all of the foregoing sensory characteristics (FIG. 107A).

FIG. 108A in Ex. 144 shows a chromatogram of an MRP prepared with Alanine, Glucose and Stevia extract sample 1-4 in phosphate-buffer pH=7.8 for 2.5 hours at 120° C.

FIG. 108B in Ex. 144 shows a chromatogram with a peak of 15-17 min as related to heated sugar with an extracted m/z=198, indicative of alapyridaine [M+H⁺]⁺).

FIG. 108C in Ex. 144 shows a chromatogram with a peak of 17.8 minutes as related to heated sugar with an m/z 198=[M+H⁺]⁺, m/z 216=[M+H₂O+H⁺]⁺, m/z 152=[M-46 [CO₂H₂]+H⁺]⁺ UV-spectrum of the peak at 17.5 minutes.

FIG. 108D in Ex. 144 shows a chromatogram with a UV-Vis spectrum similar to published one for alapyridaine.

FIG. 109A in Ex. 145 shows an exemplary chromatogram with a SIM-Trace of m/z=797 indicative of an Amadori product corresponding to Arginine+Rubusoside. FIG. 109B in Ex. 145 shows a corresponding mass spectrum with an m/z=797 and fragments indicative of an Amadori product corresponding to Arginine+Rubusoside.

FIG. 109C in Ex. 145 shows an exemplary chromatogram with a SIM-Trace of m/z=248 indicative of an Amadori product corresponding to Valine+Xylose. FIG. 109D in Ex. 145 shows a corresponding mass spectrum with an m/z=248 and fragments indicative of an Amadori product corresponding to Arginine+Rubusoside.

FIG. 110A in Ex. 146 shows the time-intensity curves for Vanilla Flavor in yoghurt (4.5% Sugar) with or without GSG-MRP-CA (200 ppm) and Flavor Recognition Time (RT) [mean±s.d.].

FIG. 110B in Ex. 146 shows the time-intensity curves for Vanilla Flavor in yoghurt (4.5% Sugar) with or without GRU90-MRP-FTA (39-10 in example 39) (200 ppm) and Flavor Recognition Time (RT) [mean±s.d.].

FIG. 111A in Ex. 146 shows the time-intensity curves for Cola Flavor in sugar-free beverage (Sucralose) with or without GSG-MRP-CA (200 ppm) and Flavor Recognition Time (RT) [mean±s.d.].

FIG. 111B in Ex. 146 shows the time-intensity curves for Cola Flavor in sugar-free beverage (Sucralose) with or without GRU90-MRP-CA (200 ppm) and Flavor Recognition Time (RT) [mean±s.d.].

FIG. 111C in Ex. 146 shows the time-intensity curves for Cola Flavor in sugar-free beverage (Sucralose) with or without GRU90-MRP-FTA (39-10 in example 39) (200 ppm) and Flavor Recognition Time (RT) [mean±s.d.].

FIG. 112A in Ex. 146 shows the time-intensity curves for Lemon Flavor in water with or without GSG-MRP-CA (200 ppm) and Flavor Recognition Time (RT) [mean±s.d.].

FIG. 112B in Ex. 146 shows the time-intensity curves for Lemon Flavor in water with or without GRU90-MRP-CA (200 ppm) and Flavor Recognition Time (RT) [mean±s.d.].

FIG. 112C in Ex. 146 shows the time-intensity curves for Lemon Flavor in water with or without GRU90-MRP-FTA (39-10 in example 39) (200 ppm) and Flavor Recognition Time (RT) [mean±s.d.].

FIG. 113A in Ex. 147 shows the sensory evaluation results to the ratio of RA97 to GRU90-MRP-FTA (131-01 in Ex. 131). FIG. 113B in Ex. 147 shows the overall likability to the ratio of RA97 to GRU90-MRP-FTA (131-01 in Ex. 131).

FIG. 114A in Ex. 153 shows the sensory evaluations of product compositions containing mixtures of GSTV85 and GRU90 in different ratios. FIG. 114B shows the overall likability of the product compositions in FIG. 114A.

FIG. 115A in Ex. 155 is a chart showing the sensory evaluation results of GSG-MRP-FTA/GRU90-MRP-FTAs (154-01 to 154-04 in Ex. 154) in 400 ppm RA75/RB15 solution (155-01 to 155-04 in Ex. 154). FIG. 115B in Ex. 155 is a bar graph showing the overall likability of GSG-MRP-FTA/GRU90-MRP-FTAs (product 154-01 to 154-04 from Ex. 154) in 400 ppm RA75/RB15 solution (155-01 to 155-04 in Ex. 154).

FIG. 116A in Ex. 156 is a bar graph showing the sensory evaluation results in Table 156-2. FIG. 116B in Ex. 156 is a bar graph showing the overall likability of the results in Table 156-2.

FIG. 117A in Ex. 158 is a chart showing the sensory evaluation results of GRU90-MRP-FTA (157-01 to 157-05 in Ex. 157) in 400 ppm RA75/RB15 solution. FIG. 117B in Ex. 158 is bar graph showing the overall likability of GRU90-MRP-FTA (157-01 to 157-05 in Ex. 157) in 400 ppm RA75/RB15 solution.

FIG. 118A in Ex. 161 is a bar graph showing the sensory evaluation results in Table 161-2. FIG. 118B in Ex. 161 is a bar graph showing the overall likability of the samples in Table 161-2.

FIG. 119 in Ex. 167 is a bar graph showing the bitterness and overall likability of GRU90-MRP-FTA (39-01 in Ex. 39) in salad.

FIG. 120A in Ex. 170 shows an exemplary sweetness and lingering profile as a function of time. FIG. 120B in Ex. 170 shows a sweetness profile of GRU90-MRP-PLTA (168-01 in Ex. 168) as a function of time. FIG. 120C in Ex. 170 shows a sweetness profile of GSG-MRP-PLTA (168-02 in Ex. 168) as a function of time.

### DETAILED DESCRIPTION

### I. Definitions

Unless defined otherwise, all technical and scientific terms used herein have the same meanings as commonly understood by one of ordinary skill in the art to which this application belongs. All publications and patents specifically mentioned herein are incorporated by reference in their entirety for all purposes including describing and disclosing the chemicals, instruments, statistical analyses and methodologies which are reported in the publications which might be used in connection with the application. All references cited in this specification are to be taken as indicative of the level of skill in the art. Nothing herein is to be construed as an admission that the application is not entitled to antedate such disclosure by virtue of prior invention.

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a,” “an,” and “the” include plural reference unless the context clearly dictates otherwise. Further, the terms “a” (or “an”), “one or more” and “at least one” can be used interchangeably herein. It is also to be noted that the terms “comprising,” “including,” “characterized by” and “having” can be used interchangeably. Further, any reactant concentrations described herein should be considered as being described on a weight to weight (w/w) basis, unless otherwise specified to the contrary (e.g., mole to mole, weight to volume (w/v), etc.).

As used herein, the term “glycoside” refers to a molecule in which a sugar (the “glycone” part or “glycone component” of the glycoside) is bonded to a non-sugar (the “aglycone” part or “aglycone component”) via a glycosidic bond.

The terms “steviol glycoside,” and “SG” are used interchangeably with reference to a glycoside of steviol, a diterpene compound shown in Formula I, wherein one or more sugar residues are attached to the steviol compound of Formula I.

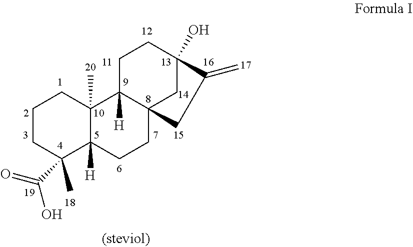

Steviol glycosides also include glycosides of isomers of steviol (isosteviol) as depicted in Formula II below, and derivatives of steviol, such as 12α-hydroxy-steviol and 15α-hydroxy-steviol.

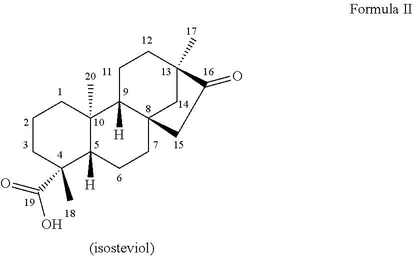

The terms “glycosidic bond” and “glycosidic linkage” refer to a type of chemical bond or linkage formed between the anomeric hydroxyl group of a saccharide or saccharide derivative (glycone) and the hydroxyl group of another saccharide or a non-saccharide organic compound (aglycone) such as an alcohol. The reducing end of the di- or polysaccharide lies towards the last anomeric carbon of the structure, whereas the terminal end lies in the opposite direction.

By way of example, a glycosidic bond in steviol and isosteviol involves the hydroxyl-group at the sugar carbon atom numbered 1 (so-called anomeric carbon atom) and a hydroxyl-group in the C19 carbonyl group of the steviol or isosteviol molecule building up a so-called O-glycoside or glycosidic ester. Additional glycosidic ester linkages can be formed at the hydroxyl group at C13 of steviol and at the carbonyl oxygen at C16 of isosteviol. Linkages at carbon atoms in the C1, C2, C3, C6, C7, C11, C12 and C15 positions of both steviol and isosteviol yield C-glycosides. In addition, C-glycosides can also be formed at the 2 methyl groups at C18 and C20 in both steviol and isosteviol.

The sugar part can be selected from any sugar with 3-7 carbon atoms, derived from either a dihydroxy-acetone (ketose) or a glycerin-aldehyde (aldose). The sugars can occur in open chain or in cyclic form, as D- or L-enantiomers and in α- or β-conformation.

Representative structures of possible sugar (Sug) conformations exemplified by glucose include D-glucopyranose and L-glucopyranose in which the position 1 is determinative of the α- or β-conformation:

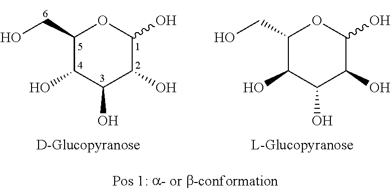 [SMILES: OC[C@H]1OC(O)[C@H](O)[C@@H](O)[C@@H]1O ; OC[C@@H]1OC(O)[C@@H](O)[C@H](O)[C@H]1O]

The steviol glycosides for use in the sweetener or flavor composition of the present application include one or more glycosylated compounds with structures depicted in Table A.

TABLE A
Possible positions of sugar (Sug) molecules
linked to steviol/isosteviol.

| Aglycone | Position | Sugar (Sug) | Conjugation | Category |
|---|---|---|---|---|
| Steviol | 13 | D- α | D-Sug α (1-13) | O-glucoside |
| | | D- β | D-Sug β (1-13) | |
| | | L- α | L-Sug α (1-13) | |
| | | L- β | L-Sug β (1-13) | |
| Isosteviol | 16 | D- α/β | D-Sug α/β (1-16) | O-glucoside |
| | | L- α/β | L-Sug α/β (1-16) | (after reduction |
| | | | | of keto-group) |
| Steviol | 19 | D/L- α/β | D/L-Sug α/β (1-19) | Glucose-ester |
| Isosteviol | | | | |
| Steviol | 1 | D/L- α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | 14 | | D/L-Sug α/β (1-14) | |
| | 15 | | D/L-Sug α/β (1-15) | |
| Steviol | (18) | D/L- α/β | D/L-Sug α/β (1-18) | Methyl en- |
| | | | | glucoside |
| | (20) | | D/L-Sug α/β (1-20) | |
| Isosteviol | 1 | D/L- α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | (13) | | D/L-Sug α/β (1-12) | |
| | 14 | | D/L-Sug α/β (1-14) | |
| | 15 | | D/L-Sug α/β (1-15) | |
| Isosteviol | (18) | D/L- α/β | D/L-Sug α/β (1-18) | Methylen- |
| | | | | glucoside |
| | (20) | | D/L-Sug α/β (1-20) | |

Stevia plants contain a variety of different SGs in varying percentages. The phrase “steviol glycoside” is recognized in the art and is intended to include the major and minor constituents of Stevia. These “SGs” include, for example, stevioside, steviolbioside, rebaudioside A (RA), rebaudioside B (RB), rebaudioside C (RC), rebaudioside D (RD), rebaudioside E (RE), rebaudioside F (RF), rebaudioside M (RM), rebaudioside O (RO), rebaudioside H (RH), rebaudioside I (RI), rebaudioside L (RL), rebaudioside N (RN), rebaudioside K (RK), rebaudioside J (RJ), rebaudioside U, rubusoside, dulcoside A (DA) as well as those listed in Tables A and B or mixtures thereof.

As used herein, the terms “rebaudioside A,” “Reb A,” “Reb-A” and “RA” are equivalent terms referring to the same molecule. The same condition applies to all lettered rebaudiosides with the exception of rebaudioside U, which may be referred to as Reb-U or Reb U, but not RU, so as to not be confused with rubusoside which is also referred to as RU.

Based on the type of sugar (i.e. glucose, rhamnose/deoxyhexose, xylose/arabinose) SGs can be grouped into three families (1) SGs with glucose; (2) SG with glucose and one rhamnose or deoxyhexose moiety; and (3) SGs with glucose and one xylose or arabinose moiety. The steviol glycosides for use in the present application are not limited by source or origin. Steviol glycosides may be extracted from Stevia leaves, synthesized by enzymatic processes, synthesized by chemical syntheses, or produced by fermentation.

Specific examples of steviol glycosides include, but are not limited to, the compounds listed in Table B and isomers thereof. The steviol glycosides for use in the present application are not limited by source or origin. Steviol glycosides may be extracted from Stevia plants, Sweet tea leaves, synthesized by enzymatic processes or chemical syntheses, or produced by fermentation.

TABLE B
Exemplary steviol glycosides

| | | | # Added | # Added | | | |
|---|---|---|---|---|---|---|---|
| | | # Added | Rhamnose/ | Xylose/ | | | |
| | | Glucose | Deoxyhexose | Arabinose | | | |
| | | moieties | moieties | moieties | | | |
| SG Name | MW | mw = 180 | mw = 164 | mw = 150 | R1 (C-19) | R2 (C-13) | Backbone |
| Related | 457 | — | | | | | |
| SvGn#1 | | | | | | | |
| Steviol- | 479 | 1 | | | H— | Glcβ1- | Steviol |
| monoside | | | | | | | |
| Steviol- | 479 | 1 | 1 | | Glcβ1- | H— | |
| monoside A | | | | | | | |
| SG-4 | 611 | 1 | | 1 | H— | Xylβ(1-2)Glcβ1- | Steviol |
| Dulcoside | 625 | 1 | 1 | | H— | Rhaα(1-2)Glcβ1- | Steviol |
| A1 | | | | | | | |
| Iso-steviol- | 641 | 2 | | | H— | Glcβ(1-2)Glcβ1- | Isosteviol |
| bioside | | | | | | | |
| Reb-G1 | 641 | 2 | | | H— | Glcβ(1-3)Glcβ1- | Steviol |
| Rubusoside | 641 | 2 | | | Glcβ1- | Glcβ1- | Steviol |
| Steviolbioside | 641 | 2 | | | H— | Glcβ(1-2)Glcβ1- | Steviol |
| Related | 675 | — | | | | | |
| SvGn#3 | | | | | | | |
| Reb-F1 | 773 | 2 | | 1 | H— | Xylβ(1-2)[Glcβ(1- | Steviol |
| | | | | | | 3)]Glcβ1- | |
| Reb-R1 | 773 | 2 | | 1 | H— | Glcβ(1-2)[Glcβ(1- | Steviol |
| | | | | | | 3)]Xylβ1- | |
| Stevioside F | 773 | 2 | | 1 | Glcβ1- | Xylβ(1-2)Glcβ1- | Steviol |
| (SG-1) | | | | | | | |
| SG-Unk1 | 773 | 2 | | 1 | — | — | Steviol |
| Dulcoside A | 787 | 2 | 1 | | Glcβ1- | Rhaα(1-2)Glcβ1- | Steviol |
| Dulcoside B | 787 | 2 | 1 | | H— | Rhaα(1-2)[Glcβ(1- | Steviol |
| (JECFA C) | | | | | | 3)]Glcβ1- | |
| SG-3 | 787 | 2 | 1 | | H— | 6-deoxyGlcβ(1- | Steviol |
| | | | | | | 2)[Glcβ(1-3)]Glcβ1- | |
| Stevioside D | 787 | 2 | 1 | | Glcβ1- | Glcβ(1-2)6- | |
| | | | | | | deoxyGlcβ1- | |
| Iso-Reb B | 803 | 3 | | | H— | Glcβ(1-2)[Glcβ(1- | Isosteviol |
| | | | | | | 3)]Glcβ1- | |
| Iso- | 803 | 3 | | | Glcβ1- | Glcβ(1-2)Glcβ1- | Isosteviol |
| Stevioside | | | | | | | |
| Reb B | 803 | 3 | | | H— | Glcβ(1-2)[Glcβ(1- | Steviol |
| | | | | | | 3)]Glcβ1- | |
| Reb G | 803 | 3 | | | Glcβ1- | Glcβ(1-3)Glcβ1- | Steviol |
| Reb-KA | 803 | 3 | | | Glcβ(1- | Glcβ1- | Steviol |
| | | | | | 2)Glcβ1- | | |
| SG-13 | 803 | 3 | | | Glcβ1- | Glcβ(1-2)Glcβ1- | Isomeric |
| | | | | | | | steviol |
| | | | | | | | (12α- |
| | | | | | | | hydroxy) |
| Stevioside | 803 | 3 | | | Glcβ1- | Glcβ(1-2)Glcβ1- | Steviol |
| Stevioside B | 803 | 3 | | | Glcβ(1- | Glcβ1- | Steviol |
| (SG-15) | | | | | 3)Glcβ1- | | |
| Reb F | 935 | 3 | | 1 | Glcβ1- | Xylβ(1-2)[Glcβ(1- | Steviol |
| | | | | | | 3)]Glcβ1- | |
| Reb R | 935 | 3 | | 1 | Glcβ1- | Glcβ(1-2)[Glcβ(1- | Steviol |
| | | | | | | 3)]Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xylβ(1- | Glcβ(1-2)Glcβ1- | Steviol |
| (SG-11) | | | | | 6)Glcβ1- | | |
| Reb F2 | 935 | 3 | | 1 | Glcβ1- | Glcβ(1-2)[Xylβ(1- | Steviol |
| (SG-14) | | | | | | 3)]Glcβ1- | |
| Reb C | 949 | 3 | 1 | | Glcβ1- | Rhaα(1-2)[Glcβ(1- | Steviol |
| | | | | | | 3)]Glcβ1- | |
| Reb C2/Reb S | 949 | 3 | 1 | | Rhaα(1- | Glcβ(1-2)Glcβ1- | Steviol |
| | | | | | 2)Glcβ1- | | |
| Stevioside E | 949 | 3 | 1 | | Glcβ1- | 6-DeoxyGlcβ(1- | Steviol |
| (SG-9) | | | | | | 2)[Glcβ(1-3)]Glcβ1- | |
| Stevioside | 949 | 3 | 1 | | 6-DeoxyGlcβ1- | Glcβ(1-2)[Glcβ(1- | |
| E2 | | | | | | 3)]Glcβ1- | |
| SG-10 | 949 | 3 | 1 | | Glcβ1- | Glcα(1-3)Glcβ(1- | Steviol |
| | | | | | | 2)[Glcβ(1-3])Glcβ1- | |
| Reb L1 | 949 | 3 | 1 | | H— | Glcβ(1-3)Rhaα(1- | Steviol |
| | | | | | | 2)[Glcβ(1-3)]Glcβ1- | |
| SG-2 | 949 | 3 | 1 | | Glcβ1- | 6-deoxyGlcβ(1- | Steviol |
| | | | | | | 2)[Glcβ(1-3)]Glcβ1- | |
| Reb A3 | 965 | 4 (1 Fru) | | | Glcβ1- | Glcβ(1-2)[Fruβ(1- | |
| (SG-8) | | | | | | 3)]Glcβ1- | |
| Iso-Reb A | 965 | 4 | | | Glcβ1- | Glcβ(1-2)[Glcβ(1- | Isosteviol |
| | | | | | | 3)]Glcβ1- | |
| Reb A | 965 | 4 | | | Glcβ1- | Glcβ(1-2)[Glcβ(1- | Steviol |
| | | | | | | 3)]Glcβ1- | |
| Reb A2 | 965 | 4 | | | Glcβ1- | Glcβ(1-6)[Glcβ(1- | Steviol |
| (SG-7) | | | | | | 2)]Glcβ1- | |
| Reb E | 965 | 4 | | | Glcβ(1- | Glcβ(1-2)Glcβ1- | Steviol |
| | | | | | 2)Glcβ1- | | |
| Reb H1 | 965 | 4 | | | H— | Glcβ(1-6)Glcβ(1- | Steviol |
| | | | | | | 3)[Glcβ1-3)]Glcβ1- | |
| Related | 981 | — | | | | | |
| SvGn#2 | | | | | | | |
| Related | 981 | — | | | | | |
| SvGn#5 | | | | | | | |
| Reb U2 | 1097 | 4 | | 1 | Xylβ(1- | Glcβ(1-2)Glcβ1- | |
| | | | | | 2)[Glcβ(1- | | |
| | | | | | 3)]Glcβ1- | | |
| Reb T | 1097 | 4 | | 1 | Xylβ(1- | Glcβ(1-2)[Glcβ(1- | |
| | | | | | 2)Glcβ1- | 3)]Glcβ1- | |
| Reb W | 1097 | 4 | | 1 | Glcβ(1- | Glcβ(1-2)Glcβ1- | |
| | | | | | 2)[Araβ(1- | | |
| | | | | | 3)]Glcβ1- | | |
| Reb W2 | 1097 | 4 | | 1 | Araβ(1- | Glcβ(1-2)[Glcβ(1- | |
| | | | | | 2)Glcβ1- | 3)]Glcβ1- | |
| Reb W3 | 1097 | 4 | | 1 | Araβ(1- | Glcβ(1-2)[Glcβ(1- | |
| | | | | | 6)Glcβ1- | 3)]Glcβ1- | |
| Reb U | 1097 | 4 | | 1 | Araα(1- | Glcβ(1-2)[Glcβ(1- | Steviol |
| | | | | | 2)-Glcβ1- | 3)]Glcβ1- | |
| SG-12 | 1111 | 4 | 1 | | Rhaα(1- | Glcβ(1-2)[Glcβ(1- | Steviol |
| | | | | | 2)Glcβ1- | 3)]Glcβ1- | |
| Reb H | 1111 | 4 | 1 | | Glcβ1- | Glcβ(1-3)Rhaα(1- | Steviol |
| | | | | | | 2)[Glcβ(1-3)]Glcβ1- | |
| Reb J | 1111 | 4 | 1 | | Rhaα(1- | Glcβ(1-2)[Glcβ(1- | Steviol |
| | | | | | 2)Glcβ1- | 3)]Glcβ1- | |
| Reb K | 1111 | 4 | 1 | | Glcβ(1- | Rhaα(1-2)[Glcβ(1- | Steviol |
| | | | | | 2)Glcβ1- | 3)]Glcβ1- | |
| Reb K2 | 1111 | 4 | 1 | | Glcβ(1- | Rhaα(1-2)[Glcβ(1- | Steviol |
| | | | | | 6)Glcβ1- | 3)]Glcβ1- | |
| SG-Unk4 | 1111 | 4 | 1 | | — | — | Steviol |
| SG-Unk5 | 1111 | 4 | 1 | | — | — | Steviol |
| Reb D | 1127 | 5 | | | Glcβ(1- | Glcβ(1-2)[Glcβ(1- | Steviol |
| | | | | | 2)Glcβ1- | 3)]Glcβ1- | |
| Reb I | 1127 | 5 | | | Glcβ(1- | Glcβ(1-2)[Glcβ(1- | Steviol |
| | | | | | 3)Glcβ1- | 3)]Glcβ1- | |
| Reb L | 1127 | 5 | | | Glcβ1- | Glcβ(1-6)Glcβ(1- | Steviol |
| | | | | | | 2)[Glcβ(1-3)]Glcβ1- | |
| Reb I3 | 1127 | 5 | | | [Glcβ(1- | Glcβ(1-2)Glcβ1- | |
| | | | | | 2)Glcβ(1- | | |
| | | | | | 6)]Glcβ1- | | |
| SG-Unk6 | 1127 | 5 | | | — | — | Steviol |
| Reb Q | 1127 | 5 | | | Glcβ1- | Glcα(1-4)Glcβ(1- | Steviol |
| (SG-5) | | | | | | 2)[Glcβ(1-3)]Glcβ1- | |
| Reb 12 | 1127 | 5 | | | Glcβ1- | Glcα(1-3)Glcβ1- | Steviol |
| (SG-6) | | | | | | 2[Glcβ1-3)]Glcβ1- | |
| Reb Q2 | 1127 | 5 | | | Glcα(1- | Glcβ(1-2)Glcβ1- | |
| | | | | | 2)Glcα(1- | | |
| | | | | | 4)Glcβ1- | | |
| Reb Q3 | 1127 | 5 | | | Glcβ1- | Glcα(1-4)Glcβ(1- | |
| | | | | | | 3)[Glcβ(1-2)]Glcβ1- | |
| Reb T1 | 1127 | 5 (1 Gal) | | | Galβ(1- | Glcβ(1-2)[Glcβ(1- | |
| | | | | | 2)Glcβ1- | 3)]Glcβ1- | |
| Related | 1127 | — | | | | | |
| SvGn#4 | | | | | | | |
| Reb V2 | 1259 | 5 | | 1 | Xylβ(1- | Glcβ(1-2)[Glcβ(1- | Steviol |
| | | | | | 2)[Glcβ(1- | 3)]Glcβ1- | |
| | | | | | 3)]-Glcβ1- | | |
| Reb V | 1259 | 5 | | 1 | Glcβ(1- | Xylβ(1-2)[Glcβ(1- | |
| | | | | | 2)[Glcβ(1- | 3)]-Glcβ1- | |
| | | | | | 3)]Glcβ1- | | |
| Reb Y | 1259 | 5 | | 1 | Glcβ(1- | Glcβ(1-2)[Glcβ(1- | |
| | | | | | 2)[Araβ(1- | 3)]Glcβ1- | |
| | | | | | 3)]Glcβ1- | | |
| Reb N | 1273 | 5 | 1 | | Rhaα(1- | Glcβ(1-2)[Glcβ(1- | Steviol |
| | | | | | 2)[Glcβ(1- | 3)]Glcβ1- | |
| | | | | | 3)]Glcβ1- | | |
| Reb M | 1289 | 6 | | | Glcβ(1- | Glcβ(1-2)[Glcβ(1- | Steviol |
| | | | | | 2)[Glcβ(1- | 3)]Glcβ1- | |
| | | | | | 3)]Glcβ1- | | |
| 15α-OH | 1305 | 6 | | | Glcβ1- | Glcβ(1-2)[Glcβ1- | 15α- |
| Reb M | | | | | 2(Glcβ1- | 3]Glcβ1- | Hydroxy- |
| | | | | | 3)Glcβ1- | | steviol |
| Reb O | 1435 | 6 | 1 | | Glcβ(1- | Glcβ(1-2)[Glcβ(1- | Steviol |
| | | | | | 3)Rhaα(1- | 3)]Glcβ1- | |
| | | | | | 2)[Glcβ(1- | | |
| | | | | | 3)]Glcβ1- | | |
| Reb O2 | 1435 | 6 | 1 | | Glcβ(1- | Glcβ(1-2)[Glcβ(1- | |
| | | | | | 4)Rhaα(1- | 3)]Glcβ1- | |
| | | | | | 2)[Glcβ(1- | | |
| | | | | | 3)]Glcβ1- | | |

Legend: SG-1 to 16: SGs without a specific name; SG-Unk1-6: SGs without detailed structural proof; Glc: Glucose; Rha: Rhamnose; Xyl: Xylose; Ara: Arabinose.

The term “glycosylated steviol glycosides (GSGs)” refers to molecules that (1) contain a SG backbone and one or more additional sugar residues, and (2) are artificially produced by enzymatic conversion, fermentation or chemical synthesis.

The terms “ST plant”, “Chinese sweet tea plant”, “sweet tea plant”, and “Rubus suavissimus plant” are used interchangeably with reference to a Rubus suavissimus plant.

The term “sweet tea extract (STE)” refers to extract prepared from the whole ST plant, in the aerial part of an ST plant, in the leaves of an ST plant, in the flowers of an ST plant, in the fruit of an ST plant, in the seeds of an ST plant, in the roots of an ST plant, branches of an ST plant, and/or any other portions of an ST plant. It should also be understood that a sweet tea extract (STE) can be purified and/or separated into one or more sweet tea components (STC).

The term “sweet tea component (STC)”, refers to a component of a STE. A STC, such as rubusoside, may be purified from a natural source, produced by a chemical or enzymatic process (e.g., converted from stevioside with glycosyl hydrolase, thermostable lactase from Therus Themophilus, Hesperidinase from Aspergillus Niger or any other types of enzymes), or produced by fermentation. Examples of STC include, but are not limited to, rubusoside (RU), suaviosides (SUs), steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin. Examples of suaviosides (SUs) include, but are not limited to, SU-A, SU-B, SU-C1, SU-D1, SU-D2, SU-E, SU-F, SU-G, SU-H, SU-I, and SU-J.

The terms “sweet tea glycoside (STG)” refers to a glycoside derived from sweet tea plants or known to be present in sweet tea plants. Examples of STG include, but are not limited to, rubusoside, suaviosides such as SU-A, SU-B, SU-C1, SU-D1, SU-D2, SU-E, SU-F, SU-G, SU-H, SU-I, and SU-J, steviolmonoside, rebaudioside A, 13-O-β-D-glucosyl-steviol, isomers of rebaudioside B, isomers of stevioside, panicloside IV and sugeroside. Some STGs, such as rubusoside, are also present in Stevia plants and are steviol glycosides (SGs)

The term “non-Stevia sweet tea component (NSTC)” refers to a STC that is not present in a naturally growing Stevia plant. Examples of NSTCs include, but are not limited to, sauviosides.

The term “non-stevia sweet tea glycoside (NSTG)” refers to a STG that is not present in Stevia plants or Stevia extracts. Examples of NSTGs include, but are not limited to, sauviosides.

The term “sauviosides” refers to a group of kaurane-type diterpene glycosides that can be isolated from the leaves of Rubus suavissimus. Examples of suaviosides include, but are not limited to, SU-A, SU-B, SU-C1, SU-D1, SU-D2, SU-E, SU-F, SU-G, SU-H, SU-I, and SU-J. The chemical structure of some suaviosides are shown in Table 47-7.

The terms “rubusoside” or “RU” are used interchangeably with reference to a steviol glycoside that is steviol in which both the carboxy group and the tertiary allylic hydroxy group have been converted to their corresponding beta-D-glucosides. Rubusoside may be extracted from a natural source, e.g., leaves from Rubus suavissimus, produced by a chemical or enzymatic process, or produced by fermentation. The structure of rubusoside is set forth in Formula III:

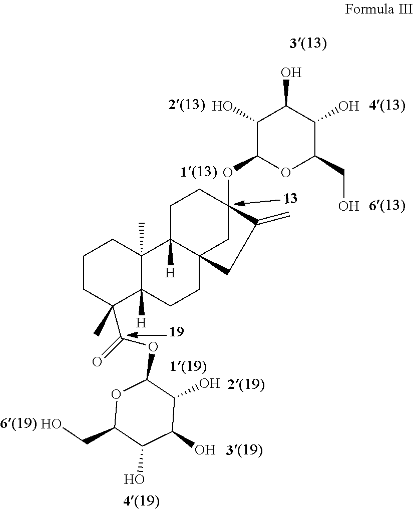

As used herein, the acronym “RUx” is used with reference to a sweet tea extract (ST-E) that is defined by its concentration of RU. More particularly, the acronym “RUx” refers to a sweet tea extract (ST-E) containing rubusoside (RU) in amount of ≥x % and <(x+10)%, except as otherwise noted, where e.g., the acronym “RU100” specifically refers to pure RU; the acronym “RU99.5” specifically refers to a composition where the amount of RA is ≥99.5 wt %, but <100 wt %; the acronym “RU99” specifically refers to a composition where the amount of RU is ≥99 wt %, but <100 wt %; the acronym “RU98” specifically refers to a composition where the amount of RU is ≥98 wt %, but <99 wt %; the acronym “RU97” specifically refers to a composition where the amount of RU is ≥97 wt %, but <98 wt %; the acronym “RAU95” specifically refers to a composition where the amount of RU is ≥95 wt %, but <97 wt %; the acronym “RU85” specifically refers to a composition where the amount of RU is ≥85 wt %, but <90 wt %; the acronym “RU75” specifically refers to a composition where the amount of RU is ≥75 wt %, but <80 wt %; the acronym “RU65” specifically refers to a composition where the amount of RU is ≥65 wt %, but <70 wt %; the acronym “RU20” specifically refers to a composition where the amount of RU is ≥15 wt %, but <30 wt %. Sweet tea extracts include, but are not limited to, RU10, RU20, RU30, RU40, RU50, RU60, RU80, RU90, RU95, RU97, RU98, RU99, RU99.5, or any integer defining a lower limit of RU wt %.

The term “purified RU” refers to a RU preparation that contains at least 50% RU by weight. Purified RU may be prepared from a natural source, such a Stevia extract or a sweet tea extract, or produced by a chemical or enzymatic process, or fermentation. In some embodiments, the term “purified RU” refers to a RU preparation that contains at least 60%, 70%, 80%, 85%, 90%, 95%, 96%, 97%, 98%, or 99% RU by weight.

The term “enriched RU” refers to a RU preparation that contains at least 5% RU by weight. Enriched RU may be prepared from a natural source, such a Stevia extract or a sweet tea extract, or produced by a chemical or enzymatic process, or fermentation. In some embodiments, the term “enriched RU” refers to a RU preparation that contains at least 5%, 10%, 15%, 20%, 25%, 30%, 35%, 40% or 45% RU by weight.

The terms “non-RU STC” or “non-RU-STG” refers to a STC or STG that is not RU. A non-RU STC or non-RU STG may be purified from a natural source, or produced by a chemical or enzymatic process, or fermentation. The non-RU STC can be a volatile compound or a non-volatile compound.

The term “terpene” is used with reference to a large and diverse class of organic hydrocarbon molecules classified according to the number of isoprene units in the molecule. Although terpenoids are sometimes used interchangeably with “terpenes”, terpenoids (or isoprenoids) are modified terpenes as they contain additional functional groups, usually oxygen-containing. The term “terpene” includes hemiterpenes (isoprene, single isoprene unit), monoterpenes (two isoprene units), sesquiterpenes (three isoprene units), diterpenes (four isoprene units), sesterterpenes (five isoprene units), triterpenes (six isoprene units), sesquarterpenes (seven isoprene units), tetraterpenes (eight isoprene units) and polyterpenes (long chains of many isoprene units).

The term “terpenoid” is used with reference to a large and diverse class of organic molecules derived from terpenes, more specifically five-carbon isoprenoid units assembled and modified in a variety of ways and classified in groups based on the number of isoprenoid units used in group members. Although terpenoids are sometimes used interchangeably with “terpenes”, terpenoids (or isoprenoids) are modified terpenes as they contain additional functional groups, usually oxygen-containing. Similar to the nomenclature for terpenes, the term “terpenoids” includes hemiterpenoids, monoterpenoids, sesquiterpenoids, diterpenoids, sesterterpenoids, triterpenoids, tetraterpenoids and polyterpenoids.

The terms “terpene glycoside” and “terpene sweetener” refer to a compound having a terpene aglycone linked by a glycosidic bond to a glycone. Terpene glycosides include, but are not limited to, diterpene glycosides, such as steviol glycosides and suaviosides, and triterpene compounds, such as mogrosides.

Exemplary diterpene glycosides from Rubus suavissimus (and extracts thereof), include steviol glycosides, such as rubusoside, steviol monoside, rebaudioside A, isomers of rebaudioside B, isomers of stevioside, as well as kaurane-type diterpene glycosides found in sweet tea plants, such as the sweet tasting suaviosides B (SU-B), SU-G, SU-H, SU-I and SU-J, respectively. Additional SUs include bitter suaviosides, such as SU-C1, SU-D2, SU-F and tasteless suaviosides, such as SU-D1 and SU-E.

Exemplary triterpene glycosides from plants or extracts derived from Siraitia grosvenorii (also referred to Luo Han Guo or swingle) include mogrol glycosides, mogrosides, mogroside II, mogroside II B, mogroside II E, mogroside III, mogroside III A2, mogroside IV, mogroside V, mogroside VI, neomogroside, grosmomoside siamenoside I, 7-oxo-mogroside II E, 11-oxo-mogroside A1, 11-deoxy-mogroside III, -oxomogroside IV A, 7-oxo-mogroside V, 11-oxo-mogroside V and others.

The term “glycosylated sweet tea extract (GSTE)” refers to a STE that has been subjected to an exogenously preformed glycosylation process. A GSTE may be artificially produced by enzymatic conversion or fermentation. It should be understood that a glycosylation product of STE may contain unreacted starting materials. For example, a GSTE may contain glycosylated sweet tea components, unreacted sweet tea components, and unreacted sugar donors such as maltodextrin.

The term “glycosylated sweet tea component (GSTC)” refers to a STC that has been subjected to an exogenously preformed glycosylation process. A GSTC may be artificially produced by enzymatic conversion, fermentation or chemical synthesis.

The term “glycosylated sweet tea glycoside (GSTG)” refers to a molecule that (1) contains a STG backbone and one or more additional sugar residues, and (2) is artificially produced by enzymatic conversion, fermentation or chemical synthesis.

The term “glycosylated non-stevia sweet tea component (GNSTC)” refers to a NSTC that has been subjected to an exogenously preformed glycosylation process. A GNSTC may be artificially produced by enzymatic conversion, fermentation or chemical synthesis.

The term “glycosylated non-stevia sweet tea glycoside (GNSTG)” refers to a molecule that (1) contain a NSTG backbone and one or more additional sugar residues, and (2) are artificially produced by enzymatic synthesis, chemical synthesis or fermentation.

The terms “glycosylated rubusoside” “glycosylated RU” and “GRU” are used interchangeably with reference molecules having a RU backbone (as shown in Formula III with a molecular weight of 641) and additional sugar units added in a glycosylation reaction under man-made conditions. GRUs include, but are not limited to, molecules having a RU backbone and 1-50 additional sugar units. As used herein, the term “sugar unit” refers to a monosaccharide unit.

Examples of mono-glucosylated RU include, but are not limited to, the molecules listed in Table C below.

TABLE C
Mono-glucosylated forms of RU.

| | Position 19 | Position 13 | |
|---|---|---|---|
| Rubusoside (RU) | β-glc (1′ (19)) | β-glc (1′ (13)) | Common Name |
| Mono-Glc RU | β-glc (1-2′ (19)) | — | Reb-KA |
| | β-glc (1-3′ (19)) | — | Stevioside B |
| | β-glc (1-4′ (19)) | — | |
| | β-glc (1-6′ (19)) | — | |
| | α-glc (1-2′ (19)) | — | |
| | α-glc (1-3′ (19)) | — | |
| | α-glc (1-4′ (19)) | — | |
| | α-glc (1-6′ (19)) | — | |
| | — | β-glc (1-2′ (13)) | Stevioside |
| | — | β-glc (1-3′ (13)) | Reb-G |
| | — | β-glc (1-4′ (13)) | |
| | — | β-glc (1-6′ (13)) | |
| | — | α-glc (1-2′ (13)) | |
| | — | α-glc (1-3′ (13)) | |
| | — | α-glc (1-4′ (13)) | |
| | — | α-glc (1-6′ (13)) | |

The term “glycosylated suavioside,” “glycosylated SU’ and “GSU” are used interchangeably with reference to an exogenously glycosylated suavioside.

As used herein, the term “enzymatically catalyzed method” refers to a method that is performed under the catalytic action of an enzyme, in particular of a glycosidase or a glycosyltransferase. The method can be performed in the presence of said glycosidase or glycosyltransferase in isolated (purified, enriched) or crude form.

The term “glycosyltransferase” (GT) refers to an enzyme that catalyzes the formation of a glycosidic linkage to form a glycoside. As used herein, the term “glycosyltransferase” also includes variants, mutants and enzymatically active portions of glycosyltransferases. Likewise, the term “glycosidase” also includes variants, mutants and enzymatically active portions of glycosidases.

The term “monosaccharide” as used herein refers to a single unit of a polyhydroxyaldehyde forming an intramolecular hemiacetal the structure of which including a six-membered ring of five carbon atoms and one oxygen atom. Monosaccharides may be present in different diasteromeric forms, such as α or β anomers, and D or L isomers. An “oligosaccharide” consists of short chains of covalently linked monosaccharide units. Oligosaccharides comprise disaccharides which include two monosaccharide units, as well as trisaccharides which include three monosaccharide units. A “polysaccharide” consists of long chains of covalently linked monosaccharide units.

The acronym “G-X” refers to the glycosylation products of a composition X, i.e., product prepared from an enzymatically catalyzed glycosylation process with X and one or more sugar donors as the starting materials. For example, G-ST-MRPs refers to the glycosylation product of ST-MRPs and G-(RU20+RB8) refers to the glycosylation product of a mixture of RU20 and RB8.

As used herein, the term “Maillard reaction” refers to a non-enzymatic reaction of (1) one or more reducing and/or non-reducing sugars, and (2) one or more amine donors in the presence of heat, wherein the non-enzymatic reaction produces a Maillard reaction product and/or a flavor. Thus, this term is used unconventionally, since it accommodates the use of non-reducing sweetening agents as substrates, which were not heretofore thought to serve as substrates for the Maillard reaction.

The term “reaction mixture” refers to a composition comprising at least one amine donor and one sugar donor, wherein the reaction mixture is to be subjected to a Maillard reaction; a “reaction mixture” is not to be construed as the reaction contents after a Maillard reaction has been conducted, unless otherwise noted.

The term “sugar,” as used herein, refers to a sweet-tasting, soluble carbohydrate, typically used in consumer food and beverage products.

The term “sugar donor,” as used herein, refers to a sweet-tasting compound or substance from natural or synthetic sources, which can participate as a substrate in a Maillard reaction with an amine group-containing donor molecule.

The term “amine donor,” as used herein, refers to a compound or substance containing a free amino group, which can participate in a Maillard reaction.

The term “Maillard reaction product” or “MRP” refers to any compound produced by a Maillard reaction between an amine donor and a sugar donor in the form of a reducing sugar, non-reducing sugar, or both. Preferably, the sugar donor includes at least one carbonyl group. In certain embodiments, the MRP comprises a compound that provides a flavor (“Maillard flavor”), a color (“Maillard color”), or both.

As used hereinafter, the term “standard MRP” or “conventional MRP (C-MRP)” refers to an MRP formed from a reaction mixture that contains (1) one or more mono and/or disaccharides as sugar donor and (2) one or more free amino acids as amine donor.

The term “RU-derived MRP” and “RU-MRP” are used interchangeably with reference to the MRP derived from rubusoside (RU) and/or glycosylated rubusoside (GRU). The term “G-RU-MRP” refers to the glycosylation product of RU-MRP.

The term “STE-MRP” refers the MRP derived from one or more STEs.

The term “STC-MRP” refers the MRP derived from one or more STCs.

The term “STG-MRP” refers the MRP derived from one or more STGs.

The term “NSTC-MRP” refers the MRP derived from one or more NSTCs.

The term “NSTG-MRP” refers the MRP derived from one or more NSTGs.

The term “GSTE-MRP” refers the MRP derived from one or more GSTEs.

The term “GSTC-MRP” refers the MRP derived from one or more GSTCs.

The term “GSTG-MRP” refers the MRP derived from one or more GSTGs.

The term “GNSTC-MRP” refers the MRP derived from one or more GNSTCs.

The term “GNSTG-MRP” refers the MRP derived from one or more GNSTGs.

The terms “ST-derived MRP” and “ST-MRP” are used interchangeably with reference to the product of a Maillard reaction, wherein the starting material of the Maillard reaction comprises a STE, a STC, a STG, a NSTC, a NSTG, a GSTE, a GSTC, a GSTG, a GNSTC, a GNSTG or combinations thereof. Accordingly, ST-MRPs include, but are not limited to, STE-MRP, STC-MRP, STG-MRP, NSTC-MRP, NSTG-MRP, GSTE-MRP, GSTC-MRP, GSTG-MRP, GNSTC-MRP and GNSTG-MRP.

The terms “glycosylated ST-MRP” and “G-ST-MRP” are used interchangeably with reference to the product of an artificially set up glycosylation reaction, wherein the starting material of the glycosylation reaction comprises a ST-MRP. Specifically, G-ST-MRPs include, but are not limited to, the glycosylation products of STE-MRP, STC-MRP, STG-MRP, NSTC-MRP, NSTG-MRP, GSTE-MRP, GSTC-MRP, GSTG-MRP, GNSTC-MRP, GNSTG-MRP and mixtures thereof.

The terms “Stevia-MRP” refers to the product of a Maillard reaction, wherein the starting material of the Maillard reaction comprises a Stevia extract (SE), a steviol glycoside (SG), a glycosylated Stevia extract (GSE), a glycosylated steviol glycoside (GSG) or combinations thereof. Accordingly, Stevia-MRPs include, but are not limited to, SE-MRPs, SG-MRPs, GSE-MRPs and GSG-MRPs.

The terms “MRP composition,” “Maillard product composition” and “Maillard flavor composition” are used interchangeably and refer to a composition comprising one or more MRPs, C-MRPs, ST-MRPs, and Stevia-MRPs.

The term “thaumatin”, as used herein, is used generically with reference to thaumatin I, II, III, a, b, c, etc. and/or combinations thereof.

The term “non-volatile”, as used herein, refers to a compound having a negligible vapor pressure at room temperature, and/or exhibits a vapor pressure of less than about 2 mm of mercury at 20° C.

The term “volatile”, as used herein, refers to a compound having a measurable vapor pressure at room temperature, and/or exhibits a vapor pressure of, or greater than, about 2 mm of mercury at 20° C.

As used herein, the term “sweetener” generally refers to a consumable product, which produces a sweet taste when consumed alone. Examples of sweeteners include, but are not limited to, high-intensity sweeteners, bulk sweeteners, sweetening agents, and low sweetness products produced by synthesis, fermentation or enzymatic conversion methods.

As used herein the term “high-intensity sweetener,” refers to any synthetic or semi-synthetic sweetener or sweetener found in nature. High-intensity sweeteners are compounds or mixtures of compounds which are sweeter than sucrose. High-intensity sweeteners are typically many times (e.g., 20 times and more, 30 times and more, 50 times and more or 100 times sweeter than sucrose). For example, sucralose is about 600 times sweeter than sucrose, sodium cyclamate is about 30 times sweeter, Aspartame is about 160-200 times sweeter, and thaumatin is about 2000 times sweeter then sucrose (the sweetness depends on the tested concentration compared with sucrose).

High-intensity sweeteners are commonly used as sugar substitutes or sugar alternatives because they are many times sweeter than sugar but contribute only a few to no calories when added to foods. High-intensity sweeteners may also be used to enhance the flavor of foods. High-intensity sweeteners generally will not raise blood sugar levels.

As used herein, the term “high intensity natural sweetener,” refers to sweeteners found in nature, typically in plants, which may be in raw, extracted, purified, refined, or any other form, singularly or in combination thereof. High intensity natural sweeteners characteristically have higher sweetness potency, but fewer calories than sucrose, fructose, or glucose. Examples of high intensity natural sweetener include, but are not limited to, sweet tea extracts, stevia extracts, swingle extracts, steviol glycosides, suaviosides, mogrosides, mixtures, salts and derivatives thereof.

As used herein, the term “high intensity synthetic sweetener” or “high intensity artificial sweetener” refers to high intensity sweeteners that are not found in nature. High intensity synthetic sweeteners include “high intensity semi-synthetic sweeteners” or “high intensity semi-artificial sweeteners”, which are synthesized from, artificially modified from, or derived from natural products. Examples of high intensity synthetic sweeteners include, but are not limited to, sucralose, aspartame, acesulfame-K, neotame, saccharin and aspartame, glycyrrhizic acid ammonium salt, sodium cyclamate, saccharin, advantame, neohesperidin dihydrochalcone (NHDC) and mixtures, salts and derivatives thereof.

As used herein, the term “sweetening agent” refers to a high intensity sweetener.

As used herein, the term “bulk sweetener” refers to a sweetener, which typically adds both bulk and sweetness to a confectionery composition and includes, but is not limited to, sugars, sugar alcohols, sucrose, commonly referred to as “table sugar,” fructose, commonly referred to as “fruit sugar,” honey, unrefined sweeteners, syrups, such as agave syrup or agave nectar, maple syrup, corn syrup and high fructose corn syrup (or HFCS).

As used herein, the term “sweetener enhancer” refers to a compound (or composition) capable of enhancing or intensifying sensitivity of the sweet taste. The term “sweetener enhancer” is synonymous with a “sweetness enhancer,” “sweet taste potentiator,” “sweetness potentiator,” and/or “sweetness intensifier.” A sweetener enhancer enhances the sweet taste, flavor, mouth feel and/or the taste profile of a sweetener without giving a detectable sweet taste by the sweetener enhancer itself at an acceptable use concentration. In some embodiments, the sweetener enhancer provided herein may provide a sweet taste at a higher concentration by itself. Certain sweetener enhancers provided herein may also be used as sweetening agents.

Sweetener enhancers can be used as food additives or flavors to reduce the amounts of sweeteners in foods while maintaining the same level of sweetness. Sweetener enhancers work by interacting with sweet receptors on the tongue, helping the receptor to stay switched “on” once activated by the sweetener, so that the receptors respond to a lower concentration of sweetener. These ingredients could be used to reduce the calorie content of foods and beverages, as well as save money by using less sugar and/or less other sweeteners. Examples of sweetener enhancers include, but are not limited to, brazzein, miraculin, curculin, pentadin, mabinlin, thaumatin, and mixtures thereof.

In some cases, sweetening agents or sweeteners can be used as sweetener enhancers or flavors when their dosages in food and beverage are low. In some cases, sweetener enhancers can be utilized as sweeteners where their dosages in foods and beverages are higher than dosages regulated by FEMA, EFSA or other related authorities.

As used herein, the phrase “low sweetness products produced by synthesis, fermentation or enzymatic conversion” refers to products that have less sweetness or similar sweetness than sucrose. Examples of low sweetness products produced by extraction, synthesis, fermentation or enzymatic conversion method include, but are not limited to, sorbitol, xylitol, mannitol, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, and mixtures thereof.

For example, “sugar alcohols” or “polyols” are sweetening and bulking ingredients used in manufacturing of foods and beverages. As sugar substitutes, they supply fewer calories (about a half to one-third fewer calories) than sugar, are converted to glucose slowly, and are not characterized as causing spiked increases in blood glucose levels.

Sorbitol, xylitol, and lactitol are exemplary sugar alcohols (or polyols). These are generally less sweet than sucrose, but have similar bulk properties and can be used in a wide range of food and beverage products. In some case, their sweetness profile can be fine-tuned by being mixed together with high-intensity sweeteners.

The terms “flavor” and “flavor characteristic” are used interchangeably with reference to the combined sensory perception of one or more components of taste, aroma, and/or texture.

The terms “flavoring agent”, “flavoring” and “flavorant” are used interchangeably with reference to a product added to food or beverage products to impart, modify, or enhance the flavor of food. As used herein, these terms do not include substances having an exclusively sweet, sour, or salty taste (e.g., sugar, vinegar, and table salt).

The term “natural flavoring substance” refers to a flavoring substance obtained by physical processes that may result in unavoidable but unintentional changes in the chemical structure of the components of the flavoring (e.g., distillation and solvent extraction), or by enzymatic or microbiological processes, from material of plant or animal origin.

The term “synthetic flavoring substance” refers to a flavoring substance formed by chemical synthesis.

The term “enhance,” as used herein, includes augmenting, intensifying, accentuating, magnifying, and potentiating the sensory perception of a flavor characteristic without changing the nature or quality thereof.

Unless otherwise specified, the terms “modify” or “modified” as used herein, includes altering, varying, suppressing, depressing, fortifying and supplementing the sensory perception of a flavor characteristic where the quality or duration of such characteristic was deficient.

The phrase “sensory profile” or “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness.” A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The phrase “sucrose equivalence” or “SugarE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must generally have the same sweetness as a 12% sucrose soft drink, i.e., a diet soft drink must have a 12% SugarE. Soft drink dispensing equipment assumes a SugarE of 12%, since such equipment is set up for use with sucrose-based syrups.

As used herein, the term “off-taste” refers to an amount or degree of taste that is not characteristically or usually found in a beverage product or a consumable product of the present disclosure. For example, an off-taste is an undesirable taste of a sweetened consumable to consumers, such as, a bitter taste, a licorice-like taste, a metallic taste, an aversive taste, an astringent taste, a delayed sweetness onset, a lingering sweet aftertaste, and the like, etc.

The term “orally consumable product” refers to a composition that can be drunk, eaten, swallowed, inhaled, ingested or otherwise in contact with the mouth or nose of man or animal, including compositions which are taken into and subsequently ejected from the mouth or nose. Orally consumable products are safe for human or animal consumption when used in a generally acceptable range.

As used herein, the term “fruit” refers to firm fruits, soft fruits, sliced pieces with skin remaining, and/or dried/scarified/pricked/scraped fruit, which are well-known in the art, and described herein. Examples of fruit include, but are not limited to, apple, pear, orange, tangerine, lemon, lime, apricot, plum, prune, kiwi, guava, pineapple, coconut, papaya, mango, grape, cherry, pomegranate, grape fruit passion fruit, dragon fruit, melons and berries. Example of berries include, but are not limited to, cranberry, blueberry, boysenberry, elderberry, chokeberry, lingonberry, raspberry, mulberry, gooseberry, huckleberry, strawberry, blackberry, cloudberry, blackcurrant, redcurrant and white currant. Examples of melon include, but are not limited to, watermelon, cantaloupe, Muskmelon, honeydew melon, canary melon, casaba melon, chareatais melon, crenshaw melon, galia melon, golden Langkawi melon, hami melon, honey globe melon, horned melon, jadedew melon, kantola melon and Korean melon.

The term “fruit juice” refers to a juice derived from one or more fruits. Fruit juices include freshly prepare fruit juices, concentrated fruit juices, and juices reconstituted from concentrated fruit juices.

The term “vegetables” refers to fresh vegetables, preserved vegetables, dried vegetables, vegetable juice and vegetable extracts. Examples of vegetables include, but are not limited to, broccoli, cauliflower, artichokes, capers, cabbage, turnip, radish, carrot, celery, parsnip, beetroot, lettuce, beans, peas, potato, eggplant, tomato, sweet corn, cucumber, squash, zucchinis, pumpkins, onion, garlic, leek, pepper, spinach, yam, sweet potato, taro, and yams and cassava.

The term “vegetable juice” refers to a juice derived from one or more vegetables. Vegetables juices include freshly prepare vegetables juices, concentrated vegetables juices, and juices reconstituted from concentrated vegetables juices.

Unless otherwise noted, the term “ppm” (parts per million) means parts per million on a w/w or wt/wt basis.

### II. Sweet Tea-Based Sweetening and Flavoring Compositions

Sweet tea (ST) plants are generally cultivated on industrial scale for the purpose of extracting sweet substances of steviol glycosides. Rubusoside (RU), the major sweetening agent in sweet tea, is characterized by unpleasant bitterness, aftertaste, slow onset of sweetness, and/or astringency, which can limit their use in foods and beverages in certain instances.

The present application provides a sweet tea-based sweetening and flavoring composition that comprises (A) a sweet tea extract (STEs) or at least one sweet tea component (STC), (B) a glycosylated STE (GSTE) or at least one glycosylated STC (GSTC), and/or (C) one or more ST-MRPs and/or G-ST-MRPs. In some embodiments, the sweet tea-based sweetening and flavoring composition further comprises (D) one or more components selected from the group consisting of SEs, SGs, GSEs, GSGs, Stevia-MRPs and conventional MRPs.

In some embodiments, the STC described above is a non-stevia STC (NSTC).

Sweet tea (ST) plants contain a wide variety of compounds, macromolecules and glycosides (collectively sweet tea components or “STCs”) that can serve as useful flavoring or sweetening agents for ST-based flavoring or sweetening compositions. These ST-derived substances or STCs can be directly used in some compositions, or they may serve as substrates for exogenous glycosylation reactions and/or Maillard reactions to enhance their respective utilities.

Sweet tea plants and extracts therefrom include a wide variety of biochemically active STCs, including steviol glycosides, non-steviol glycosides substances, diterpenes, diterpenoids, triterpenes, triterpenoids, carotenoids (tetraterpenoids), flavonoids, isoflavonoids, polyphenols, tannins, carotenoids, free amino acids, vitamins, and the like.

To the extent that any of these aforementioned STCs includes a free hydroxyl group, it can serve as a substrate for a sugar donor in a glycosylation reaction. Moreover, to the extent that any of the STCs has a free amino group or a reactive carbonyl group in the form of a free aldehyde (aldose) or free ketone (ketose), among others, it can serve as a substrate for a Maillard reaction.

A. Sweet Tea Extracts (STEs) and Sweet Tea Components (STCs)

Sweet tea extracts, as well as rubusoside or glycosylated rubusoside have drawn attention due to their capability of masking, reducing, suppressing bitterness, sourness and astringency of compounds. However, all types of products including sweet tea extracts, purified rubusoside and glycosylated sweet tea extracts can create a bitter and astringent taste when used at higher concentrations, thereby limiting their potential applications. Thus, there is a need to find compositions and methods to overcome these disadvantages to facilitate widespread embrace of their use in the food, beverage, pharmaceutical and cosmetic industries.

As described in the present application, adding sufficient amounts and proportions of one or more STEs and/or one or more STCs to a sweetener or flavoring agent, food or beverage product, with or without other steviol glycosides, natural, synthetic or semi-synthetic high intensity sweeteners and/or sweetening enhancers, can significantly enhance the sensory taste profiles of the sweetener, flavoring agent, food or beverage product.

In one embodiment, the present application provides a sweetener or flavoring composition comprising a STE or one or more STCs, in an amount of 000.1-99.9 wt % of the composition. In some embodiments, the composition further comprises a conventional-

In some embodiments, the STE, or the one or more STCs, are present in the amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, or 90-99 wt % of the composition.

In some embodiments, the sweetener or flavoring composition comprises a STE that contains enriched RU.

In some embodiments, the sweetener or flavoring composition comprises a STE that contains an enriched diterpene glycoside.

In some embodiments, the sweetener or flavoring composition comprises one or more STCs selected from the group consisting of RU, SU, steviolmonoside, rebaudioside A, 13-O-3-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin.

In some embodiments, the sweetener or flavoring composition comprises one or more suaviosides selected from the group consisting of SU-A, SU-B, SU-C1, SU-D1, SU-D2, SU-E, SU-F, SU-G, SU-H, SU-I, and SU-J.

In some embodiments, the sweetener or flavoring composition comprises purified RU.

In some embodiments, the sweetener or flavoring composition comprises a STE having a RU content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the STE.

In some embodiments, the sweetener or flavoring composition comprises a STE having a RU content of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition comprises one or more flavonoid glycosides, isoflavone glycosides, saponin glycosides, phenol glycosides, cyanophore glycosides, anthraquinone glycosides, cardiac glycosides, bitter glycosides, coumarin glycosides, or sulfur glycosides.

Exemplary flavonoids include, but are not limited to, anthocyanidins; anthoxanthins, including flavones, such as luteolin, apigenin, tangeritin; and flavonols, such as quercetin, kaempferol, myricetin, fisetin, galangin, isorhamnetin, pachypodol, rhamnazin, pyranoflavonols, furanoflavonols; flavanones, such as hesperetin, naringenin, eriodictyol, and homoeriodictyol; flavanols, such as taxifolin (or dihydroquercetin) and dihydrokaempferol; and flavans, including flavanols, such as catechin, gallocatechin, catechin 3-gallate, gallocatechin 3-gallate, epicatechin, epigallocatechin (EGC), epicatechin 3-gallate, epigallocatechin 3-gallate, theaflavin, theaflavin-3′-gallate, theaflavin-3,3′-digallate, thearubigin, and proanthocyanidins, which are dimers, trimers, oligomers, or polymers of the flavanols, and glycosides thereof.

Exemplary isoflavonoids include isoflavones, such as genistein, daidzein, glycitein; isoflavanes, isoflavandiols, isoflavenes, coumestans, pterocarpans, and glycosides thereof.

Exemplary polyphenols include gallic acid, ellagic acid, quercetin, isoquercitrin, rutin, citrus flavonoids, catechins, proanthocyanidins, procyanidins, anthocyanins, resveratrol, isoflavones, curcumin, hesperidin, naringin, and chlorogenic acid, and glycosides thereof.

Exemplary tannins include gallic acid esters, ellagic acid esters, ellagitannins, including rubusuaviins A, B, C, D, -E, and -F; punicalagins, such as pedunculagin and 1(β)-O-galloyl pedunculagin; strictinin, sanguiin H-5, sanguiin H-6, 1-desgalloyl sanguiin H-6. lambertianin A, castalagins, vescalagins, castalins, casuarictins, grandimins, punicalins, roburin A, tellimagrandin II, terflavin B; gallotannins, including digalloyl glucose and 1,3,6-trigalloyl glucose; flavan-3-ols, oligostilbenoids, proanthocyanidins, polyflavonoid tannins, catechol-type tannins, pyrocatecollic type tannins, flavolans, and glycosides thereof.

Exemplary carotenoids include carotenes, including α-, β-, γ-, δ-, and ε-carotenes, lycopene, neurosporene, phytofluene, phytoene; and xanthophylls, including canthaxanthin, cryptoxanthin, zeaxanthin, astaxanthin, lutein, rubixanthin, and glycosides thereof.

In some embodiments, the sweetener or flavoring composition comprises one or more diterpenes, diterpenoids, triterpenes and/or triterpenoids. Exemplary diterpenes and diterpenoids include steviol, ent-16α,17-dihydroxy-kaurane-19-oic acid, ent-13-hydroxy-kaurane-16-en-19-oic acid, ent-16β,17-dihydroxy-kaurane-3-one, ent-16α,17-dihydroxy-kaurane-19-oic acid, ent-16α,17-dihydroxy-kaurane-3-one, ent-kaurane-3α,16β,17-3-triol, ent-13,17-dihydroxy-kaurane-15-en-19-oic acid, and glycosides thereof. Exemplary triterpenes and triterpenoids, include oleanolic acid, ursolic acid, saponin, and glycoside thereof.

In some embodiments, the STE/STC containing sweetener or flavoring composition further comprises a stevia extract. In some embodiments, the STE/STC containing sweetener or flavoring composition further comprises a one or more non-sweet tea steviol glycosides. In some embodiments, the STE/STC containing sweetener or flavoring composition further comprises thaumatin.

In some embodiments, the sweet tea-based sweetening and flavoring composition described in this section (Section IIA) further comprises one or more components selected from the group consisting of GSTEs, GSTCs, ST-MRPs, G-ST-MRPs, SEs, SGs, GSEs, GSGs, Stevia-MRPs and conventional MRPs.

B. Glycosylated STEs (GSTEs) and Glycosylated STCs (GSTCs)

In some embodiments, the sweetener or flavoring composition of the present application comprises a glycosylated STE (GSTE) or one or more glycosylated STCs (GSTCs), in an amount of 000.1-99.9 wt % of the composition.

In certain embodiments, the GSTEs and GSTCs used in the present application are prepared as follows: i) dissolving a sugar-donor material in water to form a liquefied sugar-donor material; ii) adding a starting STE or STC composition to liquefied sugar-donor material to obtain a mixture; and iii) adding an effective amount of an enzyme to the mixture to form a reaction mixture, wherein the enzyme catalyzes the transfer of sugar moieties from the sugar-donor material to STGs in the starting STE or STC composition; and iv) incubating the reaction mixture at a desired temperature for a desired length of reaction time to glycosylate STGs with sugar moieties present in the sugar-donor molecule. In some embodiments, after achieving a desired ratio of GSTE or GSTC and residual STE or STC contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the sugar is glucose and the sugar donor is a glucose donor. In some embodiments, the glucose donor is starch. In some embodiments the resulting solution comprising GSTEs or GSTCs, residual STGs and dextrin is decolorized. In certain embodiments the resulting solution of GSTEs or GSTCs, including residual STGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

In some embodiments, the GSTE, or the one or more GSTCs, are present in a sweetening or flavoring composition in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, or 90-99 wt % of the composition.

In some embodiments, the glycosylated STE is prepared from a STE that contains enriched RU.

In some embodiments, the glycosylated STE is prepared from a STE that contains an enriched diterpene glycoside.

In some embodiments, the one or more glycosylated STCs are selected from the glycosylation products of RU, SU, steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin.

In some embodiments, the one or more glycosylated STCs comprise one or more of the glycosylation products of SU-A, SU-B, SU-C1, SU-D1, SU-D2, SU-E, SU-F, SU-G, SU-H, SU-I, and SU-J.

In some embodiments, the one or more glycosylated STCs comprise glycosylation product of purified RU.

In some embodiments, the sweetener or flavoring composition comprises the glycosylation product of a STE having a RU content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the STE.

In certain preferred embodiments, the sweetener or flavoring composition comprises the glycosylation product of a STE having a RU content of at least 1%, at least 2%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, at least 90%, or any range defined by any pair of these integers.

In some embodiments, the sweetener or flavoring composition comprises one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, or glycosylated sulfur glycosides.

In some embodiments, the GSTE/GSTC containing sweetener or flavoring composition further comprises a glycosylated stevia extract. In some embodiments, the GSTE/GSTC containing sweetener or flavoring composition further comprises a one or more glycosylated non-sweet tea steviol glycosides. In some embodiments, the GSTE/GSTC containing sweetener or flavoring composition further comprises thaumatin.

In some embodiments, the sweet tea-based sweetening and flavoring composition described in this section (Section IIB) further comprises one or more components selected from the group consisting of STEs, STCs, ST-MRPs, G-ST-MRPs, SEs, SGs, GSEs, GSGs, Stevia-MRPs and conventional MRPs.

(1) Glycosylation Reaction

Glycosyltransferases, Glycosyl Hydrolases and Transglycosidases

The glycosylated products described in the present application, such as GSTEs, GSTCs, G-ST-MRPs, are formed by an exogenous glycosylation reaction in the present of a glycosyltransferase.

As used herein, a “glycosyltransferase” refers to an enzyme that catalyzes the formation of a glycosidic linkage to form a glycoside. A glycoside is any molecule in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. The sugar group is known as the glycone and the non-sugar group is known as the aglycone. The glycone can be part of a single sugar group (monosaccharide) or several sugar groups (oligosaccharide). A glycosyltransferase according to the present application further embraces “glycosyltransferase variants” engineered for enhanced activities.

Glycosyltransferases utilize “activated” sugar phosphates as glycosyl donors, and catalyze glycosyl group transfer to an acceptor molecule comprising a nucleophilic group, usually an alcohol. A retaining glycosyltransferases is one which transfers a sugar residue with the retention of anomeric configuration. Retaining glycosyltransferase enzymes retain the stereochemistry of the donor glycosidic linkage after transfer to an acceptor molecule. An inverting glycosyltransferase, on the other hand, is one which transfers a sugar residue with the inversion of anomeric configuration. Glycosyltransferases are classified based on amino acid sequence similarities. Glycosyltransferases are classified by the Nomenclature Committee of the International Union of Biochemistry and Molecular Biology (NC-IUBMB) in the enzyme class of EC 2.4.1 on the basis of the reaction catalyzed and the specificity.

Glycosyltransferases can utilize a range of donor substrates. Based on the type of donor sugar transferred, these enzymes are grouped into families based on sequence similarities. Exemplary glycosyltransferases include glucanotransferases, N-acetylglucosaminyltransferases, N-acetylgalactosaminyltransferases, fucosyltransferases, mannosyltransferases, galactosyltransferases, sialyltransferases, galactosyltransferases, fucosyltransferase, Leloir glycosyltransferases, non-Leloir glycosyltransferases, and other glycosyltransferases in the enzyme class of EC 2.4.1. The Carbohydrate-Active Enzymes database (CAZy) provides a continuously updated list of the glycosyltransferase families.

In some embodiments, the glycosylation products described in the present application, such as GSTEs, GSTCs, G-ST-MRPs, are formed from a reaction mixture comprising an exogenous glycosyltransferase classified as an EC 2.4.1 enzyme, including but not limited to members selected from the group consisting of cyclomaltodextrin glucanotransferase (CGTase; EC 2.4.1.19), amylosucrase (EC 2.4.1.4), dextransucrase (EC 2.4.1.5), amylomaltase, sucrose: sucrose fructosyltransferase (EC 2.4.1.99), 4-α-glucanotransferase (EC 2.4.1.25), lactose synthase (EC 2.4.1.22), sucrose-1,6-α-glucan 3(6)-α-glucosyltransferase, maltose synthase (EC 2.4.1.139), alternasucrase (EC 2.4.1.140), including variants thereof.

Cyclomaltodextrin glucanotransferase, also known as CGTase, is an enzyme assigned with enzyme classification number EC 2.4.1.19, which is capable of catalyzing the hydrolysis and formation of (1→4)-α-D-glucosidic bonds, and in particular the formation of cyclic maltodextrins from polysaccharides as well as the disproportionation of linear oligosaccharides.

Dextransucrase is an enzyme assigned with enzyme classification number EC 2.4.1.5, and is also known as sucrose 6-glucosyltransferase, SGE, CEP, sucrose-1,6-α-glucan glucosyltransferase or sucrose: 1,6-α-D-glucan 6-α-D-glucosyltransferase. Dextransucrases are capable of catalyzing the reaction: sucrose+[(1→6)-α-D-glucosyl]n=D-fructose+[(1→6)-α-D-glucosyl]n+1. In addition, a glucosyltransferase (DsrE) from Leuconostoc mesenteroides, NRRL B-1299 has a second catalytic domain (“CD2”) capable of adding alpha-1,2 branching to dextrans (U.S. Pat. Nos. 7,439,049 and 5,141,858; U.S. Patent Appl. Publ. No. 2009-0123448; Bozonnet et al., J. Bacteria 184:5753-5761, 2002).

Glycosyltransferases and other glycosylating enzymes for use in the present application may be derived from any source and may be used in a purified form, in an enriched concentrate or as a crude enzyme preparation.

In some embodiments, the glycosylation reaction is carried out by glycosylating an aglycone or glycoside substrate using e.g., a nucleotide sugar donor (e.g., sugar mono- or diphosphonucleotide) or “Leloir donor” in conjunction with a “Leloir glycosyltransferase” (after Nobel prize winner, Luis Leloir) that catalyzes the transfer of a monosaccharide unit from the nucleotide-sugar (“glycosyl donor’) to a “glycosyl acceptor”, typically a hydroxyl group in an aglycone or glycoside substrate.

Accordingly, in some embodiments the glycosylation product of the present application is formed from a reaction mixture comprising a nucleotide sugar.

In certain embodiments, the glycosylation reactions may involve the use of a specific Leloir glycosyltransferase in conjunction with a wide range of sugar nucleotides donors, including e.g., UDP-glucose, GDP-glucose, ADP-glucose, CDP-glucose, TDP-glucose or IDT-glucose in combination with a glucose-dependent glycosyltransferase (GDP-glycosyltransferases; GGTs), ADP-glucose-dependent glycosyltransferase (ADP-glycosyltransferases; AGTs), CDP-glucose-dependent glycosyltransferase (CDP-glycosyltransferases; CGTs), TDP-glucose-dependent glycosyltransferase (TDP-glycosyltransferases; TGTs) or IDP-glucose-dependent glycosyltransferase (IDP-glycosyltransferases; IGTs), respectively.

In particular embodiments, the exogenous glycosylation reaction is carried out using an exogenous Leloir-type UDP-glycosyltransferase enzyme of the classification EC 2.4.1.17, which catalyzes the transfer of glucose from UDP-α-D-glucuronate (also known as UDP-glucose) to an acceptor, releasing UDP and forming acceptor β-D-glucuronoside. In some embodiments, the glycosyltransferases include, but are not limited to, enzymes classified in the GT1 family. In certain preferred embodiment, the glycosylation reaction is catalyzed by an exogenous UDP-glucose-dependent glycosyltransferase. In some embodiments, the glycosylation reaction is catalyzed by a glycosyltransferase capable of transferring a non-glucose monosaccharide, such as fructose, galactose, ribose, arabinose, xylose, mannose, psicose, fucose and rhamnose, and derivative thereof, to the recipient.

U.S. Pat. No. 9,567,619 describes several UDP-dependent glycosyltransferases that can be used to transfer monosaccharides to rubusoside, including UGT76G1 UDP glycosyltransferase, HV1 UDP-glycosyltransferase, and EUGT11, a UDP glycosyltransferase-sucrose synthase fusion enzyme. The EUGT11 fusion enzyme contains a uridine diphospho glycosyltransferase domain coupled to a sucrose synthase domain and can exhibit 1,2-β glycosidic linkage and 1,6-β glycosidic linkage enzymatic activities, as well as sucrose synthase activity. Of the foregoing enzymes, UGT76G1 UDP glycosyltransferase contains a 1,3-O-glucose glycosylation activity which can transfer a second glucose moiety to the C-3′ of 13-O-glucose of rubusoside to produce rebaudioside G (“Reb G”); HV1 UDP-glycosyltransferase contains a 1,2-O-glucose glycosylation activity which can transfer a second glucoside moiety to the C-2′ of 19-O-glucose of rubusoside to produce rebaudioside KA (“Reb KA”); and the EUGT11 fusion enzyme contains a 1,2-O-glucose glycosylation activity which transfers a second glucose moiety to the C-2′ of 19-O-glucose of rubusoside to produce rebaudioside KA or transfer a second glucose moiety to the C-2′ of 13-O-glucose of rubusoside to produce stevioside. In addition, HV1 and EUGT11 can transfer a second sugar moiety to the C-2′ of 19-O-glucose of rebaudioside G to produce rebaudioside V (“Reb V”) and can additionally transfer a second glucose moiety to the C-2′ of 13-O-glucose of rebaudioside KA to produce rebaudioside E (“Reb E”). Furthermore, when used singly or in combination, these enzymes can be used to generate a variety of steviol glycosides known to be present in Stevia rebaudiana, including rebaudioside D (“Reb D”) and rebaudioside M (“Reb M”).

In some embodiments, monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid.

In some embodiments, glycosylation of RU and/or other STCs is driven by an exogenous glycosyl hydrolase or glycosidase from the enzyme class of EC 3.2.1. GHs normally cleave a glycosidic bond. However, they can be used to form glycosides by selecting conditions that favor synthesis via reverse hydrolysis. Reverse hydrolysis is frequently applied e.g., in the synthesis of aliphatic alkylmonoglucosides.

Glycosyl hydrolases have a wide range of donor substrates employing usually monosaccharides, oligosaccharides or/and engineered substrates (i.e., substrates carrying various functional groups). They often display activity towards a large variety of carbohydrate and non-carbohydrate acceptors. Glycosidases usually catalyze the hydrolysis of glycosidic linkages with either retention or inversion of stereochemical configuration in the product.

In some embodiments, the glycosylation products of the present application, such as GSTEs, GSTCs, G-ST-MRPs, are formed from a reaction mixture comprising an exogenous glycosyl hydrolase classified as an EC 3.2.1 enzyme, including but not limited to alpha-glucosidase, beta-glucosidase and beta-fructofuranosidase.

Exemplary glycosyl hydrolases for use in the present application include, but are not limited to α-amylases (EC 3.2.1.1), α-glucosidases (EC 3.2.1.20), β-glucosidases (EC 3.2.1.21), α-galactosidases (EC 3.2.1.22), β-galactosidases (EC 3.2.1.23), α-mannosidase (EC 3.2.1.24), β-mannosidase (EC 3.2.1.25), β-fructofuranosidase (EC 3.2.1.26), amylo-1,6-glucosidases (EC 3.2.1.33), β-D-fucosidases (EC 3.2.1.38), α-L-rhamnosidases (EC 3.21.40), glucan 1,6-α-glucosidases (EC 3.2.70), and variants thereof.

In some embodiments, the glycosylation products of the present application are formed using a class of glycoside hydrolases or glycosyltransferases known as “transglycosylases.” As used herein, the term “transglycosylase” and “transglycosidase” (TG) are used interchangeably with reference to a glycoside hydrolase (GH) or glycosyltransferase (GT) enzyme capable of transferring a monosaccharide moiety from one molecule to another. Thus, a GH can catalyze the formation of a new glycosidic bond either by transglycosylation or by reverse hydrolysis (i.e., condensation).

The acceptor for transglycosylase reaction acceptor can be saccharide acceptor or a monosaccharide acceptor. Thus, a transglycosidase can transfer a monosaccharide moiety to a diverse set of aglycones, including e.g., monosaccharide acceptors, such as aromatic and aliphatic alcohols. Transglycosidases can transfer a wide variety of monosaccharides (D- or L-configurations) to saccharide acceptors, including glycosides, as well as monosaccharide acceptors, including a wide variety of flavonoid aglycones, such as naringenin, quercetin, and hesperetin.

Monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid. The term “transglucosidase” is used when the monosaccharide moiety is a glucose moiety.

Transglycosidases include GHs or GTs from the enzyme classes of EC 3.2.1 or 2.4.1, respectively. In spite of the inclusion of certain glycosyltransferases as transglycosidases, TGs are classified into various GH families on the basis of sequence similarity. A large number of retaining glycosidases catalyze both hydrolysis and transglycosylation reactions. In particular, these enzymes catalyze the intra- or intermolecular substitution of the anomeric position of a glycoside. Under kinetically controlled reactions, retaining glycosidases can be used to form glycosidic linkages using a glycosyl donor activated by a good anomeric leaving group (e.g., nitrophenyl glycoside). In contrast, the thermodynamically controlled reverse hydrolysis uses high concentrations of free sugars.

Transglycosidases corresponding to any of the GH families with notable transglycosylase activity may be used in the present application, and may include the use of e.g., members of the GH2 family, including LacZ β-galactosidase, which converts lactose to allolactose; GH13 family, which includes cyclodextran glucanotransferases that convert linear amylose to cyclodextrins, glycogen debranching enzyme, which transfers three glucose residues from the four-residue glycogen branch to a nearby branch, and trehalose synthase, which catalyzes the interconversion of maltose and trehalose; GH16 family, including xyloglucan endotransglycosylases, which cuts and rejoins xyloglucan chains in the plant cell wall; GH31, for example α-transglucosidases, which catalyze the transfer of individual glucosyl residues between α-(1→4)-glucans; GH70 family, for example glucansucrases, which catalyze the synthesis of high molecular weight glucans, from sucrose; GH77 family, for examples amylomaltase, which catalyzes the synthesis of maltodextrins from maltose; and the GH23, GH102, GH103, and GH104 families, which include lytic transglycosylases that convert peptidoglycan to 1,6-anhydrosugars.

In one embodiment, the glycosyltransferase is a transglucosylase from the glycoside hydrolase 70 (GH70) family. GH70 enzymes are transglucosylases produced by lactic acid bacteria from, e.g., Streptococcus, Leuconostoc, Weisella or Lactobacillus genera. Together with the families GH13 and GH77 enzymes, they form the clan GH-H. Most of the enzymes classified in this family use sucrose as the D-glucopyranosyl donor to synthesize α-D-glucans of high molecular mass (>106 Da) with the concomitant release of D-fructose. They are also referred to as glucosyltransferases or glucansucrases.

A wide range of α-D-glucans, varying in size, structure, degree of branching and spatial arrangements can thus be produced by GH70 family members. For example, GH70 glucansucrases can transfer D-glucosyl units from sucrose onto hydroxyl acceptor groups. Glucansucrases catalyze the formation of linear as well as branched α-D-glucan chains with various types of glycosidic linkages, namely α-1,2; α-1,3; α-1,4; and/or α-1,6.

In addition, sucrose analogues such as α-D-glucopyranosyl fluoride, p-nitrophenyl α-D-glucopyranoside, α-D-glucopyranosyl α-L-sorofuranoside and lactulosucrose can be utilized as D-glucopyranosyl donors. A large variety of acceptors may be recognized by glucansucrases, including carbohydrates, alcohols, polyols or flavonoids to yield oligosaccharides or gluco-conjugates.

Exemplary glucansucrases for use in the present application include e.g., dextransucrase (sucrose:1,6-α-D-glucosyltransferase; EC 2.4.1.5), alternansucrase (sucrose:1,6(1,3)-α-D-glucan-6(3)-α-D-glucosyltransferase, EC 2.4.1.140), mutansucrase (sucrose:1,3-α-D-glucan-3-α-D-glucosyltransferase; EC 2.4.1.125), and reuteransucrase (sucrose:1,4(6-α-D-glucan-4(6)-α-D-glucosyltransferase; EC 2.4.1.-). The structure of the resultant glucosylated product is dependent upon the enzyme specificity.

In some embodiments, a fructosyltransferase may be used to catalyze the transfer of one or more fructose units, optionally comprising terminal glucose, of the following sequence: (Fru)n-Glc consisting of one or more of: β2,1, β2,6, α1,2 and β-1,2 glycosidic bonds, wherein n typically is 3-10. Variants include Inulin type β-1,2 and Levan type β-2,6 linkages between fructosyl units in the main chain. Exemplary fructosytransferases for use in the present application include e.g., β-fructofuranosidase (EC 3.2.1.26), inulosucrase (EC 2.4.1.9) levansucrase (EC 2.4.1.10), or endoinulinase.

In some embodiments, a galactosyltransferase or β-galactosidase may be used to catalyze the transfer of multiple saccharide units, in which one of the units is a terminal glucose and the remaining units are galactose and disaccharides comprising two units of galactose. In certain embodiments, the resulting structure includes a mixture of galactopyranosyl oligomers (DP=3-8) linked mostly by β-(1,4) or β-(1,6) bonds, although low proportions of β-(1,2) or β-(1,3) linkages may also be present. Terminal glucosyl residues are linked by β-(1,4) bonds to galactosyl units. These structures may be synthesized by the reverse action of β-galactosidases (EC 3.2.1.23) on lactose at relatively high concentrations of lactose.

In some embodiments, the transglycosidase is an enzyme having trans-fucosidase, trans-sialidase, trans-lacto-N-biosidase and/or trans-N-acetyllactosaminidase activity.

In some embodiments, the glycosylation reactions may utilize a combination of any of glycosyltransferases described herein in combination with any one of the glycosyl hydrolases or transglycosidases described herein. In these reactions, the transglycosylase and the glycosyl hydrolase or transglycosidase may be present in a range of ratios (w/w), wherein the transglycosylase/glycosyl hydrolase ratio (w/w) ranges from 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

Reaction Conditions for Glycosylation

The glycosylated sweet tea extracts (GSTEs) and glycosylated sweet tea components (GSTCs) of the present application can be obtained for example, by synthetic manipulation or by enzymatic processes. The GSTEs and GSTCs obtained by these methods are therefore non-naturally occurring sweet tea glycosides.

The glycosylating enzyme may be dissolved in the reaction mixture or immobilized on a solid support which is contacted with the reaction mixture. If the enzyme is immobilized, it may be attached to an inert carrier. Suitable carrier materials are known in the art. Examples for suitable carrier materials are clays, clay minerals such as kaolinite, diatomaceous earth, perlite, silica, alumina, sodium carbonate, calcium carbonate, cellulose powder, anion exchanger materials, synthetic polymers, such as polystyrene, acrylic resins, phenol formaldehyde resins, polyurethanes and polyolefins, such as polyethylene and polypropylene. For preparing carrier-bound enzymes the carrier materials usually are used in the form of fine powders, wherein porous forms are preferred. The particle size of the carrier material usually does not exceed 5 mm, in particular 2 mm. Further, suitable carrier materials are calcium alginate and carrageenan. Enzymes may directly be linked by glutaraldehyde. A wide range of immobilization methods are known in the art. Ratio of reactants can be adjusted based on the desired performance of the final product. The temperature of the glycosylation reaction can be in the range of 1-100° C., preferably 40-80° C., more preferably 50-70° C.

In certain embodiments, the GSTEs and GSTCs used in the present application are prepared as follows: i) mixing a starting STE or STC composition with a sugar-donor material to obtain a mixture; and ii) adding an effective amount of an enzyme to the mixture to form a reaction mixture, wherein the enzyme catalyzes the transfer of sugar moieties from the sugar-donor material to STGs in the starting STE or STC composition; and iii) incubating the reaction mixture at a desired temperature for a desired length of reaction time to glycosylate STGs with sugar moieties present in the sugar-donor molecule. In some embodiments, after achieving a desired ratio of GSTE/GSTC to residual STE/STC contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GSTEs or GSTCs, residual STGs and residue sugar donor is decolorized. Examples of sugar donors include, but are not limited to, glucose, fructose, galactose, lactose, and mannose. In some embodiments, the GSTEs and GSTCs used in the present application are prepared as follows: i) dissolving a glucose-donor material in water to form a liquefied glucose-donor material; ii) adding a starting STE or STC composition to liquefied glucose-donor material to obtain a mixture; and iii) adding an effective amount of an enzyme to the mixture to form a reaction mixture, wherein the enzyme catalyzes the transfer of glucose moieties from the glucose-donor material to STGs in the starting STE or STC composition; and iv) incubating the reaction mixture at a desired temperature for a desired length of reaction time to glycosylate STGs with glucose moieties present in the glucose-donor molecule. In some embodiments, after achieving a desired ratio of GSTE or GSTC- and residual STE or STC contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GSTEs or GSTCs, residual STGs and dextrin is decolorized. In certain embodiments the resulting solution of GSTEs or GSTCs, including residual STGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

The enzymatically catalyzed reaction can be carried out batch wise, semi-batch wise or continuously. Reactants can be supplied at the start of reaction or can be supplied subsequently, either semi-continuously or continuously. The catalytic amount of glycosidase or glycosyltransferase required for the method of the invention depends on the reaction conditions, such as temperature, solvents and amount of substrate.

The reaction can be performed in aqueous media such as buffer. A buffer adjusts the pH of the reaction mixture to a value suitable for effective enzymatic catalysis. Typically the pH is in the range of about pH 4 to about pH 9, for example of about pH 5 to about pH 7. Suitable buffers include, but are not limited to, sodium acetate, tris(hydroxymethyl) aminomethane (“Tris”) and phosphate buffers.

Optionally, the reaction may take place in the presence of a solvent mixture of water and a water miscible organic solvent at a weight ratio of water to organic solvent of from 0.1:1 to 9:1, for example from 1:1 to 3:1. The organic solvent is no primary or secondary alcohol and, accordingly, is non-reactive towards the polysaccharide. Suitable organic solvents comprise alkanones, alkylnitriles, tertiary alcohols and cyclic ethers, and mixtures thereof, for example acetone, acetonitrile, t-pentanol, t-butanol, 1,4-dioxane and tetrahydrofuran, and mixtures thereof. Generally, the use of organic solvents is not preferred.

In certain embodiments, the GSTEs and GSTCs used in the present application are prepared as follows: i) dissolving a glucose-donor material in water to form a liquefied glucose-donor material; ii) adding a starting STE or STC composition to liquefied glucose-donor material to obtain a mixture; and iii) adding an effective amount of an enzyme to the mixture to form a reaction mixture, wherein the enzyme catalyzes the transfer of glucose moieties from the glucose-donor material to STGs in the starting STE or STC composition; and iv) incubating the reaction mixture at a desired temperature for a desired length of reaction time to glycosylate STGs with glucose moieties present in the glucose-donor molecule. In some embodiments, after achieving a desired ratio of GSTE or GSTC- and residual STE or STC contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GSTEs or GSTCs, residual STGs and dextrin is decolorized. In certain embodiments the resulting solution of GSTEs or GSTCs, including residual STGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

(2) Glycosylation Products

The glycosylation products, such as GSTEs, GSTCs, G-ST-MRPs, may include both reacted and unreacted components from the starting materials (i.e., the mixture of materials before the initiation of the glycosylation reaction). In some embodiments, the glycosylated component (e.g., glycosylated RU) or components are presented in the glycosylation product in a range between 0.00001-99.5 wt %, 0.0001-99.5 wt %, 0.001-99.5 wt %, 0.01-99.5 wt %, 0.01-0.02 wt %, 0.01-0.05 wt %, 0.01-0.07 wt %, 0.01-0.1 wt %, 0.01-0.2 wt %, 0.01-0.5 wt %, 0.01-0.7 wt %, 0.01-1 wt %, 0.01-2 wt %, 0.01-5 wt %, 0.01-7 wt %, 0.01-10 wt %, 0.01-20 wt %, 0.01-50 wt %, 0.01-70 wt %, 0.01-99 wt %, 0.02-0.05 wt %, 0.02-0.07 wt %, 0.02-0.1 wt %, 0.02-0.2 wt %, 0.02-0.5 wt %, 0.02-0.7 wt %, 0.02-1 wt %, 0.02-2 wt %, 0.02-5 wt %, 0.02-7 wt %, 0.02-10 wt %, 0.02-20 wt %, 0.02-50 wt %, 0.02-70 wt %, 0.02-99 wt %, 0.05-0.07 wt %, 0.05-0.1 wt %, 0.05-0.2 wt %, 0.05-0.5 wt %, 0.05-0.7 wt %, 0.05-1 wt %, 0.05-2 wt %, 0.05-5 wt %, 0.05-7 wt %, 0.05-10 wt %, 0.05-20 wt %, 0.05-50 wt %, 0.05-70 wt %, 0.05-99 wt %, 0.07-0.1 wt %, 0.07-0.2 wt %, 0.07-0.5 wt %, 0.07-0.7 wt %, 0.07-1 wt %, 0.07-2 wt %, 0.07-5 wt %, 0.07-7 wt %, 0.07-10 wt %, 0.07-20 wt %, 0.07-50 wt %, 0.07-70 wt %, 0.07-99 wt %, 0.1-0.2 wt %, 0.1-0.5 wt %, 0.1-0.7 wt %, 0.1-1 wt %, 0.1-2 wt %, 0.1-5 wt %, 0.1-7 wt %, 0.1-10 wt %, 0.1-20 wt %, 0.1-50 wt %, 0.1-70 wt %, 0.1-99 wt %, 0.2-0.5 wt %, 0.2-0.7 wt %, 0.2-1 wt %, 0.2-2 wt %, 0.2-5 wt %, 0.2-7 wt %, 0.2-10 wt %, 0.2-20 wt %, 0.2-50 wt %, 0.2-70 wt %, 0.2-99 wt %, 0.5-0.7 wt %, 0.5-1 wt %, 0.5-2 wt %, 0.5-5 wt %, 0.5-7 wt %, 0.5-10 wt %, 0.5-20 wt %, 0.5-50 wt %, 0.5-70 wt %, 0.5-99 wt %, 0.7-1 wt %, 0.7-2 wt %, 0.7-5 wt %, 0.7-7 wt %, 0.7-10 wt %, 0.7-20 wt %, 0.7-50 wt %, 0.7-70 wt %, 0.7-99 wt %, 1-2 wt %, 1-5 wt %, 1-7 wt %, 1-10 wt %, 1-20 wt %, 1-50 wt %, 1-70 wt %, 1-99 wt %, 2-5 wt %, 2-7 wt %, 2-10 wt %, 2-20 wt %, 2-50 wt %, 2-70 wt %, 2-99 wt %, 5-7 wt %, 5-10 wt %, 5-20 wt %, 5-50 wt %, 5-70 wt %, 5-99 wt %, 7-10 wt %, 7-20 wt %, 7-50 wt %, 7-70 wt %, 7-99 wt %, 10-20 wt %, 10-50 wt %, 10-70 wt %, 10-99 wt %, 20-50 wt %, 20-70 wt %, 20-99 wt %, 50-70 wt %, 50-99 wt %, or 70-99 wt % of the glycosylation product.

In some embodiments, the glycosylated components are presented in the glycosylation product in an amount greater than 0.01 wt %, 0.1 wt %, 1 wt %, 2 wt %, 5 wt %, 10 wt %, 20 wt %, 30 wt %, 40 wt %, 50 wt %, 60 wt %, 70 wt %, 80 wt %, 90 wt %, 95 wt %, or 99 wt %.

In some embodiments, the glycosylation products comprise glycosylated RU in a amounts ranging 1-5 wt %, 1-10 wt %, 1-15 wt %, 1-20 wt %, 1-30 wt %, 1-40 wt %, 1-50 wt %, 1-60 wt %, 1-70 wt %, 1-80 wt %, 1-90 wt %, 1-95 wt %, 1-99 wt %, 5-10 wt %, 5-15 wt %, 5-20 wt %, 5-30 wt %, 5-40 wt %, 5-50 wt %, 5-60 wt %, 5-70 wt %, 5-80 wt %, 5-90 wt %, 5-95 wt %, 5-99 wt %, 10-15 wt %, 10-20 wt %, 10-30 wt %, 10-40 wt %, 10-50 wt %, 10-60 wt %, 10-70 wt %, 10-80 wt %, 10-90 wt %, 10-95 wt %, 10-99 wt %, 15-20 wt %, 15-30 wt %, 15-40 wt %, 15-50 wt %, 15-60 wt %, 15-70 wt %, 15-80 wt %, 15-90 wt %, 15-95 wt %, 15-99 wt %, 20-30 wt %, 20-40 wt %, 20-50 wt %, 20-60 wt %, 20-70 wt %, 20-80 wt %, 20-90 wt %, 20-95 wt %, 20-99 wt %, 30-40 wt %, 30-50 wt %, 30-60 wt %, 30-70 wt %, 30-80 wt %, 30-90 wt %, 30-95 wt %, 30-99 wt %, 40-50 wt %, 40-60 wt %, 40-70 wt %, 40-80 wt %, 40-90 wt %, 40-95 wt %, 40-99 wt %, 50-60 wt %, 50-70 wt %, 50-80 wt %, 50-90 wt %, 50-95 wt %, 50-99 wt %, 60-70 wt %, 60-80 wt %, 60-90 wt %, 60-95 wt %, 60-99 wt %, 70-80 wt %, 70-90 wt %, 70-95 wt %, 70-99 wt %, 80-90 wt %, 80-95 wt %, 80-99 wt %, 90-95 wt %, 90-99 wt % or 95-99 wt % of the glycosylation products.

In some embodiments, the glycosylation products, such as GSTEs, GSTCs, G-ST-MRPs, comprise glycosylated RU. The glycosylated RU may comprise RU molecules with different levels of glycosylation, including but are not limited to, glycosylated RU molecules that contain a RU backbone (as described in Table 1 with a molecular weight of 641) with 1-50 additional monosaccharide units that are added to the RU backbone during a man-made glycosylation reaction. In some embodiments, the additional monosaccharide units are glucose units. In some embodiments, the additional monosaccharide units are non-glucose units, such as fructose, xylose and galactose units. In some embodiments, the additional monosaccharide units are a mixture of glucose units and non-glucose units.

In some embodiments, the glycosylation products, such as GSTEs, GSTCs, G-ST-MRPs, comprise glycosylated RU in an amount of less than 80%, 75%, 70%, 65%, 60%, 55%, 50%, 45%, 40%, 35%, 30%, 25%, 20%, 15% or 10% by weight of the glycosylation products. In some embodiments, the glycosylation products, such as GSTEs, GSTCs, G-ST-MRPs, comprise glycosylated RU in an amount of greater than 10%, 15%, 20%, 25%, 30%, 35%, 40%, 45%, 50%, 55%, 60%, 65%, 70%, 75%, 80%, 85%, 90% or 95% by weight of the glycosylation products.

In some embodiments, the glycosylation products, such as GSTEs, GSTCs, G-ST-MRPs, comprise steviolmonoside in an amount of great than 6%, 8%, 10%, 12%, 15%, 20%, 25% or 30% by weight of the glycosylation products. In some embodiments, the glycosylation products, such as GSTEs, GSTCs, G-ST-MRPs, comprise steviolmonoside in an amount of less than 60%, 55%, 50%, 45%, 40%, 35%, 30%, 25%, 20%, 15%, 10% or 5% by weight of the glycosylation products.

In some embodiments, the glycosylation products, such as GSTEs, GSTCs, G-ST-MRPs, comprise less than 10%, 8%, 6%, 4% or 2% mono-glycosylated RU (i.e., RU backbone with one added monosaccharide unit) by weight of the glycosylation products. In some embodiments, the glycosylation products, such as GSTEs, GSTCs, G-ST-MRPs, comprise greater than 5%, 10%, 15%, 20%, 25%, 30%, 35%, 40%, 45%, 50%, 55% or 60% mono-glycosylated RU by weight of the glycosylation products.

In some embodiments, the glycosylation products, such as GSTEs, GSTCs, G-ST-MRPs, comprise less than 15%, 12%, 10%, 8%, 6%, 4% or 2% bi-glycosylated RU (i.e., RU backbone with two added monosaccharide units) by weight of the glycosylation products. In some embodiments, the glycosylation products, such as GSTEs, GSTCs, G-ST-MRPs, comprise greater than 5%, 10%, 15%, 20%, 25%, 30%, 35%, 40%, 45% or 50% bi-glycosylated RU by weight of the glycosylation products.

In some embodiments, the glycosylation products, such as GSTEs, GSTCs, G-ST-MRPs, comprise less than 5%, 4%, 3%, 2%, 1% tri-glycosylated RU (i.e., RU backbone with three added monosaccharide units) by weight of the glycosylation products. In some embodiments, the glycosylation products, such as GSTEs, GSTCs, G-ST-MRPs, comprise greater than 5%, 10%, 15%, 20%, 25%, 30%, 35% or 40% tri-glycosylated RU by weight of the glycosylation products.

In some embodiments, the glycosylation products, such as GSTEs, GSTCs, G-ST-MRPs, comprise mono-glycosylated RU, bi-glycosylated RU and triglycosylated RU in a total amount of less than 30%, 25%, 20%, 15% or 10% by weight of the glycosylation products. In some embodiments, the glycosylation products, such as GSTEs, GSTCs, G-ST-MRPs, comprise mono-glycosylated RU, bi-glycosylated RU and triglycosylated RU in a total amount of greater than 10%, 15%, 20%, 25%, 30%, 35%, 40%, 45%, 50%, 55%, 60%, 65%, 70%, 75%, 80%, 85% or 90% by weight of the glycosylation products.

In some embodiments, the glycosylation products, such as GSTEs, GSTCs, G-ST-MRPs, comprise RU in an amount of less than 30%, 25%, 20%, 15%, 10%, 5%, 4%, 3%, 2% or 1% by weight of the glycosylation products. In some embodiments, the glycosylation products, such as GSTEs, GSTCs, G-ST-MRPs, comprise RU in an amount of greater than 1%, 2%, 5%, 10%, 15%, 20%, 25%, 30%, 35%, 40%, 45%, 50%, 55%, 60%, 65%, 70%, 75% or 80% by weight of the glycosylation products.

In some embodiments, the glycosylation products are produced from a stevia extract composition comprises rubusoside and suaviosides, where the weight percentage of suaviosides is at least 0.1%, 1%, 5%, 8%, or 10%, and optionally comprises one or more of stevia glycosides selected from Reb A, Reb B, Reb C, Reb D, Reb E, Reb I, Reb M, Reb N, and Reb O. In some embodiments, the glycosylation products are produced from enriched rubusoside, wherein enriched rubusoside may be produced from isolated stevia leaves, or by hydrolyzing stevioside to produce rubusoside and suaviosides therefrom.

C. Maillard Reaction Products of STEs, STCs, GSTEs and GSTCs (Collectively ST-MRPs) and Glycosylation Products of ST-MRP (G-ST-MRP)

In one embodiment, the sweetener or flavoring composition of the present application comprises one or more ST-MRPs. In some embodiments, the sweetener or flavoring composition of the present application comprises one or more STE-MRPs, one or more STC-MRPs, one or more GSTE-MRPs, one or more GSTC-MRPs, or combinations thereof.

In some embodiments, the one or more ST-MRPs are present in the sweetening or flavoring composition in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, or 90-99 wt % of the composition.

In some embodiments, the one or more ST-MRPs are prepared from a Maillard reaction mixture that contains enriched RU.

In some embodiments, the one or more ST-MRPs are prepared from a Maillard reaction mixture that contains an enriched diterpene glycoside.

In some embodiments, the one or more ST-MRPs are prepared from a Maillard reaction mixture that comprises one or more STCs selected from the group consisting of RU, SU, steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin.

In some embodiments, the one or more ST-MRPs are prepared from a Maillard reaction mixture that comprises one or more suaviosides selected from the group consisting of SU-A, SU-B, SU-C1, SU-D1, SU-D2, SU-E, SU-F, SU-G, SU-H, SU-I, and SU-J.

In some embodiments, the one or more ST-MRPs are prepared from a Maillard reaction mixture that comprises purified RU.

In some embodiments, the one or more ST-MRPs comprises a MRP prepared from a Maillard reaction mixture that comprises a STE having a RU content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the STE.

In some embodiments, the one or more ST-MRPs comprises a MRP prepared from a Maillard reaction mixture that comprises a GSTE, wherein the GSTE is the glycosylation product of a STE having an RU content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the STE.

In some embodiments, the one or more ST-MRPs comprises a MRP prepared from a Maillard reaction mixture that comprises a GSTE, wherein the GSTE is the glycosylation product of a STE having a RU content of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetener or flavoring composition additionally includes MRPs formed from one or more flavonoid glycosides, isoflavone glycosides, saponin glycosides, phenol glycosides, cyanophore glycosides, anthraquinone glycosides, cardiac glycosides, bitter glycosides, coumarin glycosides, and/or sulfur glycosides.

In some embodiments, the sweetener or flavoring composition additionally includes MRPs formed from one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, and/or glycosylated sulfur glycosides.

In some embodiments, the sweetener or flavoring composition additionally includes MRPs formed from one or more flavonoid glycosides, isoflavone glycosides, saponin glycosides, phenol glycosides, cyanophore glycosides, anthraquinone glycosides, cardiac glycosides, bitter glycosides, coumarin glycosides, or sulfur glycosides.

In some embodiments, the sweetener or flavoring composition additionally includes MRPs formed from one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, and/or glycosylated sulfur glycosides.

In some embodiments, a sweetener or flavoring composition comprises one or more ST-MRPs and thaumatin.

In some embodiments, the sweet tea-based sweetening and flavoring composition described in this section (Section IIC) further comprises one or more components selected from the group consisting of STEs, STCs, GSTEs, GSTCs, G-ST-MRPs, SEs, SGs, GSEs, GSGs, Stevia-MRPs and conventional MRPs.

(1) The Maillard Reaction

The Maillard reaction generally refers to a non-enzymatic browning reaction of a sugar donor with an amine donor in the presence of heat which produces flavor. Common flavors produced as a result of the Maillard reaction include, for example, those associated with red meat, poultry, coffee, vegetables, bread crust etc. subjected to heat. A Maillard reaction relies mainly on sugars and amino acids but it can also contain other ingredients including: autolyzed yeast extracts, hydrolyzed vegetable proteins, gelatin (protein source), vegetable extracts (i.e., onion powder), enzyme treated proteins, meat fats or extracts and acids or bases to adjust the pH of the reaction. The reaction can be in an aqueous environment with an adjusted pH at specific temperatures for a specified amount of time to produce a variety of flavors. Typical flavors include those associated with chicken, pork, beef, caramel, chocolate etc. However, a wide variety of different taste and aroma profiles can be achieved by adjusting the ingredients, the temperature and/or the pH of the reaction. The main advantage of the reaction flavors is that they can produce characteristic meat, burnt, roasted, caramellic, or chocolate profiles desired by the food industry, which are not typically achievable by using compounding of flavor ingredients.

Reducing groups can be found on reducing sugars (sugar donors) and amino groups can be found on amino donors such as free amino acids, peptides, and proteins. Initially, a reactive carbonyl group of a reducing sugar condenses with a free amino group, with a concomitant loss of a water molecule. A reducing sugar substrate for Maillard reaction typically has a reactive carbonyl group in the form of a free aldehyde or a free ketone. The resultant N-substituted glycoaldosylamine is not stable. The aldosylamine compound rearranges, through an Amadori rearrangement, to form a ketosamine. Ketosamines that are so-formed may further react through any of the following three pathways: (a) further dehydration to form reductones and dehydroreductones; (b) hydrolytic fission to form short chain products, such as diacetyl, acetol, pyruvaldehyde, and the like, which can, in turn, undergo Strecker degradation with additional amino groups to form aldehydes, and condensation, to form aldols; and (c) loss of water molecules, followed by reaction with additional amino groups and water, followed by condensation and/or polymerization into melanoids. Factors that affect the rate and/or extent of Maillard reactions include among others the temperature, water activity, and pH. The Maillard reaction is enhanced by high temperature, low moisture levels, and alkaline pH.

In the Maillard reaction, suitable carbonyl containing reactants include those that comprise a reactive aldehyde (—CHO) or keto (—CO—) group, such that the carbonyl free aldehyde or free keto group is available to react with an amino group associated with the reactant. Typically, the reducing reactant is a reducing sugar, e.g., a sugar that can reduce a test reagent, e.g., can reduce Cu2+ to Cu+, or can be oxidized by such reagents.

Monosaccharides, disaccharides, oligosaccharides, polysaccharides (e.g., dextrins, starches, and edible gums) and their hydrolysis products are suitable reducing reactants if they have at least one reducing group that can participate in a Maillard reaction. Reducing sugars include aldoses or ketoses such as glucose, fructose, maltose, lactose, glyceraldehyde, dihydroxyacetone, arabinose, xylose, ribose, mannose, erythrose, threose, and galactose. Other reducing reactants include uronic acids (e.g., glucuronic acid, glucuronolactone, and galacturonic acid, mannuronic acid, iduronic acid) or Maillard reaction intermediates bearing at least one carbonyl group such as aldehydes, ketones, alpha-hydroxycarbonyl or dicarbonyl compounds.

(2) Maillard Reaction Components

The inventors of the present application have found that Maillard reaction product (MRP) compositions can provide improved taste profiles over previously reported high intensity natural sweetener compositions. In addition, the inventors have surprisingly discovered that non-reducing sugars, including steviol glycosides, exemplified by rubusoside and suavioside, may serve as substrates in the Maillard reaction so as to provide improved taste profiles. Thus, sweet tea compositions or extracts may also serve as substrates in the Maillard reaction and provide Maillard reaction product (MRP) compositions having improved taste or flavor profiles.

In some embodiments, the present application provides a sweet tea Maillard reaction product (ST-MRP) that is formed from heating a reaction mixture comprising (1) one or more exogenously added amine donors, (2) one or more exogenously added reducing sugars; and (3) one or more STEs, GSTEs, STCs and/or GSTCs.

In some embodiments, the present application provides a sweet tea Maillard reaction product (ST-MRP) that is formed from heating a reaction mixture comprising (1) one or more exogenously added amine donors, and (2) one or more STEs, GSTEs, STCs and/or GSTCs.

In some embodiments, the present application provides a sweet tea Maillard reaction product (ST-MRP) that is formed from heating a reaction mixture comprising (1) one or more exogenously added reducing sugars; and (2) one or more STEs, GSTEs, STCs and/or GSTCs.

In some embodiments, the present application provides a sweet tea Maillard reaction product (ST-MRP) that is formed from heating a reaction mixture comprising (1) one or more exogenously added amine donors, (2) one or more exogenously added non-reducing sugars; and (3) one or more STEs, GSTEs, STCs and/or GSTCs.

In some embodiments, the present application provides a sweet tea Maillard reaction product (ST-MRP) that is formed from heating a reaction mixture comprising (1) one or more exogenously added non-reducing sugars; and (2) one or more STEs, GSTEs, STCs and/or GSTCs.

In some embodiments, the present application provides a sweet tea Maillard reaction product (ST-MRP) that is formed from heating a reaction mixture comprising (1) one or more exogenously added amine donors, (2) one or more exogenously added reducing sugars; (3) one or more exogenously added non-reducing sugars; and (4) one or more STEs, GSTEs, STCs and/or GSTCs.

In some embodiments, the present application provides a sweet tea Maillard reaction product (ST-MRP) that is formed from heating a reaction mixture comprising (1) one or more exogenously added reducing sugars; (2) one or more exogenously added non-reducing sugars; and (3) one or more STEs, GSTEs, STCs and/or GSTCs.

In some embodiments, the present application provides a glycosylated sweet tea Maillard reaction product (G-ST-MRP) that is formed by glycosylation of a ST-MRP. Exemplary conditions of glycosylation are described in Section II(B).

In some embodiments, the present application provides a glycosylated Stevia extract Maillard reaction product or a glycosylated steviol glycoside Maillard reaction product (collectively G-SG-MRP) that is formed by glycosylation of a SG-MRP. Exemplary conditions of glycosylation are described in Section II(B).

Amine Donor

The MRP compositions of the present application are formed from a reaction mixture comprising at least one exogenous amine donor comprising a free amino group. As used herein, the term “amine donor” refers to a compound or substance containing a free amino group, which can participate in a Maillard reaction. Amine containing reactants include amino acids, peptides (including dipeptides, tripeptides, and oligopeptides), proteins, proteolytic or nonenzymatic digests thereof, and other compounds that react with reducing sugars and similar compounds in a Maillard reaction, such as phospholipids, chitosan, lipids, etc. In some embodiments, the amine donor also provides one or more sulfur-containing groups. Exemplary amine donors include amino acids, peptides, proteins, protein extracts.

Exemplary amino acids include, for example, nonpolar amino acids, such as alanine, glycine, isoleucine, leucine, methionine, tryptophan, phenylalanine, proline, valine; polar amino acids, such as cysteine, serine, threonine, tyrosine, asparagine, and glutamine; polar basic (positively charged) amino acids, such as histidine and lysine; and polar acidic (negatively charged) amino acids, such as aspartate and glutamate.

Exemplary peptides include, for example, hydrolyzed vegetable proteins (HVPs) and mixtures thereof.

Exemplary proteins include, for example, sweet taste-modifying proteins, soy protein, sodium caseinate, whey protein, wheat gluten or mixtures thereof. Exemplary sweet taste-modifying proteins include, for example, thaumatin, monellin, brazzein, miraculin, curculin, pentadin, mabinlin, and mixtures thereof. In certain embodiments, the sweet-taste modifying proteins may be used interchangeably with the term “sweetener enhancer.”

Exemplary protein extracts include yeast extracts, plant extracts, bacterial extracts and the like.

The nature of the amino donor can play an important role in accounting for the many flavors produced from a Maillard reaction. In some embodiments, the amine donor may account for one or more flavors produced from a Maillard reaction. In some embodiments, a flavor may be produced from a Maillard reaction by using one or more amine donors, or a particular combination of an amine donor and sugar donor.

In certain embodiments, the amine donor is present in the compositions described herein in a range of from about 1 to about 99 weight percent, from about 1 to about 50 weight percent, from about 1 to about 10 weight percent, from about 2 to about 9 weight percent, from about 3 to about 8 weight percent, from about 4 to about 7 weight percent, from about 5 to about 6 weight percent and all values and ranges encompassed over the range of from about 1 to about 50 weight percent. In some embodiments, the amine donor is from a plant source, such as vegetable juice, fruit juice, berry juice, etc.

Sugar Donor

In some embodiments, the sugar donor is a reducing sugar. Reducing sugars for use in the present application include, for example, all monosaccharides and some disaccharides, which can be aldose reducing sugars or ketose reducing sugars. Typically, the reducing sugar may be selected from the group consisting of aldotetrose, aldopentose, aldohexose, ketotetrose, ketopentose, and ketohexose reducing sugars. Suitable examples of aldose reducing sugars include erythrose, threose, ribose, arabinose, xylose, lyxose, allose, altrose, glucose, mannose, gulose, idose, galactose and talose. Suitable examples of ketose reducing sugars include erythrulose, ribulose, xylulose, psicose, fructose, sorbose and tagatose. The aldose or the ketose may also be a deoxy-reducing sugar, for example a 6-deoxy reducing sugar, such as fucose or rhamnose.

Specific monosaccharide aldoses include, for example, reducing agents include, for example, where at least one reducing sugar is a monosaccharide, or the one or more reducing sugars are selected from a group comprising monosaccharide reducing sugars, typically at least one monosaccharide reducing sugar is an aldose or a ketose.

Where the reducing sugar is a monosaccharide, the monosaccharide may be in the D- or L-configuration, or a mixture thereof. Typically, the monosaccharide is present in the configuration in which it most commonly occurs in nature. For example, the one or more reducing sugars may be selected from the group consisting of D-ribose, L-arabinose, D-xylose, D-lyxose, D-glucose, D-mannose, D-galactose, D-psicose, D-fructose, L-fucose and L-rhamnose. In a more particular embodiment, the one or more reducing sugars are selected from the group consisting of D-xylose, D-glucose, D-mannose, D-galactose, L-rhamnose and lactose.

Specific reducing sugars include ribose, glucose, fructose, maltose, lyxose, galactose, mannose, arabinose, xylose, rhamnose, rutinose, lactose, maltose, cellobiose, glucuronolactone, glucuronic acid, D-allose, D-psicose, xylitol, allulose, melezitose, D-tagatose, D-altrose, D-alditol, L-gulose, L-sorbose, D-talitol, inulin, stachyose, including mixtures and derivatives therefrom.

Exemplary disaccharide reducing sugars for use in the present application include maltose, lactose, lactulose, cellubiose, kojibiose, nigerose, sophorose, laminarbiose, gentiobiose, turanose, maltulose, palantinose, gentiobiulose, mannobiose, melibiose, melibiulose, rutinose, rutinulose or xylobiose.

Mannose and glucuronolactone or glucuronic acid can be used as sugar donors under Maillard reaction conditions, although they have seldom been used. Maillard reaction products of mannose, glucuronolactone or glucuronic acid provide yet another unique approach to provide new taste profiles with the sweetening agents described throughout the specification alone or in combination with additional natural sweeteners, synthetic sweeteners, and/or flavoring agents described herein.

In some embodiments, one or more carbohydrate sweeteners may be added to a reaction mixture subjected to the Maillard reaction. In other embodiments, one or more carbohydrate sweeteners may be added to an MRP composition. Non-limiting examples of carbohydrate sweeteners for use in the present application include caloric sweeteners, such as, sucrose, fructose, glucose, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, sugar alcohols, such as erythritol, xylitol, mannitol, sorbitol, maltitol, lactitol, mannitol, and inositol; xylo-oligosaccharides (xylotriose, xylobiose and the like), gentio-oligoscaccharides (gentiobiose, gentiotriose, gentiotetraose and the like), galacto-oligosaccharides, sorbose, nigero-oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (containing fructose and glucose, e.g., HFCS55, HFCS42, or HFCS90), coupling sugars, soybean oligosaccharides, and glucose syrup. Additionally, the above carbohydrates may be in either the D- or L-configuration.

It should be noted, however, that not all carbohydrate sweeteners are reducing sugars. Sugars having acetal or ketal linkages are not reducing sugars, as they do not have free aldehyde chains. They therefore do not react with reducing-sugar test solutions (e.g., in a Tollens' test or Benedict's test). However, a non-reducing sugar can be hydrolyzed using diluted hydrochloric acid.

In some embodiments, the sugar donor is a non-reducing sugar that does not contain free aldehyde or free keto groups. Exemplary non-reducing sugars include, but are not limited to, sucrose, trehalose, xylitol, and raffinose. In some embodiments, the sugar donor comprises both reducing sugar and non-reducing sugar. In some embodiments, the sugar donor is derived from a food ingredient, such as sugar, flour, starch, vegetable and fruits. In some embodiments, the sugar donor is from a plant source, such as fruit juice, berry juice, vegetable juice, etc. In some embodiments, the sugar donor is orange juice, cranberry juice, apple juice, peach juice, watermelon juice, pineapple juice, grape juice and concentrated product thereof. In some embodiments, the fruit juice, berry juice or vegetable juice serves as both amine donor and sugar donor.

In some embodiments, the sugar donor and amino donor are present in the reaction mixture in a molar ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the sugar donor and amino donor are present in the reaction mixture in a sugar donor:amino donor weight ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the weight ratio between the total amount of STE, STC, GSTE and GSTC and the total amount of sugar donor and amine donor (Total STE/STC/GSTE/GSTC: Total sugar/amine) in the reaction mixture is from 10:1 to 1:10, from 8:1 to 1:8, from 6:1 to 1:6, from 4:1 to 1:4, from 3:1 to 1:3 or from 2:1 to 1:2.

In one aspect, in an exemplary composition having two different components, the components can have ratios of from 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween wherein the ratios are from 1:99 and vice versa, e.g., a ratio of from 1:99 to 50:50, from 30:70 to 42:58, etc.

It should be understood that the different components can be STEs, STCs, RU, GSTEs, GSTCs, GSUs, STE-MRPs, STC-MRPs, RU-MRPs, GSTE-MRPs, GSTC-MRPs, GRU-MRPs, SGs, SGEs, GSGs, GSGEs, SG-MRPs, SGE-MRPs, GSG-MRPs, GSGE-MRPs, sugar donors, amine donors, sweeteners, non-nutritive sweeteners, high intensity natural sweeteners, high intensity synthetic or semi-synthetic sweeteners, sweetener enhancers, components of swingle extracts, mogrosides etc.

In another aspect, in an exemplary composition having three different components. The components can have ratios of from 1:1:98, 1:2:97, 1:3:96, 1:4:95, 1:5:94, 1:6:93, 1:7:92, 1:8:91, 1:9:90, 1:10:89, 1:11:88, 1:12:87, 1:13:86, 1:14:85, 1:15:84, 1:16:83, 1:17:82, 1:18:81, 1:19:80, 1:20:79, 1:21:78, 1:22:77, 1:23:76, 1:24:75, 1:25:74, 1:26:73, 1:27:72, 1:28:71, 1:29:70, 1:30:69, 1:31:68, 1:32:67, 2:3:95, 2:4:94, 2:5:93, 2:6:92, 2:7:91, 2:8:90, 2:9:89, 2:10:88, 2:11:87, 2:12:86, 2:13:85, 2:14:84, 2:15:83, 2:16:82, 2:17:81, 2:18:80, 2:19:79, 2:20:78, 2:21:77, 2:22:76, 2:23:75, 2:24:74, 2:25:73, 2:26:72, 2:27:71, 2:28:70, 2:29:69, 2:30:68, 2:31:67, 2:32:66, 2:3:95, 3:3:94, 3:4:93, 3:5:92, 3:6:91, 3:7:90, 3:8:89, 3:9:88, 3:10:87, 3:11:86, 3:12:85, 3:13:84, 3:14:83, 3:15:82, 3:16:81, 2:17:80, 3:18:79, 3:19:78, 3:20:77, 3:21:76, 3:22:75, 3:23:74, 3:24:73, 3:25:72, 3:26:71, 3:27:70, 3:28:69, 3:29:68, 3:30:67, 3:31:66, 3:32:65, 4:4:92, 4:5:91, 4:6:90, 4:7:89, 4:8:88, 4:9:87, 4:10:86, 4:11:85, 4:12:84, 4:13:83, 4:14:82, 4:15:81, 4:16:80, 4:17:79, 4:18:78, 4:19:77, 4:20:76, 4:21:75, 4:22:74, 4:23:73, 4:24:72, 4:25:71, 4:26:70, 4:27:69, 4:28:68, 4:29:67, 4:30:66, 4:31:65, 4:32:64, 5:5:90, 5:6:89, 5:7:88, 5:8:87, 5:9:86, 5:10:85, 5:11:84, 5:12:83, 5:13:82, 5:14:81, 5:15:80, 5:16:79, 5:17:78, 5:18:77, 5:19:76, 5:20:75, 5:21:74, 5:22:73, 5:23:72, 5:24:71, 5:25:70, 5:26:69, 5:27:68, 5:28:67, 5:29:66, 5:30:65, 5:31:64, 5:32:63, 6:6:88, 6:7:87, 6:8:86, 6:9:85, 6:10:84, 6:11:83, 6:12:82, 6:13:81, 6:14:80, 6:15:79, 6:16:78, 6:17:77, 6:18:76, 6:19:75, 6:20:74, 6:21:73, 6:22:72, 6:23:71, 6:24:70, 6:25:69, 6:26:68, 6:27:67, 6:28:66, 6:29:65, 6:30:64, 6:31:63, 6:32:62, 7:7:86, 7:8:85, 7:9:84, 7:10:83, 7:11:82, 7:12:81, 7:13:80, 7:14:79, 7:15:78, 7:16:77, 7:17:76, 7:18:75, 7:19:74, 7:20:73, 7:21:72, 7:22:71, 7:23:70, 7:24:69, 7:25:68, 7:26:67, 7:27:66, 7:28:65, 7:29:64, 7:30:63, 7:31:62, 7:32:61, 8:8:84, 8:9:83, 8:10:82, 8:11:81, 8:12:80, 8:13:79, 8:14:78, 8:15:77, 8:16:76, 8:17:75, 8:18:74, 8:19:73, 8:20:72, 8:21:71, 8:22:70, 8:23:69, 8:24:68, 8:25:67, 8:26:66, 8:27:65, 8:28:64, 8:29:63, 8:30:62, 8:31:61, 8:32:60, 9:9:82, 9:10:81, 9:11:80, 9:12:79, 9:13:78, 9:14:77, 9:15:76, 9:16:75, 9:17:74, 9:18:73, 9:19:72, 9:20:71, 9:21:70, 9:22:69, 9:23:68, 9:24:67, 9:25:66, 9:26:65, 9:27:64, 9:28:63, 9:29:62, 9:30:61, 9:31:60, 9:32:59, 10:10:80, 10:11:79, 10:12:78, 10:13:77, 10:14:76, 10:15:75, 10:16:74, 10:17:73, 10:18:72, 10:19:71, 10:20:70, 10:21:69, 10:22:68, 10:23:67, 10:24:66, 10:25:65, 10:26:64, 10:27:63, 10:28:62, 10:29:61, 10:30:60, 10:31:59, 10:32:58, 11:11:78, 11:12:77, 11:13:76, 11:14:75, 11:15:74, 11:16:73, 11:17:72, 11:18:71, 11:19:70, 11:20:69, 11:21:68, 11:22:67, 11:23:66, 11:24:65, 11:25:64, 11:26:63, 11:27:62, 11:28:61, 11:29:60, 11:30:59, 11:31:58, 11:32:57, 12:12:76, 12:13:75, 12:14:74, 12:15:73, 12:16:72, 12:17:71, 12:18:70, 12:19:69, 12:20:68, 12:21:67, 12:22:66, 12:23:65, 12:24:64, 12:25:63, 12:26:62, 12:27:61, 12:28:60, 12:29:59, 12:30:58, 12:31:57, 12:32:56, 13:13:74, 13:14:73, 13:15:72, 13:16:71, 13:17:70, 13:18:69, 13:19:68, 13:20:67, 13:21:66, 13:22:65, 13:23:64, 13:24:63, 13:25:62, 13:26:61, 13:27:60, 13:28:59, 13:29:58, 13:30:57, 13:31:56, 13:32:55, 14:14:72, 14:15:71, 14:16:70, 14:17:69, 14:18:68, 14:19:67, 14:20:66, 14:21:65, 14:22:64, 14:23:63, 14:24:62, 14:25:61, 14:26:60, 14:27:59, 14:28:58, 14:29:57, 14:30:56, 14:31:55, 14:32:54, 15:15:70, 15:16:69, 15:17:68, 15:18:67, 15:19:66, 15:20:65, 15:21:64, 15:22:63, 15:23:62, 15:24:61, 15:25:60, 15:26:59, 15:27:58, 17:28:57, 15:29:56, 15:30:55, 15:31:54, 15:32:53, 16:16:68, 16:17:67, 16:18:66, 16:19:65, 16:20:64, 16:21:63, 16:22:62, 16:23:61, 16:24:60, 16:25:59, 16:26:58, 16:27:57, 16:28:56, 16:29:55, 16:30:54, 16:31:53, 16:32:52, 17:17:66, 17:18:65, 17:19:64, 17:20:63, 17:21:62, 17:22:61, 17:23:60, 17:24:59, 17:25:58, 17:26:57, 17:27:56, 17:28:55, 17:29:54, 17:30:53, 17:31:52, 17:32:51, 18:18:64, 18:19:63, 18:20:62, 18:21:61, 18:22:60, 18:23:59, 18:24:58, 18:25:57, 18:26:56, 18:27:55, 18:28:54, 18:29:53, 18:30:52, 18:31:51, 18:32:50, 19:19:62, 19:20:61, 19:21:60, 19:22:59, 19:23:58, 19:24:57, 19:25:56, 19:26:55, 19:27:54, 19:28:53, 19:29:52, 19:30:51, 19:31:50, 19:32:49, 20:20:60, 20:21:59, 20:22:58, 20:23:57, 20:24:56, 20:25:55, 20:26:54, 20:27:53, 20:28:52, 20:29:51, 20:30:50, 20:31:49, 20:32:48, 21:21:58, 21:22:57, 21:23:56, 21:24:55, 21:25:54, 21:26:53, 21:27:52, 21:28:51, 21:29:50, 21:30:49, 21:31:48, 21:32:47, 22:22:56, 22:23:55, 22:24:54, 22:25:53, 22:26:52, 22:27:51, 22:28:50, 22:29:49, 22:30:48, 22:31:47, 22:32:46, 23:23:54, 23:24:53, 23:25:52, 23:26:51, 23:27:50, 23:28:49, 23:29:48, 23:30:47, 23:31:46, 23:32:45, 24:24:52, 24:25:51, 24:26:50, 24:27:49, 24:28:48, 24:29:47, 24:30:46, 24:31:45, 24:32:44, 25:25:50, 25:26:49, 25:27:48, 25:28:47, 25:29:46, 25:30:45, 25:31:44, 25:32:43, 26:26:48, 26:27:47, 26:28:46, 26:29:45, 26:30:44, 26:31:43, 26:32:42, 27:27:46, 27:28:45, 27:29:44, 27:30:43, 27:31:42, 27:32:41, 28:28:44, 28:29:43, 28:30:42, 28:31:41, 28:32:40, 29:29:42, 29:30:41, 29:31:40, 29:32:39, 30:30:40, 30:31:39, 30:32:38, 31:31:38, 31:32:37, 32:32:36, 32:33:35, and 33.3:33.3:33.3, and all ranges therebetween wherein the ratios are from 1:1:98 and vice versa, e.g., a ratio of from 1:1:98 to 33.3:33.3:33.3, from 10:30:70 to 15:40:45, etc.

It should be understood that the different components can be STEs, STCs, RU, GSTEs, GSTCs, GSUs, STE-MRPs, STC-MRPs, RU-MRPs, GSTE-MRPs, GSTC-MRPs, GRU-MRPs, sugar donors, amine donors, sweeteners, non-nutritive sweeteners, individual components of sweeteners, such as stevioside, steviolbioside, RA, RB, RC, RD, RE, RF, RH, RI, RJ, RK, RL, RM, RN, RO, rubusoside and dulcoside A, etc., components of stevia extracts, components of mogroside extracts, etc.

It is noted that the present disclosure is not limited to compositions having only two or three different components, and that the exemplary ratios are non-limiting. Rather, the same formula can be followed for establishing ratios of as many different components as are contained within a given composition. As a further example, in a composition that comprises 20 different components described herein, the components can have ratios of from 1:1:1:1:1:1:1:1:1:1:1:1:1:1:1:1:1:1:1:81 to 5:5:5:5:5:5:5:5:5:5:5:5:5:5:5:5:5:5:5:5, and all possible combinations of ratios therebetween. In some embodiments, a composition of the present disclosure may have up to and including a combination of all compounds.

The Maillard reaction is conducted with a suitable solvent. Additionally, solvents can be employed along with water. Suitable solvents approved for oral use include, for example, alcohols, such as low molecular weight alcohols, e.g., methanol, ethanol, propanol, butanol, pentanol, hexanol, ethylene glycol, propylene glycol, butyl glycol, etc. The following additional solvents may be used in the Maillard reaction or may act as carriers for Maillard reaction products: acetone, benzyl alcohol, 1,3-butylene glycol, carbon dioxide, castor oil, citric acid esters of mono- and di-glycerides, ethyl acetate, ethyl alcohol, ethyl alcohol denatured with methanol, glycerol (glycerin), glyceryl diacetate, glyceryl triacetate (triacetin), glyceryl tributyrate (tributyrin), hexane, isopropyl alcohol, methyl alcohol, methyl ethyl ketone (2-butanone), methylene chloride, monoglycerides and diglycerides, monoglyceride citrate, 1,2-propylene glycol, propylene glycol mono-esters and diesters, triethyl citrate, and mixtures thereof.

Although recognizing that other suitable solvents may be used for flavoring agents, The International Organization of the Flavor Industry (IOFI) Code of Practice (Version 1.3, dated Feb. 29, 2012) lists the following solvents as being appropriate for use in flavoring agents: acetic acid, benzyl alcohol, edible oils, ethyl alcohol, glycerol, hydrogenated vegetable oils, isopropyl alcohol, mannitol, propylene glycol, sorbitol, sorbitol syrup, water, and xylitol. Accordingly, in certain embodiments, these are preferred solvents.

In some embodiments, the solvent is water. In some embodiments, the solvent is glycerol. In some embodiments, the solvent is a glycerol-water mixture with a glycerol:water ratio (v:v) of 10:1 to 1:10, 9:1 to 1:9, 8:1 to 1:8, 7:1 to 1:7, 6:1 to 1:6, 1:5 to 5:1, 1:4 to 4:1, 1:3 to 3:1, 1:2 to 2:1. In some embodiments, the solvent is a glycerol-water mixture with a glycerol:water ratio (v:v) of 1:9, 1:8, 1:7, 1:6, 1:5, 1:4, 1:3, 1:2, 1:1, 2:1, 3:1, 4:1, 5:1, 6:1, 7:1, 8:1 or 9:1.

In some embodiments, the reaction mixture comprises a solvent in an amount of 10-90 wt %, 10-80 wt %, 10-70 wt %, 10-60 wt %, 10-50 wt %, 10-40 wt %, 10-30 wt %, 10-20 wt %, 20-90 wt %, 20-80 wt %, 20-70 wt %, 20-60 wt %, 20-50 wt %, 20-40 wt %, 20-30 wt %, 30-90 wt %, 30-80 wt %, 30-70 wt %, 30-60 wt %, 30-50 wt %, 30-40 wt %, 40-90 wt %, 40-80 wt %, 40-70 wt %, 40-60 wt %, 40-50 wt %, 50-90 wt %, 50-80 wt %, 50-70 wt %, 50-60 wt %, 60-90 wt %, 60-80 wt %, 60-70 wt %, 70-90 wt %, 70-80 wt %, or 80-90 wt % of the reaction mixture. In some embodiments, the reaction mixture comprises a solvent in an amount of about 10 wt %, about 15 wt %, about 20 wt %, about 25 wt %, about 30 wt %, about 33 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt % of the reaction mixture.

In some embodiments, the sugar donor may account for one or more flavors produced from a Maillard reaction. More particularly, a flavor may be produced from a Maillard reaction by using one or more sugar donors, wherein at least one sugar donor is selected from a product comprising a glycoside and a free carbonyl group. In some embodiments, glycosidic materials for use in Maillard reactions include natural juice/concentrates/extracts selected from strawberry, blueberry, blackberry, bilberry, raspberry, lingonberry, cranberry, red currants, white currants, blackcurrants, apple, peach, pear, apricot, mango, grape, watermelon, cantaloupe, grapefruit, passion fruit, dragon fruit, carrot, celery, eggplant, tomato, etc.

The natural extracts used in Maillard reactions described herein can include any solvent extract-containing substances, such as polyphenols, free amino acids, flavonoids etc. The extracts can be further purified by methods such as resin-enriched, membrane filtration, crystallization etc., as further described herein.

In one embodiment, a Maillard reaction mixture or an MRP composition produced thereof may include a sweetener, thaumatin, and optionally one or more MRP products, wherein the sweetener is selected from date paste, apple juice concentrate, monk fruit concentrate, sugar beet syrup, pear juice or puree concentrate, apricot juice concentrate. Alternatively, a root or berry juice may be used as sugar donor or sweetener added to an MRP composition.

In some embodiments, particular flavors may be produced from a Maillard reaction through the use of one or more sugar donors, where at least one sugar donor is selected from plant juice/powder, vegetable juice/powder, berries juice/powder, fruit juice/powder. In certain preferred embodiments, a concentrate or extract may be used, such as a bilberry juice concentrate or extract having an abundance of anthocyanins. Optionally, at least one sugar donor and/or one amine donor is selected from animal source based products, such as meat, oil etc. Meat from any part of an animal, or protein(s) from any part of a plant could be used as source of amino donor(s) in this application.

In some embodiments, the Maillard reactants may further include one or more high intensity synthetic sweeteners, non-ST natural sweeteners, and/or the glycosylation products thereof. Alternatively, or in addition, the high intensity synthetic sweeteners may be added to an MRP composition comprising reaction products formed in the Maillard reaction.

High intensity synthetic sweeteners are synthetically produced sugar substitutes or sugar alternatives that are similarly many times sweeter than sugar and contribute few to no calories when added to foods. Moreover, they can be similarly used as Maillard reaction components or as flavor enhancers added to MRP compositions of the present application. High intensity synthetic sweeteners include Advantame, Aspartame, Acesulfame potassium (Ace-K), Neotame, Sucralose, and Saccharin.

The inventor has found that Advantame, a non-caloric high intensity synthetic sweetener and aspartame analog, can boost the flavor and taste profile of the compositions disclosed herein, especially when added after Maillard reaction. Generally, Advantame and other high intensity synthetic sweeteners can be added in the range of 0.01 ppm to 100 ppm.

(3) Maillard Reaction Conditions

Maillard reaction conditions are affected by temperature, pressure, pH, reaction times, ratio of different reactants, types of solvents, and solvents-to-reactants ratio. Accordingly, in certain embodiments, the reaction mixture may include a pH regulator, which can be an acid or a base. Suitable base regulators include, for example, sodium hydroxide, potassium hydroxide, baking powder, baking soda any useable food grade base salts including alkaline amino acids. Additionally, the Maillard reaction can be conducted in the presence of alkalinic amino acids without the need of an additional base where the alkaline amino acid serves as the base itself. The pH of the reaction mixture can be maintained at any pH suitable for the Maillard reaction. In certain embodiments, the pH is maintained at a pH of from about 2 to about 14, from about 2 to about 7, from about 3 to about 9, from about 4 to about 8, from about 5 to about 7, from about 7 to about 14, from about 8 to about 10, from about 9 to about 11, from about 10 to about 12, or any pH range derived from these integer values.

In some embodiments, the reaction mixture has a pH of 4, 5, 6, 7, 8 or 9 at the initiation of the Maillard reaction.

In any of the embodiments described in the present application, the reaction temperature in any of the MRP reaction mixtures described in the present application may be 0° C., 5° C., 10° C., 20° C., 25° C., 30° C., 35° C., 40° C., 50° C., 55° C., 60° C., 65° C., 70° C., 80° C., 90° C., 100° C., 110° C., 120° C., 125° C., 130° C., 135° C., 140° C., 150° C., 155° C., 160° C., 165° C., 170° C., 180° C., 190° C., 200° C., 210° C., 220° C., 225° C., 230° C., 235° C., 240° C., 250° C., 255° C., 260° C., 265° C., 270° C., 280° C., 290° C., 300° C., 400° C., 500° C., 600° C., 700° C., 800° C., 900° C., 1000° C., or any temperature range defined by any two temperature values in this paragraph.

In more particular embodiments, the reaction temperature in any of the MRP reaction mixtures described in the present application may range from 0° C. to 1000° C., 10° C. to 300° C., from 15° C. to 250° C., from 20° C. to 250° C., from 40° C. to 250° C., from 60° C. to 250° C., from 80° C. to 250° C., from 100° C. to 250° C., from 120° C. to 250° C., from 140° C. to 250° C., from 160° C. to 250° C., from 180° C. to 250° C., from 200° C. to 250° C., from 220° C. to 250° C., from 240° C. to 250° C., from 30° C. to 225° C., from 50° C. to 225° C., from 70° C. to 225° C., from 90° C. to 225° C., from 110° C. to 225° C., from 130° C. to 225° C., from 150° C. to 225° C., from 170° C. to 225° C., from 190° C. to 225° C., from 210° C. to 225° C., from 80° C. to 200° C., from 100° C. to 200° C., from 120° C. to 200° C., from 140° C. to 200° C., from 140° C. to 200° C., from 160° C. to 200° C., from 180° C. to 200° C., from 90° C. to 180° C., from 100° C. to 180° C., from 110° C. to 180° C., from 120° C. to 180° C., from 130° C. to 180° C., from 140° C. to 180° C., from 150° C. to 180° C., from 160° C. to 180° C., from 80° C. to 160° C., from 90° C. to 160° C., from 100° C. to 160° C., from 110° C. to 160° C., from 120° C. to 160° C., from 130° C. to 160° C., from 140° C. to 160° C., from 150° C. to 160° C., from 80° C. to 140° C., from 90° C. to 140° C., from 100° C. to 140° C., from 110° C. to 140° C., from 120° C. to 140° C., from 130° C. to 140° C., from 80° C. to 120° C., from 85° C. to 120° C., from 90° C. to 120° C., from 95° C. to 120° C., from 100° C. to 120° C., from 110° C. to 120° C., from 115° C. to 120° C., from 80° C. to 100° C., from 85° C. to 100° C., from 90° C. to 100° C., from 95° C. to 100° C.; or any aforementioned temperature value in this paragraph, or a temperature range defined by any pair of the aforementioned temperature values in this paragraph.

Maillard reaction(s) can be conducted either under open or sealed conditions. The reaction time is generally from 1 second to 100 hours, more particularly from 1 minute to 24 hours, from 1 minute to 12 hours, from 1 minute to 8 hours, from 1 minute to 4 hours, from 1 minute to 2 hours, from 1 minute to 1 hour, from 1 minute to 40 minutes, from 1 minute to 20 minutes, from 1 minute to 10 minutes, from 10 minutes to 24 hours, from 10 minutes to 12 hours, from 10 minutes to 8 hours, from 10 minutes to 4 hours, from 10 minutes to 2 hours, from 10 minutes to 1 hour, from 10 minutes to 40 minutes, from 10 minutes to 20 minutes, from 20 minutes to 24 hours, from 20 minutes to 12 hours, from 20 minutes to 8 hours, from 20 minutes to 4 hours, from 20 minutes to 2 hours, from 20 minutes to 1 hour, from 20 minutes to 40 minutes, from 40 minutes to 24 hours, from 40 minutes to 12 hours, from 40 minutes to 8 hours, from 40 minutes to 4 hours, from 40 minutes to 2 hours, from 40 minutes to 1 hour, from 1 hour to 24 hours, from 1 hour to 12 hours, from 1 hour to 8 hours, from 1 hour to 4 hours, from 1 hour to 2 hours, from 2 hour to 24 hours, from 2 hour to 12 hours, from 2 hour to 8 hours, from 2 hour to 4 hours, from 4 hour to 24 hours, from 4 hour to 12 hours, from 4 hour to 8 hours, from 8 hour to 24 hours, from 8 hour to 12 hours, or from 12 hour to 24 hours. Depending on the desired taste, the reaction can be terminated at any time. The Maillard reaction mixture can contain unreacted reactants, degraded substances from the reactants, pH regulator(s), and/or salt(s).

The Maillard reactions can be conducted at atmospheric pressure or under pressure. When conducted under pressure, the reaction mixture may be subjected to constant pressure or it may be subjected to varying pressures over time. In certain embodiments, the pressure in the reaction vessel is at least 10 MPa, at least 20 MPa, at least 30 MPa, at least 40 MPa, at least 50 MPa, at least 75 MPa, at least 100 MPa, at least 150 MPa, at least 200 MPa, at least 250 MPa, at least 300 MPa, at least 400 MPa, at least 500 MPa, at least 600 MPa, at least 700 MPa, at least 800 MPa, and any pressure range derived from the aforementioned pressure values.

In some embodiments, it is desirable to suppress the Maillard reaction, in part. This can be achieved by exercising one or more of the following approaches, including the use of raw materials that are not susceptible to browning, adjusting the factors affecting the browning velocity of Maillard reaction, lowering the temperature, lowering pH, adjusting water activity, increasing the level of oxygen, using oxidant, introducing enzymes, etc.

In certain embodiments, the use of low solubility or insoluble amino acids in the Maillard reaction may result in insoluble reactants present in the final MRP composition. In such cases, filtration may be used to remove any insoluble components present in the MRP compositions.

A general method to prepare derived Maillard reaction product(s) is described as follows. Briefly, an SG or ST extract is dissolved with or without a sugar donor, and together with amino acid donor in water, followed by heating of the solution at an elevated temperature, for example from about 50 to about 200 degrees centigrade. The reaction time can be varied from more than one second to a few days, more generally a few hours, until Maillard reaction products (MRPs) are formed or the reaction components have been exhausted or the reaction has been completed, with or without formation of caramelization reaction products (CRPs), which are further described below. When required, a pH adjuster or pH buffer can be added to regulate the pH of the reaction mixture before, during or after reaction as further described herein. The resultant solution is dried by spray dryer or hot air oven to remove the water and to obtain the MRP(s).

When the reaction is completed, the product mixture does not need to be neutralized or it can be neutralized. Water and/or solvent(s) do not necessarily need to be removed but can be removed by distillation, spray drying or other known methods if the product is desired as a powder or liquid, whatever the case may be.

Interestingly, when a reaction mixture is dried to a powder, such as by spray drying, the resultant powders only have a slight smell associated with them. This is in contrast to regular powdered flavoring agents that generally have a strong smell. The dried powdered reaction mixtures of the embodiments, when dissolved in a solvent, such as water or alcohol or mixtures thereof, release the smell. This demonstrates that the volatile substances in the MRPs can be preserved by SEs, SGs, STGs, STEs and/or STCs present in the reaction products and compositions of the present application. Powders with strong aroma can be obtained too, particularly where the carrier, such as STE, is much less compared with MRPs flavors or strong flavor substances are used during Maillard reaction.

In some embodiments, the MRP mixtures may further include one or more carriers (or flavor carriers) acceptable for use with sweetening agents or flavoring agents. In addition, such carriers may be suitable e.g., as solvents for the Maillard reaction.

Exemplary carriers include acetylated distarch adipate, acetylated distarch phosphate, agar, alginic acid, beeswax, beta-cyclodextrine, calcium carbonate, calcium silicate, calcium sulphate, candelilla wax, carboxymethyl cellulose, sodium salt, carnauba wax, carrageenan, microcrystalline cellulose, dextran, dextrin, diammonium phosphate, distarch phosphate, edible fats, elemi resin, ethyl lactate, ethyl cellulose, ethyl hydroxyethyl cellulose, ethyl tartrate, gelatin, gellan gum, ghatti gum, glucose, glyceryl diacetate, glyceryl diesters of aliphatic fatty acids C6-C18, glyceryl monoesters of aliphatic fatty acids C6-C18, glyceryl triacetate (triacetin), glyceryl triesters of aliphatic fatty acids C6-C18, glyceryl tripropanoate, guar gum, gum arabic, hydrolyzed vegetable protein, hydroxypropylmethyl cellulose, hydroxypropyl cellulose, hydroxypropyl distarch phosphate, hydroxypropyl starch, karaya gum, konjac gum, lactic acid, lactose, locust bean gum (carob bean gum), magnesium carbonate, magnesium salts of fatty acids, maltodextrin, methyl cellulose, medium chain triglyceride, modified starches, such as acetylated distarch adipate, acetylated oxidized starch, acid-treated starch, alkaline treated starch, bleached starch, roasted starch dextrins, distarch phosphate, hydroxypropyl distarch phosphate, acetylated distarch phosphate, hydroxypropyl starch, monostarch phosphate, oxidized starch, phosphated distarch phosphate, starch acetate, starch sodium octenyl succinate, and enzyme treated starches; mono-, di- and tri-calcium orthophosphate, Na, K, NH4 and Ca alginate, pectins, processed euchema seaweed, propylene glycol alginate, sodium chloride (salt), silicon dioxide, sodium aluminium diphosphate, sodium aluminium silicate, Sodium, potassium and calcium salts of fatty acids, starch, starch (sodium) octenyl succinate, starch acetate, sucro glycerides, sucrose, sucrose esters of fatty acids, type I and type II sucrose oligoesters, taragum, tragacanth, triethylcitrate, whey powder, xanthan gum, fibers such as non-starch polysaccharides, lignin, cellulose, methylcellulose, the hemicelluloses, 3-glucans, mucilage, inulins, oligosaccharides, polydextrose, fructooligosaccharides, cyclodextrins, chitins, and combinations thereof, and thickeners such as carbomers, cellulose base materials, gums, waxes, algin, agar, pectins, carrageenan, gelatin, mineral or modified mineral thickeners, polyethylene glycol and polyalcohols, polyacrylamide and other polymeric thickeners, and combinations thereof.

When utilizing the MRP compositions for use in a sweetening or flavoring composition, one or more additional components may be added to the MRP composition after the Maillard reaction has occurred. These additional components include flavoring substances. Moreover, the reaction products after the Maillard reaction has been completed can further include, for example, one or more sweetening agents, reducing sugars (i.e., residue sugar donors), amine donors, sweetener enhancers, and CRPs, as well as one or more degraded sweetening agents, degraded sugar donors, degraded amine donors, and salts.

It should also be understood, for example, that the Maillard reaction can be performed under conditions containing an excess of amine donors in comparison to reducing sugars or much less than the amount of reducing sugars present. In the first instance, the resultant MRPs would include unreacted amine donors, degraded amine donors and/or residues from reacted amine donors. Conversely, when there is an excess of reducing sugars present in the Maillard reaction, the amine donors would be more fully reacted during the course of the reaction and a greater amount of unreacted reducing sugars as well as degraded reducing sugars and/or degrading reducing sugars and residues therefrom. Surprisingly, where the reducing sugar is replaced with a sweetening agent (e.g., a material such as a STE that does not include a reactive aldehydic or ketone moiety) and reacted with one or more amine donors, the amine donors may be present in the reaction products in reduced amounts reflecting their consumption in the Maillard type reaction or there excess of amine donors, as well as amine donor residues and/or amine degradation products after the Maillard reaction has been completed.

There are many ways to control the resulting MRPs. For instance, adjusting the pH, pressure, reaction time, and ingredient additions to optimize the ratio of raw materials etc. Further, the separation of MRPs products can provide a means for preparing different types of flavors or flavor enhancers. For example, MRPs include both volatile substances and non-volatile substances. Therefore, by evaporating the volatile substances, non-volatile substances can be purified for use. These non-volatile substances (or products) can be used as flavor modifiers or with the top note flavor in final products, such as volatile peach, lemon flavor provided by traditional flavor houses.

Volatile substances can be used as flavor or flavor enhancers as well. Partial separation of MRPs can be carried out to obtain volatile substances, which can be further separated by distillation etc. or obtain non-volatile substances for instance by recrystallization, chromatograph etc. could be done to meet different targets of taste and flavor. Therefore, in this specification, MRPs include a composition including one or more volatile substances, one or more non-volatile substances or mixtures thereof. Non-volatile substances in MRPs or isolated from MRPs can provide a good mouth feel, umami and Kokumi taste.

(4) Use of Raw Materials, Such as Fruit Juices, in Maillard Reaction

(A) Raw Materials in MRP Reactions and/or MRP-Containing Composition

In some embodiments, the reactants for the Maillard reaction include a number of different raw materials for producing MRP compositions. The raw materials may be categorized into the following groups comprising the following exemplary materials:

1) Protein Nitrogen Sources:

Protein nitrogen containing foods (meat, poultry, eggs, dairy products, cereals, vegetable products, fruits, yeasts), extracts thereof and hydrolysis products thereof, autolyzed yeasts, peptides, amino acids and/or their salts.

2) Carbohydrate Sources:

Foods containing carbohydrates (cereals, vegetable products and fruits) and their extracts; mono-, di- and polysaccharides (sugars, dextrins, starches and edible gums), and hydrolysis products thereof

3) Fat or Fatty Acid Sources:

Foods containing fats and oils, edible fats and oil from animal, marine or vegetable origin, hydrogenated, trans-esterified and/or fractionated fats and oils, and hydrolysis products thereof.

4) Miscellaneous List of Additional Ingredients:
Foodstuffs, herbs, spices, their extracts and flavoring agents identified therein
Water
Thiamine and its hydrochloric salt
Ascorbic, Citric, Lactic, Fumaric, Malic, Succinic, Tartaric and the Na, K, Ca, Mg and NH4 salts of these acids
Guanylic acid and inosinic acid and its Na, K and Ca salts
Inositol
Sodium, potassium and ammonium sulphides, hydrosulphides and polysulphides
Lecithin
Acids, bases and salts as pH regulators:
Acetic, hydrochloric, phosphoric and sulphuric acids
Sodium, potassium, calcium and ammonium hydroxide.
Salts of the above acids and bases
Polymethylsiloxane as antifoaming agent.

In another aspect, the present application contemplates the use of any one of a number of raw materials exemplified below to produce NATURAL PRODUCTS:

Sugar Syrups: Xylose syrup, arabinose syrup and rhamnose syrup manufactured from beech wood. Ardilla Technologies supply these along with natural crystalline L-xylose, L-arabinose and L-rhamnose. Xylose syrup may also be obtained from natural sources, such as the xylan-rich portion of hemicellulose, mannose syrup from ivory nut, etc. These and other types of syrup described herein can be used as sugar donors in the compositions described herein.

Hydrolyzed gum arabic: Thickeners, such as gum arabic can be hydrolyzed with an organic acid or by enzyme hydrolysis to produce a mixture containing arabinose. Arabinose could also be obtained from other wood-based or biomass hydrolysate. Cellulose enzymes can also be used.

Meat Extracts: Commercially available from a number of companies, such as Henningsens (Chicken skin and meat), which gives excellent chicken notes.

Jardox: Meat and poultry extracts and stocks.

Kanegrade: Fish powders, anchovy, squid, tuna and others.

Vegetable Powders: onion and garlic powders, celery, tomato and leek powders are effective flavor contributors to reaction flavors.

Egg Yolk: Contains 50% fat and 50% protein. The fat contains phospholipids and lecithin. The proteins are coagulating proteins and their activity must be destroyed by hydrolysis with acid or by the use of proteases prior to use. This will also liberate amino acids and peptides useful in reaction flavors (Allergen activity).

Vegetable oils: Peanut (groundnut) oil—Oleic acid 50%, Linoleic acid 32%—beef and lamb profile. Sunflower—linoleic acid 50—75%, oleic 25%—chicken profile. Canola (rapeseed)—oleic 60%, linoleic 20%, alpha-linoleic 10%, gadoleic 12%.

Sauces: Fish sauce, soy sauce, oyster sauce, miso.

Enzyme Digests: Beef heart digest—rich in phospholipids. Liver digest—at low levels <5% gives a rich meaty character. Meat digests can also add authenticity but they are usually not as powerful as yeast extracts and HVPs.

Enzyme enhanced umami products—shitake or porcini mushrooms, kombu, etc. Enzyme digested fats—beef, lamb, etc.

All of the components of the compositions disclosed herein can be purchased or made by processes known to those of ordinary skill in the art and combined (e.g., precipitation/co-precipitation, mixing, blending, grounding, mortar and pestle, microemulsion, solvothermal, sonochemical, etc.) or treated as defined by the current invention.

(B) Fruit Juice

Reducing sugars can be derived from various sources for use as a sugar donor in the Maillard reaction or as a component added to an MRP composition. For example, a sugar syrup may be extracted from a natural source, such as Monk fruit, fruit juice or juice concentrate (e.g., grape juice, apple juice, etc.), vegetable juice (e.g., onion etc.), or fruit (e.g., apples, pears, cherries, etc.), could be used as sugar donor. Such a syrup may include any type of juice regardless whether there is any ingredient being isolated from juice, such as purified apple juice with trace amount of malic acid etc. The juice could be in the form of liquid, paste or solid. Reducing sugars may also be extracted from Stevia, sweet tea, luohanguo, etc. after isolation of high intensity sweetening agents described herein (containing non-reducing sugars) from crude extracts and mixtures thereof. Extract from any part of plant containing reduced sugar could be used as sugar donor in Maillard reaction with or without other additional reduced sugar. An embodiment of composition of Maillard Reaction Products prepared by using plant extract as sugar donor.

(C) Extract Used as Flavor to Blend with Current Invention

Sugar reduced, fat reduced and salt reduced food and beverage lack of freshness, taste and flavor compared with their conventional full sugar, full fat and full salt versions. The inventor surprisingly found adding the plant extracts containing less-volatile or non-volatile substances from flavor sourced plants instead of essential oil or volatile flavors could significantly improve the freshness, characteristic flavor of food and beverage. An embodiment of a composition comprises: a) one or more component selected from STC, STE, STG, GSTC, GSTE, GSTG, ST-MRP, G-ST-MRP; b) a plant extracts containing less-volatile or non-volatile substances. An further embodiments of composition, where b) a plant extract is selected from vanilla extract, mango extract, cinnamon extract, citrus extract, coconut extract, ginger extract, viridiflorol extract, almond extract, bay extract, thyme extract, cedar leaf extract, nutmeg extract, allspice extract, sage extract, mace extract, mint extract, clove extract, grape juice concentrate, apple juice concentrate, banana juice concentrate, watermelon juice concentrate, pear juice concentrate, peach juice concentrate, strawberry juice concentrate, raspberry juice concentrate, cherry concentrate, plum concentrate, pineapple concentrate, apricot concentrate, lemon juice concentrate, lime juice concentrate, orange juice concentrate, tangerine juice concentrate, grapefruit concentrate or any other fruit, berry, tea, vegetable, cocoa, chocolate, spices, herbs concentrate.

D. SEs, SGs, GSEs, GSGs, Stevia-MRPs and Conventional MRPs.

In some embodiments, the sweetener or flavoring agent composition of the present application comprises (A) a sweet tea extract (STEs) or at least one sweet tea component (STC), (B) a glycosylated STE (GSTE) or at least one glycosylated STC (GSTC), and/or (C) one or more ST-MRPs and/or G-ST-MRPs, and further comprises (D) one or more component selected from the group consisting of SEs, SGs, GSEs, GSGs, Stevia-MRPs and conventional MRPs.

In some embodiments, the sweetener or flavoring agent composition comprises RA, RB, RC, RD, RE, RI, RM, RO or any combinations thereof are used. Example combinations include, but are not limited to, RA+RB, RA+RC, RA+RD, RA+RE, RA+RI, RA+RM, RA+RO, RB+RC, RB+RD, RB+RE, RB+RI, RB+RM, RB+RO, RC+RD, RC+RE, RC+RI, RC+RM, RC+RO, RD+RE, RD+RI, RD+RM, RD+RO, RE+RI, RE+RM, RE+RO, RI+RM, RI+RO, RM+RO, RA+RB+RD, RA+RB+RC, RA+RB+RI, RA+RB+RE, RA+RD+RM, RA+RB+RC+RD, RD+RM+RO+RE RA+RB+RC+RD+RE and RA+RB+RC+RD+RM.

In some embodiments, the sweetener or flavoring agent composition of the present application comprises one or more stevia extracts (SEs) or glycosylated SEs (GSEs). Extracts from Stevia leaves, for example, provide SGs with varying percentages corresponding to the SGs present in a particular extract. A Stevia extract may contain various combinations of individual SGs, where the extract may be defined by the proportion of a particular SG in the extract.

As used herein, the phrase “total steviol glycosides” refers to the total amount (w/w %) of different SGs and/or GSGs in a composition, unless specific groups of SGs or GSGs are measured in the examples. Further, the acronym of the type “YYxx” is used herein with reference to an SG composition or GSG composition formed therefrom, where YY refers to a given (such as RA) or collection of compounds (e.g., SGs), where “xx” is typically a percent by weight number between 1 and 100 denoting the level of purity of a given compound (such as RA) or collection of compounds, where the weight percentage of YY in the dried product is equal to or greater than xx. The acronym “YYxx+WWzz” refers to a composition, where each one of “YY” and “WW” refers to a given compound (such as RA) or a collection of compounds (e.g., SGs), and where each of “xx” and “zz” refers to a percent by weight number between 1 and 100 denoting the level of purity of a given compound (such as RA) or a collection of compounds, where the weight percentage of YY in the dried product is equal to or greater than xx, and where the weight percentage of WW in the dried product is equal to or greater than zz.

The acronym “RAx” refers to a Stevia composition containing RA in amount of ≥x % and <(x+10)% with the following exceptions: the acronym “RA100” specifically refers to pure RA; the acronym “RA99.5” specifically refers to a composition where the amount of RA is ≥99.5 wt %, but <100 wt %; the acronym “RA99” specifically refers to a composition where the amount of RA is ≥99 wt %, but <100 wt %; the acronym “RA98” specifically refers to a composition where the amount of RA is ≥98 wt %, but <99 wt %; the acronym “RA97” specifically refers to a composition where the amount of RA is ≥97 wt %, but <98 wt %; the acronym “RA95” specifically refers to a composition where the amount of RA is ≥95 wt %, but <97 wt %; the acronym “RA85” specifically refers to a composition where the amount of RA is ≥85 wt %, but <90 wt %; the acronym “RA75” specifically refers to a composition where the amount of RA is ≥75 wt %, but <80 wt %; the acronym “RA65” specifically refers to a composition where the amount of RA is ≥65 wt %, but <70 wt %; the acronym “RA20” specifically refers to a composition where the amount of RA is ≥15 wt %, but <30 wt %. Stevia extracts include, but are not limited to RA20, RA40, RA50, RA60, RA80, RA 90, RA95, RA97, RA98, RA99, RA99.5, RB8, RB10, RB15, RC15, RD6, and combinations thereof.

The acronym “GSG-RAxx” refers to a GSG composition prepared in an enzymatically catalyzed glycosylation process with RAxx as the starting SG material. More generally, acronyms of the type “GSG-YYxx” refer to a composition of the present application where YY refers to a compound (such as RA, RB, RC, RD, RE, RI and RM), or a composition (e.g., RA20), or a mixture of compositions (e.g., RA40+RB8). For example, GSG-RA20 refers to the glycosylation products formed from RA20.

In some embodiments, the one or more SGs are selected from the group consisting of RA, RB, RD, RE, RI, RM, RN and RO. SGs may further include non-steviol glycoside components. Certain non-steviol glycoside components are volatile substances characterized by a characteristic aroma and/or flavor, such as a citrus flavor and other flavors described herein. In addition, SGEs may include certain non-volatile types of non-steviol glycoside substances comprising one or more molecules characterized by terpene, di-terpene, or ent-kaurene structure.

Accordingly, in some embodiments, the SEs, SGs, GSEs and/or GSGs may include one or more volatile and/or one or more non-volatile types of non-steviol glycoside substances.

In some embodiments, the SEs can be fractionated to select for high molecular weight molecules.

In a particular embodiment, the SE comprises 25-35 wt % Reb-A, 0.4-4 wt % Reb-B, 5-15 wt % Reb-C, 1-10 wt % Reb-D, 2-5 wt % Reb-F, 1-5 wt % Reb-K, and 20-40 wt % Stevioside.

In another embodiment, the SE comprises one or more members selected from the group consisting of 1-5 wt % Rubusoside, 1-3 wt % Dulcoside A, 0.01-3 wt % steviolbioside, 0.2-1.5 wt % Dulcoside B, 00.01-2 wt % Reb-O, 0.01-2 wt % Reb-S, 0.01-1.2 wt % Reb-T, 0.01-0.8 wt % Reb-R, 0.01-0.7 wt % Reb-J, 0.01-0.7 wt % Reb-W, 0.01-0.7 wt % Reb-V, 0.01-0.6 wt % Reb-V2, 0.01-0.5 wt % Reb-G, 0.01-0.5 wt % Reb-H, 0.01-0.5 wt % Reb-K2, 0.01-0.5 wt % Reb-U2, 0.01-0.5% Reb-I, 0.01-0.5 wt % Rel SG #4, 0.01-0.5 wt % Rel SG #5, 0.01-0.4 wt % Reb-M, 0.01-0.4 wt % Reb-N, 0.01-0.4 wt % Reb-E, 0.01-0.4 wt % Reb-F1, 0.01-0.4 wt % Reb-Y, and combinations thereof.

In another embodiment, the SE comprises at least 20, at least 21, at least 22, at least 23 or at least 24 members selected from the group consisting of: 1-5 wt % Rubusoside, 1-3 wt % Dulcoside A, 0.01-3 wt % steviolbioside, 0.2-1.5 wt % Dulcoside B, 00.01-2 wt % Reb-O, 0.01-2 wt % Reb-S, 0.01-1.2 wt % Reb-T, 0.01-0.8 wt % Reb-R, 0.01-0.7 wt % Reb-J, 0.01-0.7 wt % Reb-W, 0.01-0.7 wt % Reb-V, 0.01-0.6 wt % Reb-V2, 0.01-0.5 wt % Reb-G, 0.01-0.5 wt % Reb-H, 0.01-0.5 wt % Reb-K2, 0.01-0.5 wt % Reb-U2, 0.01-0.5% Reb-I, 0.01-0.5 wt % Rel SG #4, 0.01-0.5 wt % Rel SG #5, 0.01-0.4 wt % Reb-M, 0.01-0.4 wt % Reb-N, 0.01-0.4 wt % Reb-E, 0.01-0.4 wt % Reb-F1, and 0.01-0.4 wt % Reb-Y.

In another embodiment, the SE comprises 45-55 wt % Reb-A, 20-40 wt % Stevioside, 2-6 wt % Reb-C, 0.5-3 wt % Reb-B, and 0.5-3 wt % Reb-D.

In another embodiment, the SE comprises one or more members selected from the group consisting of: 0.1-3 wt % Related SG #5, 0.05-1.5 wt % Reb-R1, 0.0.05-1.5 wt % Reb-K2, 0.05-1.5 wt % Reb-E, 0.01-1 wt % Dulcoside A, 0.01-1 wt % Dulcoside B, 0.01-1 wt % Rubusoside, 0.01-1 wt % Steviolbioside, 0.01-1 wt % Iso-steviolbioside, 0.01-1 wt % Stevioside-B, 0.01-1 wt % Related SG #3, 0.01-1 wt % Related SG #2, 0.01-1 wt % Reb-G, 0.01-1 wt % Reb-F, and 0.01-1 wt % Reb-W.

In another embodiment, the SE includes at least 12, at least 13, at least 14 or at least 15 members selected from the group consisting of: 0.1-3 wt % Related SG #5, 0.05-1.5 wt % Reb-R1, 0.0.05-1.5 wt % Reb-K2, 0.05-1.5 wt % Reb-E, 0.01-1 wt % Dulcoside A, 0.01-1 wt % Dulcoside B, 0.01-1 wt % Rubusoside, 0.01-1 wt % Steviolbioside, 0.01-1 wt % Iso-steviolbioside, 0.01-1 wt % Stevioside-B, 0.01-1 wt % Related SG #3, 0.01-1 wt % Related SG #2, 0.01-1 wt % Reb-G, 0.01-1 wt % Reb-F, and 0.01-1 wt % Reb-W.

In another embodiment, the SE includes 35-45 wt % Reb-A, 10-25 wt % Stevioside, 4-12 wt % Reb-B, 4-12 wt % Dulcoside A, 0.5-4 wt % Reb-C, and 0.1-4 wt % Reb-O.

In another embodiment, the SE includes one or more members selected from the group consisting of: 0.3-3 wt % Rubusoside, 0.1-3 wt % Reb-D, 0.1-3 wt % Reb-G, 0.1-3 wt % Reb-I, 0.1-3 wt % Stevioside B, 0.1-3 wt % Related SG #3, 0.05-1.5 wt % Reb-E, 0.05-2 wt % Reb-R, 0.05-1 wt % Dulcoside B, 0.01-1 wt % Reb-N, 0.01-1 wt % Reb-Y, 0.01-1 wt % Steviolbioside, 0.01-1 wt % Dulcoside B, and combinations thereof.

In another embodiment, the SE includes at least 10, at least 11, at least 12 or at least 13 members selected from the group consisting of: 0.3-3 wt % Rubusoside, 0.1-3 wt % Reb-D, 0.1-3 wt % Reb-G, 0.1-3 wt % Reb-I, 0.1-3 wt % Stevioside B, 0.1-3 wt % Related SG #3, 0.05-1.5 wt % Reb-E, 0.05-2 wt % Reb-R, 0.05-1 wt % Dulcoside B, 0.01-1 wt % Reb-N, 0.01-1 wt % Reb-Y, 0.01-1 wt % Steviolbioside, and 0.01-1 wt % Dulcoside B.

Much like the case with the GSTEs and GSTCs described above, GSGs and GSEs can be similarly obtained by synthetic manipulation or by enzymatic processes to produce both naturally occurring and non-naturally occurring GSGs. Exemplary GSGs of the present application include Stevioside G1 (ST-G1), Stevioside G2 (ST-G2), Stevioside G3 (ST-G3), Stevioside G4 (ST-G4), Stevioside G5 (ST-G5), Stevioside G6 (ST-G6), Stevioside G7 (ST-G7), Stevioside G8 (ST-G8), Stevioside G9 (ST-G9), Rebaudioside A G1 (RA-G1), Rebaudioside A G2 (RA-G2), Rebaudioside A G3 (RA-G3), Rebaudioside A G4 (RA-G4), Rebaudioside A G5 (RA-G5), Rebaudioside A G6 (RA-G6), Rebaudioside A G7 (RA-G7), Rebaudioside A G8 (RA-G8), Rebaudioside A G9 (RA-G9), Rebaudioside B G1 (RB-G1), Rebaudioside B G2 (RB-G2), Rebaudioside B G3 (RB-G3), Rebaudioside B G4 (RB-G4), Rebaudioside B G5 (RB-G5), Rebaudioside B G6 (RB-G6), Rebaudioside B G7 (RB-G7), Rebaudioside B G8 (RB-G8), Rebaudioside B G9 (RB-G9), Rebaudioside C G1 (RC-G1), Rebaudioside C G2 (RC-G2), Rebaudioside C G3 (RC-G3), Rebaudioside C G4 (RC-G4), Rebaudioside C G5 (RC-G5), Rebaudioside C G6 (RC-G6), Rebaudioside C G7 (RC-G7), Rebaudioside C G8 (RC-G8), Rebaudioside C G9 (RC-G9), Rebaudioside D G1, Rebaudioside D G2, Rebaudioside D G3, Rebaudioside D G4, Rebaudioside D G5, Rebaudioside D G6, Rebaudioside D G7, Rebaudioside D G8, Rebaudioside D G9, Rebaudioside E G1, Rebaudioside E G2, Rebaudioside E G3, Rebaudioside E G4, Rebaudioside E G5, Rebaudioside E G6, Rebaudioside E G7, Rebaudioside E G8, Rebaudioside E G9, Rebaudioside F G1, Rebaudioside F G2, Rebaudioside F G3, Rebaudioside F G4, Rebaudioside F G5, Rebaudioside F G6, Rebaudioside F G7, Rebaudioside F G8, Rebaudioside F G9, Rebaudioside M G1, Rebaudioside M G2, Rebaudioside M G3, Rebaudioside E G4, Rebaudioside M G5, Rebaudioside M G6, Rebaudioside M G7, Rebaudioside M G8, Rebaudioside M G9, Rubusoside G1, Rubusoside G2, Rubusoside G3, Rubusoside G4, Rubusoside G5, Rubusoside G6, Rubusoside G7, Rubusoside G8, Rubusoside G9, Dulcoside A G1, Dulcoside A G2, Dulcoside A G3, Dulcoside A G4, Dulcoside A G5, Dulcoside A G6, Dulcoside A G7, Dulcoside A G8, Dulcoside A G9.

Examples of GSEs including GSG-RA20, GSG-RA30, GSG-RA40, GSG-RA50, GSG-RA60, GSG-RA70, GSG-RA80, GSG-RA90, GSG-RA95, GSG-RA97, GSG-(RA50+RB8), GSG-(RA30+RC15), and GSG-(RA40+RB8). GSG-RA20 is typically prepared from RA20 as a key starting material, GSG-RA30 is typically prepared from RA30 as a key starting material, GSG-RA40 is typically prepared from RA40 as a key starting material, GSG-RA50 is typically prepared from RA50 as a key starting material, GSG-RA60 is typically prepared from RA60 as a key starting material, GSG-RA70 is typically prepared from RA70 as a key starting material, GSG-RA80 is prepared from RA80 as the key starting material, GSG-RA90 is typically prepared from RA90 as a key starting material, GSG-RA95 is typically prepared from RA95 as a key starting material, and GSG-RA97 is prepared from RA97 as a key starting material.

In some embodiments, the sweetener or flavoring agent composition of the present application comprises one or more SGs, SEs, GSGs, GSEs, Stevia-MRPs and/or C-MRPs in the amount of 1% wt/wt, 2% wt/wt, 3% wt/wt, 4% wt/wt, 5% wt/wt, 6% wt/wt, 7% wt/wt, 8% wt/wt. 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt or 99% wt/wt, or any range encompassed by any pair of the foregoing integer values.

In some embodiments, the sweetener or flavoring agent composition of the present application comprises one or more SGs, SEs, GSGs, GSEs, Stevia-MRPs and/or C-MRPs in the amount of less than 80% wt/wt, 70% wt/wt, 60% wt/wt, 50% wt/wt, 40% wt/wt, 30% wt/wt, 20% wt/wt, 10% wt/wt or 5% wt/wt.

In some embodiments, the sweetener or flavoring agent composition of the present application comprises one or more SGs, SEs, GSGs, GSEs, Stevia-MRPs and/or C-MRPs in the amount of 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, from about 10% wt/wt to about 20% wt/wt, from about 20 to less than about 50 percentage by weight, from about 30 to less than about 50 percentage by weight, from about 40 to less than about 50 percentage by weight, and from about 20 to 45 percentage by weight of the of the sweetener or flavoring agent composition.

### III. Rationale for the Subject Matter of the Present Application

Memories of taste and flavor are sequential and in order. They can be accessed in the order that they are remembered. Like Marcel Proust wrote in his book, human beings are unable to directly reverse the sequence of a memory. Each sensory characteristic of taste and flavor of consumables is remembered as an elaborate hierarchy of nested activities.

Consumers are constantly predicting the future and hypothesizing what we will experience in taste and smell. This expectation influences what we actually perceived from consumables. Consumers' conscious experience of perceptions is actually changed by their interpretations. Consumers can recognize a pattern of taste and flavor of consumables even if only part of it is perceived and even if it contains alterations. Consumers' recognition ability is apparently able to detect invariant features of a pattern-characteristics that survive real-world variations. Segmenting the temporal sequence and size of the tasting decision, this implicates familiar tastes and smells that spark the memory and allows a taster's attention to focus on expected familiar tastes and flavors of consumables, particular those where the perception is positive.

The present application provides compositions and methods for providing the major components of flavor playing crucial roles in recognition of flavor by simultaneous activation of millions of pattern recognitions for a given flavor. As each input from a low-level recognition of taste and flavor from a consumable flows up to a higher level, the perceptional connection can be weighted to provide an indication of how important that particular element in the pattern is. Thus, the more significant elements of pattern recognition for flavors are more heavily weighted in the context of triggering recognition by the taster. If a particular level is unable to fully process and recognize the taste and flavor, the task of recognition would be sent to the next higher level. If none of the levels succeeds in recognizing the pattern of taste and flavor of consumables, it is deemed to be a new pattern of taste and flavor.

Classifying a pattern of taste and flavor as new does not necessarily mean that every aspect of it is new. A person's brain has evolved to save energy when making recognition decisions of taste and flavor. The earlier the flavor is recognized at low-level pattern recognizer, the less energy would be spent for brain for recognition. The present application provides a method to accelerate the speed of recognition of a taste and flavor in consumable, thus increases the palatability. Thalamus is considered a gateway for collecting and preparing sensory information of consumable to enter the neocortex. The neocortex is responsible for sensory perception. Hundreds of millions of pattern recognizers of taste and flavor in the neocortex to be constantly checking in with the thalamus. Neocortex will determine whether a sensory experience of taste and flavor is novel or not in order to present it to the hippocampus. The present application provides a composition containing many familiar pattern of substances which are able to be recognized at low-level of recognizer. An embodiment of current composition is used for treatment of consumers who suffer from memories losses by ingesting the consumable containing composition in this invention to evoke their memories by the familiar taste and flavors.

The inventors have surprisingly found that compositions in this invention could be used for enhance the umami attribute of consumable. A particular aspect of what makes umami delicious is aftertaste of consumables. Umami develops over a different time frame than do saltiness and sourness, which disappear quite quickly. Umami persists for longer than all the other basic tastes. This lingering aftertaste is probably one of the reasons why consumers associate umami with deliciousness and something pleasant. It is a taste sensation with fullness and roundness that completely permeates the oral cavity and then dissipates very slowly.

The enhanced umami by this invention could successfully mask the unpleasant taste of low sugar, low fat and low salt consumables. The receptors for sweetness are closely related to the receptors for umami taste. Without bound by the theory, the inventor found there is strong synergy between umami taste substances such as MSG, 5′ribonucleotides (such as IMP, GMP). An embodiment of composition containing umami substances which could increase palatability of high intensity sweeteners. Alanine also play a role for umami except MSG. Alapyridaine enhances not only the umami tastes, but also strengthens the sweet and salty tastes. An embodiment of composition of the present application comprises alapyridaine.

Oligosaccharides are carbohydrate chains containing 3-10 sugar units. Oligosaccharides can be made of any sugar monomers, such as ADMO s (algae derived marine oligosaccharide)AOS(Arabino-oligosaccharides), COS (Chitooligosaccharides), FOS (Fructooligosaccharides), GOS (Galactooligosaccharides), HMO (Human milk oligosaccharides), MAOS (Mannan oligosaccharides), MOS (Maltooligosaccharides), POS (Pectic oligosaccharides), SOS (Soya-oligosaccharides), TOS (Transgalactosylated oligosaccharides), XOS(Xylooligosaccharides). Oligosaccharides normally have mild sweet taste, lower viscosity, moisturizing, low water activity. Adding oligosaccharides in the composition of this invention could improve the sweet taste of composition, such as creating honey flavored sweet and flavor composition. When using the composition containing in this invention, it could block the crystallization of ice creams etc., thus provide improved taste and flavor of consumables. An embodiment of composition comprises oligosaccharides.

When ingesting consumables, trigeminal sensation instead of taste buds on the tongue and olfactory bulb cells gets the first impression of taste sensation such as sourness, salty, sweetness of consumables. There are many research about synergy between taste and flavor. The inventor surprisingly found that trigeminal sensation has strong interaction with taste and flavor. There are many compounds present in many foods or aromatic spices creates trigeminal stimuli, such as substances present in mustard oil, chili peppers, or horseradish, are responsible for pungency. Other trigeminal stimuli such as menthol or eucalyptol are also responsible for cooling sensations. Astringency is another trigeminal sensation, described as a dry mouthfeel that is generated by particular foods (unripe fruits) or drinks (tea or red wine), which are rich in polyphenolic compounds such as tannins. An embodiment of a method to use trigeminal stimuli to improve the taste and flavor of consumables, especially consumables with less sugar, less fat, and less salt. An embodiment of composition of a sweetener or a flavor comprises (a) one or more substances selected from SGs, GSGs, STC, GSTC, GSG-MRP, GSTC-MRP, MG, GMSG and(b) trigeminal stimuli substances.

Trigeminal stimuli substances plays the big role for mouth-feel, especially mouth contracting and mouth drying. Mouthfeel could be classified into three categories: Mouth coating, mouth contracting, and mouth dry. Mouth coating is one type of mouthfeel. The word coating is chosen because these elements leave a thin layer behind in the mouth. Saliva becomes thicker, more viscous. Mouth coating is related strongly to texture of consumable. Compared with mouth coating, mouth contracting is another type of mouthfeel. Mouth contracting is the sematic trigeminal sensation, it has no or less relation with texture of consumables in mouth. Acidity, salty and all kinds of irritation (pepper, mustard, horse radish, ginger) cause contraction in the mouth, it is called mouth contracting. Just as carbonic acid (CO2) does in a variety of drinks, such as mineral water, sparkling wines, beer and soda. Light, fresh white and red wines with a nice acidity are examples of ‘contracting’ drinks. A low temperature also makes the mouth contract. This implies that serving temperature influences mouthfeel (and flavor intensity as we will see). Contraction gives the impression of refreshment, of cleansing the mouth. Contracting elements will often stimulate saliva flow. An embodiment of composition in this invention improves the mouth-contracting of consumables.

As one of main attribute of mouth contracting, freshness stands for the property of being pure and fresh (as if newly made) of consumable. From a sensory point of view perception of freshness is a multi-sensory decision process. Freshness cannot be perceived by single taste receptors nor is it represented by a single stimulus of somatosensory neurons. Freshness can be triggered on a perceptual level and is an important part of the sensory characteristics of a product (smell, taste, mouth-feeling, cognitive mechanisms and psychophysiological factors). Semantic and perceptual information is processed concomitantly, inter-connected and each other influencing. The processing involves a continuous context-based alignment with information stored in our memory. At the end of the processing stands a decision whether or not freshness is perceived.

Freshness perception is mandatory to generate a refreshing feeling that is associated positively in the memory with freshness. Fresh fruits are a good model to comprehend the perceived freshness and the refreshing feeling (i.e. apple, orange). Freshness is not necessarily associated with refreshing (i.e., fresh bread, fresh fish) but in case of beverages, especially fruit based ones, refreshing feeling is in most cases the ultimate target to achieve. A refreshing feeling is connected to the positive experiences of alleviating unpleasant symptoms in the mouth and throat (dry mouth, thirst) as consequence of feeling hot, of exercise or of mental fatigue. An embodiment of composition in this invention improves the freshness of consumables and make quicker recognition of flavor.

Quick sweet and or freshness perception are important contributors to a consumer's “hedonic preference”. A complicated and long lasting sensory decision making process to recognize a taste or a flavor triggers failure search and defect analysis (lower overall quality rating).

The quick sweet and or freshness decision depends on the combination of sensory signals and their fit with our acquired perception of freshness. The clearer and the easier recognizable a set of signals appears, the quicker and easier our brain can decide in favor of good sweet and or freshness perception, the less attention to be paid to other attributes of sensory perception. Ambiguity in a set of signals prevents a quick decision making process. A set of unclear and/or unrecognized sensory signals triggers uncertainty in our brain. This uncertainty is either interpreted as “not recognizable” or yields a decision telling us “similar to . . . with following defects” with psychological attention.

Quick and early recognition of a taste and or a flavor is not only of major importance for the sweet and or freshness decision. Our brain tends to stop further considerations once a decision is made (evolutionary useful feature as thinking costs a lot of energy). With other words, once a familiar sweet or freshness decision is made, sensory attributes will no more followed up making failure responses or defect analysis much less probable than in cases where it took long time to recognize a taste or a flavor.

Freshness is an ignored sensory attribution by the food and beverage industry. Slow sweet perception is an underestimated factor for palatability of consumables. An embodiment of composition in this invention could improve the freshness and or quick onset sweetness which could significantly improve the palatability of consumables.

An embodiment of a food and beverage comprises one or more components selected from STEs, STCs, GSTEs, GSTCs, STE-MRPs, STC-MRPs, GSTE-MRPs, and GSTC-MRPs, and blends thereof, which contribute sucrose equivalences (SugarEs) above 1%, above 1.5%, above 2%, above 2.5%, above 3%, above 4, above 5%. In other embodiments, the present application provides methods for using one or more components selected from STEs, STCs, GSTEs, GSTCs, STE-MRPs, STC-MRPs, GSTE-MRPs, GSTC-MRPs, and blends thereof as food ingredients or food additives. A further embodiment of a food ingredient or additive comprises one or more STEs, STCs, GSTEs, GSTCs, STE-MRPs, STC-MRPs, GSTE-MRPs, and GSTC-MRPs. It should be noted that the rubusoside used in the compositions and methods of the present application can originate from any source, including but not limited to sweet tea, stevia leaves, enzymatic conversion from stevia extracts and stevia glycosides, fermentation, hydrolysis, and other biosynthetic or synthetic methods.

The inventor surprisingly found that STEs, STCs, GSTEs, GSTCs, STE-MRPs, STC-MRPs, GSTE-MRPs, and GSTC-MRPs can significantly mask the bitterness, metallic taste of natural high intensity sweeteners such as stevia extract, stevia glycosides, monk fruit juice, monk fruit extract, licorice extract, and also high synthetic sweeteners, such as Acesulfame K, sucralose. Thus, in certain embodiments, a food flavor or sweetener can comprise: a) one or more components selected from STEs, STCs, GSTEs, GSTCs, STE-MRPs, STC-MRPs, GSTE-MRPs, and GSTC-MRPs; and b) one or more component selected from natural or synthetic high sweeteners.

High intensity sweeteners like natural sweeteners such as stevia extract, monk fruit extract etc., and synthetic sweeteners such as sucralose, acesulfame-K, aspartame, sodium saccharin etc. are characterized by their slow on-site, less high-peak sweetness, lower tongue heaviness, sweet aftertaste, less mouth coating, slipperiness, and high bitter aftertaste, metallic aftertaste. An extraordinary or good beverage must have synchronized or harmonized sweetness temporal profile, acidity temporal profile and aroma temporal profile. However, it is painful for food and beverage formulators when using these high intensity sweeteners to make these three dimensions synchronized, especially for sugar reduced, sugar free products. Normally, the sequence of formulation is to have balanced sweetness and sourness, then add flavor, but it is so difficult to have good balanced sweetness and sourness for sugar reduced, sugar free products. These defects of high intensity sweeteners make the current diet products less palatable to consumers. In current prevailing market, flavor, acidity and sweetness are dis-integrated in diet products, such non-synchronized products leave either initial bad taste/flavor which are difficult to be swallowed, or aftertaste or after flavor with bad impression, not hedonic at all. Most case, the flavor temporal profile is very short, or the flavor comes first before sweet or sour taste, or the bitterness, lingering, metallic taste. All so-called good taste of natural sweeteners, such as GSGs, higher molecule SGs such as RI, RD, RM, highly purified RA and RE, and synthetic sweeteners, such as Ac—K and sucralose, create metallic and lingering taste, which are difficult for consumers to swallow. Swallow is a big decision for consumers. Thinking about feeding baby and kids, if it is bitter, they use tongue to repel the food out of tongue. Swallow is the first and most important frontier to secure our lives. Mouth is the scout to identify the risk. A good food and beverage should create a synchronized aroma/taste which could let us relax and release the alertness and suspiciousness, at least the message from food and beverage should be that it is harmless to swallow.

Tasty food and beverage have their own footprints. The inventor surprisingly found that STEs, STCs, GSTEs, GSTCs, ST-MRPs, G-ST-MRPs and blends thereof can provide great tools for designing such products. Tasting a beverage has a particular physical and psychological sequence; well-designed products have a characteristic rhythm and temporal sequence in providing a satisfactory response to the product. For example, the physical sequence of drinking beverage consists of ordering a drink, looking at the drink, taking in the drink and swallowing the drink. The psychological sequence of drinking a beverage can be described by three stages: LIKING, WANTING and THINKING.

LIKING: When ordering a drink, consumers always have something in their memo, it means consumers have expectation. Therefore, color of product, words and photos in the package, sound of opening cans, sniff smell, all these are alluring factors for liking. The simple top note currently provided by flavor houses might not be enough for creating LIKING, especially for sugar reduced product. Liking is not only an issue to have volatile top note. The inventor has found the STEs, STCs, GSTEs, GSTCs, ST-MRPs, G-ST-MRPs and blends thereof can create retronasal aroma to enhance the orthonasal smell. An embodiment of composition comprises one or more ingredients selected from STEs, STCs, GSTEs, GSTCs, ST-MRPs, G-ST-MRPs and blends thereof which could create retronasal aroma to enhance the orthonasal smell.

WANTING: When drinking the beverage in mouth, if the general impression including flavor/taste is good, it is easy to make a big “swallowing” decision. If the product does not taste good, the swallowing will be restricted. If the product is so, we swallow, then our natural reaction is to stretch our tongue out of mouth to show dislike, resulting in a feeling of regret or making a mistake. Wanting is not an issue only for taste, but strongly depends on the hidden retronasal aroma. Use of the ST-MRPs and G-ST-MRPs according to the present application provides retronasal aromas which can accelerate the speed and frequency of swallowing. Therefore, in preferred embodiments, a composition of the present application includes one or more ingredients selected from ST-MRPs, G-ST-MRPs. SG-MRPs, and/or GSG-MRPs, which can accelerate the speed and frequency of swallowing.

THINKING: After swallowing, the first reaction psychologically is to confirm the expectation. Great designed products create surprise and desire. The present application provides a product which can make foods and beverages tasty so as to exceed expectations leading to the consumer to desire more of the product. Therefore, in preferred embodiments, a composition of the present application includes one or more ingredients selected from ST-MRPs, G-ST-MRPs. SG-MRPs, and/or GSG-MRPs, which can create retronasal aromas to improve consumer's approval and desire for the food and beverage products.

The inventor have surprisingly found that ST-MRPs and G-ST-MRPs can better synchronize the overall taste dimensions of sweetness, flavor, sourness, and mouthfeel so as to provide quick sweetness onset, less sweet lingering, and a characteristic flavor. These features are useful for many food and beverage applications and can make the formulation job easier and faster. Thus, the present application has been developed to provide STEs, STCs, GSTEs, GSTCs, ST-MRPs, G-ST-MRPs and blends thereof which can synchronize the sweetness, sourness, mouthfeel and flavor in food and beverage products. An embodiment of composition comprises STEs, STCs, GSTEs, GSTCs, ST-MRPs, G-ST-MRPs and blends thereof which can provide quick onset of sweetness/flavor and less lingering sweetness. In certain embodiments, STEs, STCs, GSTEs, GSTCs, ST-MRPs, G-ST-MRPs, blends thereof, and one or more other high intensity sweeteners can provide quick onset of sweetness/flavor and less lingering sweetness. In certain particular embodiments, a modified food or beverage comprises rubusoside in amount less than 100 ppm. In other embodiment, modified food or beverage comprises rubusoside and one or more GSG-MRPs, where rubusoside is less than 100 ppm. In a further embodiment, the modified food or beverage comprises rubusoside, one or more GSG-MRPs, and thaumatin, where rubusoside is present in an amount less than 100 ppm.

In one embodiment, a food or beverage product comprises rubusoside and one or more components selected from STEs, STCs, GSTEs, GSTCs, ST-MRPs, G-ST-MRPs and high intensity sweeteners, 1) where rubusoside is less than 100 ppm; or 2) where total rubusoside and glycosylated rubusoside is less than 1,000 ppm, less than 800 ppm, 600 ppm, less than 500 ppm, less than 400 ppm, less than 200 ppm, less than 100 ppm, less than 50 ppm, less than 20 ppm or less than 10 ppm.

In another embodiment, a food or beverage product comprises rubusoside and one or more components selected from GSTEs, GSTCs, ST-MRPs, and G-ST-MRPs. In some embodiments, the food or beverage product comprises glycosylated rubusosides and unconverted rubusosides, where the mono-glycosylated rubusoside is more than 10 wt %, 20 wt %, 30 wt %, 40 wt %, 50 wt %, 60 wt %, 70 wt %, 80 wt %, 90 wt % or 95 wt % of the total glycosylated rubusosides.

A further embodiment of a food or beverage comprises glycosylated rubusoside, where the amount of mono-glycosylated rubusoside is more than 1 ppm, 10 ppm, 50 ppm, 100 ppm, 150 ppm, 200 ppm, 250 ppm, 300 ppm, 500 ppm, 1,000 ppm or 10,000 ppm. In some embodiments, the food or beverage further comprises unconverted rubusosides.

A further embodiment of a food or beverage comprises glycosylated rubusoside, where the mono-glycosylated rubusoside is less than 10,000 ppm, 5,000 ppm, 1,000 ppm, 500 ppm, 300 ppm, 250 ppm, 100 ppm, 50 ppm, 10 ppm, 5 ppm or 1 ppm. In some embodiments, the food or beverage further comprises unconverted rubusosides.

Nasal cavity owns a large surface area and is a good approach for brain nutrition and medicines. Sublingual administration has certain advantages over oral administration. Being more direct, it is often faster and effective. The intranasal and sublingual routes of drug administration have been used for a variety of medications. The present application provides a solution to make intranasal and sublingual nutrition and medicines more palatable. Therefore, in some embodiments, an intranasal or sublingual composition includes one or more ingredients selected from STEs, STCs, GSTEs, GSTCs, ST-MRPs and G-ST-MRPs. An embodiment of a CBD, cannabis extract or cannabis oil product comprises one or more composition selected from STEs, STCs, GSTEs, GSTCs, ST-MRPs and G-ST-MRPs, where the product could be either food or beverage, preferably in a intranasal or sublingual form.

Masking bitter taste remains a primary goal for food and beverage industry. Bitterness has been a challenge with a wide range of foodstuffs, such as fruits including grapefruit, passionfruit, oranges, vegetables including cucumbers, avocados, beverage including beer, coffee, chocolate, and protein products including dairy and soy products. The inventor successfully develop a new composition comprises one or more ingredient selected from GSTE, GSTC, GSTE-MRP, GSTC-MRP, G-RU-MRP which could mask the bitterness of food and beverage.

The inventor has surprisingly found that MRPs originated from natural plant derived products such as MRPs using stevia, sweet tea, monk fruit, licorice etc. could maintain the overall flavor intensity and sensory quality of beverage and foods during the process and storage, thus also could reduce the amount of flavor added in food and beverage. An embodiment of a consumable comprises one or more MRPs ingredients derived from stevia, sweet tea, monk fruit, licorice etc., which could maintain the overall flavor intensity and sensory quality of consumable.

The inventor also surprisingly found that STEs, STCs, GSTEs, GSTCs, ST-MRPs, and G-ST-MRPs can enhance the astringency, accelerate the quick acidity sensation. In one embodiment, the sweetener or flavoring agent composition of the present application includes one or more substances selected from STEs, STCs, GSTEs, GSTCs, ST-MRPs, and G-ST-MRPs, which can enhance the astringency and quick acid on-site sensation. In certain preferred embodiments, the consumable contains a tea extract, a tea concentrate, cranberry juice, cranberry flavor, cranberry concentrate, grapefruit juice, grapefruit concentrate, grapefruit flavor, or a lemon and/or lime flavored juice or concentrate. More preferably, a consumable contains one or more substances selected from STE, STC, GSTE, GSTC, ST-MRPs, G-ST-MRPs and quinic acid, where the quinic acid is above 0.1 ppm, 1 ppm, 5 ppm, 10 ppm, 50 ppm, 100 ppm, 200 ppm, 500 ppm, 1,000 ppm, 2,000 ppm, 5,000 ppm, 10,000 ppm, 50,000 ppm or 100,000 ppm.

Once again, rubusoside is one of STCs, it should be understandable in whole specification that STCs include rubusoside or other sweet tea components that could be originated from other sources including but not limited to stevia extract, stevia glycosides, or fermentation, enzymatic conversion, synthetic method.

Surprisingly, the inventor has also found that STEs, STCs, GSTEs, GSTCs, ST-MRPs, and G-ST-MRPs can improve the solubility and enhance the sweetness of stevia glycosides. In particular, synergistic effects have been observed when these components have been combined together. In some embodiments, a consumable product includes one or more substances selected from STEs, STCs, GSTEs, GSTCs, STE-MRPs, STC-MRPs, GSTE-MRPs, GSTC-MRPs in combination with one or more stevia extracts comprising one or more stevia glycosides selected from Reb A, Reb B, Reb C, Reb D, Reb E, Reb I, Reb M, Reb O, such that the solubility and/or sweetness of the stevia extract(s) is increased.

In one embodiment, the sweetener or flavoring agent composition of the present application includes a GSTE or GSTC, where the ratio of one glucose residue being added to rubusoside to two glucose residues being added to rubusoside is more than 1.

In another embodiment, the sweetener or flavoring agent composition of the present application includes an STE or STC, where the rubusoside content is less than 90%, less than 70%, less than 50%, less than 30%, less than 20%, less than 15%, less than 10%, less than 5%, the non-rubusoside substances originated from sweet tea plant are above 5%, 10%, 20%, 30%, 40%, 50%, 60%, 70%, 80%, 90% or 95%.

In another embodiment, the sweetener or flavoring agent composition of the present application includes a GSTE or GSTC, where total glycosylated rubusosides is less than less than 90%, less than 70%, less than 50%, less than 30%, less than 20%, less than 15%, less than 10%, less than 5%, the non-rubusoside substances or their glycosylated form originated from sweet tea plant are above 5%, 10%, 20%, 30%, 40%, 50%, 60%, 70%, 80%, 90% or 95%.

Poor aqueous solubility is not only an obstacle to extend their application for stevia glycosides, but also for many other pharmaceutical active substances, herb extract. for instance, carotenoids like lutein, zeaxanthin, lutein esters, epilutein, polyphenols like apple polyphenols, kiwi polyphenols, grape seed polyphenols, flavonoids such as flavonoids extracted from gingko biloba, alkaloids such as devil's claw extract etc. The inventor found high intensity sweetener extracts, such as stevia extract, sweet tea extract, monk fruit extract could improve the solubility of substances which have poor water solubility, preferably the crude extract comprises non-stevia glycosides or non-sweetening substances. An embodiment of composition comprising a) one or more ingredient selected from sweet tea extract, stevia extract, monk fruit extract, licorice extract, their glycosylated products, and their MRPs, and b) one or more ingredient selected from herb extract or pharmaceutical active ingredients, where a) could improve the solubility and bioavailability of b).

Flavors from edible products such as fruits, berries, herbs and species are useful to enhance the palatability of food and beverage. However, the prevailing mindset of flavor industry takes volatile substances to bring the olfactory smell as key factor to measure the quality of flavor. The inventor found flavors containing flavor substances from plant juices such as fruit juice, berries juice, fresh herb or species juices could have substantially positive impact on retronasal flavors when adding into a food or beverage. The flavor compositions comprises less volatile and/or non-volatile substances are important to influence the palatability of food and beverage. An embodiment of composition comprising a) one or more ingredient selected from sweet tea extract, stevia extract, monk fruit extract and licorice extract, their glycosylated products, and their MRPs, and b) one or more flavor extracted or concentrated ingredient selected from plant juices such as fruits juices, berries juices, herb and species fresh juices, where b) comprises less-volatile and/or non-volatile substances from juices, and the composition could improve the palatability of food and beverage substantially. An additional embodiment of such composition comprises water soluble juicy substances, such as fruit concentration or juice concentrate or extract from water melon, bilberry, citrus, orange, lime, lemon, kiwi, apple etc.

In some embodiments, an STE, STC, GSTE or GSTC can be enriched for the presence of aromatic terpene substances containing oxygen in the structure. In some embodiments, a citrus or tangerine taste is enhanced by heat-treating a terpene- and/or terpenoid rich STE under acidic conditions comprising e.g., citric acid, tartaric acid, fumaric acid, lactic acid, malic acid etc., more preferably citric acid. In addition, substances such as linalool can react with citric acid with or without Maillard reaction. Vacuum distillation of fractions or column chromatography employing macroporous resins and/or silica gels, including ion exchange resins produced by Dow and Sunresin can be used for further purification.

In one embodiment, the present application provides a composition comprising a tangerine (or citrus) flavored ST extract and method for producing the same as further described in the Examples. In a particular embodiment, a method to produce a citrus flavored ST extract involves a heat process with or without Maillard reaction under acid conditions, more preferably in a Maillard reaction with citric acid.

One embodiment includes compositions comprising flavor substances from the sweet tea plant or other natural sweetener plants described herein, including leaves, roots, seeds, etc. therefrom.

### IV. Consumable Products Comprising the Sweet Tea-Based Sweetener or Flavoring Composition

The compositions and methods described herein are useful in a wide range of consumable products. A non-limiting outline of products for application of the sweet tea-based sweetener or flavoring compositions described herein includes the following:
1 Dairy Products
1.1 Milk and dairy—based drinks

Milk and buttermilk

Buttermilk (plain)

Dairy based drinks, flavored and/or fermented
1.2 Fermented, renneted milk products (excluding drinks)
1.3 Condensed milk and analogues

Condensed milk (plain)

Beverage whiteners
1.4 Cream (plain) and similar products

Pasteurized cream

Sterilized, UHT, whipping or whipped and reduced-fat creams

Clotted cream

Cream analogues
1.5 Milk or cream powders

Milk or cream powders

Milk or cream powders analogues
1.6 Cheese

Unripened cheese

Ripened cheese

Whey cheese

Processed cheese

Cheese analogues
1.7 Dairy-based desserts (e.g., ice cream, ice milk, pudding, fruit or flavored yogurt)
1.8 Whey and whey products, excluding whey cheese
2 Fats and oils and fat emulsions (type water-in-oil)
2.1 Fats and oils essentially free from water
2.2 Fat emulsions, water-in-oil
2.3 Fat emulsions other than 2.2, including mixed and/or flavored products based on fat emulsions.
2.4 Fat-based desserts (excluding dairy-based desserts)
3 Edible ices, including sherbet and sorbet
4, Fruits and vegetables (including mushrooms and fungi, roots and tubers, pulses and legumes) and nuts and seeds
4.1 Fruit
4.1.1 Fresh fruit

Untreated fruit

Surface—treated fruit

Peeled or cut fruit
4.1.2 Processed fruit

Frozen fruit

Dried fruit

Fruit in vinegar, oil or brine

Canned or bottled (pasteurized) fruit

Jams, jellies and marmalades

Fruit—based spread

Candied fruit

Fruit preparations, including pulp and fruit toppings

Fruit-based desserts, including fruit-flavored water-based desserts

Fermented fruit products

Fruit fillings for pastries

Cooked or fried fruits
4.2 Vegetables (including mushrooms and fungi, roots and tubers, pulses and legumes) and nuts and seeds
4.2.1 Fresh vegetables

Untreated vegetables

Surface treated vegetables

Peeled or cut vegetables
4.2.2 Processed vegetable and nuts and seeds

Frozen vegetable

Dried vegetables

Vegetables in vinegar, oil or brine

Canned or bottled (pasteurized) vegetables

Vegetable, nut and seed purees and spreads

Vegetable, nut and seed pulps and preparations

Fermented vegetable products

Cooked or fried vegetables
5 Confectionery
5.1 Cocoa products and chocolate products, including imitations and chocolate substitutes

Cocoa mixes (powder and syrups)

Cocoa based spreads, including fillings

Cocoa and chocolate products (e.g., milk chocolate bars, chocolate flakes, white chocolate)

Imitation chocolate and chocolate substitute products
5.2 Sugar-based confectionery other than 5.1, 5.3 and 5.4, including hard and soft candy and nougats
5.3 Chewing gum
5.4 Decorations (e.g., for fine bakery wares), toppings (non-fruit) and sweet sauces
6 Cereals and cereal products, including flours and starches from roots and tubers, and pulses and legumes, excluding bakery wares

Whole, broken or flaked grain, including rice

Flours and starches

Breakfast cereals, including rolled oats

Pastas and noodles

Cereals and starch-based desserts (e.g., rice pudding, tapioca pudding)

Batters (e.g., for fish or poultry)
7 Bakery wares
7.1 Bread and ordinary bakery wares

Breads and rolls

Crackers, excluding sweet crackers

Other ordinary bakery products (e.g., bagels, pitta, English muffins)

Bread-type products, including bread stuffing and breadcrumbs
7.2 Fine bakery wares

Cakes, cookies and pies (e.g., fruit-filled or custard types)

Other fine bakery products (e.g., doughnuts, sweet rolls, scones and muffins)

Mixes for fine bakery wares (e.g., cakes, pancakes)
8 Meat and meat products, including poultry and game
8.1 Fresh meat, poultry and game

Fresh meat, poultry and game, whole pieces or cuts

Fresh meat, poultry and game, comminuted
8.2 Processed meat, poultry and game products in whole pieces or cuts
8.3 Processed comminuted meat, poultry and game products
8.4 Edible casings (e.g., sausage casings)
9, Fish and fish products, including mollusks, crustaceans and echinoderms
9.1 Fish and fish products
9.2 Processed fish and fish products
9.3 Semi-preserved fish and fish products
9.4 Fully preserved fish and fish products
10 Eggs and egg products
10.1 Fresh egg
10.2 Egg products
10.3 Preserved eggs
10.4 Egg-based desserts
11 Sweeteners, including honey
11.1 White and semi-white sugar (sucrose or saccharose), fructose, glucose (dextrose), xylose, sugar solutions and syrups, and (partially) inverted sugars, including molasses, treacle and sugar toppings.
11.2 Other sugar and syrups (e.g., brown sugar, maple syrup)
11.3 Honey
11.4 Table—top sweeteners, including those containing high-intensity sweeteners, other than 11.1-11.3
12 Salt, spices, soups, sauces, salads, protein products, etc.
12.1 Salt
12.2 Herbs, spices, seasonings (including salt substitutes) and condiments
12.3 Vinegars
12.4 Mustards
12.5 Soups and broths

Ready-to-eat soups and broths, including canned, bottled and frozen

Mixes for soups and broths
12.6 Sauces and similar products

Emulsified sauces (e.g., mayonnaise, salad dressing)

Non-emulsified sauces (e.g., ketchup, cheese sauce, cream sauce, brown gravy)

Mixes for sauces and gravies
12.7 Salads (e.g., macaroni salad, potato salad) and sandwich spreads (excluding cocoa- and nut-based spreads)
12.8 Yeast
12.9 Protein products
13 Foodstuffs intended for particular nutritional uses
   13.1 Infant formulae and follow-up formulae
   13.2 Foods for young children (weaning food)
   13.3 Diabetic foods intended for special medical purposes
   13.4 Diabetic formulae for slimming purposes and weight reduction
   13.5 Diabetic foods other than 13.1-13.4
   13.6 Food supplements
   14 Beverage excluding dairy products
   14.1 Non-alcoholic (“soft”) beverages
   14.1.1 Waters
      Natural mineral waters and source waters
      Table waters and soda waters
   14.1.2 Fruit and vegetable juices
      Canned or bottled (pasteurized) fruit juice
      Canned or bottled (pasteurized) vegetable juice
      Concentrates (liquid or solid) for fruit juice
      Concentrates (liquid or solid) for vegetable juice
   14.1.3 Fruit and vegetable nectars
      Canned or bottled (pasteurized) fruit nectar
      Canned or bottled (pasteurized) vegetable nectar
      Concentrate (liquid or solid) for fruit nectar
      Concentrate (liquid or solid) for vegetable nectar
   14.1.4 Water-based flavored drinks, including ‘sport’ or ‘electrolyte” drinks
      Carbonated drinks
      Non-carbonated drinks, including punches
      Concentrates (liquid or solid) for drinks
14.1.15 Coffee, coffee substitutes, tea, herbal infusions and other hot cereal beverages, excluding cocoa
14.2 Alcoholic beverages, including alcohol-free and low-alcoholic counterparts
14.2.1 Beer or malt beverage
14.2.2 Cider and perry
14.2.3 Wines

Still wine

Sparking and semi-sparkling wines

Fortified wine and liquor wine

Aromatized wine
14.2.4 Fruit wine
14.2.5 Mead
14.2.6 Spirituous beverages

Spirituous beverage containing at least 15% alcohol

Spirituous beverage containing less than 15% alcohol
15 Ready-to-eat savories

Snacks, potato-, cereal-, flour-, or starch-based (from roots and tubers, pulses and legumes)

Processed nuts, including coated nuts and nut mixtures (with e.g., dried fruit)

16 Composite foods (e.g., casseroles, meat pies, mincemeat)—foods that could not be placed in categories 1-15.

In one aspect, the present application provides an orally consumable product comprising one or more sweet tea-based sweetener or flavoring compositions of the present application described herein. The term “consumables”, as used herein, refers to substances which are contacted with the mouth of man or animal, including substances, which are taken into and subsequently ejected from the mouth, substances which are drunk, eaten, swallowed or otherwise ingested, and are safe for human or animal consumption when used in a generally acceptable range.

The sweet tea-based sweetener or flavoring compositions of the present application can be added to an orally consumable product to provide a sweetened product or a flavored product. The sweet tea-based sweetener or flavoring compositions of the present application can be incorporated into any oral consumable product, including but not limited to, for example, beverages and beverage products, food products or foodstuffs (e.g., confections, condiments, baked goods, cereal compositions, dairy products, chewing compositions, and tabletop sweetener compositions), pharmaceutical compositions, smoking compositions, oral hygiene compositions, dental compositions, and the like. Consumables can be sweetened or unsweetened. Consumables employing the sweet tea-based sweetener or flavoring compositions of the present application are also suitable for use in processed agricultural products, livestock products or seafood; processed meat products such as sausage and the like; retort food products, pickles, preserves boiled in soy sauce, delicacies, side dishes; soups; snacks, such as potato chips, cookies, or the like; as shredded filler, leaf, stem, stalk, homogenized leaf cured and animal feed.

A. Beverages and Beverage Products

In some embodiments, a beverage or beverage product comprises a composition of the present application, or a sweetener composition comprising the same. The beverage may be sweetened or unsweetened. The composition of the present application, or sweetener composition comprising the same, may be added to a beverage to sweeten the beverage or enhance its existing sweetness or flavor profile. In some embodiments, the composition of the present application comprises one or more substances selected from the group consisting of STEs, STCs, GSTEs, GSTCs, ST-MRPs and G-ST-MRPs.

A “beverage” or “beverage product,” is used herein with reference to a ready-to-drink beverage, beverage concentrate, beverage syrup, or powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g., black tea, green tea, red tea, oolong tea), coffee, cocoa drink, broths, beverages comprising milk components (e.g., milk beverages, coffee comprising milk components, cafe au lait, milk tea, fruit milk beverages), beverages comprising cereal extracts, and smoothies. Beverages may be frozen, semi-frozen (“slush”), non-frozen, ready-to-drink, concentrated (powdered, frozen, or syrup), dairy, non-dairy, probiotic, prebiotics, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free.

The resulting beverages may be dispensed in open containers, cans, bottles or other packaging. Such beverages and beverage preparations can be in ready-to-drink, ready-to-cook, ready-to-mix, raw, or ingredient form and can use the composition as a sole sweetener or as a co-sweetener.

A significant challenge in the beverage industry is to preserve flavor in drinks. Normally, essential oils and their fractions are used as key flavors. They are prone to be oxidized to create unpleasant flavor(s) or the components easily evaporate to cause the food or beverage to lose their initial designed flavors as they sit on shelves. The embodiments herein provide new methods and compositions to overcome those disadvantages and provide new solutions to the food and flavor industry.

Compared with conventional flavors, which are mainly preserved in different oils or oil soluble solvents, the present embodiments provide new methods to provide water soluble solutions, syrups and powders for flavoring agents.

Compared to conventional isolated flavors, often as extracts from plant or animal sources, which are not always compatible for top note flavor and/or taste when sugar replacement sweeteners are added, the current embodiments provide new types of combined multi components which are compatible for a designed flavor.

The embodiments surprisingly create sugar reduced sweeteners which have better taste than sugar including, for example, sweetening agents such as Stevia extract, steviol glycosides, STE, monk fruit, licorice, etc. and synthetic sweetener such as sucralose.

Beverage concentrates and beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverages comprise a matrix, i.e., the basic ingredient in which the ingredients—including the compositions of the present application—are dissolved. In one embodiment, a beverage comprises water of beverage quality as the matrix, such as, for example deionized water, distilled water, reverse osmosis water, carbon-treated water, purified water, demineralized water or combinations thereof, can be used. Additional suitable matrices include, but are not limited to phosphoric acid, phosphate buffer, citric acid, citrate buffer and carbon-treated water.

The beverage concentrations below can be provided by the composition of the present application or sweetener composition of the present application.

Compared with simple blends of all ingredients together, the STCs and degradation products of STCs generate different compositions of sugar donors, which react with amine donors, and have interactions with the taste profile of remaining added sugar donors, STCs, STEs, GSTCs, GSTEs, ST-MRPs, G-ST-MRPs, SGs, SEs, GSGs, GSEs, Stevia-MRPs and C-MRPs, thus creating complicated, compatible tastes and aromas with steviol glycosides and other flavors, and substantially enriches the stereoscopic feeling of aroma and taste profile.

Traditionally, the use of regular guar gum and other thickeners have been limited to certain applications due to their notable “beany” or “grassy” off notes in both flavor and aroma. These “off notes” are the result of volatile organic compounds such as hexanal and hexanoic acid etc. These compounds can influence the sensation of many delicate flavors in food and beverage applications. The STEs, STCs, GSTEs, GSTCs, ST-MRPs and G-ST-MRPs described herein, can modify the taste of thickeners, such as guar gum, caragum, xanthan gum etc. so that the taste is more pleasing to the consumer. The STEs, STCs, GSTEs, GSTCs, ST-MRPs and G-ST-MRPs described herein could also partially or totally replace thickeners used in the food and beverage industry. There is a synergy between the STEs, STCs, GSTEs, GSTCs, ST-MRPs and G-ST-MRPs and thickeners to obtain a balance of taste and cost. There is also a synergy between the STEs, STCs, GSTEs, GSTCs, ST-MRPs and/or G-ST-MRPs and SGs, SEs, GSGs, GSEs, Stevia-MRPs and/or C-MRPs to produce improved taste profiles. A desired taste and aroma of a food or beverage product can be obtained by adjusting the type of STCs and ratio of reactants and reaction conditions, such as temperature, pressure, reaction time etc.

The size of bubbles in a carbonated beverage can significantly affect the mouth feel and flavor of the beverage. It is desirable to manipulate one or more properties of the bubbles produced in a beverage. Such properties can include the size of bubbles produced, the shape of bubbles, the amount of bubbles generated, and the rate at which bubbles are released or otherwise generated. Taste tests revealed a preference for carbonated beverages containing bubbles of smaller size.

The inventors of the present application have surprisingly found that adding certain STEs, STCs, GSTEs, GSTCs, ST-MRPs and/or G-ST-MRPs can minimize the size of bubbles, thus improving the mouth feel and flavor of beverages. Accordingly, in some embodiments, compositions of STEs, STCs, GSTEs, GSTCs, ST-MRPs and/or G-ST-MRPs, with or without other additives such as sweetening agents and/or thaumatin, can be used as additives to manipulate the size of bubbles, preferably for reducing the size of bubbles.

Additionally, the inventors surprisingly found that inclusion of thaumatin in the Maillard reaction or inclusion of thaumatin in combination of MRPs can significantly improve the overall taste profile of food and beverages to have a better mouth feel, a creamy taste, a reduction of bitterness of other ingredients in food and beverage, such as astringency of tea, protein, or their extracts, acidic nature and bitterness of coffee, etc. It can also reduce lingering, bitterness and metallic aftertaste of natural, synthetic high intensity sweeteners, or their combinations, their combination with other sweeteners, with other flavors much more than thaumatin itself. Thus, it plays a unique function in sugar reduction or sugar free products, and can be used as an additive for improving the taste performance of food and beverage products comprising one or more sweetening agents or sweeteners such as sucralose, acesulfame-K, aspartame, steviol glycosides, swingle extract, sweet tea extracts, allulose, sodium saccharin, sodium cyclamate or siratose.

A probiotic beverage normally is made by fermenting milk, or skimmed milk powder, sucrose and/or glucose with selected bacteria strains, by manufacturers such as Yakult or Weichuan. Normally, a large amount of sugar is added to the probiotic beverage to provide nutrients to the probiotics in order to keep them alive during shelf life. Actually, the main function of such a large amount of sugar is also needed to counteract the sourness of probiotic beverage and enhance its taste. Sweetness and the thickness are the two key attributes that are most affected for the acceptability of the beverage. It is a challenge for the manufacturers to produce tasteful probiotic beverages of reduced sugar versions.

In any of the embodiments described in the present application, the final concentration of any of STEs, STCs, GSTEs, GSTCs, ST-MRPs and/or G-ST-MRPs in the beverage may be 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, any of the STEs, STCs, GSTEs, GSTCs, ST-MRPs and/or G-ST-MRPs may be present in the beverage at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm, any aforementioned concentration value in this paragraph, or a range defined by any pair of the aforementioned concentration values in this paragraph. As used herein, “final concentration” refers to the concentration of, for example, any one of the aforementioned components present in any final composition or final orally consumable product (i.e., after all ingredients and/or compounds have been added to produce the composition or to produce the orally consumable product).

B. Confections

In some embodiments, the consumable product comprising one or more STEs, STCs, GSTEs, GSTCs, ST-MRPs and/or G-ST-MRPs of the present application is a confection. In some embodiments, a “confection” refers to a sweet, a lollipop, a confectionery, or similar term. The confection generally contains a base composition component and a sweetener component. A “base composition” refers to any composition which can be a food item and provides a matrix for carrying the sweetener component. An MRP or other composition of the present application comprising the same can serve as the sweetener component. The confection may be in the form of any food that is typically perceived to be rich in sugar or is typically sweet.

In other embodiments of the present application, the confection may be a bakery product, such as a pastry, Bavarian cream, blancmange, cake, brownie, cookie, mousse and the like; a dessert, such as yogurt, a jelly, a drinkable jelly, a pudding; a sweetened food product eaten at tea time or following meals; a frozen food; a cold confection, such as ice, ice milk, lacto-ice and the like (food products in which sweeteners and various other types of raw materials are added to milk products, and the resulting mixture is agitated and frozen); ice confections, such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfajor, and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; creams, including butter creams, flour pastes, whipped cream and the like; jams including strawberry jam, marmalade and the like; and breads including sweet breads and the like or other starch products, or combinations thereof.

Suitable base compositions for embodiments of this application may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerine, natural or synthetic gum, starch, and the like, or combinations thereof. Such components generally are recognized as safe (GRAS) and/or are U.S. Food and Drug Administration (FDA)-approved.

In any of the condiments described herein, STEs, STCs, GSTEs, GSTCs, ST-MRPs and/or G-ST-MRPs composition of the present application may be present in the condiment at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, STEs, STCs, GSTEs, GSTCs, ST-MRPs and/or G-ST-MRPs composition of the present application may be present in any of the condiments described herein at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose or fruit sugar, levulose, honey, unrefined sweetener, galactose, syrups, such as agave syrup or agave nectar, maple syrup, corn syrup, including high fructose corn syrup (HFCS); solids, tagatose, polyols (e.g., sorbitol, mannitol, xylitol, lactitol, erythritol, and maltitol), hydrogenated starch hydrolysates, isomalt, trehalose, or mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

C. Condiments

In some embodiments, the consumable product that contains STEs, STCs, GSTEs, GSTCs, ST-MRPs and/or G-ST-MRPs of the present application is a condiment. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, or combinations thereof); fruits, vegetables, or their products (e.g., tomatoes or tomato-based products (paste, puree), fruit juices, fruit juice peels, or combinations thereof); oils or oil emulsions, particularly vegetable oils; thickeners (e.g., xanthan gum, food starch, other hydrocolloids, or combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, or combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, a composition containing one or more STEs, STCs, GSTEs, GSTCs, ST-MRPs and/or G-ST-MRPs of the present application is used instead of traditional caloric sweeteners.

The condiment composition optionally may include other natural and/or synthetic high-potency sweeteners, bulk sweeteners, pH modifying agents (e.g., lactic acid, citric acid, phosphoric acid, hydrochloric acid, acetic acid, or combinations thereof), fillers, functional agents (e.g., pharmaceutical agents, nutrients, or components of a food or plant), flavoring agents, colorings, or combinations thereof.

In any of the confections described herein, the STEs, STCs, GSTEs, GSTCs, ST-MRPs and/or G-ST-MRPs of the present application may be present in the confection at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, STEs, STCs, GSTEs, GSTCs, ST-MRPs and/or G-ST-MRPs of the present application may be present in any of the confections described herein, at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

D. Dairy Products

A wide variety of dairy products can be made using the STEs, STCs, GSTEs, GSTCs, ST-MRPs and/or G-ST-MRPs of the present invention. Such products include without limitation, milk, whole milk, buttermilk, skim milk, infant formula, condensed milk, dried milk, evaporated milk, fermented milk, butter, clarified butter, cottage cheese, cream cheese, and various types of cheese.

In any of the solid dairy compositions described herein, STEs, STCs, GSTEs, GSTCs, ST-MRPs and/or G-ST-MRPs of the present application may be present in the solid dairy composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, STEs, STCs, GSTEs, GSTCs, ST-MRPs and/or G-ST-MRPs of the present application may be present in any of the confections described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

Alternatively, in any of the liquid dairy compositions described herein, STEs, STCs, GSTEs, GSTCs, ST-MRPs and/or G-ST-MRPs of the present application may be present in the liquid dairy composition at a final concentration of 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, STEs, STCs, GSTEs, GSTCs, ST-MRPs and/or G-ST-MRPs of the present application may be present in the liquid dairy composition at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm, any aforementioned concentration value in this paragraph, or a range defined by any pair of the aforementioned concentration values in this paragraph.

E. Cereal Compositions

In some embodiments, the consumable product comprising one or more STEs, STCs, GSTEs, GSTCs, ST-MRPs and/or G-ST-MRPs of the present application is a cereal composition. Cereal compositions typically are eaten either as staple foods or as snacks. Non-limiting examples of cereal compositions for use in some embodiments include ready-to-eat cereals as well as hot cereals. Ready-to-eat cereals are cereals which may be eaten without further processing (i.e., cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, oatmeal, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in some embodiments include maize, wheat, rice, barley, bran, bran endosperm, bulgur, sorghums, millets, oats, rye, triticale, buckwheat, fonio, quinoa, bean, soybean, amaranth, teff, spelt, and kaniwa.

The cereal composition comprises one or more STEs, STCs, GSTEs, GSTCs, ST-MRPs and/or G-ST-MRPs of the present application and at least one cereal ingredient. The STEs, STCs, GSTEs, GSTCs, ST-MRPs and/or G-ST-MRPs of present application may be added to the cereal composition in a variety of ways, such as, for example, as a coating, as a frosting, as a glaze, or as a matrix blend (i.e., added as an ingredient to the cereal formulation prior to the preparation of the final cereal product).

Accordingly, in some embodiments, one or more STEs, STCs, GSTEs, GSTCs, ST-MRPs and/or G-ST-MRPs of the present application are added to the cereal composition as a matrix blend. In one embodiment, one or more STEs, STCs, GSTEs, GSTCs, ST-MRPs and/or G-ST-MRPs are blended with a hot cereal prior to cooking to provide a sweetened hot cereal product. In another embodiment, one or more STEs, STCs, GSTEs, GSTCs, ST-MRPs and/or G-ST-MRPs are blended with the cereal matrix before the cereal is extruded.

In some embodiments, one or more STEs, STCs, GSTEs, GSTCs, ST-MRPs and/or G-ST-MRPs are added to the cereal composition as a coating, such as, for example, in combination with food grade oil and applying the mixture onto the cereal. In a different embodiment, one or more STEs, STCs, GSTEs, GSTCs, ST-MRPs and/or G-ST-MRPs and the food grade oil are applied to the cereal separately, by applying either the oil or the sweetener first. Non-limiting examples of food grade oils for use some embodiments include vegetable oils such as corn oil, soybean oil, cottonseed oil, peanut oil, coconut oil, canola oil, olive oil, sesame seed oil, palm oil, palm kernel oil, or mixtures thereof. In yet another embodiment, food grade fats may be used in place of the oils, provided that the fat is melted prior to applying the fat onto the cereal.

In another embodiment, one or more STEs, STCs, GSTEs, GSTCs, ST-MRPs and/or G-ST-MRPs are added to the cereal composition as a glaze. Non-limiting examples of glazing agents for use in some embodiments include corn syrup, honey syrups and honey syrup solids, maple syrups and maple syrup solids, sucrose, isomalt, polydextrose, polyols, hydrogenated starch hydrolysate, aqueous solutions thereof, or mixtures thereof. In another such embodiment, one or more STEs, STCs, GSTEs, GSTCs, ST-MRPs and/or G-ST-MRPs are added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and also may include a flavor.

In another embodiment one or more STEs, STCs, GSTEs, GSTCs, ST-MRPs and/or G-ST-MRPs are added to the cereal composition as a frosting. In one such embodiment, one or more STEs, STCs, GSTEs, GSTCs, ST-MRPs and/or G-ST-MRPs are combined with water and a frosting agent and then applied to the cereal. Non-limiting examples of frosting agents for use in some embodiments include maltodextrin, sucrose, starch, polyols, or mixtures thereof. The frosting also may include a food grade oil, a food grade fat, a coloring agent, and/or a flavor.

In any of the cereal compositions described herein, the one or more STEs, STCs, GSTEs, GSTCs, ST-MRPs and/or G-ST-MRPs are present in the cereal composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In some embodiments, one or more STEs, STCs, GSTEs, GSTCs, ST-MRPs and/or G-ST-MRPs may be present in any of the cereal compositions described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

F. Chewing Compositions

In some embodiments, the consumable product comprising one or more STEs, STCs, GSTEs, GSTCs, ST-MRPs and/or G-ST-MRPs of the present application is a chewing composition. The term “chewing compositions” include chewing gum compositions, chewing tobacco, smokeless tobacco, snuff, chewing gum and other compositions which are masticated and subsequently expectorated.

Chewing gum compositions generally comprise a water-soluble portion and a water-insoluble chewable gum base portion. The water soluble portion, which typically includes one or more STEs, STCs, GSTEs, GSTCs, ST-MRPs and/or G-ST-MRPs of the present application, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, polybutadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from α-pinene, β-pinene and/or D-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In some embodiment, the resin is present in the gum base in an amount in the range of about 5 to about 75 weight percent of the gum base.

Softeners, which also are known as plasticizers, are used to modify the ease of chewing and/or mouth feel of the chewing gum composition. Generally, softeners comprise oils, fats, waxes, and emulsifiers. Non-limiting examples of oils and fats include tallow, hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, lecithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In some embodiments, the softeners are present in the gum base in an amount in the range of about 0.5 to about 25 weight percent of the gum base.

Emulsifiers are used to form a uniform dispersion of the insoluble and soluble phases of the chewing gum composition and also have plasticizing properties. Suitable emulsifiers include glycerol monostearate (GMS), lecithin (phosphatidyl choline), polyglycerol polyricinoleic acid (PPGR), mono and diglycerides of fatty acids, glycerol distearate, tracetin, acetylated monoglyceride, glycerol triacetate, and magnesium stearate. In some embodiments, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestone, aluminum hydroxide, aluminum silicate, talc, clay, alumina, titanium dioxide, and calcium phosphate. In some embodiments, lecithin can be used as an inert filler to decrease the stickiness of the chewing gum composition. In other some embodiments, lactic acid copolymers, proteins (e.g., gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In some embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof. Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, or mixtures thereof. In some embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In some embodiments, the flavoring agent comprises an essential oil, such as an oil produced from a plant or a fruit, peppermint oil, spearmint oil, other mint oils, clove oil, cinnamon oil, oil of wintergreen, bay, thyme, cedar leaf, nutmeg, allspice, sage, mace, and almonds. In another embodiment, the flavoring agent comprises a plant extract or a fruit essence such as apple, banana, watermelon, pear, peach, grape, strawberry, raspberry, cherry, plum, pineapple, apricot, or mixtures thereof. In still another embodiment, the flavoring agent comprises a citrus flavor, such as an extract, essence, or oil of lemon, lime, orange, tangerine, grapefruit, citron, or kumquat.

In some embodiments, the chewing gum composition comprises one or more STEs, STCs, GSTEs, GSTCs, ST-MRPs and/or G-ST-MRPs of the present application and a gum base.

In any of the chewing gum compositions described herein, the one or more STEs, STCs, GSTEs, GSTCs, ST-MRPs and/or G-ST-MRPs of the present application may be present in the chewing gum composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the one or more STEs, STCs, GSTEs, GSTCs, ST-MRPs and/or G-ST-MRPs of the present application may be present in any of the chewing gum compositions described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

G. Tabletop Sweetener Compositions

In general, tabletop sugar replacements lack certain taste attributes associated with sugar, especially for solid tabletop sweeteners. In addressing this need, the inventor of the present application has developed more palatable tabletop sugar replacements than commonly known. Specifically, in some embodiments, the present application provides an orally consumable product comprising one or more STEs, STCs, GSTEs, GSTCs, ST-MRPs and/or G-ST-MRPs of the present application in the form of an orally consumable tabletop sweetener composition. In one embodiment, the orally consumable tabletop sweetener composition has a taste similar to molasses.

In some embodiments, the tabletop sweetener composition may further include at least one bulking agent, additive, anti-caking agent, functional ingredient or combination thereof.

Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, or mixtures thereof. Additionally, in accordance with still other embodiments of the application, granulated sugar (sucrose) or other caloric sweeteners such as crystalline fructose, other carbohydrates, or sugar alcohol can be used as a bulking agent due to their provision of good content uniformity without the addition of significant calories.

As used herein, the phrase “anti-caking agent” and “flow agent” refers to any composition which assists in content uniformity and uniform dissolution. In some embodiments, non-limiting examples of anti-caking agents include cream of tartar, aluminium silicate (Kaolin), calcium aluminium silicate, calcium carbonate, calcium silicate, magnesium carbonate, magnesium silicate, mono-, di- and tri-calcium orthophosphate, potassium aluminium silicate, silicon dioxide, sodium aluminium silicate, salts of stearic acid, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

The tabletop sweetener compositions can be packaged in any form known in the art. Non-limiting forms include, but are not limited to, powder form, granular form, packets, tablets, sachets, pellets, cubes, solids, and liquids.

In one embodiment, the tabletop sweetener composition is a single-serving (portion control) packet comprising a dry-blend. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (˜8 g). The amount of an MRP composition of the present application in a dry-blend tabletop sweetener formulation can vary. In some embodiments, a dry-blend tabletop sweetener formulation may comprise a Composition of the present application in an amount from about 1% (w/w) to about 10% (w/w) of the tabletop sweetener composition.

Solid tabletop sweetener embodiments include cubes and tablets. A non-limiting example of conventional cubes is equivalent in size to a standard cube of granulated sugar, which is approximately 2.2×2.2×2.2 cm3 and weighs approximately 8 g. In one embodiment, a solid tabletop sweetener is in the form of a tablet or any other form known to those skilled in the art.

A tabletop sweetener composition also may be embodied in the form of a liquid, wherein one or more STEs, STCs, GSTEs, GSTCs, ST-MRPs and/or G-ST-MRPs of the present application are combined with a liquid carrier. Suitable non-limiting examples of carrier agents for liquid tabletop sweeteners include water, alcohol, polyol, glycerin base or citric acid base dissolved in water, or mixtures thereof. The sweetness equivalent of a tabletop sweetener composition for any of the forms described herein or known in the art may be varied to obtain a desired sweetness profile. For example, a tabletop sweetener composition may have a degree of sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

In any of the tabletop sweetener compositions described herein, one or more STEs, STCs, GSTEs, GSTCs, ST-MRPs and/or G-ST-MRPs of the present application may be present in the tabletop sweetener composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, or 100 wt %, or a weight concentration range defined by any two of the aforementioned weight percentages in this paragraph.

In more particular embodiments, one or more STEs, STCs, GSTEs, GSTCs, ST-MRPs and/or G-ST-MRPs of the present application may be present in any of the tabletop sweetener compositions described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

H. Medicinal Compositions

In certain embodiments, one or more STEs, STCs, GSTEs, GSTCs, ST-MRPs and/or G-ST-MRPs of the present application may be used in medicinal compositions. As used herein, the term “medicinal composition” includes solids, gases and liquids which are ingestible materials having medicinal value, such as cough syrups, cough drops, medicinal sprays, vitamins, and chewable medicinal tablets that are administered orally or used in the oral cavity in the form of e.g., a pill, tablet, spray, capsule, syrup, drop, troche agent, powder, and the like.

I. Oral Hygiene Compositions

In some embodiments, one or more STEs, STCs, GSTEs, GSTCs, ST-MRPs and/or G-ST-MRPs of the present application may be used in an oral hygiene composition. As used herein, the “oral hygiene composition” includes mouthwashes, mouth rinses, breath fresheners, toothpastes, tooth polishes, dentifrices, mouth sprays, teeth whitening agents, soaps, perfumes, and the like.

J. Cosmetic Compositions

In some embodiments, one or more STEs, STCs, GSTEs, GSTCs, ST-MRPs and/or G-ST-MRPs of the present application is utilized in a cosmetic composition for enhancing the aroma of a cosmetic or skin-care product. As used herein, the term “cosmetic composition” means a composition that is formulated for topical application to skin, which has a pleasant color, odor and feel, and which does not cause unacceptable discomfort (stinging, tautness or redness) liable to discourage the consumer from using it.

Cosmetic composition may be preferably formulated in the form of an emulsion, e.g., W/O (water-in-oil), O/W (oil-in-water), W/O/W (water-in-oil-in-water), O/W/O (oil-in-water-in-oil) emulsion, PIT emulsion, Pickering emulsion, emulsion with a low oil content, micro- or nanoemulsion, a solution, e.g., in oil (fatty oils or fatty acid esters, in particular C6-C₃₂ fatty acid C₂-C₃₀ esters) or silicone oil, dispersion, suspension, creme, lotion or milk, depending on the production method and ingredients, a gel (including hydrogel, hydrodispersion gel, oleogel), spray (e.g., pump spray or spray with propellant) or a foam or an impregnating solution for cosmetic wipes, a detergent, e.g., soap, synthetic detergent, liquid washing, shower and bath preparation, bath product (capsule, oil, tablet, salt, bath salt, soap, etc.), effervescent preparation, a skin care product such as e.g., an emulsion (as described above), ointment, paste, gel (as described above), oil, balsam, serum, powder (e.g., face powder, body powder), a mask, a pencil, stick, roll-on, pump, aerosol (foaming, non-foaming or post-foaming), a dearomaant and/or antiperspirant, mouthwash and mouth rinse, a foot care product (including keratolytic, dearomaant), an insect repellent, a sunscreen, aftersun preparation, a shaving product, aftershave balm, pre- and aftershave lotion, a depilatory agent, a hair care product such as e.g., shampoo (including 2-in-1 shampoo, anti-dandruff shampoo, baby shampoo, shampoo for dry scalps, concentrated shampoo), conditioner, hair tonic, hair water, hair rinse, styling creme, pomade, perm and setting lotion, hair spray, styling aid (e.g., gel or wax), hair smoothing agent (detangling agent, relaxer), hair dye such as e.g., temporary direct-dyeing hair dye, semi-permanent hair dye, permanent hair dye, hair conditioner, hair mousse, eye care product, make-up, make-up remover or baby product.

K. Smokable Compositions

In some embodiments, one or more STEs, STCs, GSTEs, GSTCs, ST-MRPs and/or G-ST-MRPs of the present application may be used in a smokable composition. The term “smokable composition,” as used herein, includes any material that can be smoked or inhaled, such as tobacco and cannabis, as well as any smokable material that is burned to provide desirable aromas (e.g., charcoal briquettes for grilling foods, incense etc.). The smoking compositions may encompass cigarettes, electronic cigarettes (e-cigarettes), cigars, pipe and cigar tobacco, chew tobacco, vaporizable liquids, and all forms of tobacco such as shredded filler, leaf, stem, stalk, homogenized leaf cured, reconstituted binders, reconstituted tobacco from tobacco dust, fines, or other sources in sheet, pellet or other forms. “Smokable compositions” also include cannabis compositions (e.g., flower materials, leaf materials, extracts, oils, edible candies, vaporizable liquids, cannabis-infused beverages, etc.) and tobacco substitutes formulated from non-tobacco materials.

### V. Taste Profiles and Taste Testing of Compositions Containing One or More STEs, STCs, GSTEs, GSTCs, ST-MRPs and/or G-ST-MRPs

The one or more STEs, STCs, GSTEs, GSTCs, ST-MRPs and/or G-ST-MRPs and methods described herein are useful for improved taste and aroma profiles of many consumable products relative to control samples. The phrase “taste profile”, which is interchangeable with “sensory profile” and “sweetness profile”, may be defined as the temporal profile of all basic tastes of a sweetener. The “temporal profile” may be considered to represent the intensity of sweetness perceived over time in tasting of the composition by a human, especially a trained “taster”. Carbohydrate and polyol sweeteners typically exhibit a quick onset followed by a rapid decrease in sweetness, which disappears relatively quickly on swallowing a food or beverage containing the same. In contrast, high intensity natural sweeteners typically have a slower sweet taste onset reaching a maximal response more slowly, followed by a decline in intensity more slowly than with carbohydrate and polyol sweeteners. This decline in sweetness is often referred to as “sweetness linger” and is a major limitation associated with the use of high intensity natural sweeteners.

In the context of taste tasting, the terms “improve”, “improved” and “improvement” are used interchangeably with reference to a perceived advantageous change in a composition or consumable product upon introduction of one or more STEs, STCs, GSTEs, GSTCs, ST-MRPs and/or G-ST-MRPs of the present application from the original taste profile of the composition or consumable product without the added one or more STEs, STCs, GSTEs, GSTCs, ST-MRPs and/or G-ST-MRPs in any aspect, such as less bitterness, better sweetness, better sour taste, better aroma, better mouth feel, better flavor, less aftertaste, etc. The terms “improve” or “improvement” can refer to a slight change, a change, or a significant change of the original taste profile, etc., which makes the composition more palatable to an individual.

In some embodiments, the one or more STEs, STCs, GSTEs, GSTCs, ST-MRPs and/or G-ST-MRPs of the present application and methods described herein are useful for improving the taste and aroma profiles for other synthetic sweeteners, such as sucralose, ACE-K, aspartame, sodium saccharin, and mixtures thereof, and for natural high intensity sweeteners such as steviol glycosides, Stevia extracts, monk fruit extract, monk fruit components, licorice extract, licorice components.

In some embodiments, the one or more STEs, STCs, GSTEs, GSTCs, ST-MRPs and/or G-ST-MRPs of the present application may be evaluated with reference to the degree of their sucrose equivalence. Accordingly, the STEs, STCs, GSTEs, GSTCs, ST-MRPs and/or G-ST-MRPs compositions of the present application may be diluted or modified with respect to its ingredients to conform with this sucrose equivalence.

The onset and decay of sweetness when one or more STEs, STCs, GSTEs, GSTCs, ST-MRPs and/or G-ST-MRPs of the present application are consumed can be perceived by trained human tasters and measured in seconds from first contact with a taster's tongue (“onset”) to a cutoff point (typically 180 seconds after onset) to provide a “temporal profile of sweetness”. A plurality of such human tasters is called a “sensory panel.” In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness.” Aromas from aroma producing substances are volatile compounds which are perceived by the aroma receptor sites of the smell organ, i.e., the olfactory tissue of the nasal cavity. They reach the receptors when drawn in through the nose (orthonasal detection) and via the throat after being released by chewing (retronasal detection). The concept of aroma substances, like the concept of taste substances, is to be used loosely, since a compound might contribute to the typical aroma or taste of one food, while in another food it may cause a faulty aroma or taste, or both, resulting in an off-flavor. Thus, sensory profile may include evaluation of aroma as well.

The term “mouth feel” involves the physical and chemical interaction of a consumable in the mouth. More specifically, as used herein, the term “mouth feel” refers to the fullness sensation experienced in the mouth, which relates to the body and texture of the consumable such as its viscosity. Mouth feel is one of the most important organoleptic properties and the major criteria that consumers use to judge the quality and freshness of foods. Subtle changes in a food and beverage product's formulation can change mouth feel significantly. Simply taking out sugar and adding a high intensity sweetener can cause noticeable alterations in mouth feel, making a formerly good product unacceptable to consumers. Sugar not only sweetens, it also builds body and viscosity in food and beverage products, and leaves a slight coating on the tongue. For example, reducing salt levels in soup changes not only taste, but can alter mouth feel as well. Primarily it is the mouth feel that is always the compliant with non-sugar sweeteners.

The phrase “sweetness detection threshold” refers to the minimum concentration at which panelists consisting of 1-10 persons are able to detect sweetness in a composition, liquid or solid. This is further defined as provided in the Examples herein and are conducted by the methods described in Sensory Testing for Flavorings with Modifying Properties by Christie L. Harman, John B. Hallagan, and the FEMA Science, Committee Sensory Data Task Force, November 2013, Volume 67, No. 11 and Appendix A attached thereto, the teachings of which are incorporated herein by reference.

“Threshold of sweetness” refers to a concentration of a material below which sweetness cannot be detected, but can still impart a flavor to a consumable (including water). When half of a trained panel of testers determines something is “sweet” at a given concentration, then the sample meets the threshold. When less than half of a panel of testers cannot discern sweetness at a given concentration, then concentrations of the substance below the sweetness level are considered a flavoring agent.

It should be understood that the flavoring agents described herein, including STEs, STCs, GSTEs, GSTCs, ST-MRPs and/or G-ST-MRPs, can be used in combination with other materials, including non-ST steviol glycosides, to encapsulate and reduce or eliminate the unwanted off taste present in the composition. There is a sequence of steps in Maillard reaction(s) that can be used to produce flavor(s). That is, there can be a first step where a first reaction takes place between a first sugar donor and a first amine donor under appropriate conditions followed by a second reaction with a second sugar donor and a second amine donor, and possible subsequent reactions to provide a complex flavorant composition that is a combination of various Maillard reaction products between, for example, the first sugar donor and first amine donor, along with the reaction between the first sugar donor and a second amine donor or a second sugar donor reacting with the first sugar donor, etc. under the Maillard reaction conditions described herein. The processes described herein can be used to preserve flavors.

For example, to dissolve any flavor or flavor combination in a dissolved steviol glycosides solution, afterwards, the solution could be ready to use, or it could be further concentrated to syrup or powder form. For evaluating the taste profile of a given composition, a sample may be tested by e.g., a panel of 1-10 people. In some cases, a trained taster may independently taste the sample(s) first. The taster may be asked to describe the taste profile and score 0-5 according to the increasing sugar like, bitterness, aftertaste and lingering taste profiles. The taster may be allowed to re-taste, and then make notes for the sensory attributes perceived. Afterwards, another group of 1-10 tasters may similarly taste the sample(s), record its taste attributes and discuss the samples openly to find a suitable description. Where more than 1 taster disagrees with the results, the tasting may be repeated. For example, a “5” for sugar like is the best score for having a taste that is sugar like and conversely a value of 0 or near zero is not sugar like. Similarly, a “5” for bitterness, aftertaste and lingering is not desired. A value of zero or near zero means that the bitterness, aftertaste and/or lingering is reduced or is removed. Other taste attributes may include astringency and overall likability.

In some embodiments, vanilla, maltol or other flavor modifier product(s) “FMPs” can be added to the compositions described herein to further improve the taste. FMPs, such as maltol, ethyl-maltol, vanillin, ethyl vanillin, m-methylphenol, and m-n-propylphenol can further enhance the mouth feel, sweetness and aroma of the ST-MRP compositions described herein. Thus, in some embodiments, one or more FMPs may be added before or after the Maillard reaction, such as maltol, ethyl-maltol, vanillin, ethyl vanillin, m-methylphenol, m-n-propylphenol, or combinations thereof. In certain embodiments, MRPs and/or sweeteners may be combined with one or more FMPs. Particular MRP/FMP combinations include MRPs and maltol; MRPs and vanillin; sweetener(s) and maltol; sweetener(s) and vanillin etc. Such compositions may be used in any of the food or beverage products described herein.

Production of ST-MRPs may comprise the use of any of the following methodologies, including reflux at atmospheric pressure, reaction under pressure, oven drying, vacuum oven drying, roller/drum drying, surface scraped heat exchange, and/or extrusion.

The inventors of the present application have also developed a unique process which could preserve useful flavor substances originating from sweet tea plants and recovered in in the form of sweet tea extracts. Such substances are further amplified in glycosylation and/or Maillard reactions involving sweet extracts in combination with various amine donors as described herein.

Additionally, the flavor substances in the sweet tea plant should also contain any new possible flavor substances from new sweet tea varieties by hybridizing, grafting and other cultivating methods.

A flavoring agent, other than a flavor derived from a Maillard reaction product as described herein, can be added to the compositions described herein before or after a Maillard reaction has been effected. Suitable flavoring agents include, for example, natural flavors, vitamins, such as vitamin C, artificial flavors, spices, seasonings, and the like. Exemplary flavor agents include synthetic flavor oils and flavoring aromatics and/or oils, uronic acids (e.g., glucuronic acid and galacturonic acid) or oleoresins, essences, and distillates, and a combination comprising at least one of the foregoing.

During the Maillard reaction or following completion of the Maillard reaction, “top note” agents may be added, which are often quite volatile, vaporizing at or below room temperature. “Top notes” are often what give foods their fresh flavors. Suitable top note agents include but are not limited to, for example, furfuryl mercaptan, methional, nonanal, trans,trans-2,4-decadienal, 2,2′-(dithiodimethylene) difuran, 2-methyl-3-furanthiol, 4-methyl-5-thiazoleethanol, pyrazineethanethiol, bis(2-methyl-3-furyl) disulfide, methyl furfuryl disulfide, 2,5-dimethyl-2,5-dihydroxy-1,4-dithiane, 95%, trithioacetone, 2,3-butanedithiol, methyl 2-methyl-3-furyl disulfide, 4-methylnonanoic acid, 4-methyloctanoic acid, or 2-methyl-3-tetrahydrofuranthiol.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors, such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, a wasabi (Japanese horseradish) flavor; a nut flavor, such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

Generally any flavoring agent or food additive, such as those described in “Chemicals Used in Food Processing”, Publication No 1274, pages 63-258, by the National Academy of Sciences, can be used. This publication is incorporated herein by reference.

As used herein, a “flavoring agent” or “flavorant” herein refers to a compound or an ingestibly acceptable salt or solvate thereof that induces a flavor or taste in an animal or a human. The flavoring agent can be natural, semi-synthetic, or synthetic. Suitable flavorants and flavoring agent additives for use in the compositions of the present application include, but are not limited to, vanillin, vanilla extract, mango extract, cinnamon, citrus, coconut, ginger, viridiflorol, almond, bay, thyme, cedar leaf, nutmeg, allspice, sage, mace, menthol (including menthol without mint), an essential oil, such as an oil produced from a plant or a fruit, such as peppermint oil, spearmint oil, other mint oils, clove oil, cinnamon oil, oil of wintergreen, or an oil of almonds; a plant extract, fruit extract or fruit essence from grape skin extract, grape seed extract, apple, banana, watermelon, pear, peach, grape, strawberry, raspberry, cherry, plum, pineapple, apricot, a flavoring agent comprising a citrus flavor, such as an extract, essence, or oil of lemon, lime, orange, tangerine, grapefruit, citron, kumquat, or combinations thereof. Flavorants for use in the present application include both natural and synthetic substances which are safe for humans or animals when used in a generally accepted range.

Non-limiting examples of proprietary flavorants include Dohler™ Natural Flavoring Sweetness Enhancer K14323 (Dohler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

In the any of the embodiments described in the present application, the flavoring agent is present in the sweetener or flavoring composition of the present application in an amount effective to provide a final concentration of about 0.1 ppm, 0.5 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120 ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm, 380 ppm, 400 ppm, 425 ppm, 450 ppm, 475 ppm, 500 ppm, 550 ppm, 600 ppm, 650 ppm, 700 ppm, 750 ppm, 800 ppm, 850 ppm, 900 ppm, 950 ppm, 1000 ppm, 1500 ppm, 2000 ppm, 2500 ppm, 3000 ppm, 3500 ppm, 4000 ppm, 4500 ppm, 5000 ppm, 6000 ppm, 7000 ppm, 8000 ppm, 9000 ppm, 10,000 ppm, 11,000 ppm, 12,000 ppm, 13,000 ppm, 14,000 ppm, or 15,000 ppm; or to provide a final concentration corresponding to any one of the aforementioned values in this paragraph; or to provide a final concentration range corresponding to any pair of the aforementioned values in this paragraph.

In more particular embodiments, the flavoring agent is present in the composition of the present application in an amount effective to provide a final concentration ranging from 10 ppm to 1000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 75 ppm to 600 ppm, from 75 ppm to 500 ppm, from 75 ppm to 400 ppm, from 75 ppm to 300 ppm, from 75 ppm to 200 ppm, from 75 ppm to 100 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm; or to provide a final concentration corresponding to any one of the aforementioned values in this paragraph; or to provide a final concentration range corresponding to any pair of the aforementioned values in this paragraph.

### VI. STEs, STCs, GSTEs, GSTCs, ST-MRPs and/or G-ST-MRPs as Flavor Enhancers

The inventors have surprisingly found STEs, STCs, GSTEs, GSTCs, ST-MRPs or G-T-MRPs can bind the volatiles of various flavors used in food, beverages, cosmetics, feeds and pharmaceuticals. The STEs, STCs, GSTEs, GSTCs, ST-MRPs and G-T-MRPs prepared by the methods disclosed herein could be widely soluble in water, water/alcohol, alcohol, and other organic solvents used for the flavor industry at different temperatures. The sweet tea composition could naturally encapsulate the flavor produced during the processes described herein. Therefore, it is also excellent carrier or encapsulating material for flavors, including but not limited to flavors and spices originated from plants such as bark, flowers, fruits, leaves, animals such as concentrated meat and sea food soups etc., and their extracts such as essential oils etc. In one aspect, a processed flavor is added to solution containing one or more STEs, STCs, GSTEs, GSTCs, ST-MRPs and/or G-T-MRPs, then dried into a powder by any method, including but not limited spray-drying, crystallization, tray-drying, freeze drying etc. Thus, volatile flavors could be preserved. Normally, MRP flavors have to be maintained at low temperatures such as 10 degrees centigrade. The advantage of the present embodiments is that encapsulated flavors by STEs, STCs, GSTEs, GSTCs, ST-MRPs and/or G-T-MRPs could be kept at room temperature or even higher temperatures without much loss of flavor. The antioxidant properties of one or more ST-MRPs play an additional role of protection of the flavors. In addition, depending on desired product, specially designed compositions can enhance a foam for a specific application such as foamed/frothy coffee. In addition, an anti-foaming agent could be added together or separately during the reaction processes descried herein, such that the product could be used to prevent foaming for beverage bottling applications.

Another advantage of the present embodiments is that flavors could be absorbed in or to the inner surface of pores of STE, STC, GSTE, GSTC, ST-MRP and/or G-T-MRP powders. Flavors are preserved and can be released when in solution. The present embodiments avoid the use of starch, or dextrin as a carrier which can bring wheat taste to the flavors.

Another advantage is that three or more molecules selected from rubusosides, or suaviosides bind one water molecule and act as a moisture preserver. An embodiment of composition comprises one more ingredient selected from STEs, STCs, GSTEs, GSTCs, ST-MRPs and G-T-MRPs as a moisture preserver.

Citrus flavors are among the most popular flavors in the food market. They are widely used in sauces and dressings as well as in sweet products, such as beverages, cookies, and desserts. Their consumption is growing steadily at more than 3% per year. Unfortunately, they are highly susceptible to the surroundings and deteriorate during processing and storage. Of all commercial citrus products, citrus flavor in beverages is the most delicate and difficult flavor to preserve. Lemon oil or lemon juice volatiles contain unstable flavor substances such as citral. The degradation of citrus flavors lowers intensity and balance, and develops unacceptable “off-flavors” from the degradation products. The generation of off-flavors is an especially troublesome problem negatively impacting the market potential of citrus flavors in the market place. Therefore, many investigators have attempted to better understand the mechanism of deterioration and inhibit deterioration of these flavors.

The compositions and method in the present application have succeeded in stabilizing flavors in solution or even powder form. It is assumed that flavor substances are dissolved by stevia glycosides. Fat soluble flavor substances are surrounded or protected by steviol in the structure of stevia glycosides to prevent attachment of free radicals in water solution. On the surface of surrounded stevia glycosides, MRPs form a membrane acting as an antioxidant to protect the flavor substances. Additionally, dextrin residues and other sugar donors can act as coating material for powdered formulations to prevent attachment of oxygen in air.

Compared with traditional essential oil flavors which have to be emulsified before being added to beverages, the compositions and methods of the present application do not require the use of emulsifiers. This maximizes the intensity of flavor, stabilizes the flavor from degradation by oxygen, light, heat etc., and makes the beverage transparent. In one embodiment, a stabilized flavor composition comprises: (a) one or more substances selected from STEs, STCs, GSTEs, GSTEs, ST-MRPs, G-ST-MRPs, rubusoside enriched stevia extracts and/or MRPs formed from rubusoside enriched stevia extracts; rubusoside enriched stevia glycosides and/or MRPs formed therefrom; glycosylated rubusoside enriched stevia extracts and/or MRPs formed from rubusoside enriched stevia glycosides; glycosylated rubusoside enriched stevia glycosides, such as SGs or GSGs, as well as MRPs formed from glycosylated rubusoside enriched stevia glycosides; and residues of dextrin and/or other type of sugar donors; and (b) a flavor substance. In a further aspect, a consumable food or beverage product contains the aforementioned substances in both (a) and (b).

Freshness is one of the most important factors representing consumers' satisfaction with the sensory qualities present in fruit or berry juices, juice flavored beverages, fruited foods etc. Freshly squeezed juices without any treatment provide a refreshing, pleasant flavor with the mouth-contracting characteristics of fruits. Mouth-contracting is one type of mouthfeeling where ingredients cause contraction like freshness, acidity, salt, and spiciness in the mouth. Contracting substances typically stimulate saliva flow. Commercial fruit juices have shown variations in quality and freshness resulted from deterioration of flavor substances during the product's shelf-life as well as seasonal variations in fruit quality. Juice flavor is composed of a broad mixture of different aroma fractions containing a variety of volatile compounds. The aroma compounds in these fractions may undergo several changes during processing and storage that gradually lead to a loss of freshness and the formation of unpleasant aromas (off-flavors). Most of these changes are acid-catalyzed reactions supported by the acidity of the juice and accelerated by high processing and storage temperatures.

Freshness is an important character of quality for food and beverage products and is characterized by various definitions or aspects. In one aspect, the freshness or lack of freshness is perceived as a sensation. For example, a basil leave on a plant has a fresh smell and fresh taste. The same leaf after 2 days on the shelf doesn't smell fresh or taste fresh. In another aspect, freshness is derived from a multisensory sensation and a learned expectation together which can provide a “refreshing” sensation. For example, a consumer can assess sparkling water as fresh or refreshing even before drinking it. When people are thirsty and an unknown drink is provided, the effect of the unknown drink may be subconsciously compared with sparkling water. The basic properties of cognitive freshness are clear. Coldness, colorless, carbonated are typical characters of refreshing; sourness enhances freshness; colors such as red or orange increase thirst-quenching perception; flavors, such as mint, orange, peppermint, lemon, citrus, and peach are among the most refreshing aromas.

Without being bound by theory, the inventor's surprising findings strongly show that retronasal aroma is an inseparable part of taste. Taste and retronasal aromas arise from integrated senses. A lot of what is perceived as taste by human beings is in fact the result of retronasal aromas passing through the nose. It is known that people with severe colds have a greatly reduced sense of taste, because retronasal aromas cannot reach the retronasal olfactory receptors in the nose. Retronasal aromas compete with taste when reaching a sensory impression of a food or beverage product by the brain. Sweetness and mouthfeel cannot be solely attribute sensory perceptions originating on the tongue or in the mouth. Retronasal aroma (or nose-feeling) significantly contributes to what is considered traditional mouthfeel (mouth-contracting, mouth-coating, mouth-dry) without necessarily increasing the viscosity of a food or beverage. Aromas contracting with the mouth give the impression of refreshment and cleansing of the mouth. The compositions of the present application can be classified as contracting aromas that can stimulate saliva flow.

Compared with prevailing industry approaches for improving the overall taste and flavor of food and beverage products, the present application provides a unique approach to taste and flavor that better integrates aroma and taste to provide more tasteful food and beverage products. For example, in contrast to many of the traditional approaches in the flavor industry that rely on the use of essential oils having strong orthonasal sensory characteristics, the inventor of the present application has surprisingly found that retronasal aroma plays a more important role than orthonasal smell in making a consumable product with improved hedonic characteristics. By providing good mouthfeel and intensity of aroma, the compositions of the present application provide improved overall flavor. In one embodiment, a composition of the present application includes one or more substances selected from STEs, STCs, GSTEs, GSTCs, ST-MRPs and G-T-MRPs, and optionally one or more substance elected from SGs, SEs, GSGs, GSEs, Stevia-MRPs and C-MRPs, wherein one or more sensory attributes selected from mouth-contracting, mouth-coating, mouthfeel, flavor intensity, and sweetness are increased relative to a composition without the one or more substances.

In some instances, people have acquired a reduction or loss in their sensory capabilities for taste and smell, especially upon aging or following infections by viruses, such as COVID-19. The compositions and methods of the present application provide effective tools for enhancing retronasal olfactory senses to make food and beverages more palatable for being swallowed. This can improve the speed of drinking beverages or eating foods by those with such reduced senses. Without being bound by theory, it is believed that the compositions of the present application are anti-inflammatory for the mucous membranes of the oral cavity, throat and retronasal cavity, and cause increased permeability of aroma substances through the epithelium. Thus, in some embodiments, the composition comprises one or more substances selected from STEs, STCs, GSTEs, GSTCs, ST-MRPs and G-T-MRPs, where at least one of the substances is an angiogenesis inhibitor. In some embodiments, the composition may further include one or more members selected from lutein, epilutein, and/or anthocyanins. Such composition may be used, for example, in patients suffering from COVID-19 or other sensory deficiencies.

The inventor has surprisingly found that compositions comprising low molecular weight stevia glycosides, such as rubusoside and glycosylated low molecular weight stevia glycosides, including glycosylated rubusoside, as well as MRPs formed therefrom can increase the freshness of food and beverage products, and provide an improved, quicker onset of sweetness. These substances are further believed to provide an earlier recognition of flavor by the brain. The resultant effect of quick-onset of sweetness and refreshing flavor enables consumers to categorize food or beverage products quicker than if those glycosides were not added. The effect of this addition can provide improved overall flavor and taste of food and beverage products.

For instance, when high intensity sweeteners, such as sucralose, Acesulfame K, monk fruit extract, stevia glycosides are used as sweeteners, lingering is always generated. The lingering becomes the lead sensation. It dominates other sensations and distracts tasters from other sensations. However, the compositions of the present application can block the lingering and bitterness of high intensity sweeteners and act synergistically to improve sweetness.

In one embodiment, a flavor composition or sweetener composition comprises one or more substances selected from STEs, STCs, GSTEs, GSTCs, ST-MRPs and G-T-MRPs, rubusoside enriched stevia extracts and/or MRPs therefrom, rubusoside enriched stevia glycosides and/or MRPs therefrom, glycosylated rubusoside enriched stevia extracts and/or MRPs therefrom, glycosylated rubusoside enriched stevia glycosides and/or MRPs therefrom, wherein the one or more substances generate a quick onset of sweetness, enhance the strength of orthonasal smell, improve the freshness, and/or increase the sweetness of a food or beverage product.

In another embodiment, a method to accelerate flavor identification by the brain comprises adding one or more substances selected from STEs, STCs, GSTEs, GSTCs, ST-MRPs and G-T-MRPs, rubusoside enriched stevia extracts and/or MRPs therefrom, rubusoside enriched stevia glycosides and/or MRPs therefrom, glycosylated rubusoside enriched stevia extracts and/or MRPs therefrom, glycosylated rubusoside enriched stevia glycosides and/or MRPs therefrom, wherein the identification is accelerated by less than 1 second, less than 0.1 second, less than 0.01 second, or less than 0.001 second.

Oral mucosa can be classified into three different types: masticatory mucosa, lining mucosa and specialized mucosa. Masticatory mucosa covers the gingiva and hard palate, which accounts for about 25% of the oral mucosa. Specialized mucosa with characteristics of both masticatory and lining mucosa is found on the dorsum of the tongue. The dorsum of tongue accounts for about 15% of the oral mucosa. Lining mucosa covers the remaining regions, except for the dorsal surface of the tongue. Liming mucosa is related to the conventional third of the major chemosensory systems, the trigeminal chemosensory system. The neurons and their associated endings in this system are typically activated by chemicals classified as irritants, including air pollutants (e.g., sulfur dioxide), ammonia (smelling salts), ethanol (liquor), acetic acid (vinegar), carbon dioxide (in soft drinks), menthol (in various inhalants), and capsaicin (the compound in chili peppers that elicits the characteristic burning sensation). Contrary to conventional knowledge, the inventor of the present application believes that the lining mucosa contains taste and aroma receptors, and plays a principal role in overall taste and aroma together with retronasal nose-tasting, retronasal nose-coating, retronasal nose-aroma and taste by tongue. This means that the overall flavor, including taste and aroma, is an integrated and inseparable entity created by taste and flavor receptors spreading in lining mucosal sites, in addition to tongue, throat and retronasal areas.

Substances such as STC, STE, GSTC, GSTE, ST-MRPs and G-ST-MRPs can stimulate trigeminal nerve receptors in the mouth and retronasal cavity, and play an important role in flavor and taste identification of consumable products. Further, when combining STC, STE, GSTC, GSTE, ST-MRPs and G-ST-MRPs therefrom with pungent and irritant chemicals, synergistic effects are observed. Whereas pungent and irritant chemicals can activate trigeminal nerve receptors at lower thresholds or concentrations when combined with rubusoside-based glycosides or other small molecular stevia glycosides. Thus, in one embodiment, a composition or consumable product comprises: (a) one or more flavor and/or taste substances, and (b) one or more substances selected from STC, STE, GSTC, GSTE, ST-MRPs, and G-ST-MRPs, wherein the threshold for activating trigeminal receptors is reduced compared to a composition or product containing only the one or more flavor and/or taste substance in part (a).

The inventor has surprisingly found that substances, such as STC, STE, GSTC, GSTE, ST-MRPs and G-ST-MRPs therefrom can be used as trigeminal nerve stimulants. When used together with other taste or flavor stimulants, these substances can induce nerve firing, elicit enhanced sensations such as irritation, burning, stinging, tingling, pain, as well as the general perception of temperature, viscosity, weight, and freshness. When used at higher concentrations, these trigeminal stimulants can suppress the perception of olfactory compounds. Thus, in one embodiment, a composition or consumable product comprises: (a) one or more flavor and taste substances, and b) one or more substances selected from STCs, STEs, GSTCs, GSTEs, ST-MRPs, and G-ST-MRPs, where stimulation strength of (a) is enhanced when using (b) at lower concentrations; and stimulation strength of a) is reduced when using b) at higher concentrations.

Without being bound by theory, the inventor believes that masticatory mucosa and lining mucosa are essentially responsible for mouth-contracting, and specialized mucosa is mainly responsible for mouth-coating or tongue-coating. Both are responsible for mouthfeel. It is further believed that the lining mucosa is responsive to rubusosides, glycosylated rubusosides and MRPs therefrom exhibit significant flexibility, biocompatibility and propensity for adhesively attaching to these mucosal surfaces. Accordingly, these substances are believed to improve permeability and adhesiveness of flavor substances to oral mucosa so as to bind sensory receptors responsive to bitterness, as well as metallic and synthetic tastes, thereby blocking other unpleasant substances to these receptors that would otherwise have a negative effect on taste and flavor. Nasal mucosa are particularly sensitive; rubusoside, glycosylated rubusoside and MRPs formed therefrom exhibit better accessibility and stronger impact on nasal mucosa.

In view of the foregoing, one embodiment of the present application includes a composition comprising one or more components selected from rubusoside, glycosylated rubusoside, rubusoside-MRPs, and glycosylated rubusoside-MRPs. Adding these components to a consumable product can enhance the mouth-contracting and freshness of the consumable product. In a more particular embodiment, the composition further comprises one or more components selected from SGs, SEs, GSGs, GSEs, Stevia-MRPs, C-MRPs, wherein the amount of rubusosides and glycosylated rubusosides is less than 95%, less than 80%, less than 50%, less than 30%, less than 10%, less than 1%, less than 0.5%, or less than 0.1%. Further, inclusion of the one or more components can reduce the amount of rubusosides and/or glycosylated rubusosides necessary to enhance the mouth-coating of consumable food and beverage products.

Improving the freshness of food and beverage products can modify their overall flavor, acidity and sweetness profiles, regardless of whether the product contains sugar(s) or a reduced sugar content. In particular, the freshness of food and beverage products, including both sugar containing and reducing sugar versions thereof, can be significantly improved by combining compositions of the present application, such as STC, STE, GSTC, GSTE, ST-MRPs and G-ST-MRPs with flavor substances, especially water phase essence flavors or water phase concentrated flavors, such as lemon juice concentrated aroma, orange juice concentrated aroma, cucumber concentrated aroma, and apple juice concentrated aroma etc. Adding these compositions to food and beverage can enhance the contracting mouthfeel, orthonasal smell, retronasal aroma, reduce lingering, reduce metallic and artificial aftertaste of both natural and synthetic high intensity sweeteners, make the food and beverage products more palatable, and provide new flavors with improved sensory characteristics.

An embodiment of a flavor or sweeteners comprises one or more substances selected from STC, STE, GSTC, GSTE, ST-MRPs and G-ST-MRPs, where it further comprises one or more volatile substances set forth in any one of Tables 75-2 to 75-13.

In one embodiment, a flavor or sweetener comprises (a) a composition comprising one or more substances selected from rubusoside, glycosylated rubusoside, rubusoside-MRPs and glycosylated rubusoside-MRPs, wherein the one or more substances are present in an amount of at least 1%, at least 2%, at least 3%, at least 4%, at least 5%, at least 10%, at least 20%, at least 30%, at least 50%, at least 60%, at least 80%, at least 90%, or at least 95%; and (b) a composition comprising non-rubusoside stevia glycosides, wherein non-rubusoside stevia glycosides comprise one or more stevia glycosides selected from Reb A, Reb B, Reb C, Reb D, Reb E, Reb M, Reb N, and Reb O.

In another embodiment, a food or beverage product comprises a composition comprising: (a) a composition comprising one or more substances selected from rubusoside, glycosylated rubusoside, rubusoside-MRPs and glycosylated rubusoside-MRPs, wherein the one or more substances are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm; and (b) a composition comprising non-rubusoside stevia glycosides, wherein non-rubusoside stevia glycosides comprise one or more stevia glycosides selected from Reb A, Reb B, Reb C, Reb D, Reb E, Reb I, Reb M, Reb N, and Reb O.

In another embodiment, a food or beverage product comprises a composition comprising: (a) a composition comprising one or more substances selected from rubusoside, glycosylated rubusoside, rubusoside-MRPs and glycosylated rubusoside-MRPs; and (b) a composition comprising non-rubusoside stevia glycosides, wherein non-rubusoside stevia glycosides comprise one or more stevia glycosides selected from Reb A, Reb B, Reb C, Reb D, Reb E, Reb I, Reb M, Reb N, and Reb O, wherein the part (a) is added in sufficient amount to significantly improve solubility, increase sweetness, reduce bitterness, and/or reduce metallic or lingering aftertastes of (b).

In another embodiment, a food or beverage product comprises a composition comprising: (a) a composition comprising one or more substances selected from rubusoside, glycosylated rubusoside, rubusoside-MRPs and glycosylated rubusoside-MRPs; and (b) a composition comprising non-rubusoside stevia glycosides, where non-rubusoside stevia glycosides comprise one or more stevia glycosides selected from Reb A, Reb B, Reb C, Reb D, Reb E, Reb M, Reb N, and Reb O, where the ratio (w/w) of the composition in part (a) to the composition in part (b), is 1:99 to 99:1. In some embodiments, the ratio (w/w) of the composition in part (a) to the composition in part (b), is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is about, or great than, 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

In another embodiment, a flavor composition or sweetener composition comprises: (a) one or more substances selected from rubusoside, glycosylated rubusoside, and rubusoside-MRPs; and (b) one or more substances selected from monk fruit extract, glycosylated monk fruit extract, where the one or more substances in part (a) comprise at least 1%, at least 2%, at least 3%, at least 4%, at least 5%, at least 10%, at least 20%, at least 30%, at least 50%, at least 60%, at least 80%, at least 90%, or at least 95% (w/w) of the flavor or sweetener. In a further aspect, a food or beverage product includes the one or more substances in each of parts (a) and (b), where the one or more substances in part (a) are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, the food or beverage product includes the one or more substances in each of parts (a) and (b), where the solubility (in the food or beverage product) of the one or more substances in part (b) is significantly improved in the presence of part (a), or where the overall sweetness of the product is increased relative to a food or beverage product without aforementioned substances, or where the bitterness, metallic aftertaste and/or lingering aftertaste are reduced relative to a food or beverage product without aforementioned substances, or where the ratio of the one or more substances in part (a) to the one or more substances in part (b) is between 1:99 and 99:1 on a w/w basis.

In another embodiment, a flavor or sweetener comprises: (a) one or more substances selected from rubusoside, glycosylated rubusoside, and rubusoside-MRPs, and (b) one or more substances selected from sucralose, acesulfame K, saccharin, aspartame, Neotame, and alitame, where the one or more substances in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w). In a further aspect, a food or beverage product includes the one or more substances in each of parts (a) and (b), where the one or more substances in part (a) are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, the food or beverage product includes the one or more substances in each of parts (a) and (b), where the solubility (in the food or beverage product) of the one or more substances in part (b) is significantly improved, or where the overall sweetness of the product is increased relative to a food or beverage product without aforementioned substances, or where the bitterness, metallic aftertaste and/or lingering aftertaste are reduced relative to a food or beverage product without aforementioned substances, or where the ratio of the one or more substances in part (a) to the one or more substances in part (b) is between 1:99 and 99:1 on a w/w basis.

In another embodiment, a flavor or sweetener comprises: (a) one or more substances selected from rubusoside, glycosylated rubusoside, and rubusoside-MRPs, and (b) one or more substances selected from polydextrins, modified starch, inulin, erythritol, where the one or more substances in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w). In a further aspect, a food or beverage product includes the one or more substances in each of parts (a) and (b), where the one or more substances in part (a) are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, the food or beverage product includes the one or more substances in each of parts (a) and (b), where the solubility (in the food or beverage product) of the one or more substances in part (b) is significantly improved, or where the overall sweetness of the product is increased relative to a food or beverage product without aforementioned substances, or where the bitterness, metallic aftertaste and/or lingering aftertaste are reduced relative to a food or beverage product without aforementioned substances, or where the ratio of the one or more substances in part (a) to the one or more substances in part (b) is between 1:99 and 99:1 on a w/w basis.

In another embodiment, a flavor or sweetener composition comprises glycosylated rubusoside and rubusoside, where the ratio of glycosylated rubusoside to rubusoside is from 1:99 to 99:1, optionally where the flavor or sweetener composition further comprises one or more carriers, such as maltodextrin.

In another embodiment, a flavor or sweetener composition includes one or more components selected from the group consisting of STEs, STCs, GSTEs, GSTCs, rubusosides from stevia, stevia extracts containing enriched rubusoside, glycosylated rubusosides from stevia, glycosylated stevia extracts containing glycosylated enriched rubusoside. These components can significantly improve the taste profile of high intensity sweeteners, such as sucralose, Acesulfame K, Aspartame, saccharin, stevia extract, stevia glycosides, monk fruit extract, mogrosides, licorice extract. Accordingly, in certain embodiments, the flavor or sweetener composition further includes one or more high intensity sweeteners selected from sucralose, Acesulfame K, Aspartame, saccharin, stevia extract, stevia glycosides, monk fruit extract, mogrosides, licorice extract.

In another aspect, a method to improve the taste profile of a high intensity sweetener includes the step of adding to a composition containing the high intensity sweetener one or more components selected from the group consisting of STEs, STCs, GSTEs, GSTCs, rubusoside from stevia, stevia extract containing rubusoside, glycosylated rubusoside from stevia, glycosylated stevia extract containing glycosylated rubusoside.

In another aspect, a consumable product includes one or more components selected from the group consisting of STEs, STCs, GSTEs, GSTCs, rubusosides from stevia, stevia extracts containing enriched rubusoside, glycosylated rubusosides from stevia, glycosylated stevia extracts containing glycosylated enriched rubusoside. In another embodiment, the consumable product includes one or more components selected from the group consisting of STEs, STCs, GSTEs, GSTCs, rubusosides from stevia, stevia extracts containing enriched rubusoside, glycosylated rubusosides from stevia, glycosylated stevia extracts containing glycosylated enriched rubusoside, where the total content of rubusoside and glycosylated rubusoside in the consumable product is at least 0.1 ppm, at least 1 ppm, at least 5 ppm, at least 10 ppm, at least 50 ppm, at least 100 ppm, at least 250 ppm, at least 500 ppm, at least 1,000 ppm, at least 1%, at least 5%, or at least 10% on weight:weight basis.

Umami is a delicious aroma formed by convergence of taste and retronasal olfactory pathways in the human brain. Soy sauces are widely used in Asian area. There is strong demand to reduce salt and or added sugar in soy sauces. The inventor has surprisingly found that adding one or more components selected from the group consisting of STC, STE, GSTC, GSTE, ST-MRPs and G-ST-MRPs can reduce the amount of salt, increase the mouthfeel or mouth-coating, minimize the off-taste of fermentation and soybean, and/or improve the umami taste when used in soy sauces. In one aspect, a method to improve the taste profile of a sugar or reduced sugar soy sauce includes the step of adding to the soy sauce one or more STC, STE, GSTC, GSTE, ST-MRPs and G-ST-MRPs described in the present application, optionally with one or more substances selected from SGs, SEs, GSGs, GSEs, Stevia-MRPs and C-MRPs.

Jams contain high sugars such as sucrose, fructose etc. The inventor has surprisingly found that adding or combining one or more STEs, STCs, GSTEs, GSTCs, ST-MRPs and G-ST-MRPs thereof described in the present application, optionally with one or more substances selected from SGs, SEs, GSGs, GSEs, Stevia-MRPs and C-MRPs in a jam can increase the freshness of fruit flavors in the jam, increase the sweetness of the jam and or increase the mouthfeel of the jam.

Fermented milks, such as yogurt, exhibit long lasting sourness, which is unpleasant to many consumers. There is huge challenge to reduce sugar and fat in yogurt and other milk products. Plant-based protein beverages, such as soybean milk and coconut milk have grassy, beany off-note aromas. The inventor has surprisingly found that adding compositions of the present application containing one or more substances selected from STEs, STCs, GSTEs, GSTCs, ST-MRPs and G-ST-MRPs thereof, optionally with one or more SGs, SEs, GSGs, GSEs, Stevia-MRPs and C-MRPs can improve the mouthfeel or mouth-coating, quick onset sweetness, reduce unpleasant aftertastes, and/or reduce the sourness of fermented protein beverages, where the protein is from an animal and/or plant source. The compositions of the present application are particularly well suited for use with plant-based proteins so as to provide taste and retronasal olfactory inputs to the brain that can be observed by neuroimaging.

Glucose transporters GLUT1 (transports glucose) and GLUTS (transports fructose) have been implicated in several diseases including cancer and diabetes. In one embodiment, the present application provides a method for weight management, comprising oral administration of a consumable product containing one or more substances selected from rubusoside, glycosylated rubusoside, and MRPs formed therefrom, wherein the one or more substances are present in the consumable product in an amount sufficient for reducing absorption of glucose and/or fructose or inhibiting their transport by GLUT1 and/or GLUTS.

Rubusoside is present in stevia plants, including stevia leaf extracts, or it may be obtained via bioconversion from stevioside. Any composition of stevia glycosides or stevia extracts containing rubusoside, including those isolated from stevia leaves, and/or enriched via enzymatic conversion from stevia extracts containing stevioside can be used as raw material for glycosylating rubusoside. The inventor has found that compositions containing rubusoside, glycosylated rubusoside, and/or MRPs formed therefrom can play a major role in modifying the taste properties of food ingredients or flavors in a consumable product. Generally, the higher the content of rubusoside or glycosylated rubusoside in a composition, the more pronounced is the effect of reducing the lingering aftertaste. In one embodiment, a composition for reducing lingering includes glycosylated rubusoside and rubusoside, where the purity of rubusoside in the raw material used for glycosylating rubusoside is at least at least 1%, at least 5%, at least 10%, at least 50%, at least 75%, at least 90%, at least 95%, or at least 99% (w/w). In a further embodiment, the composition includes glycosylated rubusoside and rubusoside, where the non-rubusoside substances in the raw material used for glycosylating rubusoside is less than 99%, less than 95%, less than 90%, less than 75%, less than 50%, less than 10%, less than 5%, or less than 1% (w/w). When using stevia extract as a source of raw material, the total amount of non-rubusoside stevia glycosides selected from the groups consisting of Reb A, Reb B, Reb C, Reb D, Reb E, stevioside, and Reb M are less than 99%, less than 95%, less than 90%, less than 75%, less than 50%, less than 10%, less than 5%, or less than 1% (w/w).

Rubusoside can be also produced from different raw materials via fermentation or chemical synthesis. In either case, the final product, either crude or purified, may contain non-rubusoside substances, including unfermented or unreacted raw materials, isomers, substances of side reactions etc. In one embodiment, a composition of the present application includes rubusoside and glycosylated rubusoside, where the raw material used for obtaining the glycosylated rubusoside is obtained by fermentation or chemical synthesis, and where the total amount of non-rubusoside substances is less than 99%, less than 95%, less than 75%, less than 50%, less than 10%, less than 5%, less than 1%, or less than 0.1% (w/w) of the composition.

In one embodiment, a composition of the present application includes rubusoside and glycosylated rubusoside, where the raw material used for obtaining the glycosylated rubusoside is obtained by fermentation or chemical synthesis, and where the content of the rubusoside and glycosylated rubusoside in the composition is at least 99%, at least 95%, at least 75%, at least 50%, at least 10%, at least 5%, at least 1%, or at least 0.1% (w/w) of the composition.

The inventor has surprisingly found that compositions of the present application containing rubusoside, glycosylated rubusoside, and/or MRPs from therefrom can act synergistically with vanilla extract, vanillin, or ethyl vanillin to reduce the amount of vanilla or vanillin needed in a consumable. In one embodiment, a composition of the present application includes one or more substances selected from STCs, STEs, GSTCs, GSTEs, ST-MRPs and G-ST-MRPs in combination with one or more substances selected from vanilla extract, vanillin, and ethyl vanillin.

The inventor has surprisingly found that compositions of the present application composition containing rubusoside, glycosylated rubusoside, or MRPs formed therefrom can create a fatty taste sensation, or enhance the fat taste-feeling of skim milk, vegetable burgers, and other low fat food and beverage products. In this case, it is believed that one or more substances selected from STCs, STEs, GSTCs, GSTEs, ST-MRPs and G-ST-MRPs act in combination with fat to produce a synergistic effect with respect to fat sensation in a consumable product containing these substances. Accordingly, in one embodiment, a composition of the present application includes one or more substances selected from STCs, STEs, GSTCs, GSTEs, ST-MRPs and G-ST-MRPs in combination with one or more fats.

When modified starches, such as hydroxypropyl distarch phosphate (cross-linked hydroxylpropyl ether starch) are used as a stabilizers or fat replacers in food and beverages, they create a chalky or starchy taste, which may be characterized by the sensation of granules or particles on the tongue or in the cavity of the mouth. The inventor has surprisingly found that compositions of the present application can significantly minimize the chalky or starchy taste when modified starch is used in a consumable. In one embodiment, a composition of the present application includes one or more substances selected from STCs, STEs, GSTCs, GSTEs, ST-MRPs and G-ST-MRPs in combination with one or more modified starches, where the one or more substances are added in an amount sufficient to reduce an otherwise chalky or starchy taste, characterized by the sensation of granules or particles on the tongue or mouth cavity.

When water insoluble or less water soluble substances, such as stevia extracts or stevia glycosides are combined with the compositions of the present application, the solubility of the substances can be improved. Moreover, when the poorly water soluble or insoluble substances are high intensity sweeteners combined with the compositions of the present application, the overall sweetness can be synergistically increased. In one embodiment, a composition of the present application includes one or more substances selected from GSGs, STCs, STEs, GSTCs, GSTEs, GSG-MRPs, ST-MRPs and G-ST-MRPs and one or more poorly water soluble or insoluble stevia glycosides, including but not limited to Reb A, Reb B, Reb C, stevioside, Reb D, Reb I, Reb N, Reb M, Reb O, where the solubility and sweetness of the one or more poorly water soluble or insoluble stevia glycosides is increased when combined with the one or more substances.

The fresh pressed sugar-cane or sugar beet juice, its concentrate with low temperature or short time concentration could be combined with the composition in this invention to boost the sweet taste profile of products. An embodiment of a composition comprises one or more substances selected from GSGs, STCs, STEs, GSTCs, GSTEs, GSG-MRPs, ST-MRPs and G-ST-MRPs and one or more product obtained from sugar-cane, preferably the fresh pressed sugar-cane or sugar beet juice, or its concentrate with low temperature or short time concentration where the maximum flavors are reserved. An embodiment of a composition comprises one or more substances selected from GSGs, STCs, STEs, GSTCs, GSTEs, GSG-MRPs, ST-MRPs and G-ST-MRPs and one or more product obtained from sugar-cane, where the sugar-cane product has less sweetness such as caramelized molasses, or less sweetener dark colored sugar-cane or sugar beet products.

In one aspect, the present application relates to a composition comprising (a) rubusoside, glycosylated rubusoside, rubusoside-MRPs and/or glycosylated rubusoside-MRPs; and (b) one or more substances selected from Reb A, Reb B, Reb D, Reb E, Reb I and/or Reb M, where the components in parts (a) and (b) are added in amounts sufficient so that the sweetness of the one or more substance in part (b) is synergistically increased by the addition of rubusoside and/or glycosylated rubusoside; or where the lingering aftertaste, metallic aftertaste and/or bitter aftertaste of the one or more substances in part (b) are reduced by the addition of rubusoside and/or glycosylated rubusoside. In this embodiment, the substances in part (a) can be obtained from stevia extracts, by fermentation, or by bioconversion; the rubusoside or glycosylated rubusoside can be obtained from sweet tea extracts, by chemical synthesis, by fermentation, by bio-conversion from stevioside, or by bio-conversion from other substances, such as terpenes. In some embodiments, part (b) comprises Reb A. In some embodiments, part (b) comprises Reb B. In some embodiments, part (b) comprises Reb D. In some embodiments, part (b) comprises Reb E. In some embodiments, part (b) comprises Reb I. In some embodiments, part (b) comprises Reb M. In some embodiments, part (b) comprises Reb A and Reb B. In some embodiments, part (b) comprises Reb A and Reb D. In some embodiments, part (b) comprises Reb A and Reb E. In some embodiments, part (b) comprises Reb A and Reb M. In some embodiments, part (b) comprises Reb B and Reb D. In some embodiments, part (b) comprises Reb B and Reb E. In some embodiments, part (b) comprises Reb B and Reb M. In some embodiments, part (b) comprises Reb D and Reb E. In some embodiments, part (b) comprises Reb D and Reb M. In some embodiments, part (b) comprises Reb E and Reb M. In some embodiments, part (b) comprises Reb A and Reb I. In some embodiments, part (b) comprises Reb B and Reb I. In some embodiments, part (b) comprises Reb D and Reb I. In some embodiments, part (b) comprises Reb E and Reb I. In some embodiments, part (b) comprises Reb M and Reb I. In some embodiments, part (b) comprises Reb A, Reb B and Reb D. In some embodiments, part (b) comprises Reb A, Reb B and Reb E. In some embodiments, part (b) comprises Reb A, Reb B and Reb M. In some embodiments, part (b) comprises Reb B, Reb D and Reb E In some embodiments, part (b) comprises Reb B, Reb D and Reb M. In some embodiments, part (b) comprises Reb D, Reb E and Reb M. In some embodiments, part (b) comprises Reb A, Reb B and Reb I. In some embodiments, part (b) comprises Reb A, Reb D and Reb I. In some embodiments, part (b) comprises Reb A, Reb E and Reb I. In some embodiments, part (b) comprises Reb A, Reb M and Reb I. In some embodiments, part (b) comprises Reb B, Reb D and Reb I. In some embodiments, part (b) comprises Reb B, Reb E and Reb I. In some embodiments, part (b) comprises Reb B, Reb M and Reb I. In some embodiments, part (b) comprises Reb D, Reb E and Reb I. In some embodiments, part (b) comprises Reb D, Reb M and Reb I. In some embodiments, part (b) comprises Reb E, Reb M and Reb I.

In some embodiments, the weight ratio of part (a) to part (b) is 1:99 to 99:1. In some embodiments, the ratio (w/w) of the composition in part (a) to the composition in part (b), is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is about, or great than, 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

The inventor has surprisingly found a sweetness synergy between the sweet tea derived products and other sweeteners. In one embodiment, a composition of the present application includes: A) one or more ingredients selected from STEs, STCs, GSTEs, GSTCs, ST-MRPs and G-ST-MRPs; and B) one or more ingredients selected from following components:

(1) A GMG or mixtures of GMGs.

(2) A GMG in combination with a sugar donor.

(3) A GMG in combination with a GSG.

(4) A GMG in combination with an SG.

(5) A GMG in combination with an MG.

(6) A GMG, a GSG and a sugar donor.

(7) A GMG, an SG and a sugar donor.

(8) A GMG, an MG and a sugar donor.

(9) A GMG, a GSG and an SG.

(10) A GMG, a GSG and an MG.

(11) A GMG, an SG and an MG.

(12) A GMG, a GSG, an SG and an MG.

(13) A GMG, a GSG an SG and a sugar donor.

(14) A GMG, a GSG, an MG and a sugar donor.

(15) A GMG, a GSG an SG, an MG and a sugar donor.

(16) An MG, an SG, a GSG and a sugar donor.

(17) An MG and a GSG.

(18) An MG, a GSG and an SG.

(19) An MG, a GSG and a sugar donor.

(20) An MG, a GSG, an SG and a sugar donor.

(21) A stevia extract.

(22) A stevia extract and a sugar donor.

(23) A steviol glycoside (SG).

(24) A steviol glycoside (SG) and a sugar donor.

(25) A glycosylated steviol glycoside (GSG).

(26) A glycosylated steviol glycoside (GSG) and a sugar donor.

(27) A swingle extract (mogroside extract).

(28) A swingle extract (mogroside extract) and a sugar donor.

(29) A glycosylated swingle extract.

(30) A glycosylated swingle extract and a sugar donor.

(31) A mogroside (MG) or a mixture of MGs.

(32) A mogroside (MG) and a sugar donor.

(33) A glycosylated mogroside (GMG).

(34) A glycosylated mogroside and a sugar donor

(35) A steviol glycoside (SG) and a glycosylated steviol glycoside (GSG).

(36) A steviol glycoside (SG), a glycosylated steviol glycoside (GSG) and a sugar donor.

(37) Any of the above 36 combinations further including one or more salts.

(38) Any of the above 37 further including a sweetener.

(39) Any of the above 38 combinations further including a sweetener enhancer.

(40) Any of Maillard reaction products using above 39 combinations as raw material for Maillard reactions.

It should be understood, that in the 40 combinations noted above, that where the singular is used, e.g., a glycosylated stevia glycoside, that the plural of such is included, e.g., glycosylated stevia glycosides.

An embodiment of composition comprises (A) and (B), where the ratio of (A) to (B) is from 1:99 to 99:1. A further embodiment of food and beverage comprises (A) and (B). An additional embodiment of food and beverage comprises (A) and (B), where the total amount of (A)+(B) is from 1 ppm to 10,000 ppm.

Caramelization could occur in the course of Maillard reaction. Exemplary reactions include:

1. equilibration of anomeric and ring forms

2. sucrose inversion to fructose and glucose

3. condensation

4. intramolecular bonding

5. isomerization of aldoses to ketoses

6. dehydration reactions

7. fragmentation reactions

8. unsaturated polymer formation

One embodiment comprises one or more of these non-volatile substances originated from ST-MRPs including remaining sugar donor, remaining amine donor, it could also include caramelized substances such as disaccharides, trisaccharides, tetrasaccharides etc. which are formed by sugar donors, dimer-peptide, tri-peptide, tetra-peptides etc. which are formed by amine donors, glycosylamine and their derivatives such as Amadori compounds, Heyns compounds, enolisated compounds, sugar fragments, amino acid fragments and non-volatile flavor compounds which are formed by Maillard reaction of sugars and amino acid donors.

Thickeners such as hydrocolloids or polyols are used in liquid to improve the mouth feel by increasing the viscosity, they are also used in solid base product as filler for low cost sugar products. However, they could create a chalky or a floury taste, and higher viscosities would make a beverage less palatable. Therefore, there is a need to find a solution to reduce the amount of thickeners to be used for food and beverage especially for sugar, fat and salt reduction products. The inventors surprisingly found that adding one or more ST-MRPs could enhance the mouth feel of thickeners and have a synergistic effect without necessarily increasing the viscosity, thus improving the palatability of the food or beverage. An embodiment comprises one or more ST-MRPs and sweetening agent(s), or a mixture of one or more ST-MRPs, sweetening agent and thaumatin) and a thickener, wherein the thickener is selected from one or more hydrocolloids and/or polyols. In one embodiment, the composition of the present invention can comprise one or more ST-MRPs and at least one of sweetening agent and/or sweeteners. The one or more ST-MRPs are a direct result of a Maillard reaction without separation or purification. The one or more ST-MRPs comprise the reaction product of an amine donor and a sugar donor. Wherein, the sugar donor comprises reducing sugar, sweetener and/or sweetening agent. The sweetener comprises one or more sweeteners selected from the group consisting of sorbitol, xylitol, mannitol, aspartame, acesulfame-K, neotame, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, sodium cyclamate, or mixtures thereof. The sweetening agent comprises one or more products selected from the group consisting of a licorice extract, a stevia extract, a swingle extract, a glycosylated stevia extract, a glycosylated swingle extract, a glycosylated steviol glycoside, a glycosylated mogroside or mixtures thereof. SGEs includes one or more steviol glycoside components (SGCs). From the perspective of volatile and non-volatile substances, the Maillard reaction comprises volatile substances (comprising pure and impure substances) and non-volatile substances (comprising pure and impure substances).

ST-MRPs may include various isolated products, either partially volatile substances or partially non-volatile substances removed from the direct result of the Maillard reaction. With increasing demand of natural flavors such as vanilla, citrus, cocoa, coffee etc., the food and beverage industry face a big challenge to meet consumers' requirements. For example, the harvest of citrus in recent years has been heavily influenced by fruit disease which has created a shortage. Vanilla, coffee and Cocoa supply is always strongly influenced by climate. To increase their availability, farmers have to use more land to compete with other necessary cultivation of food and vegetable products, thus there is an additional danger of deforestation. Therefore, there is a need to find alternative sources to complement the market demand. The inventors surprisingly found that adding one or more ST-MRPs could significantly improve the taste profile of flavors, lower the threshold of flavors and reduce the amount of flavors to be used. An embodiment comprises one or more ST-MRPs (or mixture of one or more ST-MRPs and sweetening agent, or mixture of one or more ST-MRPs, sweetening agent and thaumatin) and a flavor.

Consumers are demanding ‘cleaner’ labels while retailers demand longer shelf life. The use of natural antioxidants such as tocopherols and rosemary extracts can solve these problems simultaneously. However, natural antioxidants always retain their own characteristic aroma, which makes it difficult to incorporate them in food and beverages. There is a need to look for alternative solutions. The inventors surprisingly found that adding one or more ST-MRPs to food or beverages could significantly reduce the negative aroma of antioxidants and provide a synergy of antioxidant property. In one embodiment, a composition comprising one or more ST-MRPs (or a mixture of one or more ST-MRPs and sweetening agent(s), or a mixture of one or more MRPs ST-MRPs, sweetening agent(s) and thaumatin) and a natural antioxidant is disclosed.

Thaumatin is a good alternative solution for sugar reduction. However, its lingering taste makes it difficult to be used at higher dosages. The inventors surprisingly found adding one or more ST-MRPs could substantially reduce the lingering and bitterness of thaumatin and widen its usage in foods and beverages. In one aspect, compositions comprising one or more ST-MRPs and thaumatin are disclosed, including food or beverages comprising one or more ST-MRPs and thaumatin. Addition of a sweetening agent, such as stevia, together with one or more ST-MRPs can significantly improve the taste profile of thaumatin, reducing its lingering taste. Thaumatin has synergy with one or more ST-MRPs to reduce the bitterness and/or aftertaste of stevia.

It should be understood throughout that various compositions can include combinations of one or more ST-MRP(s); or one or more ST-MRP(s) with thaumatin (or one or more sweetener(s)); or one or more ST-MRP(s) with one or more sweetening agent(s); or one or more ST-MRP(s) with one or more sweetening agent(s) and one or more sweeteners, e.g., thaumatin.

Maillard reaction products also create problems for the food industry. A lot of resources have been expended to prevent Maillard reactions in food proceeding in order to keep the good quality of food. Therefore, there is a need to find methods to produce useful Maillard reaction products which the food and beverage industry could benefit from. In one aspect, 2-Amino-1-methyl-6-phenylimidazo (4, 5-b)pyridine (PhlP) is formed in high amounts and is usually responsible for around 80% of the aromatic amines present in cooked meat products. It is listed on the IARC list of carcinogens. It is now understood that (HAAs) are over 100 fold more mutagenic than Aflatoxin B1. For example, heterocyclic aromatic amines (HAAs) can be formed under mild conditions—when glucose, glycine and creatine/creatinine are left at room temperature in a phosphate buffer for 84 days HAA's are formed. HAA's are reported in all kinds of cooked meat and fish products especially those that have been grilled, barbecued or roasted. Traditional restaurant food preparation tends to produce more HAA's than fast food outlets. With chicken, deep fat frying produces the highest levels of HAA's. Increasing mutagenic activity correlates with increased weight loss during cooking. In BBQ'd beef additional mutagenic components are present. Acrylamide for example, was first identified in 2002 by Margaret Tornquist of Stockholm University. She compared the blood samples of Swedish tunnel builders working with a sealant containing acrylamide with those of the general population. The results showed that the general population was regularly exposed to high levels of acrylamide. Rat feeding studies revealed that acrylamide increased the rates of several types of cancer. All these results showed that there is a need to find alternative solutions to provide the desired taste without these harmful substances, especially for bread, grilled meat, roasted coffee and chocolate. The inventor's solution was to select a suitable sugar and amine donor to create taste or flavor which could be added in food or beverages, especially for sweet foods and beverages. When adding healthy one or more ST-MRPs, it would allow for conditions of baking, frying, grilling, roasting of food at lower temperatures, to have shorter heating times, and thus reduce the amount of harmful substances, or avoid creating harmful substances compared with traditional food process methods. Meanwhile, traditional methods heat the whole food which consumes a lot of energy and creates more pollution when compared to this invention. The invention makes it possible to create new methods of baking, frying, grilling and roasting without compromising taste. In one aspect, a food or beverage can include healthy and harmless one or more ST-MRPs. Protein becomes an important healthy factor for foods and beverages. However, protein's raw egg taste and smell is an obstacle for wide use. Bean protein, whey protein and Coconut protein possess characteristic unpleasant tastes after drying. There is a need to find solutions to make them palatable. The inventors surprisingly found that adding compositions of this invention could significantly block the unpleasant taste of the protein and make it more palatable to consumers. One embodiment pertains to a composition comprising one or more ST-MRPs (or a mixture of one or more ST-MRPs and sweetening agent(s), or a mixture of one or more ST-MRPs, sweetening agent(s) and thaumatin) and protein(s). Another embodiment pertains to proteins (food) and beverages comprising one or more ST-MRPs, or a mixture of one or more ST-MRPs and one or more sweetening agent, or a mixture of one or more ST-MRPs. one or more sweetening agents and thaumatin. Reduced fat foods and beverages are prevalent in the market. However, lack of mouth feel and saturated fat taste on the tongue make them unpalatable for consumers. There exists a need to find a solution to solve it. The inventors surprisingly found adding compositions this invention could significantly improve the mouth feel and overall taste of reduced fat food and beverages. One embodiment pertains to compositions comprising fat and one or more ST-MRPs (or a mixture of one or more ST-MRPs and sweetening agent(s), or a mixture of one or more ST-MRPs, sweetening agent(s) and thaumatin). One embodiment pertains to partially or completed reduced fat foods and beverages comprising one or more ST-MRPs, or a mixture of one or more ST-MRPs and one or more sweetening agents, or a mixture of one or more ST-MRPs, one or more sweetening agents and thaumatin.

Reduced salt foods and beverages are in high demand. However, the taste is not very satisfying to most consumers. There is need to find a solution to enhance the salty taste without increasing sodium intake. The inventors surprisingly found there is synergy of one or more ST-MRPs, mixture(s) of one or more ST-MRPs and sweetening agent(s), mixture(s) of one or more ST-MRPs and sweetening agent(s) and thaumatin with salt. One embodiment pertains to reduced compositions of salt with one or more ST-MRPs, or mixture(s) of one or more ST-MRPs and sweetening agent(s), mixture(s) of one or more ST-MRPs and sweetening agent(s) and thaumatin. One embodiment provides salt foods or beverages comprising one or more ST-MRPs, or a mixture of one or more ST-MRPs and one or more sweetening agents, or a mixture of one or more ST-MRPs, one or more sweetening agents and thaumatin.

Foods and beverages containing vegetable or vegetable juices, especially garlic, ginger, beet root etc. have their strong characteristic flavors, which sometimes become taste barriers for certain consumers. There is need to find solution to neutralize or harmonize the taste of this type of food or beverage. The inventors surprisingly found that adding the compositions this invention could harmonize the taste of such foods and beverages and make them more consumer-likeable products. One embodiment provides vegetable containing foods and beverages comprising one or more ST-MRPs, or a mixture of one or more ST-MRPs and one or more sweetening agents, or a mixture of one or more ST-MRPs, one or more sweetening agents and thaumatin.

Vegetables with a bitter taste such as artichoke, broccoli, radicchio, arugula, brussels sprouts, chicory, white asparagus, endive, kale and brassica, dandelion, eggplant and bitter melon are added into foods and beverages providing healthy choices to consumers. However, there is a need to find a solution to neutralize or mask the bitter taste associated with the vegetables. The inventors surprisingly found that adding the compositions of this invention could harmonize the taste of such foods and beverages and make them more consumer-likeable products. One embodiment pertain to bitter vegetable containing foods and beverages comprising one or more ST-MRPs, or a mixture of one or more ST-MRPs and one or more sweetening agents, or mixture of one or more ST-MRPs, one or more sweetening agents and thaumatin.

Foods and beverages containing juices, juice concentrate, or fruit extract such as cranberry, pomegranate, bilberry, raspberry, lingonberry, grapefruit, lime and citrus have a sour and astringent taste. The inventors surprisingly found that adding compositions of this invention could harmonize the taste and make it acceptable to consumers. One embodiment contains fruit or fruit juice foods or beverages comprising one or more ST-MRPs, or a mixture of one or more ST-MRPs and one or more sweetening agents, or mixture of one or more ST-MRPs, one or more sweetening agents and thaumatin.

Foods and beverages containing minerals and trace elements can have a metallic taste. There is a need to find a solution to overcome this drawback. The inventors surprisingly found that adding compositions of this invention could block the metallic taste of minerals, thus improving the palatable taste of foods and beverages to consumers. One embodiment pertains to mineral enriched foods or beverages comprising one or more ST-MRPs, or a mixture of one or more ST-MRPs and one or more sweetening agents, or mixture of one or more ST-MRPs, one or more sweetening agents and thaumatin.

Vitamin fortified foods and beverages provide challenges to acceptable taste due to bitterness or stale taste associated with Vitamin B series and sour and tingling tastes for Vitamin C. The inventors surprisingly found that adding composition of this invention could block the bitterness of Vitamin B series and improve the taste and mouth feel of Vitamin C as well as overall likeability. One embodiment is a vitamin fortified food or beverage one or more ST-MRPs, or a mixture of one or more ST-MRPs and one or more sweetening agents, or mixture of one or more ST-MRPs, one or more sweetening agents and thaumatin.

Foods and beverages containing amino acids such as arginine, aspartic acid, cysteine HCl, glutamine, histidine HCl, isoleucine, lysine HCl, methionine, proline, tryptophan and valine have bitter, metallic or an alkaline taste. A solution is required to overcome these drawbacks. The inventors surprisingly found that adding compositions of this invention to amino acids could block the bitter, metallic or alkaline taste. One embodiment pertains to amino acid enriched foods and beverages comprising one or more ST-MRPs, or a mixture of one or more ST-MRPs and one or more sweetening agents, or mixture of one or more ST-MRPs, one or more sweetening agents and thaumatin.

Foods and beverages containing fatty acids such as linoleic acid, linolenic acid and palmitoleic acid have a mineral or pungent taste. There is a need to find a solution to overcome these drawbacks. The inventors surprisingly found that adding composition of this invention could block the mineral or pungent taste of fatty acids. One embodiment pertains to fatty acid containing foods and beverages comprising one or more ST-MRPs, or a mixture of one or more ST-MRPs and one or more sweetening agents, or mixture of one or more ST-MRPs, one or more sweetening agents and thaumatin.

Foods and beverages that contain natural herbs, natural herb extracts, concentrates, purified substances from herbs such as tonic water, etc. have earthy, grassy, herb tastes which are unpalatable to a lot of consumers. There is need to find a solution. The inventors surprisingly found that adding the compositions this invention could significantly mask or reduce the grassy, earthy or herb taste in such foods and beverages. One embodiment provides an herb or herb extract enriched food or beverage comprising one or more ST-MRPs, or a mixture of one or more ST-MRPs and one or more sweetening agents, or mixture of one or more ST-MRPs, one or more sweetening agents and thaumatin.

Foods and beverages that contain caffeine, tea extract, ginseng juice or ginseng extract, taurine or guarana that function to boost energy, while having an earthy or bitter taste, which requires a solution. The inventors surprisingly found that adding the compositions of this invention could significantly mask or reduce the earthy or bitter taste of such foods and beverages. One embodiment provides an energy food or beverage comprising one or more ST-MRPs, or a mixture of one or more ST-MRPs and one or more sweetening agents, or mixture of one or more ST-MRPs, one or more sweetening agents and thaumatin.

Foods and beverages that contain cocoa powder or coffee powder, cocoa or coffee extract, have a bitter taste. The inventors surprisingly found that adding the compositions of this invention could significantly mask the bitter taste and/or enhance the flavor of such foods and beverages. One embodiment provides a cocoa or coffee containing foods or beverages comprising one or more ST-MRPs, or a mixture of one or more ST-MRPs and one or more sweetening agents, or mixture of one or more ST-MRPs, one or more sweetening agents and thaumatin.

Foods and beverages that contain tea powder or tea extract, or flavored tea have a bitter taste or astringent mouth feel. The inventors surprisingly found that adding the compositions of this invention could significantly mask the bitter taste and/or improve the mouth feel.

An embodiment provides a tea containing food or beverage comprising one or more ST-MRPs, or a mixture of one or more ST-MRPs and one or more sweetening agents, or mixture of one or more ST-MRPs, one or more sweetening agents and thaumatin.

Alcoholic products such as wine, liquor, whisky etc. have huge variations in taste due to changes in quality of raw materials from year to year. Also there are customers that cannot accept the astringent taste etc. of the alcohol, thus, there is a need to find a solution to produce tasty alcohol products. The inventors surprisingly found that adding the compositions of this invention could block the astringent taste and make the product taste more full. One embodiment of alcohol in products comprising one or more ST-MRPs, or a mixture of one or more ST-MRPs and one or more sweetening agents, or mixture of one or more ST-MRPs, one or more sweetening agents and thaumatin.

Sauces, such as soy bean sauces, Jams, chocolate, butter, cheese etc. cannot depend upon fermentation to create flavors to meet consumers' demands. There is a need to find a simple solution to enhance the taste and flavor of these products. The inventors found that adding the compositions of this invention could improve the overall taste of these fermented products. One embodiment provides sauces or fermented products comprising one or more ST-MRPs, or a mixture of one or more ST-MRPs and one or more sweetening agents, or mixture of one or more ST-MRPs, one or more sweetening agents and thaumatin.

With the increase of obesity and a diabetic population, limiting sugar has become a top concern for a healthy diet choices worldwide, with consumers preferring for low sugar foods and beverages but without a sacrifice in taste. High intensive natural sugar alternatives such as stevia extract, monk fruit extract and sweet tea extract, and artificial high intensive sweetener such as sucralose, ACE-K and aspartame, are applied in foods and beverages for reduced sugar product claims, each of these highly intensive sugar alternatives has a unique taste profile but none tastes exactly like sugar. Some bring bitter or metallic off notes which results in the low sugar food and beverage to have an unsatisfactory taste to consumers' palate. A solution to improve the taste of low sugar foods and beverages is imperative in the promotion of a healthy diet.

Current beverages with low sugar or sugar free, such as fruit juices and concentrates for fruit juice, vegetable juice and concentrate for vegetable juice, fruit nectars and concentrates from fruit nectar, vegetable nectar and concentrate from vegetable nectar, taste flat and watery with an unpleasant aftertaste. The inventors surprisingly found that adding the composition of this invention could improve the taste profile, remove bitter or metallic aftertaste, and make the beverage taste more like sugar. One embodiment of low sugar or sugar free beverages comprising one or more ST-MRPs, or a mixture of one or more ST-MRPs and one or more sweetening agents, or mixture of one or more ST-MRPs, one or more sweetening agents and thaumatin.

Water-based flavored beverages, including ‘sport’, ‘energy’ or ‘electrolyte’ beverages and in particular, beverages such as carbonated water-based flavored beverages, non-carbonated water based flavored beverages, concentrates (liquid or solid) for water-based flavored beverages, often taste flat and watery with an unpleasant aftertaste. The inventors surprisingly found that by adding the compositions of this invention to the beverages could improve the taste profile, remove bitter or metallic aftertaste, and/or the flavor is enhanced. One embodiment pertains to low sugar or sugar free water-based flavored beverages comprising one or more ST-MRPs, or a mixture of one or more ST-MRPs and one or more sweetening agents, or mixture of one or more ST-MRPs, one or more sweetening agents and thaumatin.

Low sugar or sugar free dairy foods and beverages such as milk and flavored milk, butter milk and flavored butter milk, fermented and renneted milk, flavored fermented and renneted milk, condensed milk and flavored condensed milk, and flavored ice-cream taste flat and watery with an unpleasant aftertaste. The inventors surprisingly found that adding the compositions of this invention could improve the taste profile, remove bitter or metallic aftertaste, enhance flavor, and improve the mouth feel and/or overall likeability. One embodiment pertains to low sugar or sugar free dairy products comprising one or more ST-MRPs, or a mixture of one or more ST-MRPs and one or more sweetening agents, or mixture of one or more ST-MRPs, one or more sweetening agents and thaumatin.

Cannabidiol (CBD) oil, for example, is extracted from the stalks, seeds and flower of plants like hemp and has a taste that is commonly described as nutty, earthy or grassy. There is a need to find a solution to make it palatable for eating and smoking. Adding the compositions of this invention to CBD oil could mask the unpleasant taste. One embodiment pertains to of CBD oil comprising one or more ST-MRPs, or a mixture of one or more ST-MRPs and one or more sweetening agents, or mixture of one or more ST-MRPs, one or more sweetening agents and thaumatin.

Nicotine has a bitter or astringent taste and aroma when inhaled. Popular electronic cigarettes require an improved taste and aroma. Adding the compositions of this invention to nicotine could mask nicotine's unpleasant taste. One embodiment pertains to nicotine contained in a cigarette product, either in solid or liquid form, comprising one or more ST-MRPs, or a mixture of one or more ST-MRPs and one or more sweetening agents, or mixture of one or more ST-MRPs, one or more sweetening agents and thaumatin.

The compositions of the present application could be used in the cosmetic, pharmaceutical, and feed industries. In some embodiments, the compositions of the present application comprises one or more ST-MRPs. In some embodiments, the compositions of the present application comprises one or more ST-MRPs and one or more other additives such as thickeners, flavors, salts and fats. In some embodiments, the compositions of the present application comprises one or more ST-MRPs and one or more sweetening agents. In some embodiments, the compositions of the present application comprises one or more ST-MRPs, one or more sweetening agents and thaumatin.

Maillard reaction products from Maillard reaction can taste bitter when applied to foods and beverages, especially when the reaction time is long at elevated temperatures or when the Maillard reaction products are used at higher dosages. For bitterness-sensitive people, Maillard reaction products are bitter at all concentrations in solution. The inventors found ST-MRPs could block the bitterness of Maillard reaction products, while one or more ST-MRPs could modify the lingering, bitterness, aftertaste etc. Surprisingly, the bitterness from STEs, STCs, GSTEs, GSTCs and ST-MRPs are not superimposed or multiplied.

In some instances MRPs taste bitter. Thaumatin has a slow sweetness onset and lingering sweetness. Surprisingly, when combing (1) a MRP, such as a ST-MRP or a C-MRP, with (B) one or more products selected from STEs, STCs, GSTEs, GSTCs and (C) thaumatin together, the bitterness of STEs, STCs, GSTEs, GSTCs and lingering of thaumatin are not superimposed or multiplied. To the contrary, STEs, STCs, GSTEs, and GSTCs act as bridge between MRPs and thaumatin, while MRPs act as a bridge between STEs, STCs, GSTEs, GSTCs and thaumatin to create a pleasant integrated taste profile.

Depending on requirement of flavor or flavor enhancing intensity, sweetening derived one or more ST-MRPs could be further blended with a sweetening agent(s), sweetener(s) or other ingredients to obtain acceptable taste and aroma profiles.

In one aspect, a flavoring agent(s) in combination with one or more ingredient selected from STEs, STCs, GSTEs, GSTCs, ST-MRPs and G-ST-MRPs is provided. It has been found that substances including rubusoside surprisingly protects the flavoring agent. Not to be limited by any theory, there is a surprising protective effect exerted by the sweet tea or rubusoside-rich derived products on the flavoring agent(s).

For example, unlike typical powdered flavoring agents which have a strong aroma, the inventors have surprisingly found that the combination of (1) one or more ingredient selected from STEs, STCs, GSTEs, GSTCs, ST-MRPs and G-ST-MRPs and (2) one or more flavoring agents in a powder form results in a composition with minimal smell. However, when the same combination is dissolved in a solution (e.g., water, alcohol or mixtures thereof), the aroma of the flavoring agent is released resulting in a strong smell.

The above observations are not meant to be limited to powders. The one or more ingredient selected from STEs, STCs, GSTEs, GSTCs, ST-MRPs and G-ST-MRPs and the flavoring agent(s) can be part of a liquid composition, such as a syrup.

In one aspect, the reaction products of the embodiments described herein can be dissolved at neutral pH.

In one embodiment, the processes of the embodiments described herein are useful for improvement of taste and aroma profile for other natural sweeteners, including but not limited to licorice, thaumatin etc., their mixtures, their mixtures with sweet tea or rubusoside-rich derived products, etc.

In another embodiment, the processes of the embodiments described herein are used for improvement of taste and aroma profile for other synthetic sweeteners, including but not limited to AC-K, aspartame, sodium saccharin, sucralose or their mixtures.

The embodiments described above are applicable for any synthetic sweetener, blends thereof and other natural sweeteners, blends thereof, or mixtures of synthetic and natural sweetener(s), especially with sucralose.

For example, one or more ingredients selected from the group consisting of STEs, STCs, GSTEs, GSTCs, ST-MRPs and G-ST-MRPs could be added in ratio of from about 1 to about 99% on a weight/weight basis of total raw material into the following formulation to create a Baked ham flavor:

Water 10%

Pork lard 5% to 10%

Cysteine 1% to 5%

Xylose 1% to 5%

Char Oil hickory 1% to 5%

Hydrolyzed vegetable protein 5% to 10%

Sunflower oil 50% to 75%

Mix them well with heating to 110 degree C. for two hours.

Cool with mixing to 95 degree C. for one hour.

Allow to separate and filter top oil layer while warm.

Another example is to add one or more ingredients selected from the group consisting of STEs, STCs, GSTEs, GSTCs, ST-MRPs and G-ST-MRPs in ratio of from about 1 to about 99% on a weight to weight basis of total material in the following formulation to create tea flavored products:

Reducing sugar: high fructose corn syrup

Protein: theanine

Acids: citric acid or phosphoric acid

The ratio of reducing sugar and acid is 1 to 0.5. Theanine is from about 0.01 to about 0.5%.

1. The mixture was heated at 100 to 120 degree C. for 15 minutes.

2. Soluble tea solids was added to the solution and then heated at 182 degree C. for 30 minutes. The ratio of tea solids and reducing sugar is about 1:6 to about 2:8.

3. Distilled water was added to the mixture and kept at 100 degree C. for 45 minutes followed by filtration.

Another example is to add one or more ingredients selected from the group consisting of STEs, STCs, GSTEs, GSTCs, ST-MRPs and G-ST-MRPs by ratio of from about 1 to about 99% on a weight to weight basis of total raw material in the following formulation to create specific vegetable flavored products:

Reducing sugars: glucose, fructose, or sucrose.

Dehydrated vegetables: cabbage, onion, leek, tomato, eggplant, broccoli sprouts, kidney beans, corn, and bean sprouts.

| | | |
|---|---|---|
| Soybean oil | 500~700 | Kgs. |
| Selected vegetable | 30~70 | Kgs. |
| Sugar and water | 25~50 | Kgs. |
| Cysteine | 0.001~0.05 | Kgs. |

The mixture was mixed uniformly and maintained at the temperature of 135 degree C. for 3 hours.

The solution was cooled down.

Mushroom flavor products can be prepared by adding one or more compositions selected from STE, STC, GSTE, GSTC in ratio of from about 1 to about 99% on a weight to weight basis of total raw material by following procedures:

1. Mushroom Hydrolysate:

Milled dry mushroom 10 to about 30 grams were mixed with distilled water in a ratio of 1:10 to about 1:50.

The mixtures were preheated at 85 degree C. for 30 minutes in order to denature protein.

After cooling the mixture to 0 degree C., the enzymatic hydrolysis was conducted in two steps.

1st Step:

The pH of the mixture was adjusted to about 4 to about 6, then cellulase was added at a ratio of 2:100 or 5:100 while the temperature was between about 55 and about 70 degrees for 2˜3 hours.

2nd Step:

The pH was adjusted to 7, then neutral protease was added with at a ratio of 3:100.

The mixture was digested at 55 degree C. for another 2 hours.

The hydrolysate was heated at 100 degree C. or higher for 30 minutes to inactivate the enzymes and was then centrifuged.

The final supernatant was collected.

2. Maillard Reaction of Mushroom

D-xylose (0.05˜0.20 g) and L-cysteine (0.10˜0.20 g) were dissolved into 30 ml of mushroom hydrolysate.

The pH of the mixture was adjusted to 7.4˜8.

Then the mixture was heated at 140 degree C. for 135 minutes.

In another embodiment, one or more ingredient selected from the group consisting of STEs, STCs, GSTEs, GSTCs, ST-MRPs and G-ST-MRPs in ratio of from about 1 to about 99% on a weight to weight basis of total raw material could be added in the following enzyme modified cheese flavor process:

Cheddar cheese base preparation: Cheddar cheese: 48% Water: 48%

Trisodium Citrate: 2%

Salt: 1.85%

Sorbic Acid: 0.15%

Method:

Cook the cheddar cheese base, then cool cheddar cheese base to about 40˜45 centigrade, add the enzyme (the enzyme could be one or more selected from Lipase AY30, R, Protease M, A2, P6, Glutaminase SD);

Mix thoroughly;

Pour the mixture into the jar provided, seal the lid;

Incubate for 7.5 hours at 45 centigrade;

Allow to cool.

In another embodiment, one or more ingredient selected from the group consisting of STEs, STCs, GSTEs, GSTCs, ST-MRPs and G-ST-MRPs could be added in ratio of from about 1 to about 99% on weight to weight basis of total raw material in the following White meat reaction flavor preparation formulation:

1.25 g Cysteine, 1.00 g leucine, 1.25 g xylose, 2.00 g dextrose, 2.00 g salt, 3 g torula yeast bionis goldcell (one or more other type of yeasts such as baker's yeast Biospringer BA10, Autolyzed Yeast D120/8-PW, Maxarome standard powder, Prime Extract Maxarome Selected, HVP (Protex 2538, Exter 301, Springer 2020, Gistex HUMLS could be used too), 1.5 g sunflower oil, and 13 g water.

Method: Make the mixture and heat it as per general process flavor's production method.

In another embodiment, one or more ingredient selected from the group consisting of STEs, STCs, GSTEs, GSTCs, ST-MRPs and G-ST-MRPs could be added in ratio of from about 1 to about 99% on a weight to weight basis of total raw material in the following Red meat reaction flavor preparation:

1.5 g cysteine hydrochloride, 1.0 g methionine, 1.0 g thiamine, 1.0 g xylose, 1.5 g MSG, 0.5 g riboside, 9.0 g maxarome plus, 5.0 g gistex, 1.5 g onion powder, 1.0 g groundnut oil, 0.1 g black pepper oleoresin, and 26.0 g water.

Method: Weigh ingredients into screw cap bottles provided;

Mix thoroughly then measure the PH;

React under pressure at 125 centigrade for 30 minutes at 20 psi.

Above prepared flavors could be used in beef burger as an example:

102 g Minced beef, 100 g Minced chicken, 36 g chopped onion, 5 g rusk (dry type), 3 g water, 2.5 g salt, 0.25 g ground black pepper and 1.25˜3.00 g reaction flavors.

Method: weigh ingredients into a bowl; mix until ingredients combined; divide into 60 g portion; form into a burger shape, fry.

Again, it should be emphasized that one or more ingredient selected from the group consisting of STEs, STCs, GSTEs, GSTCs, ST-MRPs and G-ST-MRPs detailed herein can be added before, during or after the Maillard reaction, preferably before and during the reaction without limitation of examples. The amine donor could be amino acid, peptide, protein or their mixture from either vegetable or animal source or their mixture. The fat could be either vegetable or animal source or their mixture, too.

Consumers are now open and willing to experiment with spices to experience new flavors like tamarind, lemongrass, ginger, kaffir lime, cinnamon and clove. From candy to beer to tea, everything with ginger is now fashionable. Ginger works well in alcoholic beverages as a mixer, in ginger beer itself, in confections, muffins and cookies.

Sodium metabisulfite, olive oil and ascorbic acid were found to be effective to stabilize the antibacterial activity. 1.5% CMC shows a good performance too. Ginseng is one of the top 10 best-selling herbal dietary supplements in US, but ginseng-containing products have been mostly limited to beverages, despite a growing functional food market. The original ginseng flavors include bitterness and earthiness and must be minimized in order to establish potential success in the US market. The embodiments described herein can successfully solve this issue and make new ginseng food products such as cookies, snacks, cereals energy bars, chocolates and coffee with great taste.

In Asia, especially south-east Asia, Rose, Jasmine, Pandan, Lemon grass, yellow ginger, blue ginger, lime leaf, curry leave, Lilies, basil, coriander, coconut etc. are specific local flavors. In East Asia, many herbs are used in the cooking such as Artemisia argyi, dandelion, Codonopsis pilosula, Radix salviae Miltiorrhizae, Membranous Milkvetch Root, rhizoma gastrodiae etc. The inventors have found that adding one or more STEs, STCs, GSTEs, GSTCs, ST-MRPs and G-ST-MRPs could significantly improve the taste profile of these flavors and their added products. For example, one or more ingredients selected from adding one or more STEs, STCs, GSTEs, GSTCs, ST-MRPs and G-ST-MRPs can be added in ratio of from about 1 to about 99% on a weight to weight basis of total raw material in the following processes to prepare such flavored products:

Lilies as a raw material were washed and milled to give a lily slurry.

Alpha-amylase (0.1-0.8%) was added and treated at 70 degree C. for one and half hours.

Protease (0.05-0.20% by mass of the lily) was then added and heated at 55 degree C. for 70 minutes.

One or more ingredients selected from adding one or more STEs, STCs, GSTEs, GSTCs, ST-MRPs and G-ST-MRPs could be also added in following process:

Fenugreek Extract:

The seeds were roasted and crushed uniformly.

The seeds was extracted with ethyl alcohol, filtered to obtain a yellowish brown solution followed by concentration.

An extract 10 parts, glucose 1 part and proline 0.6 parts were mixed together and heated at 110˜120 degree C. for 4˜6 hours.

Savory is full of flavor, delicious and tasty-usually something that someone has cooked.

Savory foods are appetizing, pleasant or agreeable to the taste or smell, but there is a need to find suitable compatible a sweet taste balanced solution. One or more ingredients selected from adding one or more STEs, STCs, GSTEs, GSTCs, ST-MRPs and G-ST-MRPs can be added into following formulation in ratio of 1˜99% on a weight to weight basis of total raw material to produce well balanced sweet products:1) Tomato sauce formula:

| | | |
|---|---|---|
| olive oil | 25~50 | grams |
| onion diced | 150~200 | grams |
| garlic minced | 10~20 | grams |
| tomato paste | 600~900 | grams |
| salt | 5~10 | grams |
| basil chopped | 10~20 | grams |
| black pepper ground | 0.5~2 | gram |

Cooking and mixing for 25 minutes

2) Grilled Flavor Formula:

Beef tallow or soybean oil is passed through a grilling device being heated at 450 degree C. continuously. The grilled flavor is collected through a condenser.

3) Roasted Meat Flavor:

A mixture of 8.0˜10 grams of cysteine, 8.0˜10 grams of thiamine, and 300 grams of vegetable protein hydrolysate is brought to 1000 grams by the addition of water and adjusted to a pH of 5.

The mixture is then boiled under reflux condition (100˜110 degree C.) at atmospheric pressure for 3-5 hours and allowed to cool. A roasted meat flavor was formed.

4) Chicken Base Flavored Products:

| water | 10% |
|---|---|
| hydrolyzed vegetable protein | 10~20% |
| xylose | 0.10~0.50% |
| cysteine | 0.20~0.50% |
| Premixing to form slurry. | |
| Adding premix to sunflower oil while mixing. | |
| sunflower oil | 50~80% |

Heating with constant mixing to about 100˜110 degree C. for two to three hours.

Cool the mixture down to about 80 degree C. with mixing for another one hour.

Flavonoids are an important and widespread group of plant natural products that possess many biological activities. These compounds are part of the wide range of substances called “polyphenols”, which are widely known mainly by their antioxidant properties, and are present in human dietary sources showing great health benefits.

Neohesperidine and naringin, which are flavanone glycosides present in citrus fruits and grapefruit, are responsible for the bitterness of citrus juices. These substances and their derivates, such as neohesperidine chalcone, naringin chalcone, phloracetophenone, neohesperidine dihydrochalcone, naringin dihydrochalcone etc. can be good candidates for bitterness or sweetener enhancers. The inventors surprisingly found adding these components in the compositions described herein could help the masking the bitterness or aftertaste of other ingredients and made the taste cleaner. One embodiment includes the compositions described herein and further comprises flavonoids, more preferably flavonoids containing flavanone glycosides. The ratio of flavonoids in the composition could be in range of from about 0.1 ppm to 99.9%.

Metal salts of dihydrochalcone having the following formula:

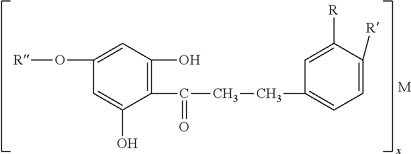

wherein R is selected from the group consisting of hydrogen and hydroxy, R′ is selected from the group consisting of hydroxy, methoxy, ethoxy and propoxy, and R″ is selected from the group consisting of neohesperidoxyl, B-rutinosyl and β-D-glucosyl, M is a mono- or divalent metal selected from the group consisting of an alkali metal and an alkaline earth metal, and n is an integer from 1 to 2 corresponding to the valence of the selected metal M.

Typical compounds of the above formula are the alkali or alkaline earth metal monosalts of the following:

Neohesperidin dihydrochalcone, having the formula:

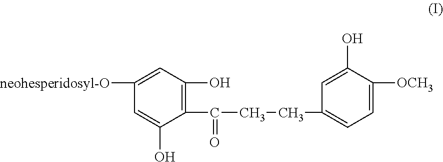

2′, 4′, 6′, 3-tetrahydroxy-4-n-propoxydihydrochalcone 4′-β neohesperidoside having the formula:

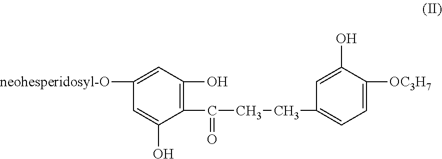

naringin dihydrochalcone of the formula:

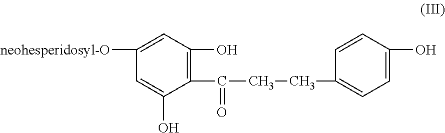

prunin dihydrochalcone of the formula:

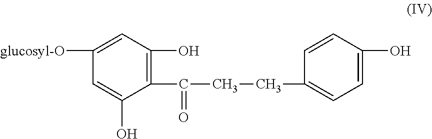

hesperidin dihydrochalcone having the formula:

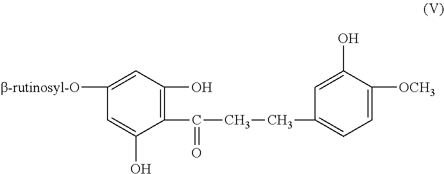

and hesperitin dihydrochalcone glucoside having the formula:

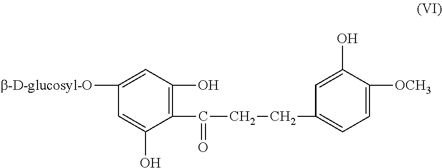

The alkali metal includes sodium, potassium, lithium, rubidium, cesium, and ammonium, while the term alkaline earth metal includes calcium, strontium and barium. Other alkali amino acids can serve as counterions. Thus embodiments of compositions described herein further comprises one or more salts of dihydrochalcone.

The compositions described herein can further comprise one or more products selected from Trilobatin, phyllodulcin, Osladin, Polypodoside A, Eriodictyol, Homoeriodicyol sodium salt, hesperidin or hesperetin, Neohesperidin dihydrochalcone, naringin dihydrochalcone, or advantame to provide additional flavors and products. Another embodiment comprises of the compositions described herein and one or more of the aforementioned products, wherein the ratio of one or more products selected in the composition can be in the range of from about 0.1% to about 99.9%.

Advantame is high potency synthetic sweetener and can be used as a flavor enhancer. The inventors found that adding advantame into the compositions described herein can boost the flavor and taste profile of a food or beverage. In one aspect, Advantame can be added after conventional or non-conventional Maillard reaction. One embodiment provides compositions described herein which further comprise advantame, wherein the amount of advantame can be in the range of from about 0.01 ppm to about 100 ppm.

Creating a sweet enhanced meat process flavor can be obtained by adding STE, STC, GSTE, GSTC by using one or more of following ingredients: A source of Sulphur: Cysteine, (cystine), glutathione, methionine, thiamine, inorganic sulphides, meat extracts, egg derivatives; Amino Nitrogen Source: Amino acids, HVP's, yeast extracts, meat extracts; The Sugar Component: Pentose and hexose sugars, Vegetable powders, (onion powder, tomato powder), hydrolyzed gums, dextrins, pectins, alginates. Fats and Oils: Animal fats, vegetable oils, coconut oil. Enzyme hydrolyzed oils and fats. Other Components: Herbs, spices, IMP, GMP, acids, etc.

Pigs, especially young pigs, appreciate good and pleasant tastes and aroma much the way young children do. Cats are notoriously fussy about the taste and smell of their feed. Feeds such as rapeseed meal, which has a bitter taste, are used as good protein sources for cattle, sheep, and horses. Even chickens are known for their taste discrimination, as chickens are selective to their feeds. Green, natural or organic farming of animals become more and more popular. Therefore, there is a need to find a solution to satisfy market requirements. An embodiment of feed or feed additives comprises the compositions described herein.

The intense sweetness and flavor/aroma enhancement properties of the compositions described herein provide useful applications in improving the palatability of medicines, traditional Chinese medicine, food supplements, beverage, food containing herbs, particularly those with unpleasant long-lasting active ingredients not easily masked by sugar or glucose syrups, let alone sweetening agents or synthetic high intensity sweeteners. The inventors surprisingly found the compositions described herein can mask the unpleasant taste and smell of the products containing these substances, for instance Goji berries juice, sea buckthorn juice, milk thistle extract, Ginkgo biloba extract etc. Thus traditional Chinese medicine, or food supplements can be combined with one or more of compositions described herein, especially when used as a masking agent.

Except for a reduced sugar donor and an amine donor, all other ingredients can be either added before, during and after the conventional Maillard reaction, more preferably before and during the Maillard reaction. An embodiment of composition in this invention is prepared by adding all ingredients in the Maillard reaction to react together.

Products such as maltol, ethyl-maltol, vanillin, ethyl vanillin, m-methylphenol, and m-(n)-propylphenol can further enhance the mouthfeel, sweetness and aroma of the compositions described herein. In some embodiments, the sweetener or flavoring agent composition of the present application further comprises one or more products selected from maltol, ethyl-maltol, vanillin, ethyl vanillin, m-methylphenol, m-propylphenol. In some embodiments, the sweetener or flavoring agent compositions of the present application comprises a combination of one or more C-MRPs and maltol, C-MRPs and Vanillin, a combination of one or more ST-MRP and maltol, a combination of one or more ST-MRP and vanillin, etc. are provided. In some embodiments, a food or beverage comprises the above-described sweetener or flavoring agent compositions.

Aquaplants and seafood cultivated from fresh water or sea water always have a fish smell or marine aroma. Examples of aromaiferous aquatic foodstuffs include spirulina powder or its enriched protein extract, protein extracted from duckweeds (lemnoideae family), fish protein, fish meal etc. There is a need to minimize or cover the unpleasant aroma to make the food product palatable. The inventors surprisingly found that compositions described herein could be added in these products to minimize the aromas to make them more acceptable to consumers including feeds for animals. Embodiments of consumables comprise components from aquaplants and/or seafood, and any of the compositions described herein.

Foods and beverages containing acids can irritate the tongue. For instance, products containing acetic acid can irritate the tongue and make that product unpalatable. The inventors surprisingly found that adding any of the compositions described herein could significantly balance the acid taste and make the products palatable.

Beverages containing vinegar, such as apple cider vinegar drink, shrub, switchel etc. have become popular in the market due to vinegar's health attributes. The acetic acid can be naturally occurring, for instance it is originated from fermentation of fruits such as apple, pear, persimmon etc., grains such as rice, wheat etc. It could be also synthetic. However, the taste of acetic acid is strong and sour and tends to burn the throat. Therefore, there is a need to find a solution to harmonize it. The inventors surprisingly found that adding any of the compositions described herein can strongly harmonize the taste of beverages containing acetic acid and make them palatable. One embodiment provides a composition comprising acetic acid and any of the compositions described herein. Another embodiment provides a method to harmonize the taste of acetic acid by using any of the compositions described herein. Another embodiment provides a consumable that comprises acetic acid and any of the compositions described herein. Another embodiment provides the use of any the compositions described herein in beverages containing acetic acid, where the dosage of the composition(s) described herein is above 10(⁻⁹) ppb. Embodiments of the composition(s) described herein include, for example, one or more STEs, STCs, GSTEs, GSTCs, ST-MRPs and G-ST-MRPs, combinations of thaumatin and one or more STEs, STCs, GSTEs, GSTCs, ST-MRPs and G-ST-MRPs, combinations of one or more of STEs, STCs, GSTEs, GSTCs, ST-MRPs and G-ST-MRPs and one or more high intensity sweeteners, combinations of thaumatin, one or more STEs, STCs, GSTEs, GSTCs, ST-MRPs and G-ST-MRPs, and one or more high intensity sweetener.

Thermotreating STE, STC, GSTE, GSTC, especially thermo-reaction treatment can result in improved taste of STE, STC, GSTE, GSTC. Thermo-treatment is like caramelization of STEs, STCs, GSTEs, GSTCs (without MRPs). The temperature range can be from 0-1000° C., in particular from about 20 to about 200° C., more particularly from about 60 to about 120° C. The period of treatment can be from be from a few seconds to a few days, more particularly about one day and even more particularly from about 1 hour to about 5 hours.

The inventors surprisingly found that adding one or more STEs, STCs, GSTEs, GSTCs, ST-MRPs and G-ST-MRPs, combinations of (1) thaumatin and (2) one or more STEs, STCs, GSTEs, GSTCs, ST-MRPs and G-ST-MRPs, combinations of (1) one or more STEs, STCs, GSTEs, GSTCs, ST-MRPs and G-ST-MRPs and (2) one or more high intensity sweeteners, combinations of (1) thaumatin, (2) one or more STEs, STCs, GSTEs, GSTCs, ST-MRPs and G-ST-MRPs and (3) high intensity sweetener in food and beverages containing alcohol can enhance the strength of alcohol. Embodiments provide food and beverages containing alcohol comprising composition selected from one or more STEs, STCs, GSTEs, GSTCs, ST-MRPs and G-ST-MRPs.

Flavor of beer, the size and the amount of bubbles are important factors in measuring the quality of beer. Compositions described herein can be used for enhancing the flavor of beer taste and to adjust the size and amount of bubbles. In one embodiment, beer or beer containing products can include one or more STEs, STCs, GSTEs, GSTCs, ST-MRPs and G-ST-MRPs.

Foods having high sugar content such as area catechu, spicy bar (or called spicy strip, hot strip, spicy glutein), pickled vegetables, meat and fishes, or fermented foods always require large amounts of sugar in order to balance the total taste profile and make them more palatable. The inventors surprisingly found that adding thaumatin, one or more of STEs, STCs, GSTEs, GSTCs, ST-MRPs and G-ST-MRPs, combinations of (1) one or more STEs, STCs, GSTEs, GSTCs, ST-MRPs and G-ST-MRPs and (2) thaumatin, combinations of (1) one or more STEs, STCs, GSTEs, GSTCs, ST-MRPs and G-ST-MRPs and (2) high intensity sweetener, or combinations of (1) one or more STEs, STCs, GSTEs, GSTCs, ST-MRPs and G-ST-MRPs, (2) one or more high intensity sweetener and (3) thaumatin, could significantly improve the taste profile and/or palatability, especially when sugar reduction is required for such foods. For example, embodiments of such compositions include area catechu, spicy bar, pickled food, or fermented foods with one of composition(s) described herein.

Vegetable burgers have become popular in recent years, but the taste is still not palatable to most consumers. Compositions described herein can be used for enhancing the flavor and taste of the vegetable burger. In one embodiment, a vegetable burger comprises thaumatin, one or more STEs, STCs, GSTEs, GSTCs, ST-MRPs and G-ST-MRPs, combinations of (1) one or more STEs, STCs, GSTEs, GSTCs, ST-MRPs and G-ST-MRPs and (2) thaumatin, combinations of (1) one or more STEs, STCs, GSTEs, GSTCs, ST-MRPs and G-ST-MRPs and (2) high intensity sweetener, or combinations of (1) one or more STEs, STCs, GSTEs, GSTCs, ST-MRPs and G-ST-MRPs, (2) one or more high intensity sweetener and (3) thaumatin.

Grilled foods often incorporate sugar to enhance the taste. However, sugar creates strong colors during grilling, and when the fried foods become cold, the sugar syrup becomes sticky. The inventors found that by adding the compositions described herein to the food to be grilled, these disadvantages can be overcome. For example, embodiments include grilled foods that include thaumatin, one or more of STEs, STCs, GSTEs, GSTCs, ST-MRPs and G-ST-MRPs, combinations of (1) one or more STEs, STCs, GSTEs, GSTCs, ST-MRPs and G-ST-MRPs and (2) thaumatin, combinations of (1) one or more STEs, STCs, GSTEs, GSTCs, ST-MRPs and G-ST-MRPs and (2) high intensity sweetener, or combinations of (1) one or more STEs, STCs, GSTEs, GSTCs, ST-MRPs and G-ST-MRPs, (2) one or more high intensity sweetener and (3) thaumatin.

An embodiment of composition comprises A) one or more ingredients selected from STEs, STCs, GSTEs, GSTCs, ST-MRPs and G-ST-MRPs and B) one or more substances selected from fibers such as polydextrose; inulin, Promitor produced by Tate&Lyle; monosaccharide-derived polyols such as erythritol, mannitol, xylitol, and sorbitol; disaccharide-derived alcohols such as isomalt, lactitol, and maltitol; and hydrogenated starch hydrolysates, synthetic high intensity sweeteners such as sodium saccharin, sucralose, aspartame, acesulfame-K, N—[N-[3-(3-hydroxy-4-methoxyphenyl)propyl]-alpha-aspartyl]-L-phenylalanine 1-methyl ester, sodium cyclamate, neotame; natural low intensity sweeteners such as trehalose, raffinose, cellobiose, tagatose, DOLCIA PRIMA™ allulose; Natural high intensity sweeteners such as Licorice extract, glycyrrhizin-derived substances, stevia extract, monk fruit extract, glycosylated stevia extract, glycosylated monk fruit extract; modified starch such as Rezista, Claria, Kolgauard etc. produced by Tate&Lyle; or mixtures thereof. A further embodiment of composition comprises A) and B), where ratio of A) to B) is from 1:99 to 99:1. An additional embodiment of composition comprises A) and B), where the final product is in powder or liquid form. A certain embodiment of a food and beverage syrup comprises A) and B).

An embodiment of composition comprises A) one or more ingredients selected from STEs, STCs, GSTEs, GSTCs, ST-MRPs and G-ST-MRPs and B) a stevia glycoside composition contains one or more stevia glycosides selected from Reb A, Reb B, Reb C, Reb D, Reb E, Reb I, Reb M, Reb N, Reb O, Stevioside. An additional embodiment of composition of A) and B), where ratio of A) to B) is from 1:99 to 99:1. A further embodiment of food and beverage comprises A) and/or B), where the total concentration of A) is in range of 1 ppm to 10,000 ppm; and/or B) where the total concentration of B) is in range of 1 ppm to 2,000 ppm. A certain embodiment of a food and beverage syrup comprises A) and B).

The inventor surprisingly found that the present application can improve the solubility of stevia extract, stevia glycosides. An embodiment comprises A) one or more STEs, STCs, GSTEs, GSTCs, ST-MRPs and G-ST-MRPs and B) one or more stevia glycosides selected from Reb A, Reb B, Reb C, Reb D, Reb E, Reb I, Reb M, Reb N, Reb O, Stevioside, where A) could improve the solubility of B).

Rubusoside could inhibit absorption of glucose and fructose in intestine. Without limiting the theory, stevia extract, stevia glycosides, sweet tea extract, and sweet tea component may block the absorption of lactose, gluten, absorption by humans in intestine and nasal cavity. An embodiment of a product comprising one or more ingredient selected from STEs, STCs, GSTEs, GSTCs, ST-MRPs and G-ST-MRPs is used to improve the tolerance of lactose, gluten. A further embodiment to use such consumable for weight management.

The volatile substances from sweet tea could form aerosol when formulated in food and beverage. These substances could inhibit the absorption of pollen or other substances which could bring the allergies to humans. A method to use one or more STEs, STCs, GSTEs, GSTCs, ST-MRPs and G-ST-MRPs in anti-allergy products. The product could be consumable, or health supplement or medical formulation such as sprayer.

Another aspect of the present application relates to compositions comprising one or more terpenoid glycosides (TGs). TGs include steviol glycosides and other high intensity natural sweetening agents from plants, including glycosides, which may serve as sugar substitutes, and which are further described below.

A glycoside is a molecule in which a sugar is bound to another functional group via a glycosidic bond. The sugar group is known as the glycone and the non-sugar group as the aglycone or genin part of the glycoside. Glycosides are prevalent in nature and represent a significant portion of all the pharmacologically active constituents of botanicals. As a class, aglycones are much less water-soluble than their glycoside counterparts.

Depending on whether the glycosidic bond lies “below” or “above” the plane of the cyclic sugar molecule, glycosides of the present application can be classified as α-glycosides or β-glycosides. Some enzymes such as α-amylase can only hydrolyze α-linkages; others, such as emulsin, can only affect β-linkages. Further, there are four types of linkages present between glycone and aglycone: a C-linked glycosidic bond, which cannot be hydrolyzed by acids or enzymes”; an O-linked glycosidic bond; an N-linked glycosidic bond; or an S-linked glycosidic bond.

The glycone can consist of a single sugar group (monosaccharide) or several sugar groups (oligosaccharide). Exemplary glycones include glucose, galactose, fructose, mannose, rhamnose, rutinose, xylose, lactose, arabinose, glucuronic acid etc. An aglycone is the compound remaining after the glycosyl group on a glycoside is replaced by a hydrogen atom. When combining a glycone with an aglycone, a number of different glycosides may be formed, including steviol glycosides, terpenoid glycosides, alcoholic glycosides, anthraquinone glycosides, coumarin glycosides, chromone glycosides, cucurbitane glycosides, cyanogenic glycosides, flavonoid glycosides, phenolic glycosides, steroidal glycosides, iridoid glycosides, and thioglycosides.

For example, the term “flavonoid aglycone” refers to an unglycosylated flavonoid. Flavonoid aglycones include flavone aglycones, flavanol aglycones, flavanone aglycones, isoflavone aglycones and mixtures thereof. Thus, the terms “flavone aglycone”, “flavanol aglycone”, “flavanone aglycone” and “isoflavone aglycones” refer to unglycosylated flavones, flavanols, flavanones and isoflavones, respectively. More particularly, the flavonoid aglycone may be selected from the group consisting of apigenin, luteolin, quercetin, kaempferol, myricetin, naringenin, pinocembrin, hesperetin, genistein, and mixtures thereof.

Terpenoid glycosides (TGs) for use in the present application, include e.g., steviol glycosides, Stevia extracts, mogrosides (MGs), Siraitia grosvenorii (luo han guo or monk fruit) plant extracts, rubusosides (RUs), Rubus suavissimus (Chinese sweet tea) plant extracts; flavanoid glycosides, such as neohesperidin dihydrochalcone (NHDC); osladin, a sapogenin steroid glycoside from the rhizome of Polypodium vulgare; trilobatin, a dihydrochalcone glucoside from apple leaves; eriodictyol, a bitter-masking flavonoid glycoside extracted from yerba santa (Eriodictyon californicum), one of the four flavanones extracted from this plant as having taste-modifying properties, along homoeriodictyol, its sodium salt, and sterubin; polypodoside A (from the rhizome of Polypodium glycyrrhiza); phyllodulcin, a coumarin glycoside found in Hydrangea macrophylla and Hydrangea serrata; swingle glycosides, such as mogroside V, mogroside IV, siamenoside I, and 11-oxomogroside V, which are cucurbitane glycosides; monatin, a naturally occurring, high intensity sweetener isolated from the plant Sclerochiton ilicifolius, and its salts (monatin SS, RR, RS, SR); hernandulcin, an intensely sweet chemical compound gained from the chiefly Mexican and South American plant Lippia dulcis; phlorizin, plant-derived dihydrochalcone that is a glucoside of phloretin, which is found primarily in unripe Malus (apple) and the root bark of apple; glycyphyllin, an alpha-L-rhamnoside derived from phloretin, the aglucone of phlorizin, a plant-derived dihydrochalcone; baiyunoside, a diterpene glycoside isolated from the Chinese drug Bai-Yun-Shen; pterocaryoside A and pterocaryoside B, secodammarane saponin glycosides isolated from Pterocarya paliurus Batal. (Juglandaceae), which are native to China; mukuroziosides Ia, Ib, IIa and Iib, acyclic sesquiterpene oligoglycosides isolated from the pericarp of Sapindus mukurossi and Sapindus rarak; phlomisoside I, a furanolabdane-type diterpene glycoside isolated from the roots of the Chinese plant, Phlomis betonicoides Diels (Lamiaceae); periandrin I and V, two sweet-tasting triterpene-glycosides from Periandra dulcis; abrusoside A-D, four sweet tasting triterpene glycosides from the leaves of Abrus precatorius; cyclocariosides I; II, and III, and synthetically glycosylated compositions thereof (e.g., GSGs, glycosylated Stevia extracts, etc.). Lithocarpus litseifolius folium (latin name) is a sweet tea species. Phlorizin and trilobatin are the main ingredients. Phlorizin is a glucoside of phloretin, a dihydrochalcone. Phlorizin is abundant in the leaves of another kind of Sweet Tea (Lithocarpus polystachyus Rehd), too.

In some embodiments, the composition of the present application is a flavor composition comprises one or more glycosylated non-stevia terpenoids glycoside from GSGs, GSG-MRPs, GSTEs, GSTCs, GSTE-MRPs, GSTC-MRPs and/or G-ST-MRPs in an amount of above 0.01 ppm, 0.1 ppm, 1 ppm, 10 ppm, 100 ppm, 1,000 ppm, 1%, 5%, 10%, 20%, 50% or 90% by weight.

In some embodiments, the flavor composition comprises one or more glycosylated non-stevia terpenoid glycoside from GSGs, GSG-MRPs, GSTEs, GSTCs, GSTE-MRPs, GSTC-MRPs and/or G-ST-MRPs in an amount of above 0.01 ppm, 0.1 ppm, 1 ppm, 10 ppm, 100 ppm, 1,000 ppm, 1%, 5%, 10%, 20%, 50%, 90%, where the content of glycosylated non-sweet terpenoids is higher than the natural sources or their natural extracts. For example, Glycosylated stevia glycosides or stevia extracts contains higher glycosylated non-sweet terpenoids than their feeding material of stevia glycosides and Stevia extract before glycosylation. GSTEs, GSTCs contain higher glycosylated non-stevia terpenoid glycosides than their STEs and STCs before glycosylation. Glycosylated non-stevia terpenoid glycosides in GSGs, glycosylated stevia extract, GSTEs, GSTCs could serve as sugar donor to react with amine donor during Maillard reaction.

In some embodiments, the consumable product is a beverage and the beverage comprises the one or more glycosylated non-stevia terpenoid glycoside from GSGs, GSG-MRPs, GSTEs, GSTCs, GSTE-MRPs, GSTC-MRPs and/or G-ST-MRPs in an amount of 0.01-5000 ppm.

It should be understood that throughout this specification, when reference is made to a specific terpenoid glycoside or high intensity natural sweetening agent, such as an SG, a Stevia extract, a mogroside, a swingle extract, a sweet tea extract, NHDC, or any glycosylated derivative thereof, that the example is meant to be inclusive and applicable to all of the other terpenoid glycosides or high intensity natural sweetening agents in these classes. The same principle applies to other sweeteners; when reference is made to a sweetening agent, such as a terpenoid glycoside sweetener, steviol glycoside sweetener, high intensity natural sweetener, sweetener enhancer, high intensity synthetic sweetener, reducing sugar, or non-reducing sugar, that the example is meant to be inclusive and applicable to all of the other sweeteners or sweetening agents in any given class.

Plants contain aglycones, which normally are hydrophobic, water insoluble volatile substances. There are also glycosides in plants which are more water soluble. The inventor found that glycosylation process could make these hydrophobic compounds into water soluble and stable in water solution. The inventor surprisingly found that adding these substances in food and beverage could significantly improve the intensity of retronasal aroma, and MRPs have synergy effect with these glycoside substances to create a stronger palatable retronasal aroma when adding into food and beverage together. An embodiment of flavor composition comprises glycosylated treated ingredients to have higher glycoside contents than their natural plant sources before glycosylation treatment, where the ingredients are originated from plant sources such as leaves, flowers, fruits, berries, barks, seeds etc. An embodiment of such composition further comprises Maillard reaction products, or such composition could provide a sugar donor for Maillard reactions. An embodiment of these composition further include one or more components selected from stevia extract, stevia glycosides, glycosylated stevia extract, glycosylated stevia glycosides, sweet tea extract, sweet tea components, glycosylated sweet tea extract, glycosylated sweet tea components, monk fruit extract, monk fruit component, glycosylated monk fruit extract, glycosylated monk fruit component, licorice root extract, licorice root component, glycosylated licorice root extract, glycosylated licorice root component. An embodiment of all these types of glycosylated treated plant ingredients, their Maillard reaction blends or Maillard reacted products are used in food and beverage.

There is huge waste when producing food or beverage ingredients from natural sources, such as juice and flavor production, there is need to find solution to take use of these natural gifted waste to create new commercial value. Plant waste after extraction of flavor or other health active compounds could be useful in this invention. The present application could create commercial value to take use of every individual compounds from natural source. For example, the chocolate production process isn't typically very sustainable. The pulp, husk, and other components that surround the cacao bean are generally discarded as waste. Cacao juice is the juice from the mucilage, or the sticky pulp surrounding the cacao bean. This mucilage is a key element in the development of the flavor of chocolate. Cacao farmers use a wild fermentation process that starts with this sugary juice, which attracts certain bacteria. Cacao begins to ferment as soon as it is harvested, a process that is critical to its flavor. The cacao juice or other waste from Chocolate production or glycosylated treated cacao juice could be excellent source of raw material to provide sugar donor for additional Maillard reaction to create a fresh retronasal chocolate aroma. The same is applied for coffee products, especially for green coffee bean extract, which is rich in chlorogenic acids. An embodiment of flavor composition comprises glycosylated cacao juice. A further embodiment of consumable comprises glycosylated cacao juice and Maillard reaction products higher than their original natural sources.

Green vanilla contains glycosides, namely gluco-vanillin (vanilloside) and glucovanillic alcohol. The water or water extraction of green vanilla could be used as retronasal aroma flavor. In an embodiment, a flavor composition comprises enriched vanilla glycosides higher than the natural occurred source. A further embodiment of flavor preparation to use green vanilla as raw material. An additional embodiment of food or beverage comprises vanilloside, where the vanilloside content is higher than 0.01 ppm, 0.1 ppm, 1 ppm, 5 ppm, 10 ppm, 50 ppm, 100 ppm, 1,000 ppm. Apple contains rich flavanols, phenolic acids, dihydrochalcones, flavonols, such as gallic acid, ferulic acid, caffeic acid, phloretin-2-O-beta-glucoside, quercetin-3-O-galactoside, qucercetin-3-O-glucoside, quecetin-3-O-rutinoside, quercetin-3-O-xyloside, qucertin-3-O-arabonoside, qucertin-3-O-rahmnoside etc. The polyphenols in apple extract could be further glycosylated. The apple polyphenols or their additional glycosylated compounds could act as sugar donor for Maillard reaction. The final Maillard reaction products could be used as flavor to enhance the intensity of retronasal flavor. An embodiment of a flavor composition comprises glycosides in apple polyphenols higher than its original natural sources. A further embodiment of a consumable comprises apple polyphenols with enriched glycosides in amount of higher than 0.01 ppm, 0.1 ppm, 1 ppm, 5 ppm, 100 ppm, 1,000 ppm, 5,000 ppm.

Green coffee bean is rich in chlorogenic acids, but also contains other substances such as three trans-cinnamic acids (caffeic, ferulic and dimethoxycinnamic), six cinnamoyl-amino acid conjugates (caffeoyl-N-tyrosine, p-coumaroyl-N-tyrosine, caffeoyl-N-tryptophan, p-coumaroyl-N-tryptophan, feruloyl-N-tryptophan, caffeoyl-N-phenylalanine) and three cinnamoyl glycosides (caffeoylhexose, dicaffeoylhexose and dimethoxycinnamoylhexose). The green coffee bean extract could be glycosylated. Green coffee bean extract and/or glycosylated green coffee bean extract could act as sugar donor or amine donor for Maillard reactions. An embodiment of a flavor composition comprises glycosylated substances in green coffee bean extracts higher than its original natural sources. A further embodiment of a consumable comprises green coffee bean extracts with enriched glycosylated substances in amounts higher than 0.01 ppm, 0.1 ppm, 1 ppm, 5 ppm, 100 ppm, 1,000 ppm, 5,000 ppm, 1%, 5%, 10%.

Flavonoids are widely contained in citrus such as lemon, conferring the typical taste and biological activities to lemon. There are five main flavonoid glycosides, of which the aglycone are eriocitrin, narirutin, hesperidin, rutin, and diosmin, respectively. Citrus extract could be glycosylated. Citrus extract or its glycosylated product could act as sugar donor for Maillard reaction. An embodiment of a flavor composition comprises glycosylated substances in citrus extracts higher than its original natural sources. A further embodiment of a consumable comprises lemon extract with enriched glycosylated substances in amount of higher than 0.01 ppm, 0.1 ppm, 1 ppm, 5 ppm, 100 ppm, 1,000 ppm, 5,000 ppm, 1%, 5% or 10% by weight.

Oleoresins are semi-solid extracts composed of a resin in solution in an essential and/or fatty oil, obtained by evaporation of the hydrocarbon solvent(s) used for their production. Compared to essential oils obtained by steam distillation, oleoresins are rich in heavier, less volatile and lipophilic compounds, such as resins, waxes, fats and fatty oils. Gummo-oleoresins (oleo-gum resins, gum resins) occur mostly as crude balsams and contain also water-soluble gums. Oleoresins are prepared from spices, such as basil, capsicum (paprika), cardamom, celery seed, cinnamon bark, clove bud, fenugreek, fir balsam, ginger, jambu, labdanum, mace, marjoram, nutmeg, parsley, pepper (black/white), pimenta (allspice), rosemary, sage, savory (summer/winter), thyme, turmeric, vanilla, West Indian bay leaves. The solvents used are nonaqueous and may be polar (alcohols) or nonpolar (hydrocarbons, carbon dioxide). The waste after removing oleoresins, preferably, the water extraction of waste after removing oleoresins, more preferably, its glycosylated treated water extraction of waste after removing oleoresin, most preferably, the fresh juice, water or water/alcohol extracted from plant source, could be used as raw material as sugar donor, to have Maillard reaction with one or more of amine donors to create a pleasant retronasal aroma. Any natural sweetening agent in this invention could be added before or after the Maillard reaction. Surely water or water alcohol extraction of whole plant source material such as flower, seed, bark, leaves etc. could be used as raw material for glycosylation and/or Maillard reaction, too. For example, Zingiberaceae is the large diverse family comprised of rhizomatous plants with a higher concentration of phenolic compounds containing aglycones and glycosides. The normal ginger (Zingiber officinale Rosc.) and black ginger (Kaempferia parviflora Wall.) belongs to this family. The water extract of whole ginger root, the fresh ginger root juice, the water or water/alcohol extraction of ginger after removing oleoresins, preferably, the glycosylated products of these extracts could be flavor ingredients. Any of these ginger extract or their glycosylated products could be used as sugar donor to have Maillard reaction with any single or combined amine donors. One or more natural high intensity sweetener could be added before or after the Maillard reaction.

Natural sources used to produce food and beverage, such as apple to produce apple juice, citrus peels to produce citrus flavor. During the concentration of juice, water soluble volatile substances could be collected and could be used in the formulation of retronasal aroma. An embodiment of retronasal aroma composition comprises water soluble volatile substances. In some embodiments, the consumable product is a beverage or food, and the beverage or food comprises a) one or more STEs, GSTEs, STCs, GSTCs, ST-MRPs and/or G-ST-MRPs and b) water soluble volatile substances from fruit juices, berries, species, where the water soluble volatile substances in an amount of 0.01-5000 ppm.

The glycosides from original plants, their extracts or after glycosylation of plant extracts, could provide sugar donor to Maillard reaction and create a stable form of aroma substances, which could result in stronger and palatable retronasal flavor for consumables, such as food and beverage. An embodiment of composition comprises Maillard reaction products prepared by reacting an amine donor with a sugar donor of glycosides from one or more ingredient selected from isolated glycosides from plant, plant extract, additional glycosylation treated glycosides isolated from plant, and additional glycosylation treated plant extracts with or without additional sugar donors.

An embodiment of method to produce a palatable flavor by making Maillard reaction of amine donor and one or more ingredient selected from plant extract, isolated glycosides from plant, additional glycosylation treated glycosides isolated from plant, and glycosylation treated plant extract. It could further add sugar donor.

An embodiment of food and beverage comprises ingredients prepared by Maillard reaction of amine donor and one or more ingredient selected from isolated glycosides from plant, plant extract, additional glycosylation treated glycosides isolated from plant, and additional glycosylation treated plant extract with or without additional sugar donor.

The glycosides can also originate from animal sources. Amine donors can originate from animal sources, vegetable sources, fermentation, or chemical synthesis. The Maillard reaction could be controlled to have complete reaction by consuming amine donor and/or sugar donor completely or it contains residue of amine donor and/or sugar donor. An embodiment of flavor comprises one or more ingredients selected from a sugar conjugated substance from plant, an amine conjugated substance and their reacted products. An embodiment of consumable comprises such ingredient.

The embodiments described above are applicable for any synthetic sweetener, blends thereof and other natural sweeteners, blends thereof, or mixtures of synthetic and natural sweetener(s), especially sucralose.

Diabetes is a chronic disease that occurs either when the pancreas does not produce enough insulin or when the body cannot effectively use the insulin it produces. To regulate the blood sugar, people with diabetes are instructed not to take or take less sugared consumables. The same is true for obese people. However, in such cases, there is an increased risk of developing depression. The consumables containing the compositions in present application could activate clusters of neurons either unconsciously or consciously, enhance consumers' attention of recognition of energy sources and flavors, initiate the reward system in the brain and create a hedonic feeling. Elderly people are prone to losing memory and developing Alzheimer's disease. Consumable products containing the compositions in the present application could produce familiar tastes and flavors, thus preventing or slowing the progress of memory loss and Alzheimer's disease development. An embodiment of a consumable product includes one or more compositions of ST-MRPs and GSG-MRPs, which could improve the quality of lives for people with diabetes, depression and obesity in e.g., elderly people by activating the cluster of neurons in brain that generate hedonic feelings. An embodiment of such consumables could further activate the reward system in brain, and exhibit synergistic effects with caffeine or natural extracts containing caffeine.

High intensity sweeteners can have the disadvantage of slow onset, which can create a big challenge for the brain to recognize the safety of consumable products containing high intensity sweeteners. Slow-onset also distracts the attention for identifying unpleasant tastes, as well as unsynchronized tastes and flavors, which can generate a feeling of dislike. Quick onset of sweetness is an important feature for consumables containing sweeteners. The perceived quick onset feeling depends on the momentum of sweetness (momentum=velocity×strength), which is related to two factors: velocity and strength of sweet recognition. The inventor has surprisingly found that compositions containing different components and amounts according to the present application can improve the momentum of sweetness. Embodiments of comprising the substances of the present application can be used for improving the velocity and strength of sweetness.

Consumable products containing high intensity sweeteners generally lack long lasting flavor or contain flavors that are lost quickly during storage. Normally, the shelf lives of consumables are shorter. The inventor has surprisingly found that using compositions of the present application could significantly enhance and preserve the flavors in consumables, and extend their shelf life. Accordingly, the present application provides compositions for extending the shelf lives of consumables.

Honey is a sweet, viscous food substance made by honey bees and certain related insects. Bees produce honey from the sugary secretions of plants or honeydew. Honey consists mostly of glucose, fructose, maltose, and sucrose; water; other minor components include proteins, organic acids, amino acids, vitamins, flavonoids, and acetylcholine. The inventor has surprisingly found that the addition of honey or honey distillate as a sugar donor could significantly accelerate the recognition of sweetness and improve the taste and flavor profile of high intensity sweeteners.

Carrots are a traditional food containing sucrose, glucose, xylose, fructose and heptose. Carrot juice can be used as sugar donor in a Maillard reaction. Carrot juice distillates can be added before or after the Maillard reaction to enhance the sweet taste and flavor profile. Additional sweeteners, such as maple syrup, agave syrup and their hydrolyzed products, birch water, sweet fruit juices, including berry juices from e.g., strawberries and raspberries, and other fruit juices from cherries, pineapples, grapes, pears, apples, peaches, apricots, bananas, tomato etc. and vegetable juices from carrots, tomatoes etc. can be good sources for the sugar donor in the Maillard reactions of the present application.

In one embodiment, a sweetener or flavor includes (a) one or more substances selected from STEs, SGs, GSTEs, GSGs, ST-MRPs, and GSG-MRPs, and (b) one or more components selected from honey, agave syrup, maple syrup, birch water and any fruit, berry or vegetable juice. A further embodiment includes a method for using one or more components selected from honey or honey distillate, sugar-cane juice, syrup or distillates, sugar beet juice, syrup or distillate, agave syrup or distillate, maple syrup or distillate, birch water or concentrate, and any fruit, berry, vegetable juice and distillates, any animal or plant source sweet products as a sugar donor in the Maillard reaction and their resulting reaction products for use in consumable products in an amount between about 1 to 5,000 ppm. In another embodiment, a sweetener or flavor includes one or more compositions selected from ST-MRPs and GSG-MRPs, which can activate the orbitofrontal cortex and adjoining agranular insula.

Fractions of fruit or vegetable juices, such as fruit juice distillates, fruit juice volatile concentrates or any type of fractions originated from fruits or vegetables etc. can be added to a composition during or after the Maillard reaction. Fractions of fruit juices can accelerate secretion and flow of saliva, thereby improving the freshness and speed of flavor recognition. In one embodiment, a sweetener or flavor includes (a) one or more compositions selected from STEs, SGs, GSTEs, GSGs, ST-MRPs, GSG-MRPs; and (2) one or more fractions of fruit juices. In a further embodiment, a composition containing MRPs is produced from fractions of fruit or vegetable juices during or after the reaction.

Oral viscosity can be perceived by the human primary taste cortex, mid insular area, and the orbitofrontal and perigenual cingulate cortices. It is known that the perigenual cingulate cortex can be activated by the texture of fat in the mouth and sucrose. Surprisingly, compositions of the present application can activate the perigenual cingulate cortex and medial orbitofrontal cortex so as to improve the mouthfeel of consumables containing high intensity sweeteners. In further embodiments, a sweetener or flavor comprises compositions of the present application that activate the insular taste cortex.

High intensity sweeteners do not activate neurons in the vagal ganglia and brainstem via the gut-brain axis to produce feelings of satiety. However, in certain embodiments, compositions of the embodiment of the present application containing high intensity sweeteners and one or more products selected from ST-MRPs and GSG-MRPs can stimulate such neurons to create a sugar-taking feeling without the accompaniment of ingested calories.

The inventor of the present application has surprisingly found that compositions containing glycosylated rubusosides can improve the taste profile of stevia glycosides, glycosylated stevia glycosides. In one embodiment, a sweetener or flavor comprises glycosylated rubusosides and one or more substances selected from stevia glycosides, glycosylated stevia glycosides to provide an improved taste profile.

### Additional Embodiments

The following paragraphs enumerated consecutively from 1 through 101 provide for various aspects of the present invention.

1. A flavoring or sweetening composition comprising one or more sweet tea (ST)-derived products selected from the group consisting of RU, GRU, RU-MRP, GRU-MRP, STC, GSTC, STE, GSTE, ST-MRP, G-ST-MRP, SU, GSU, SU-MRP and GSU-MRP, wherein the one or more products are present in the flavoring or sweetening composition in a total amount of 0.001-99.9 wt %, and wherein the one or more products are prepared by cell extraction, enzymatic conversion or chemical synthesis.

2. The composition of paragraph 1, comprising a sweetener composition.

3. The composition of paragraph 1, comprising a flavoring composition.

4. The composition of paragraph 1, comprising a sweetener composition and a flavoring composition.

5. The composition of any one of paragraphs 1-4, wherein the one or more ST-derived products comprise a diterpene glycoside.

6. The composition of any one of paragraphs 1-5, wherein the one or more ST-derived products are selected from the group consisting of RU, STC, STE, SU, and combinations thereof.

7. The composition of paragraph 6, wherein the one or more ST-derived products comprise RU.

8. The composition of paragraph 7, wherein the one or more ST-derived products comprise RU in an amount (w/w) greater than zero, but less than 95%, less than 80%, less than 70%, less than 50%, less than 30%, less than 20%, less than 10%, less than 5%, less than 1%, less than 0.5%, or less than 0.1%.

9. The composition of paragraph 6, wherein the one or more ST-derived products comprise one or more STEs, optionally wherein the one or more STEs comprise RU20, RU30, RU40, RU50, RU60, RU70, U80 or RU90.

10. The composition of paragraph, 9, wherein at least one of the one or more STEs comprises an enriched diterpene glycoside in an amount of 50-99 wt % of the STE.

11. The composition of paragraph 10, wherein the enriched diterpene glycoside is RU.

12. The composition of paragraph 10, wherein the enriched diterpene glycoside is produced by from enzyme catalyzed conversion of steviol glycosides to rubusoside.

13. The composition of paragraph 9, wherein at least one of the one or more STEs comprises at least 50-99 wt % of stevioside, wherein at least a portion of the total stevioside are hydrolyzed to form an enriched RU composition.

14. The composition of any one of paragraphs 9-13, wherein at least one of the one or more STEs comprises one or more one or more sweet tea derived components (STCs) selected from the group consisting of rubusoside (RU), suavioside (SU), steviolmonoside, rebaudioside A, 13-O-β-D-glucosyl-steviol, isomers of rebaudioside B, isomers of stevioside, panicloside IV, sugeroside, ent-16α,17-dihydroxy-kaurane-19-oic acid, ent-13-hydroxy-kaurane-16-en-19-oic acid, ent-kaurane-16-en-19-oic-13-O-β-D-glucoside, ent-16β,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, isoquercitrin, and any combination thereof.

15. The composition of any one of paragraphs 9-14, wherein at least one of the one or more STEs comprises one or more suaviosides selected from the group consisting of SU-A, SU-B, SU-C1, SU-D1, SU-D2, SU-E, SU-F, SU-G, SU-H, SU-I, SU-J, and any combination thereof.

16. The composition of paragraph 5, wherein the diterpene glycoside comprises a glycosylated diterpene glycoside.

17. The composition of paragraph 16, wherein the glycosylated diterpene glycoside comprises a steviol or isosteviol aglycone.

18. The composition of paragraph 16 or 17, wherein the glycosylated diterpene glycoside comprises a sugar linked to a hydroxyl group of the steviol aglycone at C13 and/or C19.

19. The composition of paragraph 18, wherein the glycosylated diterpene glycoside comprises a sugar linked to a hydroxyl group of the isosteviol aglycone at C1 and/or a carbonyl group at C16.

20. The composition of any one of paragraphs 16-19, wherein the glycosylated diterpene glycoside is an O-glycoside, a C-glucoside, glucose-ester or methylene-glucoside.

21. The composition of any one of paragraphs 16-20, wherein the glycosylated diterpene glycoside comprises a sugar linked to the steviol or isosteviol agylcone according to a conjugation listed in Table 1.

22. The composition of any one of paragraphs 16-22, wherein the glycosylated diterpene glycoside is a glucosylated glycoside.

23. The composition of paragraph 22, wherein the glucosylated glycoside between 1-20 sugar groups conjugated to one or more positions of the aglycone.

24. The composition of any one of paragraphs 16-23, wherein the diterpene glycoside is GRU, optionally wherein the GRU is GRU10, GRU20, GRU30, GRU40, GRU50, GRU60, GRU70, GRU80 or GRU90.

25. The composition of paragraph 24, wherein the GRU is present in the composition in an amount (w/w) greater than zero, but less than 95%, less than 80%, less than 70%, less than 50%, less than 30%, less than 20%, less than 10%, less than 5%, less than 1%, less than 0.5%, or less than 0.1%.

26. The composition of paragraph 24, wherein the GRU comprises mono-glucosylated rubusoside, a di-glucosylated rubusoside or a tri-glucosylated rubusoside present in the composition in a total amount (w/w) of at least 0.1%, at least 0.5%, at least 1%, at least 5%, at least 10%, at least 20%, at least 30%, at least 50%, at least 70%, at least 90%, or at least 95%.

27. The composition of paragraph 1, wherein the one or more products are selected from the group consisting of GSTC, GSTE, GSU, and any combination thereof.

28. The composition of paragraph 27, wherein the one or more products comprise at least one GSTE.

29. The composition of paragraph 28, wherein the at least one GSTE comprises GRU, optionally wherein the GRU is selected from the group consisting of GRU is GRU10, GRU20, GRU30, GRU40, GRU50, GRU60, GRU70, GRU80 or GRU90.

30. The composition of paragraph 29, wherein the composition comprises mono-glucosylated rubusosides in a total amount (w/w) of at least 0.1%, at least 0.5%, at least 1%, at least 5%, at least 10%, at least 20%, at least 30%, at least 50%, at least 70%, at least 90%, or at least 95%.

31. The composition of paragraph 29, wherein the composition comprises mono and di-glucosylated rubusosides in a total amount (w/w) of at least 0.1%, at least 0.5%, at least 1%, at least 5%, at least 10%, at least 20%, at least 30%, at least 50%, at least 70%, at least 90%, or at least 95%.

32. The composition of paragraph 29, wherein the composition comprises mono, di, and tri-glycosylated rubusosides in a total amount (w/w) of at least 0.1%, at least 0.5%, at least 1%, at least 5%, at least 10%, at least 20%, at least 30%, at least 50%, at least 70%, at least 90%, or at least 95%.

33. The composition of paragraph 29, wherein the composition comprises mono, di, tri- and tetra glycosylated rubusosides in a total amount (w/w) of at least 0.1%, at least 0.5%, at least 1%, at least 5%, at least 10%, at least 20%, at least 30%, at least 50%, at least 70%, at least 90%, or at least 95%.

34. The composition of paragraph 29, wherein the composition comprises mono, di, tri-, tetra and penta-glycosylated rubusosides in a total amount (w/w) of at least 0.1%, at least 0.5%, at least 1%, at least 5%, at least 10%, at least 20%, at least 30%, at least 50%, at least 70%, at least 90%, or at least 95%.

35. The composition of paragraphs 29, wherein the composition comprises penta-glycosylated rubusosides in a total amount (w/w) that is greater than zero, but less than 95%, less than 80%, less than 70%, less than 50%, less than 30%, less than 20%, less than 10%, less than 5%, less than 1%, less than 0.5%, or less than 0.1%.

36. The composition of paragraph 29, wherein the composition comprises tetra and penta-glycosylated rubusosides in a total amount (w/w) that is greater than zero, but less than 95%, less than 80%, less than 70%, less than 50%, less than 30%, less than 20%, less than 10%, less than 5%, less than 1%, less than 0.5%, or less than 0.1%.

37. The composition of paragraph 29, wherein the composition comprises tri, tetra and penta-glycosylated rubusosides in a total amount (w/w) that is greater than zero, but less than 95%, less than 80%, less than 70%, less than 50%, less than 30%, less than 20%, less than 10%, less than 5%, less than 1%, less than 0.5%, or less than 0.1%.

38. The composition of paragraph 29, wherein the composition comprises di, tri, tetra and penta-glycosylated rubusosides in a total amount (w/w) that is greater than zero, but less than 95%, less than 80%, less than 70%, less than 50%, less than 30%, less than 20%, less than 10%, less than 5%, less than 1%, less than 0.5%, or less than 0.1%.

39. The composition of paragraph 29, wherein the GRU is present in the composition in a total amount (w/w) that is greater than zero, but less than 95%, less than 80%, less than 70%, less than 50%, less than 30%, less than 20%, less than 10%, less than 5%, less than 1%, less than 0.5%, or less than 0.1%.

40. The composition of any one of paragraphs 28-39, wherein the composition comprises an enriched glycosylated diterpene in an amount (w/w) of 40-90% of the composition.

41. The composition of paragraph 26, wherein the enriched diterpene glycoside is GRU.

42. The composition of any one of paragraphs 1-41, wherein the one or more ST-derived products are selected from the group consisting of RU-MRP, GRU-MRP, ST-MRP, SU-MRP, GSU-MRP, and any combination thereof.

43. The composition of any one of paragraphs 1-42, further comprising one or more GSG-MRPs comprise at least one MRP selected from the group consisting of GSG-MRP-FTA, GSG-MRP-TN, GSG-MRP-CA, GSG-MRP-HO, and GSG-MRP-TA.

44. The composition of any one of paragraphs 1-43, wherein the one or more GSG-MRPs comprise 43. The composition of any one of paragraphs 1-42, further comprising one or more flavors selected from the group consisting of oil phase flavors, water phase flavors, juice concentrated aromas, fraction of oil phase flavors, crude extracts, flavors or flavor derivatives from plant sources, and flavors or flavor derivatives from animal sources.

45. The composition of paragraph 44, wherein the one or more flavors are selected from the group consisting of lemon juice concentrate aroma, orange juice volatiles concentrate extract, mandarin orange juice volatiles concentrate extract, bitter orange volatiles concentrate extract, lemon volatiles concentrate extract, cucumber juice volatiles concentrated aroma, blood orange volatiles concentrate extract, blood orange juice concentrate aroma, lime juice concentrated aroma, bilberry or blueberry juice volatile concentrate extract, cranberry juice volatile concentrate extract, pineapple juice volatile concentrate extract, peach juice volatile concentrate extract, mongo juice volatile concentrate extract, banana paste volatile concentrate extract, coconut juice volatile concentrate extract, Litchi juice volatile concentrate extract, grape volatile concentrate extract, grapefruit volatile concentrate extract, ginger juice volatile concentrate extract, ginseng juice volatile concentrate juice extract, pear juice volatile concentrate extract, pomegranate juice volatile concentrate extract, jasmine water extracted volatile concentrate, cocoa juice volatile concentrate extract, tea volatile concentrate extract, coffee volatile concentrate extract, and mint juice volatile concentrate extract.

46. The composition of paragraph 44 or paragraph 45, wherein the one or more flavors are extracted from a fruit or berry juice.

47. The composition of any one of paragraphs 44-46, wherein the one or more flavors are selected from Massoia lactone Mossoia bark extract, hydrolyzed products from cheese, butter, milk fat, casein or salts thereof, and vanilla extract.

48. The composition of any one of paragraphs 44-47, wherein the one or more flavors in the composition comprise one or more substances selected from limonene, linalool, citronellol, citral, geraniol, bergaptene, terpeneol, decanal, linalyl acetate, caryophyllene, neryl acetate, perillaldehyde, thymol, methyl N-methylanthranilate, alpha-sinensal, gamma-terpenene, and octanal.

49. The composition of any one of paragraphs 44-48, wherein the one or more flavors in the composition are present in an amount of at least 0.1%, at least 0.5%, at least 1%, at least 2%, at least 2.5%, at least 5%, or at least 10% on w/w basis, optionally wherein the one or more flavors comprise one or more volatile substances.

50. The composition of any one of paragraphs 1-49, wherein the composition further comprises one or more high intensity sweeteners.

51. The composition of paragraph 50, wherein the one or more high intensity sweeteners are selected from acesulfame-K, sucralose, saccharine, aspartame, stevia extract, stevia glycosides, monk fruit extract, mogrosides, sweet tea extract, enriched rubusoside from sweet tea or stevia, and licorice extract.

52. The composition of any one of paragraphs 1-51, wherein the composition further comprises one or more sweeteners or fibers selected from allulose, inulin, polydextrins, modified starch, erythritol.

53. The composition of any one of paragraphs 1-52, further comprising one or more stevia-derived products selected from the group consisting of one or more SGs described in Table B, one or more SG-MRPs, one or more SEs, one or more SE-MRPs, one or more GSGs, one or more GSG-MRPs, one or more GSEs, one or more GSE-MRPs and any combination thereof.

54. The composition of paragraph 53, wherein the weight ratio of sweet tea derived products to stevia-derived products is a range between 1:20 and 20:1.

55. The composition of any one of paragraphs 1-54, wherein the composition comprises one or more compounds listed in Tables 75-2 to 75-13.

56. The composition of any one of paragraphs 1-55, further comprising: (1) a Maillard reaction product (MRP) composition formed from a reaction mixture comprising: (a) one or more reducing sugars having a free carbonyl group, and (b) one or more amine donors having a free amino group; and (2) one or more sweet tea (ST)-derived products selected from the group consisting of RU, GRU, STC, GSTC, STE, GSTE, SU, and GSU, wherein the MRP composition is present in the sweetener composition in an amount in the range of 0.1-99 wt %.

57. A composition comprising one or more MRPs formed from a reaction mixture comprising: (a) one or more reducing sugars having a free carbonyl group, and (b) one or more amine donors having a free amino group; and (2) one or more sweet tea (ST)-derived products of paragraph 1, wherein the composition is present in a sweetener composition in an amount in the range of 0.1-99 wt %.

58. The composition of paragraph 56 or 57, wherein the reaction mixture further comprises one or more SGs described in Table 2, an SE, a GSG, or a GSE, optionally wherein the reaction mixture further comprise an SG selected from the group consisting of RA20, RA40, RA50, RA60, RA80, RA 90, RA95, RA97, RA98, RA99, RA99.5, RB8, RB10, RB15, RC15, RD6, STV60, STV90, RA75/RB15, RA90/RD7, RA80/RB10/RD6 and any combination thereof.

58. The composition of paragraph 56 or 57, wherein the one or more amine donors comprise one or more of a primary amine compound, a secondary amine compound, an amino acid, a protein, a peptide, a yeast extract or mixtures thereof.

59. The composition of paragraph 58, wherein the one or more amine donors comprise an amino acid selected from the group consisting of alanine, arginine, asparagine, aspartic acid, cysteine, glutamic acid, glutamine glycine, histidine, isoleucine, leucine, lysine, methionine, phenylalanine, proline, serine, tyrosine, tryptophan, threonine and valine.

60. The composition of paragraph 58, wherein the one or more amine donors comprise thaumatin.

61. The composition of paragraph 58, wherein the one or more amine donors comprise an amino acid and thaumatin.

62. The composition of any one of paragraphs 56-61, wherein the one or more reducing sugars comprise a monosaccharide, a disaccharide, an oligosaccharide, an polysaccharide, or a combination thereof.

63. The composition of paragraph 62, wherein the one or more reducing sugars comprise ribose, glucose, fructose, lyxose, galactose, mannose, arabinose, xylose, rhamnose, rutinose, lactose, maltose, cellobiose, glucuronolactone, glucuronic acid, D-allose, D-psicose, xylitol, allulose, melezitose, D-tagatose, D-altrose, D-alditol, L-gulose, L-sorbose, D-talitol, inulin, stachyose, emaltose, lactulose, cellubiose, kojibiose, nigerose, sophorose, laminarbiose, gentiobiose, turanose, maltulose, palantinose, gentiobiulose, mannobiose, melibiose, melibiulose, rutinose, rutinulose or xylobiose.

64. The composition of paragraph 62, wherein the one or more reducing sugars are provided in the form of a fruit juice concentrate or fruit juice, optionally apple juice or pear juice.

65. The composition of paragraph 62, wherein the one or more reducing sugars comprise isomalto-oligosaccharide, galactooligosaccaride, or fructooligosaccharide

66. The composition of any one of paragraphs 56-65, further comprising a GRU selected from the group consisting of GRU10, GRU20, GRU30, GRU40, GRU50, GRU60, GRU70, GRU80, GRU90 and any combination thereof.

67. The composition of any one of paragraphs 56-65, further comprising one or more SGs described in Table 2, an SE, a GSG, a GSE or a combination thereof.

68. The composition of paragraph 66, comprising an SE selected from the group consisting of RA20, RA40, RA50, RA60, RA80, RA 90, RA95, RA97, RA98, RA99, RA99.5, RB8, RB10, RB15, RC15, RD6, STV60, STV90, RA75/RB15, RA90/RD7, RA80/RB10/RD6 and any combination thereof.

69. The composition of paragraph 68, comprising a GSG formed from an SE selected from the group consisting of RA20, RA40, RA50, RA60, RA80, RA 90, RA95, RA97, RA98, RA99, RA99.5, RB8, RB10, RB15, RC15, RD6, STV60, STV90, RA75/RB15, RA90/RD7, RA80/RB10/RD6 and any combination thereof.

70. The composition of any one of paragraphs 56-69, further comprising one or more sweeteners selected from the group consisting of sorbitol, xylitol, mannitol, sucralose, aspartame, acesulfame-K, neotame, erythritol, Luo Han Guo extract, trehalose, raffinose, cellobiose, tagatose, allulose, inulin, N—[N-[3-(3-hydroxy-4-methoxyphenyl)propyl]-alpha-aspartyl]-L-phenylalanine 1-methyl ester, glycyrrhizin, sodium cyclamate, brazzein, miraculin, curculin, pentadin, mabinlin, thaumatin, neohesperidin dihydrochalcone (NHDC), naringin dihydrochalcone, maltol, ethyl maltol, advantame, and combinations thereof.

71. The composition of any one of paragraphs 56-69, further comprising further comprising one or more S-MRPs comprise at least one MRP selected from the group consisting of GSG-MRP-FTA, GSG-MRP-TN, GSG-MRP-CA, GSG-MRP-HO, GSG-MRP-TA, and any combination thereof.

72. The composition of any one of paragraphs 56-72, wherein the MRP composition has a citrus, tangerine or caramel flavor.

73. The composition of any one of paragraphs 1-72, wherein the composition comprises: (a) a glycosylated component selected from the group consisting of GRU, GSTE, GSU; (b) RU, STE, SU, or SE corresponding to the glycosylated component in (a); and (c) an unreacted sugar donor or residue thereof, wherein the unreacted sugar donor or residue therefrom is derived from a dextrin and is present in the composition in an amount greater than zero, but less than 15%, less than 10%, less than 5%, less than 4%, less than 3%, less than 2%, less than 1%, less than 0.5%, less than 0.1%, less than 0.05%, less than 0.01%, less than 100 ppm, less than 10 ppm, or less than 1 ppm (wt/wt).

74. The composition of paragraph 73, wherein the unreacted sugar donor or residue therefrom comprises dextrin, maltodextrin or a hydrolysis product thereof.

75. A consumable product comprising the composition in any one of paragraphs 1-74.

76. The consumable product of paragraph 75, wherein the concentration (w/w) of the composition in the consumable is greater than zero, but less than 10,000 ppm, less than 5,000 ppm, less than 1,000 ppm, less than 500 ppm, less than 100 ppm, less than 50 ppm, less than 10 ppm, or less than 1 ppm.

77. The consumable product of paragraph 75 or paragraph 76, wherein the consumable product is a beverage, food product, or personal care product.

78. The consumable product of any one of paragraphs 75-77, wherein the consumable product is a beverage.

79. The consumable product of any one of paragraphs 75-77, wherein the consumable product is a food product.

80. The consumable product of any one of paragraphs 75-77, wherein the consumable product is a personal care product.

81. The consumable product of any one or paragraphs 75-80, wherein the composition comprises one or more flavors selected from the group consisting of lemon juice concentrate aroma, orange juice volatiles concentrate extract, mandarin orange juice volatiles concentrate extract, bitter orange volatiles concentrate extract, lemon volatiles concentrate extract, cucumber juice volatiles concentrated aroma, blood orange volatile concentrate extract, blood orange juice concentrate aroma, lime juice concentrated aroma, bilberry or blueberry juice volatile concentrate extract, cranberry juice volatile concentrate extract, pineapple juice volatile concentrate extract, peach juice volatile concentrate extract, mongo juice volatile concentrate extract, banana paste volatile concentrate extract, coconut juice volatile concentrate extract, Litchi juice volatile concentrate extract, grape volatile concentrate extract, grapefruit volatile concentrate extract, ginger juice volatile concentrate extract, ginseng juice volatile concentrate juice extract, pear juice volatile concentrate extract, pomegranate juice volatile concentrate extract, jasmine water extracted volatile concentrate, cocoa juice volatile concentrate extract, tea volatile concentrate extract, coffee volatile concentrate extract, and mint juice volatile concentrate extract, and wherein the one or more flavors are present in the consumable product in an amount greater than zero, but less than 1000 ppm, less than 100 ppm, less than 50 ppm, less than 10 ppm, less than 5 ppm, less than, 1 ppm, less than 0.5 ppm, or less than 0.1 ppm.

82. The consumable product of any one of paragraphs 75-81, wherein the one or more flavors in the composition further comprise one or more substances selected from the group consisting of limonene, linalool, citronellol, citral, geraniol, bergaptene, terpeneol, decanal, linalyl acetate, caryophyllene, neryl acetate, perillaldehyde, thymol, methyl N-methylanthranilate, alpha-sinensal, gamma-terpenene, octanal, and combinations thereof.

83. The product of any one of paragraphs 75-82, wherein the composition comprises at least one sweet tea (ST)-derived product selected from the group consisting of RU, GRU, RU-MRP, GRU-MRP, STC, GSTC, STC-MRP, GSTC-MRP, STE, GSTE, STE-MRP, GSTE-MRP, SU, GSU, SU-MRP, and GSU-MRP, wherein the concentration of the at least one high intensity sweeteners in the consumable product is at least 1 ppm, at least 10 ppm, at least 100 ppm, at least 200 ppm, at least 300 ppm, at least 500 ppm, at least 1,000 ppm, or at least 10,000 ppm.

84. A method for improving the sensory profile of a beverage comprising adding to the beverage the composition of any one of paragraphs 75-83 in an amount sufficient to improve one or more sensory evaluation characteristics described in Example 5.

85. The method of paragraph 84, where addition of the composition enhances juiciness, mouthfeel, flavor, and/or overall likability; and/or where addition of the composition reduces bitterness lingering, sweetness lingering and/or metallic aftertaste.

86. The method of paragraph 84 or 85, wherein the composition is selected from the group consisting of GTRU20, GTRU20-MRP-HO, GRU40-MRP-FTA, GRU40-MRP-CA, GRU90, GRU90-MRP-TA, GRU-MRP-CA, GRU-MRP-FTA, or a combination thereof.

87. A method for improving the sensory profile of a natural sweetener comprising adding to the natural sweetener the composition of any one of paragraphs 75-83 in an amount sufficient to improve one or more sensory evaluation characteristics described in Example 5.

88. The method of paragraph 87, where addition of the composition enhances juiciness, mouthfeel, flavor, and/or overall likability; and/or where addition of the composition reduces bitterness lingering, sweetness lingering and/or metallic aftertaste.

89. The method of paragraph 87 or 88, wherein the composition is selected from the group consisting of GTRU20, GTRU20-MRP-HO, GRU40-MRP-FTA, GRU40-MRP-CA, GRU90, GRU90-MRP-TA, GRU-MRP-CA, GRU-MRP-FTA, or any combination thereof.

90. A method for replacing sugars in a beverage so as to maintain or improve the taste profile relative to the unmodified beverage, comprising adding to a reduced sugar version of the beverage the composition of any one of paragraphs 75-83 to produce a modified beverage, wherein the composition is added to the reduced sugar version of the beverage in an amount sufficient to maintain or improve the taste profile of the modified beverage relative to the unmodified beverage.

91. The method of paragraph 90, wherein the composition comprises RU20, GTRU20, GTRU20-MRP-CA, GTRU20-MRP-HO, GRU90, GRU90-MRP-TA, GRU90-MRP-FTA, GRU90-MRP-CA, GRU90-MRP-HO, GRU40-MRP-CA, GRU40-MRP-FTA, GRU10-MRP-CA, GRU10-MRP-FTA or a combination thereof.

92. A method for improving the sensory profile of a natural sweetener comprising adding to the natural sweetener the composition of any one of paragraphs 75-83 in an amount sufficient to improve one or more sensory evaluation characteristics described in Example 5.

93. The method of paragraph 92, wherein addition of the composition enhances juiciness, mouthfeel, flavor, and/or overall likability; and/or where addition of the composition reduces bitterness lingering, sweetness lingering and/or metallic aftertaste

94. The method of paragraph 92 or 93, wherein the composition comprises GTRU20, GTRU20-MRP-HO, GRU40-MRP-FTA, GRU40-MRP-CA, GRU90, GRU90-MRP-TA, GRU-MRP-CA, GRU-MRP-FTA, or a combination thereof.

94. The method of any one of paragraphs 92-94, wherein the natural sweetener is sucralose, acesulfame-K, RA97, RM, RD, RM/RD mixtures, RM/RD/RA mixtures, thaumatin, allulose, polydextrose, Luo Han Guo extract, GSG-MRP-CA, or a combination thereof.

95. A method for improving the sensory profile of a food product comprising adding to the food product the composition of any one of paragraphs 75-83 in an amount sufficient to improve one or more sensory evaluation characteristics described in Example 5.

96. The method of paragraph 95, where addition of the composition enhances the mouthfeel, flavor, and/or overall likability of the food product.

97. The method of paragraph 95 or 96, wherein the food product is selected from the group consisting of yogurt dressing, balsamic olive oil, balsamic vinegar, egg salad spread, tuna salad spread, chicken spread, pickles, beet salad, marinated mushrooms, tomato sauce, beef goulash, chili con carne, minestrone, potato cream soup, vegetable soup, garlic cream soup, broccoli cream soup and mushroom soup.

98. The method of paragraph 95 or 96, wherein the food product is a dairy product, optionally where the dairy product is yogurt, full-fat milk, cream cheese or soymilk.

99. The method of any one of paragraphs 96-98, wherein the composition is selected from the group consisting of GRU20-MRP-CA, GTRU20-MRP-CA, GTRU20-MRP-TA, GTRU20-MRP-HO, GRU90-MRP-CA, GRU90-MRP-TA, GRU90-MRP-HO, GRU90- and MRP-FTA.

100. A method to accelerate the recognition of flavor in a consumable product by adding to the consumable product the composition of any one of paragraphs 75-83 in an amount sufficient to accelerate the recognition of flavor.

101. A method to increase solubility and bioavailability of a natural sweetener, comprising adding to the natural sweetener the composition of any one of paragraphs 75-83 in an amount sufficient to increase solubility and bioavailability of the natural sweetener.

102. A stevia composition comprising rubusoside and one or more of rebaudioside A, stevioside and suavioside.

103. The stevia composition of paragraph 102, wherein the rubusoside content is greater than 1%, 5%, 10%, 20%, 30%, 40%, 50%, 60%, 70%, 80%, 90%, 95%, or 99% by weight.

104. The stevia composition of paragraph 102 or paragraph 103, comprising rebaudioside A.

105. The stevia composition of paragraph 104, wherein the rebaudioside A content is greater than 1%, 5%, 10%, 20%, 30%, 40%, 50%, 60%, 70%, 80%, 90%, 95%, or 99% by weight.

106. The stevia composition of paragraph 102 or paragraph 103, comprising stevioside.

107. The stevia composition of paragraph 106, wherein the stevioside content is less than 50%, 40%, 30%, 10%, 5%, 1%, or 0.1% by weight.

108. The stevia composition of paragraph 102 or paragraph 103, comprising a suavioside.

109. The stevia composition of paragraph 108, wherein the suavioside is selected from the group consisting of suavioside B, suavioside C1, suavioside D2, suavioside E, suavioside F, suavioside G, suavioside H, suavioside I, suavioside J and combinations thereof.

110. The stevia composition of paragraph 109, wherein the total suavioside content is less than 99%, 90%, 80%, 70%, 60%, 50%, 40%, 30%, 20%, 10%, 5% or 1% by weight.

111. The stevia composition of paragraph 104 or paragraph 105, further comprising stevioside.

112. The stevia composition of paragraph 111, wherein the stevioside content is less than 50%, 40%, 30%, 10%, 5%, 1%, or 0.1% by weight.

113. The stevia composition of paragraph 104 or paragraph 105, further comprising a suavioside.

114. The stevia composition of paragraph 113, wherein the suavioside is selected from the group consisting of suavioside B, suavioside C1, suavioside D2, suavioside E, suavioside F, suavioside G, suavioside H, suavioside I, suavioside J and combinations thereof.

115. The stevia composition of paragraph 113 or paragraph 114, wherein the total suavioside content is less than 99%, 90%, 80%, 70%, 60%, 50%, 40%, 30%, 20%, 10%, 5% or 1% by weight.

116. The stevia composition of paragraph 108 or paragraph 109, further comprising stevioside.

117. The stevia composition of paragraph 116, wherein the stevioside content is less than 50%, 40%, 30%, 10%, 5%, 1%, or 0.1% by weight.

118. The stevia composition of paragraph 111 or paragraph 112, further comprising a suavioside.

119. The stevia composition of paragraph 118, wherein the suavioside is selected from the group consisting of suavioside B, suavioside C1, suavioside D2, suavioside E, suavioside F, suavioside G, suavioside H, suavioside I, suavioside J and combinations thereof.

120. The stevia composition of paragraph 119, wherein the total suavioside content is less than 99%, 90%, 80%, 70%, 60%, 50%, 40%, 30%, 20%, 10%, 5% or 1% by weight.

121. The stevia composition of any one of paragraphs 102-120, comprising a glycosylation product of rubusoside, rebaudioside A, stevioside or a suavioside

122. The stevia composition of any one of paragraphs 102-121, comprising an MRP product formed from rubusoside, rebaudioside A, stevioside, a suavioside, a glycosylated rubusoside, a glycosylated rebaudioside A, a glycosylated stevioside, a glycosylated suavioside, or a combination thereof.

123. A method to enhance umami taste in a consumable product, comprising adding to the consumable product the composition of any one of paragraphs 1-56.

124. A method to enhance salty taste in a consumable product, comprising adding to the consumable product the composition of any one of paragraphs 1-56.

### EXAMPLES

### Example 1. Production of Treated Rubusoside 20% (TRU20)

Materials: Rubusoside 20% (Guilin Layin Natural Ingredients Corp. The concentration of RU is 20.68% Lot #STL02-151005), CaO (Sinopharm Chemical Reagent Co., Ltd)

Process:

(i) 20 g Rubusoside 20% was dissolved in 170 ml deionized water and stirred at 69° C. for 2 hours.

(ii) 60 mL 0.1 mol/L CaO was added to above (i) solution and stirred at 69° C. for 30 min.

(iii) the above (ii) solution was incubated at room temperature for 30 min, followed by centrifugation at 4000 rpm for 10 min.

(iv) the pH of the supernatant from (iii) was adjusted to about 5.3 and followed by centrifugation at 4000 rpm for 10 min.

(v) the solution from (iv) was treated with cation exchange resin (Xi'an Lanxiao Technology New Material Co., Ltd).

(vi) the solution from (v) was spray dried, yielding 10 g of TRU20 as a white powder.

### Example 2. Preparation of Glycosylated TRU 20% (GTRU20)

A glycosylated reaction product composition was prepared using Rubusoside 20% (product of Ex. 1, TRU20) according to the following method:

(i) 15 g Tapioca dextrin (BAOLIBAO BIOLOGY Co., Ltd) was dissolved in 45 ml deionized water

(ii) 15 g TRU20 (the product of Ex. 1) was added to liquefied dextrin to form a mixture.

(iii) 0.75 ml CGTase enzyme (Amano Enzyme, Inc.) and 15 ml deionized water were added to the mixture and incubated at 69° C. for 20 hours to glycosylate the TRU20 with glucose molecules derived from Tapioca dextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 25 g of GTRU20 as a white powder (the residue RU is 1.15 wt %).

### Example 3. Preparation of Flavored Glycosylated Rubusoside 20% (GTRU20-MRP-CA) from GTRU20, Alanine and Xylose

GTRU20: The product of Ex. 2.

10 g GTRU20, 1.67 g alanine and 5 g xylose were mixed. The ratio of xylose to alanine was 3:1 and the ratio of GTRU20 to the mixture of xylose and alanine was 1.5:1. The mixture obtained was dissolved in 50 g pure water without pH adjustment. The resulting solution was then heated at about 100° C. for 2 hours. When the reaction was completed, the reaction mixture was filtered through filter paper and the filtrate was dried with a spray dryer. The resulting composition contained 12.5 g of GTRU20-MRP-CA as an off white powder.

### Example 4. Preparation of Flavored Glycosylated Rubusoside 20% (GTRU20-MRP-HO) from GTRU20, Phenylalanine and Xylose

GTRU20: the product of Ex. 2.

10 g GTRU20, 1 g phenylalanine and 2 g xylose were mixed. The ratio of xylose to phenylalanine was 2:1 and the ratio of GTRU20 to the mixture of xylose and phenylalanine was 10:3. The obtained mixture was then dissolved in 45 g pure water without pH adjustment. The resulting solution was then heated at about 100° C. for 1 hour. When the reaction was completed, the solution was filtered through filter paper and the filtrate was dried with a spray dryer. The resulting composition contained 9.6 g of GTRU20-MRP-HO as an off white powder.

### Example 5. Sensory Evaluation Methods and their Use in Evaluating the Sweetness and Overall Likability of RU20, GTRU20, GTRU20-MRP-CA and GTRU20-MRP-HO from Examples 1-4

The products in examples below are evaluated by the following methods.

Sensory evaluation method: products were evaluated in terms of mouth feel, bitterness, bitterness lingering, sweet lingering, metallic aftertaste and overall likability.

A panel of 6 trained testers evaluated the samples and gave scores of 1-5 according to the followed standards. The average score of the panel members was taken as the score of each factor.

For mouth feel, one factor, kokumi, was evaluated.

(1) Kokumi Level

Evaluation standard: A 5% sucrose solution with neutral water was prepared. This solution was used as a standard solution to which the kokumi degree was set as 5.

A 250 ppm RA (available from Sweet Green Fields) solution was prepared with neutral water. This solution was used as a standard solution to which the kokumi degree was set as 1.

An appropriate amount of yeast extract (available from Leiber, 44400P-145) was dissolved in a 250 ppm aqueous solution of RA97 such that the degree of kokumi of the resulting solution was consistent with the standard solution of kokumi degree of 5 (5% sucrose). After evaluation by a panel of 6 testers, it was determined that a solution of 100 ppm the yeast extract dissolved in 250 ppm RA97 was substantially identical to the degree of kokumi of the 5% sucrose solution. Thus, the criteria for determining the degree of kokumi are as follows.

TABLE 5-1
Kokumi evaluation test standard

| | RA97 | | | | |
|---|---|---|---|---|---|
| Range of yeast | 250 ppm | | | | |
| extract concentration | <25 ppm | 25-50 ppm | 50-75 ppm | 75-100 ppm | >100 ppm |
| Score of kokumi level | 1 | 2 | 3 | 4 | 5 |

Evaluation Method:

The sample to be evaluated was dissolved in neutral deionized water. The tester placed 20-30 mL of the evaluation solution in their mouth. After 5 seconds the solution was spit out. After a mouthwash step with water, the standard solution was taken. If the degree of Kokumi was similar, the Kokumi degree of the sample solution could be determined as the Kokumi degree value of the standard solution. Otherwise it was necessary to take additional standard solutions and try again until the Kokumi degree value was determined.

(2) Bitterness

Quinine (99% purity) concentration of 10⁻⁸-10⁻⁴ mol/L was the bitterness standard, and the specific bitterness scoring standards are shown in the following table.

TABLE 5-2
Bitterness evaluation test standard

| Range of quinine | | 8 × 10⁻⁷~ | 7 × 10⁻⁶~ | 2 × 10⁻⁵~ | |
|---|---|---|---|---|---|
| concentration mol/L | <8 × 10⁻⁷ | 3 × 10⁻⁶ | 2 × 10⁻⁵ | 1 × 10⁻⁴ | >1 × 10⁻⁴ |
| Score of bitterness | 1 | 2 | 3 | 4 | 5 |

The sample to be evaluated was dissolved in neutral deionized water. The tester placed 20-30 mL of the evaluation solution in their mouth. After 5 seconds the sample was spit out. After a rinse step with water, the standard solution was tasted. If the bitter taste was similar, the bitterness of the sample could be determined as the bitterness value of the standard solution. Otherwise it was necessary to take additional standard solution(s) and try again until the bitterness value was determined.

(3) Bitterness Lingering

The sample to be evaluated was dissolved in neutral deionized water. The tester placed 20-30 mL of the evaluation solution in their mouth, and timing was started to record the bitterness start time and peak time. The test solution was then spit out. Recording of time continued for the time when the bitterness disappeared completely. The time at which the bitterness completely disappeared was compared to the time in the table below to determine the value of bitterness lingering.

TABLE 5-3
Bitterness lingering evaluation test standard

| Time at which the bitterness | | | | | |
|---|---|---|---|---|---|
| completely disappears | <20 s | 20-30 s | 30-40 s | 40-50 s | >50 s |
| Score of bitterness lingering | 1 | 2 | 3 | 4 | 5 |

(4) Sweet Lingering

The sample to be evaluated was dissolved in neutral deionized water. The tester placed 20-30 mL of the evaluation solution in their mouth, and timing was started to record the sweetness start time and peak time. The test solution was then spit out. Recording of time continued for the time when the sweetness disappeared completely. The time at which the sweetness completely disappeared was compared to the time in the table below to determine the value of sweet lingering.

TABLE 5-4
Sweet lingering evaluation test standard

| time at which the sweetness | | | | | |
|---|---|---|---|---|---|
| completely disappears | <20 s | 20-30 s | 30-40 s | 40-50 s | >50 s |
| Score of sweet lingering | 1 | 2 | 3 | 4 | 5 |

(5) Metallic Aftertaste

Sucralose (available from Anhui Jinhe Industrial Co., Ltd and Lot # is 201810013) was used as a standard reference. The specific metallic aftertaste scoring standards are shown in the table below.

TABLE 5-5
Metallic aftertaste evaluation test standard

| Range of sucralose concentration | <50 ppm | 50-100 ppm | 100-150 ppm | 150-200 ppm | >200 ppm |
|---|---|---|---|---|---|
| Score of metallic aftertaste | 1 | 2 | 3 | 4 | 5 |

The sample to be evaluated was dissolved in neutral deionized water. The tester placed 20-30 mL of the evaluation solution in their mouth. After 5 seconds, the solution was spit out. After a rinse step with water the standard solution was tasted. If the metallic aftertaste was similar, the metallic aftertaste of the sample was determined as the metallic aftertaste score of the standard liquid, otherwise it was necessary to take additional standard liquid samples and taste it again until the metallic aftertaste score was determined.

(6) Overall Likability

Overall likability is the general impact of the sample. The sample to be evaluated was dissolved in neutral deionized water. The tester places 20-30 mL of the evaluation solution in their mouth and evaluate the general impact based on its kokumi, bitterness, bitterness lingering, sweet lingering, and metallic aftertaste. The test solution was then spit out. A score of 1-5 indicates a strong dislike, dislike, average, like, and strong like.

(7) Sucrose Equivalence

The terms “sucrose equivalence” and “SugarE” refer to the amount of non-sucrose sweetener required to provide the sweetness of a given percentage of sucrose in the same solution.

TABLE 5-6
SugarE evaluation standard:

| Sucrose weight | 1 g | 2 g | 3 g | 4 g | 5 g | 6 g | 7 g | 8 g | 9 g | 10 g |
|---|---|---|---|---|---|---|---|---|---|---|
| Water volume | 100 mL | | | | | | | | | |
| SugarE | 1% | 2% | 3% | 4% | 5% | 6% | 7% | 8% | 9% | 10% |

Evaluation method: The sample to be evaluated was dissolved in neutral deionized water. The tester placed 20-30 mL of the evaluation solution in their mouth. After 5 seconds the solution was spit out. After a mouthwash step with water, the standard solution was taken. If the degree of SugarE was similar, the SugarE degree of the sample solution can be determined as the SugarE degree value of the standard solution. Otherwise it was necessary to take additional standard solutions and try again until the SugarE degree value was determined.

(8) Time-Intensity Curves

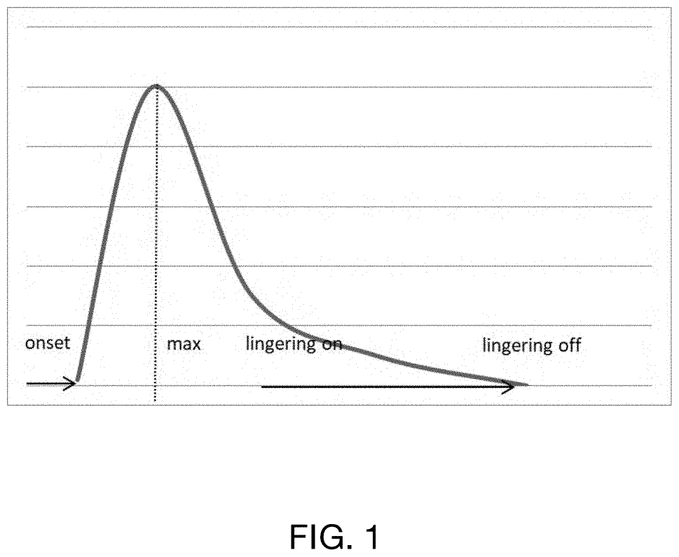

Evaluation method: Each person of the test panel had to drink sample solutions with defined concentrations. During the test, all persons had a time clock. They had to note the appearance-time for four specific points of a time-intensity curves (onset, maximum sweetness, lingering on and lingering off). The results were recorded and make a graph, mean values were calculated from at least 6 individual test persons. FIG. 1 shows a schematic diagram of the Time-intensity curve.

(9) Starch Taste

Maltodextrin (available from BAOLIBAO BIOLOGY Co., Ltd) was used as a standard reference. The specific starch taste scoring standards are shown in the table below.

TABLE 5-7
Starch taste evaluation test standard

| Range of maltodextrin concentration | <0.5% | 0.5%-1% | 1%-2% | 2%-3% | >3% |
|---|---|---|---|---|---|
| Score of starch taste | 1 | 2 | 3 | 4 | 5 |

The sample to be evaluated was dissolved in neutral deionized water. The tester placed 20-30 mL of the evaluation solution in their mouth. After 5 seconds, the solution was spit out. After a rinse step with water the standard solution was tasted. If the starch taste was similar, the starch taste of the sample was determined as the starch taste score of the standard liquid, otherwise it was necessary to take additional standard liquid samples and taste it again until the starch taste score was determined.

Preparation of Sample Solutions:

RU20, GTRU20, GTRU20-MRP-CA and GTRU20-MRP-HO from Examples 1 to 4 were weighed and uniformly mixed according to the weights shown in Table 5-8, 5-9, 5-10, and 5-11; dissolved in 100 ml pure water; and subjected to a sweetness and overall likability evaluation test.

TABLE 5-8
RU20 sample composition

| | | | Volume of |
|---|---|---|---|
| | Concentration of | Weight of | Pure Water |
| No. | RU20 (ppm) | RU20 (g) | (mL) |
| 5-1-01 | 100 | 0.01 | 100 |
| 5-1-02 | 200 | 0.02 | 100 |
| 5-1-03 | 400 | 0.04 | 100 |
| 5-1-04 | 800 | 0.08 | 100 |
| 5-1-05 | 1200 | 0.12 | 100 |
| 5-1-06 | 2000 | 0.2 | 100 |
| 5-1-07 | 2500 | 0.25 | 100 |

TABLE 5-9
GTRU20 sample composition

| | | | Volume of |
|---|---|---|---|
| | Concentration of | Weight of | Pure Water |
| No. | GTRU20 (ppm) | GTRU20 (g) | (mL) |
| 5-2-01 | 200 | 0.02 | 100 |
| 5-2-02 | 400 | 0.04 | 100 |
| 5-2-03 | 800 | 0.08 | 100 |
| 5-2-04 | 1600 | 0.16 | 100 |
| 5-2-05 | 2400 | 0.24 | 100 |
| 5-2-06 | 4000 | 0.4 | 100 |
| 5-2-07 | 5000 | 0.5 | 100 |

TABLE 5-10
GTRU20-MRP-CA sample composition

| | Concentration of | Weight of | Volume of |
|---|---|---|---|
| | GTRU20- | GTRU20-MRP- | Pure Water |
| No. | MRP-CA (ppm) | CA (g) | (mL) |
| 5-3-01 | 320 | 0.032 | 100 |
| 5-3-02 | 640 | 0.064 | 100 |
| 5-3-03 | 1280 | 0.128 | 100 |
| 5-3-04 | 2560 | 0.256 | 100 |
| 5-3-05 | 3840 | 0.384 | 100 |
| 5-3-06 | 6400 | 0.64 | 100 |
| 5-3-07 | 8000 | 0.8 | 100 |

TABLE 5-11
GTRU20-MRP-HO sample composition

| | Concentration of | Weight of | Volume of |
|---|---|---|---|
| | GTRU20- | GTRU20- | Pure Water |
| No. | MRP-HO (ppm) | MRP-HO (g) | (mL) |
| 5-4-01 | 260 | 0.026 | 100 |
| 5-4-02 | 520 | 0.052 | 100 |
| 5-4-03 | 1040 | 0.104 | 100 |
| 5-4-04 | 2080 | 0.208 | 100 |
| 5-4-05 | 3120 | 0.312 | 100 |
| 5-4-06 | 5200 | 0.52 | 100 |
| 5-4-07 | 6500 | 0.65 | 100 |

The sugar equivalence and overall likability (an overall likability score of 4 or above means very good taste, an overall likability score of 3 or above means palatable taste) of above solutions were evaluated by the above method.

The results are shown in Tables 5-12, 5-13, 5-14, and 5-15.

TABLE 5-12
SugarE and overall likability evaluation of RU20

| | Concentration of | Sugar | Overall |
|---|---|---|---|
| No. | RU20 (ppm) | Equivalence | likability |
| 5-1-01 | 100 | 0.5 | 2 |
| 5-1-02 | 200 | 1 | 1.5 |
| 5-1-03 | 400 | 2.5 | 1 |
| 5-1-04 | 800 | 4 | 1 |
| 5-1-05 | 1200 | 5 | 1 |
| 5-1-06 | 2000 | 6 | 1 |
| 5-1-07 | 2500 | 7 | 1 |

TABLE 5-13
SugarE and overall likability evaluation of GTRU20

| | Concentration of | Sugar | Overall |
|---|---|---|---|
| No. | GTRU20 (ppm) | Equivalence | likability |
| 5-2-01 | 200 | 0.3 | 3.65 |
| 5-2-02 | 400 | 1 | 3.1 |
| 5-2-03 | 800 | 2 | 2.5 |
| 5-2-04 | 1600 | 2.8 | 2 |
| 5-2-05 | 2400 | 4 | 1 |
| 5-2-06 | 4000 | 5 | 1 |
| 5-2-07 | 5000 | 5 | 1 |

TABLE 5-14
SugarE and overall likability evaluation of GTRU20-MRP-CA

| | Concentration of | | |
|---|---|---|---|
| | GTRU20-MRP-CA | Sugar | Overall |
| No. | (ppm) | Equivalence | likability |
| 5-3-01 | 320 | 0.3 | 4.2 |
| 5-3-02 | 640 | 1 | 3.8 |
| 5-3-03 | 1280 | 2 | 3.3 |
| 5-3-04 | 2560 | 2.8 | 3 |
| 5-3-05 | 3840 | 4 | 2 |
| 5-3-06 | 6400 | 5 | 1.2 |
| 5-3-07 | 8000 | 5 | 1 |

TABLE 5-15
SugarE and overall likability evaluation of GTRU20-MRP-HO

| | Concentration of | | |
|---|---|---|---|
| | GTRU20-MRP-HO | Sugar | Overall |
| No. | (ppm) | Equivalence | likability |
| 5-4-01 | 260 | 0.5 | 4.6 |
| 5-4-02 | 520 | 1.2 | 4.35 |
| 5-4-03 | 1040 | 2 | 4 |
| 5-4-04 | 2080 | 3.2 | 3.5 |
| 5-4-05 | 3120 | 4 | 3 |
| 5-4-06 | 5200 | 5.2 | 2 |
| 5-4-07 | 6500 | 5.3 | 1 |

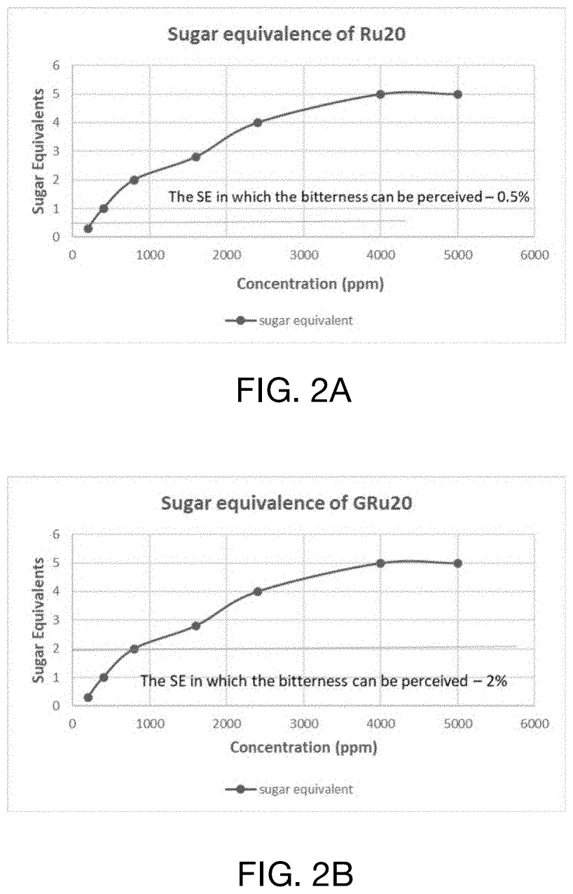

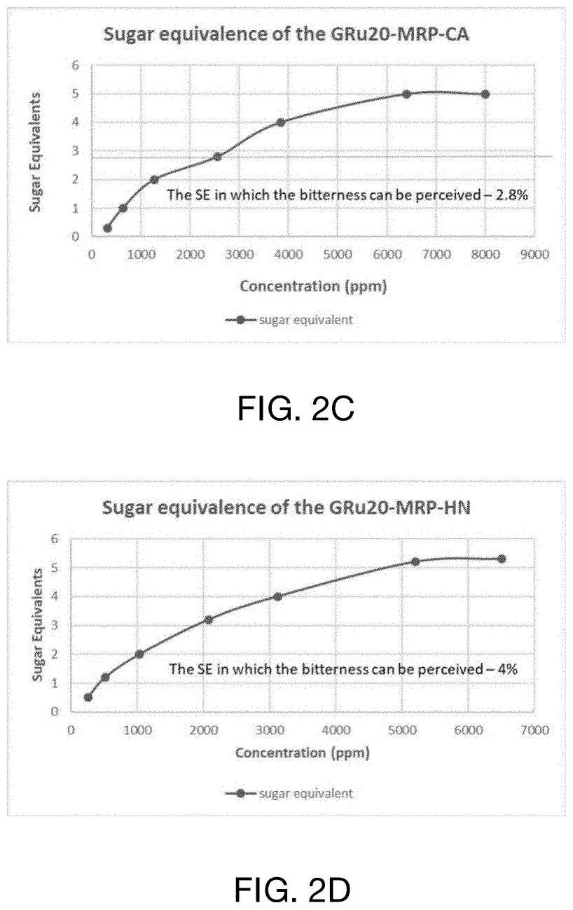

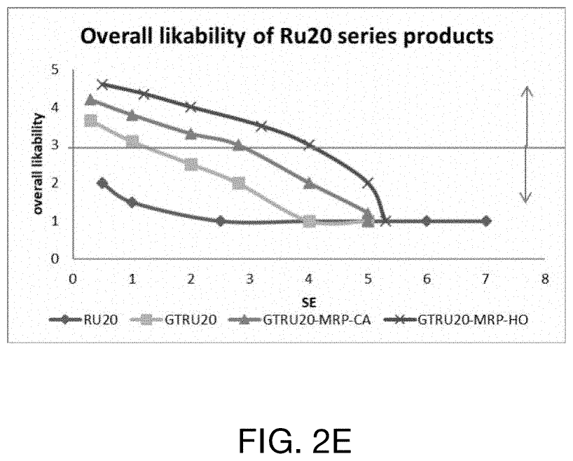

Data analysis: The SugarE of different concentrations of RU20, GTRU20, GTRU20-MRP-CA and GTRU20-MRP-HO in this Example are shown in FIGS. 2A-2D.

The overall likability of different SugarEs of RU20, GTRU20, GTRU20-MRP-CA and GTRU20-MRP-HO in this Example are shown in FIG. 2E.

Conclusion: As shown in FIG. 2E, the taste of RU20 was unpalatable even at low SugarE level. However, when modified by glycosylation, the taste was improved. The SugarE at which the taste can be palatable increased to 1% SugarE. When further modified by glycosylation/Maillard reaction, the taste was further improved. The SugarE at which the taste can be palatable increased to 2.8% SugarE and 4% SugarE respectively. This example demonstrates that the overall likability of RU20 can be modified, such as by glycosylation or glycosylation/Maillard reaction, especially glycosylation/Maillard reaction.

### Example 6. Evaluation of the Taste Profiles of RU20, GTRU20, GTRU20-MRP-CA and GTRU20-MRP-HO in a 40% Sugar Reduction System

Materials: RU20, Guilin Layin Natural Ingredients Corp. The concentration of RU is 20.68%; Lot #:STL02-151005; GTRU20, the product of Ex. 2; GTRU20-MRP-CA, the product of Ex. 3; GTRU20-MRP-HO, the product of Ex. 4.

Preparation of sample solutions: RU20, GTRU20, GTRU20-MRP-CA and GTRU20-MRP-HO and 6% sugar solution were mixed according to the weights shown in Table 6-1 below.

The samples in example below were evaluated by the methods in Ex. 5. Each panelist was asked to evaluate by his preference six aspects—flavor, sweet lingering, mouth feel, bitterness, bitterness lingering, and overall likability. It should be noted that according to the sensory evaluation method, the evaluation of the mouth feel, sweet lingering, bitterness, bitterness lingering and overall likability is based on the iso-sweetness, 10% SugarE. The evaluation results are shown in Table 6-2.

TABLE 6-1
Test sample compositions.

| | | Volume of | | Sugar |
|---|---|---|---|---|
| | Weight | 6% sugar | Concentration | concentration |
| Components | (mg) | solution | (ppm) | (%) |
| RU20 | 80 | 100 ml | 800 | 6 |
| GTRU20 | 240 | | 2400 | 6 |
| GTRU20-MRP- | 384 | | 3840 | 6 |
| CA | | | | |
| GTRU20-MRP- | 312 | | 3120 | 6 |
| HO | | | | |

TABLE 6-2
Evaluation: RU20, GTRU20, GTRU20-MRP-CA
and GTRU20-MRP-HO in 6% sugar solution

| | | Overall | Mouth | Sweet | | Bitterness |
|---|---|---|---|---|---|---|
| sample | Flavor | likability | feel | lingering | Bitterness | lingering |
| RU20 | Herb | 2 | 2.00 | 3.00 | 4.00 | 3.50 |
| GTRU20 | Tea | 3 | 3.00 | 2.00 | 3.00 | 3.00 |
| GTRU20-MRP-CA | Caramel | 3.8 | 3.50 | 2.00 | 2.50 | 2.00 |
| GTRU20-MRP-HO | Honey | 4.2 | 4.00 | 2.00 | 2.00 | 2.00 |

Conclusion: Compared to RU20, in a 40% sugar reduction system the bitterness and bitterness lingering of the GTRU20, GTRU20-MRP-CA and GTRU20-MRP-HO were remarkably decreased. In addition, GTRU20-MRP-CA and GTRU20-MRP-HO were found to supply a significantly pleasant flavor. The results further showed that the mouth feel of RU20 can be significantly improved by purification and then glycosylation. Moreover, when the glycosylated RU was flavored by the Maillard reaction, its taste profile was found to be further improved in good mouth feel and pleasant flavor.

### Example 7. Preparation of Glycosylated Rubusoside 90% (GRU90) from Rubusoside 90%

Glycosylated reaction products from Rubusoside 90% were prepared according to the following method.

Rubusoside 90% (available from EPC Natural Products Co., Ltd. The content of RU is 92.8% Lot #EPC-238-34-03)

(i) 15 g tapioca dextrin was dissolved in 45 ml deionized water.

(ii) 15 g Rubusoside 90% was added to liquefied dextrin.

(iii) 0.75 ml CGTase enzyme and 15 ml deionized water were added to the mixture of (ii) and incubated at 69° C. for 20 hours to glycosylate the RU90 composition via glucose molecules derived from tapioca dextrin.

(iv) The reaction mixture was heated to 85° C. for 10 min to inactivate the CGTase, which was then removed by filtration.

(v) The resulting solution of GRU90, residual RU and dextrin were decolored and spray dried yielding 25 g of GRU90 as a white powder (the content of residue RU is 12.16%).

### Example 8. Preparation of a Sugar-Like Flavored Maillard Reaction Product (GRU90-MRP-TA) from GRU90, Glutamic Acid and Galactose

GRU90: the product of Ex. 7.

10 g GRU90, 0.83 g galactose and 0.27 g glutamic acid were mixed. The ratio of galactose to glutamic acid was 3:1 and the ratio of GRU90 to the mixture of galactose and glutamic acid was 10:1. The mixture obtained was dissolved in 35 g pure water without pH adjustment (pH was about 5). The solution was then heated at about 100° C. for 1.5 hours. When the reaction completed, the solution was filtered through filter paper and the filtrate was dried with a spray dryer, thereby resulting in about 8.2 g of GRU90-MRP-TA as an off white powder.

### Example 9. Preparation of Caramel-Flavored Maillard Reaction Product (GRU90-MRP-CA) from GRU90, Alanine and Xylose

GRU90: the product of Ex. 7.

10 g GRU90, 1.67 g alanine and 5 g xylose were mixed. The ratio of xylose to alanine was 3:1 and the ratio of GRU90 to the mixture of xylose and alanine was 1.5:1. The mixture obtained was dissolved in 50 g pure water without pH adjustment. The resulting solution was heated at about 100° C. for 2 hours. When the reaction was completed, the solution was filtered through filter paper and the filtrate was dried with a spray dryer, thereby resulting in about 13 g of GRU90-MRP-CA as an off white powder.

### Example 10. Preparation of Honey-Flavored Glycosylated Rubusoside 90% (GRU90-MRP-HO) from GRU90, Phenylalanine and Xylose

GRU90: the product of Ex. 7.

10 g GRU90, 1 g phenylalanine and 2 g xylose were mixed. The ratio of xylose to phenylalanine was 2:1 and the ratio of GRU90 to the mixture of xylose and phenylalanine was 10:3. The mixture obtained was dissolved in 45 g pure water without pH adjustment. The solution was then heated at about 100° C. for 1 hour. When the reaction was completed, the solution was filtered through filter paper and the filtrate was dried with a spray dryer, thereby resulting in about 9 g of GRU90-MRP-HO as an off white powder.

### Example 11. Sensory Evaluations and Taste Profiles of RU90, GRU90, GRU90-MRP-TA, GRU90-MRP-CA and GRU90-MRP-HO in a 60% Sugar Reduction System

Materials: RU90, available from EPC Natural Products Co., Ltd. The content of RU is 92.8%; GRU90, the product of Ex. 7; GRU90-MRP-TA, the product of Ex. 8; GRU90-MRP-CA, the product of Ex. 9; GRU90-MRP-HO, the product of Ex. 10.

Method: RU90, GRU90, GRU90-MRP-TA, GRU90-MRP-CA and GRU90-MRP-HO and 4% SugarE sugar solution were mixed according to the weight shown in Table 11-1 in this example. Each sample was evaluated according to the sensory evaluation method in Ex. 5. Average scores from the test panel for each sensory criterion were recorded as the evaluation test results depicted in Table 11-2. It should be noted that according to the sensory evaluation method, the evaluation of the mouth feel and the taste profile were based on the iso-sweetness, 10% SugarE. The evaluation results are shown in Tables 11-2 and 11-3.

TABLE 11-1
Test sample compositions.

| | | Volume of | | Sugar |
|---|---|---|---|---|
| | Weight | 4% sugar | Concentration | concentration |
| Components | (mg) | solution | (ppm) | (%) |
| RU90 | 30 | 100 ml | 300 | 4 |
| GRU90 | 60 | | 600 | 4 |
| GRU90-MRP-TA | 66 | | 660 | 4 |
| GRU90-MRP-CA | 96 | | 960 | 4 |
| GRU90-MRP-HO | 78 | | 780 | 4 |

TABLE 11-2
Evaluation of RU90, GRU90 and GRU90-MRP-TA in 4% sugar solution

| | | Overall | Mouth | Sweet | | Bitterness |
|---|---|---|---|---|---|---|
| Sample | Flavor | likability | feel | lingering | Bitterness | lingering |
| RU90 | Herb | 2.75 | 3.00 | 3.00 | 3.00 | 2.50 |
| GRU90 | Tea | 3.67 | 4.00 | 2.00 | 2.00 | 2.00 |
| GRU90-MRP-CA | Caramel | 4.08 | 4.50 | 2.00 | 1.50 | 1.50 |
| GRU90-MRP-TA | Sugar | 4.58 | 5.00 | 1.50 | 1.00 | 1.00 |
| GRU90-MRP-HO | Honey | 4.50 | 5.00 | 2.00 | 1.00 | 1.00 |

Conclusion: In a 60% sugar reduction system, GRU90, GRU90-MRP-TA, GRU90-MRP-CA and GRU90-MRP-HO showed significantly decreased bitterness and bitterness lingering compared to RU90. In addition, GRU90, GRU90-MRP-TA, GRU90-MRP-CA and GRU90-MRP-HO provided a significantly pleasant flavor that served to improve their full body mouth feel. The sweet lingering of GRU90-MRP-TA, GRU90-MRP-CA and GRU90-MRP-HO products were significantly decreased compared to that of RU90. In summary, GRU90, GRU90-MRP-TA, GRU90-MRP-CA and GRU90-MRP-HO provided a significantly more pleasant taste, as well as remarkably improved overall likability compared to RU20.

### Example 12. GTRU20 Improves the Taste and Mouth Feel of Sucralose when Blended Therewith

Process: GTRU20 and sucralose (available from Anhui Jinhe Industrial Co., Ltd and Lot # is 201810013) were weighed and uniformly mixed according to the weight shown in Table 12-1, dissolved in 100 ml pure water, and subjected to the sensory evaluation tests described in Ex. 5).

TABLE 12-1
Test sample compositions.

| | The ratio of | | | |
|---|---|---|---|---|
| | sucralose to | Weight of | Weight of | Volume of pure |
| No. | GTRU20 | sucralose (mg) | GTRU20 (mg) | water (mL) |
| 12-00 | 10/0 | 15 | 0 | 100 |
| 12-01 | 10/1 | 15 | 1.5 | 100 |
| 12-02 | 10/3 | 15 | 4.5 | 100 |
| 12-03 | 10/5 | 15 | 7.5 | 100 |
| 12-04 | 10/7 | 15 | 10.5 | 100 |
| 12-05 | 10/9 | 15 | 13.5 | 100 |
| 12-06 | 10/10 | 15 | 15 | 100 |
| 12-07 | 10/40 | 15 | 60 | 100 |
| 12-08 | 10/70 | 15 | 105 | 100 |
| 12-09 | 10/100 | 15 | 150 | 100 |

Evaluation: Several mixtures of GTRU20 and sucralose were mixed in this example. Each sample was evaluated according to the sensory evaluation method in Ex. 5. Average scores from the test panel for each sensory criterion were recorded as the evaluation test results. The taste profiles of the mixtures are set forth in Table 12-2. It should be noted that according to the sensory evaluation method, in these evaluations, the concentration of sucralose in the sample solution was the same, 150 ppm.

TABLE 12-2
Sensory evaluation results

| | Mouth | Sweet | Metallic | Overall |
|---|---|---|---|---|
| No. | feel | lingering | aftertaste | likability |
| 12-00 | 1.0 | 3.0 | 3.5 | 2.3 |
| 12-01 | 1.5 | 3.0 | 3.5 | 2.5 |
| 12-02 | 1.5 | 2.5 | 3.0 | 2.7 |
| 12-03 | 2.0 | 2.0 | 2.0 | 3.2 |
| 12-04 | 3.0 | 2.0 | 2.0 | 4.0 |
| 12-05 | 3.0 | 2.0 | 2.0 | 4.0 |
| 12-06 | 3.0 | 2.0 | 2.0 | 4.0 |
| 12-07 | 3.5 | 2.0 | 2.0 | 4.0 |
| 12-08 | 4.0 | 2.0 | 2.0 | 4.0 |
| 12-09 | 4.0 | 2.0 | 2.0 | 4.0 |

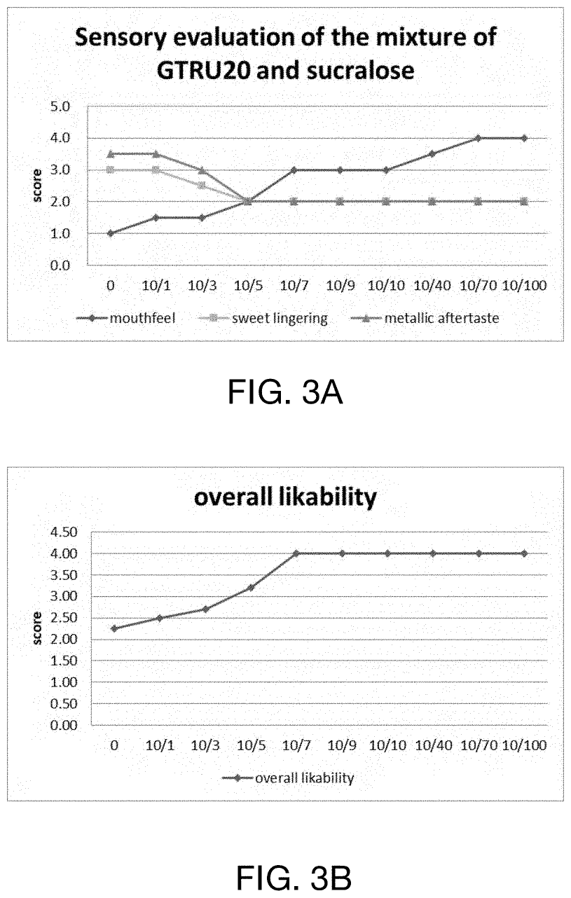

Data analysis: The relationship between the sensory evaluation results to the ratio of sucralose to GTRU20 in this example is shown in FIG. 3A. The relationship between the overall likability results to the ratio of sucralose to GTRU20 in this example is shown in FIG. 3B.

Conclusion: The result showed that GTRU20 significantly improved the mouth feel, cut the sweet lingering and decrease the metallic aftertaste of sucralose. This effect was observed in all the tested sucralose-to-GTRU20 ratios (from 10:1 to 10:100). The effect can be extended to a sucralose-to-GTRU20 ratio range of 99:1 to 1:99. This example demonstrates that GTRU20 could improve taste profile, flavor intensity and mouth feel of artificial sweetener such as sucralose. Such effect can be extended to all artificial sweeteners.

### Example 13. GTRU20 Improves the Taste and Mouth Feel of RA97

Process: GTRU20 and RA97 (available from Sweet Green Fields. The content is 97.15%. Lot #3050123) were weighed and uniformly mixed according to the weight shown in Table 13-1, dissolved in 100 ml pure water, and subjected to a sensory evaluation test.

TABLE 13-1
Test sample composition

| | The ratio of | | | |
|---|---|---|---|---|
| | RA97 to | Weight of | Weight of | Volume of pure |
| No. | GTRU20 | RA97 (mg) | GTRU20 (mg) | water (mL) |
| 13-00 | 10/0 | 20 | 0 | 100 |
| 13-01 | 10/1 | 20 | 2 | 100 |
| 13-02 | 10/3 | 20 | 6 | 100 |
| 13-03 | 10/5 | 20 | 10 | 100 |
| 13-04 | 10/7 | 20 | 14 | 100 |
| 13-05 | 10/9 | 20 | 18 | 100 |
| 13-06 | 10/10 | 20 | 20 | 100 |
| 13-07 | 10/40 | 20 | 80 | 100 |
| 13-08 | 10/70 | 20 | 140 | 100 |
| 13-09 | 10/100 | 20 | 200 | 100 |

Experiment: Several mixtures of RA97 and GTRU20 were mixed in this example. Each sample was evaluated according to the sensory evaluation method in Ex. 5. Average scores from the test panel for each sensory criterion were recorded as the evaluation test results. The taste profiles of the mixtures are set forth in Table 13-2. It should be noted that according to the sensory evaluation method, in these evaluations, the concentration of RA97 in the sample solution was the same, 200 ppm.

TABLE 13-2
Sensory evaluation results

| | Mouth | Sweet | | Overall |
|---|---|---|---|---|
| No. | feel | lingering | Bitterness | likability |
| 13-00 | 1.00 | 3.00 | 3.00 | 2.00 |
| 13-01 | 1.50 | 2.50 | 2.50 | 2.40 |
| 13-02 | 2.00 | 2.00 | 2.00 | 3.00 |
| 13-03 | 3.00 | 1.50 | 2.00 | 3.75 |
| 13-04 | 3.50 | 1.50 | 1.50 | 4.20 |
| 13-05 | 4.00 | 1.50 | 1.50 | 4.30 |
| 13-06 | 4.00 | 1.50 | 1.60 | 4.20 |
| 13-07 | 4.50 | 1.50 | 2.00 | 3.50 |
| 13-08 | 4.50 | 1.50 | 2.50 | 3.00 |
| 13-09 | 5.00 | 1.50 | 2.70 | 3.00 |

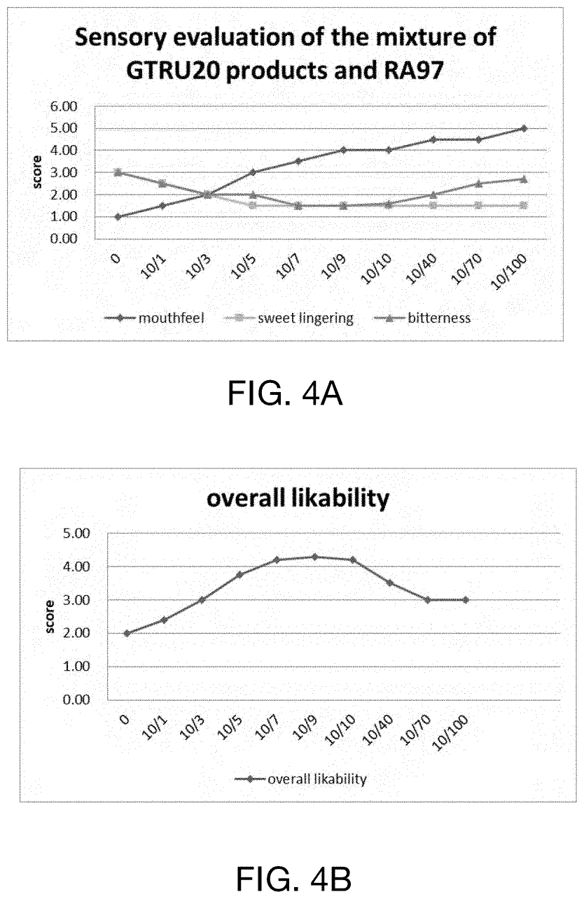

Data analysis: The relationship between the sensory evaluation results to the ratio of RA97 to GTRU20 in this example is shown in FIG. 4A.

The relationship between the overall likability results to the ratio of RA97 to GTRU20 in this example is shown in FIG. 4B.

Conclusion: The result showed that GTRU20 significantly improve the mouth feel, cut the sweet lingering and decrease the bitterness of RA97. This effect was observed in all the tested RA97-to-GTRU20 ratios (from 10:1 to 10:100). The effect can be extended to the RA97-to-GTRU20 ratio range of 99:1 to 1:99. This example demonstrates that GTRU20 can improve taste and mouth feel of natural sweetener such as RA97. Such effect can be extended to all natural sweeteners.

### Example 14. GTRU20-MRP-HO Improves the Taste and Mouth Feel of Acesulfame-K

Process: GTRU20-MRP-HO and acesulfame-K (available from JINGDA PERFUME) were weighed and uniformly mixed according to the weight shown in Table 14-1, dissolved in 100 ml pure water, and subjected to a sensory evaluation test.

TABLE 14-1
Test sample composition

| | The ratio of | | | |
|---|---|---|---|---|
| | acesulfame-K | Weight of | Weight of | |
| | to GTRU20- | acesulfame-K | GTRU20- | Volume of pure |
| No. | MRP-HO | (mg) | MRP-HO (mg) | water (mL) |
| 14-00 | 10/0 | 20 | 0 | 100 |
| 14-01 | 10/1 | 20 | 2 | 100 |
| 14-02 | 10/3 | 20 | 6 | 100 |
| 14-03 | 10/5 | 20 | 10 | 100 |
| 14-04 | 10/7 | 20 | 14 | 100 |
| 14-05 | 10/9 | 20 | 18 | 100 |
| 14-06 | 10/10 | 20 | 20 | 100 |
| 14-07 | 10/40 | 20 | 80 | 100 |
| 14-08 | 10/70 | 20 | 140 | 100 |
| 14-09 | 10/100 | 20 | 200 | 100 |

Experiments

Several mixtures of GTRU20-MRP-HO and acesulfame-K were mixed in this example. Each sample was evaluated according to the sensory evaluation method in Ex. 5. Average scores from the test panel for each sensory criterion were recorded as the evaluation test results. The taste profiles of the mixtures are set forth in Table 14-2. It should be noted that according to the sensory evaluation method, in these evaluations, the concentration of acesulfame-K in the sample solution was the same, 200 ppm. The results are shown in Table 14-2.

TABLE 14-2
Sensory evaluation results

| | Mouth | Sweet | | Metallic | Overall |
|---|---|---|---|---|---|
| No. | feel | lingering | Bitterness | aftertaste | likability |
| 14-00 | 2.00 | 3.00 | 3.00 | 3.00 | 2.50 |
| 14-01 | 2.50 | 3.00 | 3.00 | 2.00 | 2.90 |
| 14-02 | 3.00 | 2.00 | 2.00 | 2.00 | 3.50 |
| 14-03 | 4.00 | 2.00 | 1.50 | 1.50 | 4.20 |
| 14-04 | 4.00 | 2.00 | 1.00 | 1.50 | 4.50 |
| 14-05 | 4.50 | 2.00 | 1.00 | 1.50 | 4.50 |
| 14-06 | 4.50 | 2.00 | 1.50 | 1.50 | 4.30 |
| 14-07 | 4.50 | 2.00 | 2.00 | 1.50 | 4.00 |
| 14-08 | 5.00 | 2.00 | 2.50 | 1.50 | 3.90 |
| 14-09 | 5.00 | 2.00 | 2.50 | 1.50 | 3.50 |

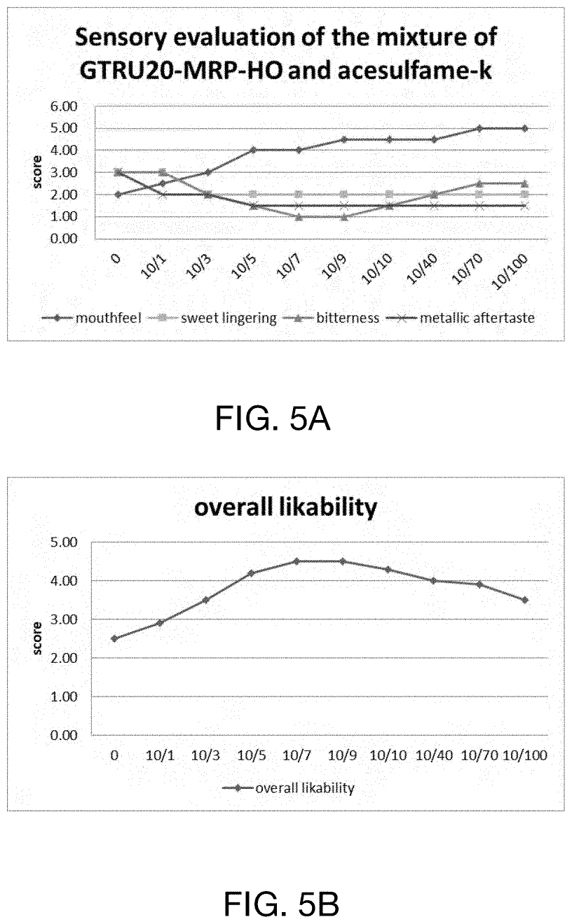

Data analysis: The relationship between the sensory evaluation results to the ratio of acesulfame-K to GTRU20-MRP-HO in this example is shown in FIG. 5A. The relationship between the overall likability results to the ratio of acesulfame-K to GTRU20-MRP-HO in this example is shown in FIG. 5B.

Conclusion: The result showed that GTRU20-MRP-HO could significantly improve the mouth feel, cut the sweet lingering, decrease the metallic aftertaste and bitterness of acesulfame-K. This effect was observed in all the tested acesulfame-K-to-GTRU20-MRP-HO ratios (from 10:1 to 10:100). The effect can be extended to the acesulfame-K-to-GTRU20-MRP-HO ratio range of 99:1 to 1:99. This example demonstrates that GTRU20-MRP-HO can improve taste and mouth feel of artificial sweetener such as acesulfame-K. Such effect can be extended to all artificial sweeteners.

### Example 15. Sweetness and Overall Likability of RU90, GRU90, GRU90-MRP-TA, GRU90-MRP-CA and GRU90-MRP-HO

RU90, GRU90, GRU90-MRP-TA, GRU90-MRP-CA and GRU90-MRP-HO from Examples 7-10 were weighed and uniformly mixed according to the weights shown in Table 15-1, 15-2, 15-3, and 15-4; dissolved in 100 ml pure water; and subjected to a sweetness and overall likability evaluation test.

TABLE 15-1
RU90 sample composition

| | Concentration of | Weight of | Volume of Pure |
|---|---|---|---|
| No. | RU90 (ppm) | RU90 (g) | Water (mL) |
| 15-1-01 | 50 | 0.005 | 100 |
| 15-1-02 | 100 | 0.01 | 100 |
| 15-1-03 | 150 | 0.015 | 100 |
| 15-1-04 | 200 | 0.02 | 100 |
| 15-1-05 | 250 | 0.025 | 100 |
| 15-1-06 | 300 | 0.03 | 100 |
| 15-1-07 | 350 | 0.035 | 100 |
| 15-1-08 | 400 | 0.04 | 100 |
| 15-1-09 | 450 | 0.045 | 100 |
| 15-1-10 | 500 | 0.05 | 100 |

TABLE 15-2
GRU90 sample composition

| | Concentration of | Weight of | Volume of Pure |
|---|---|---|---|
| No. | GRU90 (ppm) | GRU90 (g) | Water (mL) |
| 15-2-01 | 100 | 0.01 | 100 |
| 15-2-02 | 200 | 0.02 | 100 |
| 15-2-03 | 300 | 0.03 | 100 |
| 15-2-04 | 400 | 0.04 | 100 |
| 15-2-05 | 500 | 0.05 | 100 |
| 15-2-06 | 600 | 0.06 | 100 |
| 15-2-07 | 700 | 0.07 | 100 |
| 15-2-08 | 800 | 0.08 | 100 |
| 15-2-09 | 900 | 0.09 | 100 |
| 15-2-10 | 1000 | 0.1 | 100 |

TABLE 15-3
GRU90-MRP-TA sample composition

| | Concentration of | Weight of | |
|---|---|---|---|
| | GRU90- | GRU90- | Volume of Pure |
| No. | MRP-TA (ppm) | MRP-TA (g) | Water (mL) |
| 15-3-01 | 110 | 0.011 | 100 |
| 15-3-02 | 220 | 0.022 | 100 |
| 15-3-03 | 330 | 0.033 | 100 |
| 15-3-04 | 440 | 0.044 | 100 |
| 15-3-05 | 550 | 0.055 | 100 |
| 15-3-06 | 660 | 0.066 | 100 |
| 15-3-07 | 770 | 0.077 | 100 |
| 15-3-08 | 880 | 0.088 | 100 |
| 15-3-09 | 990 | 0.099 | 100 |
| 15-3-10 | 1100 | 0.11 | 100 |

TABLE 15-4
GRU90-MRP-CA sample composition

| | Concentration of | Weight of | Volume of |
|---|---|---|---|
| | GRU90-MRP-CA | GRU90-MRP-CA | Pure Water |
| No. | (ppm) | (g) | (mL) |
| 15-4-01 | 160 | 0.016 | 100 |
| 15-4-02 | 320 | 0.032 | 100 |
| 15-4-03 | 480 | 0.048 | 100 |
| 15-4-04 | 640 | 0.064 | 100 |
| 15-4-05 | 800 | 0.08 | 100 |
| 15-4-06 | 960 | 0.096 | 100 |
| 15-4-07 | 1120 | 0.112 | 100 |
| 15-4-08 | 1280 | 0.128 | 100 |
| 15-4-09 | 1440 | 0.144 | 100 |
| 15-4-10 | 1600 | 0.16 | 100 |

TABLE 15-5
GRU90-MRP-HO sample composition

| | Concentration of | Weight of | Volume of |
|---|---|---|---|
| | GRU90-MRP-HO | GRU90-MRP-HO | Pure Water |
| No. | (ppm) | (g) | (mL) |
| 15-5-01 | 130 | 0.013 | 100 |
| 15-5-02 | 260 | 0.026 | 100 |
| 15-5-03 | 390 | 0.039 | 100 |
| 15-5-04 | 520 | 0.052 | 100 |
| 15-5-05 | 650 | 0.065 | 100 |
| 15-5-06 | 780 | 0.078 | 100 |
| 15-5-07 | 910 | 0.091 | 100 |
| 15-5-08 | 1040 | 0.104 | 100 |
| 15-5-09 | 1170 | 0.117 | 100 |
| 15-5-10 | 1300 | 0.13 | 100 |

The sugar equivalence and overall likability of above solutions were evaluated by the above method in Ex. 5.

The results are shown in Tables 15-6, 15-7, 15-8, 15-9 and 15-10.

TABLE 15-6
SugarE and overall likability evaluation of RU90

| | Concentration of | Sugar | Overall |
|---|---|---|---|
| No. | RU90 (ppm) | Equivalence | likability |
| 15-1-01 | 50 | 1 | 3.5 |
| 15-1-02 | 100 | 2.2 | 3 |
| 15-1-03 | 150 | 3 | 2.5 |
| 15-1-04 | 200 | 3.8 | 2 |
| 15-1-05 | 250 | 3.8 | 1.5 |
| 15-1-06 | 300 | 4 | 1 |
| 15-1-07 | 350 | 4 | 1 |
| 15-1-08 | 400 | 4.2 | 1 |
| 15-1-09 | 450 | 4.6 | 1 |
| 15-1-10 | 500 | 5 | 1 |

TABLE 15-7
SugarE and overall likability evaluation of GRU90

| | Concentration of | Sugar | Overall |
|---|---|---|---|
| No. | GRU90 (ppm) | Equivalence | likability |
| 15-2-01 | 100 | 1 | 4.5 |
| 15-2-02 | 200 | 2 | 4 |
| 15-2-03 | 300 | 2.8 | 3.5 |
| 15-2-04 | 400 | 4 | 3 |
| 15-2-05 | 500 | 5 | 2.5 |
| 15-2-06 | 600 | 5.5 | 2 |
| 15-2-07 | 700 | 6 | 1.5 |
| 15-2-08 | 800 | 6 | 1.5 |
| 15-2-09 | 900 | 6 | 1.5 |
| 15-2-10 | 1000 | 6 | 1.5 |

TABLE 15-8
SugarE and overall likability evaluation of GRU90-MRP-TA

| | Concentration of | Sugar | Overall |
|---|---|---|---|
| No. | GRU90 (ppm) | Equivalence | likability |
| 15-3-01 | 110 | 1 | 5 |
| 15-3-02 | 220 | 2 | 5 |
| 15-3-03 | 330 | 2.8 | 5 |
| 15-3-04 | 440 | 4 | 5 |
| 15-3-05 | 550 | 5 | 4.5 |
| 15-3-06 | 660 | 6 | 4 |
| 15-3-07 | 770 | 6.2 | 3.5 |
| 15-3-08 | 880 | 6.5 | 3 |
| 15-3-09 | 990 | 6.5 | 3 |
| 15-3-10 | 1100 | 6.5 | 3 |

TABLE 15-9
SugarE and overall likability evaluation of GRU90-MRP-CA

| | Concentration of | | |
|---|---|---|---|
| | GRU90-MRP-CA | Sugar | Overall |
| No. | (ppm) | Equivalence | likability |
| 15-4-01 | 160 | 1 | 5 |
| 15-4-02 | 320 | 2 | 5 |
| 15-4-03 | 480 | 2.8 | 4.6 |
| 15-4-04 | 640 | 4 | 4 |
| 15-4-05 | 800 | 5 | 3.6 |
| 15-4-06 | 960 | 6 | 3.2 |
| 15-4-07 | 1120 | 6.2 | 3 |
| 15-4-08 | 1280 | 6.3 | 2.6 |
| 15-4-09 | 1440 | 6.5 | 2.3 |
| 15-4-10 | 1600 | 6.6 | 2 |

TABLE 15-10
SugarE and overall likability evaluation of GRU90-MRP-HO

| | Concentration of | | |
|---|---|---|---|
| | GRU90-MRP-HO | Sugar | Overall |
| No. | (ppm) | Equivalence | likability |
| 15-5-01 | 130 | 1.5 | 5 |
| 15-5-02 | 260 | 2.2 | 5 |
| 15-5-03 | 390 | 3 | 5 |
| 15-5-04 | 520 | 4 | 4.6 |
| 15-5-05 | 650 | 5 | 4.2 |
| 15-5-06 | 780 | 6 | 3.7 |
| 15-5-07 | 910 | 7 | 3 |
| 15-5-08 | 1040 | 7.8 | 2.5 |
| 15-5-09 | 1170 | 8.5 | 2.3 |
| 15-5-10 | 1300 | 8.5 | 2 |

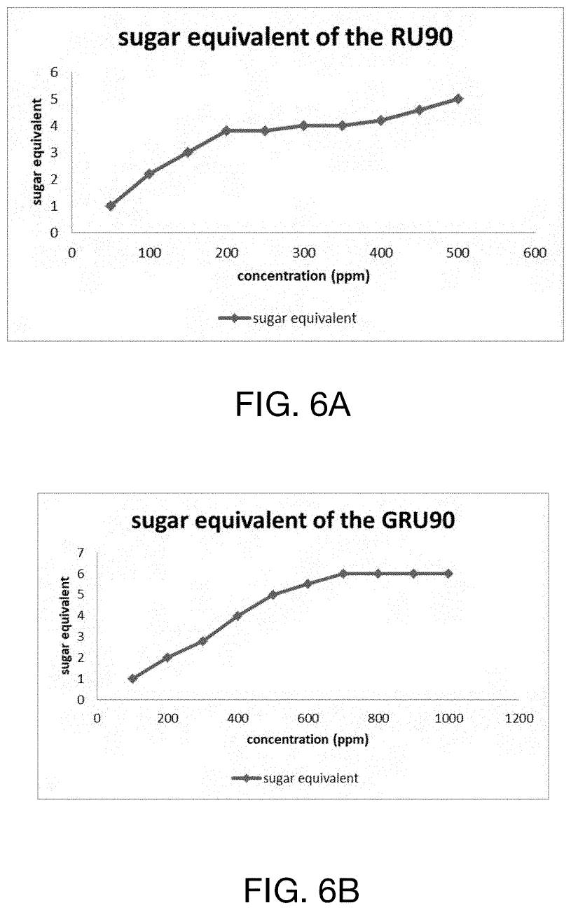

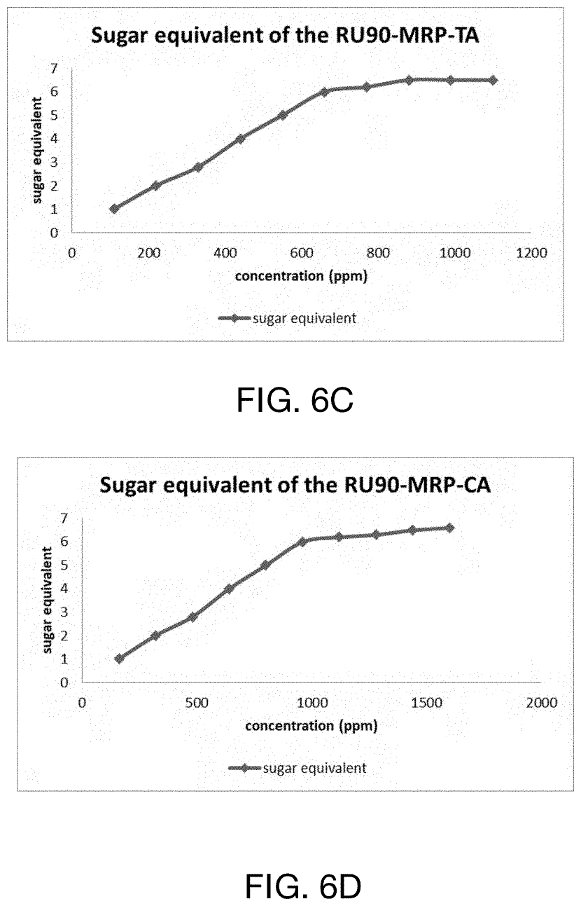

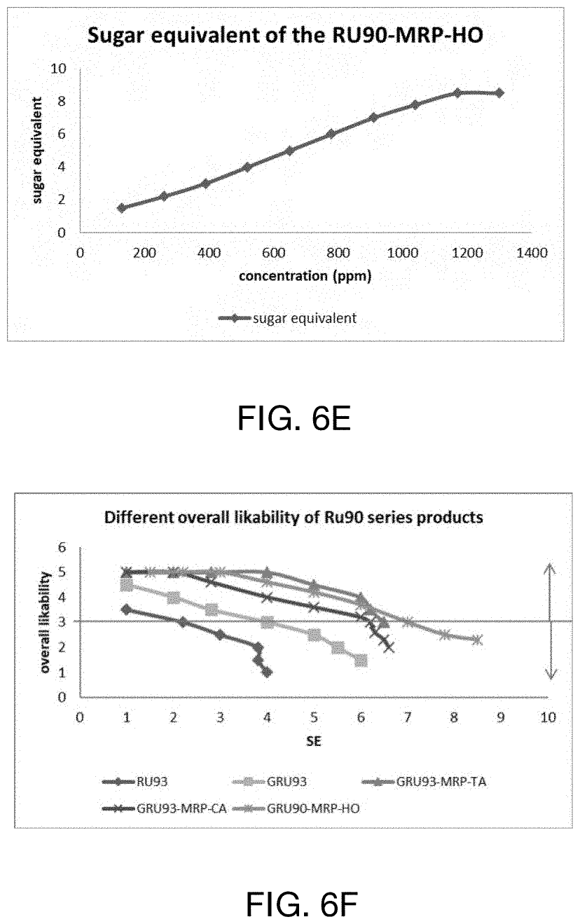

Data analysis: The SugarE evaluation of different concentrations of RU90, GRU90, GRU90-MRP-TA, GRU90-MRP-CA and GTRU20-MRP-HO in this Example are shown in FIGS. 6A-6E, respectively.

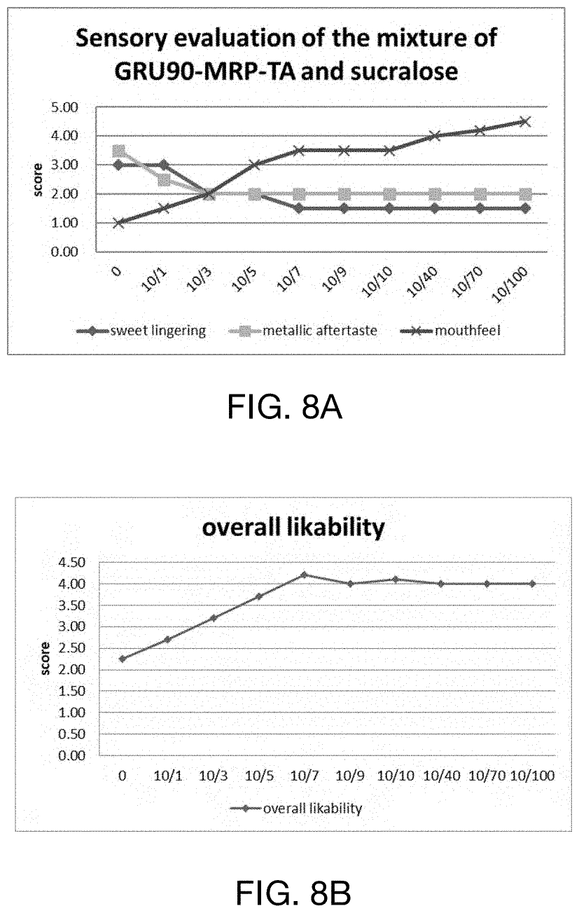

The overall likability evaluation of different concentrations of RU90, GRU90, GRU90-MRP-TA, GRU90-MRP-CA and GTRU20-MRP-HO in this example are shown in FIG. 8F.

Conclusion: As shown in FIG. 6F, the acceptable taste of RU90 is low to 2% SugarE. However, the good taste perception of GRU90, GRU90-MRP-TA, GRU90-MRP-CA and GRU90-MRP-HO were improved to 4% SugarE, 6.5% SugarE, 6.2% SugarE, and 7% SugarE respectively. This example demonstrates that the overall likability of RU90 can be modified by further modification, such as glycosylation or glycosylation/Maillard reaction, especially glycosylation/Maillard reaction.

### Example 16. GRU90 Improves the Taste and Mouth Feel of Acesulfame-K when Blended Therewith

Process: GRU90 (product of Ex. 7) and acesulfame-K (available from JINGDA PERFUME) were weighed and uniformly mixed according to the weight shown in Table 16-1, dissolved in 100 ml pure water, and subjected to mouth feel evaluation tests.

TABLE 16-1
Test sample compositions.

| | The ratio of | Weight of | Weight | Volume of |
|---|---|---|---|---|
| | acesulfame-K | acesulfame-K | of GRU90 | pure water |
| No. | to GRU90 | (mg) | (mg) | (mL) |
| 16-00 | 10/0 | 20 | 0 | 100 |
| 16-01 | 10/1 | 20 | 2 | 100 |
| 16-02 | 10/3 | 20 | 6 | 100 |
| 16-03 | 10/5 | 20 | 10 | 100 |
| 16-04 | 10/7 | 20 | 14 | 100 |
| 16-05 | 10/9 | 20 | 18 | 100 |
| 16-06 | 10/10 | 20 | 20 | 100 |
| 16-07 | 10/40 | 20 | 80 | 100 |
| 16-08 | 10/70 | 20 | 140 | 100 |
| 16-09 | 10/100 | 20 | 200 | 100 |

Experiments: Several mixtures of GRU90 and acesulfame-K were mixed in this example. Each sample was evaluated according to the sensory evaluation method in Ex. 5. Average scores from the test panel for each sensory criterion were recorded as the evaluation test results. The resulting taste profiles of the mixtures are shown in Table 16-2. It should be noted that according to the sensory evaluation method, in these evaluations, the concentration of acesulfame-K in the sample solution was the same, 200 ppm. The results are shown in Table 16-2.

TABLE 16-2
Sensory evaluation results

| | Mouth | Sweet | | Metallic | Overall |
|---|---|---|---|---|---|
| No. | feel | lingering | Bitterness | aftertaste | likability |
| 16-00 | 2.00 | 3.00 | 3.00 | 3.00 | 2.50 |
| 16-01 | 2.00 | 3.00 | 2.50 | 2.50 | 2.70 |
| 16-02 | 2.50 | 2.00 | 2.00 | 2.00 | 3.30 |
| 16-03 | 3.00 | 1.00 | 1.50 | 2.00 | 3.80 |
| 16-04 | 3.50 | 1.00 | 1.00 | 2.00 | 4.20 |
| 16-05 | 3.50 | 1.00 | 1.00 | 2.00 | 4.40 |
| 16-06 | 4.00 | 1.00 | 1.00 | 2.00 | 4.40 |
| 16-07 | 4.00 | 1.00 | 1.50 | 2.00 | 4.00 |
| 16-08 | 4.00 | 1.00 | 2.00 | 2.00 | 3.70 |
| 16-09 | 4.00 | 1.00 | 2.50 | 2.00 | 3.50 |

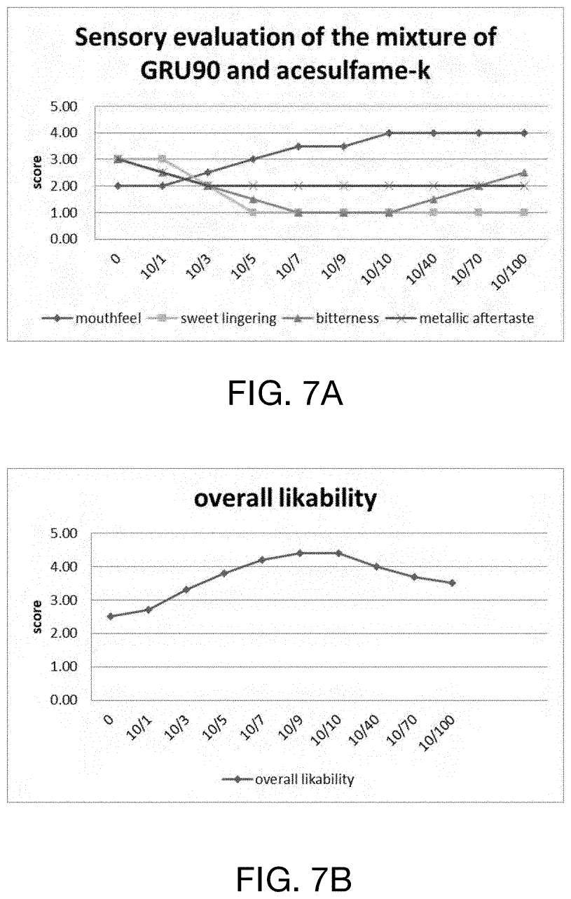

Data analysis: The relationship between the sensory evaluation results to the ratio of acesulfame-K to GRU90 in this example is shown in FIG. 7A. The relationship between the overall likability results to the ratio of acesulfame-K to GRU90 in this example is shown in FIG. 7B.

Conclusion: The results show that GRU90 significantly improved the mouth feel, cut the sweet lingering, decrease the metallic aftertaste and bitterness of acesulfame-K. These effects were observed in all the tested acesulfame-K-to-GRU90 ratios (from 10:1 to 10:100). These effects can be extended to the acesulfame-K-to-GRU90 ratio ranges of 99:1 to 1:99. This example demonstrates that GRU90 can improve taste, flavor intensity and mouth feel of artificial sweeteners, such as acesulfame-K. These effects can be extended to all artificial sweeteners.

### Example 17. GRU90-MRP-TA Improves the Taste and Mouth Feel of Sucralose when Blended Therewith

Process: GRU90-MRP-TA (product of Ex. 8) and sucralose (available from Anhui Jinhe Industrial Co., Ltd and Lot # is 201810013) were weighed and uniformly mixed according to the weight shown in Table 17-1, dissolved in 100 ml pure water, and subjected to a mouth feel evaluation test.

TABLE 17-1
Test sample composition

| | | | Weight of | |
|---|---|---|---|---|
| | The ratio of | Weight of | GRU90- | Volume of |
| | sucralose to | sucralose | MRP-TA | pure water |
| No. | GRU90-MRP-TA | (mg) | (mg) | (mL) |
| 17-00 | 10/0 | 15 | 0 | 100 |
| 17-01 | 10/1 | 15 | 1.5 | 100 |
| 17-02 | 10/3 | 15 | 4.5 | 100 |
| 17-03 | 10/5 | 15 | 7.5 | 100 |
| 17-04 | 10/7 | 15 | 10.5 | 100 |
| 17-05 | 10/9 | 15 | 13.5 | 100 |
| 17-06 | 10/10 | 15 | 15 | 100 |
| 17-07 | 10/40 | 15 | 60 | 100 |
| 17-08 | 10/70 | 15 | 105 | 100 |
| 17-09 | 10/100 | 15 | 150 | 100 |

Experiments: Several mixtures of GRU90-MRP-TA and sucralose were mixed in this example. Each sample was evaluated according to the sensory evaluation method in Ex. 5. Average scores from the test panel for each sensory criterion were recorded as the evaluation test results. The resulting taste profiles of the mixtures are shown in Table 17-2. It should be noted that according to the sensory evaluation method, in these evaluations, the concentration of sucralose in the sample solution was the same, 150 ppm.

TABLE 17-2
Sensory evaluation results

| | Mouth | Sweet | Metallic | Overall |
|---|---|---|---|---|
| No. | feel | lingering | aftertaste | likability |
| 17-00 | 1.00 | 3.00 | 3.50 | 2.25 |
| 17-01 | 1.50 | 3.00 | 2.50 | 2.70 |
| 17-02 | 2.00 | 2.00 | 2.00 | 3.20 |
| 17-03 | 3.00 | 2.00 | 2.00 | 3.70 |
| 17-04 | 3.50 | 1.50 | 2.00 | 4.20 |
| 17-05 | 3.50 | 1.50 | 2.00 | 4.00 |
| 17-06 | 3.50 | 1.50 | 2.00 | 4.10 |
| 17-07 | 4.00 | 1.50 | 2.00 | 4.00 |
| 17-08 | 4.20 | 1.50 | 2.00 | 4.00 |
| 17-09 | 4.50 | 1.50 | 2.00 | 4.00 |

Data analysis: The relationship between the sensory evaluation results to the ratio of sucralose to GRU90-MRP-TA in this example is shown in FIG. 8A. The relationship between the overall likability results to the ratio of sucralose to GRU90-MRP-TA in this example is shown in FIG. 8B.

Conclusion: The results show that GRU90-MRP-TA can significantly improve the mouth feel, cut the sweet lingering and decrease the metallic aftertaste of sucralose. These effects were observed in all the tested sucralose-to-GRU90-MRP-TA ratios (from 10:1 to 10:100). These effects can be extended to the sucralose-to-GRU90-MRP-TA ratio ranges of 99:1 to 1:99. This example demonstrates that GRU90-MRP-TA can improve the taste, flavor intensity and mouth feel of artificial sweetener, such as sucralose. These effects can be extended to all artificial sweeteners.

### Example 18. GRU90-MRP-CA (Product of Ex. 9) Improves the Taste and Mouth Feel of RA97 when Blended Therewith

Process: GRU90-MRP-CA and RA97 (available from Sweet Green Fields RA97, the content of RA is 97.15%. Lot #3050123) were weighed and uniformly mixed according to the weight shown in Table 18-1, dissolved in 100 ml pure water, and subjected to a mouth feel evaluation test.

TABLE 18-1
Preparation of mixtures of GRU90-MRP-CA and RA97

| | The ratio of | | Weight of | Volume |
|---|---|---|---|---|
| | RA97 to | Weight of | GRU90-MRP- | of pure |
| No. | GRU90-MRP-CA | RA97 (mg) | CA (mg) | water (mL) |
| 18-00 | 10/0 | 20 | 0 | 100 |
| 18-01 | 10/1 | 20 | 2 | 100 |
| 18-02 | 10/3 | 20 | 6 | 100 |
| 18-03 | 10/5 | 20 | 10 | 100 |
| 18-04 | 10/7 | 20 | 14 | 100 |
| 18-05 | 10/9 | 20 | 18 | 100 |
| 18-06 | 10/10 | 20 | 20 | 100 |
| 18-07 | 10/40 | 20 | 80 | 100 |
| 18-08 | 10/70 | 20 | 140 | 100 |
| 18-09 | 10/100 | 20 | 200 | 100 |

Experiments: Several mixtures of GRU90-MRP-CA and RA97 were mixed in this example. Each sample was evaluated according to the sensory evaluation method in Ex. 5. Average scores from the test panel for each sensory criterion were recorded as the evaluation test results. The resulting taste profiles of the mixtures are set forth in Table 18-2. It should be noted that according to the sensory evaluation method in these evaluations, the concentration of RA97 in the sample solution was the same, 200 ppm.

TABLE 18-2
Sensory evaluation results

| | Mouth | Sweet | | Overall |
|---|---|---|---|---|
| No. | feel | lingering | Bitterness | likability |
| 18-00 | 1.00 | 3.00 | 3.00 | 2.00 |
| 18-01 | 1.50 | 2.50 | 2.50 | 2.40 |
| 18-02 | 2.00 | 2.00 | 2.00 | 3.00 |
| 18-03 | 3.00 | 1.50 | 1.50 | 3.80 |
| 18-04 | 3.50 | 1.50 | 1.20 | 4.30 |
| 18-05 | 4.00 | 1.50 | 1.00 | 4.50 |
| 18-06 | 4.00 | 1.50 | 1.00 | 4.50 |
| 18-07 | 4.50 | 1.50 | 1.20 | 4.20 |
| 18-08 | 4.50 | 1.50 | 1.50 | 4.10 |
| 18-09 | 5.00 | 1.50 | 2.00 | 4.00 |

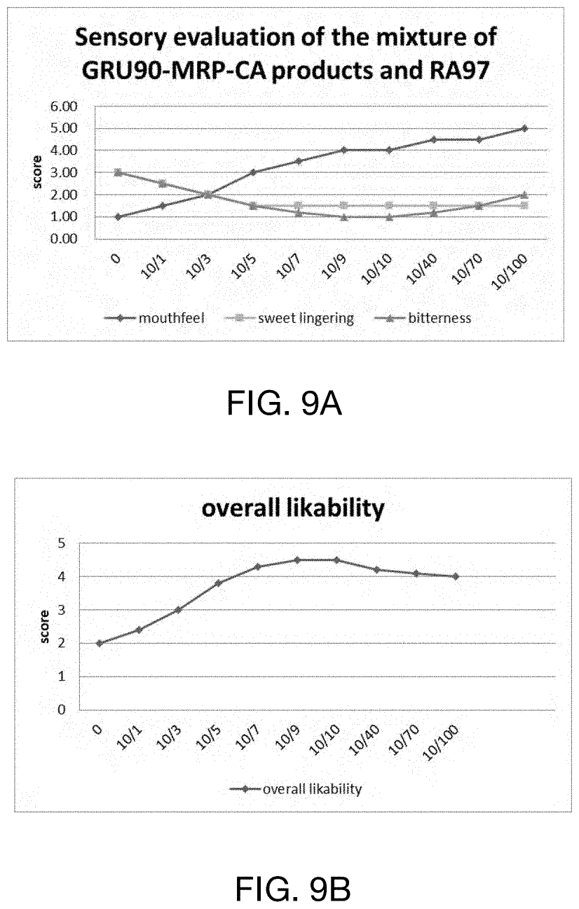

Data analysis: The relationship between the sensory evaluation results to the ratio of RA97 to GRU90-MRP-CA in this example is shown in FIG. 9A. The relationship between the overall likability results to the ratio of RA97 to GRU90-MRP-CA in this example is shown in FIG. 9B.

Conclusion: The results show that GRU90-MRP-CA can significantly improve the mouth feel, cut sweet lingering, and mask the bitterness of RA97. These effects were observed in all the tested RA97-to-GRU90-MRP-CA ratios (from 10:1 to 10:100). These effects can be extended to the RA97-to-GRU90-MRP-CA ratio ranges of 99:1 to 1:99. This example demonstrates that GRU90-MRP-CA can improve the taste profile, flavor intensity and mouth feel of natural sweeteners, such as RA97. Such effects can be extended to all natural sweeteners.

### Example 19. Addition of Fructose in the Maillard Reaction Improves the Taste Profile of GRU90-MRP-TA when Blended Therewith

Preparation of GRU90-MRP-TA from GRU90, glutamic acid and galactose/fructose:

The preparation of samples was the same as in Ex. 8, except that the reducing sugars were replaced by the blend of galactose and fructose (3:1). The weights of galactose and fructose and ratios therefrom are shown in Table 19-1.

TABLE 19-1
Test sample composition

| | Ratio of | | |
|---|---|---|---|
| | galactose to | Weight of | Weight of |
| Product No. | fructose | galactose(g) | fructose(g) |
| 19-00 | 1/0 | 0.83 | 0 |
| 19-01 | 1/1 | 0.415 | 0.415 |
| 19-02 | 1/4 | 0.16 | 0.67 |
| 19-03 | 0/1 | 0 | 0.83 |

Evaluation of the taste profile of the products of Ex. 19.

The samples in this example are evaluated by the method in Ex. 5.

Each panelist was asked to evaluate by his preference on 4 aspects—flavor, sweet lingering, mouth feel, and overall likability. The concentration was 550 ppm for each sample solutions.

TABLE 19-2
The score in sensory evaluation

| | | Mouth | Sweet | Overall |
|---|---|---|---|---|
| Product No. | flavor | feel | lingering | likability |
| 19-00 | Sugar | 3 | 3.5 | 3 |
| 19-01 | | 3.5 | 2.5 | 4 |
| 19-02 | | 4 | 2 | 4.5 |
| 19-03 | | 4.5 | 1 | 5 |

Each person of the test panel had to drink the products in this example and record the time-intensity curves. The results were recorded in Table 19-3, mean values were calculated from 6 individual test persons.

TABLE 19-3
Sweetness profile data of the products in Ex. 19

| | | | LINGERING | LINGERING |
|---|---|---|---|---|
| | ONSET | MAX | ON | OFF |
| Product No. | [sec] | [sec] | [sec] | [sec] |
| 19-00 | 1.75 | 4 | 7 | 18 |
| 19-01 | 1.2 | 3 | 6 | 15 |
| 19-02 | 0.75 | 2 | 5.5 | 13 |
| 19-03 | 0 | 1 | 4 | 9 |

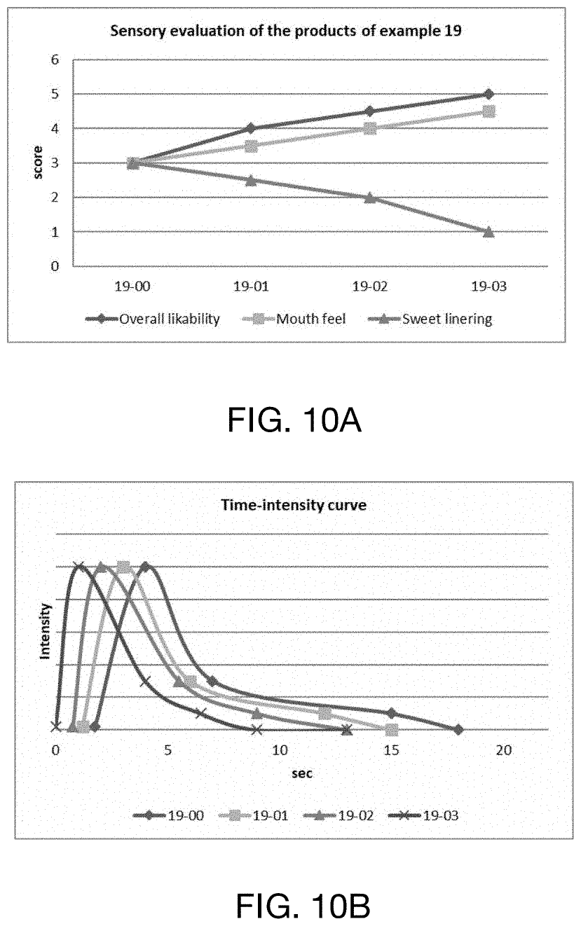

Data analysis: The sensory evaluation of products in this example is shown in FIG. 10A. Time-intensity curves are shown in FIG. 10B.

Conclusion: The results showed that having fructose participate in the Maillard reaction can significantly improve the mouth feel and overall likability, cut sweet lingering of GRU90-MRP-TA. In addition, the sweetness onset, max and lingering were improved with increasing amounts of fructose. This example demonstrates that having fructose participate in the Maillard reaction can significantly improve the taste profile of GRU90-MRP-TA.

### Example 20. Addition of Fructose in the Maillard Reaction Improves the Taste Profile of GRU90-MRP-CA when Blended Therewith

Preparation of GRU90-MRP-CA from GRU90, alanine and xylose/fructose:

The preparation of samples was the same as in Ex. 9, except that the reducing sugars were replaced by a blend of xylose and fructose. The weight of xylose and fructose was as follows.

TABLE 20-1
Test sample compositions.

| | Ratio of xylose | Weight of | Weight of |
|---|---|---|---|
| Product No. | to fructose | xylose (g) | fructose(g) |
| 20-00 | 1/0 | 5 | 0 |
| 20-01 | 1/1 | 2.5 | 2.5 |
| 20-02 | 1/4 | 1 | 4 |
| 20-03 | 0/1 | 0 | 5 |

Evaluation of the taste profile of the products of Ex. 20.

The samples in this example were evaluated by the method in Ex. 5.

Each panelist was asked to evaluate by his preference on four aspects—flavor, sweet lingering, mouth feel, and overall likability ability. The concentration was 800 ppm for each sample solutions.

TABLE 20-2
Sensory evaluation results.

| | | Mouth | Sweet | Overall |
|---|---|---|---|---|
| Product No. | Flavor | feel | lingering | likability |
| 20-00 | Caramel | 3.5 | 3 | 3 |
| 20-01 | | 4 | 2.5 | 3.5 |
| 20-01 | | 4.5 | 2 | 4 |
| 20-02 | | 5 | 1.5 | 4.75 |

Each person of the test panel had to drink the products in this example and record the time-intensity curves. The results were recorded in Table 20-3, mean values were calculated from 6 individual test persons.

TABLE 20-3
Sweetness profile data of the products in Ex. 20

| | | | LINGERING | LINGERING |
|---|---|---|---|---|
| | ONSET | MAX | ON | OFF |
| Product No. | [sec] | [sec] | [sec] | [sec] |
| 20-00 | 2 | 5 | 8.5 | 20 |
| 20-01 | 1.4 | 3.5 | 7 | 16 |
| 20-02 | 1 | 2.5 | 6 | 13 |
| 20-03 | 0.5 | 1.5 | 5 | 10 |

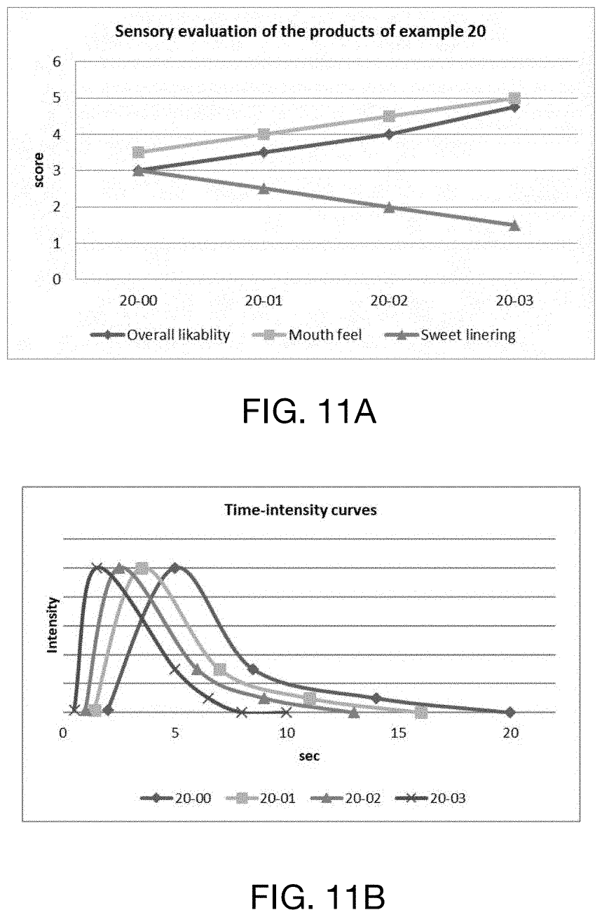

Data analysis: The sensory evaluation of products in this example is shown in FIG. 11A. Time-intensity curves are shown in FIG. 11B.

Conclusion: The results showed that having fructose participate Maillard reaction can significantly improve the mouth feel and overall likability, cut sweet lingering of GRU90-MRP-CA. In addition, the sweetness onset, max and lingering was improved with increasing amounts of fructose. This example demonstrates that having fructose participate in the Maillard reaction can significantly improve taste profile of GRU90-MRP-CA.

### Example 21. GRU90-MRP-FTA Improves the Taste Profile of Rebaudioside N (RM) when Blended Therewith

Process: GRU90-MRP-FTA and RM (available from Sichuan Ingia Biosynthetic Co., Ltd, China, the content of RM was 93.03% Lot #:20180915) were weighed and uniformly mixed according to the weight shown in Table 21-1, dissolved in 100 ml pure water, and subjected to an overall likability and time-intensity evaluation test.

TABLE 21-1
Test sample composition

| | | | Weight of | |
|---|---|---|---|---|
| | The ratio of RM to | Weight of | GRU90-MRP- | Volume of pure |
| No. | GRU90-MRP-FTA | RM (mg) | FTA (mg) | water (mL) |
| 21-00 | 10/0 | 50 | 0 | 100 |
| 21-01 | 10/1 | 50 | 5 | 100 |
| 21-02 | 10/3 | 50 | 15 | 100 |
| 21-03 | 10/5 | 50 | 25 | 100 |
| 21-04 | 10/7 | 50 | 35 | 100 |
| 21-05 | 10/9 | 50 | 45 | 100 |
| 21-06 | 10/10 | 50 | 50 | 100 |
| 21-07 | 10/40 | 50 | 200 | 100 |
| 21-08 | 10/70 | 50 | 350 | 100 |
| 21-09 | 10/100 | 50 | 500 | 100 |

Experiments: Several mixtures of GRU90-MRP-FTA and RM were mixed in this example. Each sample was evaluated according to the sensory evaluation method in Ex. 5. Average scores from the test panel for each sensory criterion were recorded as the evaluation test results. The resulting taste profiles of the mixtures are shown in Table 21-2. It should be noted that according to the sensory evaluation method, in these evaluations, the concentration of RM in the sample solution was the same, 500 ppm.

TABLE 21-2
Time-intensity and overall likability data of the products in Ex. 21

| | | | LINGERING | LINGERING | |
|---|---|---|---|---|---|
| Product | ONSET | MAX | ON | OFF | Overall |
| No. | [sec] | [sec] | [sec] | [sec] | likability |
| 21-00 | 1 | 2 | 5.5 | 15 | 2.5 |
| 21-01 | 0.75 | 1.7 | 5.5 | 13 | 3 |
| 21-02 | 0.5 | 1.5 | 5 | 12 | 3.5 |
| 21-03 | 0.5 | 1.5 | 5 | 10 | 4 |
| 21-04 | 0.25 | 1.2 | 5 | 10 | 4.5 |
| 21-05 | 0.1 | 1.2 | 4.5 | 10 | 4.5 |
| 21-06 | 0 | 1 | 4 | 9 | 4 |
| 21-07 | 0 | 1 | 4 | 9 | 3 |
| 21-08 | 0 | 1 | 4 | 9 | 3 |
| 21-09 | 0 | 1 | 4 | 9 | 3 |

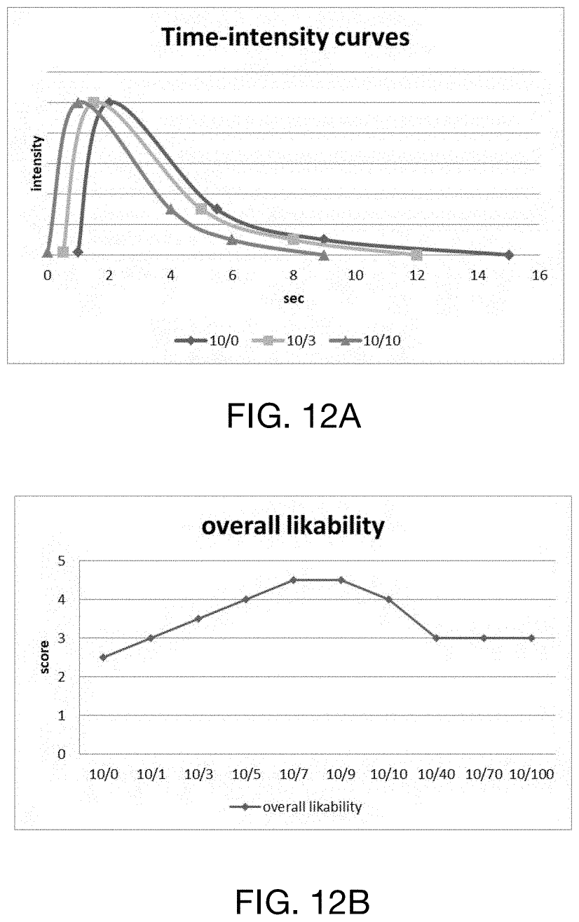

Data analysis: Time-intensity curves for three representative ratios of RM to GRU90-MRP-FTA in this example are shown in FIG. 12A.

The relationship between the overall likability results to the ratio of RM to GRU90-MRP-FTA in this example is shown in FIG. 12B.

Conclusion: The result showed that GRU90-MRP-FTA could significantly quicken sweetness onset, cut sweet lingering and improve the overall likability of RM. This effect was observed in all the tested RM-to-GRU90-MRP-FTA ratios (from 10:1 to 10:100). The effect can be extended to the RM-to-GRU90-MRP-FTA ratio range of 99:1 to 1:99. This example demonstrates that GRU90-MRP-FTA can significantly improve taste profile of natural sweeteners such as RM. Such effect can be extended to all natural sweeteners.

### Example 22. GRU90-MRP-FTA Improves the Taste Profile of Rebaudioside D (RD) when Blended Therewith

Process: GRU90-MRP-FTA (Ex. 19, 19-03) and RD (Sichuan Ingia Biosynthetic Co., Ltd, China, the content of RD was 94.39%, Lot #: 20190215) were weighed and uniformly mixed according to the weight shown in Table 22-1, dissolved in 100 ml pure water, and subjected to an overall likability and time-intensity evaluation tests.

TABLE 22-1
Test sample composition

| | The ratio of | | Weight of | Volume |
|---|---|---|---|---|
| | RD to GRU90- | Weight of | GRU90-MRP- | of pure |
| No. | MRP-FTA | RD (mg) | FTA (mg) | water (mL) |
| 22-00 | 10/0 | 50 | 0 | 100 |
| 22-01 | 10/1 | 50 | 5 | 100 |
| 22-02 | 10/3 | 50 | 15 | 100 |
| 22-03 | 10/5 | 50 | 25 | 100 |
| 22-04 | 10/7 | 50 | 35 | 100 |
| 22-05 | 10/9 | 50 | 45 | 100 |
| 22-06 | 10/10 | 50 | 50 | 100 |
| 22-07 | 10/40 | 50 | 200 | 100 |
| 22-08 | 10/70 | 50 | 350 | 100 |
| 22-09 | 10/100 | 50 | 500 | 100 |

Experiments: Several mixtures of GRU90-MRP-FTA and RD were mixed in this example. Each sample was evaluated according to the sensory evaluation method in Ex. 5. Average scores from the test panel for each sensory criterion were recorded as the evaluation test results. The taste profiles of the mixtures are shown in Table 22-2. It should be noted that according to the sensory evaluation method, in these evaluations, the concentration of RD in the sample solution was the same, 500 ppm.

TABLE 22-2
Time-intensity and overall likability data of the products in Ex. 22

| | | | LINGERING | LINGERING | |
|---|---|---|---|---|---|
| Product | ONSET | MAX | ON | OFF | Overall |
| No. | [sec] | [sec] | [sec] | [sec] | likability |
| 22-00 | 1 | 2.5 | 6 | 17 | 2.5 |
| 22-01 | 0.7 | 1.3 | 5 | 14 | 3.5 |
| 22-02 | 0.5 | 1.3 | 5 | 12 | 4 |
| 22-03 | 0.5 | 1.1 | 5 | 10 | 4.5 |
| 22-04 | 0 | 1 | 4 | 10 | 4.5 |
| 22-05 | 0 | 1 | 4 | 10 | 4 |
| 22-06 | 0 | 1 | 4 | 10 | 4 |
| 22-07 | 0 | 1 | 4 | 10 | 3 |
| 22-08 | 0 | 1 | 4 | 10 | 3 |
| 22-09 | 0 | 1 | 4 | 10 | 3 |

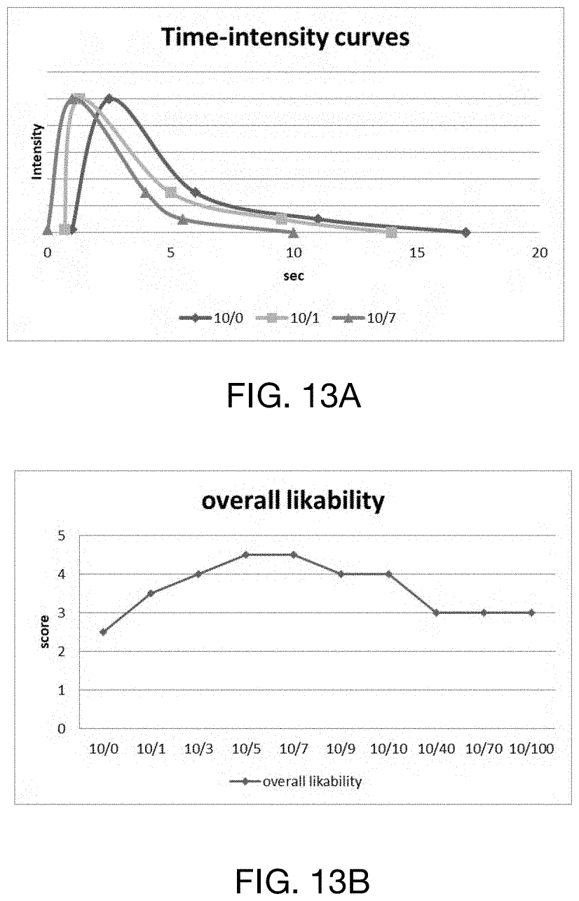

Data analysis: Time-intensity curves for three representative ratios of RD to GRU90-MRP-FTA in this example are shown in FIG. 13A. The relationship between the overall likability results to the ratio of RD to GRU90-MRP-FTA in this example is shown in FIG. 13B.

Conclusion: The result showed that GRU90-MRP-FTA could significantly quicken sweetness onset, cut sweet lingering and improve the overall likability of RD. This effect was observed in all the tested RD-to-GRU90-MRP-FTA ratios (from 10:1 to 10:100). The effect can be extended to the RD-to-GRU90-MRP-FTA ratio range of 99:1 to 1:99. This example demonstrates that GRU90-MRP-FTA can significantly improve taste profile of natural sweeteners such as RD. Such effect can be extended to all natural sweeteners.

### Example 23. GRU90-MRP-FTA Improves the Taste Profile of Thaumatin when Blended Therewith

Process: GRU90-MRP-FTA (Ex. 19, 19-03) and thaumatin (available from EPC Natural products CO., Ltd the content of thaumatin was 93%, Lot #: 20200201) were weighed and uniformly mixed according to the weight shown in Table 23-1, dissolved in 100 ml pure water, and subjected to an overall likeability and time-intensity evaluation test.

TABLE 23-1
Test sample compositions.

| | The ratio of | | | |
|---|---|---|---|---|
| | thaumatin to | | Weight of | Volume |
| | GRU90-MRP- | Weight of | GRU90-MRP- | of pure |
| No. | FTA | thaumatin (mg) | FTA (mg) | water (mL) |
| 23-00 | 15/0 | 15 | 0 | 100 |
| 23-01 | 15/5 | 15 | 5 | 100 |
| 23-02 | 15/15 | 15 | 15 | 100 |
| 23-03 | 15/30 | 15 | 30 | 100 |
| 23-04 | 15/45 | 15 | 45 | 100 |
| 23-05 | 15/60 | 15 | 60 | 100 |
| 23-06 | 15/90 | 15 | 90 | 100 |
| 23-07 | 15/150 | 15 | 150 | 100 |
| 23-08 | 15/200 | 15 | 200 | 100 |
| 23-09 | 15/300 | 15 | 300 | 100 |

Experiments: Several mixtures of GRU90-MRP-FTA and thaumatin were mixed in this example. Each sample was evaluated according to the sensory evaluation method in Ex. 5. Average scores from the test panel for each sensory criterion were recorded as the evaluation test results. The resulting taste profiles of the mixtures are shown in Table 23-2. It should be noted that according to the sensory evaluation method, in these evaluations, the concentration of thaumatin in the sample solution was the same, 15 ppm.

TABLE 23-2
Time-intensity and overall likability data of the products in Ex. 23

| | | | LINGERING | LINGERING | |
|---|---|---|---|---|---|
| Product | ONSET | MAX | ON | OFF | Overall |
| No. | [sec] | [sec] | [sec] | [sec] | likability |
| 23-00 | 1 | 7 | 13 | 28 | 3 |
| 23-01 | 1 | 5 | 9 | 21 | 3.5 |
| 23-02 | 1 | 4.5 | 9 | 21 | 4 |
| 23-03 | 1 | 4 | 8 | 19 | 4.2 |
| 23-04 | 1 | 3.5 | 8 | 16 | 4.2 |
| 23-05 | 1 | 3 | 6 | 14 | 4.5 |
| 23-06 | 1 | 2.5 | 6 | 12 | 4.5 |
| 23-07 | 1 | 2.5 | 5 | 12 | 4.8 |
| 23-08 | 1 | 2.5 | 5 | 10 | 4.8 |
| 23-09 | 1 | 2.3 | 5 | 10 | 4.8 |

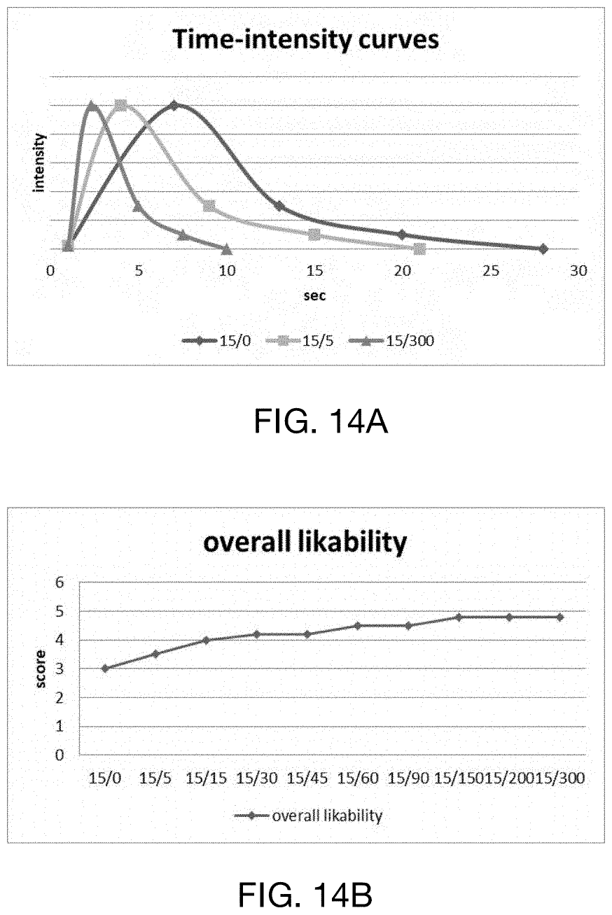

Data analysis: Time-intensity curves for three representative ratios of thaumatin to GRU90-MRP-FTA in this example are shown in FIG. 14A. The relationship between the overall likability results to the ratio of thaumatin to GRU90-MRP-FTA in this example is shown in FIG. 14B.

Conclusion: The result showed that GRU90-MRP-FTA could significantly quicken sweetness onset, cut sweet lingering and improve the overall likability of thaumatin. This effect was observed in all the tested thaumatin-to-GRU90-MRP-FTA ratios (from 15:5 to 15:300). The effect can be extended to the thaumatin-to-GRU90-MRP-FTA ratio range of 33:1 to 1:99. This example demonstrates that GRU90-MRP-FTA can significantly improve taste profile of thaumatin.

### Example 24. GRU90-MRP-FTA Improves the Taste Profile of Allulose when Blended Therewith

Process: GRU90-MRP-FTA (Ex. 19, 19-03) and allulose (available from Tate & Lyle, USA Lot #: YP17E92205) were weighed and uniformly mixed according to the weight shown in Table 24-1, dissolved in 100 ml pure water, and subjected to a sensory evaluation test.

TABLE 24-1
Test sample composition

| | The ratio of | | | |
|---|---|---|---|---|
| | allulose to | | Weight of | Volume |
| | GRU90-MRP- | Weight of | GRU90-MRP- | of pure |
| No. | FTA | allulose (g) | FTA (mg) | water (mL) |
| 24-00 | 3000/0 | 3 | 0 | 100 |
| 24-01 | 3000/10 | 3 | 10 | 100 |
| 24-02 | 3000/30 | 3 | 30 | 100 |
| 24-03 | 3000/60 | 3 | 60 | 100 |
| 24-04 | 3000/90 | 3 | 90 | 100 |
| 24-05 | 3000/120 | 3 | 120 | 100 |
| 24-06 | 3000/150 | 3 | 150 | 100 |
| 24-07 | 3000/200 | 3 | 200 | 100 |
| 24-08 | 3000/300 | 3 | 300 | 100 |

Experiments: Several mixtures of GRU90-MRP-FTA and allulose were mixed in this example. Each sample was evaluated according to the sensory evaluation method in Ex. 5. Average scores from the test panel for each sensory criterion were recorded as the evaluation test results. The resulting taste profiles of the mixtures are shown in Table 24-2. It should be noted that according to the sensory evaluation method, in these evaluations, the concentration of allulose in the sample solution was the same, 3%.

TABLE 24-2
Sensory evaluation results

| No. | Bitterness | Starch taste | Mouth feel | Overall likability |
|---|---|---|---|---|
| 24-00 | 3 | 3.5 | 3.5 | 3 |
| 24-01 | 2.5 | 3.2 | 3.5 | 3.2 |
| 24-02 | 2 | 3 | 3.5 | 3.5 |
| 24-03 | 1.5 | 2.5 | 3.2 | 4 |
| 24-04 | 1 | 2 | 3.2 | 4 |
| 24-05 | 1 | 1 | 3 | 4.5 |
| 24-06 | 1 | 1 | 3 | 4.5 |
| 24-07 | 1 | 1 | 3 | 4.5 |
| 24-08 | 1 | 1 | 3 | 4.5 |

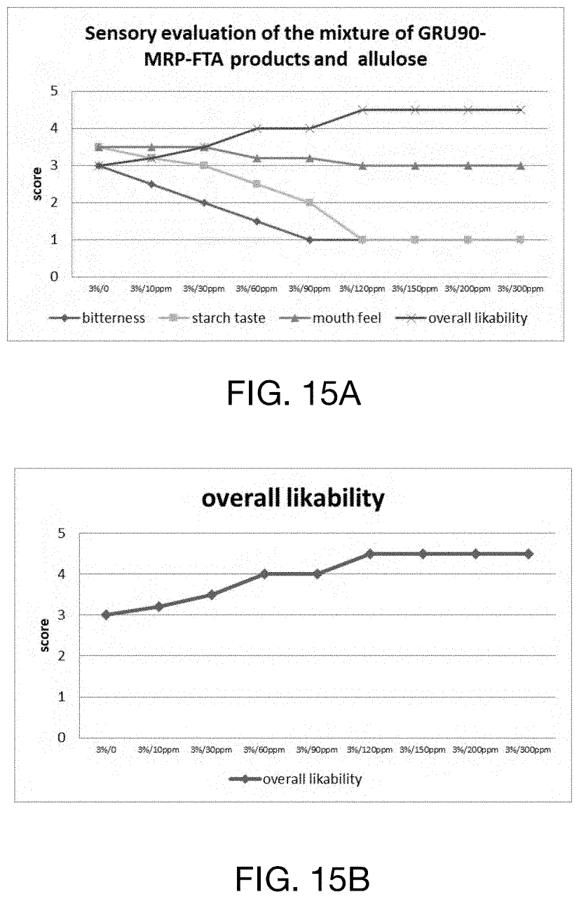

The relationship between the sensory evaluation results to the ratio of allulose to GRU90-MRP-FTA in this example is shown in FIG. 15A. The relationship between the overall likability results to the ratio of allulose to GRU90-MRP-FTA in this example is shown in FIG. 15B.

Conclusion: The results showed that GRU90-MRP-FTA can significantly mask the bitterness, starch taste and keep the mouth feel of allulose. These effects were observed in all the tested allulose-to-GRU90-MRP-FTA ratios (from 3000:10 to 3000:300). These effects can be extended to allulose-to-GRU90-MRP-FTA ratio ranges of 3000:1 to 1:1). This example demonstrates that GRU90-MRP-FTA can significantly improve taste profile of allulose.

### Example 25. GRU90-MRP-FTA Improves the Taste of Polydextrose when Blended Therewith

Process: GRU90-MRP-FTA (Ex. 19, 19-03) and polydextrose (available from Henan Tailijie Biotech Co., Ltd. Lot #: 201911113) were weighed and uniformly mixed according to the weight shown in Table 25-1, dissolved in 100 ml pure water, and subjected to a mouth feel evaluation test.

TABLE 25-1
Test sample compositions.

| | The ratio of | | | |
|---|---|---|---|---|
| | polydextrose to | Weight of | Weight of | Volume of |
| | GRU90-MRP- | polydextrose | GRU90-MRP-FTA | pure water |
| No. | FTA | (g) | (mg) | (mL) |
| 25-00 | 3000/0 | 3 | 0 | 100 |
| 25-01 | 3000/10 | 3 | 10 | 100 |
| 25-02 | 3000/30 | 3 | 30 | 100 |
| 25-03 | 3000/60 | 3 | 60 | 100 |
| 25-04 | 3000/90 | 3 | 90 | 100 |
| 25-05 | 3000/120 | 3 | 120 | 100 |
| 25-06 | 3000/150 | 3 | 150 | 100 |
| 25-07 | 3000/200 | 3 | 200 | 100 |
| 25-08 | 3000/300 | 3 | 300 | 100 |

Experiments: Several mixtures of GRU90-MRP-FTA and polydextrose were mixed in this example. Each sample was evaluated according to the sensory evaluation method in Ex. 5. Average scores from the test panel for each sensory criterion were recorded as the evaluation test results. The resulting taste profiles of the mixtures are shown in Table 25-2. It should be noted that according to the sensory evaluation method, in these evaluations, the concentration of polydextrose in the sample solution was the same, 3%.

TABLE 25-2
Sensory evaluation results

| No. | Starch taste | Mouth feel | Overall likability |
|---|---|---|---|
| 25-00 | 3.5 | 4 | 2 |
| 25-01 | 3 | 4 | 2.5 |
| 25-02 | 2.5 | 4 | 2.8 |
| 25-03 | 1.8 | 3.8 | 3 |
| 25-04 | 1.5 | 3.8 | 3.5 |
| 25-05 | 1 | 3.5 | 3.8 |
| 25-06 | 1 | 3.5 | 4 |
| 25-07 | 1 | 3 | 4 |
| 25-08 | 1 | 3 | 4 |

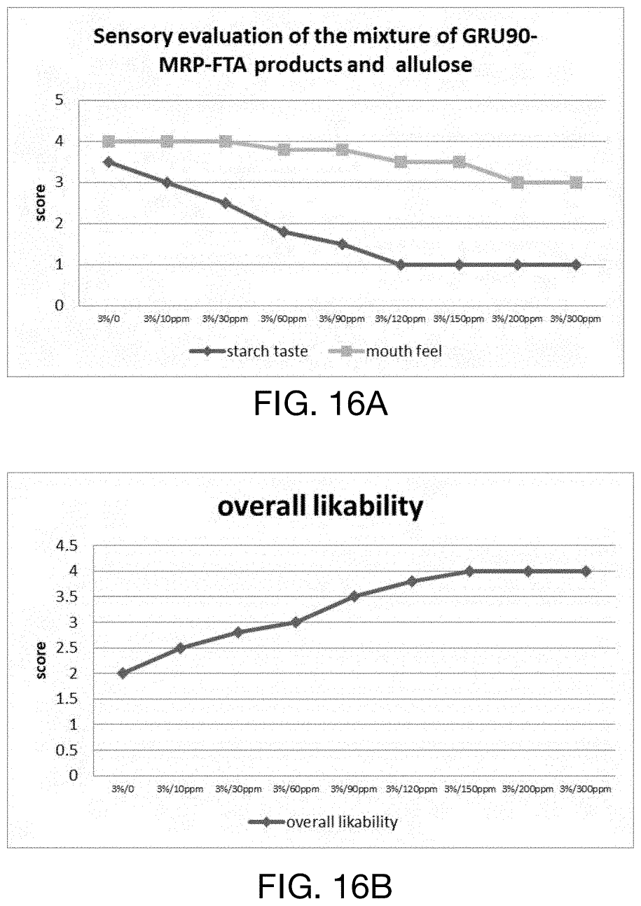

Data analysis: The relationship between the sensory evaluation results to the ratio of polydextrose to GRU90-MRP-FTA in this example is shown in FIG. 16A. The relationship between the overall likability results to the ratio of polydextrose to GRU90-MRP-FTA in this example is shown in FIG. 16B.

Conclusion: The result showed that GRU90-MRP-FTA could significantly mask the starch taste and basically keep the mouth feel of polydextrose. This effect was observed in all the tested polydextrose-to-GRU90-MRP-FTA ratios (from 3000:10 to 3000:300). The effect can be extended to the polydextrose-to-GRU90-MRP-FTA ratio range of 3000:1 to 1:1). This example demonstrates that GRU90-MRP-FTA can significantly improve taste profile of polydextrose.

### Example 26. GRU90-MRP-FTA Improves the Taste Profile of RM/RD Mixture

Process: GRU90-MRP-FTA (Ex. 19, 19-03) and RM/RD mixture (available from Sichuan Ingia Biosynthetic Co., ltd, China. The content of RM was 93.03% and Lot # was 20190215 while the content of RD was 94.39% and Lot # was 20180915) were weighed and uniformly mixed according to the weight shown in Table 26-1, dissolved in 100 ml pure water, and subjected to an overall likability and time-intensity evaluation test.

TABLE 26-1
Test sample compositions.

| | The ratio of | | | Weight | |
|---|---|---|---|---|---|
| | RM/RD to | Weight | Weight | of GRU90- | Volume of |
| | GRU90-MRP- | of RM | of RD | MRP-FTA | pure water |
| No. | FTA | (mg) | (mg) | (mg) | (mL) |
| 26-00 | 10/0 | 25 | 25 | 0 | 100 |
| 26-01 | 10/0.5 | 25 | 25 | 2.5 | 100 |
| 26-02 | 10/1 | 25 | 25 | 5 | 100 |
| 26-03 | 10/3 | 25 | 25 | 15 | 100 |
| 26-04 | 10/5 | 25 | 25 | 25 | 100 |
| 26-05 | 10/7 | 25 | 25 | 35 | 100 |
| 26-06 | 10/9 | 25 | 25 | 45 | 100 |
| 26-07 | 10/10 | 25 | 25 | 50 | 100 |
| 26-08 | 10/40 | 25 | 25 | 200 | 100 |
| 26-09 | 10/70 | 25 | 25 | 350 | 100 |
| 26-10 | 10/100 | 25 | 25 | 500 | 100 |

Experiments: Several mixtures of GRU90-MRP-FTA and RM/RD mixture were mixed in this example. Each sample was evaluated according to the sensory evaluation method in Ex. 5. Average scores from the test panel for each sensory criterion were recorded as the evaluation test results. The taste profiles of the mixtures are shown in Table 26-2. It should be noted that according to the sensory evaluation method, in these evaluations, the total concentration of RM and RD in the sample solution was the same, 500 ppm.

TABLE 26-2
Time-intensity and overall likability data of the products in Ex. 26

| | | | LINGERING | LINGERING | |
|---|---|---|---|---|---|
| Product | ONSET | MAX | ON | OFF | Overall |
| No. | [sec] | [sec] | [sec] | [sec] | likability |
| 26-00 | 1.3 | 2.5 | 6 | 18 | 3 |
| 26-01 | 1.20 | 2.2 | 5.5 | 16 | 3.2 |
| 26-02 | 1 | 1.6 | 5 | 15 | 3.5 |
| 26-03 | 0.4 | 1.6 | 5 | 14 | 3.8 |
| 26-04 | 0.25 | 1.2 | 5 | 14 | 4 |
| 26-05 | 0.1 | 1.2 | 4.5 | 11 | 4.5 |
| 26-06 | 0 | 1 | 4 | 11 | 4.5 |
| 26-07 | 0 | 1 | 4 | 9 | 4.5 |
| 26-08 | 0 | 1 | 4 | 9 | 4 |
| 26-09 | 0 | 1 | 4 | 9 | 3.5 |
| 26-10 | 0 | 1 | 4 | 9 | 3.5 |

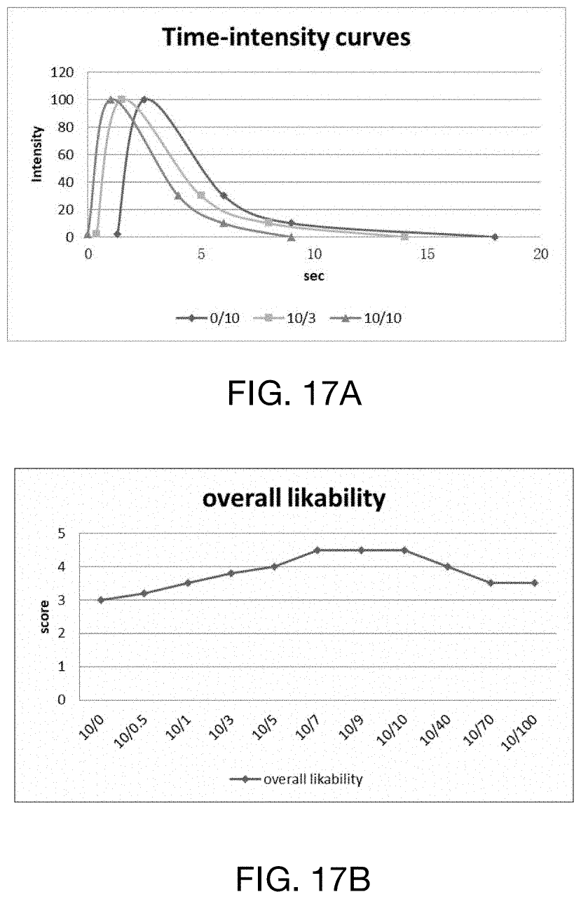

Data analysis: Time-intensity curves for three representative ratios of the RM/RD mixture to GRU90-MRP-FTA in this example are shown in FIG. 17A. The relationship between the overall likability results to the ratio of RM/RD mixture to GRU90-MRP-FTA in this example is shown in FIG. 17B.

Conclusion: The result showed that GRU90-MRP-FTA could significantly quicken sweetness onset, cut sweet lingering and improve the overall likability of the RM/RD mixture. This effect was observed in all the tested RM/RD-to-GRU90-MRP-FTA ratios (from 10:0.5 to 10:100). The effect can be extended to the RM/RD-to-GRU90-MRP-FTA ratio range of 99:1 to 1:99. This example demonstrates that GRU90-MRP-FTA can significantly improve taste profile of natural sweetener mixtures such as RM/RD. Such effect can be extended to all natural sweetener mixtures, including stevia compositions comprising one or more stevia glycosides selected from Reb A, Reb B, Reb C, stevioside, Reb D, Reb E, Reb I, Reb M, Reb N, Reb O.

### Example 27. GRU90-MRP-FTA Improves the Taste Profile of RM/RD/RA Mixture

Process: GRU90-MRP-FTA (Ex. 19, 19-03) and RM/RD/RA97 (RM and RD are available from Sichuan Ingia Biosynthetic Co., Ltd, China, while RA97 is available from Sweet Green Fields. The content of RM was 93.03%, RD was 94.39% and RA97 was 97.15%. The Lot # of RM was 20180915, RD was 20190215 and RA97 was 3050123) were weighed and uniformly mixed according to the weight shown in Table 27-1, dissolved in 100 ml pure water, and subjected to an overall likability and time-intensity evaluation test.

TABLE 27-1
Test sample composition

| | The ratio of | Weight | Weight | Weight | Weight of | Volume of |
|---|---|---|---|---|---|---|
| | RM/RD/RA97 to | of RM | of RD | of RA97 | GRU90-MRP-FTA | pure water |
| No. | GRU90-MRP-FTA | (mg) | (mg) | (mg) | (mg) | (mL) |
| 27-00 | 10/0 | 41.5 | 7 | 1.5 | 0 | 100 |
| 27-01 | 10/0.5 | 41.5 | 7 | 1.5 | 2.5 | 100 |
| 27-02 | 10/1 | 41.5 | 7 | 1.5 | 5 | 100 |
| 27-03 | 10/3 | 41.5 | 7 | 1.5 | 15 | 100 |
| 27-04 | 10/5 | 41.5 | 7 | 1.5 | 25 | 100 |
| 27-05 | 10/7 | 41.5 | 7 | 1.5 | 35 | 100 |
| 27-06 | 10/9 | 41.5 | 7 | 1.5 | 45 | 100 |
| 27-07 | 10/10 | 41.5 | 7 | 1.5 | 50 | 100 |
| 27-08 | 10/40 | 41.5 | 7 | 1.5 | 200 | 100 |
| 27-09 | 10/70 | 41.5 | 7 | 1.5 | 350 | 100 |
| 27-10 | 10/100 | 41.5 | 7 | 1.5 | 500 | 100 |

Experiments: Several mixtures of GRU90-MRP-FTA and RM/RD/RA97 mixture were mixed in this example. Each sample was evaluated according to the sensory evaluation method in Ex. 5. The resulting sweetness and overall likability profiles of the mixtures are shown in Table 27-2. It should be noted that according to the sensory evaluation methods herein, the concentration of RM/RD/RA97 mixture in each sample solution was the same, 500 ppm.

TABLE 27-2
Time-intensity and overall likability data of the products in Ex. 22

| | | | LINGERING | LINGERING | |
|---|---|---|---|---|---|
| Product | ONSET | MAX | ON | OFF | Overall |
| No. | [sec] | [sec] | [sec] | [sec] | likability |
| 27-00 | 1.8 | 3 | 7 | 32 | 3 |
| 27-01 | 1.3 | 2.5 | 6 | 22 | 3.2 |
| 27-02 | 1.2 | 2.1 | 5.5 | 20.5 | 3.5 |
| 27-03 | 0.5 | 2 | 5 | 17 | 4 |
| 27-04 | 0.5 | 2 | 4 | 16 | 4.5 |
| 27-05 | 0.5 | 2 | 4 | 16 | 4.5 |
| 27-06 | 0.5 | 1.5 | 3.5 | 13.5 | 4.5 |
| 27-07 | 0 | 1.3 | 3.5 | 10 | 4.2 |
| 27-08 | 0 | 1.3 | 3.5 | 10 | 3.5 |
| 27-09 | 0 | 1.3 | 3.5 | 10 | 3.5 |
| 27-10 | 0 | 1.3 | 3.5 | 10 | 3.2 |

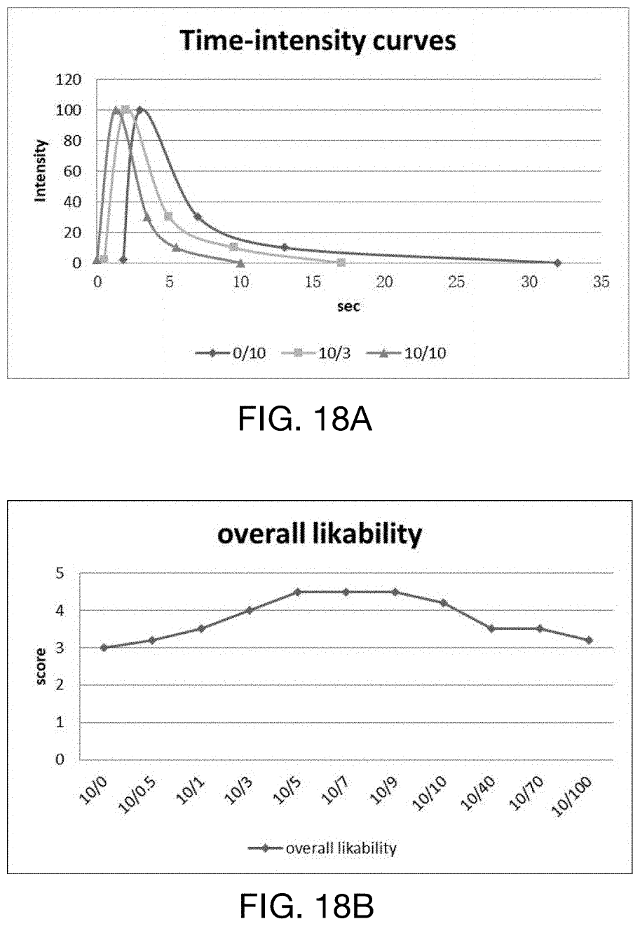

Data analysis: Time-intensity curves of three representative ratios of the RM/RD/RA97 mixture to GRU90-MRP-FTA in this example are shown in FIG. 18A. The relationship between the overall likability results to the ratio of RM/RD/RA97mixture to GRU90-MRP-FTA in this example is shown in FIG. 18B.

Conclusion: The result showed that GRU90-MRP-FTA could significantly quicken sweetness onset, cut sweet lingering and improve the overall likability of RM/RD/RA97 mixture. This effect was observed in all the tested RM/RD/RA97-to-GRU90-MRP-FTA ratios (from 10:0.5 to 10:100). The effect can be extended to the RM/RD/RA97-to-GRU90-MRP-FTA ratio range of 99:1 to 1:99. This example demonstrates that GRU90-MRP-FTA can significantly improve taste profile of natural sweetener mixtures such as RM/RD/RA97. Such effect can be extended to all natural sweetener mixtures including Stevia compositions comprising one or more stevia glycosides selected from Reb A, Reb B, Reb C, stevioside, Reb D, Reb E, Reb I, Reb M, Reb N, Reb O.

### Example 28. The Synergic Effect of GRU90-MRP-FTA and RM on Sweetness

Process: GRU90-MRP-FTA (Ex. 19, 19-03) and RM (available from Sichuan Ingia Biosynthetic Co., ltd, China. The content of RM was 93.03% and Lot # was 20180915) were weighed and uniformly mixed according to the weight shown in Table 28-1, dissolved in 100 ml pure water, and subjected to an sugar equivalent evaluation test.

TABLE 28-1
Test sample composition

| | | Weight of | |
|---|---|---|---|
| | Weight of | GRU90-MRP- | Volume of pure |
| No. | RM (mg) | FTA (mg) | water (mL) |
| 28-00 | 30 | 0 | 100 |
| 28-01 | 30 | 5 | 100 |
| 28-02 | 30 | 10 | 100 |
| 28-03 | 30 | 20 | 100 |
| 28-04 | 30 | 30 | 100 |
| 28-05 | 30 | 40 | 100 |
| 28-06 | 30 | 60 | 100 |
| 28-07 | 30 | 80 | 100 |
| 28-08 | 30 | 100 | 100 |

Experiments: Several mixtures of GRU90-MRP-FTA and RM were mixed in this example. Each sample was evaluated according to the sensory evaluation methods in Ex. 5. Average scores from the test panel for each sensory criterion were recorded as the evaluation test results. In addition, the SugarE for each mixture was determined based on the method in Ex. 5, the results of which shown in Table 28-2. It should be noted that to evaluate the sweetness effect of GRU90-MRP-FTA to RM, theoretical calculation and experiment SugarE of GRU90-MRP-FTA and RM are compared.

TABLE 28-2
SugarE of the products in Ex. 28

| | | | | | Theoretical | | Theoretical | |
|---|---|---|---|---|---|---|---|---|
| | | | | | calculation | Experiment | calculation | Experiment |
| | | | Conc. of | SugarE | SugarE of | SugarE of | SugarE of | SugarE of |
| | Conc. | SugarE | GRU90-MRP- | of | GRU90-MRP- | GRU90-MRP- | GRU90-MRP- | GRU90-MRP- |
| | of RM | of | FTA | GRU90-MRP- | FTA | FTA | FTA | FTA |
| No. | (ppm) | RM | (ppm) | FTA | and RM | and RM | per ppm | per ppm |
| 28-00 | 300 | 6 | 0 | 0 | 6 | 6 | 0 | 0 |
| 28-01 | 300 | 6 | 50 | 0.5 | 6.5 | 6.3 | 100 | 60 |
| 28-02 | 300 | 6 | 100 | 1 | 7 | 7 | 100 | 100 |
| 28-03 | 300 | 6 | 200 | 2 | 8 | 8.4 | 100 | 120 |
| 28-04 | 300 | 6 | 300 | 3 | 9 | 9.5 | 100 | 116.67 |
| 28-05 | 300 | 6 | 400 | 3.5 | 9.5 | 10 | 87.5 | 100 |
| 28-06 | 300 | 6 | 600 | 3.8 | 9.8 | 10.5 | 63.33 | 75 |
| 28-07 | 300 | 6 | 800 | 4 | 10 | 10.8 | 50 | 60 |
| 28-08 | 300 | 6 | 1000 | 4.3 | 10.3 | 10.8 | 43 | 48 |

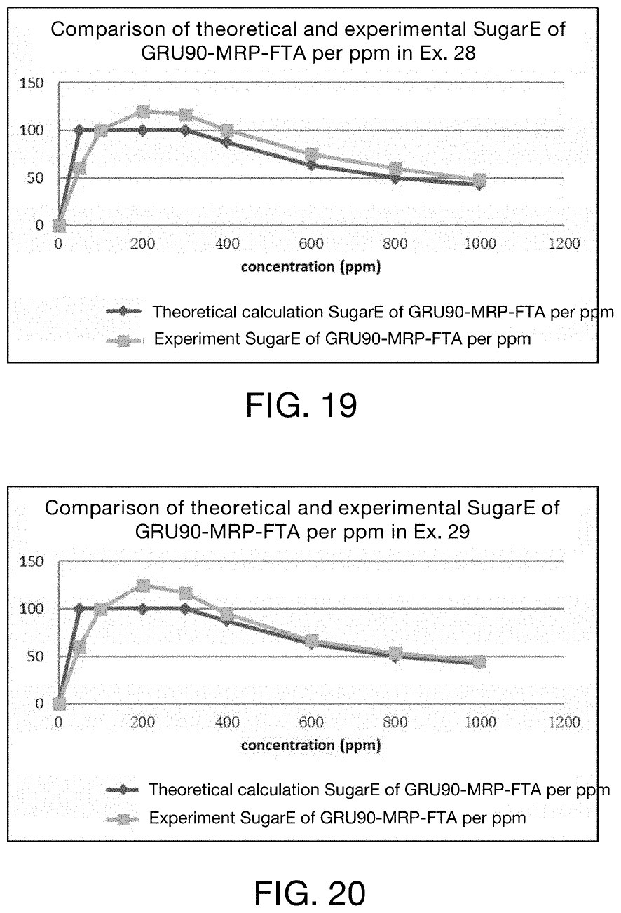

Data analysis: A comparison of theoretically calculated and experimentally determined SugarEs of GRU90-MRP-FTA per ppm in this example is shown in FIG. 19.

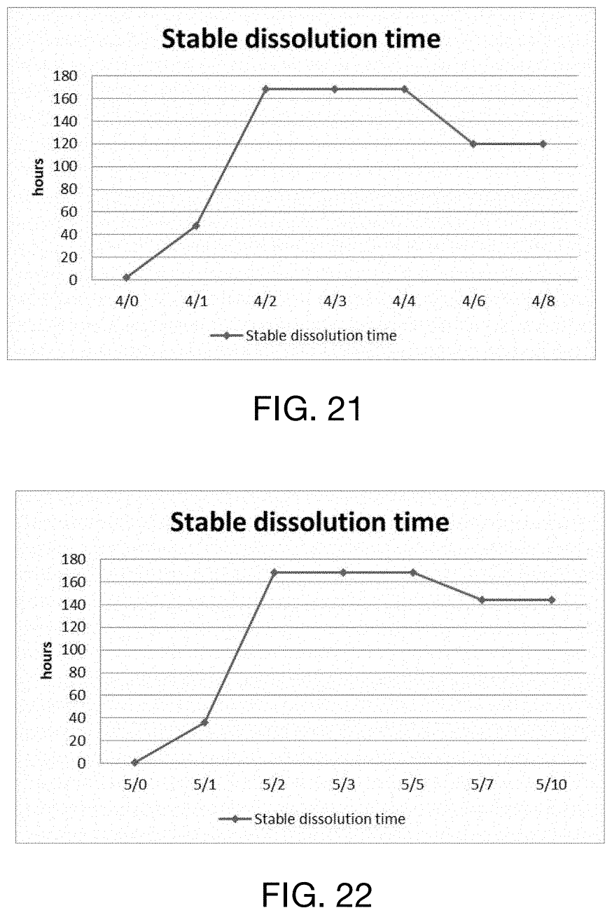

Conclusion: At 300 ppm RM content, increasing the amount of GRU90-MRP-FTA results in a measured contribution to sweetness that was higher than the calculated value as shown in FIG. 21. A positive sweetness synergic effect was found when the concentration of GRU90-MRP-FTA equaled to, or was greater than, 100 ppm. This technology can be extended to any Stevia composition comprising one or more steviol glycosides selected from Reb A, Reb B, stevioside, Reb C, Reb D, Reb E, Reb I, Reb M, Reb N, Reb O.

### Example 29. The Synergistic Effect of GRU90-MRP-FTA and RD on Sweetness

Process: GRU90-MRP-FTA (Ex. 19, 19-03) and RD (available from Sichuan Ingia Biosynthetic Co., Ltd., China. RD (94.39% content, Lot #20190215) was weighed and uniformly mixed according to the weight shown in Table 29-1, dissolved in 100 ml pure water, and subjected to a sugar equivalent evaluation test.

TABLE 29-1
Test sample composition

| | | Weight of | |
|---|---|---|---|
| | Weight of | GRU90-MRP- | Volume of pure |
| No. | RD (mg) | FTA (mg) | water (mL) |
| 29-00 | 30 | 0 | 100 |
| 29-01 | 30 | 5 | 100 |
| 29-02 | 30 | 10 | 100 |
| 29-03 | 30 | 20 | 100 |
| 29-04 | 30 | 30 | 100 |
| 29-05 | 30 | 40 | 100 |
| 29-06 | 30 | 60 | 100 |
| 29-07 | 30 | 80 | 100 |
| 29-08 | 30 | 100 | 100 |

Experiments: Several mixtures of GRU90-MRP-FTA and RD were mixed in this example. Each sample was evaluated according to the sensory evaluation methods in Ex. 5. In addition, the SugarE for each mixture was determined based on the method in Ex. 5, the results of which shown in Table 29-2. It should be noted that to evaluate the sweetness effect of GRU90-MRP-FTA to RD, the theoretical calculations and experiment SugarEs from GRU90-MRP-FTA and RD were compared.

TABLE 29-2
SugarE of the samples in Ex. 29

| | | | | | Theoretical | | Theoretical | |
|---|---|---|---|---|---|---|---|---|
| | | | Conc. | | calculation | Experiment | calculation | Experiment |
| | | | of | SugarE | SugarE of | SugarE of | SugarE of | SugarE of |
| | Conc. | SugarE | GRU90-MRP- | of | GRU90-MRP- | GRU90-MRP- | GRU90-MRP- | GRU90-MRP- |
| | of RD | of | FTA | GRU90-MRP- | FTA | FTA | FTA | FTA |
| No. | (ppm) | RD | (ppm) | FTA | and RD | and RD | per ppm | per ppm |
| 29-00 | 300 | 6.5 | 0 | 0 | 6.5 | 6.5 | 0 | 0 |
| 29-01 | 300 | 6.5 | 50 | 0.5 | 7 | 6.8 | 100 | 60 |
| 29-02 | 300 | 6.5 | 100 | 1 | 7.5 | 7.5 | 100 | 100 |
| 29-03 | 300 | 6.5 | 200 | 2 | 8.5 | 9 | 100 | 125 |
| 29-04 | 300 | 6.5 | 300 | 3 | 9.5 | 10 | 100 | 116.67 |
| 29-05 | 300 | 6.5 | 400 | 3.5 | 10 | 10.3 | 87.5 | 95 |
| 29-06 | 300 | 6.5 | 600 | 3.8 | 10.3 | 10.5 | 63.33 | 66.66 |
| 29-07 | 300 | 6.5 | 800 | 4 | 10.5 | 10.8 | 50 | 53.75 |
| 29-08 | 300 | 6.5 | 1000 | 4.3 | 10.8 | 11 | 43 | 45 |

Data analysis: A comparison of theoretically calculated and experimentally determined SugarEs of GRU90-MRP-FTA per ppm in this example is shown in FIG. 20.

Conclusion: At 300 ppm RD content, increasing the amount of GRU90-MRP-FTA resulted in a measured contribution to sweetness that was higher than the calculated value as shown in FIG. 22. A positive sweet synergic effect was found when the concentration of GRU90-MRP-FTA equaled to, or was greater than, 100 ppm.

### Example 30. GRU90-MRP-FTA Improves the Solubility of RD

Process: GRU90-MRP-FTA (Ex. 19, 19-03) and RD (available from Sichuan Ingia Biosynthetic Co. Ltd, China, The content of RD was 94.39% and Lot # was 20190215) were weighed and uniformly mixed according to the weight shown in Table 30-1, dissolved in 100 ml pure water, and subjected to an solubility stability evaluation test.

TABLE 30-1
Test sample composition

| | The ratio | | Weight | Volume | | |
|---|---|---|---|---|---|---|
| | of RD to | Weight | of GRU90- | of pure | Stable | |
| | GRU90- | of RD | MRP-FTA | water | dissolution | |
| No. | MRP-FTA | (mg) | (mg) | (mL) | time | |
| 30-00 | 4/0 | 40 | 0 | 100 | 2 | h |
| 30-01 | 4/1 | 40 | 10 | 100 | 48 | h |
| 30-02 | 4/2 | 40 | 20 | 100 | >7 | days |
| 30-03 | 4/3 | 40 | 30 | 100 | >7 | days |
| 30-04 | 4/4 | 40 | 40 | 100 | >7 | days |
| 30-05 | 4/6 | 40 | 60 | 100 | 120 | h |
| 30-06 | 4/8 | 40 | 80 | 100 | 120 | h |

Data analysis: FIG. 21 shows a graphical depiction of stable dissolution times for various ratios of GRU90-MRP-FTA to RD as a function of time in this example.

Conclusion: The results showed that GRU90-MRP-FTA improved the solubility of RD at all tested ratios. The best results (>7 days) were obtained when the RD to GRU90-MRP-FTA ratio was in the range of 4:2 to 4:4. This example demonstrates that GRU90-MRP-FT significantly improves the solubility of RD. This technology can be used for improving solubility of any Stevia composition comprising RD.

### Example 31. GRU90-MRP-FTA Improves the Solubility of RM

Process: GRU90-MRP-FTA (Ex. 19, 19-03) and RM (available from Sichuan Ingia Biosynthetic Co. Ltd, China. The content of RM was 93.03% and Lot # is 20180915) were weighed and uniformly mixed according to the weight shown in Table 31-1, dissolved in 100 ml pure water, and subjected to an solubility stability evaluation test.

TABLE 31-1
Test sample composition

| | The ratio | | Weight | Volume | | |
|---|---|---|---|---|---|---|
| | of RM to | Weight | of GRU90- | of pure | Stable | |
| | GRU90- | of RM | MRP-FTA | water | dissolution | |
| No. | MRP-FTA | (mg) | (mg) | (mL) | time | |
| 31-00 | 5/0 | 50 | 0 | 100 | 1 | h |
| 31-01 | 5/1 | 50 | 10 | 100 | 36 | h |
| 31-02 | 5/2 | 50 | 20 | 100 | >7 | days |
| 31-03 | 5/3 | 50 | 30 | 100 | >7 | days |
| 31-04 | 5/5 | 50 | 50 | 100 | >7 | days |
| 31-05 | 5/7 | 50 | 70 | 100 | 144 | h |
| 31-06 | 5/10 | 50 | 100 | 100 | 144 | h |

Data analysis: FIG. 22 shows a graphical depiction of stable dissolution times for various ratios of GRU90-MRP-FTA to RM as a function of time in this example.

Conclusion: The result showed that GRU90-MRP-FTA improved the solubility of RM in all tested ratios. The best results (>7 days) were obtained when the RM to GRU90-MRP-FTA ratio was in the range of 5:2 to 5:5. This example demonstrates that GRU90-MRP-FTA significantly improves the solubility of RM. The current technology can be used for improving the solubility of any Stevia composition comprising RM, as well as the solubility of any Stevia extract comprising RM and one or more other stevia glycosides selected form Reb A, Reb B, Reb C, stevioside, Reb D, Reb E, Reb I, Reb N, and Reb O. The current technology can also be used to improve solubility of all steviol glycoside compositions, such as RA20SG95, RA50SG95, RA80SG95 and RA99.

### Example 32. GRU90-MRP-FTA Improves the Taste of GSG-MRP-CA

Process: GRU90-MRP-FTA (Ex. 19, 19-03) and GSG-MRP-CA (available from Sweet Green field, Lot #20200101 preparation procedure: 14 g GSG was dissolved together with 1.5 g alanine and 4.5 g xylose in 120 ml deionized water. The mixture was stirred and heated to about 95-100 degrees centigrade for about 2 hours. When the reaction was complete, the solution was spray dried to provide about 95 g of an off white powder) were weighed and uniformly mixed according to the weight shown in Table 32-1, dissolved in 100 ml pure water, and subjected to a mouth feel evaluation test.

TABLE 32-1
Test sample composition

| | The ratio of | | | |
|---|---|---|---|---|
| | GSG-MRP-CA | Weight of | Weight of | Volume |
| | to GRU90- | GSG-MRP- | GRU90-MRP- | of pure |
| No. | MRP-FTA | CA (mg) | FTA (mg) | water (mL) |
| 32-00 | 10/0 | 50 | 0 | 100 |
| 32-01 | 10/0.5 | 50 | 2.5 | 100 |
| 32-02 | 10/1 | 50 | 5 | 100 |
| 32-03 | 10/3 | 50 | 15 | 100 |
| 32-04 | 10/5 | 50 | 25 | 100 |
| 32-05 | 10/7 | 50 | 35 | 100 |
| 32-06 | 10/9 | 50 | 45 | 100 |
| 32-07 | 10/10 | 50 | 50 | 100 |
| 32-08 | 10/40 | 50 | 200 | 100 |
| 32-09 | 10/70 | 50 | 350 | 100 |
| 32-10 | 10/100 | 50 | 500 | 100 |

Experiments: Several mixtures of GRU90-MRP-FTA and GSG-MRP-CA were mixed in this example. Each sample was evaluated according to the sensory evaluation methods in Ex. 5. In addition, the SugarE for each mixture was determined based on the method in Ex. 5, the results of which shown in Table 32-2. It should be noted that according to the sensory evaluation methods in this example, the concentration of GSG-MRP-CA in the sample solution was the same, 500 ppm.

TABLE 32-2
Time-intensity and overall likability data of the samples in Ex. 32

| | | | LINGERING | LINGERING | |
|---|---|---|---|---|---|
| Product | ONSET | MAX | ON | OFF | Overall |
| No. | [sec] | [sec] | [sec] | [sec] | likability |
| 32-00 | 2 | 4 | 8 | 23 | 3.5 |
| 32-01 | 1.8 | 3.5 | 7.5 | 22 | 3.8 |
| 32-02 | 1.5 | 3.2 | 6 | 20 | 4 |
| 32-03 | 1 | 3 | 5 | 17 | 4.2 |
| 32-04 | 1 | 2.8 | 5 | 16 | 4.5 |
| 32-05 | 0.8 | 2 | 4.5 | 15 | 4.5 |
| 32-06 | 0 | 1.5 | 3.5 | 13 | 4.5 |
| 32-07 | 0 | 1.3 | 3.5 | 10 | 4.4 |
| 32-08 | 0 | 1.3 | 3.5 | 10 | 4 |
| 32-09 | 0 | 1.3 | 3.5 | 10 | 3.5 |
| 32-10 | 0 | 1.3 | 3.5 | 10 | 3.5 |

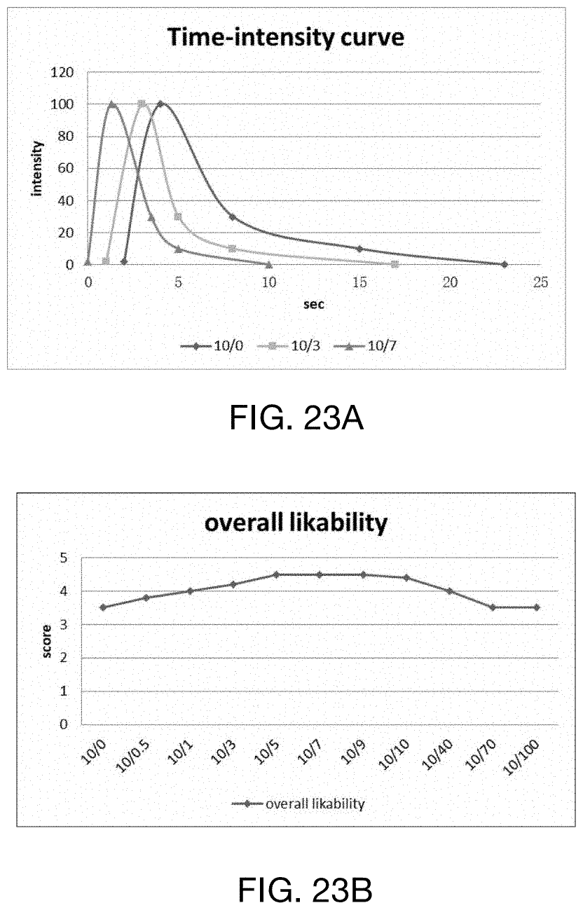

Data analysis: Time-intensity curves for three representative ratios of GSG-MRP-CA to GRU90-MRP-FTA in this example are shown in FIG. 23A. The relationship between the overall likability results to the ratio of GSG-MRP-CA to GRU90-MRP-FTA in this example is shown in FIG. 23B.

Conclusion: The result showed that GRU90-MRP-FTA could significantly quicken sweetness onset, cut sweet lingering and improve the overall likability of the GSG-MRP-CA. This effect was observed in all the tested GSG-MRP-CA-to-GRU90-MRP-FTA ratios (from 10:1 to 10:100). The effect can be extended to the GSG-MRP-CA-to-GRU90-MRP-FTA ratio range of 99:1 to 1:99. This example demonstrates that GRU90-MRP-FTA can significantly improve the taste profile of other GSG-MRP compounds.

### Example 33. GRU90-MRP-FTA and GSG-MRP-CA Improve the Taste Profile of Sucralose

Process: GRU90-MRP-FTA (Ex. 19, 19-03), GSG-MRP-CA (available from Sweet Green field, Lot #20200101) and sucralose (available from Anhui Jinhe Industrial Co., Ltd and Lot # was 201810013) were weighed and uniformly mixed according to the weight shown in Table 33-1, dissolved in 100 ml pure water, and subjected to a sensory evaluation test.

TABLE 33-1
Test sample composition

| | The ratio of | | Weight of | Weight of | Volume |
|---|---|---|---|---|---|
| | GSG-MRP- | Weight of | GSG-MRP- | GRU90- | of pure |
| | CA to GRU90- | sucralose | CA | MRP-FTA | water |
| No. | MRP-FTA | (mg) | (mg) | (mg) | (mL) |
| 33-00 | 200/0 | 15 | 20 | 0 | 100 |
| 33-01 | 190/10 | 15 | 19 | 1 | 100 |
| 33-02 | 180/20 | 15 | 18 | 2 | 100 |
| 33-03 | 150/50 | 15 | 15 | 5 | 100 |
| 33-04 | 130/70 | 15 | 13 | 7 | 100 |
| 33-05 | 100/100 | 15 | 10 | 10 | 100 |
| 33-06 | 70/130 | 15 | 7 | 13 | 100 |
| 33-07 | 50/150 | 15 | 5 | 15 | 100 |
| 33-08 | 10/190 | 15 | 1 | 19 | 100 |
| 33-09 | 0/200 | 15 | 0 | 20 | 100 |

Experiments: Several mixtures of GRU90-MRP-FTA, GSG-MRP-CA and sucralose were mixed in this example. Each sample was evaluated according to the sensory evaluation method in Ex. 5. Average scores from the test panel for each sensory criterion were recorded as the evaluation test results. The resulting taste profiles of the mixtures are shown in Table 33-2. It should be noted that according to the sensory evaluation method, in these evaluations, the concentration of sucralose in the sample solution was the same, 150 ppm. The total concentration of GSG-MRP-CA and GRU90-MRP-FTA was the same, 200 ppm.

TABLE 33-2
Sensory evaluation results

| | Sweet | Metallic | Mouth | Overall |
|---|---|---|---|---|
| No. | lingering | aftertaste | feel | likability |
| 33-00 | 3 | 3.5 | 3 | 3 |
| 33-01 | 2.5 | 2.5 | 3.5 | 3.2 |
| 33-02 | 2 | 2 | 3.5 | 3.5 |
| 33-03 | 1.5 | 1 | 4 | 4 |
| 33-04 | 1 | 1 | 4 | 4.5 |
| 33-05 | 1 | 1 | 4 | 4.2 |
| 33-06 | 1.5 | 1.5 | 3 | 4 |
| 33-07 | 2 | 2 | 3 | 3.8 |
| 33-08 | 3 | 2 | 3 | 3.5 |
| 33-09 | 3 | 2 | 3 | 3.5 |

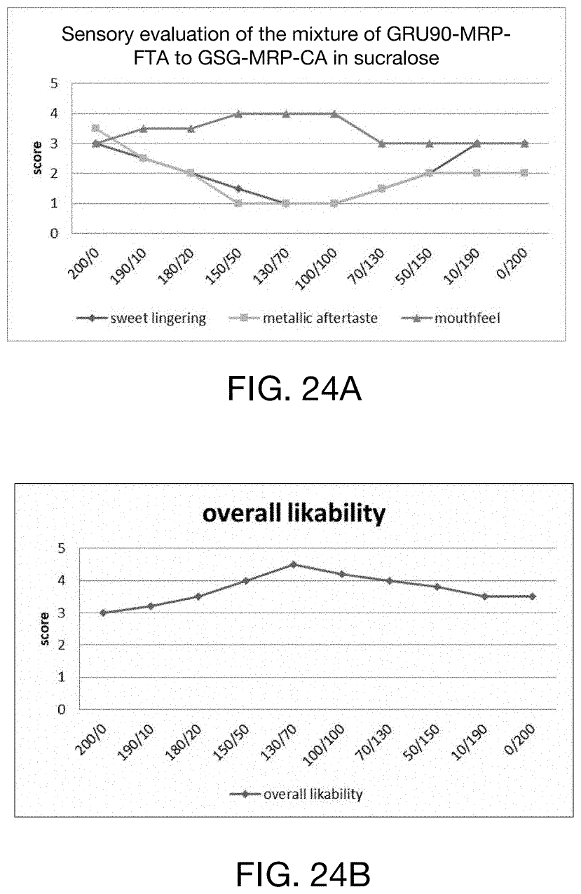

Data analysis: The relationship between the sensory evaluation results to the ratio of GSG-MRP-CA to GRU90-MRP-FTA in sucralose in this example is shown in FIG. 24A. The relationship between the overall likability results to the ratio of GSG-MRP-CA to GRU90-MRP-FTA in sucralose in this example is shown in FIG. 24B.

Conclusion: The result showed that the mixtures of GRU90-MRP-FTA and GSG-MRP-CA were more effective than GRU90-MRP-FTA alone or GSG-MRP-CA alone in reducing the metallic aftertaste and sweet lingering, and in improving the mouth feel of sucralose.

### Example 34. Preparation of GRU90-MRP-FTAs from GRU90, Fructose and Glutamic Acid

GRU90: the product of Ex. 7. GRU90, fructose, glutamic acid and water were weighed and dissolved in water according to Table 34-1. The solutions were then heated at about 100° C. for 1.5 hour. When the reactions were completed, the solutions were filtered through filter paper and the filtrates were dried with a spray dryer, thereby resulting in 34-01 and 34-02 products as an off white powder.

TABLE 34-1
Sample compositions.

| | Weight of | Weight of | Weight of | Weight of |
|---|---|---|---|---|
| Product No. | GRU90 (g) | fructose (g) | glutamic acid (g) | water (g) |
| 34-01 | 9 | 0.5 | 0.5 | 5 |
| 34-02 | 6 | 3.696 | 0.308 | 5 |

### Example 35. GRU90-MRP-FTAs (Products 34-01, 34-02 in Ex. 34) Improve the Taste Profiles of Commercial Carbonated Drinks

Reference: Coke STEVIA, 35% less sugar, available from CocaCola Singapore Beverages PTE. LTD., Lot #230519N10308. Ingredients: carbonated water, sucrose, caramel color, flavoring, phosphoric acid, preservative (sodium benzoate), caffeine and steviol glycoside (stevia leaf extract).

Test samples: Dissolve certain amount of GRU90-MRP-FTA (34-01 and 34-02 in Ex. 34) powder into carbonated drinks. The details are as follows.

TABLE 35-1
Test sample composition

| | Weight of | Volume of | |
|---|---|---|---|
| | GRU90-MRP- | Coke | |
| | FTA | STEVIA | Concentration |
| Sample | (mg) | (mL) | (ppm) |
| 35-01 | 5 (product 34-01) | 100 | 50 |
| 35-02 | 5 (product 34-02) | | 50 |

Experiment: Each sample was evaluated according to the sensory evaluation method in Ex. 5. Average scores from the test panel for each sensory criterion were recorded as the evaluation test results. The resulting taste profiles of the mixtures are shown in Table 35-2.

TABLE 35-2
Sensory evaluation results

| | Overall | | Mouth | Sweet | |
|---|---|---|---|---|---|
| Sample | likability | Flavor | feel | lingering | Bitterness |
| Coke STEVIA | 2 | 2 | 2 | 3 | 3 |
| 35-01 | 4 | 4 | 4 | 2 | 1.5 |
| 35-02 | 3.5 | 3.5 | 3.5 | 1.5 | 1 |

Conclusion: GRU90-MRP-FTA (34-01 and 34-02 in Ex. 34) significantly reduced the bitterness and sweet lingering in Coke STEVIA. In addition, GRU90-MRP-FTA (34-01 and 34-02 in Ex. 34) provided a significantly enhanced flavor and mouth feel. The results showed that GRU90-MRP-FTA improves the taste profile of Coke STEVIA. This effect can be extended to carbonated drinks of all flavors.

### Example 36. GRU90-MRP-FTAs Improve the Taste Profile of Commercial Sugar Free Tea Drinks

Reference: Sugar Free Oolong Tea Drink (Original), available from Beijing CENKI Forest Co., Ltd., Lot #20200120. Ingredients: Water, erythritol, Oolong Tea, polydextrose, Oolong Tea Powder, vitamin C, sodium bicarbonate.

Test sample: Dissolve certain amount of GRU90-MRP-FTA (34-01 and 34-02 in Ex. 34) powder into carbonated drinks. The details are as follows.

TABLE 36-1
Test sample composition

| | Weight of | Volume of | |
|---|---|---|---|
| | GRU90-MRP- | sugar free | Concentra- |
| Components | FTA(mg) | tea drink(mL) | tion (ppm) |
| 36-01 | 5 (34-01) | 100 | 50 |
| 36-02 | 5 (34-02) | | 50 |

Experiment: Each sample was evaluated according to the sensory evaluation method in Ex. 5. Average scores from the test panel for each sensory criterion were recorded as the evaluation test results. The resulting taste profiles of the mixtures are shown in Table 36-2.

TABLE 36-2
Sensory evaluation results

| | Overall | | Mouth | Bitterness | |
|---|---|---|---|---|---|
| Sample | likability | Flavor | feel | lingering | Bitterness |
| Reference | 3 | 3 | 3 | 4 | 3 |
| 36-01 | 4 | 4 | 3.5 | 2.5 | 2 |
| 36-02 | 4 | 3.5 | 4 | 2 | 1 |

Conclusion: GRU90-MRP-FTA (34-01 and 34-02 in Ex. 34) significantly reduced the bitterness lingering and bitterness in sugar free oolong tea drink. In addition, GRU90-MRP-FTA (34-01 and 34-02 in Ex. 34) provided an enhanced flavor and mouth feel. The results showed that GRU90-MRP-FTA improves the taste profile of sugar free oolong tea drink. This effect can be extended to sugar free tea drinks of all flavors.

### Example 37. GRU90-MRP-FTAs Improve the Taste Profile of Commercial Juice Drinks

Reference: Cranberry classic juice drink, available from OCEAN SPRAY International INC. Lot #:20200320. Ingredients: Water, reconstituted cranberry juice (27%), sugar, vegetable and fruit concentrate (carrot, cranberry), vitamin C.

Test samples: Dissolve certain amount of GRU90-MRP-FTA (34-01 and 34-02 in Ex. 34) powder into commercial juice drink. The details are as follows.

TABLE 37-1
Test sample composition

| | Weight of | Volume of | |
|---|---|---|---|
| | GRU90- | cranberry classic | |
| Test | MRP-FTA | juice drink | Concentration |
| Sample | (mg) | (ml) | (ppm) |
| 37-01 | 5 (34-01) | 100 | 50 |
| 37-02 | 5 (34-02) | | 50 |

Experiment: Each sample was evaluated according to the sensory evaluation method in Ex. 5. Average scores from the test panel for each sensory criterion were recorded as the evaluation test results. The resulting taste profiles of the mixtures are shown in Table 37-2.

TABLE 37-2
Sensory evaluation results

| | Overall | | Mouth | Bitterness | |
|---|---|---|---|---|---|
| Sample | likability | Flavor | feel | lingering | Bitterness |
| Reference | 3 | 4 | 3 | 2 | 3 |
| 37-01 | 4.5 | 4.5 | 3.5 | 1.5 | 2 |
| 37-02 | 4 | 3 | 4 | 1 | 1 |

Conclusion: GRU90-MRP-FTA (34-01 and 34-02 in Ex. 34) significantly reduced the bitterness lingering and bitterness in cranberry classic juice drink. In addition, GRU90-MRP-FTA (34-01 and 34-02 in Ex. 34) provided an enhanced mouth feel. The results showed that GRU90-MRP-FTA improves the taste profile of cranberry classic juice drink. This effect can be extended to juice drinks of all flavors.

### Example 38. GRU90-MRP-FTA Improves the Taste Profile of Commercial Dairy Products

Reference: Whole fat pure milk, available from Inner Mongolia Yili Industrial Group Co., Ltd. Lot #20200316. Ingredients: raw milk.

Test sample: Dissolve certain amount of GRU90-MRP-FTA (34-02 in Ex. 34) powder into commercial dairy products. The details are as follows.

TABLE 38-1
Test sample composition

| | Weight of | Volume of | |
|---|---|---|---|
| | GRU90- | dairy | |
| Test | MRP-FTA | product | Concentration |
| Sample | (mg) | (mL) | (ppm) |
| 38-01 | 5 (34-02) | 100 | 50 |

Experiment: Each sample was evaluated according to the sensory evaluation method in Ex. 5. Average scores from the test panel for each sensory criterion were recorded as the evaluation test results. The resulting taste profiles of the mixtures are shown in Table 38-2.

TABLE 38-2
Sensory evaluation results of GRU90-MRP-
FTA (34-02 in Ex. 34) in a dairy product.

| | Overall | | Mouth |
|---|---|---|---|
| Sample | likability | Flavor | feel |
| Reference | 3.5 | 3 | 3 |
| 38-01 | 4.5 | 4 | 5 |

Conclusion: GRU90-MRP-FTA (34-02 in Ex. 34) provided a pleasant milk and creamy flavor and enhanced mouth feel of milk. The results showed that GRU90-MRP-FTA improves the taste profile of dairy products. This effect can be extended to dairy products of all flavors.

### Example 39. Preparation of GSG-MRP-FTAs and GRU90-MRP-FTAs from GRU90, GSGs, Fructose, Glutamic Acid and Essential Oils/Essences

Raw Material:

GRU90: the product of Ex. 7.

GSGs (glycosylated stevia extract comprises unreacted stevia glycosides) were obtained from Sweet Green Fields Lot #: 3080191. The content of residual dextrins was similar to that in Ex. 7, except RU90 was replaced with Stevia extract. The content of total steviol glycosides is 85.7%, (including unreacted steviol glycosides and glycosylated steviol glycosides) among them RA is 9.11% and stevioside is 4.45%.

Essential oil/essence are available as follows:

TABLE 39-1
Essential oil/essence

| Type | Company | Lot# |
|---|---|---|
| Bergamot Oil Top Grade FCR | Chongqing Zhengyuan | Y0034432 |
| Lemon Juice Aroma Extract | flavor Co., Ltd | Y0034434 |
| Mandarin Juice Aroma Extract | | Y0034435 |
| Orange Brazil Type 5x | | Y0034429 |
| Bergamot Juice Aroma Extract | | Y0034433 |

Process: GRU90, GSGs, fructose, glutamic acid, essential oil/essence, water were weighed as follows. The solution was then heated at about 100° C. for 2.5 hour. When the reaction was completed, the solution was filtered through filter paper and the filtrate was dried with a spray dryer, thereby resulting in products 39-01 to 39-10 as an off white powder.

TABLE 39-2
Test sample composition

| | | Weight | | | | Weight of | | Weight of |
|---|---|---|---|---|---|---|---|---|
| Product | Product | of GSGs | Weight of | Weight of | Weight of | glutamic | Weight of | essential |
| name | No. | (g) | GRU90(g) | glucose(g) | fructose(g) | acid(g) | water(mL) | oil/essence(mL) |
| GSG-MRP- | 39-01 | 45 | — | 3.75 | — | 1.25 | 25 | Bergamot Juice |
| FTA | | | | | | | | Aroma Extract/5 mL |
| | 39-02 | | | — | 3.75 | | | Mandarin Juice |
| | | | | | | | | Aroma Extract/1.2 mL |
| | 39-03 | | | | | | | Orange Brazil |
| | | | | | | | | Type 5x/1.6 mL |
| | 39-04 | | | | | | | Bergamot Oil |
| | | | | | | | | Top Grade FCR/0.8 mL |
| | 39-05 | | | | | | | Lemon Juice |
| | | | | | | | | Aroma Extract/1.2 mL |
| GRU90-MRP- | 39-06 | — | 45g | 3.75g | — | | | Bergamot Juice |
| FTA | | | | | | | | Aroma Extract/5 mL |
| | 39-07 | | | — | 3.75 | | | Mandarin Juice |
| | | | | | | | | Aroma Extract/1.2 ML |
| | 39-08 | | | | | | | Orange Brazil |
| | | | | | | | | Type 5x/1.6 mL |
| | 39-09 | | | | | | | Bergamot Oil |
| | | | | | | | | Top Grade FCR/0.8 mL |
| | 39-10 | | | | | | | Lemon Juice |
| | | | | | | | | Aroma Extract/1.2 mL |

Conclusion: All products obtained from above process were clear solutions. It demonstrates that sweet tea extract, its glycosylated product or MRPs, stevia extract, its glycosylated product or MRPs can act as excellent carrier to flavor ingredient. The final product can be in powder or liquid form. This technology can be used to produce water-soluble essential oil, and products in powder form. The flavor intensity of the products produced by this technology was significantly intensified. There was synergy between the flavor ingredient and carrier. This technology can be used for any type of oils or soluble ingredients. The resulting products, such as soluble flavor ingredients, can enhance the retronasal flavor when added into food and beverage.

### Example 40. GRU90-MRP-FTA Improves Taste Profile of a Commercial Lemon and Lime-Flavored Soft Drink

Reference (sugar version): Sprite, available from CocaCola Beijing Co., Ltd., Lot #20191121. Ingredients: Water, high fructose syrup, sugar, food additives (carbon dioxide, citric acid, sodium citrate, sodium benzoate, sucralose, acesulfame), food flavor.

Base (sugar reduced version): Sprite Zero, available from CocaCola Beijing Co., Ltd., Lot #: 20190918. Ingredients: Water, food additives (carbon dioxide, citric acid, potassium citrate, sodium benzoate, aspartame, acesulfame, sucralose) food flavor.

Test sample: GRU90-MRP-FTA (39-10 in Ex. 39) powder was dissolved in base (Sprite Zero) as shown in Table 40-1 and compared to reference (Sprite) in the sensory evaluations below.

TABLE 40-1
Sample compositions.

| | Weight of | | | |
|---|---|---|---|---|
| | GRU90- | Volume of | Volume of | |
| | MRP-FTA | reference | base | Concentration |
| Sample | (mg) | (ml) | (ml) | (ppm) |
| Base | — | | 100 | |
| (Sprite | | | | |
| Zero) | | | | |
| Reference | | 100 | | |
| (Sprite) | | | | |
| 40-01 | 13.2 (39-10) | | 100 | 132 |

Experiment: Each sample was evaluated according to the aforementioned sensory evaluation method in Ex. 5, and the average score of the panel was taken as the evaluation result data. The resulting taste profiles of the mixtures are shown in Table 40-2.

TABLE 40-2
Sensory evaluation results.

| | Overall | | Mouth | Metallic | Sweet |
|---|---|---|---|---|---|
| Sample | likability | Flavor | feel | aftertaste | lingering |
| Reference | 4.0 | 4.0 | 2.0 | 0 | 1.5 |
| Base | 2.5 | 2.0 | 0 | 0.5 | 4.0 |
| 40-01 | 4.5 | 4.5 | 1.0 | 0 | 1.5 |

Conclusion: GRU90-MRP-FTA (39-10 in Ex. 39) significantly reduced sweet lingering in Sprite Zero. In addition, GRU90-MRP-FTA provided an enhanced fruit flavor compared to the reference (sugar version), resulting in a better overall likability. The results showed that the taste profile of Sprite Zero can be improved by GRU90-MRP-FTA to an extent that is comparable to, or even better than, the sugar version. This effect can be extended to all lemon and lime-flavored soft drinks.

### Example 41. GRU90-MRP-FTA Improves Commercial Fruit Juice-Flavored Carbonated Drink

Reference (sugar version): Fanta Orange, available from CocaCola Beijing Co., Ltd, Lot #:20200114. Ingredients: Water, high fructose syrup, sugar, food additives (carbon dioxide, citric acid, sodium benzoate, sucralose, acesulfame, food yellow) food flavor.

Base (sugar reduced version): Fanta Zero, available from CocaCola Beijing Co., Ltd., Lot #:20190827. Ingredients: Water, food additives (carbon dioxide, citric acid, potassium citrate, sodium benzoate, aspartame, acesulfame, sucralose) food flavor.

Test sample: GRU90-MRP-FTA powder (39-10 in Ex. 39) was dissolved in Fanta Zero according to Table 41-1 below and compared to Fanta Orange alone.

TABLE 41-1
Sample composition

| | Weight of | | | |
|---|---|---|---|---|
| | GRU90- | Volume of | Volume of | |
| | MRP-FTA | reference | base | Concentration |
| Sample | (mg) | (ml) | (ml) | (ppm) |
| Base | — | | 100 | |
| (Fanta | | | | |
| Zero) | | | | |
| Reference | | 100 | | |
| (Fanta | | | | |
| Orange) | | | | |
| 41-01 | 13.2 (39-10) | | 100 | 132 |

Experiment: Each sample was evaluated according to the sensory evaluation method in Ex. 5. Average scores from the test panel for each sensory criterion were recorded as the evaluation test results. The resulting taste profiles of the mixtures are shown in Table 41-2.

TABLE 41-2
Sensory evaluation results

| | Overall | | Mouth | Metallic | Sweet |
|---|---|---|---|---|---|
| Sample | likability | Flavor | feel | aftertaste | lingering |
| Reference | 4.0 | 4.0 | 1.5 | 1.0 | 1.5 |
| Base | 3.0 | 3.0 | 1.0 | 1.5 | 3.5 |
| 41-01 | 4.5 | 4.5 | 1.0 | 1.0 | 1.0 |

Conclusion: Comparing to regular Fanta orange, GRU90-MRP-FTA (39-10 in Ex. 39) significantly reduced the sweet lingering and metallic aftertaste in Fanta Zero. It also provided an enhanced fruit flavor to Fanta Zero, resulting in an overall likability better than regular Fanta Orange. The results showed that RU90-MRP-FTA improved the taste profile of sugar free Fanta and provided an overall likability that was even better than the sugar version of the drink. This effect can be extended to all fruit juice-flavored carbonated drinks.

### Example 42. GSG-MRP-FTA Improves the Taste Profile of a Commercial Fruit Juice-Flavored Carbonated Drink

Reference (sugar version): Fanta Orange, available from CocaCola Beijing Co., Ltd, Lot #: 20200114. Ingredients: Water, high fructose syrup, sugar, food additives (carbon dioxide, citric acid, sodium benzoate, sucralose, acesulfame, food yellow) food flavor.

Base (sugar reduced version): Fanta Zero, available from CocaCola Beijing Co., Ltd, Lot #: 20190827. Ingredients: Water, food additives (carbon dioxide, citric acid, potassium citrate, sodium benzoate, aspartame, acesulfame, sucralose) food flavor.

Test sample: Dissolve certain amount of GSG-MRP-FTA (39-05 in Ex. 39) powder into Fanta Zero and compare it to Fanta Orange. The details are as followed.

TABLE 42-1
Sample composition

| | Weight of | | | |
|---|---|---|---|---|
| | GSG- | Volume of | Volume of | |
| | MRP-FTA | Reference | Base | Concentration |
| Sample | (mg) | (ml) | (ml) | (ppm) |
| Base | — | | 100 | |
| (Fanta | | | | |
| Zero) | | | | |
| Reference | | 100 | | |
| (Fanta | | | | |
| Orange) | | | | |
| 42-01 | 13.2 (39-05) | | 100 | 132 |

Experiment: Each sample was evaluated according to the sensory evaluation method in Ex. 5. Average scores from the test panel for each sensory criterion were recorded as the evaluation test results. The resulting taste profiles of the mixtures are shown in Table.

TABLE 42-2
Sensory evaluation results

| | Overall | | Mouth | Metallic | Sweet |
|---|---|---|---|---|---|
| Sample | likability | Flavor | feel | aftertaste | lingering |
| Reference | 4.0 | 4.0 | 1.5 | 1.0 | 1.5 |
| Base | 3.0 | 3.0 | 1.0 | 1.5 | 3.5 |
| 42-01 | 4.5 | 4.5 | 1.0 | 1.0 | 1.0 |

Conclusion: Compared to regular Fanta Orange, GSG-MRP-FTA (39-05 in Ex. 39) significantly reduced the sweet lingering and metallic aftertaste in Fanta Orange zero added sugar. It also provided an enhanced fruit flavor to Fanta Zero, resulting in an overall likability better than regular Fanta Orange. The results showed that GSG-MRP-FTA improved the taste profile of sugar free Fanta and provided an overall likability that was even better than the sugar version of the drink. This effect can be extended to all fruit juice-flavored carbonated drinks.

### Example 43. GRU90-MRP-FTA Improves the Taste Profile of a Commercial Lemon Tea

Base: Low sugar lemon tea, available from Vita (Guangming) Lemon Tea Food and Beverage Co., Ltd., Lot #: 20200306. Ingredients: Water, sugar, black tea, Black tea powder, concentrated lemon juice, food additives (acidity regulator, antioxidant, and sweeteners), and flavor.

Reference: Sugar was dissolved in base as shown in Table 43-1.

Test samples: GRU90-MRP-FTA (39-10 in Ex. 39) powder was dissolved in base as shown in Table 43-1.

TABLE 43-1
Sample composition

| | Weight of | | Volume of | |
|---|---|---|---|---|
| | GRU90- | Weight of | sugar free | |
| | MRP-FTA | sugar | soda water | Concentration |
| Sample | (mg) | (g) | (ml) | (ppm) |
| Base | — | | 100 | |
| Reference | | 5 | 100 | |
| 43-01 | 13.2 (39-10) | | 100 | 132 |

Experiment: Each sample was evaluated according to the sensory evaluation method in Ex. 5. Average scores from the test panel for each sensory criterion were recorded as the evaluation test results. The resulting taste profiles of the mixtures are shown in Table 43-2.

TABLE 43-2
Sensory evaluation results

| | Overall | | Mouth | Metallic | Sweet |
|---|---|---|---|---|---|
| Sample | likability | Flavor | feel | aftertaste | lingering |
| Reference | 2.5 | 3.0 | 1.5 | 1.0 | 4.0 |
| 43-01 | 4.5 | 4.5 | 1.5 | 0 | 2.0 |

Conclusion: GRU90-MRP-FTA (39-10 in Ex. 39) significantly reduces the sweet lingering and metallic aftertaste in low sugar lemon tea. GRU90-MRP-FTA provided a pleasant fruit and tea flavor, resulting in better overall likability than regular lemon tea. The results showed that GRU90-MRP-FTA improved the taste profile of low sugar lemon tea and provided an overall likability that was even better than regular lemon tea. These effects can be extended to all lemon contained or tea contained beverages.

### Example 44. Conversion of Rubusoside from Steviol Glycosides

Materials: Steviol glycosides: RA20/TSG(9)95, Lot No. EPC-309-1-0; Reb A 28.98%, Stevioside 60.36%, available from Sweet Green Fields.

β-galactosidase: Lactase DS 100, Lot No. LAMR0351901K, 111000 ALU/g, available from AmanoEnzyme Inc.

Process: 100 mL steviol glycosides solution (80 g/L) and β-galactosidase (0.8 kU/g stevioside) were mixed in a 250 mL flask, stirred at 60° C. for 8 h. The reaction mixture was then boiled for 3 min to deactivate the enzyme and the precipitated enzyme was removed by centrifugation. The supernatant was spray-dried to produce 7.5 g white powder, which contained 27.4% Reb A, 42.8% rubusoside and almost no stevioside.

Conclusion: Stevioside can be converted to rubusoside by the effect of β-galactosidase. Under certain conditions, the conversion ratio is close to 100%. The converted product (in solution or powder form) can be used as raw material for glycosylation and/or Maillard reaction, or it can be further purified into 95% total stevia glycosides. The rubusoside can be enriched by crystallization etc. to any desired purity. For instance, rubusosides can be prepared from a Stevia extract to a purity of more than 40%, 90% or 95%. Any type of these compositions can be used as sweeteners or flavor ingredients in food and beverage products. Any type of these composition can be further subjected to a glycosylation reaction to product a glycosylated product, and/or a Maillard reaction to product a Maillard reaction product.

Some embodiments of the present application relate to a Stevia extract comprising rubusoside and Reb A, wherein the Reb A content is less than 50%, 40%, 30%, 20%, 10%, 5% by weight of the Stevia extract. A further embodiment of the Stevia extract comprises rubusoside and Reb A, wherein the total amount of rubusoside and Reb A is above 50% by weight of the Stevia extract, where ratio of rubusoside to Reb A is greater than 1:2 or 1:1.

Some embodiments of the present application relate to a Stevia extract comprising rubusoside, Reb A, and one or more other stevia glycosides selected from the group consisting of stevioside, Reb B, Reb C, Reb D, Reb E, Reb I, Reb M, Reb N and Reb O, wherein the total amount of the one or more other stevia glycosides is less than 50%, 40%, 30%, 20%, 10%, 5%, 2%, 1%, 0.5% by weight of the Stevia extract. In some embodiments, the Stevia extract comprises stevioside in an amount that is less than 50%, 40%, 30%, 20%, 10%, 5%, 2%, 1%, 0.5% by weight of the Stevia extract.

Some embodiments of the present application relate to a glycosylated Stevia extract composition that comprises glycosylated Reb A and glycosylated rubusoside, unreacted Reb A and unreacted rubusoside. In some embodiments, the total content of glycosylated rubusoside and glycosylated Reb A is above 1%, 5%, 10%, 40%, 50%, 60%, 70%, 80%, 85%, 90%, or 95% by weight of the composition.

Some embodiments of the present application relate to a composition that comprises (1) glycosylated rubusoside originated from a Stevia extract, and/or (2) glycosylated rubusoside enzymatic converted from stevioside. In some embodiments, the glycosylated rubusoside is present in an amount of greater than 1%, 5%, 10%, 20%, 30%, 40%, 50%, 60%, 80%, 90% or 95% by weight of the composition. In some embodiments, the composition further comprises unreacted rubusoside and sugar donors, such as starch or dextrins. In some embodiments, the dextrins is present in an amount of less than 30%, 20%, 15%, 10%, or 5% by weight of the composition.

### Example 45. Sensory Evaluation of Steviol Glycoside Samples

Materials: RU20, Lot #STL02-151005, EPC Lab; GRU20, Lot #EPC-303-89-03, EPC Lab; GRU20-MRP-CA, Lot #EPC-303-56-01, EPC Lab; GRU20-MRP-TA, Lot #EPC-303-56-02, EPC Lab; TRU20, Lot #EPC-303-74-01, EPC Lab; GTRU20, Lot #EPC-303-73-01, EPC Lab; GTRU20-MRP-CA, Lot #EPC-303-59-01, EPC Lab; GTRU20-MRP-HO, Lot #EPC-303-59-02, EPC Lab; RU90, Lot #EPC-238-34-03, EPC Lab; GRU90, Lot #EPC-303-89-02, EPC Lab; GRU90-MRP-CA, Lot #EPC-303-91-01, EPC Lab; GRU90-MRP-HO, Lot #EPC-303-91-01, EPC Lab; GRU90-MRP-TA, Lot #EPC-303-91-03, EPC Lab; GSG-MRP-CA, Part Number SCA03601, Lot #20190701; GSG-MRP-HO, Part Number SHN03801, Lot #20190704; GSG-MRP-TA, Lot #240-51-01.

Sample preparation: To perform the test, a 100 ppm water solution of the each sample was prepared and sensory evaluated. The test results are summarized in Table 45-1.

TABLE 45-1
Sensory evaluation results

| Sample | Color/Odor | Sweetness | Sensory evaluation |
|---|---|---|---|
| RU20 | Colorless, neutral | 1-2 | Herbal, slight lingering |
| | | | aftertaste |
| GRU20 | Colorless, neutral | 1-2 | Neutral taste, herbal notes |
| GRU20- | Slight yellow, | 1 | Neutral taste, herbal notes, |
| MRP-CA | neutral | | weak caramel aftertaste |
| GRU20- | Colorless, slightly | 1-2 | Neutral, slight fruity |
| MRP-TA | fruity | | aftertaste |
| TRU20 | Colorless, neutral | 1-2 | Cleaner taste, slight honey/ |
| | | | flowery notes |
| GTRU20 | Colorless, neutral | 1-2 | Neutral taste, a little bit |
| | | | cleaner taste |
| GTRU20- | Slight yellow, | 1 | Neutral, without caramel |
| MRP-CA | neutral | | notes |
| GTRU20- | Colorless, slightly | 1-2 | Neutral, slight flowery |
| MRP-HO | flowery | | aftertaste, no lingering |
| RU90 | Colorless, neutral | 3 | Sweetish, clean, slightly |
| | | | sweet lingering aftertaste |
| GRU90 | Colorless, neutral | 3.5 | Sweetish, clean |
| GRU90- | Slight yellow, | 2.5 | Sweetish, slight caramel |
| MRP-CA | neutral | | notes |
| GRU90- | Colorless, neutral | 3 | Sweetish, flowery |
| MRP-HO | | | aftertaste |
| GRU90- | Colorless, neutral | 3 | Sweetish, not fruity |
| MRP-TA | | | |
| GSG- | Yellow, neutral | 3 | Sweetish, pleasant caramel |
| MRP-CA | | | aftertaste |
| GSG- | Colorless, slightly | 3 | Sweetish, more intensive |
| MRP-HO | flowery | | flowery aftertaste |
| GSG- | Colorless, fruity | 4 | Sweet, fruity, sweet |
| MRP-TA | | | lingering aftertaste |

Conclusion: Compared to rubusoside and/or sweet tea extract, STE, STC, GSTE, GSTC and ST-MRPs showed significantly improved palatability. The unique characters of these products, such as colorless, neutral aroma and less lingering, provide advantage in their use in food and beverage applications.

### Example 46. Sweetness Profile of Thaumatin with/without Ru Samples

Materials: GRU20, Lot #EPC-303-89-03, EPC Lab; GRU90, Lot #EPC-303-89-02, EPC Lab; RU20, Lot #STL02-151005, EPC Lab; TRU20, Lot #EPC-303-74-01, EPC Lab; RU90, Lot #EPC-238-34-03, EPC Lab; Thaumatin 93%, Part Number T93001, Lot #20190601

### Experimental Design and Results

The following samples were prepared and evaluated:
15 ppm thaumatin
15 ppm thaumatin+50 ppm RU20
15 ppm thaumatin+50 ppm RU90
15 ppm thaumatin+50 ppm GRU20
15 ppm thaumatin+50 ppm GRU90
15 ppm thaumatin+50 ppm TRU20

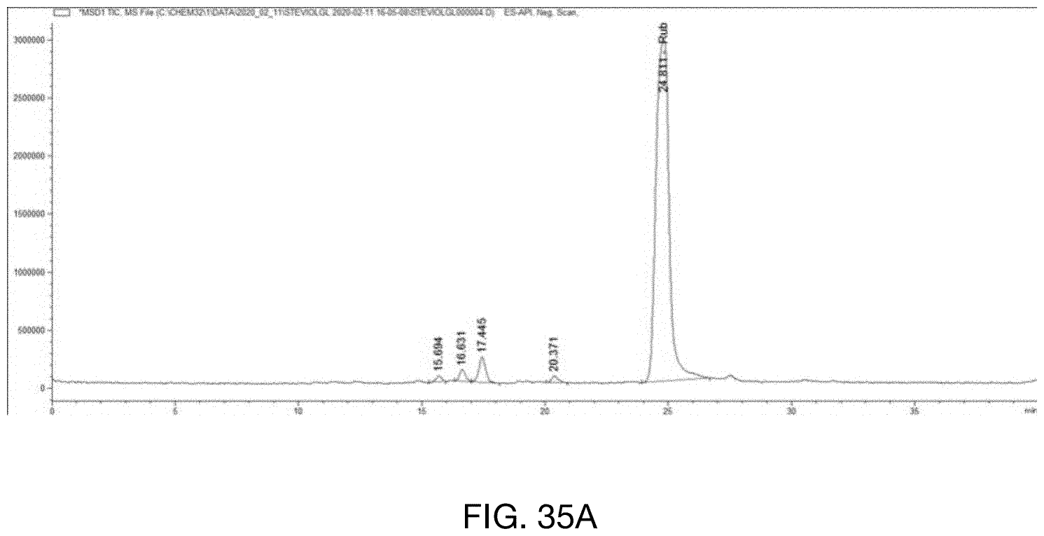

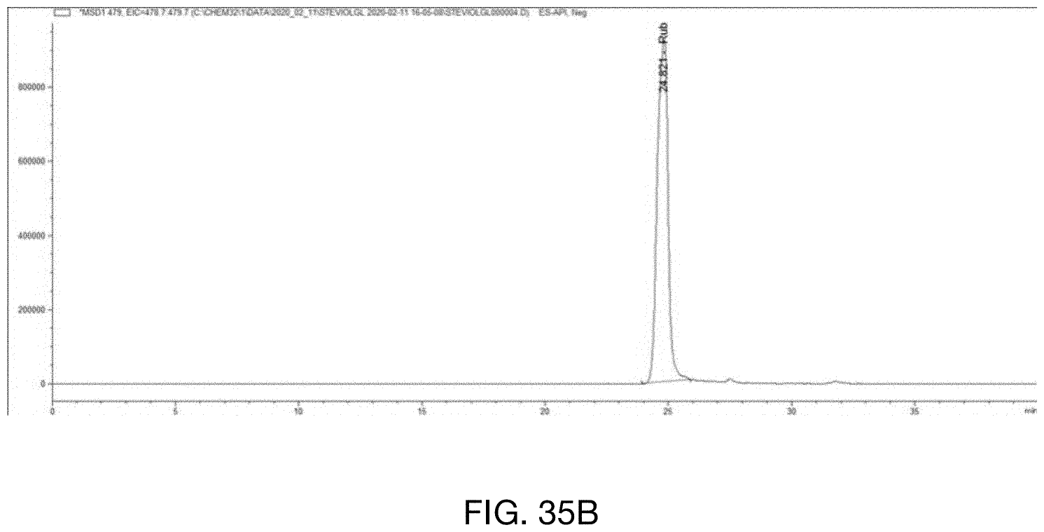

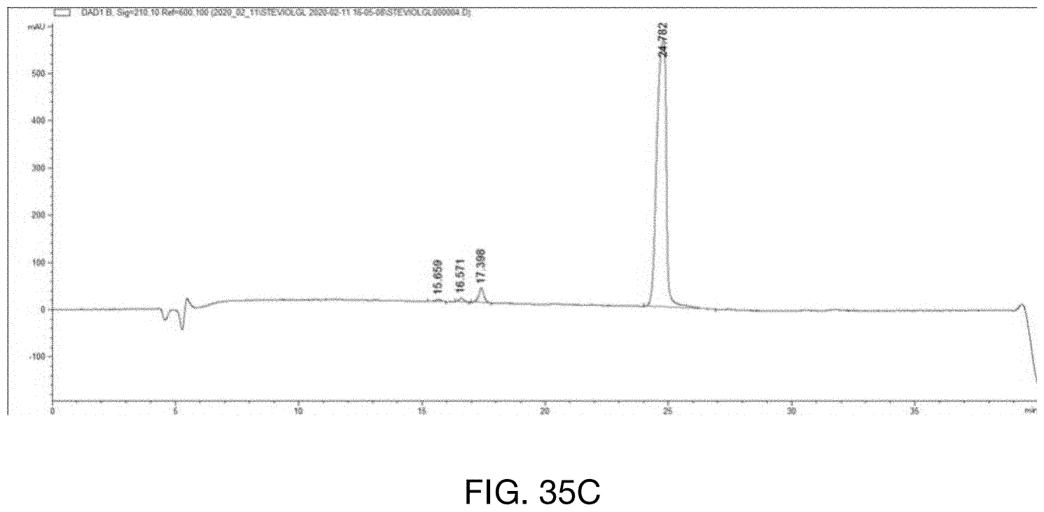

The sensory test results are shown in Table 46-1 and FIGS. 35A-35F

TABLE 46-1
Sensory test results

| | | | LINGERING | LINGERING | NO |
|---|---|---|---|---|---|
| | ONSET | MAX | ON | OFF | TASTE |
| SAMPLE | [sec] | [sec] | [sec] | [sec] | [sec] |
| 15 ppm Thaumatin | 1 | 7 | 14 | 28 | 45 |
| 15 ppm Thaumatin + | 1 | 4 | 8 | 25 | 38 |
| 50 ppm RU20 | | | | | |
| 15 ppm Thaumatin + | 1 | 3 | 8 | 18 | 25 |
| 50 ppm RU90 | | | | | |
| 15 ppm Thaumatin + | 1 | 5 | 9 | 19 | 25 |
| 50 ppm GRU20 | | | | | |
| 15 ppm Thaumatin + | 1 | 4 | 6 | 17 | 26 |
| 50 ppm GRU90 | | | | | |
| 15 ppm Thaumatin + | 1 | 5 | 8 | 23 | 31 |
| 50 ppm TRU20 | | | | | |

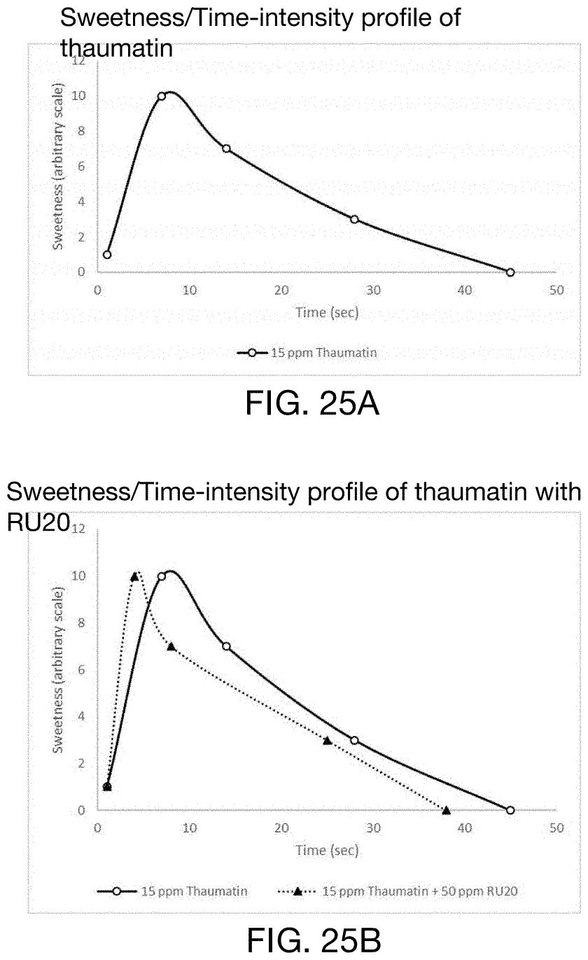

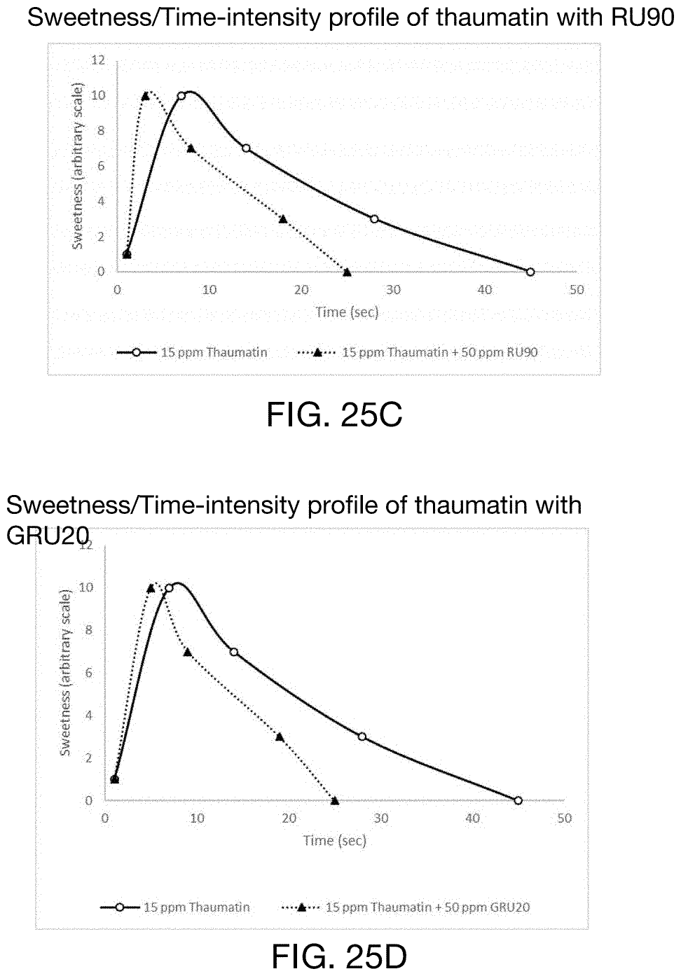

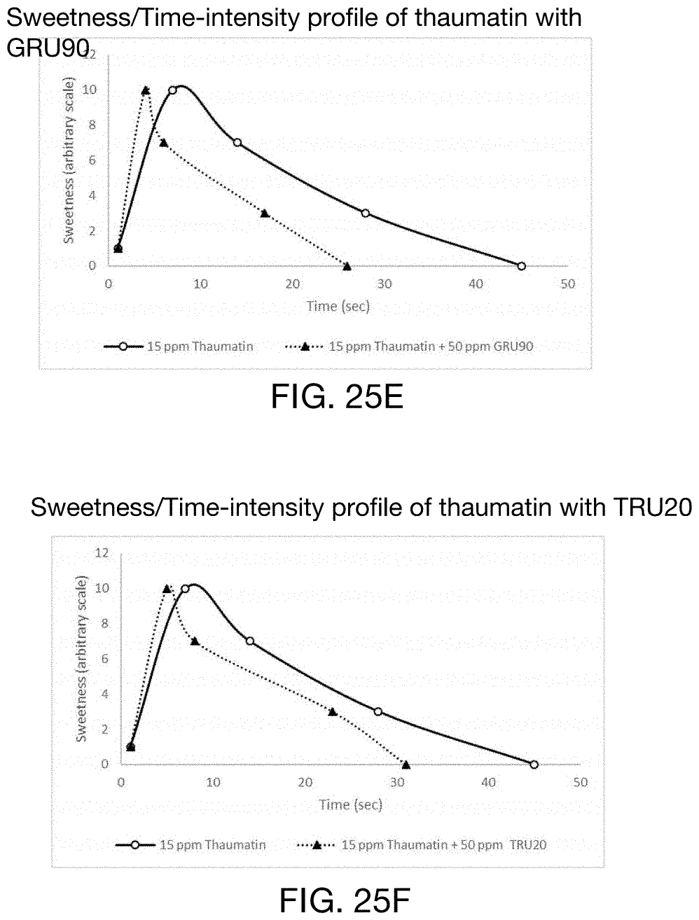

FIG. 25A shows a sweetness/time-intensity profile of thaumatin. FIG. 25B shows a sweetness/time-intensity profile of thaumatin with RU20. FIG. 25C shows a sweetness/time-intensity profile of thaumatin with RU90. FIG. 25D shows a sweetness/time-intensity profile of thaumatin with GRU20. FIG. 25E shows a sweetness/time-intensity profile of thaumatin with GRU90. FIG. 25F shows a sweetness/time-intensity profile of thaumatin with TRU20.

Conclusion: As shown in FIG. 25B, RU20 reduced lingering by 7 seconds. RU90, GRU20 and GRU90 were able to reduce lingering by 20 and 19 seconds respectively (FIGS. 25C-25E). Effect of TRU20 was presented by reduce lingering by 11 seconds.

### Example 47. Analytical Investigations with Sweet Tea Leaf Extracts

Sample Description:

Instruction:
1. Product Name: RU 20 (Guilin Layin Natural Ingredients Corp.), Lot #: STL02-151005 Process: This sample is sweet tea extract Rubusoside 20%
2. Product Name: GRU20, Lot #: EPC-303-89-03 Process: This sample is enzymatic transglucosylated sweet tea extract Rubusoside 20%
3. Product Name: TRU20, Lot #: EPC-303-74-01 Process: This sample is treated sweet tea extract Rubusoside 20%
4. Product Name: GTRU20, Lot #: EPC-303-73-01 Process: This sample is enzymatic transglucosylation treated sweet tea extract rubusoside 20%
5. Product Name: RU90, Lot #: EPC-238-34-03 Process: This sample is sweet tea extract Rubusoside 92%
6. Product Name: GRU90, Lot #: EPC-303-89-02 Process: This sample is enzymatic transglucosylated sweet tea extract Rubusoside 92%
7. Product Name: GRU20-MRP-TA, Lot #: EPC-303-56-02

Process: This sample is Maillard reaction product of enzymatic transglucosylated sweet tea extract Rubusoside 20%, which flavor is sugar like.
8. Product Name: GRU20-MRP-CA, Lot #: EPC-303-56-01

Process: This sample is Maillard reaction product of enzymatic transglucosylated sweet tea extract Rubusoside 20%, which flavor is caramel like.
9. Product Name: GUG-Ru 20%-Treated-Caramel, Lot #: EPC-303-59-01

Process: This sample is Maillard reaction product of enzymatic transglucosylated treated sweet tea extract Rubusoside 20%, which flavor is caramel like.
10. Product Name: GRU20-MRP-HO, Lot #: EPC-303-59-02

Process: This sample is Maillard reaction product of enzymatic transglucosylated treated sweet tea extract Rubusoside 20%, which flavor is honey like.
11. Product Name: GRU90-MRP-CA, Lot #: EPC-303-91-01

Process: This sample is Maillard reaction product of enzymatic transglucosylated treated sweet tea extract Rubusoside 92%, which flavor is caramel like.
12. Product Name: GRU90-MRP-HO, Lot #: EPC-303-91-02

Process: This sample is Maillard reaction product of enzymatic transglucosylated treated sweet tea extract Rubusoside 92%, which flavor is honey like.
7. Product Name: GRU90-MRP-TA, Lot #: EPC-303-91-03

Process: This sample is Maillard reaction product of enzymatic transglucosylated sweet tea extract Rubusoside 92%, which flavor is sugar like.

Methods and Materials

Reference standards (to qualify the analytical method) for steviol glycosides (Reb A, Reb B, Reb C, Reb D, Reb E, Reb F, Reb G, Reb I, Reb M, Reb N, Reb O, Stevioside, Isoreb A, Isostevioside) were obtained from Chromadex (LGC Germany). Solvents and reagents (HPLC grade) were obtained from VWR (Vienna) or Sigma-Aldrich (Vienna). Davisil Grade 633 (high-purity grade silica gel, pore size 60 A, 200-425 mesh particle size was obtained from Sigma-Aldrich (Vienna).

Sample Preparation (HPLC/DAD/MS):

All samples were fractionated over a glass column (100×5 mm) filled with Davisil Grade 633. The column was equilibrated with ethyl acetate/acetic acid/H₂O=8/3/2 (v/v/v). 100 mg sample, dissolved in 2 ml H₂O, were loaded on the column and eluted with ethyl acetate/acetic acid/H₂O=8/3/2 at a flow rate of 2 ml/min. The first 6 ml of the eluate were discarded and the next 30 ml containing unreacted steviol-glycosides were collected. Enzymatically reacted steviol-glycosides eluted in the range of 36-70 ml and were again collected.

After fractionation of 3 samples, the pooled eluates were evaporated to dryness and reconstituted in 20 ml Acetonitrile/H₂O=9/1 (v/v) corresponding to an equivalent sample concentration of 150 mg sample/10 ml.

The method was qualified by fractionation of steviol glycoside standards and enzymatically reacted steviol-glycosides. An elution yield of >97% of steviol-glycosides and of >95% enzymatically reacted steviol-glycosides was observed, the carry over between the fraction was calculated to less than 3%.

The pooled, evaporated samples were used for analysis of steviol-related compounds as well as for non-volatile non-steviol-related compounds.

HPLC-Method:

The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis 150 mg of the corresponding sample was dissolved in Acetonitrile (1 ml) and filled up to 10 ml with H₂O.

The samples were separated at 0.8 ml/min on a Phenomenex Synergi Hydro-RP (150×3 mm) followed by a Macherey-Nagel Nucleosil 100-7 C18 (250×4.6 mm) at 45° C. by gradient elution. Mobile Phase A consisted of a 0.01 molar NH₄-Acetate buffer (native pH) with 0.1% acetic acid, 0.05% trimethylamine and 0.001% dichloromethane. Mobile Phase B consisted of 0.01 molar NH₄-Acetate buffer (native pH) and Acetonitrile (1/9 v/v) with 0.1% acetic acid, 0.05% trimethylamine and 0.001% dichloromethane. The gradient started with 22% B, was increased linearly in 20 minutes to 45% B and kept at this condition for another 15 minutes. Injection volume was set to 10 μl.

The detectors were set to 210 nm (VWD), to 205 and 254 nm (DAD with spectra collection between 200-600 nm) and to ESI negative mode TIC m/z 300-1500, Fragmentor 200, Gain 2 (MS, 300° C., nitrogen 12 l/min, nebulizer setting 50 psig. Capillary voltage 4500 V).

Detection at 205 and 210 nm were used to quantify the chromatograms, the MS-spectra were used to determine the molar mass and structural information of individual peaks. Detection at 254 nm was used to identify non-steviol glycoside peaks.

Samples were quantified by external standardization against reference compounds of Reb A or stevioside, in case where no authentic reference standard was available, the peak area was quantified against the reference standard with the most similar mass and corrected for the molar mass differences. The calibration range of reference standards was in a range 1-75 mg/10 ml (dissolved in Acetonitrile/H₂O=9/1 (v/v)).

Identification and Quantification

Steviol-glycosides and enzymatically reacted steviol-glycosides were identified by comparison of retention times to authentic reference standards and/or by evaluation of the mass spectra obtained (including interpretation of the fragmentation pattern and double charged ions triggered by the presence of dichloromethane).

Steviol-glycosides were quantified against external standards. In case that no reference standard was available quantification was performed against the reference standard with the most similar molar mass.

Sample Preparation (GC/MS):

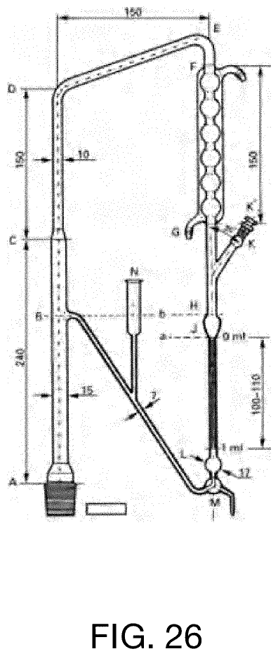

1 g of the sample was dissolved in 100 ml water and transferred in a round flask used for water steam distillation. The sample was submitted to a combined water steam distillation and solvent extraction/concentration process as shown in FIG. 26. One ml of the organic solvent used was ethyl acetate placed between the bubbles HJ and L in FIG. 26.

The steam distillation was performed for 120 minutes. The ethyl acetate was collected and injected onto the GC/MS system.

| Mobile Phase: | He | |
|---|---|---|
| Column: Agilent DB-5 | 60.0 m × 0.25 mm I.D., 0.25 μm | |
| Oven Program | 90° C. (3 min), 10° C./min to | |
| | 300° C. (hold 5 min) | |
| Constant Flow | 1.5 | ml/min |
| Injection Temperature | 240° | C. |
| Transfer Line Temperature | 250° | C. |
| MS Mode EI, TIC Full Scan | (90-270 | m/z) |
| Injection Liquid | 1.0 | μl (splitless) |
| Ion Source Temperature | 240° | C. |

Results:

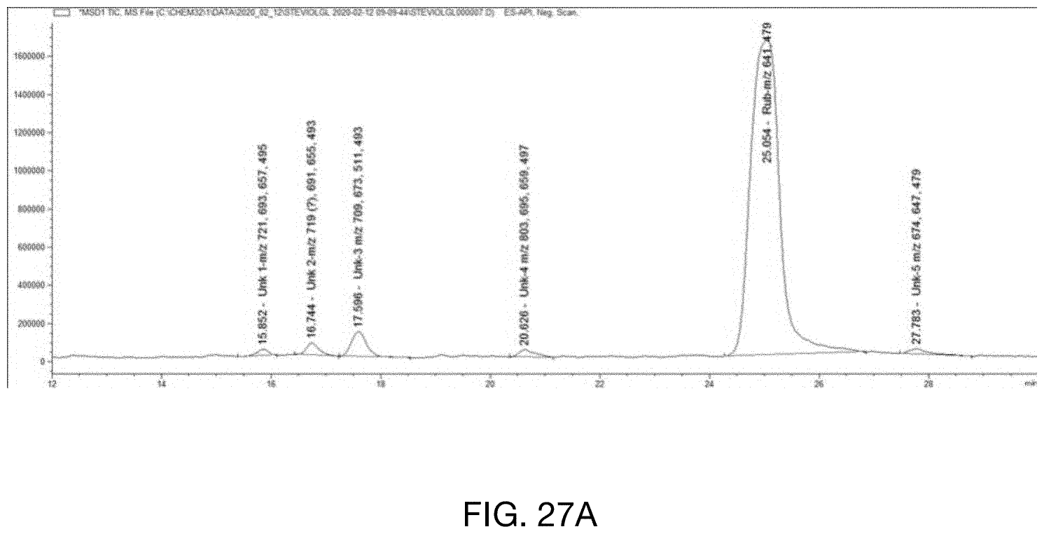

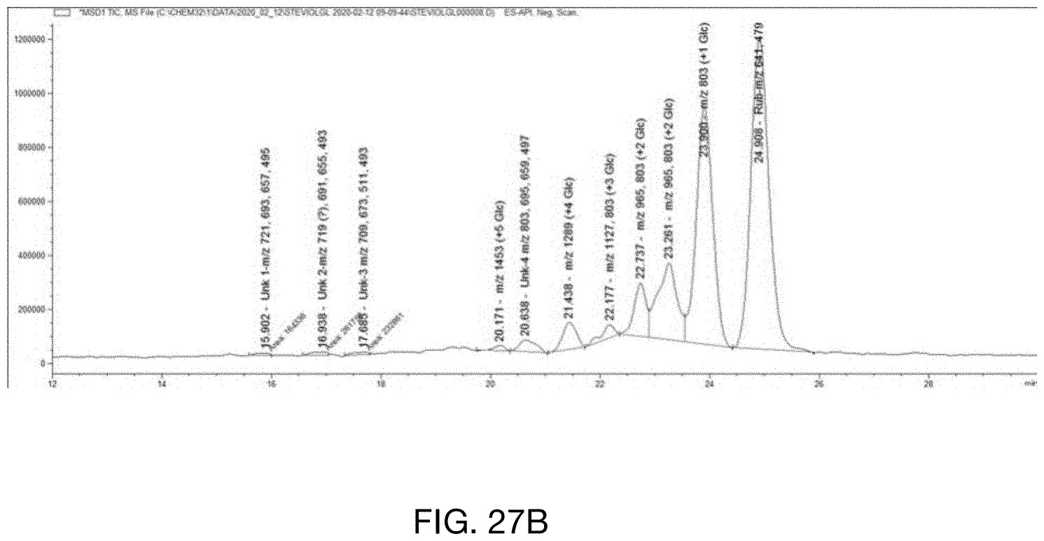

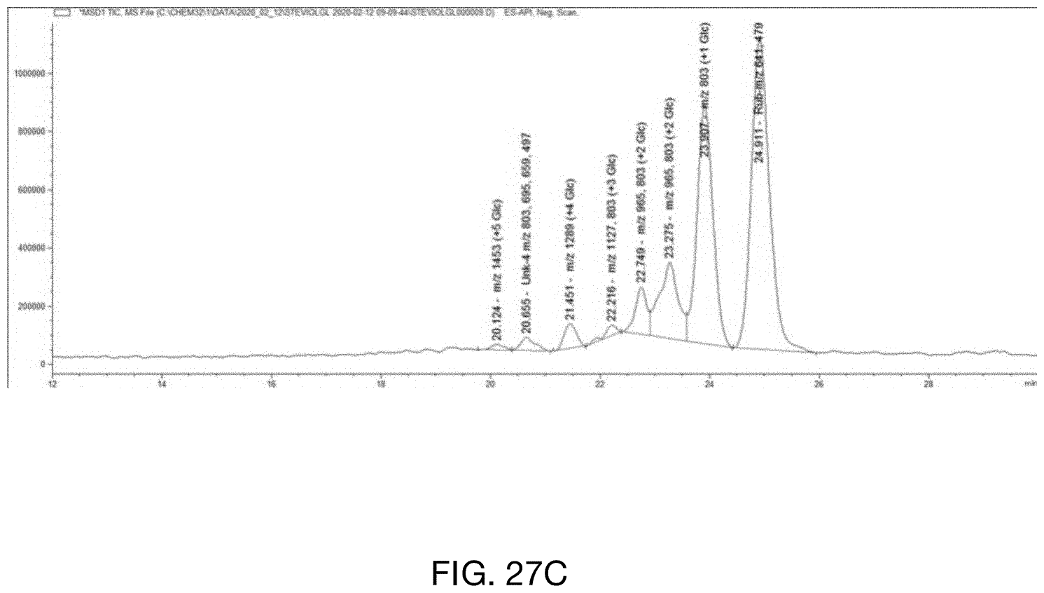

Tables 47-1 to 47-3 show the test results for steviol-glycosides and glucosylated steviol-glycosides. Tables 47-4 and 47-5 show the suavioside related compounds detected in the samples. Table 47-6 shows volatile compounds observed in the samples. FIGS. 27 to 30 (and panels therein) show chromatograms of exemplifying samples. Table 47-7 shows representative structures of suaviosides. FIGS. 27A-27C, 28A-28C and 29 show chromatograms of various samples.

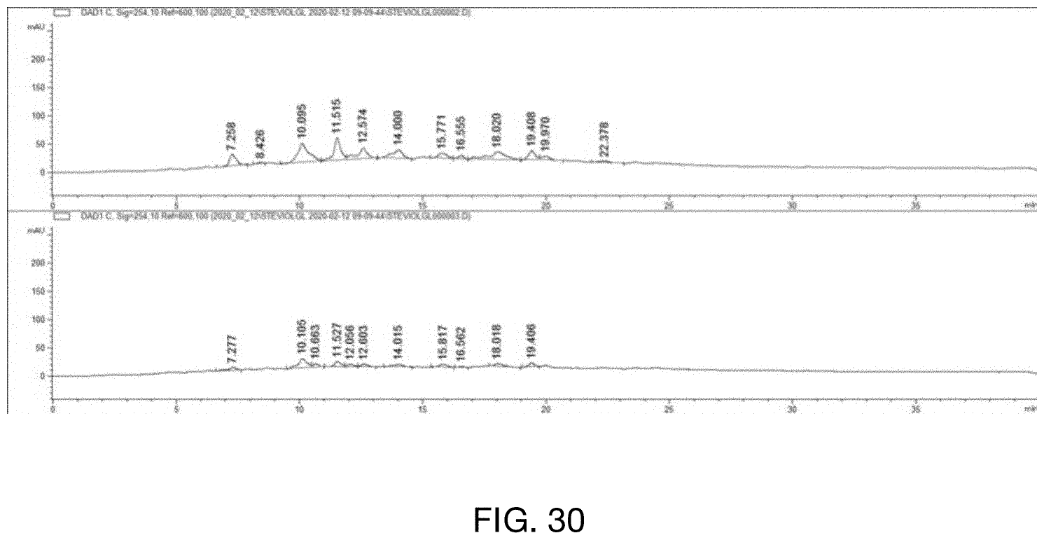

The screening for gallic acid, rutin and ellagic acid (described in the literature as marker compounds for Rubus S. leaves) failed to show any of these compounds in the samples. The screening consisted of comparison of retention times to authentic standards, comparison of online DAD-UV spectra and tracing of m/z values in ESI-MS detection. FIG. 30 shows the chromatographic evaluation at 254 nm. As seen there, there are no mentionable signal observed in sample RU20 and GRU20. These 2 samples should contain the maximum amount of compounds from this class.

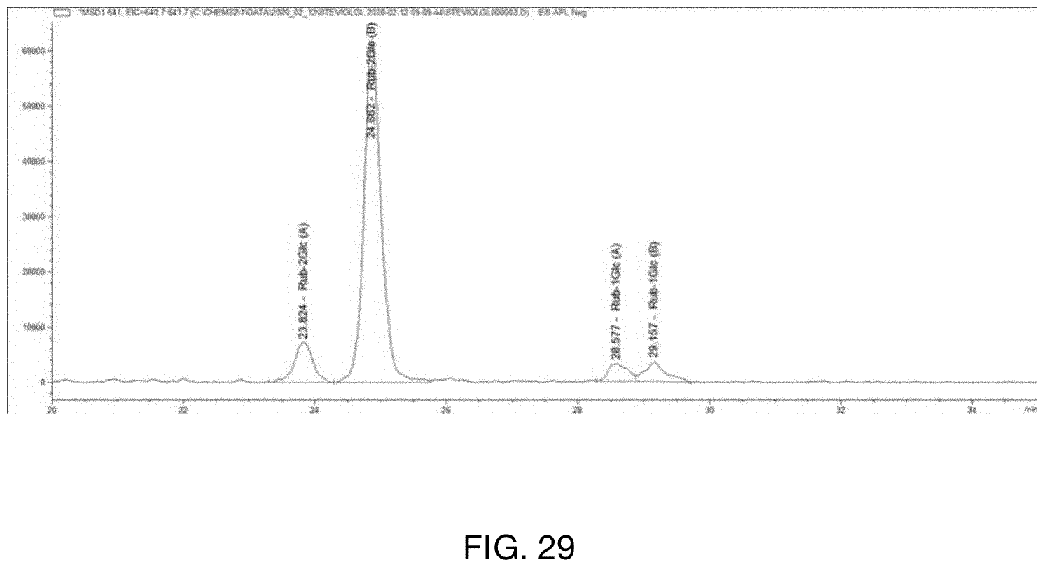

As seen in Tables 47-1 to 47-3, the base samples with 20% rubusoside (whether or not treated) contains mainly rubusoside and steviol-monoside in a ratio of around 10:1 together with traces of suaviosides. The base sample with 92% rubusoside contains mainly rubusoside and traces of suaviosides (see Table 47-4). It is therefore acceptable to allocate glucosylated steviol-glycosides as stemming mostly from rubusoside. Steviol-monoside with one added glucose can be determined due to chromatographic separation from Rubusoside, in all other glycosylation patterns it can only be differentiated between different molar masses, but not the basic molecule (rubusoside or steviol-monoside). As shown in Tables 47-1 to 47-3 and FIG. 29, the glycosylated samples show for most molar masses 2 peaks which are interpreted as rubusoside isomers.

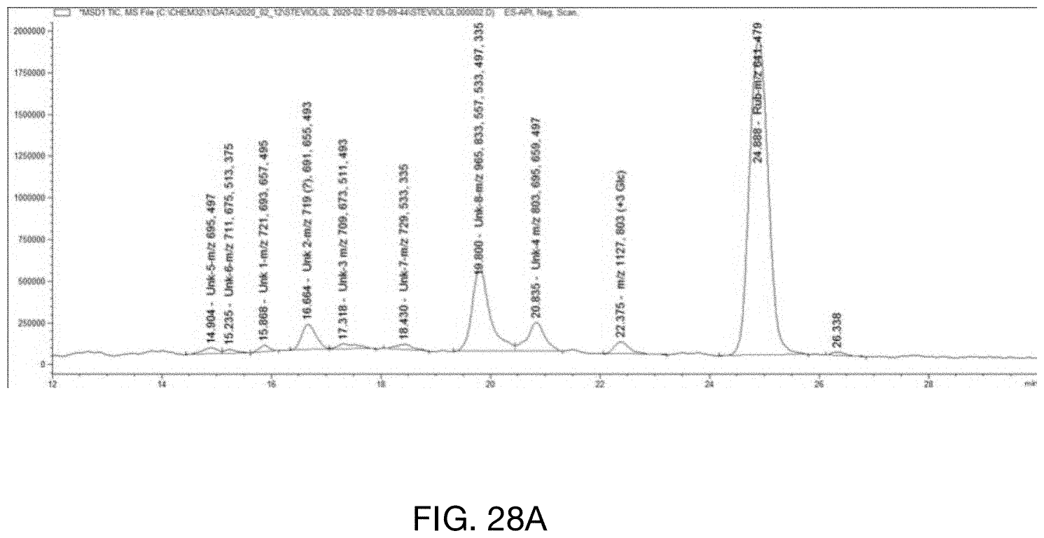

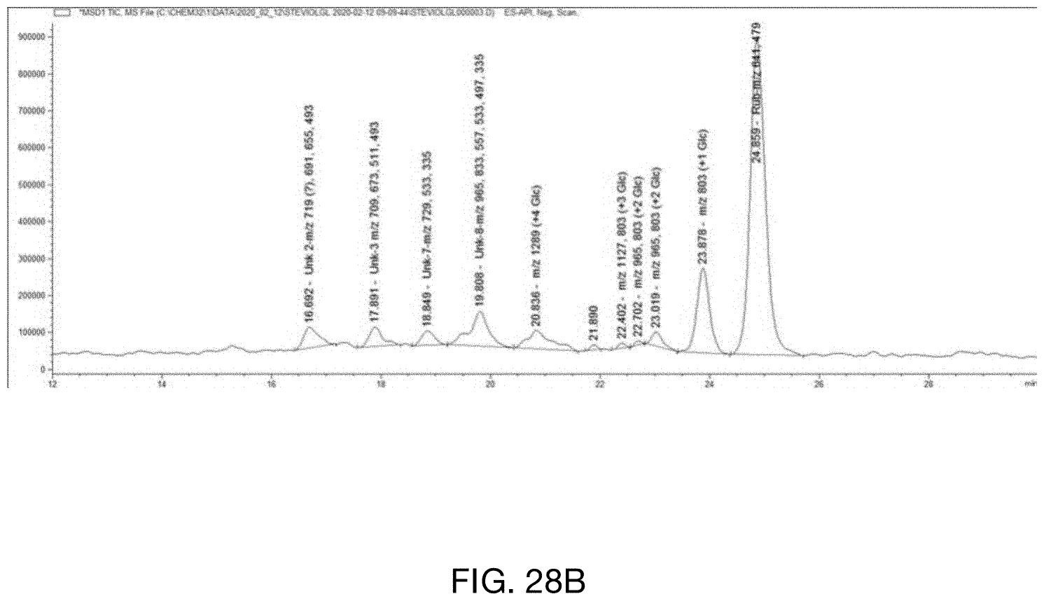

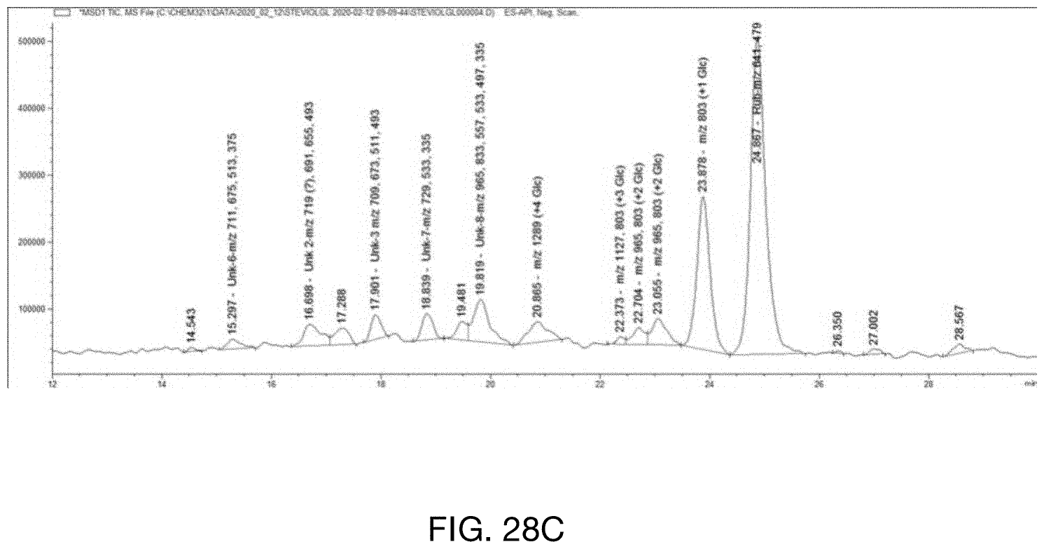

Further tracing of minor steviol-related compounds tentatively present in sweet tea leaf extracts (i.e. suaviosides) was performed by detailed evaluation of the ESI-MS trace. FIGS. 27A-27C and 28A-28C present comparative fingerprints and Tables 47-4 and 47-5 provide quantitative estimates for steviol-related compounds, tentatively from the group of suaviosides. Table 47-6 shows the qualitative results for the volatile compounds detected in the samples RU20, RU90, TRU20, GRU20 and GRU90.

TABLE 47-1
Steviolglycosides detected in sample
RU20 and samples derived from RU20.

| | | g/100 g¹⁾ | | | |
|---|---|---|---|---|---|
| Tentative | | | | GRU20- | GRU20- |
| Structure | m/z | RU20 | GRU20 | MRP-TA | MRP-CA |
| Related (as | | 1.24 | 1.26 | 1.92 | 1.75 |
| Ru) | | | | | |
| Ru-5Glc A | 1452 | n.d.²⁾ | 0.31 | 0.24 | 0.31 |
| Ru-5Glc B | 1452 | n.d. | 0.62 | 0.44 | 0.51 |
| Ru-4Glc A | 1289 | n.d. | 0.98 | 0.87 | 0.79 |
| Ru-4Glc B | 1289 | n.d. | 1.78 | 1.40 | 1.30 |
| Ru-3Glc A | 1127 | n.d. | 0.41 | 0.29 | 0.32 |
| Ru-3Glc B | 1127 | n.d. | 0.52 | 0.42 | 0.36 |
| Ru-2Glc A | 965 | n.d. | 1.47 | 1.17 | 1.12 |
| Ru-2Glc B | 965 | n.d. | 2.65 | 2.16 | 1.84 |
| Ru-1Glc | 803 | n.d. | 4.86 | 3.94 | 3.96 |
| A/B | | | | | |
| Ru | 641 | 23.4 | 4.01 | 2.14 | 2.02 |
| Stev-Mono | 479 | 3.58 | 1.44 | 0.797 | 0.525 |

¹⁾Quantification was performed by peak area at 210 nm against Reb A as external standard with molar mass correction where applicable;
²⁾n.d.: not detected

TABLE 47-2
Steviolglycosides detected in sample
TRU20 and samples derived from TRU20.

| | | g/100 g | | | |
|---|---|---|---|---|---|
| Tentative | | | | GTRU20- | GTRU20- |
| Structure | m/z | TRU20 | GTRU20 | MRP-HO | MRP-CA |
| Related (as | | 1.07 | 1.952 | 0.982 | 0.814 |
| Ru) | | | | | |
| Ru-5Glc A | 1452 | n.d. | 0.36 | 0.28 | 0.33 |
| Ru-5Glc B | 1452 | n.d. | 0.66 | 0.43 | 0.52 |
| Ru-4Glc A | 1289 | n.d. | 1.08 | 0.96 | 0.82 |
| Ru-4Glc B | 1289 | n.d. | 1.61 | 1.35 | 1.24 |
| Ru-3Glc A | 1127 | n.d. | 0.36 | 0.24 | 0.25 |
| Ru-3Glc B | 1127 | n.d. | 0.53 | 0.42 | 0.38 |
| Ru-2Glc A | 965 | n.d. | 1.34 | 1.03 | 0.97 |
| Ru-2Glc B | 965 | n.d. | 2.36 | 1.85 | 1.67 |
| Ru-1Glc | 803 | n.d. | 4.51 | 3.71 | 3.46 |
| A/B | | | | | |
| Ru | 641 | 25.5 | 1.37 | 2.34 | 0.73 |
| Stev-Mono | 479 | 2.04 | 0.0748 | 0.0402 | 0.0421 |

¹⁾ Quantification was performed by peak area at 210 nm against Reb A as external standard with molar mass correction where applicable;
²⁾ n.d.: not detected

TABLE 47-3
Steviolglycosides detected in sample RU90 and samples derived from RU90

| Tentative | | g/100 g¹⁾ | | | | |
|---|---|---|---|---|---|---|
| Structure | m/z | RU90 | GRU90 | GRU90-MRP-TA | GRU90-MRP-HO | GRU90-MRP-CA |
| Related (as Ru) | | n.d.²⁾ | 3.71 | 1.92 | 1.75 | 0.36 |
| Ru-5Glc A | 1452 | n.d. | 1.28 | 0.99 | 1.16 | 0.74 |
| Ru-5Glc B | 1452 | n.d. | 2.61 | 1.71 | 2.08 | 1.44 |
| Ru-4Glc A | 1289 | n.d. | 4.24 | 3.76 | 3.23 | 2.24 |
| Ru-4Glc B | 1289 | n.d. | 7.14 | 5.99 | 5.51 | 4.14 |
| Ru-3Glc A | 1127 | n.d. | 1.62 | 1.10 | 1.14 | 0.86 |
| Ru-3Glc B | 1127 | n.d. | 2.02 | 1.61 | 1.44 | 1.13 |
| Ru-2Glc A | 965 | n.d. | 5.67 | 4.35 | 4.13 | 3.08 |
| Ru-2Glc B | 965 | n.d. | 10.9 | 8.56 | 7.70 | 6.08 |
| Ru-1Glc A/B | 803 | n.d. | 18.3 | 15.03 | 14.00 | 11.30 |
| Ru | 641 | 92.8 | 12.7 | 10.7 | 10.0 | 7.91 |
| Stev-Mono | 479 | n.d. | n.d. | 0.48 | 0.29 | 0.63 |

¹⁾Quantification was performed by peak area at 210 nm against Reb A as external standard with molar mass correction where applicable;
²⁾n.d.: not detected

TABLE 47-4
Suavioside related compounds in samples derived from RU 92%.

Content (g/100 g)¹⁾

| Structure | | | GRU90- | GRU90- |
|---|---|---|---|---|
| (tentative) | RU90 | GRU90 | MRP-TA | MRP-HO |
| Unknown 1 | 0.539 | n.d. | n.d. | n.d. |
| Suavioside B | | | | |
| Unknown 2 | 0.897 | n.d. | n.d. | n.d. |
| Suavioside H | | | | |
| Unknown 3 | 3.21 | n.d. | n.d. | n.d. |
| 9-OH Suav J²⁾ | | | | |
| Unknown 4 | <0.05 | n.d. | n.d. | n.d. |
| Suavioside K | | | | |

¹⁾Calculated as Rubusoside on basis of peak area at 210 nm, compound identification is tentative on basis of mass spectra.
²⁾9-Hydroxy-Suavioside J

TABLE 47-5
Suavioside related compounds in samples derived from RU 20%

| | |
|---|---|
| Structure | Content (g/100 g)¹⁾ |

| (tentative) | RU20 | GRU20 | TRU20 | GTRU20 |
|---|---|---|---|---|
| Unknown 1 | 1.51 | 0.52 | 1.26 | 0.47 |
| Suavioside B | | | | |
| Unknown 2 | 1.74 | 0.30 | 1.12 | 0.14 |
| Suavioside H | | | | |
| Unknown 3 | 3.92 | 0.79 | 2.17 | 0.33 |
| 9-OH Suav J²⁾ | | | | |
| Unknown 4 | <0.05 | n.d. | n.d. | n.d. |
| Suavioside K | | | | |
| Unknown 5 | 0.56 | 0.66 | 0.42 | 0.24 |
| Suavioside E | | | | |
| Unknown 6 | 1.04 | 0.30 | 0.88 | 0.11 |
| Suavioside L | | | | |
| Unknown 7 | <0.05 | <0.05 | <0.05 | <0.05 |
| Related | | | | |
| Unknown 8 | 0.36 | 0.07 | 0.35 | 0.05 |
| Suavioside F | | | | |
| Unknown 9 | 0.22 | <0.05 | <0.05 | <0.05 |
| Suavioside O | | | | |
| Unknown 10 | 0.53 | 0.09 | 0.40 | 0.11 |
| Suavioside A | | | | |
| Unknown 11 | 0.47 | 0.07 | 0.56 | 0.06 |
| Related | | | | |

¹⁾Calculated as Rubusoside on basis of peak area at 210 nm, compound identification is tentative on basis of mass spectra.
²⁾9-Hydroxy-Suavioside J

TABLE 47-6
Volatile compounds detected in samples
RU20, RU90, GRU20 and GRU90

| Structure | | | | | |
|---|---|---|---|---|---|
| (tentative) | RU20 | RU90 | TRU20 | GRU20 | GRU90 |
| 1-Hydroxy-2-methyl-1- | + | + | + | − | − |
| phenyl-3-pentanone | | | | | |
| 2,2,3,3-Tetramethyl-butane | + | + | + | − | − |
| 3-Methyloctanedioic acid- | + | − | − | − | + |
| dimethyl ester | | | | | |
| cis-p-2-Menthen-1-ol | + | + | + | + | − |
| Coniferyl alcohol | + | − | + | − | − |
| Diisobutyl phthalate | + | + | + | + | + |
| Dodecyl aldehyde | + | − | − | − | − |
| Linalyl acetate | + | − | + | − | − |
| L-α-Terpineol | + | + | − | + | − |
| Neryl acetate | + | − | − | − | − |
| n-Tridecane | + | + | + | + | − |
| Terpineol-4 | + | + | + | + | + |
| trans-Caryophyllene | + | + | + | + | − |
| trans-Dihydrocarvyl acetate | + | − | + | − | − |
| trans-Linalool oxide | + | − | − | − | − |
| α-Terpinene | + | − | + | − | − |
| α-Thujene | + | + | + | − | − |

FIGS. 27A-27C show chromatograms that include RU90 in the upper trace (FIG. 27A), GRU90 in the middle trace (FIG. 27B), and GRU90-MRP-TA in the lower trace (FIG. 27C); MS-TIC Mode and MS-spectra are indicated at each peak.

FIGS. 28A-28C show chromatograms that include RU20 in the Upper Trace (FIG. 28A), GRU20 in the middle trace (FIG. 28B), and GRU20-MRP-TA in the lower trace (FIG. 28C); MS-TIC Mode and MS-spectra are indicated at each peak.

FIG. 29 shows a chromatogram, where the MS-Trace is indicative for molar masses 966 or less and where GRU20 shows Rub-1Glc (2 isomers) and Rub-2Glc (2 isomers).

FIG. 30 shows a chromatogram, where UV-254 nm and the upper trace shows RU20, while the lower trace shows GRU20 (indicative for phenolic acids, polyphenols).

TABLE 47-7
Suavioside-Structures

| Aglycone (bold molar mass) | Glucosylation (bold molar mass) |
|---|---|
| 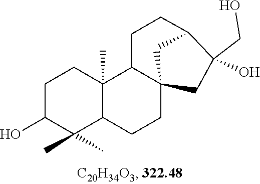 | 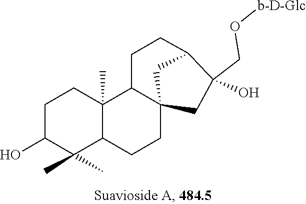 |
| 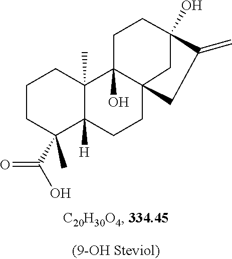 | 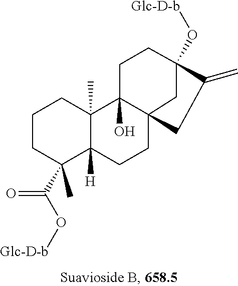 |
| 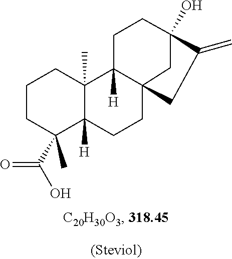 | 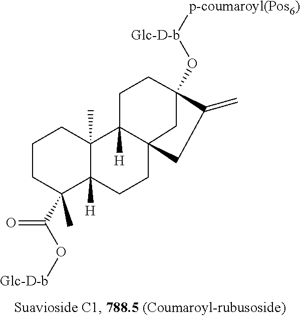 |
| 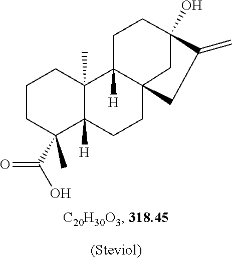 | 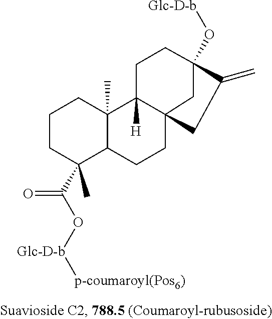 |
| 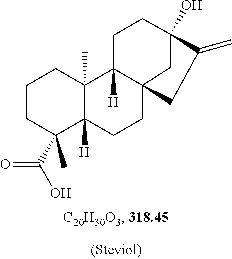 | 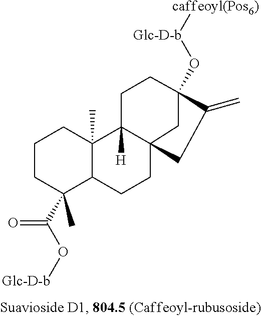 |
| 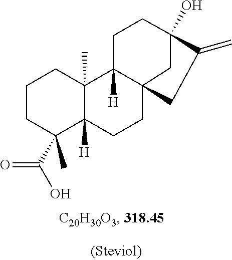 | 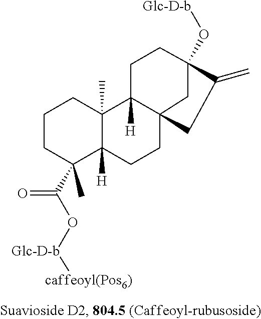 |
| 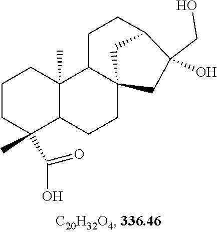 | 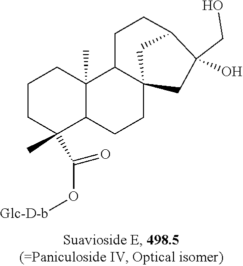 |
| 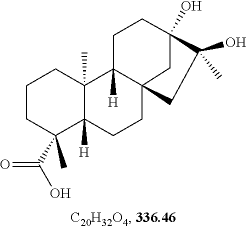 | 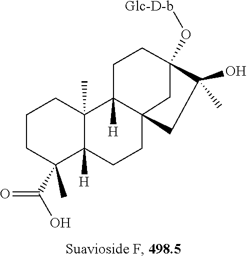 |
| 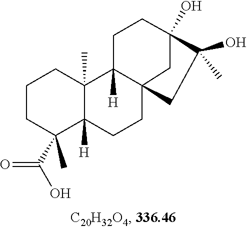 | 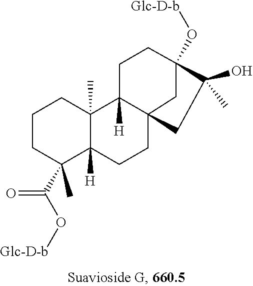 |
| 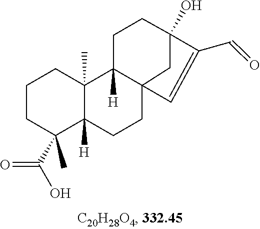 | 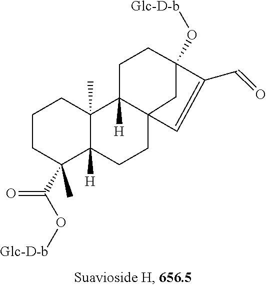 |
| 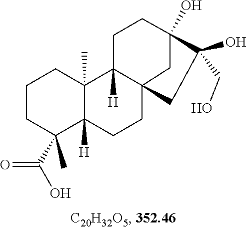 | 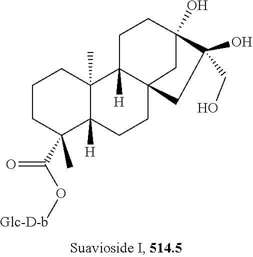 |
| 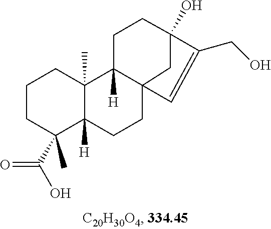 | 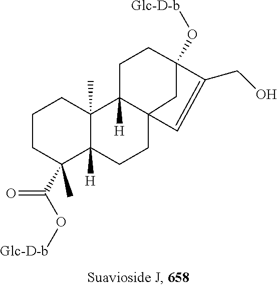 |
| 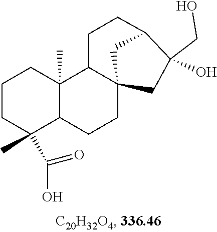 | 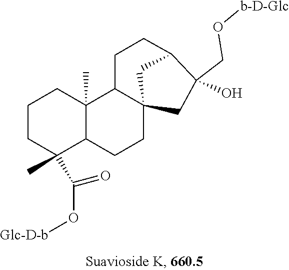 |
| 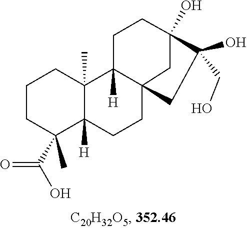 | 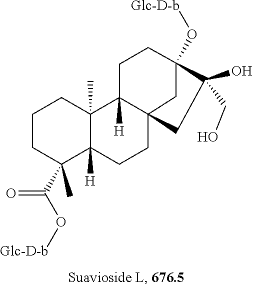 |
| 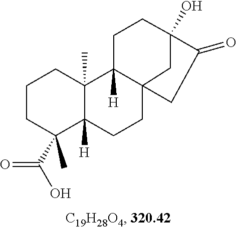 | 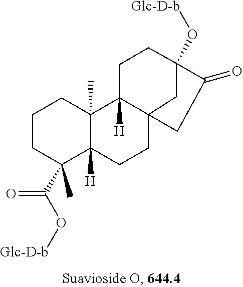 |
| 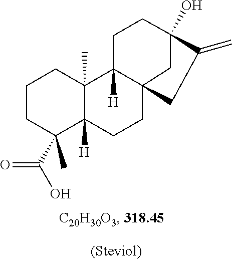 | 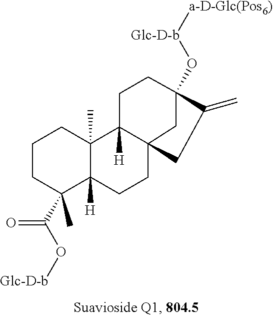 |
| 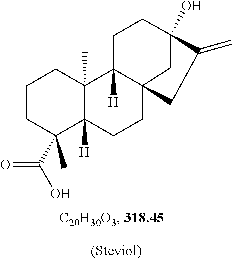 | 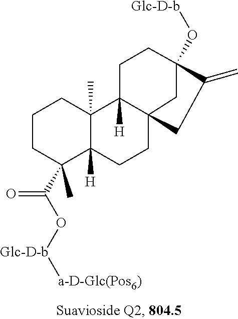 |
| 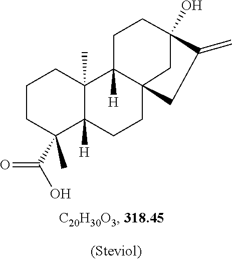 | 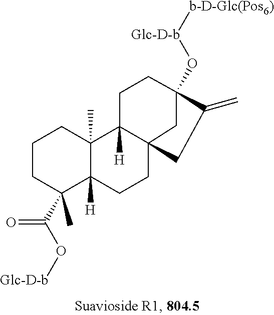 |
| 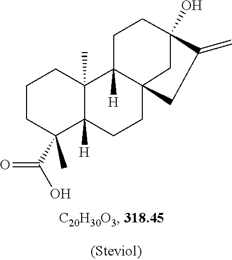 | 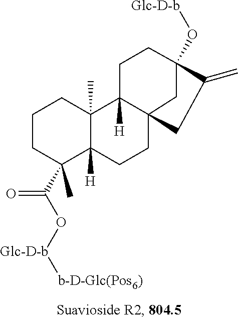 |
| 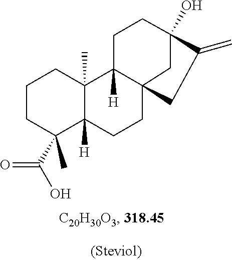 | 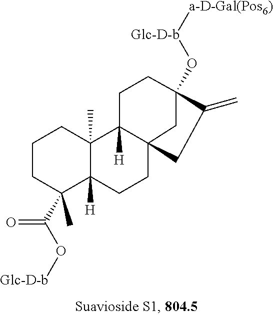 |
| 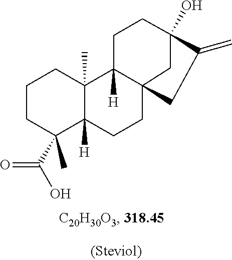 | 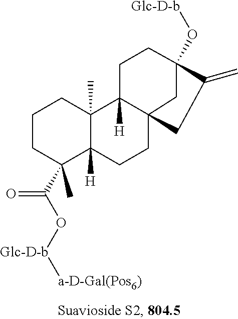 |
| 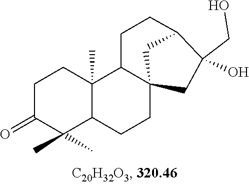 | 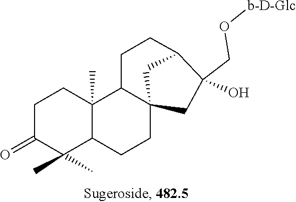 |

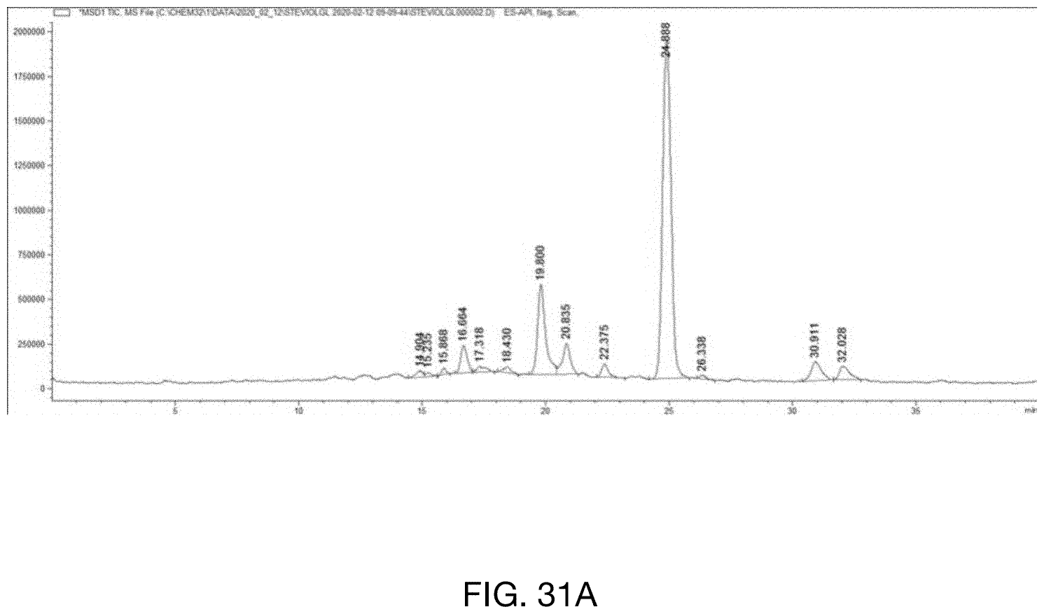

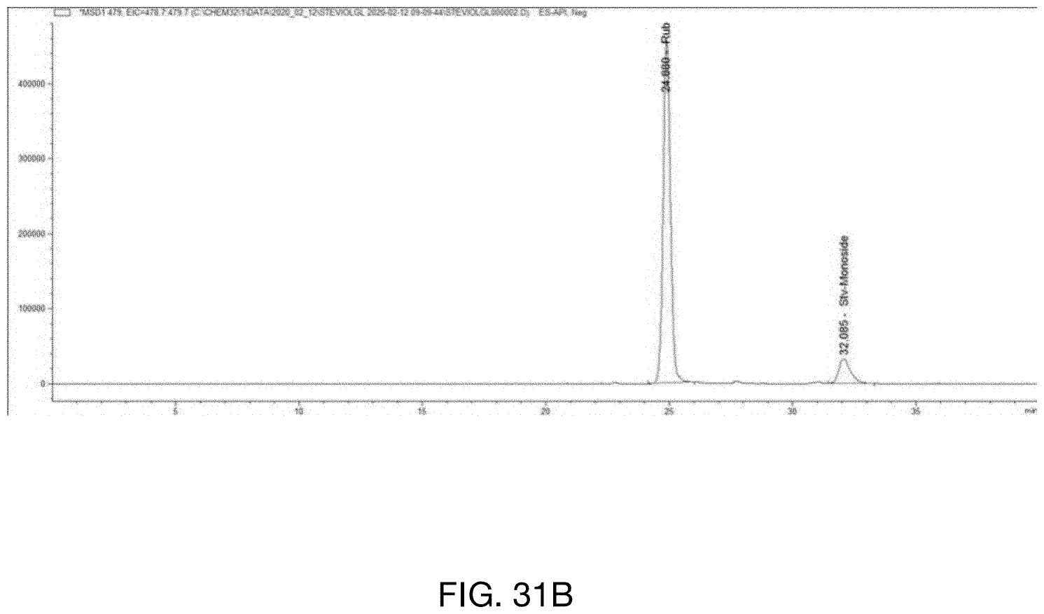

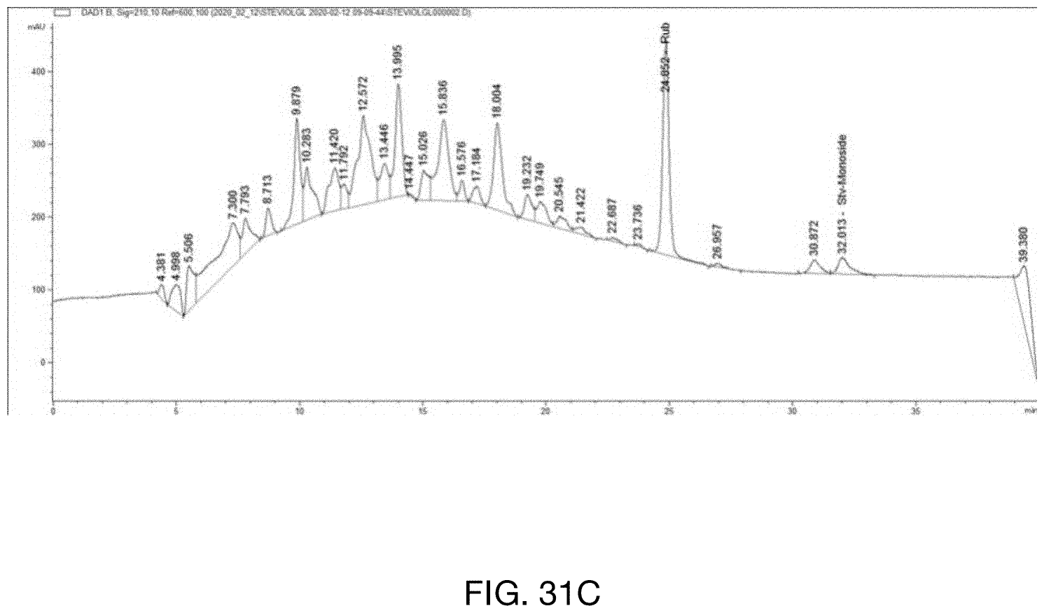

FIGS. 31A-31C show representative chromatograms of RU20.

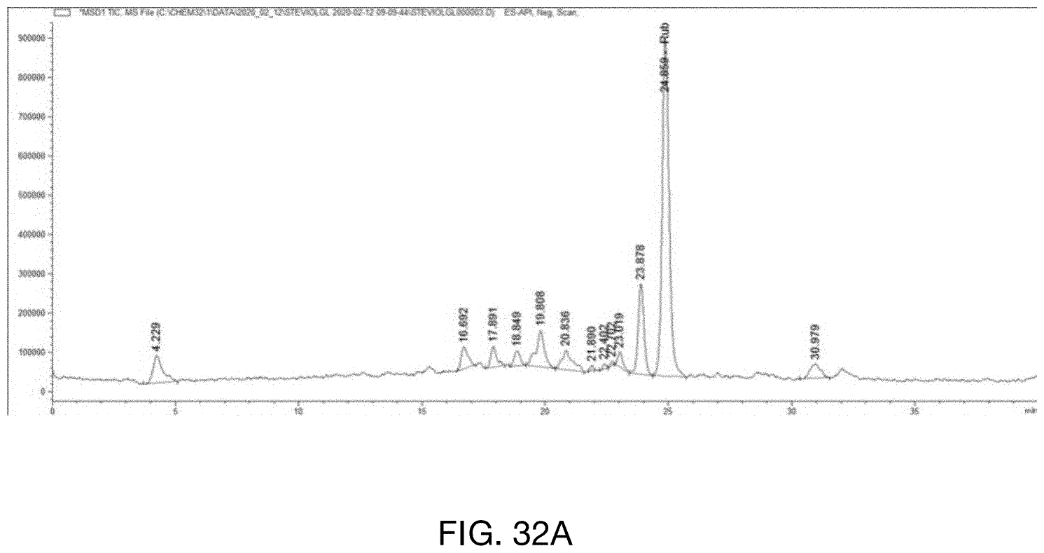

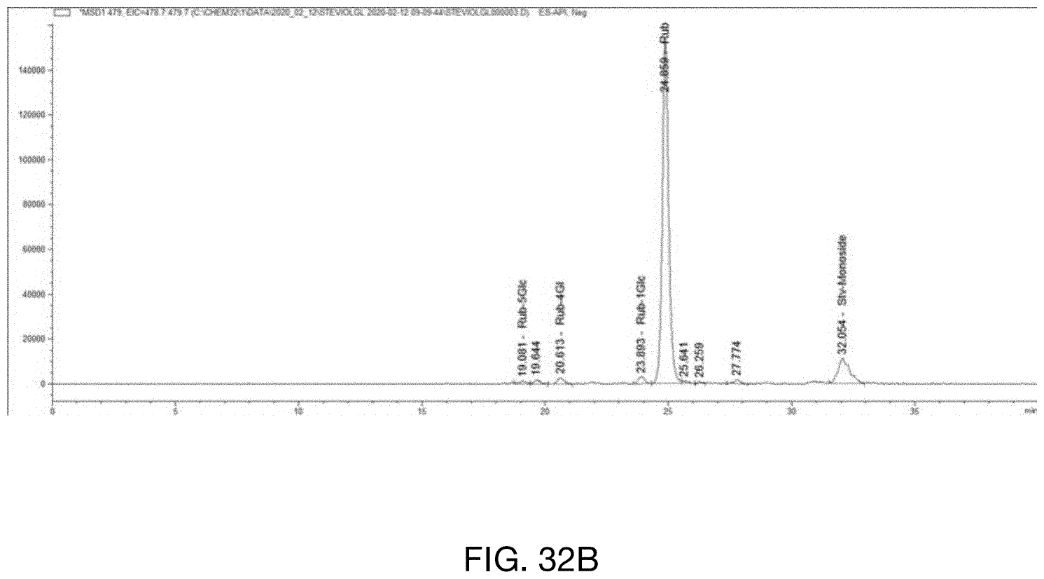

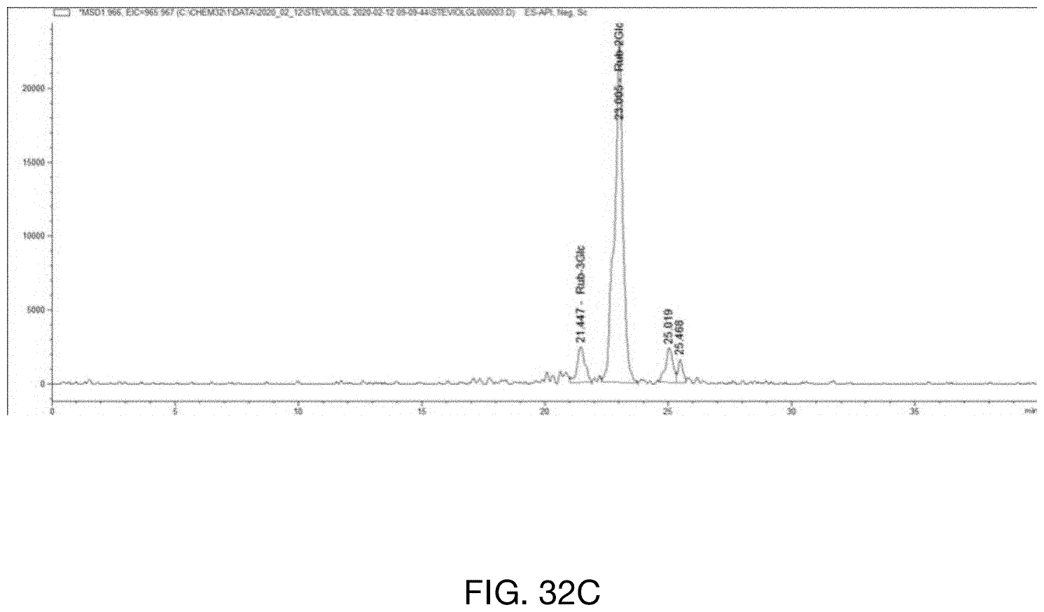

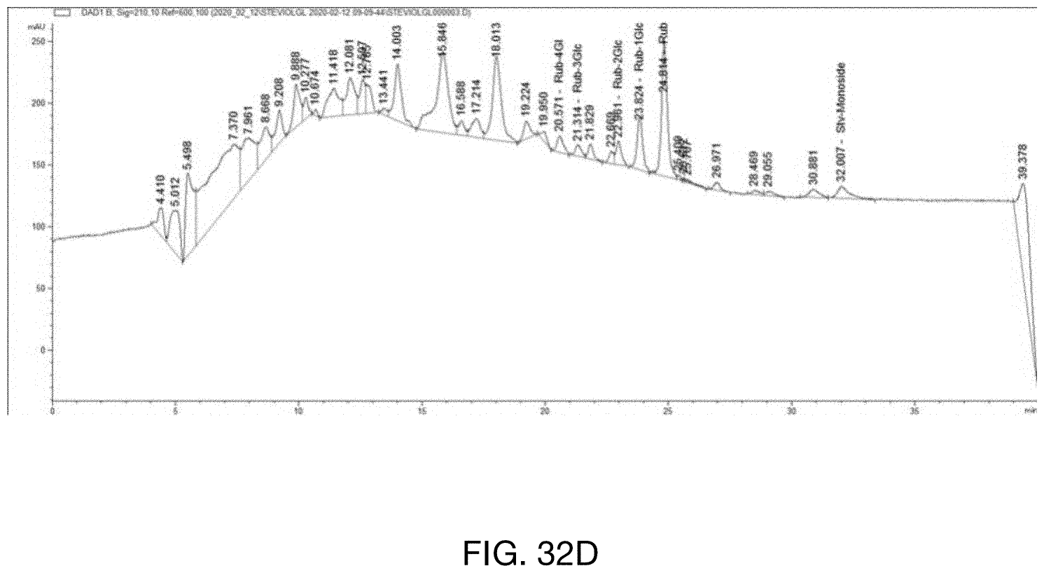

FIGS. 32A-32D show representative chromatograms of GRU20.

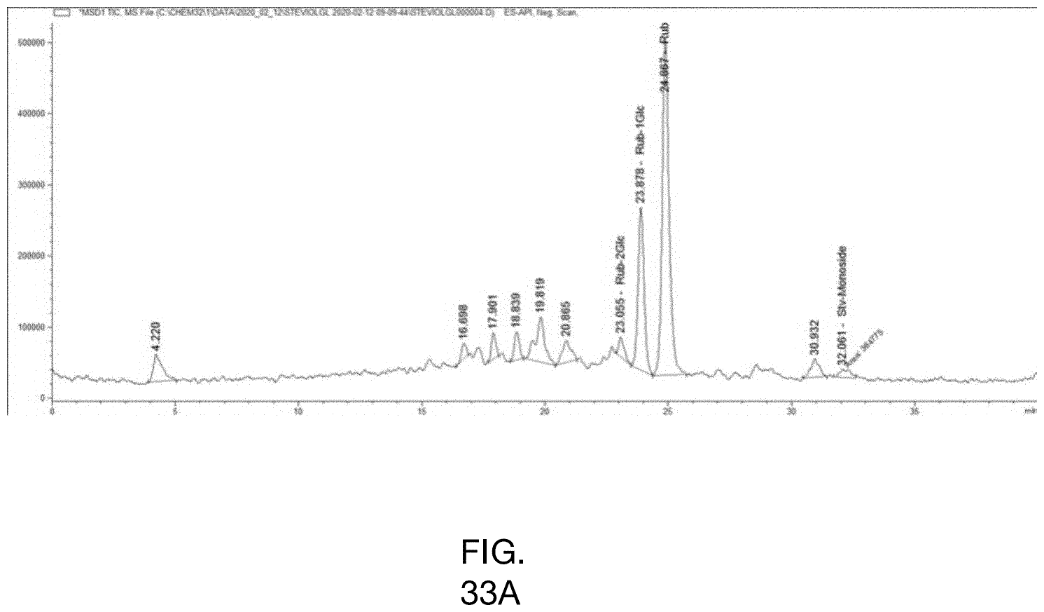

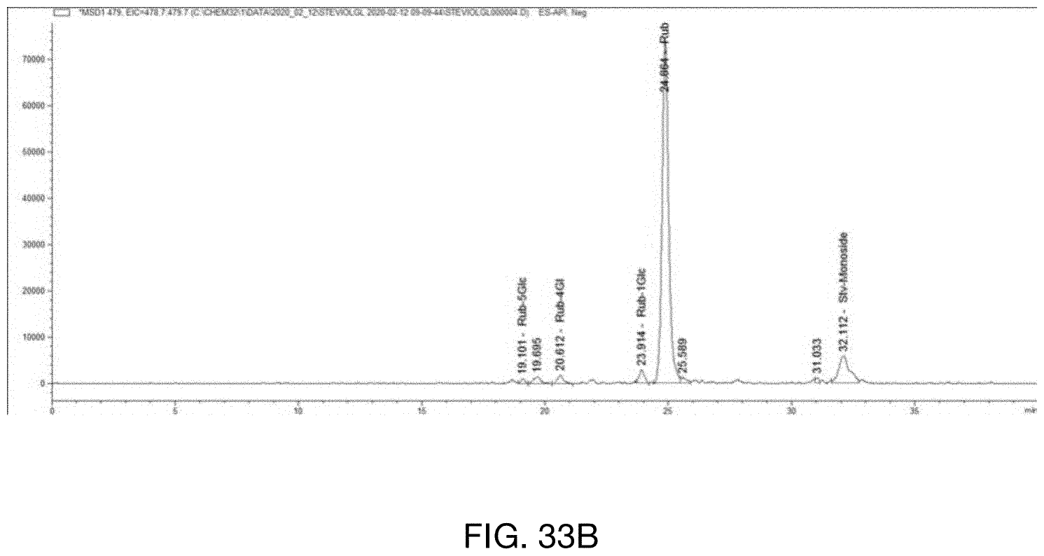

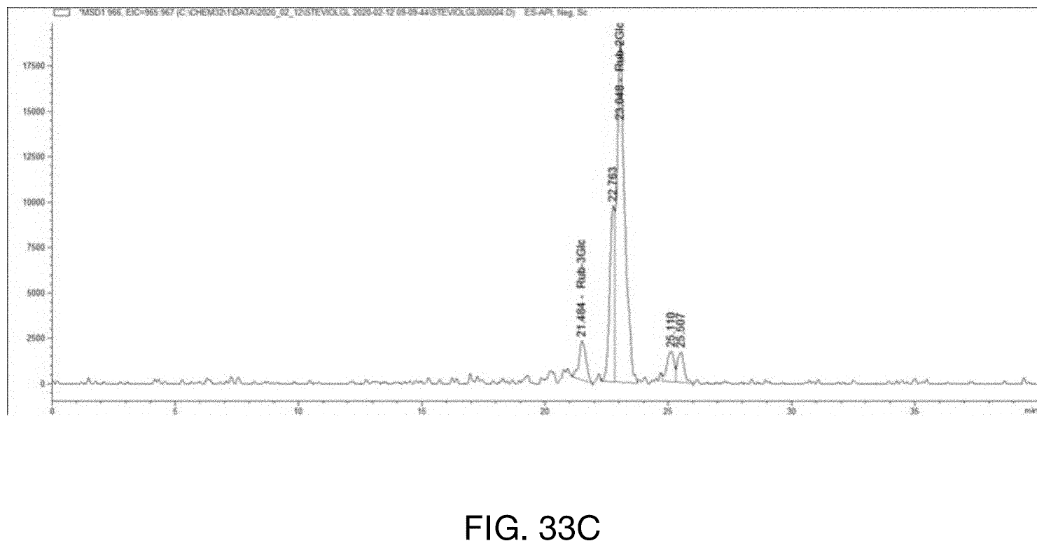

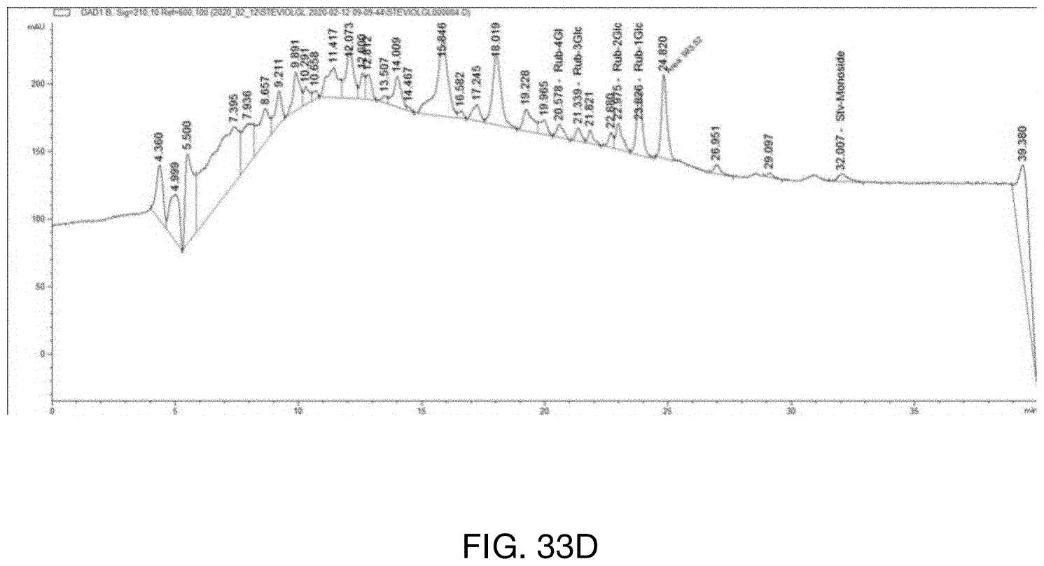

FIGS. 33A-33D show representative chromatograms of GRU20-MRP-TA.

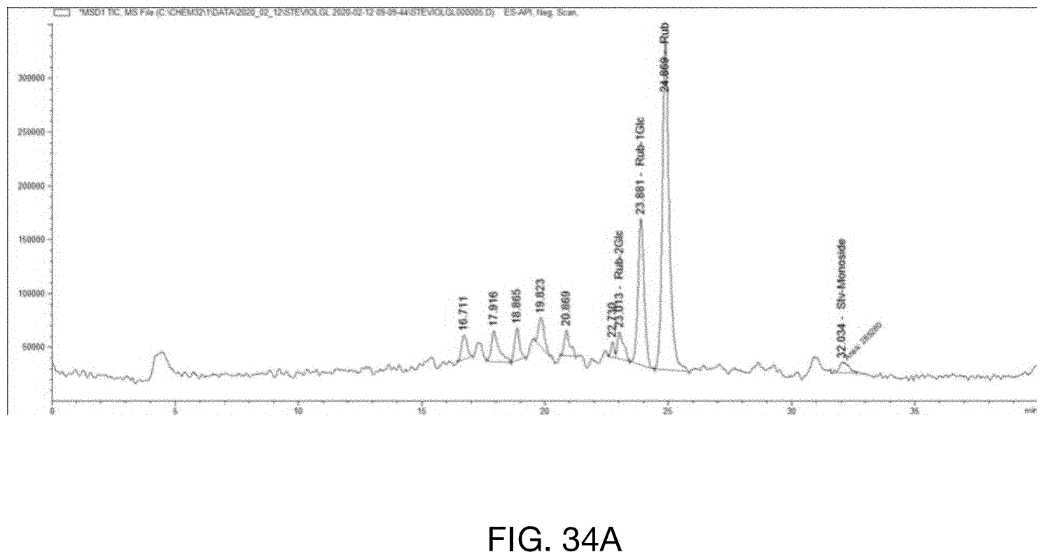

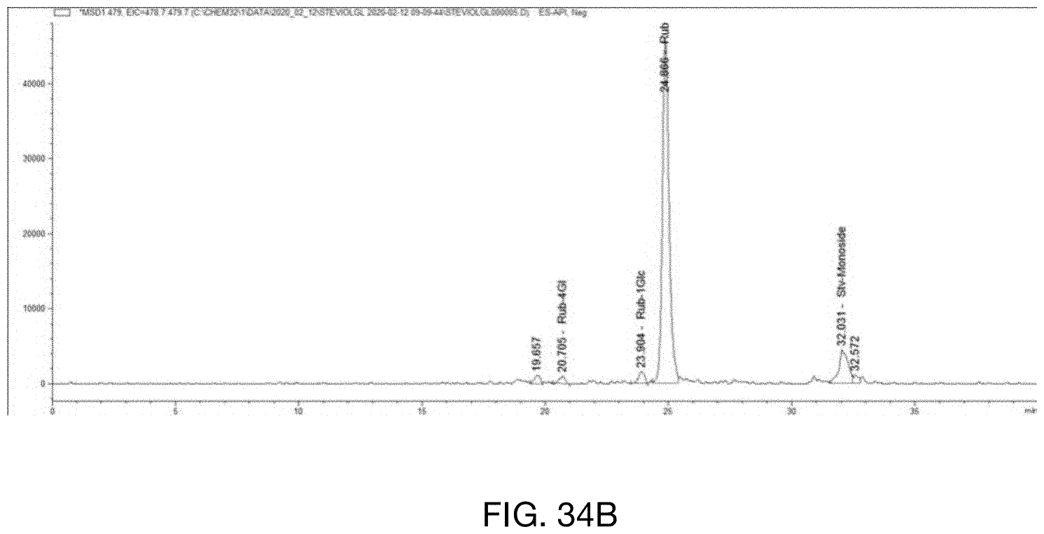

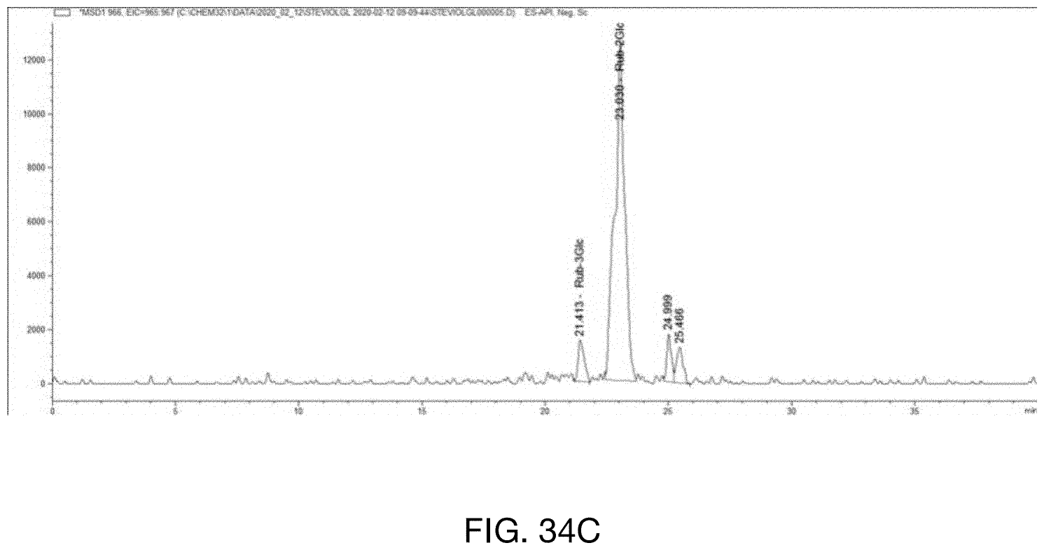

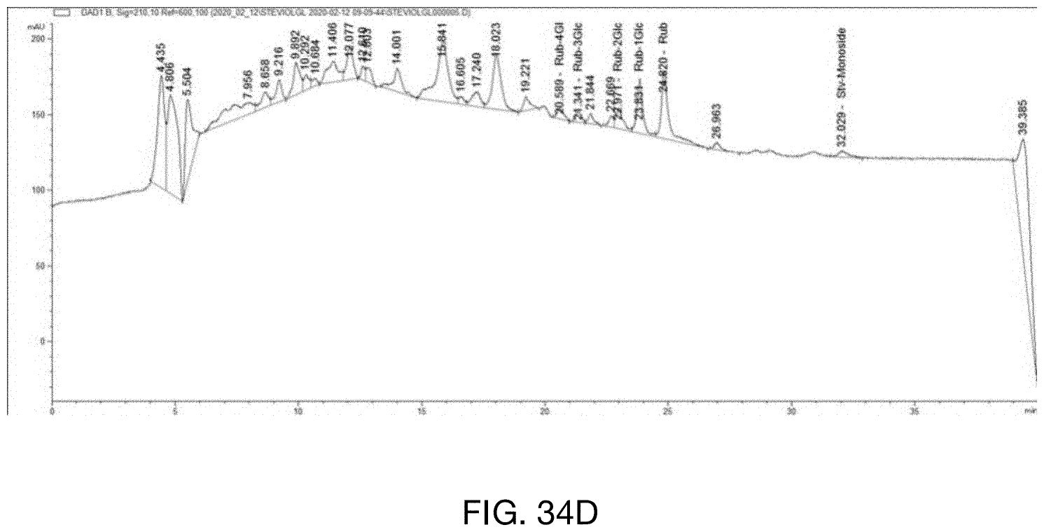

FIGS. 34A-34D show representative chromatograms of GRU20-MRP-CA.

FIGS. 35A-35C show representative chromatograms of RU90.

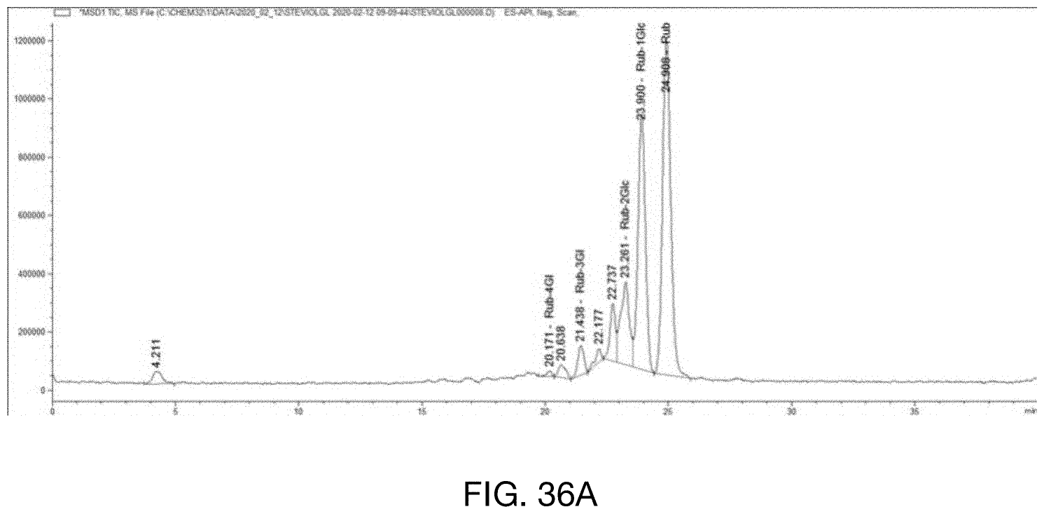

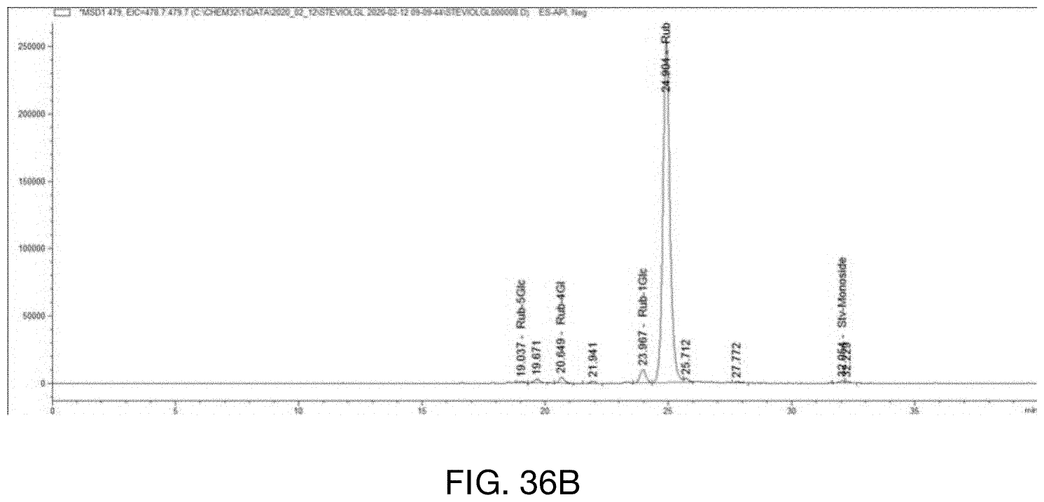

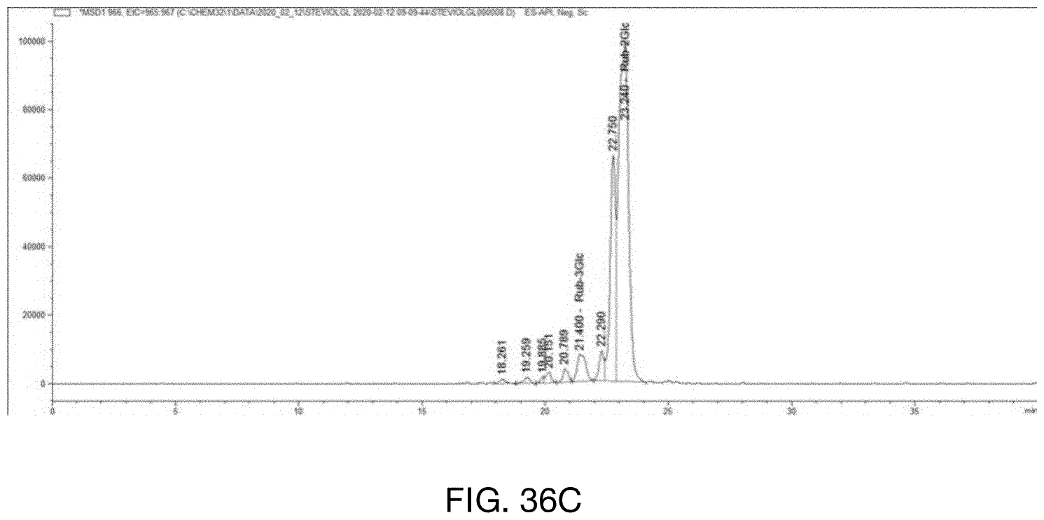

FIGS. 36A-36D show representative chromatograms of GRU90.

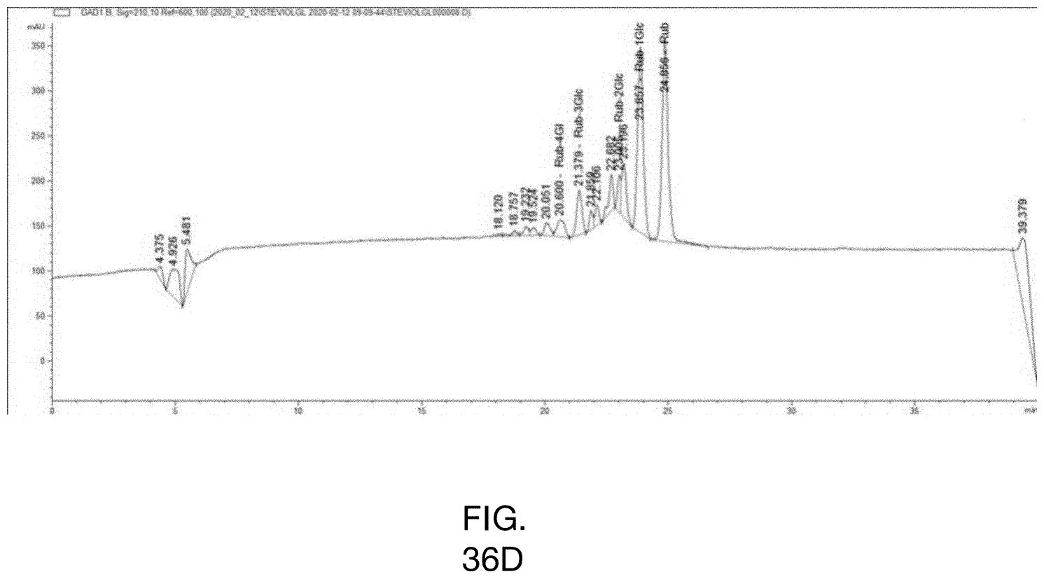

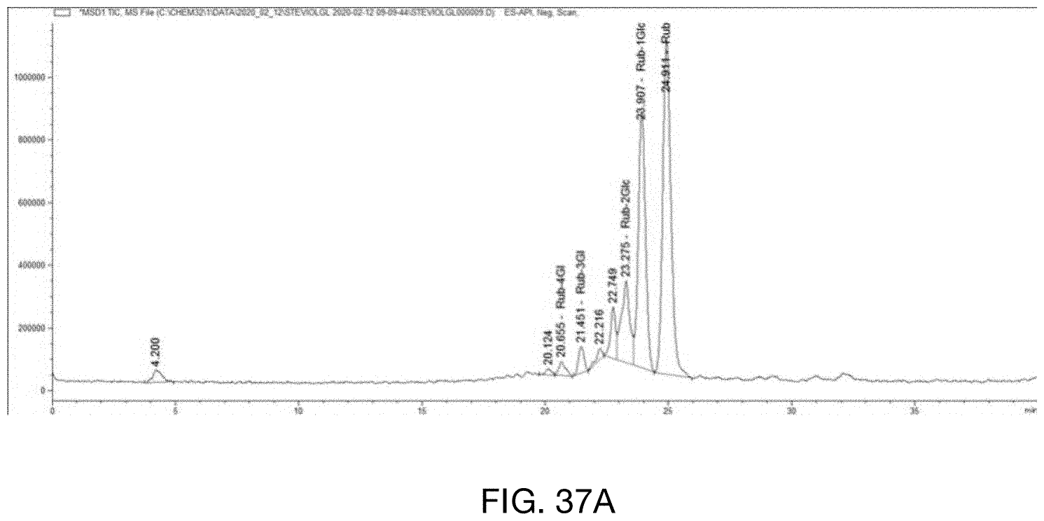

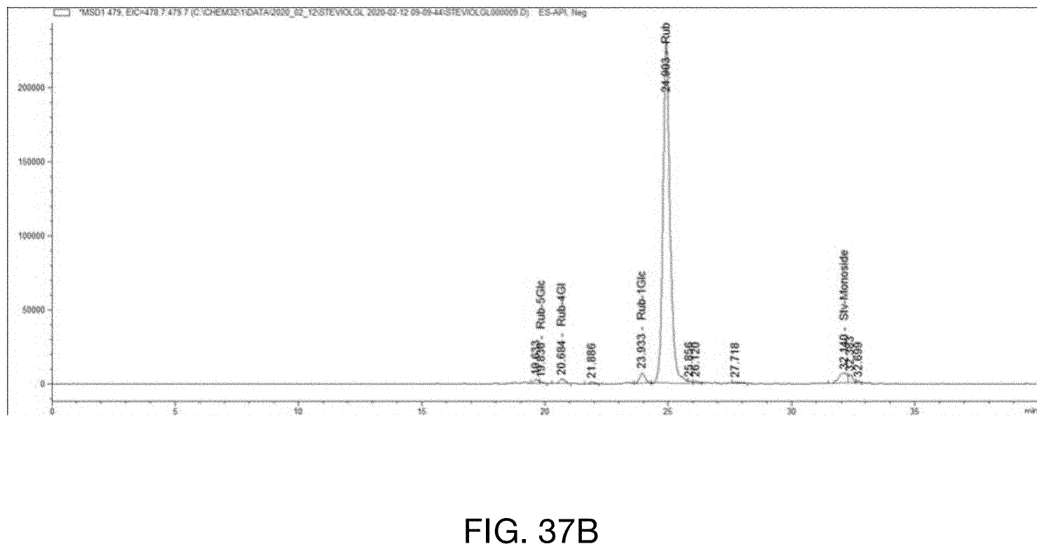

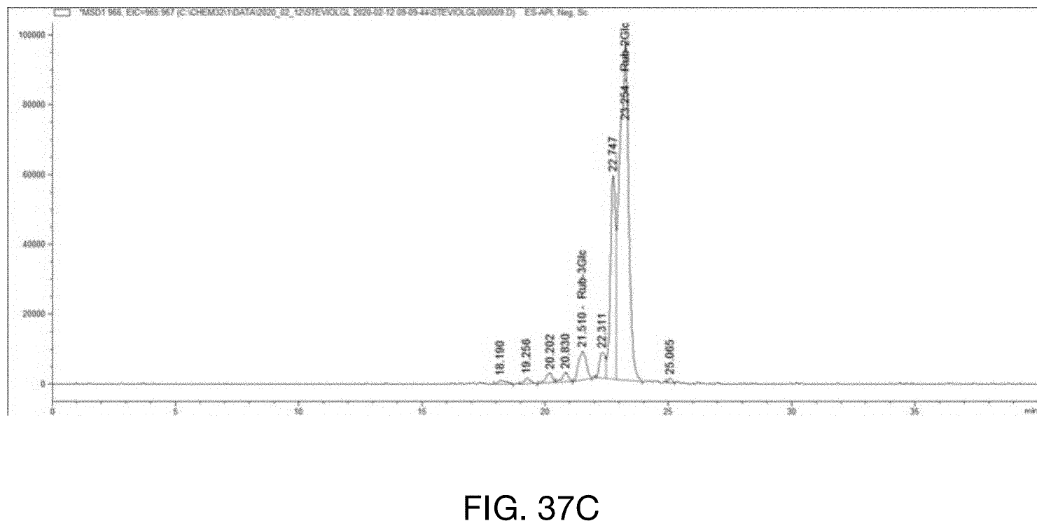

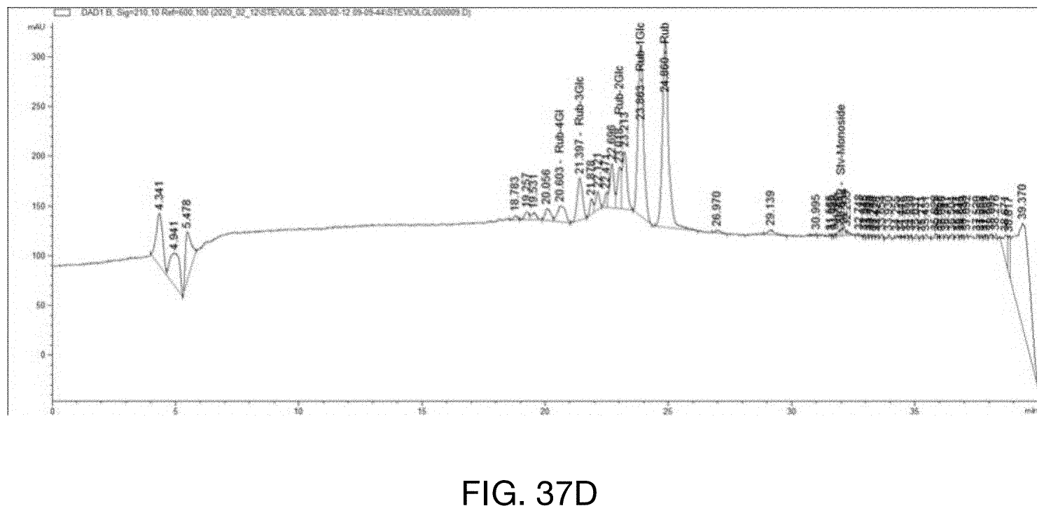

FIGS. 37A-37D show representative chromatograms of GRU90-MRP-TA.

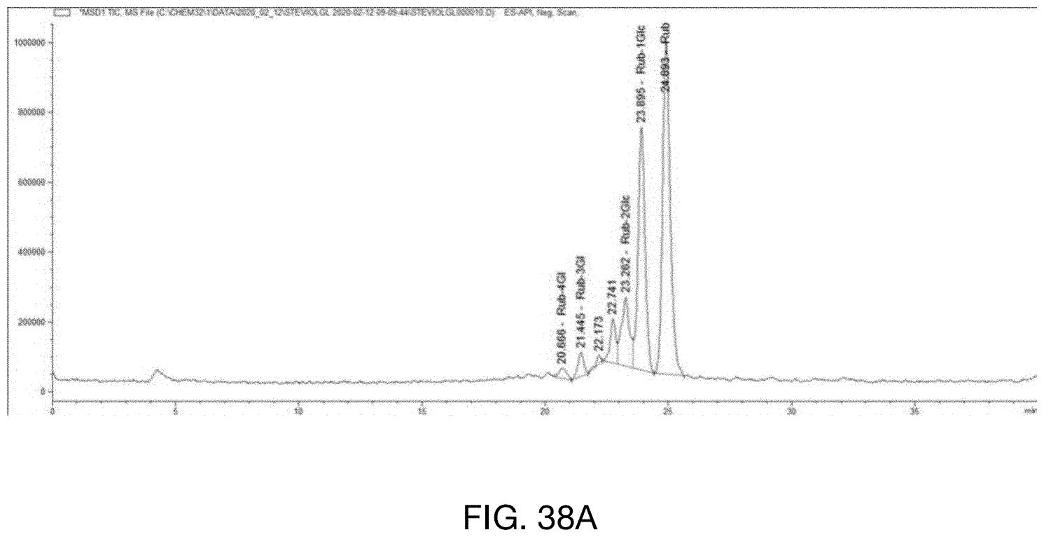

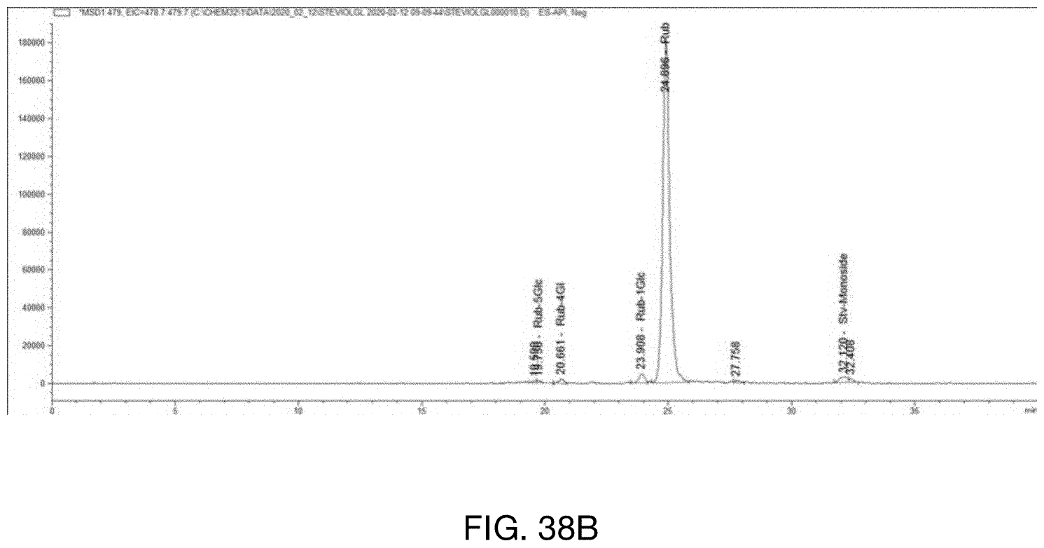

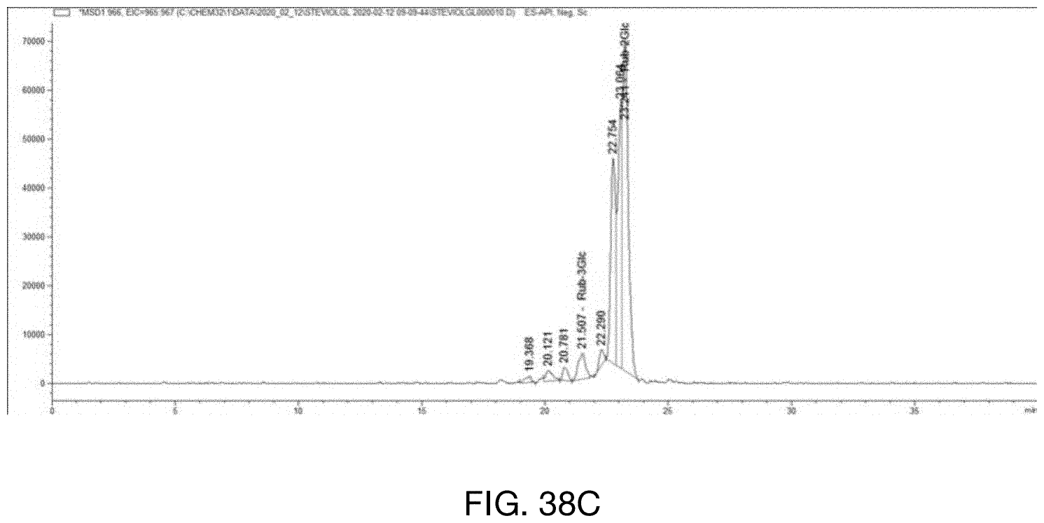

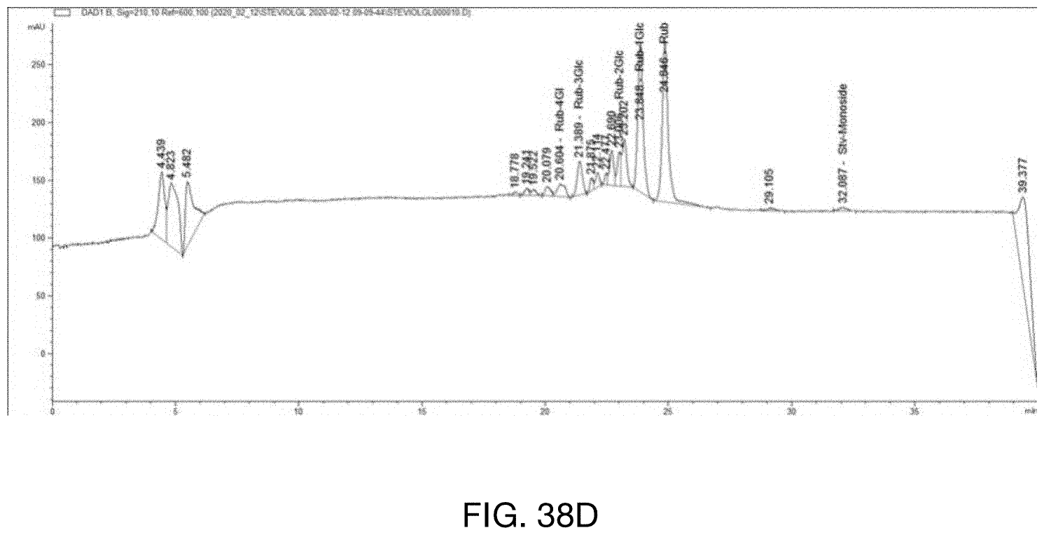

FIGS. 38A-38D show representative chromatograms of GRU90-MRP-CA.

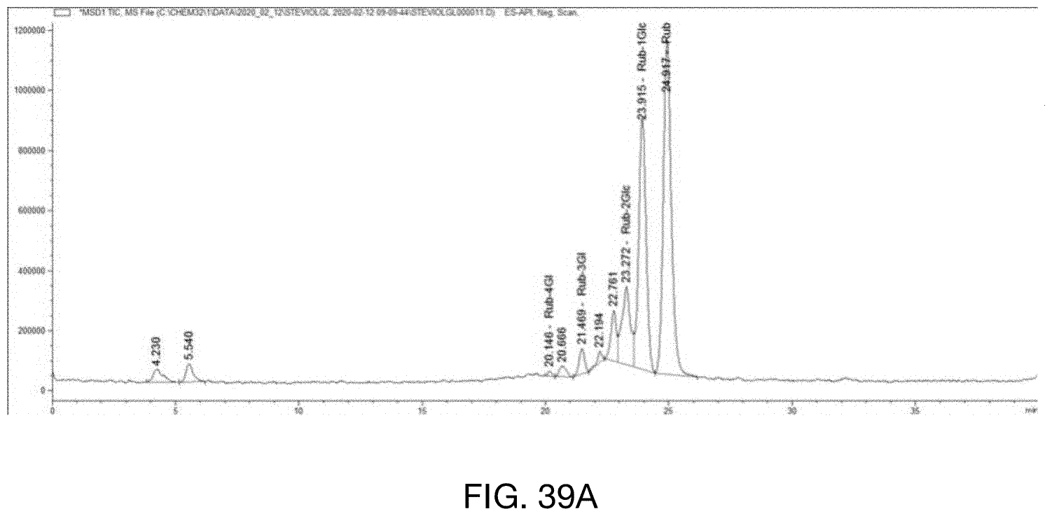

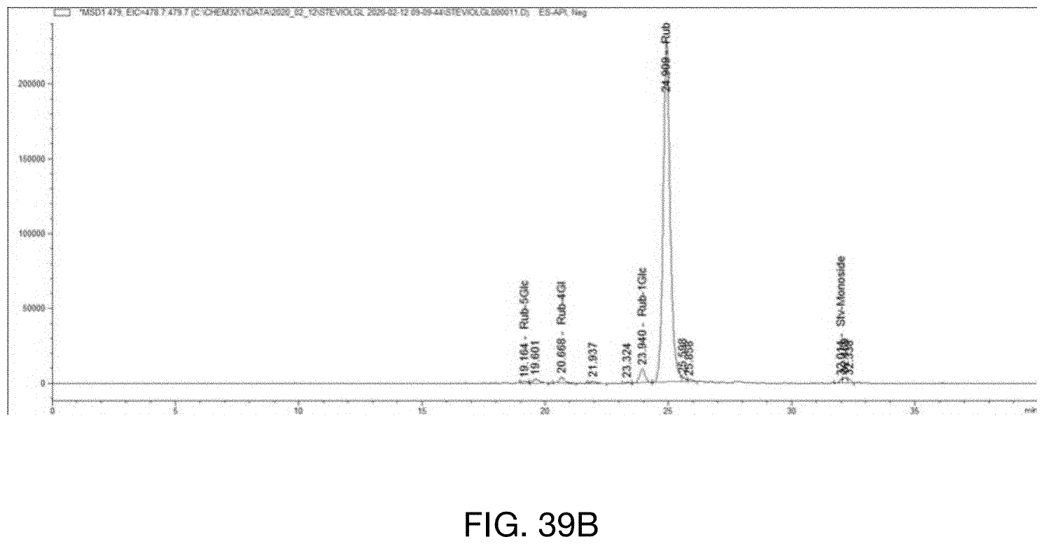

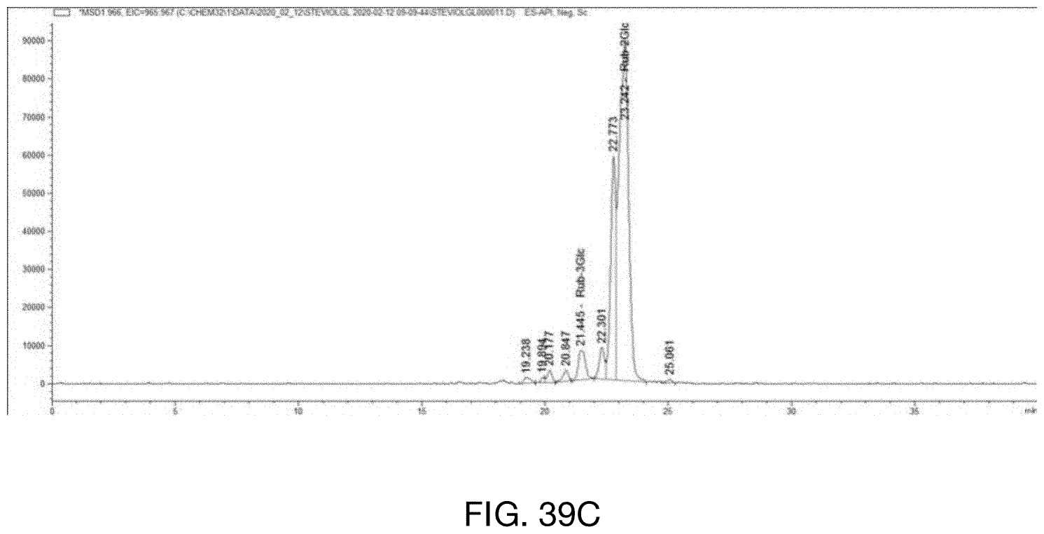

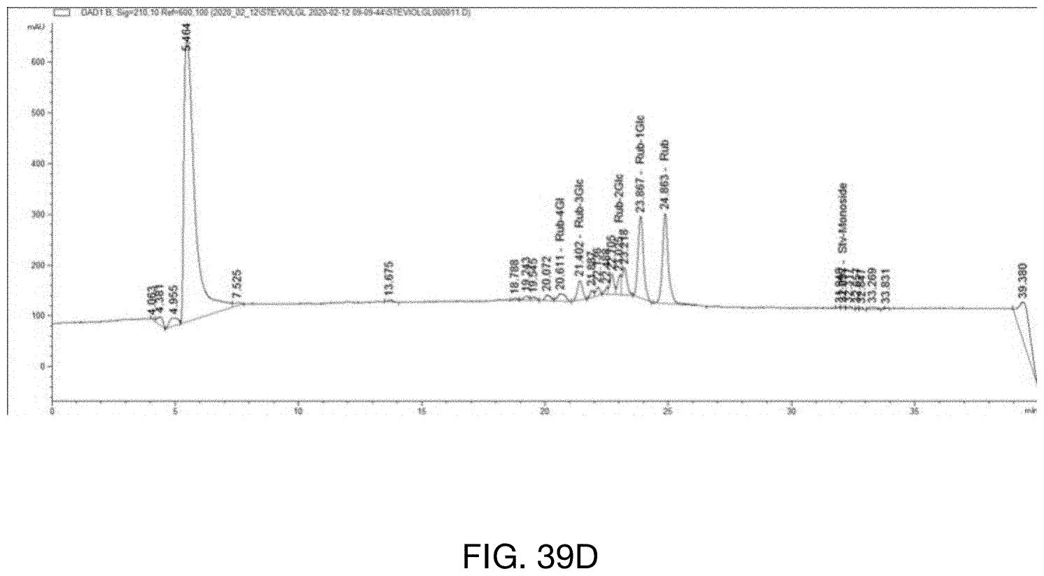

FIGS. 39A-39D show representative chromatograms of GRU90-MRP-HO

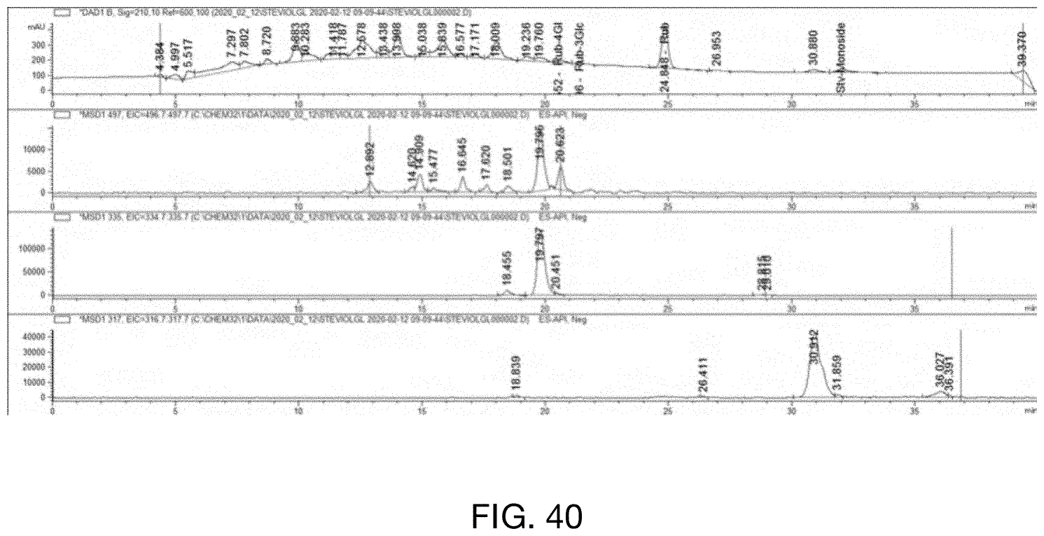

FIG. 40 shows representative chromatograms of RU20 SIM neg. MS 497, 335, 317 (indicative for suaviosides with isosteviol as skeleton).

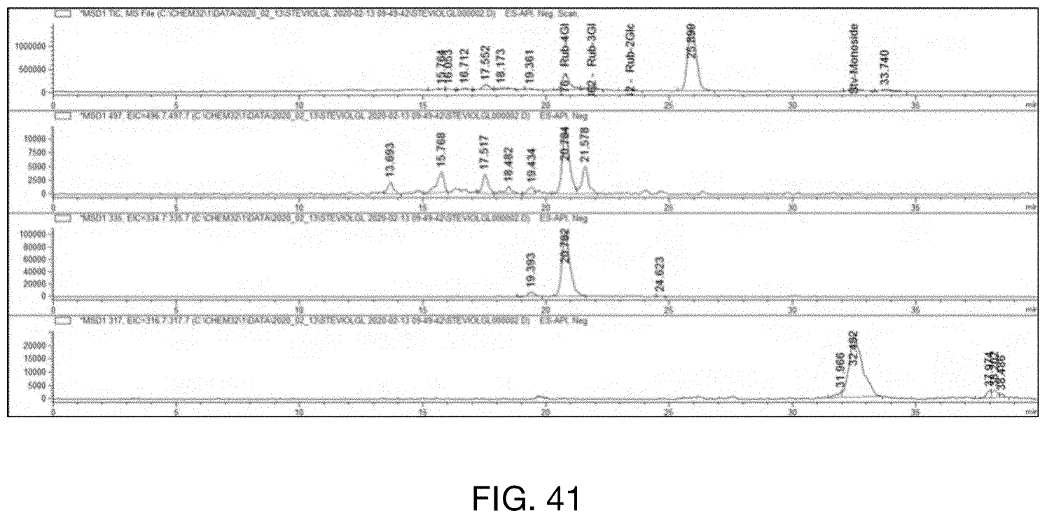

FIG. 41 shows representative chromatograms of TRU20, SIM neg. MS 497, 335, 317 (indicative for suaviosides with isosteviol as skeleton).

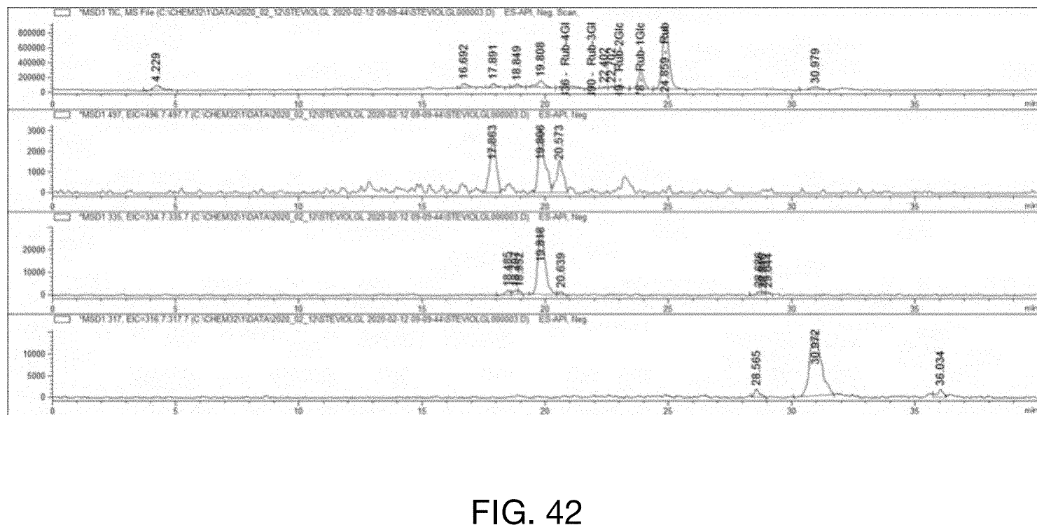

FIG. 42 shows representative chromatograms of GRU20, SIM neg. MS 497, 335, 317 (indicative for suaviosides with isosteviol as skeleton).

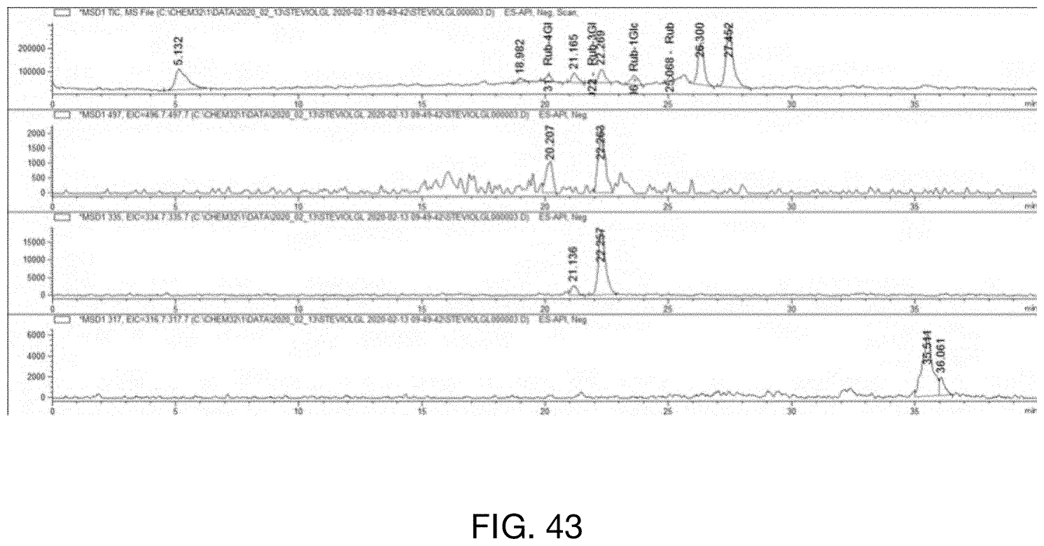

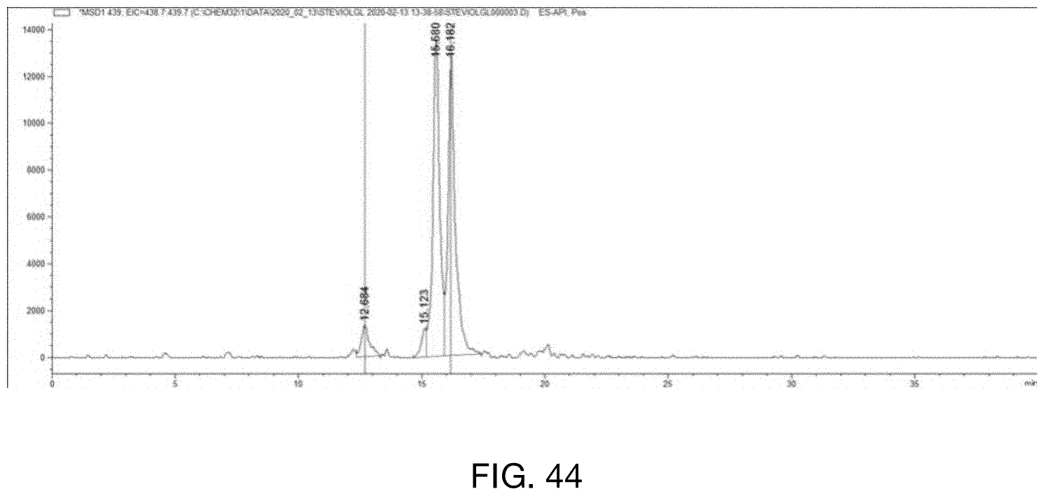

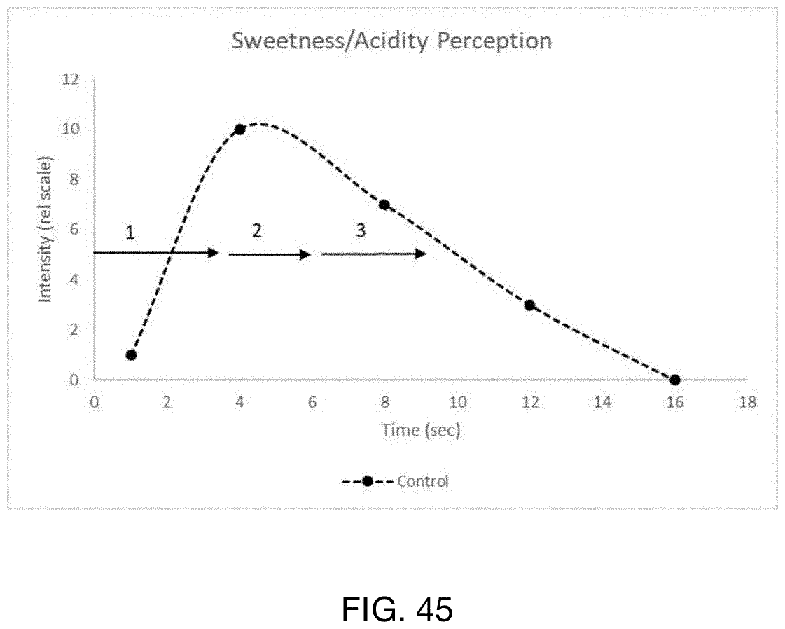

FIG. 43 shows representative chromatograms of TRU20, SIM neg. MS 497, 335, 317 (indicative for suaviosides with isosteviol as skeleton).

FIG. 44 shows a representative chromatogram of RU20, Positive MS 439.

### Example 48. RU Samples, Stevia (GSGs+SGs)-MRP, Stevia(GSGs+SGs)-MRP and Thaumatin: Perception of Acidity and Sweetness in Soft Drinks

Test 1: Lemonade

Aim of this study is to analyze the effectiveness of different sweeteners or flavors to keep the balance between sweetness and acidity in lemonade.

Materials: GRU20-MRP-CA, Lot #EPC-303-56-01, EPC Lab; GRU20-MRP-TA, Lot #EPC-303-56-02, EPC Lab; TRU20, Lot #EPC-303-74-01, EPC Lab; GTRU20, Lot #EPC-303-73-01, EPC Lab; GTRU20-MRP-CA, Lot #EPC-303-59-01, EPC Lab; RU90, Lot #EPC-238-34-03, EPC Lab; GRU90, Lot #EPC-303-89-03, EPC Lab; GRU90-MRP-CA, Lot #EPC-303-91-01, EPC Lab; GRU90-MRP-TA, Lot #EPC-303-91-03, EPC Lab; Stevia(GSGs+SGs)-MRP Caramel, Lot #20190801; Stevia (GSGs+SGs)-MRP Tangerine, Lot #20191205; Stevia(GSGs+SGs)-MRP Caramel+Thaumatin, Lot #2019709; Lemon juice, 100%, Alnatura, VL80311, 20.01.2021 09:33

Experimental procedure: To perform the test a lemonade drink was selected. The 100% direct lemon juice “Alnatura” was diluted 1:5 with water and to the obtained drink 4% of sugar was added. As control sample, a lemonade without the addition of rubusosides, Stevia (GSGs+SGs)-MRP or Stevia (GSGs+SGs)-MRP and Thaumatin, and as test samples, a lemonade with addition of 75 ppm of rubusosides, Stevia (GSGs+SGs)-MRP or Stevia (GSGs+SGs)-MRP and Thaumatin were used. Each sample was sensory evaluated. Sensory evaluation consisted of comparable sweetness, flavor and acidity intensity (each test sample compared to control).

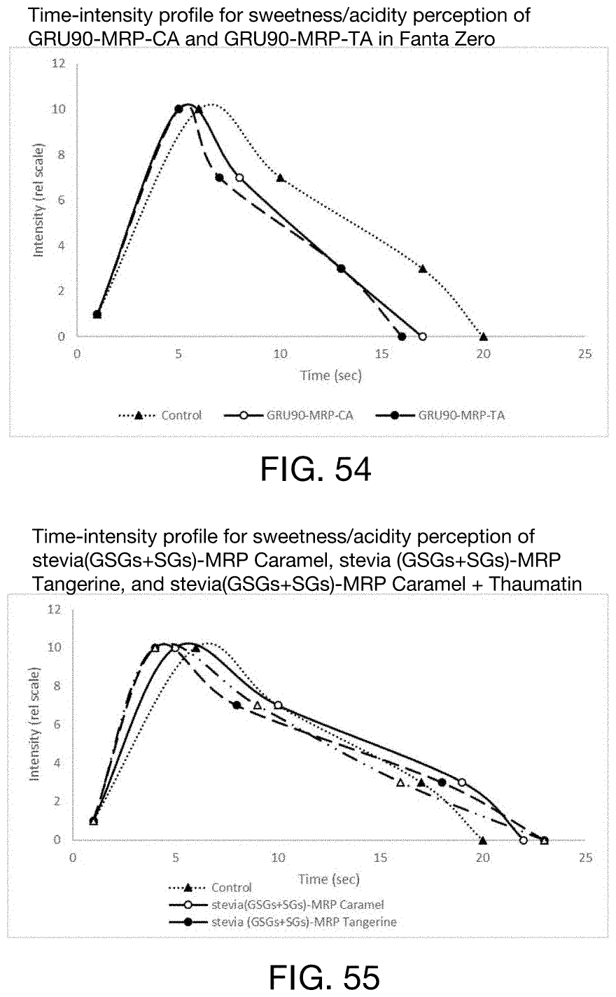

Description of sensory testing: The sensory tests were performed by 5 tasters. The sensory evaluation results are shown in Table 48-1. To evaluate the acidity/sweetness perception the time intensity profiling was separated into 3 phases as shown in FIG. 54.

TABLE 48-1
Sensory evaluation results

| Sample | Flavor | Taste |
|---|---|---|
| Control | Refreshing, citrus, | Very sour, very quick onset of |
| | lemon | acidity, bite, citrus taste, |
| | | strong astringent aftertaste |
| TRU20 | Refreshing, citrus, | Sweeter than reference, herbal |
| | lemon, no | aftertaste, slightly bitter |
| | differences | |
| GTRU20 | Refreshing, citrus, | Less bitter than TRU20, slightly |
| | lemon, no | herbal aftertaste |
| | differences | |
| RU90 | Refreshing, | Quick onset of acidity, not |
| | enhanced citrus | bitter, pleasant sour, mild |
| | flavor | acidic aftertaste |
| GRU90 | Refreshing, | Quick onset of acidity, not |
| | enhanced citrus | bitter, pleasant sour, mild |
| | flavor | acidic aftertaste |
| GRU20- | Refreshing, | Quick onset of acidity, reduced |
| MRP-CA | enhanced citrus | refreshing lemon taste, not |
| | flavor | bitter |
| GRU20- | Refreshing, citrus, | Quick onset of acidity, not |
| MRP-TA | lemon, no | bitter, mild acidic aftertaste |
| | differences | |
| GTRU20- | Refreshing, citrus, | Quick onset of acidity, not |
| MRP-CA | lemon, no | bitter, mild acidic aftertaste |
| | differences | |
| GRU90- | Refreshing, citrus, | Quick onset of acidity, sweeter |
| MRP-CA | lemon, no | than reference, not bitter, mild |
| | differences | acidic aftertaste |
| GRU90- | Refreshing, citrus, | Quick onset of acidity, sweeter |
| MRP-TA | lemon, no | than reference, not bitter, only |
| | differences | sweet, no refreshing lemon taste |
| Stevia(GSGs + | Refreshing, less | Reduced acidity, sweeter than |
| SGs)-MRP | citrus flavor | reference, mild, not bite, very |
| Caramel | | slight caramel aftertaste, |
| | | reduced refreshing lemon taste |
| Stevia(GSGs + | Refreshing, less | Reduced acidity, sweeter than |
| SGs)-MRP | citrus flavor | reference, mild, not bite, |
| Tangerine | | reduced refreshing lemon taste |
| Stevia(GSGs + | Refreshing, citrus, | Reduced acidity, sweeter than |
| SGs)-MRP | lemon, no | reference, mild, not bite, very |
| Caramel and | differences | slight caramel aftertaste, |
| Thaumatin | | noticeable sweet lingering |
| | | aftertaste |

Conclusion: STE, STC, GSTE, GSTC and collectively ST-MRP/G-ST-MRP could improve or change the taste and flavor profile of lemonade juice. Preferably RU90, GRU90, GRU20-MRP-TA, GRU90-MRP-CA, GRU90-MRP-TA are used, due to their substantial improvement of the overall flavor and taste and preference rating of all tasters. Any type of these compositions, such as STE, STC, GSTE, GSTC and collectively ST-MRP/G-ST-MRP or any combination of these compositions could be used in beverage. The added amount could be from 0.1 ppm to 99.9%, preferably from 0.1 ppm to 20,000 ppm.

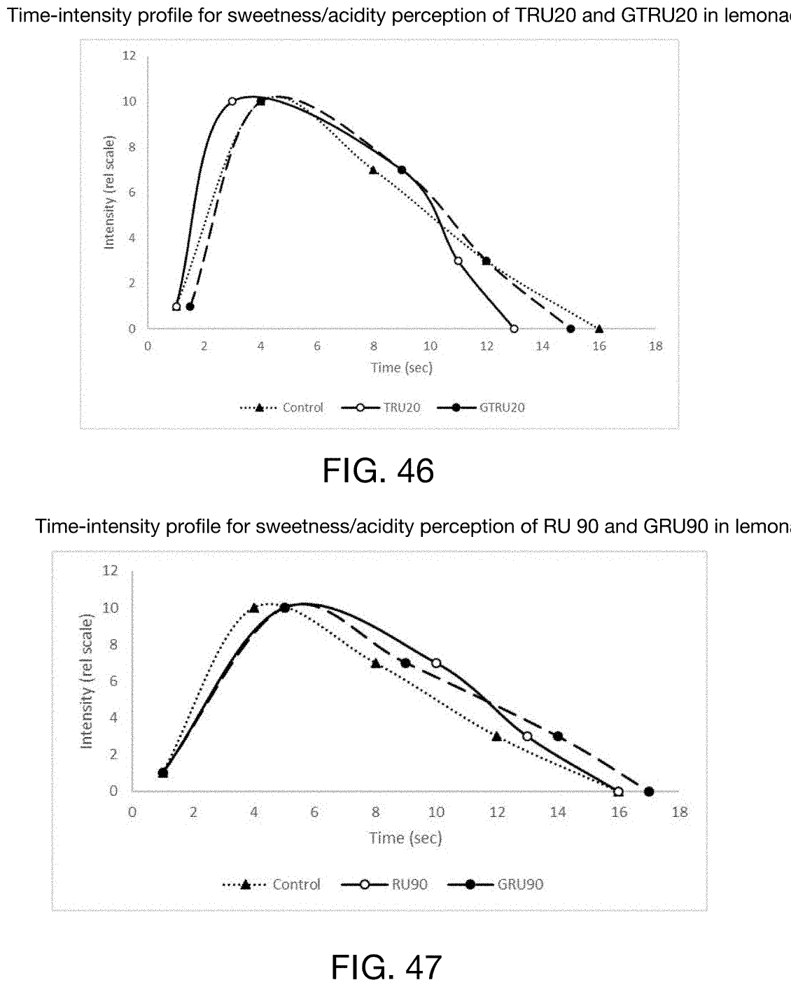

FIG. 46 shows time-intensity profiles for sweetness/acidity perception of TRU20 and GTRU20 in lemonade.

FIG. 47 shows time-intensity profiles for sweetness/acidity perception of RU 90 and GRU90 in lemonade.

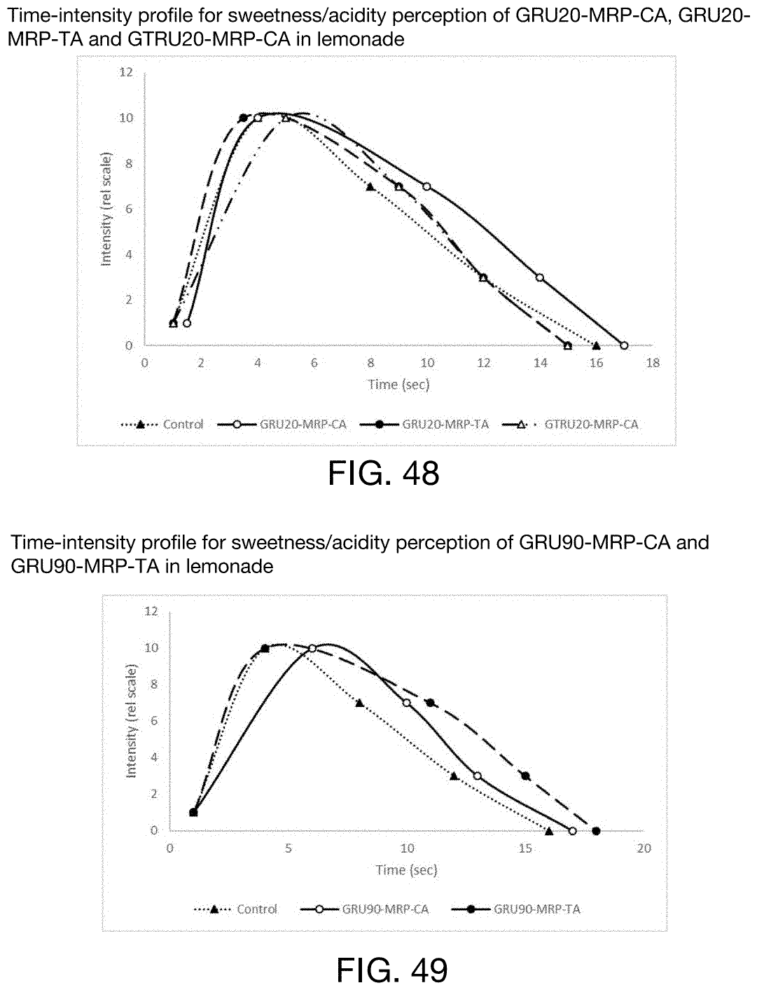

FIG. 48 shows time-intensity profiles for sweetness/acidity perception of GRU20-MRP-CA, GRU20-MRP-TA and GTRU20-MRP-CA in lemonade.

FIG. 49 shows time-intensity profiles for sweetness/acidity perception of GRU90-MRP-CA and GRU90-MRP-TA in lemonade.

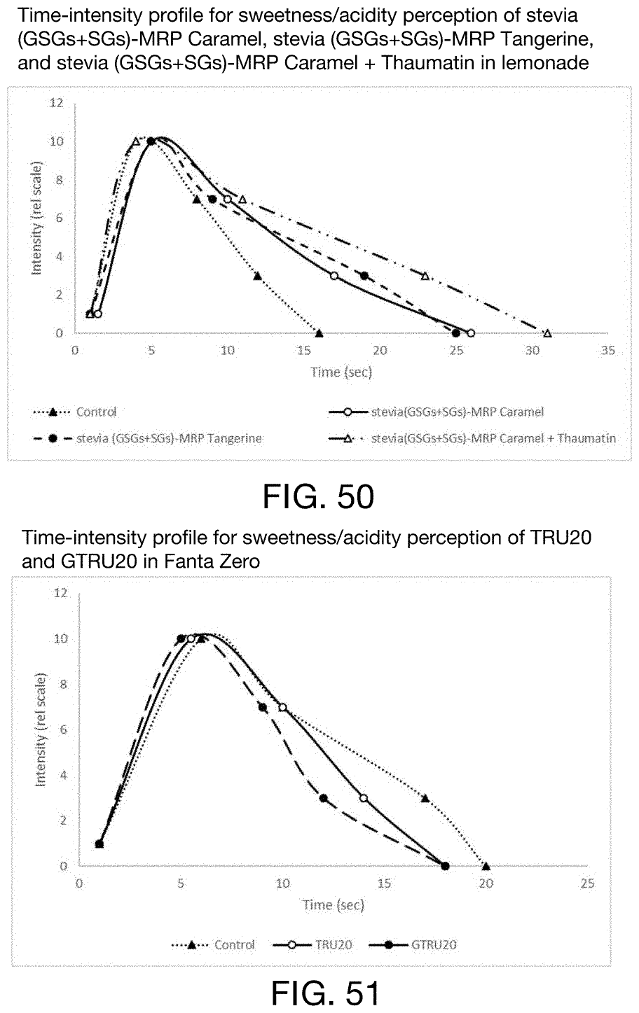

FIG. 50 shows time-intensity profiles for sweetness/acidity perception of stevia (GSGs+SGs)-MRP Caramel, stevia (GSGs+SGs)-MRP Tangerine, and stevia (GSGs+SGs)-MRP Caramel+Thaumatin in lemonade.

Test 2: Fanta Orange Zero Added Sugar

Aim of this study is to analyze the effectiveness of different sweeteners to keep the balance between sweetness and acidity in the soft drink Fanta Orange zero added sugar.

Materials: GRU20-MRP-CA, Lot #EPC-303-56-01, EPC Lab; GRU20-MRP-TA, Lot #EPC-303-56-02, EPC Lab; TRU20, Lot #EPC-303-74-01, EPC Lab; GTRU20, Lot #EPC-303-73-01, EPC Lab; GTRU20-MRP-CA, Lot #EPC-303-59-01, EPC Lab; RU90, Lot #EPC-238-34-03, EPC Lab; GRU90, Lot #EPC-303-89-03, EPC Lab; GRU90-MRP-CA, Lot #EPC-303-91-01, EPC Lab; GRU90-MRP-TA, Lot #EPC-303-91-03, EPC Lab; Stevia (GSGs+SGs)-MRP Caramel, Lot #20190801; Stevia (GSGs+SGs)-MRP Tangerine, Lot #20191205; Stevia(GSGs+SGs)-MRP Caramel+Thaumatin, Lot #2019709; Fanta Orange zero added sugar, L05Z 05:44 RA, 05.06.2020.

Experimental procedure: Fanta Orange zero added sugar is a calorie-free orange flavored soft drink sweetened with sodium cyclamate, Ace-K and sucralose, steviol glycoside and NHDC. As acidifier, citric acid and malic acid were used. As control sample, a Fanta Orange zero added sugar without the addition of rubusosides, Stevia(GSGs+SGs)-MRP or Stevia(GSGs+SGs)-MRP and Thaumatin, and as test samples, a Fanta Orange zero added sugar with addition of 75 ppm of rubusosides, Stevia(GSGs+SGs)-MRP or Stevia(GSGs+SGs)-MRP and Thaumatin were used. Each sample was sensory evaluated. Sensory evaluation consisted of comparable sweetness and flavor intensity (each sample compared to control).

TABLE 48-2
Sensory evaluation results

| Sample | Flavor | Taste |
|---|---|---|
| Control | Refreshing, fruity, | Medium sweet lingering |
| | orange | aftertaste, sticky |
| TRU20 | Less fruity flavor | Unpleasant herbal aftertaste, |
| | | inharmonious |
| GTRU20 | Refreshing, fruity, | Only sweet, not well balanced, |
| | orange, no | very-very slight herbal aftertaste |
| | differences | |
| RU90 | Refreshing, fruity, | Harmonized sweet and sour, no |
| | orange, no | artificial aftertaste, slightly |
| | differences | sweet lingering aftertaste |
| GRU90 | Refreshing, fruity, | Harmonized sweet and sour, no |
| | orange, no | artificial aftertaste, slightly |
| | differences | sweet lingering aftertaste |
| GRU20- | Refreshing, fruity, | Very slight bitter aftertaste |
| MRP-CA | orange, no | |
| | differences | |
| GRU20- | Refreshing, fruity, | More intensive fruity taste, slight |
| MRP-TA | orange, no | lingering aftertaste, well balanced |
| | differences | sweet and sour |
| GTRU20- | Refreshing, fruity, | Very slight bitter aftertaste |
| MRP-CA | orange, no | |
| | differences | |
| GRU90- | Refreshing, fruity, | Enhanced fruity taste, reduced |
| MRP-CA | orange, no | lingering aftertaste, well balanced |
| | differences | sweet and sour taste |
| GRU90- | Refreshing, fruity, | Enhanced fruity taste, reduced |
| MRP-TA | orange, no | lingering aftertaste, well balanced |
| | differences | sweet and sour taste |
| Stevia(GSGs + | Refreshing, fruity, | Very sweet, fruity, not sour, |
| SGs)-MRP | orange, no | slightly sweet lingering aftertaste |
| Caramel | differences | |
| Stevia(GSGs + | Refreshing, fruity, | Very sweet, fruity, not sour, |
| SGs)-MRP | orange, no | slightly sweet lingering aftertaste |
| Tangerine | differences | |
| Stevia(GSGs + | Refreshing, fruity, | Very sweet, fruity, not sour, |
| SGs)-MRP | orange, no | slightly sweet lingering aftertaste |
| Caramel and | differences | |
| Thaumatin | | |

FIG. 51 shows time-intensity profiles for sweetness/acidity perception of TRU20 and GTRU20 in Fanta Orange zero added sugar.

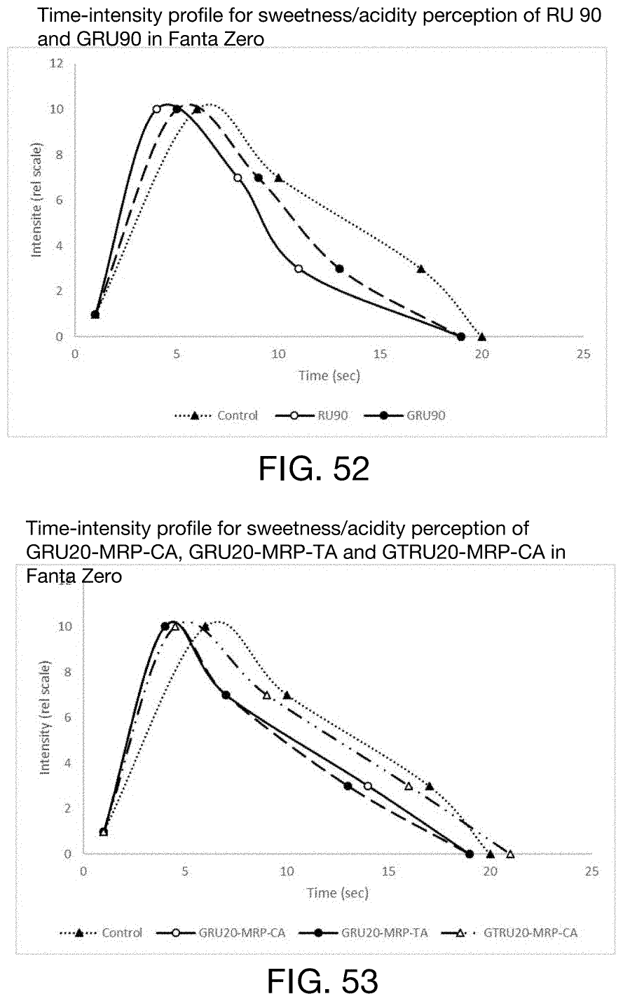

FIG. 52 shows time-intensity profiles for sweetness/acidity perception of RU 90 and GRU90 in Fanta Orange zero added sugar.

FIG. 53 shows time-intensity profiles for sweetness/acidity perception of GRU20-MRP-CA, GRU20-MRP-TA and GTRU20-MRP-CA in Fanta Orange zero added sugar.

FIG. 54 shows time-intensity profiles for sweetness/acidity perception of GRU90-MRP-CA and GRU90-MRP-TA in Fanta Orange zero added sugar.

FIG. 55 shows time-intensity profile for sweetness/acidity perception of stevia(GSGs+SGs)-MRP Caramel, stevia (GSGs+SGs)-MRP Tangerine, and stevia(GSGs+SGs)-MRP Caramel+Thaumatin.

Conclusion: STE, STC, GSTE, GSTC, ST-MRPs and stevia (GSGs+SGs)-MRPs could improve or change the taste and flavor profile of sugar free or sugar reduced beverage. Preferably RU90, GRU90, GRU20-MRP-TA, GRU90-MRP-CA, GRU90-MRP-TA are used, due to their substantial improvement of the overall flavor and taste and preference rating of all tasters. Any type of these compositions such as STE, STC, GSTE, GSTC, ST-MRPs, stevia (GSGs+SGs)-MRPs or any combination of these compositions could be used in a beverage. The added amount could be from 0.1 ppm to 99.9% by weight, preferably from 0.1 ppm to 20,000 ppm.

### Example 49. Applications with RU Samples

In the following applications the following RU samples were used: RU20, Lot #STL02-151005, EPC Lab; GRU20, Lot #EPC-303-89-03, EPC Lab; RU90, Lot #EPC-238-34-03, EPC Lab; GRU90, Lot #EPC-303-89-03, EPC Lab; GTRU20-MRP-HO, Lot #EPC-303-59-02, EPC Lab; GRU90-MRP-HO, Lot #EPC-303-91-01, EPC Lab; GRU20-MRP-CA, Lot #EPC-303-56-01, EPC Lab; GTRU20-MRP-CA, Lot #EPC-303-59-01, EPC Lab; GRU90-MRP-CA, Lot #EPC-303-91-01, EPC Lab

Sensory evaluation: Before tasting the tasters are discussing the upcoming series of samples and taste regular samples (without added flavour) to find a common sense of the description. Thereafter the flavored samples were tasted at the use level to find a common sense on how to describe the flavors (taste, smell, intensity). Five trained tasters were tasting blinded and independently all samples of a series. They were allowed to re-taste and are making notes for the sensory attributes perceived. In the last step the attributes noted were discussed openly to find a compromise description. In case that more than 1 taster disagrees with the compromise, the tasting was repeated.

Application 1: Sugar Free Energy Drink (Commercial Sample)

Materials: RedBull sugar free, M23C5, PR:02.02.2020/23:35 NO, EX: 02.02.21/1803976.

Test design: To evaluate the taste profile of RU samples a commercial sugar free energy drink (250 ml can, Brand: Red Bull, sweetened with acesulfame K and aspartame) was used. As control sample, a RedBull sugar free without the addition of RU samples, and as test sample, a RedBull sugar free with RU samples were used.

Results:

TABLE 49-1
Sensory evaluation results

| | | Concentration | |
|---|---|---|---|
| Sample | Sweetener | [ppm] | Sensory evaluation |
| Reference | — | — | Aggressive artificial aftertaste, |
| sample | | | strong lingering aftertaste, |
| | | | metallic, dry mouth-feeling |
| Test | RU20 | 50 | Dry mouth-feeling, scratchy, |
| sample | | | less lingering, herbal aftertaste |
| | RU90 | 50 | Cleaner taste, quicker onset of |
| | | | sweetness, reduced lingering |
| | | | aftertaste, a little bit sweeter, |
| | | | fruity, less sour |
| | GRU20 | 50 | Clean taste, round and smooth |
| | | | mouth-feeling, no lingering |
| | | | aftertaste, pleasant sour |
| | GRU90 | 50 | Sweeter, not sour, a little bit |
| | | | longer lingering compared to |
| | | | GRU20. |
| | GTRU20- | 50 | Clean taste, reduced lingering |
| | MRP-HO | | aftertaste, round and smooth |
| | | | mouth-feeling, no metallic |
| | | | aftertaste |
| | GRU90- | 50 | Smoother mouth-feeling |
| | MRP-HO | | compared to reference, no |
| | | | metallic aftertaste, noticeable |
| | | | flowery aftertaste, medium |
| | | | lingering aftertaste |

(1) GTRU20-MRP-HO, (2) GRU90-MRP-HO both due to substantial improvement of the overall smell and taste and preference rating of all tasters.

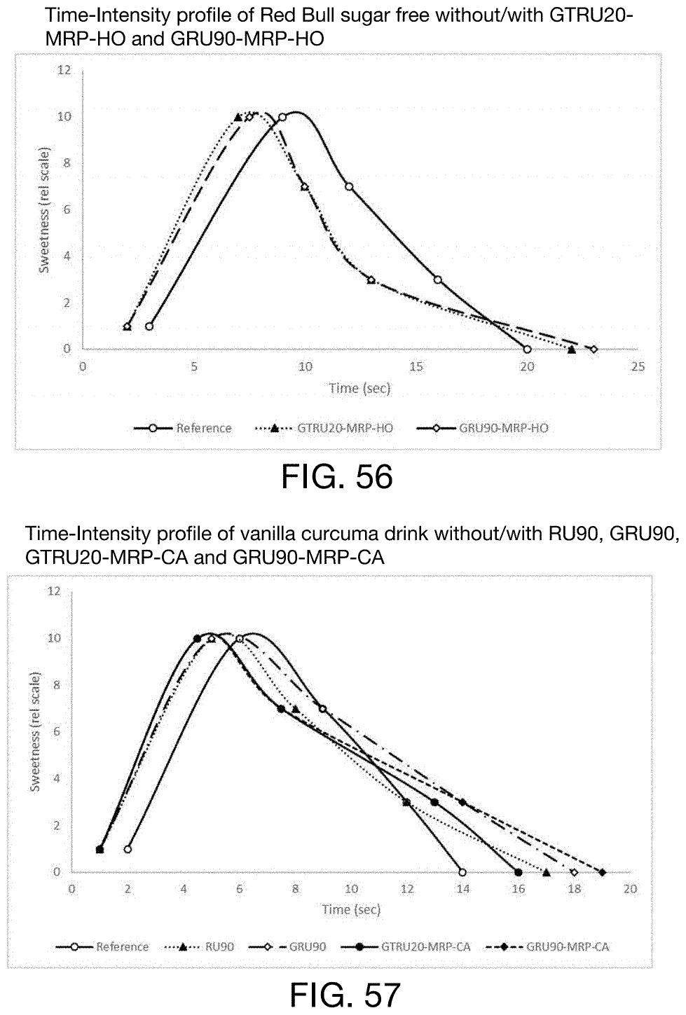

FIG. 56 shows time-intensity profiles of RedBull sugar free without/with GTRU20-MRP-HO and GRU90-MRP-HO.

Application 2: Flavored Milk Beverage (Commercial Sample)

Materials: Vanille Kurkuma Drink, 30% less sugar, without sweeteners, S9170 23.03.20 14:41, Schärdinger.

Test design: To evaluate the taste profile of RU samples a commercial flavored vanilla curcuma drink (500 g bottle, Brand: Schärdinger, 30% less sugar, sweetened with sugar, without artificial sweeteners) was used. As reference sample, a vanilla curcuma drink without the addition of RU samples, and as test sample, a vanilla curcuma drink with RU samples were used.

TABLE 49-2
Sensory evaluation results

| | | Concentration | |
|---|---|---|---|
| Sample | Sweetener | [ppm] | Sensory evaluation |
| Reference | — | — | Watery mouth-feeling, not |
| sample | | | enough sweet, spicy, turmeric |
| | | | aftertaste |
| Test | RU20 | 100 | Bitter, herbal aftertaste, |
| sample | | | unpleasant |
| | RU90 | 100 | Quicker onset of sweetness, |
| | | | smoother mouth-feeling, sweeter |
| | | | than reference, spicy, turmeric |
| | | | aftertaste, not bitter |
| | GRU20 | 100 | Bitter, herbal aftertaste, |
| | | | unpleasant |
| | GRU90 | 100 | Quicker onset of sweetness, |
| | | | smoother mouth-feeling, |
| | | | enhanced sweetness, spicy, |
| | | | enhanced flavor, not bitter |
| | GTRU20- | 100 | Quicker onset of sweetness, |
| | MRP-CA | | smoother mouth-feeling, a little |
| | | | bit sweeter than reference, spicy, |
| | | | enhanced flavor, not bitter, |
| | | | slight caramel aftertaste, |
| | | | pleasant |
| | GRU90- | 100 | Quicker onset of sweetness, |
| | MRP-CA | | smoother mouth-feeling, |
| | | | enhanced sweetness, spicy, |
| | | | enhanced flavor, not bitter, |
| | | | slight caramel aftertaste, |
| | | | pleasant |

(1) RU90, (2) GRU90, (3) GTRU20-MRP-CA, (4) GRU90-MRP-CA all due to substantial improvement of the overall smell and taste and preference rating of all tasters.

FIG. 57 shows time-intensity profiles of vanilla curcuma drink without/with RU90, GRU90, GTRU20-MRP-CA and GRU90-MRP-CA.

Application 3. Flavored Milk Beverage (Commercial Sample)

Materials: Chocolate drink, 30% less sugar, without sweeteners, S9148 12.04.2020, 07:27, Schärdinger.

Test design: To evaluate the taste profile of RU samples a commercial flavored chocolate milk drink (500 g bottle, Brand: Schärdinger, 30% less sugar, sweetened with sugar, without artificial sweeteners) was used. As reference sample, a chocolate drink without the addition of RU samples, and as test sample, a chocolate drink with RU samples were used.

TABLE 49-3
Sensory evaluation results

| | | Concentration | |
|---|---|---|---|
| Sample | Sweetener | [ppm] | Sensory evaluation |
| Reference | — | — | Watery mouth-feeling, not |
| sample | | | enough sweet, chocolate flavor, |
| | | | chocolate taste |
| Test | RU20 | 100 | Bitter, herbal aftertaste, |
| sample | | | unpleasant |
| | RU90 | 100 | Creamier mouth-feeling, sweeter |
| | | | than reference, smoother, |
| | | | pleasant chocolate flavor, not |
| | | | bitter |
| | GRU20 | 100 | Bitter, herbal aftertaste, |
| | | | unpleasant |
| | GRU90 | 100 | Creamier mouth-feeling, sweeter |
| | | | than reference, smoother, |
| | | | pleasant chocolate flavor, not |
| | | | bitter |
| | GTRU20- | 100 | Creamier mouth-feeling, sweeter |
| | MRP-CA | | than reference, smoother, |
| | | | pleasant chocolate flavor, not |
| | | | bitter |
| | GRU90- | 100 | Creamier mouth-feeling, sweeter |
| | MRP-CA | | than reference, smoother, |
| | | | pleasant chocolate flavor, not |
| | | | bitter |

(1) RU90, (2) GRU90, (3) GTRU20-MRP-CA, (4) GRU90-MRP-CA all due to substantial improvement of the overall smell and taste and preference rating of all tasters.

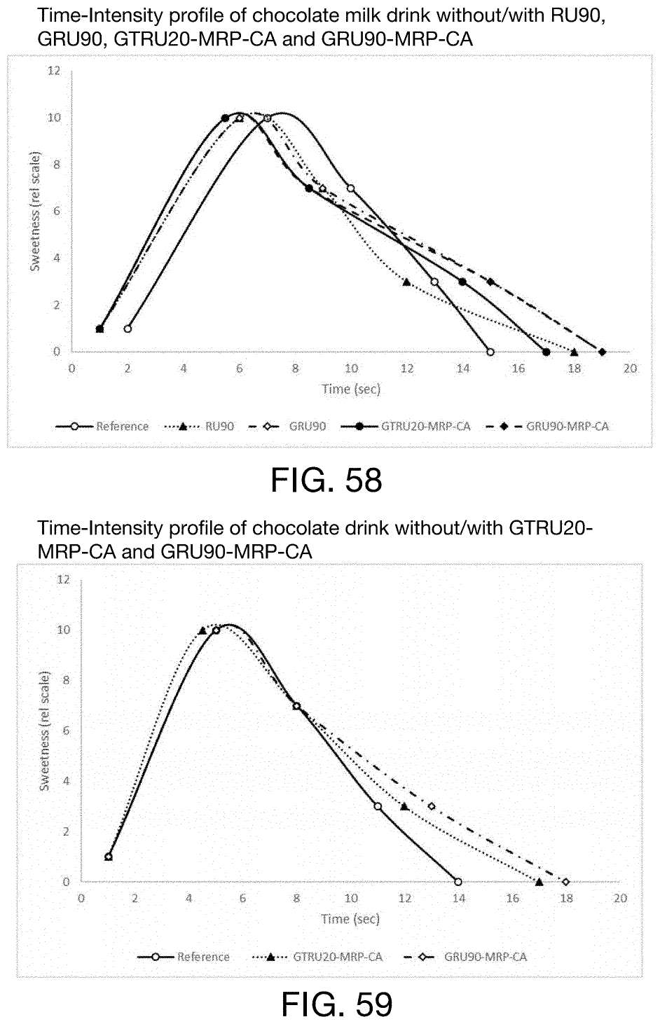

FIG. 58 shows time-intensity profiles of chocolate milk drink without/with RU90, GRU90, GTRU20-MRP-CA and GRU90-MRP-CA.

Application 4: Sugar Reduced Peach Flavored Iced Tea (Laboratory Sample)

Materials: Black tea extract, kwl, Ref. Nr: K245856; 27102 Citric acid monohydrates gritty, puriss, Lot 60960, Riedel-de Haën; 01602636 Peach Aroma, Akras Flavours GmbH.

TABLE 49-4
Test design of basic iced tea recipe

| | | 100% sugar | 75% sugar |
|---|---|---|---|
| Ingredients | | Reference sample | Test sample |
| Black tea extract | [g/L] | 2 | 2 |
| Sucrose | [g/L] | 70 | 52.5 |
| 01602636 Peach flavor | [μl/L] | 100 | 100 |
| Citric acid monohydrate | [g/L] | 1.5 | 1.5 |

TABLE 49-5
Sensory evaluation results

| | | Concentration | |
|---|---|---|---|
| Sample | Sweetener | [ppm] | Sensory evaluation |
| Reference | — | — | Pleasant sweet and sour taste, |
| (100% | | | pleasant peach flavor, only |
| sugar) | | | sweet |
| Test | — | — | Thin, watery mouth-feeling, |
| sample | | | not enough sweet |
| (75% | RU20 | 400 | Herbal, bitter aftertaste, |
| sugar) | | | unpleasant |
| | RU90 | 200 | Same sweet as reference, |
| | | | slight lingering aftertaste, |
| | | | pleasant sour, less peach |
| | | | flavor |
| | GRU20 | 400 | Herbal, bitter aftertaste, |
| | | | unpleasant |
| | GRU90 | 200 | Sweeter than reference, less |
| | | | sour, very slight lingering |
| | | | aftertaste, dry mouth-feeling |
| | GRU20- | 400 | Same sweet as reference, but |
| | MRP-CA | | with a strong caramel |
| | | | aftertaste |
| | GTRU20- | 400 | Same sweet as reference, no |
| | MRP-CA | | caramel aftertaste, no |
| | | | lingering aftertaste |
| | GRU90- | 200 | Same sweet as reference, no |
| | MRP-CA | | caramel aftertaste, no |
| | | | lingering aftertaste |

(1) GTRU20-MRP-CA, (2) GRU90-MRP-CA both due to substantial improvement of the overall smell and taste and preference rating of all tasters.

FIG. 59 shows time-intensity profiles of chocolate drink without/with GTRU20-MRP-CA and GRU90-MRP-CA.

Application 5: Sugar Free Peach Flavored Iced Tea (Laboratory Sample)

Materials: Black tea extract, kwl, Ref. No: K245856; 27102 Citric acid monohydrate gritty, puriss, Lot 60960, Riedel-de Haën; 01602636 Peach Aroma, Akras Flavours GmbH; Acesulfame K, Lot #LRAA9064, Sigma Aldrich; Aspartame, Lot #LRAAB3060, Sigma Aldrich.

TABLE 49-6
Test design of basic iced tea sugar free recipe

| | | Sugar free | Sugar free |
|---|---|---|---|
| Ingredients | | reference sample | test sample |
| Black tea extract | [g/L] | 2 | 2 |
| Acesulfame K | [mg/L] | 100 | 85 |
| Aspartame | [mg/L] | 100 | 85 |
| 01602636 Peach flavor | [μl/L] | 100 | 100 |
| Citric acid monohydrate | [g/L] | 1.5 | 1.5 |

TABLE 49-7
Results of sensory evaluation results

| | | Concentration | |
|---|---|---|---|
| Sample | Sweetener | [ppm] | Sensory evaluation |
| Reference | — | — | Dry mouth-feeling, slight |
| sample | | | lingering aftertaste |
| Test | RU20 | 150 | Very dry mouth-feeling, |
| sample | | | herbal bitter aftertaste, |
| | | | unpleasant |
| | RU90 | 150 | Less bitter than RU 20, |
| | | | sweeter than reference, dry |
| | | | mouth-feeling |
| | GRU20 | 150 | A little bit bitter, dry |
| | | | mouth-feeling, no lingering |
| | | | aftertaste |
| | GRU90 | 150 | Enhanced overall taste |
| | | | compared to reference, not |
| | | | bitter, smoother, no |
| | | | lingering aftertaste |
| | GRU20- | 150 | Reduced lingering aftertaste, |
| | MRP-CA | | smoother, no metallic |
| | | | aftertaste |
| | GTRU20- | 150 | Reduced lingering aftertaste, |
| | MRP-CA | | smoother, no metallic |
| | | | aftertaste |
| | GRU90- | 150 | Sweeter than reference, no |
| | MRP-CA | | lingering aftertaste, enhanced |
| | | | peach flavor |

(1) GRU90, (2) GRU20-MRP-CA, (3) GTRU20-MRP-CA (4) GRU90-MRP-CA all due to substantial improvement of the overall smell and taste and preference rating of all tasters.

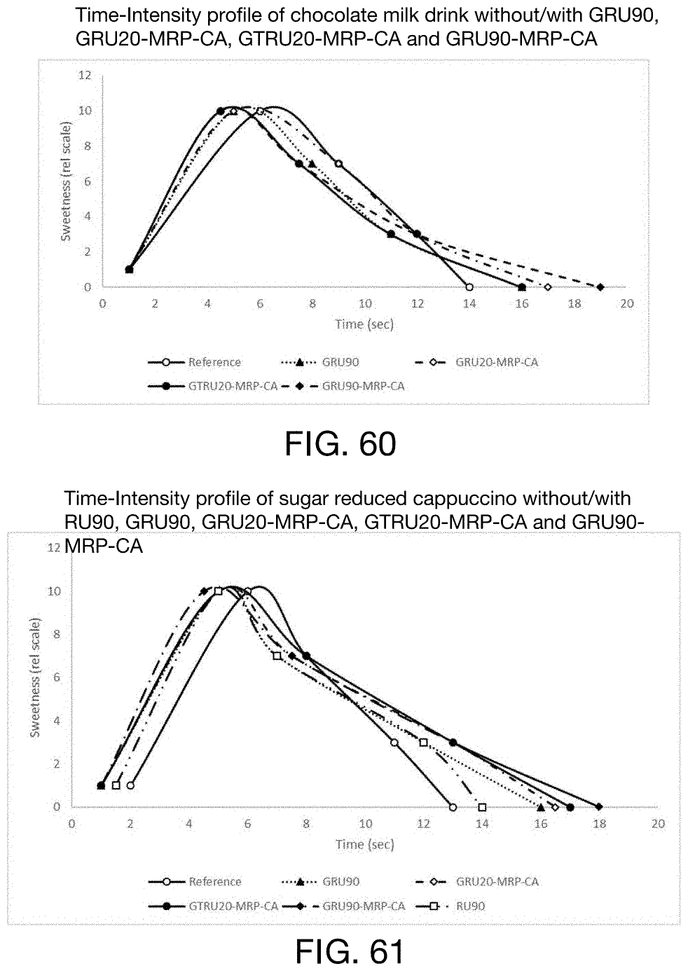

FIG. 60 shows time-intensity profiles of chocolate milk drink without/with GRU90, GRU20-MRP-CA, GTRU20-MRP-CA or GRU90-MRP-CA.

Application 6: Sugar Reduced Ice Cappuccino (Laboratory Sample)

Materials: Dried skimmed milk powder, Artikel Nr.: 2230049/PZN:09090890, 219300491, 30.05.2020; Instant Coffee Nescafe Type Espresso, 100% Arabica, 43876240-100143829, 02 2021 17:04 90440814C3.

TABLE 49-8
Test design of basic ice cappuccino recipe

| | | 100% sugar | 75% sugar |
|---|---|---|---|
| Ingredients | | Reference sample | Test sample |
| Powder coffee | [g/L] | 10 | 10 |
| Milk powder | [g/L] | 50 | 50 |
| Powdered sugar | [g/L] | 40 | 30 |

TABLE 49-9
Sensory evaluation results

| Sample | Sweetener | Concentration [ppm] | Sensory evaluation |
|---|---|---|---|
| Reference sample | — | — | Coffee-like aftertaste, very slight |
| (100% sugar) | | | bitter, smooth, pleasant sweet |
| Test sample | — | — | Watery mouth-feeling, not enough |
| (75% sugar) | | | sweet, slight bitter |
| | RU20 | 600 | Very bitter, herbal aftertaste, |
| | | | unpleasant |
| | RU90 | 300 | Sweeter than reference, less bitter, |
| | | | no herbal aftertaste, no lingering |
| | GRU20 | 600 | Bitter, herbal aftertaste, unpleasant |
| | GRU90 | 250 | Pleasant sweet, less bitter than |
| | | | reference, no lingering aftertaste |
| | GRU20-MRP-CA | 600 | Almost same sweet as reference, |
| | | | no lingering, smooth mouth-feeling |
| | GTRU20-MRP-CA | 600 | Almost same sweet as reference, |
| | | | no lingering, smooth mouth-feeling |
| | GRU90-MRP-CA | 300 | A little bit sweeter than reference, |
| | | | smooth mouth-feeling, no |
| | | | lingering aftertaste |

(1) RU90, (2) GRU90, (3) GRU20-MRP-CA, (4) GTRU20-MRP-CA, (5) GRU90-MRP-CA all due to substantial improvement of the overall smell and taste and preference rating of all tasters.

FIG. 61 shows time-intensity profiles of sugar reduced cappuccino without/with RU90, GRU90, GRU20-MRP-CA, GTRU20-MRP-CA and GRU90-MRP-CA.

Application 7: Sugar Free Ice Cappuccino (Laboratory Sample)

Materials: Dried skimmed milk powder, Artikel Nr.: 2230049/PZN:09090890, 219300491, 30.05.2020; Instant Coffee Nescafe Type Espresso, 100% Arabica, 43876240-100143829, 02 2021 17:04 90440814C3.

TABLE 49-10
Test design of basic sugar free ice cappuccino recipe

| | | Sugar free | Sugar free |
|---|---|---|---|
| Ingredients | | reference sample | test sample |
| Powder coffee | [g/L] | 10 | 10 |
| Milk powder | [g/L] | 50 | 50 |
| Sodium cyclamate | [mg/L] | 180 | 170 |
| Saccharin | [mg/L] | 60 | 50 |

TABLE 49-11
Sensory evaluation results

| Sample | Sweetener | Concentration [ppm] | Sensory evaluation |
|---|---|---|---|
| Reference | — | — | Similar sweet to reference sample |
| sample | | | sweetened with sugar, slight bitter |
| | | | aftertaste, slight lingering, metallic |
| Test | — | — | Watery mouth feeling, not |
| sample | | | enough sweet, metallic aftertaste |
| | RU20 | 150 | Very bitter, herbal aftertaste, |
| | | | unpleasant |
| | RU90 | 120 | Similar sweet and less bitter than |
| | | | reference, no herbal aftertaste, |
| | | | smoother mouth-feeling, no |
| | | | metallic aftertaste |
| | GRU20 | 150 | Bitter, herbal aftertaste, |
| | | | unpleasant |
| | GRU90 | 120 | Pleasant sweet, similar sweet as |
| | | | reference, less bitter, smoother |
| | | | mouth-feeling, not metallic |
| | GRU20-MRP-CA | 200 | Same sweet as reference, less |
| | | | bitter, smoother mouth-feeling, |
| | | | no metallic aftertaste |
| | GTRU20-MRP-CA | 200 | Same sweet as reference, less |
| | | | bitter, smoother mouth-feeling, |
| | | | no metallic aftertaste |
| | GRU90-MRP-CA | 120 | Same sweet as reference, less |
| | | | bitter, smoother mouth-feeling, |
| | | | slight caramel aftertaste |

(1) RU90, (2) GRU90, (3) GRU20-MRP-CA, (4) GTRU20-MRP-CA, (5) GRU90-MRP-CA all due to substantial improvement of the overall smell and taste and preference rating of all tasters.

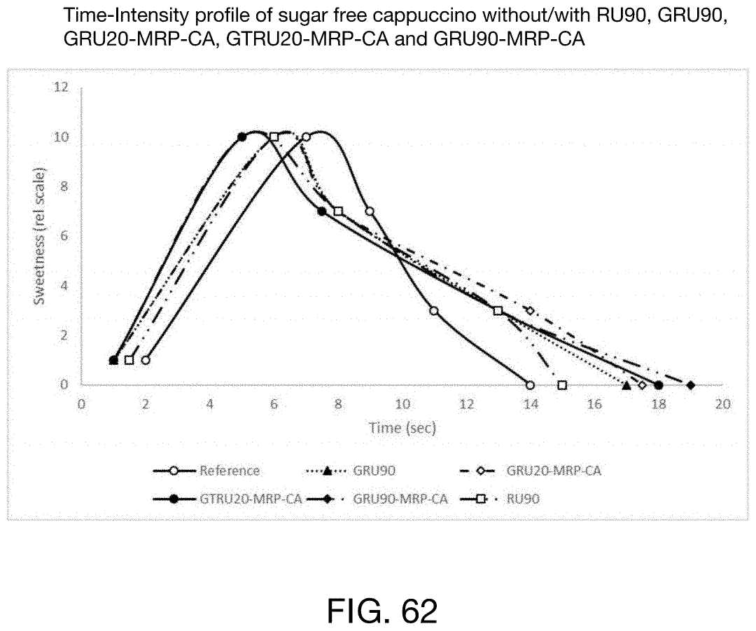

FIG. 62 shows time-intensity profiles of sugar free cappuccino without/with RU90, GRU90, GRU20-MRP-CA, GTRU20-MRP-CA and GRU90-MRP-CA.

Conclusion: Different composition of sweet tea extract has different taste and flavor effect on beverage such as energy drinks, flavored milk beverages, flavored teas, flavored coffee drinks. G-STE, GSTC, STE-MRP, STC-MRP, G-STE-MRP and G-STC-MRP could significantly improve the taste profile and palatability of beverage. The added amount calculated based on pure rubusoside content in food and beverage could be in extended to the range of 1-10,000 ppm, preferably in the range of 5-5,000 ppm, more preferably in the range of 5-3,000 ppm. In some embodiments, G-STE, GSTC, STE-MRP, STC-MRP, G-STE-MRP and/or G-STC-MRP are added at a final concentration of 10-2,000 ppm, 10-1,000 ppm, 10-500 ppm, 10-200 ppm, 10-100 ppm, 10-50 ppm, 20-2,000 ppm, 20-1,000 ppm, 20-500 ppm, 20-200 ppm, 20-100 ppm, 20-50 ppm, 50-2,000 ppm, 50-1,000 ppm, 50-500 ppm, 50-200 ppm, 50-100 ppm, 100-2,000 ppm, 100-1,000 ppm, 100-500 ppm, 100-200 ppm, 200-2,000 ppm, 200-1,000 ppm, 200-500 ppm, 500-2,000 ppm, 500-1,000 ppm or 1000-2000 ppm.

### Example 50. Preparation of Glycosylated Rubusoside 10% (GRU10)

Materials: Rubusoside 10% (Name of producer: Guilin Layin Natural Ingredients Corp., content of Ru: 11.66%, Lot #STL12-20011602).

A glycosylated reaction product was prepared using Rubusoside 10% (RU10) by the followed method:

(i) 10 g dextrin (BAOLINGBAO BIOLOGY Co., Ltd., Lot #16052872) was dissolved in 100 ml deionized water

(ii) 10 g RU10 was added to liquefied dextrin.

(iii) 0.5 ml CGTase enzyme (Amano Enzyme, Inc., Lot #CGTN0450202SLK activity: 476 u/mL) was added to mixture and incubated at 69° C. for 20 hours to glycosylate the RU10 with glucose molecules derived from Tapioca dextrin.

(v) The reaction mixture was heated to 85° C. for 10 min to inactivate the CGTase, which was then removed by filtration.

(vi) The resulting solution comprises glycosylated Rubusoside, residual RU and dextrin were decolored and spray dried, thereby yielding 17 g of GRU10 as a white powder. The final product contains glycosylated rubusoside, glycosylated non-sweet glycosides, residue of unreacted sweet tea extract components, and residue of unreacted dextrin.

### Example 51. Preparation of Flavored GRU10-MRP-CA from GRU10, Alanine and Xylose or Fructose

GRU10: the product of Ex. 50.

Procedure: GRU10, alanine, xylose or fructose and water were weighed as described in Table 51-1 and then mixed. The resulting solution was then heated at about 100° C. for 2 hours. When the reaction was completed, the reaction mixture was filtered through filter paper and the filtrate was dried with a spray dryer, thereby obtained off white powder named as 51-01 and 51-02, respectively. The final product contains Maillard reacted products, glycosylated sweet tea extract, residue of sweet tea extract, residue of dextrin, and residue of unreacted alanine, xylose and fructose.

TABLE 51-1
Sample composition

| | Weight | Weight | Weight | Weight of | Weight |
|---|---|---|---|---|---|
| Product | of GRU10 | of xylose | of fructose | glutamic acid | of water |
| No. | (g) | (g) | (g) | (g) | (g) |
| 51-01 | 6 | 3 | | 1 | 5 |
| 51-02 | 6 | | 3 | 1 | 5 |

### Example 52. Preparation of Flavored GRU10-MRP-FTA from GRU10, Glutamic Acid and Fructose

GRU10: the product of Ex. 50.

Procedure: GRU10, fructose, glutamic acid and water were weighed as described in Table 47-1 and then mixed. The solution was then heated at about 100° C. for 1.5 hours. When the reaction was completed, the solution was filtered through filter paper and the filtrate was dried with a spray dryer, thereby obtained off white powder named as 52-01 and 52-02, respectively. The final product contains glycosylated sweet tea extract, residue of sweet tea extract, residue of dextrin, residue of unreacted glutamic acid and fructose.

TABLE 52-1
Sample composition

| | Weight | Weight | Weight of | Weight |
|---|---|---|---|---|
| Product | of GRU10 | of fructose | glutamic acid | of water |
| No. | (g) | (g) | (g) | (g) |
| 52-01 | 9 | 0.5 | 0.5 | 5 |
| 52-02 | 6 | 3.696 | 0.308 | 5 |

### Example 53. Evaluation of the Taste Profiles of GRU10-MRP-CA and GRU10-MRP-FTA in a Sugar Reduction System

Materials: RU10 (Guilin Layin Natural Ingredients Corp. The content of RU is 11.66% Lot #STL12-20011602); GRU10-MRP-CA, products 51-01, 51-02 of Ex. 51; GRU10-MRP-FTA, products 52-01, 52-02 of Ex. 52.

Preparation of sample solutions: RU10, GRU10-MRP-CA (51-01, 51-02), GRU10-MRP-FTA (52-01, 52-02) and 6.5% sugar solution were mixed according to the weights shown in Table 53-1 below.

TABLE 53-1
Sample composition

| | | Volume of | | Sugar |
|---|---|---|---|---|
| | Weight | 6% sugar | Concentration | concentration |
| Components | (mg) | solution | (ppm) | (%) |
| RU10 | 18 | 100 ml | 180 | 6.5 |
| Product 51-01 | 60 | | 600 | 6.5 |
| Product 51-02 | 60 | | 600 | 6.5 |
| Product 52-01 | 40 | | 400 | 6.5 |
| Product 52-02 | 60 | | 600 | 6.5 |

Evaluation: The samples were evaluated according to the sensory evaluation methods in Ex. 5. Each panelist was asked to evaluate by his/her preference on six aspects—flavor, sweetness onset, sweet lingering, mouth feel, bitterness and overall likability. It should be noted that according to the sensory evaluation methods herein, the evaluations of mouth feel, sweetness onset, sweet lingering, bitterness and overall likability are based on the iso-sweetness 8% SugarE. The evaluation results are shown in Table 53-2. Further, each person of the test panel tasted the products in this example and time-intensity curves were generated from the sensory results as shown in Table 53-3.

TABLE 53-2
Taste profiles of RU10, GRU10-MRP-CA (51-01, 51-02) and
GRU10-MRP-FTA (52-01, 52-02) in sugar reduction system.

| | | Overall | Mouth | Sweet | | Bitterness |
|---|---|---|---|---|---|---|
| Sample | Flavor | likability | feel | lingering | Bitterness | lingering |
| RU10 | Herb | 2 | 1.5 | 3.5 | 5 | 4 |
| Product 51-01 | Caramel | 4 | 3.5 | 3 | 2 | 2.5 |
| Product 51-02 | Caramel | 4.5 | 3.8 | 2 | 1.5 | 1.5 |
| Product 52-01 | Herb | 4.2 | 3 | 2.5 | 2.5 | 2.5 |
| Product 52-02 | Herb | 4.6 | 4.2 | 1.5 | 2 | 2 |

TABLE 53-3
Sweetness profile data of the products in Ex. 53.

| Product | ONSET | MAX | LINGERING ON | LINGERING OFF |
|---|---|---|---|---|
| No. | [sec] | [sec] | [sec] | [sec] |
| RU10 | 1.5 | 4 | 8 | 18 |
| Product 51-01 | 1 | 3 | 7 | 15 |
| Product 51-02 | 0.5 | 2.5 | 6 | 13 |
| Product 52-01 | 1.2 | 3.5 | 6 | 13.5 |
| Product 52-02 | 0.7 | 2.8 | 5.5 | 10 |

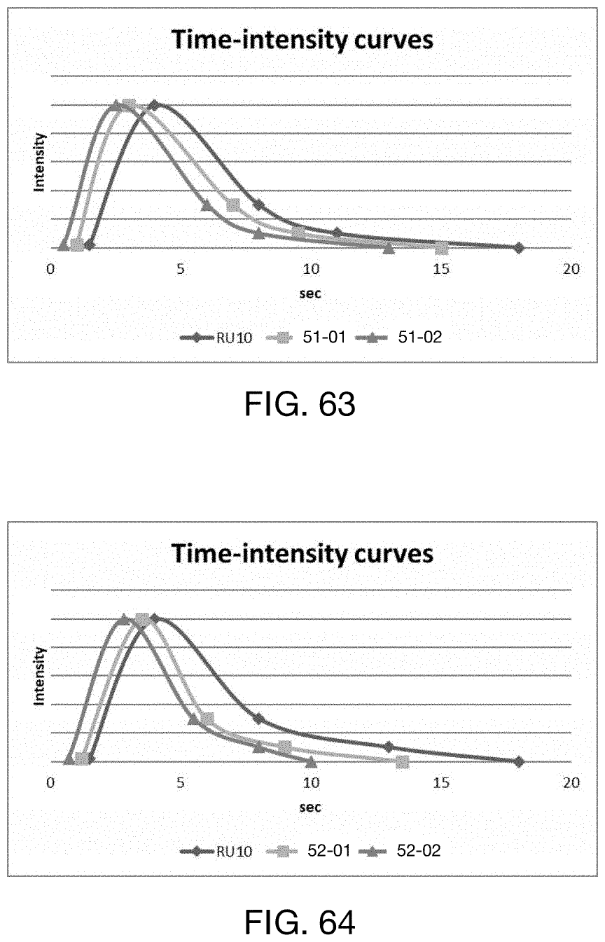

FIG. 63 shows time-sweet intensity profiles from Ex. 53 for RU10, GRU10-MRP-CA (51-01, 51-02) based on the sweetness profile data in Table 53-3.

FIG. 64 shows time-sweetness intensity profiles from Ex. 53 for RU10, GRU10-MRP-FTA (52-01, 52-02) in sugar reduction system.

Conclusion: In an 8% total SugarE and 1.5% sugar reduction system, compared to RU10, GRU10-MRP-CA (51-01, 51-02) and GRU10-MRP-FTA (52-01, 52-02) showed significantly reduced bitterness and significantly increased mouthfeel. In addition, GRU10-MRP-CA (51-01, 51-02) provide a caramel flavor and GRU10-MRP-FTA (52-01, 52-02) retaining their herb flavor. The results further showed that the mouth feel of RU10 can be significantly improved by glycosylation and Maillard reaction. This effect can be extended to any type of Maillard reacted glycosylated sweet tea extract.

### Example 54. GRU10-MRP-FTA Improves the Taste of Black Tea Drink

Black tea drink: The black tea drink (Reference) was made according to the followed formulation.

Ingredients: Water 100 mL, sugar 8 g, citric acid 0.088 g, malic Acid 0.022 g, black tea powder 0.2 g.

The test black tea drink (Test) was made according to the followed process.

GRU10-MRP-FTA powder (52-01 in Ex. 52) was dissolved into Reference. The details are as follows.

TABLE 54-1
Test sample components

| | Weight of GRU10- | Volume of reference |
|---|---|---|
| Components | MRP-FTA (52-01) | (mL) |
| Weight/volume | 5 mg | 100 ml |

Experiment: Reference and test samples were evaluated according to the sensory evaluation method in Ex. 5. Average scores from the test panel for each sensory criterion were recorded as the evaluation test results. The resulting taste profiles of the mixtures are shown in Table 54-2.

TABLE 54-2
Sensory evaluation results of GRU10-MRP-
FTA (52-01 in Ex. 52) in a black tea drink.

| | Overall | | | | Bitterness |
|---|---|---|---|---|---|
| Sample | likability | Flavor | Mouth feel | Bitterness | lingering |
| Reference | 3 | 3 | 3 | 3 | 3.5 |
| Test | 4.5 | 4 | 3.5 | 2 | 2 |

Conclusion: GRU10-MRP-FTA significantly reduced the bitterness and bitterness lingering of black tea drink. In addition, GRU10-MRP-FTA (52-01 in Ex. 52) provided significantly improved flavor and mouth feel of the black tea drink. These effects can be extended to all tea drinks.

### Example 55. Production of GSG-MRP Using Hemp Seed Oil and Crystalline CBD

Materials:

Cannabidiol (CBD), Charge (Batch) 18R18787, Arevipharma GmbH.

D(+)-Galactose, Lot 1054110, Fluka.

L(+)-Glutamic acid, Lot 581987, Merck.

Steviol glycosides: GSG RA50, Lot #5150311, Sweet Green Fields Co. Ltd.

Hemp seed oil (on-line shop, https://www.hanfland.at/produkt/bio-hanfoel/).

Sample preparation: 4.5 g of GSG RA50, 0.375 g galactose, 0.125 g glutamic acid and 0.50 g CBD were combined and dissolved in 2.5 ml deionized water under constant stirring. After that 1 ml of hemp seed oil was added and stirred. The mixture was heated at 100° C. for 1.5 h with a stir rate 200-250 rpm. During the heating time, evaporated water was continuously replaced to avoid extensive sample heating.

As a control sample, GSG RA50 was dissolved in water and diluted to the same concentration as the flavor preparation.

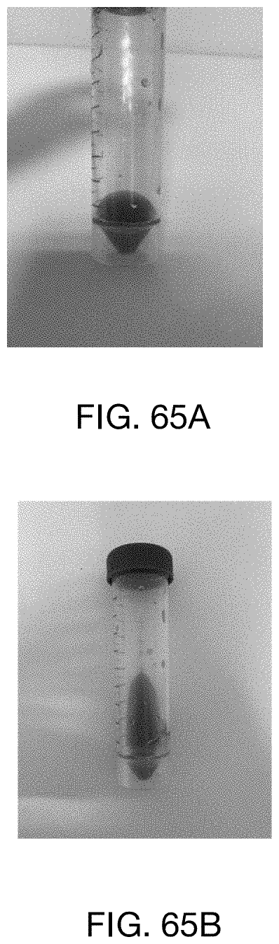

Results: As shown in FIGS. 65A and 65B, GSG-MRP/hemp seed oil/CBD final product has the following characteristics:

Color: brown, opaque

Consistency: like a syrup, viscous, homogeneous

Odor: sour, licorice

Test 1, Taste and Aroma Description

Sample preparation: 100-500 ppm of final GSG-MRP/hemp seed oil/CBD product (corresponding to 20-100 ppm CBD) were dissolved in water and sensorially compared to 100-500 ppm of the control sample (GSG RA50).

Results.

TABLE 55-1
Sensory evaluation of GSG-MRP/Hemp seed Oil/CBD

| GSG-MRP CBD | | |
|---|---|---|
| (ppm) | Appearance, aroma | Taste |
| 100 | Colorless, neutral | Slightly sweet, sweeter than control, |
| | | hemp seed oil aftertaste |
| 200 | Colorless, neutral | Sweet, sweeter than control, medium |
| | | intensive hemp seed oil aftertaste |
| 300 | Colorless, sweetish, | Sweet, sweeter than control, intensive |
| | hemp seed oil | hemp seed oil aftertaste, slightly lingering, |
| | | less bitter aftertaste than control |
| 400 | Slightly milky, sweetish, | Intensive sweet, very intensive hemp seed |
| | hemp seed oil | oil aftertaste, sweet lingering, no bitter |
| | | aftertaste like control |
| 500 | Slightly milky, sweetish, | Very intensive sweet, very intensive hemp |
| | hemp seed oil | seed oil aftertaste,, sweet lingering, no |
| | | bitter aftertaste like control |

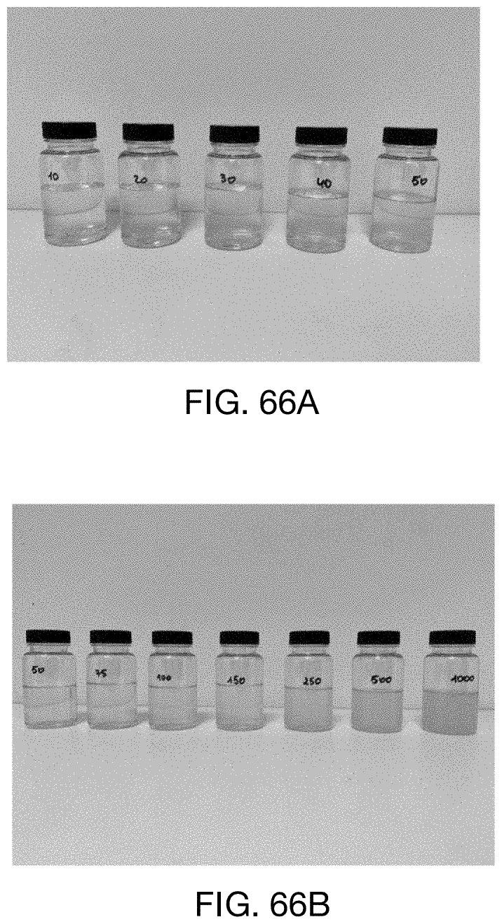

The hemp seed oil taste is noticeable in each sample and its intensity increases with the increase in the final product concentration. Likewise the aroma intensity increases with the increase of the final product concentration in water. FIG. 66A is a picture of tasting samples with various amounts of GSG-MRP/hemp seed oil/CBD final product dissolved in water for tasting.

Test 2, Solubility in Water

Sample preparation: 500-10000 ppm of final GSG-MRP/hemp seed oil/CBD product were dissolved in water to determine the maximum amount that can be dissolved in water to obtain a clear solution.

Results:

TABLE 55-2
Solubility check of GSG-MRP/hemp seed oil/CBD final product.

| | |
|---|---|
| Sample | Solubility |

| | | |
|---|---|---|
| 500-750 | ppm | Clear solution |
| 1000-1500 | ppm | Slightly milky, but still clear |
| 2500 | ppm | Cloudy, slightly oily water surface |
| 5000-10000 | ppm | Very cloudy, oily water surface |

FIG. 66B is a picture of solubility samples with various amounts of GSG-MRP/hemp seed oil/CBD final product in water.

### Example 56. Production of GSG-MRP Using Hemp Seed Oil

Materials:

D(+)-Galactose, Lot 1054110, Fluka.

L(+)-Glutamic acid, Lot 581987, Merck.

Steviol glycosides RA20/SG95, Lot #20180413, Sweet Green Fields Co. Ltd.

CBD oil, 20607.

Sample preparation: 45 g of RA20/SG95, 3.75 g galactose and 1.25 g glutamic acid were combined and dissolved in 25 ml deionized water under constant stirring. After that 3 ml of hemp seed oil was added and stirred. The mixture was heated at 100° C. for 1.5 h with a stir rate 200-250 rpm.

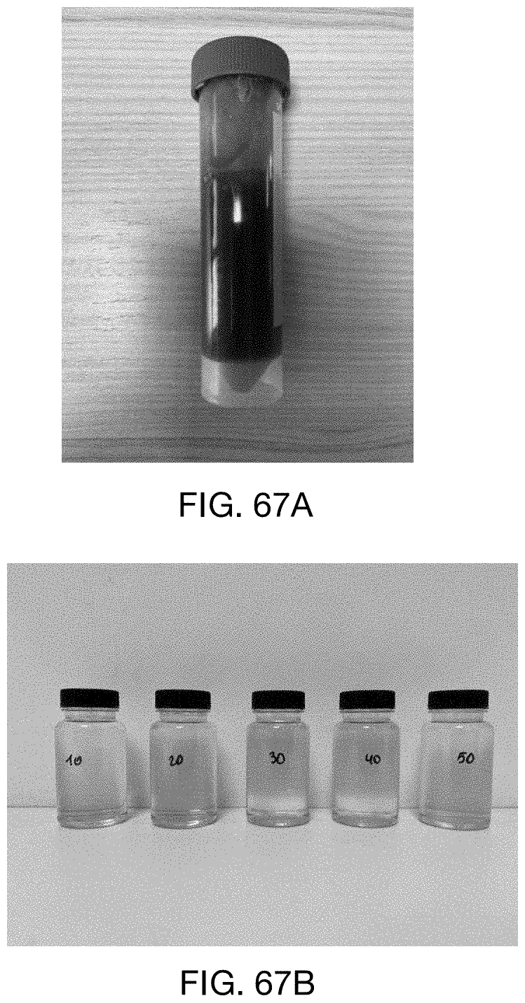

Result: The resulting reaction products are shown in FIG. 67A with the following characteristics:

Color: brown, opaque

Odor: sour, licorice, herbal

Consistency: homogeneous, after cooling had become solid (not viscous).

Taste determination: 100 mg, 200 mg, 300 mg, 400 mg and 500 mg of final GSG-MRP product (equivalent to 4, 8, 12, 16 and 20 mg CBD oil) were dissolved in 100 ml water, and tasted in comparison to 100 ppm, 200 ppm, 300 ppm, 400 ppm and 500 ppm of RA20/SG95.

The final product samples are sweeter and don't have a bitter aftertaste at 400 ppm and 500 ppm compared to 400 ppm and 500 ppm of RA20/SG95. The hemp seed oil taste is noticeable in each sample and its intensity increases linear with the increase of the final product concentration. The aroma of the samples is neutral with a slightly hemp seed oil flavor.

FIG. 67B is a picture showing the appearance of tasting samples with various concentrations of the final GSG-MRP product.

### Example 57. Production of GSG-MRP Using CBD Oil

Materials:

NuLeaf Naturals CBD in Hemp Oil (24 mgCBD/500 mg product)—lot A933H134

GSG RA20, Sweet Green Fields Co. Ltd.

D-Galactose—Fisher Scientific lot 140698

L-Glutamic Acid—Sigma Chemical No. G-2128

Sample preparation: 45 g of GSG-RA20, 3.75 g Galactose and 1.25 g Glutamic Acid were combined and dissolved in 25 g distilled water. Upon dissolution, 3 ml CBD Oil was added and stirred. Mixture was heated @100 C for 1.5 h, with a stir rate of 200 rpm. Samples were placed in 50 ml screwcap vials and sealed.

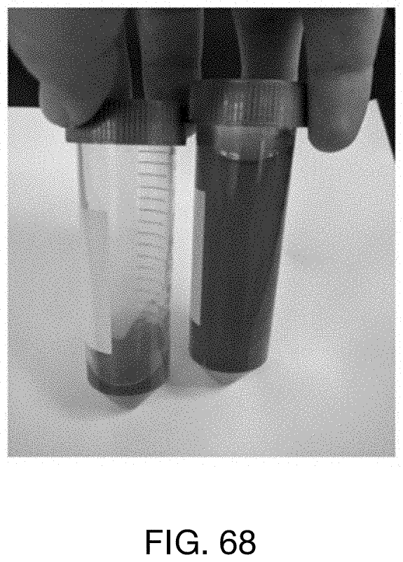

Results: the final product had a volume of about 60 ml, the CBD oil was completely emulsified. As shown in FIG. 68, the final product was brown in color, appeared opaque in opacity, and had the viscosity of honey.

Taste determination: 25 mg of final product was dissolved in 100 ml (250 ppm syrup, 225 ppm solids in syrup) and tasted, compared to 225 ppm of GSG-RA20. CBD oil tasted as is has a grassy/hay taste, which transfers over to the GSG-MRP final product. The GSG-MRP final product was slightly less sweet but had less plum/licorice off notes. The CBD flavor is slightly noticeable and lingers after tasting.

Aroma determination: Sample smelled like a syrup at 250 ppm in solution. The aroma of CBD is reminiscent of cut grass/animal feed, and the aroma transfers over to the final product. The aroma of the final product is very similar to CBD and is more pleasant than the GSGRA20 starting product.

### Example 58. Preparation of Glycosylated Rubusoside 40% (GRU40) from RU40

A glycosylated product was prepared using rubusoside 40% (Guilin Layin Natural Ingredients Corp. Content of RU is 40.30% Lot #307-48-02) according to the following method:

(i) 15 g Tapioca dextrin (BAOLIBAO BIOLOGY Co., Ltd) was dissolved in 45 ml deionized water

(ii) 15 g RU40 was added to the dissolved dextrin solution to form a mixture.

(iii) 0.75 ml CGTase enzyme (Amano Enzyme, Inc.) and 15 ml deionized water were added to the mixture and incubated at 69° C. for 20 hours to glycosylate the RU40 with glucose molecules derived from Tapioca dextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 25 g of GRU40 as a white powder.

### Example 59. Preparation of GRU40-MRP-FTA from GRU40, Fructose, Glutamic Acid

GRU40: the product of Ex. 58.

9 g GRU40, 0.5 g fructose and 0.5 g glutamic acid were mixed. The ratio of fructose to glutamic acid was 1:1 and the ratio of GRU40 to the mixture of fructose and glutamic acid was 9:1. The mixture obtained was dissolved in 5 g pure water without pH adjustment. The solution was then heated at about 100° C. for 1.5 hours. When the reaction was completed, the solution was then filtered through filter paper and the filtrate was dried with a spray dryer, thereby resulting in about 8.2 g of GRU40-MRP-FTA as an off white powder.

### Example 60. GRU40-MRP-FTA Improves the Taste Profile of a Commercial Energy Drink

Commercial energy drink: Monster Energy Ultra, available from CocaCola Beijing Co., Ltd, Lot #:20200508. Ingredients: water, maltodextrin, erythritol, citric acid, sodium citrate, food flavoring (contain guarana extract), carbon dioxide, carnitine sodium tartrate, black tea concentrate, taurine, panax powder, sucralose, green tea concentrate, coffee bean concentrate, sodium benzoate, inosite, potassium acetylsulfonate, sodium chloride, nicotinamide, pantothenic acid, vitamin B6, vitamin B12.

Process: GRU40-MRP-FTA (product in Ex. 59) powder was dissolved into the commercial Monster Energy Ultra drink as described in Table 60-1.

TABLE 60-1
Sample compositions.

| | Weight of GRU40- | Volume of | Concentration |
|---|---|---|---|
| Sample | MRP-FTA(mg) | Monster (ml) | (ppm) |
| Base | — | 100 | |
| Product in Ex. 59 | 5.0 | 100 | 50 |

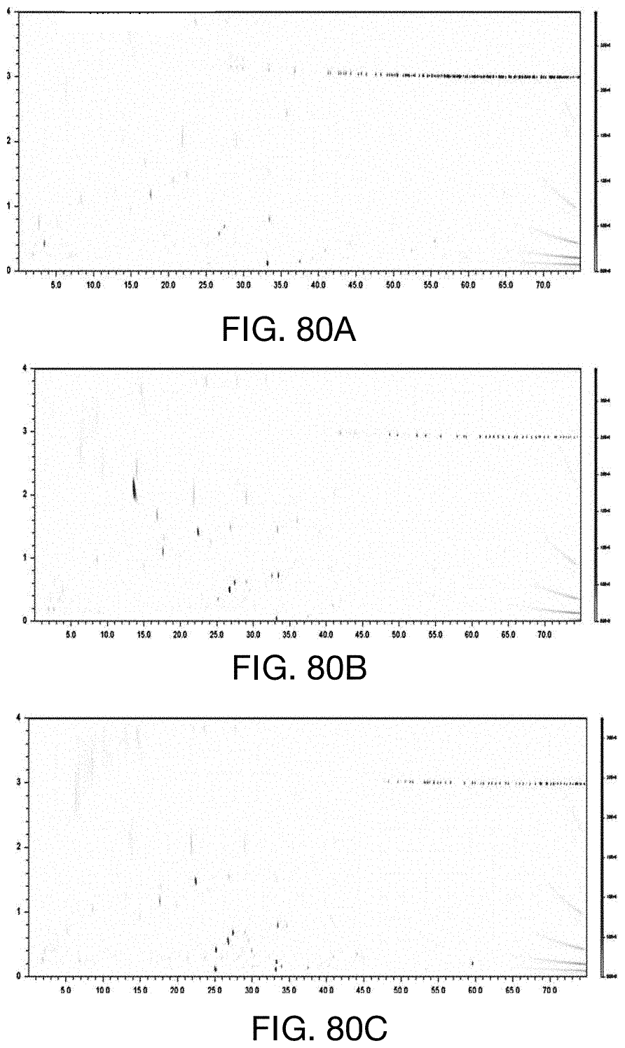

Experiment: Each sample composition in Table 60-1 was evaluated according to the aforementioned sensory evaluation method in Ex. 5. Average scores from the test panel for each sensory criterion were recorded as the evaluation test results. The taste profiles of each product sample are described in Table 60-2 and FIG. 80.

TABLE 60-2
Sensory evaluation results.

| | Overall | | Mouth | Metallic | Sweet |
|---|---|---|---|---|---|
| Sample | likability | Flavor | feel | aftertaste | lingering |
| Reference | 2.5 | 3.0 | 1.5 | 2.5 | 3.0 |
| Product in Ex. 59 | 4.5 | 4.5 | 1.5 | 1 | 1.0 |

Conclusion: GRU40-MRP-FTA (product in Ex. 59) significantly reduced the sweet lingering and metallic aftertaste in the modified Monster energy drink. GRU40-MRP-FTA (product in Ex. 59) provided an improved pleasant fruit flavor, resulting in better overall likability than the Monster drink alone. The results showed that ST-MRPs (STC-MRP or STE-MRP) can improve the taste profile of the beverage such as energy drink. Similar studies can be extended to the use of other ST-MRPs described herein; ST-MRPs can be added to the beverage in amount ranging from 0.1 ppm to 10,000 ppm.

### Example 61. Preparation of GRU90-MRP-FTA from GRU90, Fructose, Glutamic Acid and Essential Oils/Essences

Raw material: GRU90: the product of Ex. 7. Essential oils and essences were obtained from the sources identified in Table 61-1.

TABLE 61-1
Essential oils (T. Less) and essences used

| Type | Company | Lot# |
|---|---|---|
| Lemon T. Less HS | Chongqing Zhengyuan | Ref. 71026465 |
| Mandarin juice Volatiles | flavor Co., Ltd | Ref. 81025599 |
| Conc. Extract | | |
| Mandarin T. Less HS | | Ref. 91026464 |
| Orange juice Volatiles | | Ref. 71025597 |
| Conc. Extract | | |
| Blood orange T. Less HS | | Ref. 81026463 |
| Cucumber Nat pro 200 | | Ref. 91026444 |

Process: GRU90, fructose, glutamic acid, essential oil/essence, and water were weighed as follows. The solution was then heated at about 100° C. for 2.5 hour. When the reaction was completed, the solution was filtered through filter paper and the filtrate was dried with a spray dryer, resulting in products 61-01 to 61-06 as off white powders.

TABLE 61-2
Sample compositions.

| | | | | | | Weight of | |
|---|---|---|---|---|---|---|---|
| | | | | Weight of | Weight | essential | |
| Product | Product | Weight of | Weight of | glutamic | of water | oil/essence | Type of essential |
| name | No. | GRU90 (g) | fructose (g) | acid (g) | (mL) | (mL) | oil or essence |
| GRU90- | 61-01 | 45 | 3.75 | 1.25 | 25 | 1.2 | Lemon T. less HS |
| MRP-FTA | 61-02 | | | | | | Mandarin juice Volatiles |
| | | | | | | | Conc. Extract |
| | 61-03 | | | | | | Mandarin T. Less HS |
| | 61-04 | | | | | | Orange juice Volatiles |
| | | | | | | | Conc. Extract |
| | 61-05 | | | | | | Blood orange T. Less HS |
| | 61-06 | | | | | | Cucumber Nat pro 200 |

Conclusion: All products obtained from the process above were clear solutions. This example demonstrate that G-ST-MRPs can act as excellent carriers of flavor ingredients. It could improve the solubility of essential oil or flavor in oil form. The final product can be in powdered or liquid forms. This production process can be used to produce water-soluble essential oil, and products in powder form. The flavor intensity of the products produced by this production process was significantly intensified. There was a synergy between the flavor ingredients and the carriers. This technology can be used for any type of oils or water soluble ingredients. The resulting products, such as soluble flavor ingredients, can enhance orthonasal and retronasal flavors when added into food products and beverages, and increase sweetness as well. In other words, G-ST-MRP can be used as a good carrier of essential oils to maintain the original flavor of essential oils and promote their solubility. STCs such as rubusoside can be obtained or isolated from e.g., stevia or sweet tea extracts, bio-conversion from stevioside, fermentation or chemical synthesis. The ratio of essential oil to the composition of carrier could be vary from 1:99 to 99:1 depends on the designed requirement of final products.

### Example 62. GRU90-MRP-FTA Improves the Taste Profile of a Flavored Carbonated Drink

Commercial flavored carbonated drink: Mirinda, available from Pepsi Cola Co., Ltd. Lot #:20190803F

Ingredients: water, high fructose syrup, food additives (carbon dioxide, food flavoring, citric acid, sodium hexametaphosphate, sodium benzoate, sodium citrate, acesulfame potassium, sucralose, tartrazine, brilliant yellow).

Process: GRU90-MRP-FTA (product 61-04 in Ex. 61) powder was dissolved into Mirinda forming product 62-01 as described in Table 62-1.

TABLE 62-1
Sample compositions.

| | Weight of | Volume of | |
|---|---|---|---|
| | GRU90-MRP-FTA | Mirinda | Concentration |
| Sample | (61-04; mg) | (ml) | (ppm) |
| Base | — | 100 | |
| 62-01 | 5.0 | 100 | 50 |

Experiment: Each sample composition in Table 62-1 was evaluated according to the aforementioned sensory evaluation method in Ex. 5 and the method below. Average scores from the test panel for each sensory criterion were recorded as the evaluation test results. The taste profiles of the resulting beverage product samples are based on the sensory criteria in Ex. 5 and those described below.

Sensory evaluation: Each sample was dissolved in neutral deionized water. The testers placed 20-30 mL of the sample composition for evaluation in their mouths and additionally evaluated the impact based on its bubbles, fruit flavor (juiciness), and refreshing feel. The test solutions were then spit out. A score of 1-5 (i.e. from weak to strong) for each evaluated aspect was recorded.

TABLE 62-2
Sensory evaluation results.

| | Overall | | | | Sweet |
|---|---|---|---|---|---|
| Sample | likability | Flavor | Juiciness | Refreshing | lingering |
| Reference | 2.5 | 3.0 | 2.5 | 2.5 | 2.0 |
| 62-01 | 4.5 | 4.5 | 4 | 3 | 0.5 |

Conclusion: GRU90-MRP-FTA (Ex. 61, product 61-04) can provide a significant pleasant orange flavor and enhanced juiciness, refreshing feel, resulting in a better overall likability than Mirinda alone (reference). The results are consistent with G-ST-MRPs improving the taste profile of flavored carbonated drinks.

### Example 63. GRU90-MRP-FTA Improves the Taste Profile of Green Tea Beverage

Commercial green tea beverage: low sugar green tea, available from Uni-President Enterprises Corp., Lot #:20200507

Ingredients: water, sugar, green tea, jasmine tea, oolong tea, sodium hexametaphosphate, D-sodium erythorbate, food flavoring, vitamin C, sodium bicarbonate, disodium dihydrogen pyrophosphate, sodium tripolyphosphate.

Process: Dissolve GRU90-MRP-FTA (product 61-06 in Ex. 61) powder into the commercial green tea beverage to form green tea beverage product 63-01 as described in Table 63-1.

TABLE 63-1
Sample compositions.

| Green tea | Weight of | Volume of | Concentration of |
|---|---|---|---|
| beverage | GRU90-MRP-FTA | green tea | GRU90-MRP-FTA |
| product | (61-06) (mg) | (ml) | (ppm) |
| Base | — | 100 | |
| 63-01 | 5.0 | 100 | 50 |

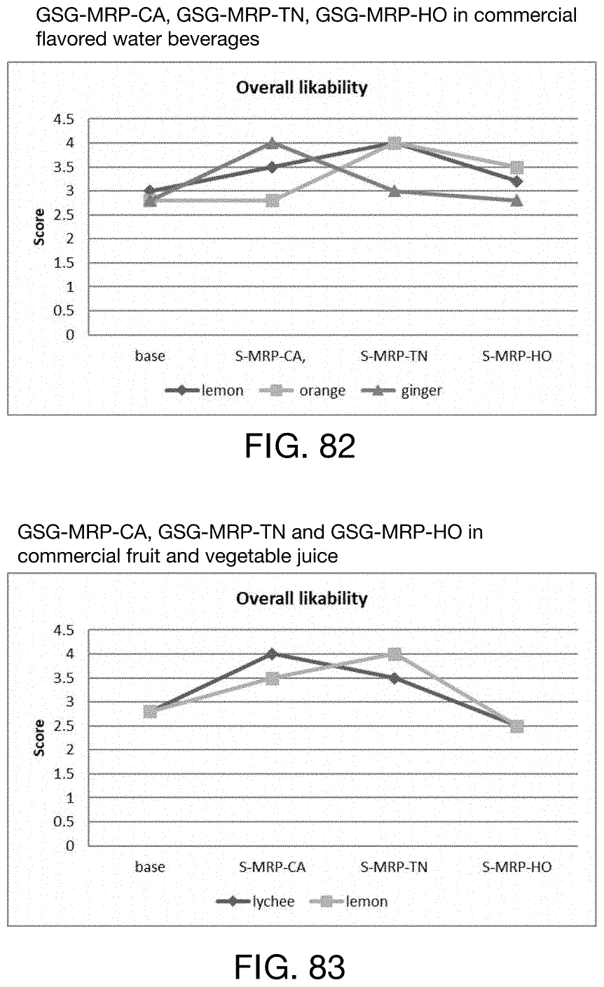

Experiment: Each sample composition in Table 63-1 was evaluated according to the aforementioned sensory evaluation methods set forth in Ex. 5. Average scores from the test panel for each sensory criterion were recorded as the evaluation test results. The taste profiles of the beverage product samples are described in Table 63-2 and FIG. 82.

TABLE 63-2
Sensory evaluation results.

| | Overall | | | |
|---|---|---|---|---|
| Sample | likability | Flavor | Bitterness | Refreshing |
| Reference (Base) | 2 | 3.5 | 3 | 2 |
| 63-01 | 4 | 4.5 | 1.5 | 3 |

Conclusion: GRU90-MRP-FTA (Ex. 61, product 61-06) can provide a significantly pleasant tea flavor and reduce bitterness, resulting in better overall likability than green tea itself. The results are consistent with G-ST-MRPs improving the taste profile of green tea beverages.

### Example 64. Preparation of GRU90-MRP-FTA from GRU90, Fructose, Glutamic Acid and Massoia Lactone

GRU90: the product of Ex. 7.

GRU90, fructose, glutamic acid, massoia lactone and water were weighed and combined as shown in Table 64-1. The solution was then heated at about 100° C. for 1.5 hours. When the reaction was completed, the solution was filtered through filter paper and the filtrate was dried with a spray dryer, resulting in product 64-01 as an off white powder.

TABLE 64-1
Sample composition

| | Weight of | Weight of | Weight of | Weight of |
|---|---|---|---|---|
| Weight of | fructose | glutamic | water | massoia |
| GRU90 (g) | (g) | acid (g) | (g) | lactone (g) |
| 6 (product 64-01) | 3.696 | 0.308 | 5 | 0.03 |

### Example 65. Preparation of GRU90-MRP-FTA and its Use in Improving the Taste Profile of a Plant-Based Yogurt

Commercial plant-based yogurt: Nongfu Spring plant-based yogurt (coconut flavor), available from Nongfu Spring Co., Ltd.

Ingredients: water, coconut water (water, concentrated coconut water), granulated sugar, hydroxypropyl distarch phosphate, Lactobacillus bulgaricus, Streptococcus thermophiles, pectin, xylitol, trisodium phosphate, agar, diacetyl tartaric acid esters of mono- and diglycerides, food flavoring.

Process: GRU90-MRP-FTA (Ex. 64, 64-01) powder was dissolved into the plant-based yogurt to form yogurt product 65-01. The details are as follows.

TABLE 65-1
Sample compositions.

| | Weight of | Volume of | Concentration of |
|---|---|---|---|
| Yogurt | GRU90-MRP-FTA | plant-based | GRU90-MRP-FTA |
| product | (64-01) (mg) | yogurt (mL) | (ppm) |
| Base | — | 100 | |
| 65-01 | 5 | 100 | 50 |

Experiment: Each sample composition in Table 65-1 was evaluated according to the sensory evaluation methods in Ex. 5, where the following creaminess evaluation test standard shown in Table 65-2 was employed. Average scores from the test panel for each sensory criterion were recorded as the evaluation test results. The taste profiles of the yogurt product samples are shown Table 65-3 and FIG. 83.

TABLE 65-2
Creaminess evaluation test standard

| Intensity of | | Relatively | | Relatively | |
|---|---|---|---|---|---|
| creaminess | Weak | weak | Moderate | Strong | Strong |
| Score of | 1 | 2 | 3 | 4 | 5 |
| creaminess | | | | | |

TABLE 65-3
Sensory evaluation results.

| | Overall | | Mouth | Metallic | |
|---|---|---|---|---|---|
| Sample | likability | Flavor | feel | aftertaste | Creaminess |
| Reference | 2 | 3 | 2 | 2 | 3 |
| (Base) | | | | | |
| 65-01 | 4 | 4 | 4 | 1 | 4 |

Conclusion: GRU90-MRP-FTA (Ex. 64, product 64-01) significantly reduced the unpleasant metallic aftertaste in yogurt (coconut flavor). In addition, GRU90-MRP-FTA provided significant enhancements in both flavor, mouth feel and creaminess. The results showed that G-ST-MRPs can improve the taste profile of yogurt.

### Example 66. Preparation of GRU90-MRP-FTA from GRU90, Fructose, Glutamic Acid and Vanillin

GRU90: the product in Ex. 7

GRU90, fructose, glutamic acid, vanillin and water was weighed as follows Table 66-1. The solution was then heated to about 100 degree centigrade and maintained at about 100 degree centigrade for 1.5 hours. When the reaction was completed, the solution was filtered through filter paper and the filtrate was dried with a spray dryer, thereby resulting in 66-01 product as an off white powder.

TABLE 66-1
Sample composition.

| | Weight of | Weight of | Weight of | Weight of | Weight of |
|---|---|---|---|---|---|
| Product | GRU90 | fructose | glutamic | water | vanillin |
| No. | (g) | (g) | acid (g) | (g) | (g) |
| 66-01 | 6 | 3.696 | 0.308 | 5 | 0.005 |

### Example 67. GRU90-MRP-FTA Improves the Taste Profile of a Commercial Dairy Product

Commercial dairy product: Full-fat milk, available from Inner Mongolia Yili Industrial Group Co., Ltd.

Ingredients: Raw milk.

Process: Dissolve GRU90-MRP-FTA (66-01 in Ex. 66) powder into milk to form milk product 67-01. The details are as follows.

TABLE 67-1
Sample compositions.

| | Weight of | Volume of | |
|---|---|---|---|
| Dairy product | GRU90-MRP-FTA | milk | Concentration |
| sample | (66-01) (mg) | (mL) | (ppm) |
| Base | — | 100 | |
| 67-01 | 5 | 100 | 50 |

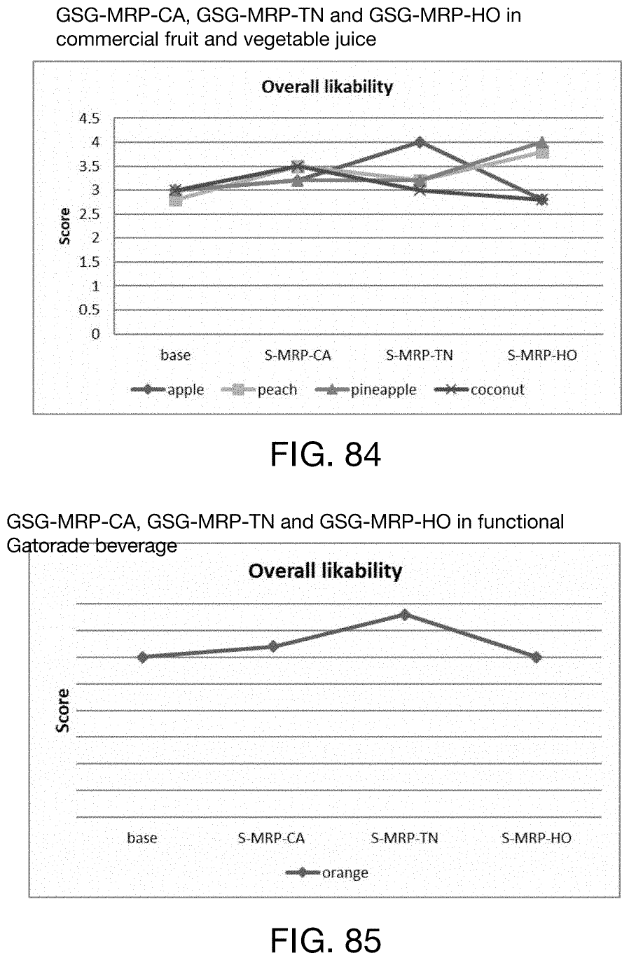

Experiment: Each sample composition in Table 67-1 was evaluated according to the aforementioned sensory evaluation method in Ex. 5. Average scores from the test panel for each sensory criterion were recorded as the evaluation test results. The taste profiles of the milk product samples are described in Table 67-2 and FIG. 84.

TABLE 67-2
Sensory evaluation results.

| Dairy product | Overall | | | |
|---|---|---|---|---|
| sample | likability | Flavor | Mouth feel | Creaminess |
| Reference (Base) | 3 | 3 | 3 | 2 |
| 67-01 | 4 | 4 | 4 | 4 |

Conclusion: GRU90-MRP-FTA (Ex. 66, product 66-01) significantly enhanced the creaminess, flavor, mouth feel and overall likability of the commercial dairy product. These results show that G-ST-MRPs can improve the taste profile of commercial dairy products. G-ST-MRPs have good compatibility with Vanillin.

### Example 68. GSG-MRP-FTA (39-05) and GRU90-MRP-FTAs (39-10 and 34-02) Improve the Taste Profiles of Commercial Carbonated Beverages

Commercial carbonated beverages: details are shown in Table 68-1.

TABLE 68-1

| Flavor | | | Lot | |
|---|---|---|---|---|
| type | Product | Company | number | Ingredients |
| Lemon | Sanpellegrino | Sanpellegrino | 20190808 | Water, concentrated lemon |
| | sparkling | S.p.A. | | juice, glucose syrup, |
| | lemon | | | fructose, sugar, carbon |
| | beverage | | | dioxide, citric acid, |
| | | | | flavoring agent |
| Orange | Sanpellegrino | Sanpellegrino | 20190809 | Water, concentrated sweet |
| | sparkling | S.p.A. | | orange juice, glucose |
| | orange | | | syrup, fructose, sugar, |
| | beverage | | | carbon dioxide, citric acid, |
| | | | | flavoring agent |
| Ginger | Sanpellegrino | Sanpellegrino | 20191118 | Water, carbon dioxide, |
| | sparkling | S.p.A. | | high fructose corn syrup, |
| | ginger | | | citric acid, concentrated |
| | beverage | | | ginger juice, flavoring |
| | | | | agent, sodium sorbate, |
| | | | | caramel color, sodium |
| | | | | benzoate |
| Cucumber | Ocean bomb | Ocean Bomb | 20190530 | Water, carbon dioxide, |
| | cucumber | | | citric acid, cucumber |
| | Flavored | | | flavoring, sugar |
| | carbonated | | | |
| | beverage | | | |

Process: Each of GSG/GRU90-MRP-FTAs (39-05, 39-10 and 34-02 products) in powder form was dissolved into one of four carbonated beverages (lemon, orange, ginger or cucumber) as described in Table 68-2.

TABLE 68-2
Sample compositions.

| Weight of | Volume of | Concentration of |
|---|---|---|
| GSG/GRU90- | carbonated | GSG/GRU90- |
| MRP-FTA (mg) | beverage (mL) | MRP-FTA (ppm) |
| — | 100 (base) | |
| 5 (product 39-05) | 100 | 50 |
| 5 (product 39-10) | 100 | 50 |
| 5 (product 34-02) | 100 | 50 |

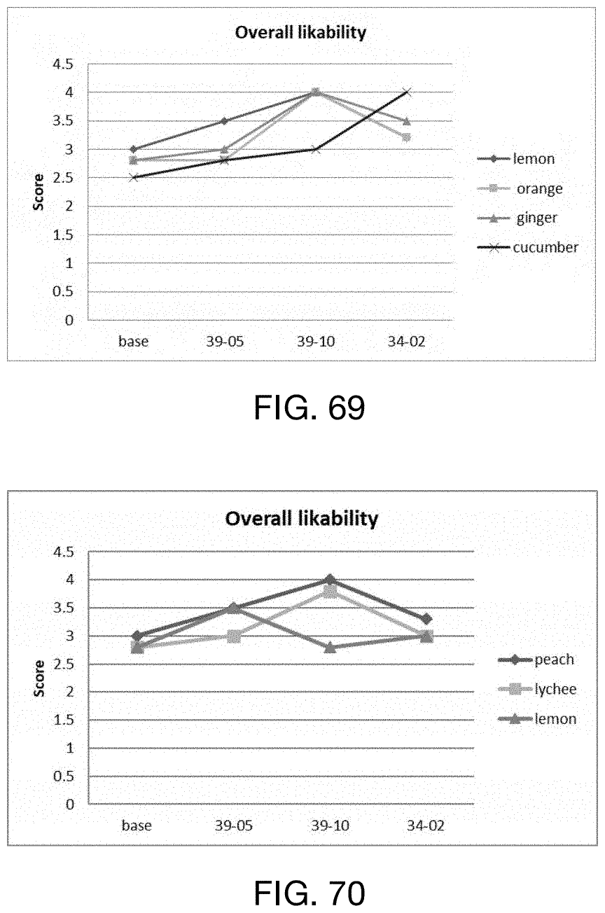

Experiment: Each sample composition in Table 68-2 was evaluated according to the aforementioned sensory evaluation methods in Ex. 5. Average scores from the test panel for each sensory criterion were recorded as the evaluation test results. The taste profiles of each product sample are described in Table 68-3 and FIG. 69.

TABLE 68-3
Sensory evaluation results.

| | Flavor | Sensory | | | | | |
|---|---|---|---|---|---|---|---|
| | type | criterion | Base | 39-05 | 39-10 | 34-02 | Evaluation |
| Carbonated | Lemon | Juiciness | 2 | 3 | 3.5 | 2.5 | GSG/GRU90-MRP-FTA (39-05, |
| beverage | | Refreshing | 3 | 2.5 | 4 | 4 | 39-10 and 34-02) all can improve |
| | | Flavor | 3.5 | 4 | 4 | 3.5 | the taste profile of lemon |
| | | Bitterness | 2 | 1.5 | 1.5 | 1.8 | carbonated beverages. 39-10 |
| | | Overall | 3 | 3.5 | 4 | 3.2 | significantly reduces bitterness; |
| | | likability | | | | | improves juiciness and |
| | | | | | | | refreshing; and enhances the |
| | | | | | | | lemon flavor of the beverage. |
| | Orange | Juiciness | 3 | 3 | 3.5 | 3 | GRU90-MRP-FTA (39-10 and |
| | | Refreshing | 2.5 | 2.5 | 4 | 3 | 34-02) both can improve the taste |
| | | Flavor | 3 | 3 | 4.2 | 3.2 | profile of orange carbonated |
| | | Overall | 2.8 | 2.8 | 4 | 3.2 | beverages. 39-10 significantly |
| | | likability | | | | | improves juiciness and |
| | | | | | | | refreshing; and enhances the |
| | | | | | | | orange flavor of the beverage. |
| | Ginger | Juiciness | 2.5 | 2.5 | 3 | 2.8 | GRU90-MRP-FTA (39-10 and |
| | | Refreshing | 3 | 2.8 | 3.5 | 3.5 | 34-02) both can improve the taste |
| | | Flavor | 3 | 3.5 | 4 | 3 | profile of ginger carbonated |
| | | Overall | 2.8 | 3 | 4 | 3.5 | beverages. 39-10 significantly |
| | | likability | | | | | improves juiciness and |
| | | | | | | | refreshing; and enhances the |
| | | | | | | | ginger flavor of the beverage. |
| | Cucumber | Juiciness | 2 | 2 | 2 | 4 | GSG/GRU90-MRP-FTA (39-05, |
| | | Refreshing | 3 | 3 | 3.5 | 4 | 39-10 and 34-02) all can improve |
| | | Bitterness | 2.5 | 2 | 2 | 2 | the taste profile of cucumber |
| | | Flavor | 3 | 4 | 4.5 | 4.5 | flavor carbonated beverages. 34-02 |
| | | Overall | 2.5 | 2.8 | 3 | 4 | significantly improves |
| | | likability | | | | | juiciness, and refreshing; and |
| | | | | | | | enhances the cucumber flavor of |
| | | | | | | | the beverage. |

FIG. 69 shows the overall likability of a commercial dairy product (67-01) containing GRU90-MRP-FTAs based on the sensory results in Table 68-3.

Conclusion: GRU90-FTA-MRPs can improve the taste profile of flavored carbonated beverages. In particular, 39-10 significantly reduces bitterness, improves juiciness and refreshing, and enhances the flavor of lemon, orange and ginger carbonated beverages, while 34-02 exhibited the greatest compatibility with the cucumber flavor. These results show that G-ST-MRPs can improve the taste profile of fruit flavored carbonated beverages, and can improve the freshness and juiciness of fruit/berry flavors in consumable flavored carbonated beverages, thereby increasing recognition of flavors quicker.

### Example 69. GSG/GRU90-MRP-FTAs Improve the Taste Profiles of Commercial Flavored Soft Drinks

Commercial flavored beverages: details are shown in the following table.

TABLE 69-1

| Flavor | | | Lot | |
|---|---|---|---|---|
| type | Product | Company | number | Ingredients |
| Peach | Glinter peach | Coca-Cola | 20191105 | Water, fructose, carbon |
| | flavor soft drink | Malaysia | | dioxide, citric acid, DL- |
| | | Co., Ltd | | malic acid, acesulfame-K, |
| | | | | aspartame, sodium citrate, |
| | | | | sodium sorbate, flavoring |
| | | | | agent (Peach flavor) |
| Lychee | Glinter lychee | Coca-Cola | 20191104 | Fructose, carbon dioxide, |
| | flavor soft drink | Malaysia | | citric acid, DL- malic acid, |
| | | Co., Ltd | | acesulfame-K, aspartame, |
| | | | | sodium citrate, sodium |
| | | | | sorbate, flavoring agent |
| | | | | (Lychee flavor). |
| Lemon | Glinter lemon | Coca-Cola | 20191106 | Fructose, carbon dioxide, |
| | flavor soft drink | Malaysia | | citric acid, DL- malic acid, |
| | | Co., Ltd | | acesulfame-K, aspartame, |
| | | | | sodium citrate, sodium |
| | | | | sorbate, flavoring agent |
| | | | | (Lemon flavor). |

Process: Each of the powdered GSG/GRU90-MRP-FTA products (39-05, 39-10 and 34-02) was dissolved in each of the flavored beverages as shown in Table 69-2.

TABLE 69-2
Sample compositions.

| | Weight of | Volume of | Concentration |
|---|---|---|---|
| | GSG/GRU90- | flavored | of GSG/GRU90- |
| | MRP-FTA | water beverage. | MRP-FTA |
| Components | (mg) | (mL) | (ppm) |
| Base | — | 100 | |
| 39-05 product | 5 | 100 | 50 |
| 39-10 product | 5 | 100 | 50 |
| 34-02 product | 5 | 100 | 50 |

Experiment: Each sample composition in Table 69-2 was evaluated according to the sensory evaluation method in Ex. 5. Average scores from the test panel for each sensory criterion were recorded as the evaluation test results. The resulting taste profiles of the mixtures are shown in Table 69-3 and FIG. 70.

TABLE 69-3
Sensory evaluation results.

| | Flavor | Sensory | | | | | |
|---|---|---|---|---|---|---|---|
| | type | criterion | Base | 39-05 | 39-10 | 34-02 | Evaluation |
| Flavored | Peach | Juiciness | 3 | 3.2 | 3.5 | 3 | GSG/GRU90-MRP- |
| water | | Refreshing | 2 | 1.8 | 3 | 2 | FTA (39-05, 39-10 and |
| beverage | | Flavor | 3.5 | 4 | 4 | 3.8 | 34-02) all can improve |
| | | Overall | 3 | 3.5 | 4 | 3.3 | the taste profile of a |
| | | likability | | | | | peach flavored water |
| | | | | | | | beverage. 39-10 |
| | | | | | | | significantly improves |
| | | | | | | | juiciness and refreshing; |
| | | | | | | | and enhances the peach |
| | | | | | | | flavor. |
| | Lychee | Juiciness | 2 | 2.5 | 3.5 | 2.5 | GSG/GRU90-MRP- |
| | | Refreshing | 3 | 2.5 | 3.5 | 3.5 | FTA (39-05, 39-10 and |
| | | Flavor | 3 | 3.2 | 4 | 3.2 | 34-02) all can improve |
| | | Overall | 2.8 | 3 | 3.8 | 3 | the taste profile of a |
| | | likability | | | | | lychee flavored water |
| | | | | | | | beverage. 39-10 |
| | | | | | | | significantly improves |
| | | | | | | | juiciness and refreshing; |
| | | | | | | | and enhances the lychee |
| | | | | | | | flavor. |
| | Lemon | Juiciness | 2.5 | 3.5 | 3 | 2.8 | GSG/GRU90-MRP- |
| | | Refreshing | 3 | 3 | 3.5 | 3.2 | FTA (39-05 and 34-02) |
| | | Flavor | 3 | 3.5 | 3 | 3.2 | both can improve the |
| | | Overall | 2.8 | 3.5 | 2.8 | 3 | taste profile of a lemon |
| | | likability | | | | | flavored water beverage. |
| | | | | | | | 39-05 significantly |
| | | | | | | | improves juiciness; |
| | | | | | | | enhances the lemon |
| | | | | | | | flavor; and maintains a |
| | | | | | | | refreshing feeling. |

FIG. 70 shows the overall likability of the samples based on the sensory results in Table 69-3.

Conclusion: Each of the GSG/GRU90-MRP-FTAs (39-05, 39-10 and 34-02) improved the taste profiles of commercial flavored water beverages. 39-10 significantly improved juiciness and refreshing, and improved the flavor of commercial peach, lychee and ginger flavored water beverages. 39-05 exhibited its greatest compatibility with the lemon flavor. The results show that G-ST-MRPs can improve the taste profile of commercial fruit flavored commercial flavored water beverages. Thus, a fruit and/or berry flavored consumable containing G-ST-MRPs can significantly improve the freshness and juiciness of fruit or berry flavors and provide quick flavor recognition. The added amount of G-ST-MRP in a consumable can be from e.g., 0.1 ppm to 1%, 5%, or 10%. Any type of G-ST-MRP can be used in a consumable product to improve the taste profile.

### Example 70. GSG/GRU90-MRP-FTAs Improve the Taste Profiles of Commercial Fruit and Vegetable Juices

Commercial fruit and vegetable juice: details are shown in Table 70-1.

TABLE 70-1

| Flavor | | | Lot | |
|---|---|---|---|---|
| type | Product | Company | number | Ingredients |
| Apple | [symbol] | Pepsi (Russia) Co., | 20200317 | Concentrated apple |
| | apple juice | Inc. | | juice, high fructose |
| | | | | corn syrup, citric acid, |
| | | | | water. |
| Peach | KEO peach | KEO Group Plc. | 20200124 | Concentrated peach |
| | juice | | | juice, citric acid, |
| | | | | ascorbic acid, |
| | | | | flavoring agent |
| Pineapple | KEO pineapple | KEO Group Plc. | 20190916 | Water, concentrated |
| | juice | | | pineapple juice, |
| | | | | ascorbic acid |
| Mango | Chabaa mango | Chabaa Bangkok | 20200112 | Water concentrated |
| | flavored | Co., Ltd. | | mango juice, sugar, |
| | beverage | | | peach pulps, citric acid |
| Melon | Chabaa melon | Chabaa Bangkok | 20190531 | Water concentrated |
| milk | flavored milk | Co., Ltd. | | melon juice, sugar, |
| | beverage | | | milk powder, |
| | | | | carrageenan, flavoring |
| | | | | agent (cantaloupe |
| | | | | flavor), brilliant blue, |
| | | | | tartrazine. |
| Red grape | Chabaa red | Chabaa Bangkok | 20190512 | Water, concentrated |
| | grape flavored | Co., Ltd. | | red grape juice, sugar, |
| | beverage | | | concentrated pear juice, |
| | | | | citric acid, sodium |
| | | | | carboxymethylcellulose |
| | | | | flavoring agent |
| Coconut | Foco roasted | Thai Agri Foods | 20191010 | Coconut juice, coconut |
| juice | coconut juice | Public Co., Ltd | | pulps, sugar, water. |

Process: Dissolve GSG/GRU90-MRP-FTA (39-05, 39-10 and 34-02 products) powder into a fruit or vegetable juice as outlined in Table 70-2.

TABLE 70-2
Sample compositions.

| | | Volume of | |
|---|---|---|---|
| | Weight of | fruit or | Concentration of |
| | GRU90-MRP-FTA | vegetable | GRU90-MRP-FTA |
| Component | (mg) | juice (mL) | (ppm) |
| Base | — | 100 | |
| 39-05 product | 5 | 100 | 50 |
| 39-10 product | 5 | 100 | 50 |
| 34-02 product | 5 | 100 | 50 |

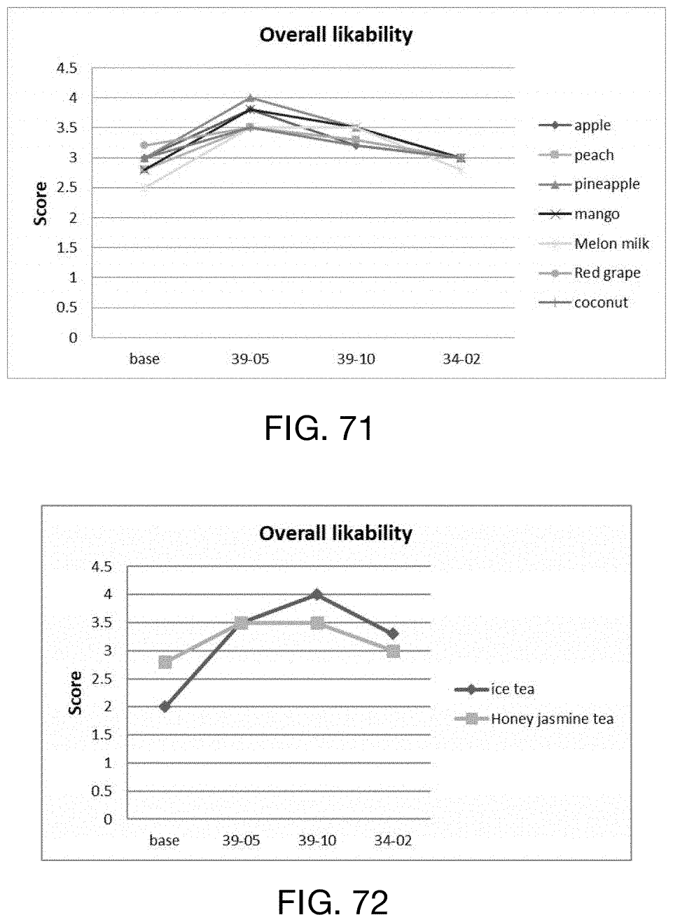

Experiment: Each sample composition in Table 70-2 was evaluated according to the aforementioned sensory evaluation method described in Ex. 5. Average scores from the test panel for each sensory criterion were recorded as the evaluation test results. The taste profiles of each juice product sample are described in Table 70-3 and FIG. 71.

TABLE 70-3
Sensory evaluation results.

| | Flavor | Sensory | | | | | |
|---|---|---|---|---|---|---|---|
| | type | criterion | Base | 39-05 | 39-10 | 34-02 | Evaluation |
| Fruit or | Apple | Juiciness | 3 | 3.5 | 3.2 | 3 | GSG/GRU90-MRP-FTA (39-05 |
| vegetable | | Mouthfeel | 2 | 3 | 2 | 1.5 | and 39-10) all can improve the |
| juice | | Flavor | 3.5 | 4 | 4 | 3.5 | taste profile of apple juice. 39-05 |
| | | Overall | 3 | 3.8 | 3.2 | 3 | significantly improves juiciness |
| | | likability | | | | | and mouthfeel, and enhances the |
| | | | | | | | apple flavor. |
| | Peach | Juiciness | 2 | 2.5 | 2.5 | 2.5 | GSG/GRU90-MRP-FTA (39-05, |
| | | Mouthfeel | 3 | 4 | 3 | 2.8 | 39-10 and 34-02) all can improve |
| | | Flavor | 3 | 4 | 4 | 3.2 | the taste profile of peach juice. |
| | | Overall | 2.8 | 3.5 | 3.3 | 3 | 39-05 enhanced juiciness, |
| | | likability | | | | | mouthfeel and the peach flavor, |
| | | | | | | | while 39-10 maintained its |
| | | | | | | | original mouthfeel. |
| | Pineapple | Juiciness | 3 | 3.5 | 3 | 2.8 | GSG/GRU90-MRP-FTA (39-05, |
| | | Mouthfeel | 3 | 4 | 3 | 2.8 | 39-10 and 34-02) all can improve |
| | | Flavor | 3 | 3.5 | 3.5 | 3.2 | the taste profile of pineapple |
| | | Overall | 3 | 4 | 3.5 | 3 | juice. 39-05 significantly |
| | | likability | | | | | improved juiciness and enhanced |
| | | | | | | | the pineapple flavor and |
| | | | | | | | mouthfeel, while 39-10 |
| | | | | | | | maintained its original |
| | | | | | | | mouthfeel. |
| | Mango | Juiciness | 3.5 | 4 | 4 | 3.8 | GSG/GRU90-MRP-FTA (39-05, |
| | | Mouthfeel | 3 | 4 | 3 | 2.8 | 39-10 and 34-02) all can improve |
| | | Flavor | 2 | 3 | 3 | 2.5 | the taste profile of mango juice. |
| | | Overall | 2.8 | 3.8 | 3.5 | 3 | 39-05 significantly improved |
| | | likability | | | | | juiciness, and enhanced the |
| | | | | | | | mango flavor and mouthfeel, |
| | | | | | | | while 39-10 maintained its |
| | | | | | | | original mouthfeel. |
| | Melon | Juiciness | 2 | 3 | 3 | 2.5 | GSG/GRU90-MRP-FTA (39-05, |
| | milk | Mouthfeel | 3 | 3.5 | 3 | 2.5 | 39-10 and 34-02) all can improve |
| | | Flavor | 2 | 3 | 3.5 | 2.8 | the taste profile of the melon |
| | | Overall | 2.5 | 3.5 | 3.5 | 2.8 | milk beverage. 39-05 |
| | | likability | | | | | significantly improved juiciness, |
| | | | | | | | and enhanced the melon milk |
| | | | | | | | flavor and mouthfeel, while 39- |
| | | | | | | | 10 maintained its mouthfeel and |
| | | | | | | | enhanced its flavor significantly. |
| | Red | Juiciness | 3.5 | 3.5 | 3.2 | 3 | GSG/GRU90-MRP-FTA (39-05, |
| | grape | Mouthfeel | 3 | 3.5 | 3 | 3 | 39-10 and 34-02) all can improve |
| | | Flavor | 3 | 3.5 | 3.5 | 3 | the taste profile of red grape |
| | | Overall | 3.2 | 3.5 | 3.3 | 3 | juice. 39-05 improved juiciness, |
| | | likability | | | | | and enhanced the red grape |
| | | | | | | | flavor and mouthfeel. |
| | Coconut | Juiciness | 3 | 3.5 | 3.5 | 3 | GSG/GRU90-MRP-FTA (39-05 |
| | | Mouthfeel | 3 | 3.5 | 3 | 3 | and 39-10) both can improve the |
| | | Flavor | 3 | 3.5 | 3.5 | 3 | taste profile of coconut juice. |
| | | Overall | 3 | 3.5 | 3.3 | 3 | 39-05 improved juiciness, and |
| | | likability | | | | | enhanced the coconut flavor and |
| | | | | | | | mouthfeel. |

FIG. 71 shows the overall likability of the tested samples based on the sensory results in Table 70-3.

Conclusion: GSG/GRU90-MRP-FTAs (39-05, 39-10 and 34-02) improve the taste profiles of commercial fruit and vegetable juices. 39-05 can significantly improve juiciness, mouthfeel and enhance the flavors of apple, peach, pineapple, mango, melon milk, red grape and coconut in commercial fruit and vegetable juices, while 39-10 can match these results and keep its mouthfeel. The results showed that G-ST-MRPs can improve the taste profile of fruit and vegetable juices.

### Example 71. GSG/GRU90-MRP-FTA Improves the Taste Profiles of Commercial Tea Drinks

Commercial tea drink: details are shown in Table 71-1.

TABLE 71-1

| Flavor | | | Lot | |
|---|---|---|---|---|
| type | Product | Company | number | Ingredients |
| Iced tea | Uni- | Uni- | 20191112 | Water, sugar, high |
| | President | President | | fructose com syrup, |
| | iced tea | Enterprises | | black tea leaves, |
| | | Corp. | | instant black tea, |
| | | | | DL-malic acid, |
| | | | | citric acid, food |
| | | | | flavoring, |
| | | | | concentrated lemon |
| | | | | juice, sodium |
| | | | | citrate, vitamin C, |
| | | | | hexametaphosphate, |
| | | | | stevioside, sodium |
| | | | | bicarbonate. |
| Honey | Master Kang | Tingyi | 20200105 | Water, sugar, |
| jasmine | low-sugar | (Cayman | | jasmine tea leaves |
| tea | green tea | Islands) | | (green tea base), |
| | | Holding | | green tea leaves, |
| | | Corp. | | honey, concentrated |
| | | | | green tea, food |
| | | | | additives (sodium |
| | | | | D-isoascorbate, |
| | | | | hexametaphosphate, |
| | | | | sodium citrate, |
| | | | | vitamin C, sodium |
| | | | | bicarbonate), food |
| | | | | flavoring. |

Process: Each powdered GSG/GRU90-MRP-FTA product (39-05, 39-10 and 34-02) was dissolved in each commercial tea drink as outlined below.

TABLE 71-2
Sample compositions.

| | Weight of | Volume of | Concentration |
|---|---|---|---|
| | GSG/GRU90- | commercial | of GSG/GRU90- |
| | MRP-FTA | tea drink | MRP-FTA |
| Component | (mg) | (mL) | (ppm) |
| Base | — | 100 | |
| 39-05 product | 5 | 100 | 50 |
| 39-10 product | 5 | 100 | 50 |
| 34-02 product | 5 | 100 | 50 |

Experiment: Each sample composition in Table 71-2 was evaluated according to the aforementioned sensory evaluation methods in Ex. 5. Average scores from the test panel for each sensory criterion were recorded as the evaluation test results to produce the following taste profiles depicted in Table 71-3 and FIG. 72.

TABLE 71-3
Sensory evaluation results.

| | Flavor | Sensory | | | | | |
|---|---|---|---|---|---|---|---|
| | type | criterion | Base | 39-05 | 39-10 | 34-02 | Evaluation |
| Tea drink | Iced | Bitterness | 2 | 1.5 | 1.5 | 1.8 | All of the |
| | tea | Refreshing | 2 | 2.5 | 3 | 2 | GSG/GRU90-MRP- |
| | | Flavor | 3.5 | 4 | 4 | 3.8 | FTAs (39-05, 39-10 |
| | | Overall | 2 | 3.5 | 4 | 3.3 | and 34-02) improved |
| | | likability | | | | | the taste profile of iced |
| | | | | | | | tea. 39-10 significantly |
| | | | | | | | improved refreshing, |
| | | | | | | | reduced bitterness and |
| | | | | | | | enhanced the tea flavor. |
| | Honey | Bitterness | 2 | 3.5 | 3.5 | 2.5 | All of the |
| | jasmine | Refreshing | 2 | 1.5 | 1.6 | 1.8 | GSG/GRU90-MRP- |
| | tea | Flavor | 3 | 3.5 | 3.3 | 3.2 | FTAs (39-05, 39-10 |
| | | Overall | 2.8 | 3.5 | 3.5 | 3 | and 34-02) improved |
| | | likability | | | | | the taste profile of |
| | | | | | | | honey jasmine tea. |
| | | | | | | | 39-10 and 39-05 had |
| | | | | | | | significantly improved |
| | | | | | | | refreshing, reduced |
| | | | | | | | bitterness, and |
| | | | | | | | enhanced the tea flavor. |

FIG. 72 shows the overall likability of the GSG/GRU90-MRP-FTAs in two commercial tea drinks, based on the sensory results in Table 71-3.

Conclusion: Each of the GSG/GRU90-MRP-FTAs (39-05, 39-10 and 34-02) improved the taste profile of the commercial tea drink tested. Samples 39-05 and 39-10 significantly reduced bitterness and enhanced the freshness and tea flavor. These results show that G-ST-MRPs can improve the taste profile of commercial tea drinks

### Example 72. GSG/GRU90-MRP-FTAs Improve the Taste Profiles of a Commercial Functional Beverage

Commercial functional beverage: details are shown in Table 72-1.

TABLE 72-1

| Flavor | | | Lot | |
|---|---|---|---|---|
| type | Product | Company | number | Ingredients |
| Orange | Gatorade | Pepsi Co. | 20190929 | Water, sugar, edible |
| | orange | (China). | | glucose, food additives |
| | flavor | Inc. | | (citric acid, sodium |
| | energy | | | citrate, monopotassium |
| | drink | | | phosphate, food |
| | | | | flavoring, sunset yellow |
| | | | | FCF), edible salt. |

Process: Each powdered GSG/GRU90-MRP-FTA (39-05, 39-10 and 34-02) product was dissolved into a commercial energy drink as described in Table 72-2.

TABLE 72-2
Sample compositions.

| | Weight of | | Concentration of |
|---|---|---|---|
| | GSG/GRU90- | Volume of commercial | GSG/GRU90- |
| | MRP-FTA | functional beverage. | MRP-FTA |
| Component | (mg) | (mL) | (ppm) |
| Base | — | 100 | |
| 39-05 | 5 | 100 | 50 |
| 39-10 | 5 | 100 | 50 |
| 34-02 | 5 | 100 | 50 |

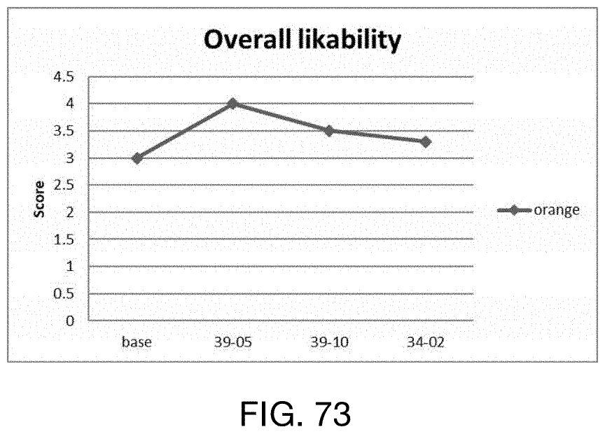

Experiment: Each sample in Table 72-2 was evaluated according to the sensory evaluation method in Ex. 5. Average scores from the test panel for each sensory criterion were recorded as the evaluation test results to produce the following taste profiles depicted in Table 72-3 and FIG. 73.

TABLE 72-3
Sensory evaluation results.

| | Flavor | Sensory | | | | | |
|---|---|---|---|---|---|---|---|
| | type | criterion | Base | 39-05 | 39-10 | 34-02 | Evaluation |
| Functional | Orange | Juiciness | 3 | 4 | 3.5 | 3 | GSG/GRU90-MRP-FTA |
| beverage | | Refreshing | 3 | 4 | 3.5 | 3.5 | (39-05, 39-10 and 34-02) |
| | | Flavor | 2.5 | 4 | 3.5 | 3 | all can improve the taste |
| | | Overall | 3 | 4 | 3.5 | 3.3 | profile of the orange |
| | | likability | | | | | flavor energy drink. |
| | | | | | | | Preferably, 39-05 can |
| | | | | | | | significantly improve |
| | | | | | | | refreshing, enhance the |
| | | | | | | | orange flavor and |
| | | | | | | | juiciness. |

FIG. 73 shows the overall likability of the test samples based on the sensory evaluation results in Table 72-3.

Conclusion: Each of the GSG/GRU90-MRP-FTAs (39-05, 39-10 and 34-02) was found to improve the taste profile of the commercial functional beverage. 39-05 significantly improved refreshing, enhanced the tea flavor and juiciness, and exhibited the greatest compatibility with the orange flavored energy drink. These results show that G-ST-MRPs can improve the taste profile of a functional beverage.

### Example 73. GRU90-MRP-FTA Improves the Taste of Luo Han Guo Extract

Process: GRU90-MRP-FTA (Ex. 34, 34-01) and Luo Han Guo extract (available from Huacheng Biotech, Inc., Lot #LHGE-161112; mogroside content is 50 wt %) were weighed, mixed and dissolved according to Table 73-1, and subjected to sensory evaluation tests, the results of which are depicted in Table 73-2.

TABLE 73-1
Preparation of mixtures of GRU90-MRP-FTA
(product 34-01) and Luo Han Guo extract

| | Ratio of | Weight of | | |
|---|---|---|---|---|
| | Luo Han Guo | Luo Han | Weight of | Volume of |
| Sample | extract to | Guo extract | GRU90-MRP- | pure water |
| No. | GRU90-MRP-FTA | (mg) | FTA (mg) | (mL) |
| 73-00 | 10/0 | 20 | 0 | 100 |
| 73-01 | 10/1 | 20 | 2 | 100 |
| 73-02 | 10/3 | 20 | 6 | 100 |
| 73-03 | 10/5 | 20 | 10 | 100 |
| 73-04 | 10/7 | 20 | 14 | 100 |
| 73-05 | 10/9 | 20 | 20 | 100 |
| 73-06 | 10/10 | 20 | 20 | 100 |

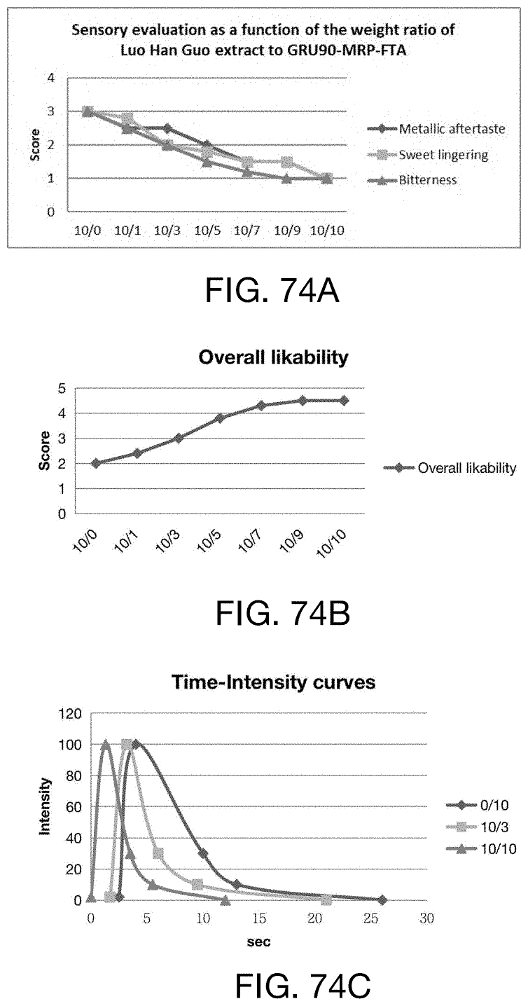

Experiments: Several mixtures of GRU90-MRP-FTA and Luo Han Guo extract were prepared and evaluated according to the sensory evaluation method in Ex. 5. Average scores from the test panel for each sensory criterion were recorded as the evaluation test results to produce the taste profiles depicted in Tables 73-2 and FIG. 74A. In the sensory evaluations, the concentration of Luo Han Guo extract in the sample solution was the same (200 ppm). Time intensity results are shown in 73-3 and FIG. 74B.

TABLE 73-2
Sensory evaluation results.

| Sample | Metallic | Sweet | | Overall |
|---|---|---|---|---|
| No. | aftertaste | lingering | Bitterness | likability |
| 73-00 | 3.00 | 3.00 | 3.00 | 2.00 |
| 73-01 | 2.50 | 2.80 | 2.50 | 2.40 |
| 73-02 | 2.50 | 2.00 | 2.00 | 3.00 |
| 73-03 | 2.00 | 1.80 | 1.50 | 3.80 |
| 73-04 | 1.50 | 1.50 | 1.20 | 4.30 |
| 73-05 | 1.50 | 1.50 | 1.00 | 4.50 |
| 73-06 | 1.00 | 1.00 | 1.00 | 4.50 |

TABLE 73-3
Time-intensity results.

| | | | LINGERING | LINGERING |
|---|---|---|---|---|
| Sample | ONSET | MAX | ON | OFF |
| No. | [sec] | [sec] | [sec] | [sec] |
| 73-00 | 2.5 | 4 | 10 | 26 |
| 73-01 | 2 | 3.5 | 8 | 23 |
| 73-02 | 1.7 | 3.2 | 6 | 21 |
| 73-03 | 1.5 | 3 | 5 | 18 |
| 73-04 | 1 | 2.8 | 5 | 15 |
| 73-05 | 0.8 | 2 | 4.5 | 12 |
| 73-06 | 0 | 1.3 | 3.5 | 12 |

Data analysis: The relationship between the sensory evaluation results as a function of the weight ratio of Luo Han Guo extract to GRU90-MRP-FTA is shown in FIG. 74A. FIG. 74B shows the overall likability of the sample compositions, based on the sensory evaluation results in Table 73-2. FIG. 74C shows time-intensity curves as a function of the weight ratio of Luo Han Guo extract to GRU90-MRP-FTA based on the data in Table 73-3.

Conclusion: The results show that GRU90-MRP-FTA (Ex. 34, 34-01) can significantly reduce sweet lingering, quicken sweetness onset and mask the bitterness of Luo Han Guo extract. This effect was observed at all tested weight ratios of Luo Han Guo extract-to-GRU90-MRP-FTA ratios (from 10:1 to 10:10). These effects can be extended to the Luo Han Guo extract-to-GRU90-MRP-FTA ratio range of 99:1 to 1:99. This example demonstrates that G-ST-MRPs can improve the taste profile, flavor intensity and mouth feel of natural sweeteners, such as Luo Han Guo extract. The Luo Han Guo extract (or monk fruit extract) can be derived from concentrated juice or a monk fruit extract with different mogroside V contents, such as 1.5%, 3%, 15%, 40%, 50%, 70%, 90%, 95%, etc. The observed effects can be extended to all natural sweeteners or low calorie sweeteners.

### Example 74. GRU90-MRP-FTA (34-02) Improves the Taste of Luo Han Guo Extract

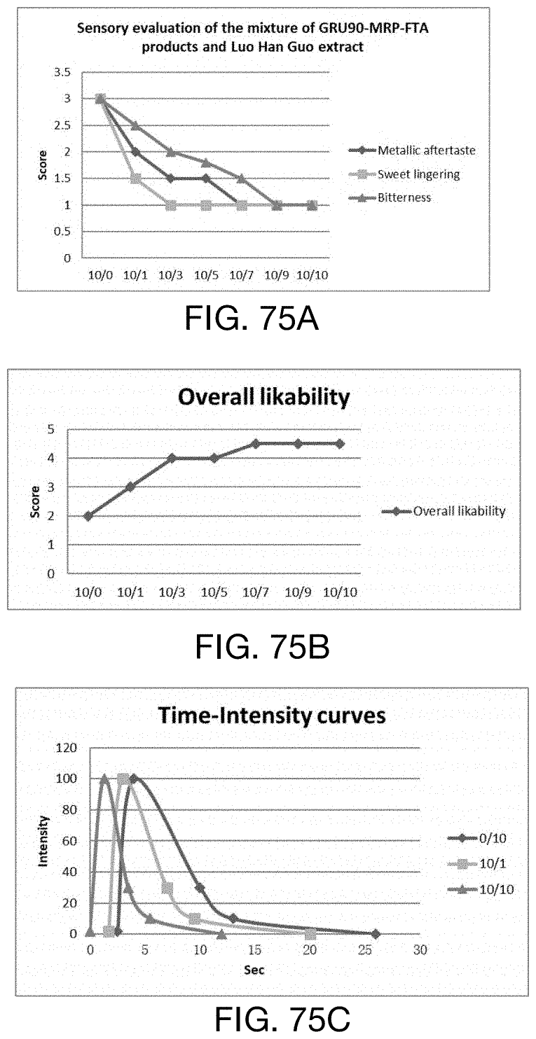

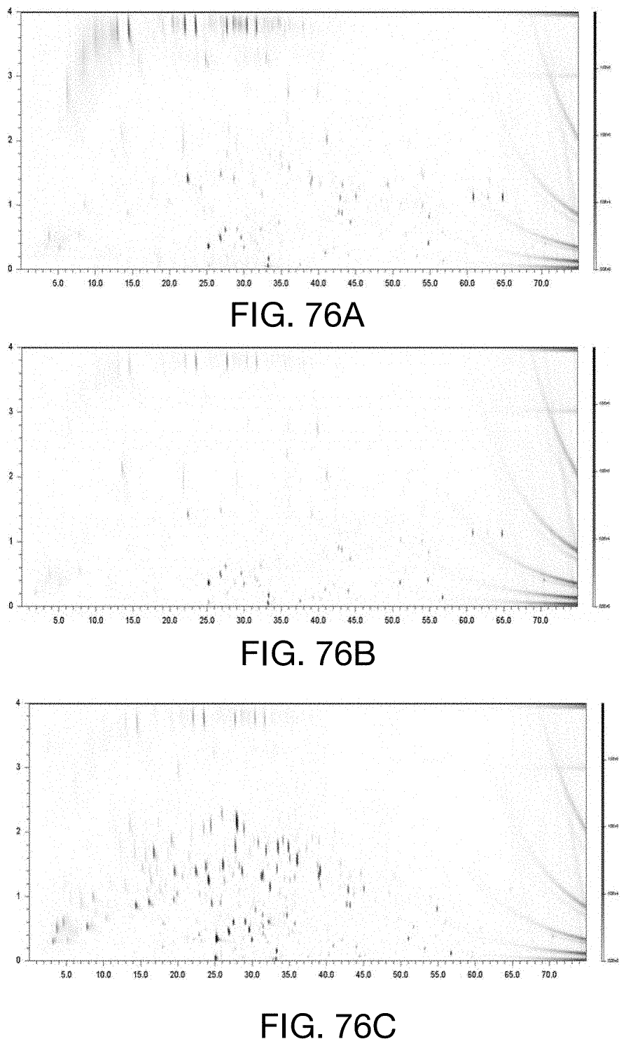

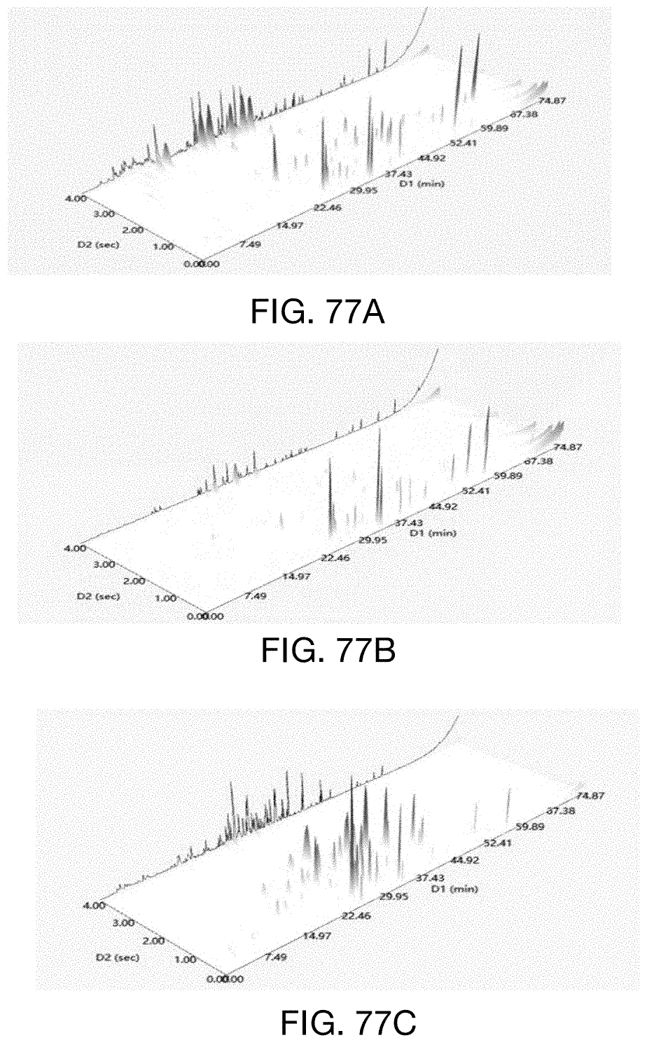

Process: GRU90-MRP-FTA (Ex. 34, 34-02) and Luo Han Guo Extract (Huacheng Biotech, Inc., Lot #LHGE-161112 containing 50% w/w mogroside) were weighed, mixed, dissolved in in 100 ml pure water as set forth in Table 74-1, and subjected to sensory evaluation tests, the results of which are shown in Tables 74-2 and 74-3 below and FIGS. 75A-75C.

TABLE 74-1
Preparation of mixtures of GRU90-
MRP-FTA and Luo Han Guo Extract

| | Ratio of | Weight of | | |
|---|---|---|---|---|
| Sample | Luo Han Guo | Luo Han | Weight of | Volume of |
| mixture | extract to | Guo Extract | GRU90-MRP- | pure water |
| no. | GRU90-MRP-FTA | (mg) | FTA (mg) | (mL) |
| 74-00 | 10/0 | 20 | 0 | 100 |
| 74-01 | 10/1 | 20 | 2 | 100 |
| 74-02 | 10/3 | 20 | 6 | 100 |
| 74-03 | 10/5 | 20 | 10 | 100 |
| 74-04 | 10/7 | 20 | 14 | 100 |
| 74-05 | 10/9 | 20 | 20 | 100 |
| 74-06 | 10/10 | 20 | 20 | 100 |

Experiments: Several mixtures of GRU90-MRP-FTA and Luo Han Guo Extract were prepared and evaluated according to the sensory evaluation method in Ex. 5. Average scores from the test panel for each sensory criterion were recorded as the evaluation test results to produce the taste profiles depicted in Table 74-2. In the sensory evaluations, the concentration of Luo Han Guo extract in the sample solution was the same (200 ppm). Time intensity results are shown in Table 74-3.

TABLE 74-2
Sensory evaluation results.

| Sample | | | | |
|---|---|---|---|---|
| mixture | Metallic | Sweet | | Overall |
| no. | aftertaste | lingering | Bitterness | likability |
| 74-00 | 3.00 | 3.00 | 3.00 | 2.00 |
| 74-01 | 2.00 | 1.50 | 2.50 | 3.00 |
| 74-02 | 1.50 | 1.00 | 2.00 | 4 |
| 74-03 | 1.50 | 1.00 | 1.80 | 4 |
| 74-04 | 1.00 | 1.00 | 1.50 | 4.50 |
| 74-05 | 1.00 | 1.00 | 1.00 | 4.50 |
| 74-06 | 1.00 | 1.00 | 1.00 | 4.50 |

TABLE 74-3
Time-intensity results

| Sample | | | LINGERING | LINGERING |
|---|---|---|---|---|
| mixture | ONSET | MAX | ON | OFF |
| no. | [sec] | [sec] | [sec] | [sec] |
| 74-00 | 2.5 | 4 | 10 | 26 |
| 74-01 | 1.7 | 3 | 7 | 20 |
| 74-02 | 1.2 | 2.5 | 6 | 16 |
| 74-03 | 1 | 2 | 5 | 13 |
| 74-04 | 0.8 | 1.3 | 5 | 12 |
| 74-05 | 0.5 | 1.3 | 4.5 | 12 |
| 74-06 | 0 | 1.3 | 3.5 | 12 |

Data analysis: The relationship between the sensory evaluation results as a function of the weight ratio of Luo Han Guo extract to GRU90-MRP-FTA is shown in FIG. 75A. FIG. 75B shows the relationship between the overall likability as a function of the weight ratio of Luo Han Guo extract to GRU90-MRP-FTA based on the sensory evaluation results in Table 74-2. FIG. 75C shows time-intensity curves as a function of the weight ratio of Luo Han Guo extract to GRU90-MRP-FTA, based on the results in Table 74-3.

Conclusion: These results show that GRU90-MRP-FTA can significantly improve mouth feel, reduce sweet lingering, quicken sweetness onset and mask the bitterness of a Luo Han Guo extract. This effect was observed at all tested weight ratios of Luo Han Guo extract-to-GRU90-MRP-FTA (from 10:1 to 10:10). These effects can be further extended to Luo Han Guo extract-to-GRU90-MRP-FTA ratio ranges from 99:1 to 1:99. This example demonstrates that G-ST-MRPs can improve taste profile, flavor intensity and mouth feel of natural sweeteners, such as Luo Han Guo extract. The observed effects can be extended to all natural sweeteners.

### Example 75. Analysis of Volatile Organic Compounds in Sweet Tea Extracts, their Glucosylated Products, and their MRPs by Comprehensive Two Dimensional Gas Chromatography Time-of-Flight Mass Spectrometry

TABLE 75-1
Sample materials.

| Sample | Specification | Lot # | Source | Note |
|---|---|---|---|---|
| Sweet tea | RU10 | STL12- | Guilin Layin | Content of |
| extract | | 20011602 | Natural | rubusoside, |
| (STE) | | | Ingredients | 11.66% |
| | | | Corp. | |
| | RU40 | 307-48-02 | Huacheng | Content of |
| | | | Biotech, Inc. | rubusoside, |
| | | | | 40.3% |
| | RU90 | STL13- | Guilin Layin | Content of |
| | | 20032201 | Natural | rubusoside, |
| | | | Ingredients | 90.17% |
| | | | Corp. | |
| Glycosylated | GRU10 | 307-71-01 | EPC Natural | Product of |
| sweet tea | | | Products | Ex. 50 |
| extract | GRU40 | 307-80-03 | Co., Ltd. | Product of |
| (GSTE) | | | | Ex. 58 |
| | GRU90 | 307-77-03 | | Produced |
| | | | | according to |
| | | | | the same |
| | | | | method of |
| | | | | Ex. 7 |
| Maillard | GRU10-MRP- | 307-71-02 | | Product of |
| reaction | FTA | | | Ex. 52 |
| product | GRU40-MRP- | 307-81-01 | | Product of |
| (MRP) | FTA | | | Ex. 59 |
| | GRU90-MRP- | 307-78-01 | | Product of |
| | FTA | | | Ex. 19-03 |

Assay for volatile organic compounds: sample preparation.

Solid phase micro-extraction (SPME) was employed using a manual fiber holder (Supelco, USA) and a PDMS/CAR/DVB fiber (Supelco, USA). Each sample (0.8 g) was placed in a 20 mL headspace vial, dissolved in 0.2 g/ml NaCl aqueous solution (5 ml), and conditioned for 15 min at 60° C. After 30 min extraction of sample, the fiber was thermally desorbed in the injector port of the GC at 250° C. for 3 min.

Instrument:

Agilent 7890B GC

Solid State Modulator SSM 1810, J&X Technologies

EI-0610 TOFMS, Hexin Mass Spectrometry

Software

Canvas GCxGC Data Processing Software

NIST 17 Mass Spectral Library

Column

1st column: DB-WAX 30 m*0.25 mm*0.25 μm

2nd column: DB-17MS 1.195 m*0.25 mm*0.15 μm

Modulation column: HV (C5-C30) 1.1 m

GC

Oven: 40° C. (5 min) to 250° C. (0 min) @ 3° C./min

Carrier Gas: He@1.0 mL/min

Injection: 250° C. (splitless)

SSM1810

Hot zone (entry): +30° C. (offset to GC oven)

Hot zone (exit): +120° C. (offset to GC oven, capped at 320° C.)

Trap: −51° C.

Modulation Period: 4 s

TOFMS

Ion source temp: 230° C.

Transfer line: 250° C.

Mass Range: 40-400 m/z

Scan rate: 100 Hz

Results and Discussion

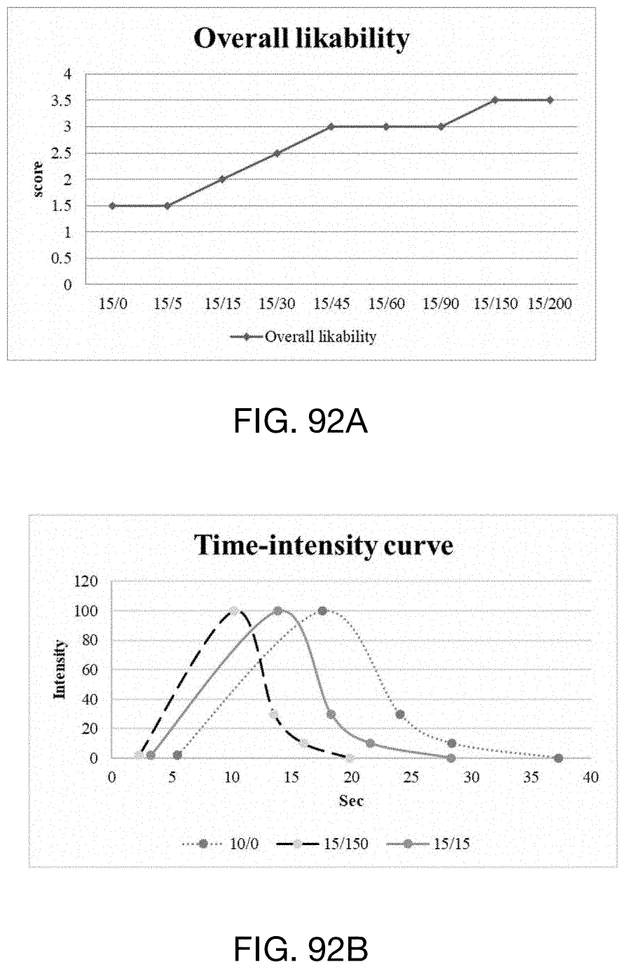

FIGS. 92A-92C show total ion chromatograms (TIC) of the RU10, GRU10 and GRU10-MRP-FTA samples detected by SPME-GCXGC-TOFMS, respectively.

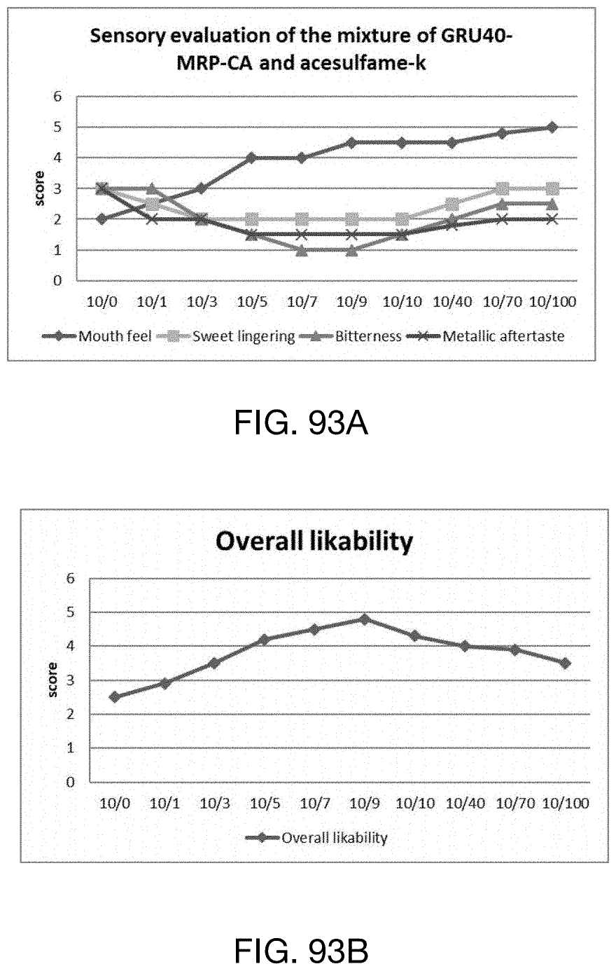

FIGS. 93A-93C show 3D surface plots of the RU10, GRU10 and GRU10-MRP-FTA samples detected by SPME-GCXGC-TOFMS, respectively.

Data processing was performed using Canvas GCxGC Data Processing Software (J&X Technologies. Version 1.5). Compound identification was achieved based on mass spectra comparisons with NIST 17. Compounds with forward and reverse matching degrees ≥700 and a peak area percentages ≥0.02% were selected for inclusion in Tables 75-2 to 75-5. A series of n-alkanes (C8-C25) were injected separately to establish first-dimension retention indices (RI1). Experimental retention indices (RI) were calculated using the n-alkane RI values and compared to literature values (NIST RI) for further confirmation. A blank run was also performed for background correction of the samples. Hundreds of volatile organic compounds (VOCs) are identified in RU10, GRU10 and GRU10-MRP-FTA.

34 VOCs including alkanes, aldehydes, ketones, esters, and alcohols, were identified in the RU10, GRU10 and GRU10-MRP-FTA samples (listed in Table 75-2). 14 of these are aroma substances. Aroma substances identified in RU10, GRU10 and GRU10-MRP-FTA are listed in Tables 75-3 to 75-5 below.

TABLE 75-2
Volatile compounds identified in RU10, GRU10 and GRU10-MRP-FTA samples.

| | | Relative percentage (%) | | | |
|---|---|---|---|---|---|
| | | | | GRU10- | |
| Compounds | CAS # | RU10 | GRU10 | MRP-FTA | Odor/flavor |
| Hydrocarbons | | | | | |
| Dodecane | 112-40-3 | 5.32 | 2.28 | 0.72 | |
| Tridecane | 629-50-5 | 0.42 | 0.11 | 0.06 | |
| Neopentane | 463-82-1 | 0.01 | 0.36 | 0.01 | |
| Tetradecane | 629-59-4 | 4.52 | 4.77 | 1.34 | |
| Pentadecane | 629-62-9 | 2.65 | 5.37 | 0.73 | |
| Hexadecane | 544-76-3 | 2.68 | 2.77 | 0.48 | |
| Aldehyde | | | | | |
| Aliphatic | | | | | |
| Nonanal | 124-19-6 | 2.32 | 2.46 | 1.55 | Odor: waxy aldehydic, |
| | | | | | rose, fresh orris, orange |
| | | | | | peel, fatty Flavor: |
| | | | | | effervescent, aldehydic |
| | | | | | citrus, cucumber and |
| | | | | | melon rindy, with raw |
| | | | | | potato and oily nutty and |
| | | | | | coconut like nuances |
| Decanal | 112-31-2 | 0.54 | 0.81 | 0.06 | Odor: sweet aldehydic |
| | | | | | waxy orange peel citrus |
| | | | | | floral |
| | | | | | Flavor: waxy, fatty, citrus |
| | | | | | and orange peel with a |
| | | | | | slight green melon nuance |
| Aromatic | | | | | |
| Benzaldehyde | 100-52-7 | 0.76 | 1.59 | 1.25 | Odor: strong sharp sweet |
| | | | | | bitter almond cherry |
| | | | | | Flavor: sweet, oily, |
| | | | | | almond, cherry, nutty and |
| | | | | | woody |
| Benzeneacetaldehyde | 122-78-1 | 0.25 | 0.8 | 0.7 | Odor: green sweet floral |
| | | | | | hyacinth clover honey |
| | | | | | cocoa |
| | | | | | Flavor: honey, sweet, |
| | | | | | floral, chocolate and cocoa, |
| | | | | | with a spicy nuance |
| 2-Furancarboxaldehyde, 5- | 620-02-0 | 0.49 | 1.35 | 1.6 | Odor: spice caramel maple |
| methyl- | | | | | Flavor: sweet, brown, |
| | | | | | caramellic, grain, maple- |
| | | | | | like |
| Monoterpene | | | | | |
| Safranal | 116-26-7 | 0.23 | 0.14 | 1.78 | Odor: fresh herbal phenolic |
| | | | | | metallic rosemary tobacco |
| | | | | | spicy |
| | | | | | Flavor: woody, medicinal, |
| | | | | | phenolic, spicy and |
| | | | | | camphoraceous with a |
| | | | | | fruity, herbal nuance |
| Alcohols | | | | | |
| Ethanol, 2-(2-ethoxyethoxy)- | 111-90-0 | 0.11 | 0.6 | 0.09 | Odor: slightly ethereal |
| 2-Furanmethanol | 98-00-0 | 0.99 | 5.84 | 1.57 | Odor: alcoholic chemical |
| | | | | | musty sweet caramel bread |
| | | | | | coffee |
| | | | | | Flavor: burnt, sweet, |
| | | | | | caramellic, brown |
| Benzyl alcohol | 100-51-6 | 0.31 | 0.78 | 0.21 | Odor: floral rose phenolic |
| | | | | | balsamic |
| | | | | | Flavor: chemical fruity |
| | | | | | cherry almond balsamic |
| | | | | | bitter |
| Phenylethyl Alcohol | 60-12-8 | 0.07 | 0.28 | 0.09 | Odor: floral rose dried rose |
| | | | | | flower rose water |
| | | | | | Flavor: floral, sweet, rosy |
| | | | | | and bready |
| Esters | | | | | |
| Dihydroactinidolide | 15356-74-8 | 0.36 | 0.7 | 0.52 | Odor: ripe apricot red fruit |
| | | | | | woody |
| Ethanone, 2-(formyloxy)-1- | 55153-12-3 | | | | |
| phenyl- | | | | | |
| 2(3H)-Furanone, 5-methyl- | 591-12-8 | 0.02 | 0.07 | 0.05 | |
| Ketones | | | | | |
| 4-Cyclopentene-1,3-dione | 930-60-9 | 0.29 | 1.69 | 0.86 | |
| 2,3-Pentanedione | 600-14-6 | 0.18 | 0.53 | 0.89 | Odor: pungent sweet butter |
| | | | | | creamy caramel nutty |
| | | | | | cheese |
| | | | | | Flavor: toasted, buttery and |
| | | | | | caramellic with |
| | | | | | marshmallow and molasses |
| | | | | | nuances |
| 1H-Pyrrole-2,5-dione, 3- | 20189-42-8 | 0.11 | 0.12 | 0.2 | |
| ethyl-4-methyl- | | | | | |
| Others | | | | | |
| Benzofuran, 2,3-dihydro- | 496-16-2 | 0.14 | 2.87 | 0.79 | |

TABLE 75-3
Aroma substances identified in RU10.

| | | Rel. | | Odor |
|---|---|---|---|---|
| Compounds | CAS # | (%) | Odor/flavor | strength |
| Alcohols | | | | |
| Monoterpenes | | | | |
| Linalool | 78-70-6 | 0.24 | Odor: citrus floral sweet bois de rose | medium |
| | | | woody green blueberry | |
| | | | Flavor: citrus, orange, lemon, floral, waxy, | |
| | | | aldehydic and woody | |
| Aromatic | | | | |
| Benzyl alcohol | 100-51-6 | 0.31 | Odor: floral rose phenolic balsamic | medium |
| | | | Flavor: chemical fruity cherry almond | |
| | | | balsamic bitter | |
| Phenylethyl Alcohol | 60-12-8 | 0.07 | Odor: floral rose dried rose flower rose | medium |
| | | | water | |
| | | | Flavor: floral, sweet, rosy and bready | |
| Furan derivatives | | | | |
| 2-Furanmethanol | 98-00-0 | 0.99 | Odor: alcoholic chemical musty sweet | medium |
| | | | caramel bread coffee | |
| | | | Flavor: burnt, sweet, caramellic, brown | |
| Aldehydes | | | | |
| Nonanal | 124-19-6 | 2.32 | Odor: waxy aldehydic rose fresh orris | high |
| | | | orange peel fatty peely | |
| | | | Flavor: effervescent, aldehydic citrus, | |
| | | | cucumber and melon rindy, with raw potato | |
| | | | and oily nutty and coconut like nuances | |
| Decanal | 112-31-2 | 0.54 | Odor: sweet aldehydic waxy orange peel | high |
| | | | citrus floral | |
| | | | Flavor: waxy, fatty, citrus and orange peel | |
| | | | with a slight green melon nuance | |
| Monoterpenes | | | | |
| Safranal | 116-26-7 | 0.23 | Odor: fresh herbal phenolic metallic | high |
| | | | rosemary tobacco spicy | |
| | | | Flavor: woody, medicinal, phenolic, spicy | |
| | | | and camphoraceous with a fruity, herbal | |
| | | | nuance | |
| Furan derivatives | | | | |
| 2- | 620-02-0 | 0.49 | Odor: spice caramel maple | medium |
| Furancarboxaldehyde, | | | Flavor: sweet, brown, caramellic, grain, | |
| 5-methyl- | | | maple-like | |
| Aromatic | | | | |
| Benzaldehyde | 100-52-7 | 0.76 | Odor: strong sharp sweet bitter almond | high |
| | | | cherry | |
| | | | Flavor: sweet, oily, almond, cherry, nutty | |
| | | | and woody | |
| Benzeneacetaldehyde | 122-78-1 | 0.25 | Odor: green sweet floral hyacinth clover | high |
| | | | honey cocoa | |
| | | | Flavor: honey, sweet, floral, chocolate and | |
| | | | cocoa, with a spicy nuance | |
| Benzaldehyde, 3- | 620-23-5 | 0.03 | Odor: sweet fruity cherry benzaldehyde | medium |
| methyl- | | | phenolic | |
| | | | Flavor: sweet fruity bitter almond cherry | |
| | | | tropical nutty | |
| Ketones | | | | |
| 6-Methyl-3,5- | 1604-28-0 | 0.07 | Odor: cinnamon coconut spice woody | medium |
| heptadiene-2-one | | | sweet weedy | |
| | | | Flavor: green, sweet, with a brown herbal | |
| | | | aftertaste | |
| (E)-beta- | 23726-93-4 | 0.39 | Odor: apple rose honey tobacco sweet | high |
| damascenone | | | | |
| 2(3H)-Furanone, 5- | 591-12-8 | 0.02 | Odor: sweet solvent nutty tonka coumarin | medium |
| methyl- | | | tobacco | |
| | | | Flavor: sweet, creamy, coconut, vanilla hay | |
| | | | and coumarin-like nuances | |
| 2,3-Pentanedione | 600-14-6 | 0.18 | Odor: pungent sweet butter creamy | high |
| | | | caramel nutty cheese | |
| | | | Flavor: toasted, buttery and caramellic with | |
| | | | marshmallow and molasses nuances | |
| 2-Acetyl-5- | 1193-79-9 | 0.02 | Odor: strong musty nutty hay coconut | high |
| methylfuran | | | coumarin milky | |
| | | | Flavor: nutty cocoa-like with a toasted | |
| | | | bready nuance | |
| Ester | | | | |
| Dihydroactinidolide | 15356-74-8 | 0.36 | Odor: ripe apricot red fruit woody | high |
| Butyrolactone | 96-48-0 | 0.11 | Odor: creamy oily fatty caramel | medium |
| | | | Flavor: milky, creamy with fruity | |
| | | | peach-like afternotes | |

TABLE 75-4
Aroma substances identified in GRU10.

| | | Rel. | | Odor |
|---|---|---|---|---|
| Compounds | CAS # | (%) | Odor/flavor | strength |
| Alcohols | | | | |
| Monoterpenes | | | | |
| Ocimenol | 5986-38-9 | 0.23 | Odor: fresh citrus lemon lime cologne sweet | medium |
| | | | mace | |
| Aromatic | | | | |
| Benzyl alcohol | 100-51-6 | 0.78 | Odor: floral rose phenolic balsamic | medium |
| | | | Flavor: chemical fruity cherry almond | |
| | | | balsamic bitter | |
| Phenylethyl Alcohol | 60-12-8 | 0.28 | Odor: floral rose dried rose flower rose water | medium |
| | | | Flavor: floral, sweet, rosy and bready | |
| Furan derivatives | | | | |
| 2-Furanmethanol | 98-00-0 | 5.84 | Odor: alcoholic chemical musty sweet caramel | medium |
| | | | bread coffee | |
| | | | Flavor: burnt, sweet, caramellic, brown | |
| Aldehydes | | | | |
| Nonanal | 124-19-6 | 2.46 | Odor: waxy aldehydic rose fresh orris orange | high |
| | | | peel fatty peely | |
| | | | Flavor: effervescent, aldehydic citrus, | |
| | | | cucumber and melon rindy, with raw potato | |
| | | | and oily nutty and coconut like nuances | |
| Decanal | 112-31-2 | 0.81 | Odor: sweet aldehydic waxy orange peel citrus | high |
| | | | floral | |
| | | | Flavor: waxy, fatty, citrus and orange peel | |
| | | | with a slight green melon nuance | |
| Monoterpenes | | | | |
| Safranal | 116-26-7 | 0.14 | Odor: fresh herbal phenolic metallic rosemary | high |
| | | | tobacco spicy | |
| | | | Flavor: woody, medicinal, phenolic, spicy and | |
| | | | camphoraceous with a fruity, herbal nuance | |
| Furan derivatives | | | | |
| 2- | 620-02-0 | 1.35 | Odor: spice caramel maple | medium |
| Furancarboxaldehyde, | | | Flavor: sweet, brown, caramellic, grain, | |
| 5-methyl- | | | maple-like | |
| Aromatic | | | | |
| Benzaldehyde | 100-52-7 | 1.59 | Odor: strong sharp sweet bitter almond cherry | high |
| | | | Flavor: sweet, oily, almond, cherry, nutty and | |
| | | | woody | |
| Benzeneacetaldehyde | 122-78-1 | 0.8 | Odor: green sweet floral hyacinth clover | high |
| | | | honey cocoa | |
| | | | Flavor: honey, sweet, floral, chocolate and | |
| | | | cocoa, with a spicy nuance | |
| Acetal | | | | |
| 1,3-Dioxolane, 2- | 4359-57-3 | 0.2 | Odor: fresh citrus orange aldehydic fatty | medium |
| heptyl- | | | | |
| Ketones | | | | |
| 2,3-Butanedione | 431-03-8 | 0.76 | Odor: strong butter sweet creamy pungent | high |
| | | | caramel | |
| | | | Flavor: sweet, buttery, creamy, milky | |
| 2,3-Pentanedione | 600-14-6 | 0.53 | Odor: pungent sweet butter creamy caramel | high |
| | | | nutty cheese | |
| | | | Flavor: toasted, buttery and caramellic with | |
| | | | marshmallow and molasses nuances | |
| Acid | | | | |
| Acetic acid | 64-19-7 | 1.27 | Odor: sharp pungent sour vinegar | high |
| | | | Flavor: pungent sour overripe fruit | |
| Butanoic acid, 3- | 503-74-2 | 0.29 | Odor: sour stinky feet sweaty cheese tropical | high |
| methyl- | | | Flavor: cheesy, dairy, creamy, fermented, | |
| | | | sweet, waxy and berry | |
| Hexanoic acid | 142-62-1 | 0.29 | Odor: sour fatty sweat cheese | medium |
| | | | Flavor: cheesy fruity phenolic fatty goaty | |
| Ester | | | | |
| Dihydroactinidolide | 15356-74-8 | 0.7 | Odor: ripe apricot red fruit woody | high |
| Butyrolactone | 96-48-0 | 0.44 | Odor: creamy oily fatty caramel | medium |
| | | | Flavor: milky, creamy with fruity peach-like | |
| | | | afternotes | |
| 2(3H)-Furanone, 5- | 591-12-8 | 0.07 | Odor: sweet solvent nutty tonka coumarin | |
| methyl- | | | tobacco | |
| | | | Flavor: sweet, creamy, coconut, vanilla hay | |
| | | | and coumarin-like nuances | |
| Benzoic acid, 2- | 85-91-6 | 0.16 | Odor: fruity musty sweet neroli powdery | medium |
| (methylamino)-, | | | phenolic wine | |
| methyl ester | | | Flavor: fruity grape skin, anthranilate-like | |
| | | | with a woody and floral nuance | |

TABLE 75-5
Aroma substances identified in GRU10-MRP-FTA.

| | | Rel. | | Odor |
|---|---|---|---|---|
| Compounds | CAS# | (%) | Odor/flavor | strength |
| Alcohols | | | | |
| Monoterpenes | | | | |
| Linalool | 78-70-6 | 1.12 | Odor: citrus floral sweet bois de | medium |
| | | | rose woody green blueberry | |
| | | | Flavor: citrus, orange, lemon, | |
| | | | floral, waxy, aldehydic and woody | |
| α-Terpineol | 98-55-5 | 0.48 | Odor: pine terpene lilac citrus | medium |
| | | | woody floral | |
| | | | Flavor: citrus woody with a lemon | |
| | | | and lime nuance, it has a slight | |
| | | | soapy mouth feel | |
| Aromatic | | | | |
| Benzyl alcohol | 100-51-6 | 0.21 | Odor: floral rose phenolic balsamic | medium |
| | | | Flavor: chemical fruity cherry | |
| | | | almond balsamic bitter | |
| Phenylethyl Alcohol | 60-12-8 | 0.09 | Odor: floral rose dried rose flower | medium |
| | | | rose water | |
| | | | Flavor: floral, sweet, rosy and | |
| | | | bready | |
| Furan derivatives | | | | |
| 2-Furanmethanol | 98-00-0 | 1.57 | Odor: alcoholic chemical musty | medium |
| | | | sweet caramel bread coffee | |
| | | | Flavor: burnt, sweet, caramellic, | |
| | | | brown | |
| Aldehydes | | | | |
| Nonanal | 124-19-6 | 1.55 | Odor: waxy aldehydic rose fresh | high |
| | | | orris orange peel fatty peely | |
| | | | Flavor: effervescent, aldehydic | |
| | | | citrus, cucumber and melon rindy, | |
| | | | with raw potato and oily nutty and | |
| | | | coconut like nuances | |
| 2-Hexenal | 505-57-7 | 1.45 | Odor: sweet almond fruity green | medium |
| | | | leafy apple plum vegetable | |
| Monoterpenes | | | | |
| Safranal | 116-26-7 | 1.78 | Odor: fresh herbal phenolic | high |
| | | | metallic rosemary tobacco spicy | |
| | | | Flavor: woody, medicinal, | |
| | | | phenolic, spicy and camphoraceous | |
| | | | with a fruity, herbal nuance | |
| 3 -Cyclohexene-1- | 29548-14-9 | 1.57 | Odor: spicy herbal | high |
| acetaldehyde, α,4- | | | | |
| dimethyl- | | | | |
| Furan derivatives | | | | |
| Furfural | 98-01-1 | 6.96 | Odor: sweet woody almond | medium |
| | | | fragrant baked bread | |
| | | | Flavor: brown, sweet, woody, | |
| | | | bready, nutty, caramellic with a | |
| | | | burnt astringent nuance | |
| 2- | 620-02-0 | 1.6 | Odor: spice caramel maple | medium |
| Furancarboxaldehyde, | | | Flavor: sweet, brown, caramellic, | |
| 5-methyl- | | | grain, maple-like | |
| Aromatic | | | | |
| Benzaldehyde | 100-52-7 | 1.25 | Odor: strong sharp sweet bitter | high |
| | | | almond cherry | |
| | | | Flavor: sweet, oily, almond, cherry, | |
| | | | nutty and woody | |
| Benzeneacetaldehyde | 122-78-1 | 0.7 | Odor: green sweet floral hyacinth | high |
| | | | clover honey cocoa | |
| | | | Flavor: honey, sweet, floral, | |
| | | | chocolate and cocoa, with a spicy | |
| | | | nuance | |
| Benzaldehyde, 3- | 620-23-5 | 0.31 | Odor: sweet fruity cherry | medium |
| methyl- | | | benzaldehyde phenolic | |
| | | | Flavor: sweet fruity bitter almond | |
| | | | cherry tropical nutty | |
| Ketones | | | | |
| Ethanone, 1-(2- | 1192-62-7 | 2.24 | Odor: sweet balsam almond cocoa | high |
| furanyl)- | | | caramel coffee | |
| | | | Flavor: sweet, nutty and roasted | |
| | | | with a sweet, baked-goods body | |
| 2-Buten-1-one, 1- | 23726-93-4 | 1.14 | Odor: apple rose honey tobacco | high |
| (2,6,6-trimethyl-1,3- | | | sweet | |
| cyclohexadien-1-yl)-, | | | | |
| (E)- | | | | |
| 2,3-Pentanedione | 600-14-6 | 0.89 | Odor: pungent sweet butter creamy | high |
| | | | caramel nutty cheese | |
| | | | Flavor: toasted, buttery and | |
| | | | caramellic with marshmallow and | |
| | | | molasses nuances | |
| 2,3-Octanedione | 585-25-1 | 0.48 | Odor: dill asparagus cilantro herbal | medium |
| | | | aldehydic earthy fatty cortex | |
| | | | Flavor: green spicy cilantro fatty | |
| | | | leafy cortex herbal | |
| 6-Methyl-3,5- | 1604-28-0 | 0.39 | Odor: cinnamon coconut spice | medium |
| heptadiene-2-one | | | woody sweet weedy | |
| | | | Flavor: green, sweet, with a brown | |
| | | | herbal aftertaste | |
| 5-Hepten-2-one, 6- | 110-93-0 | 0.31 | Odor: citrus green musty | medium |
| methyl- | | | lemongrass apple | |
| | | | Flavor: green, vegetative, musty, | |
| | | | apple, banana and green bean-like | |
| Ethanone, 1-(1H- | 1072-83-9 | 0.15 | Odor: musty nut skin maraschino | medium |
| pyrrol-2-yl)- | | | cherry coumarinic licorice walnut | |
| | | | bready | |
| | | | Flavor: sweet fruity musty cherry | |
| | | | nutty wasabi mustard tea | |
| 1-Propanone, 1-(2- | 3194-15-8 | 0.09 | Flavor: slight fruity | |
| furanyl)- | | | | |
| Acetophenone | 98-86-2 | 0.09 | Odor: sweet pungent hawthorn | high |
| | | | mimosa almond acacia chemical | |
| | | | Flavor: powdery, bitter almond | |
| | | | cherry pit-like with coumarinic and | |
| | | | fruity nuances | |
| Acids | | | | |
| Acetic acid | 64-19-7 | 1.66 | Odor: sharp pungent sour vinegar | high |
| | | | Flavor: pungent sour overripe fruit | |
| Ester | | | | |
| Dihydroactinidolide | 15356-74-8 | 0.52 | Odor: ripe apricot red fruit woody | high |
| Hydrocarbons | | | | |
| p-Cymene | 99-87-6 | 1.69 | Odor: fresh citrus terpene woody | high |
| | | | spice | |
| | | | Flavor: terpy and rancid with | |
| | | | slightly woody oxidized citrus | |
| | | | notes, it has spice nuances of green | |
| | | | pepper and oregano | |

Summary: The sweet tea extract RU10 and its glycosylated products and Maillard reaction products contain hundreds of VOCs, including hydrocarbons, ketones, aldehydes, alcohols and esters. The aroma substances among these VOCs play an important role in the flavor of the product.

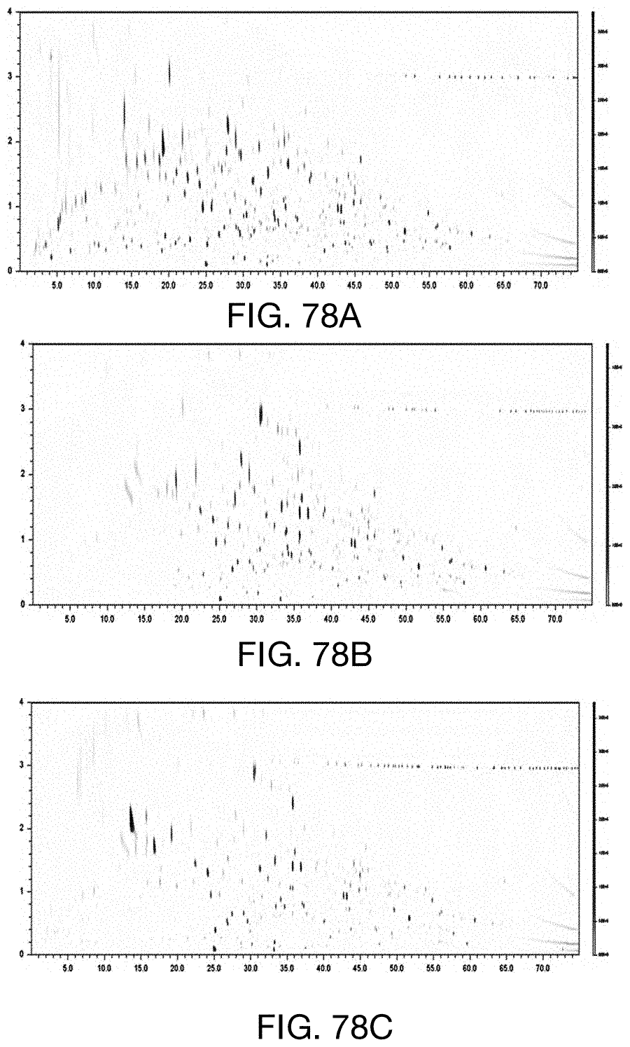

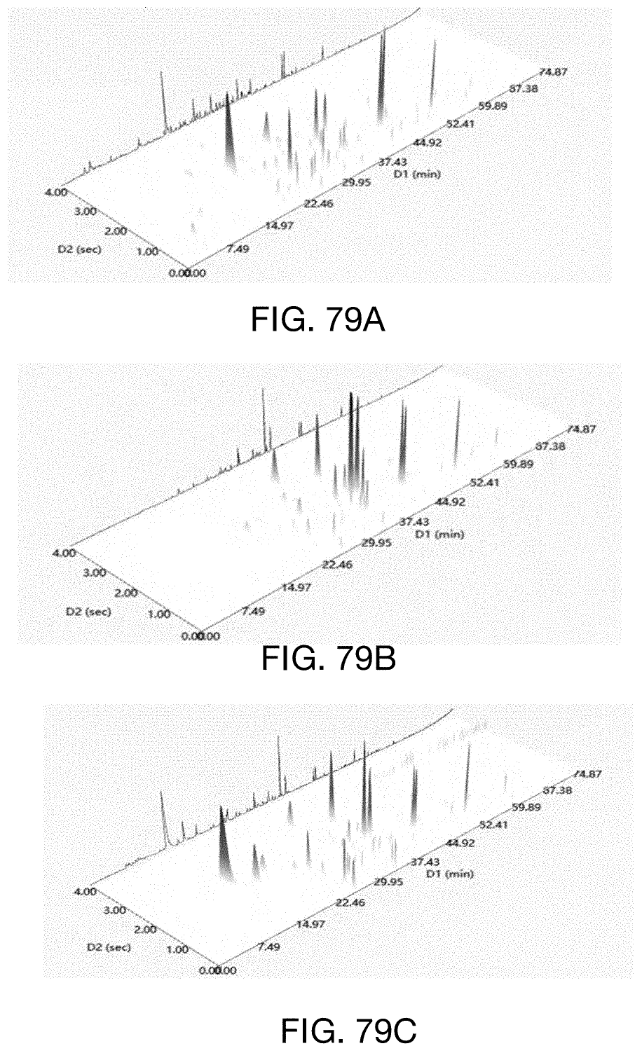

FIGS. 78A-78C and 79A-79C show total ion chromatograms (TIC) of the RU40, GRU40 and GRU40-MRP-FTA samples in Ex. 75 detected by SPME-GCxGC-TOFMS.

Data processing was performed using Canvas GC×GC Data Processing Software (J&X Technologies. Version 1.8). Compound identification was achieved based on mass spectra comparison with NIST 17. Compounds with forward and reverse matching degrees ≥750 and a peak area percentages ≥0.05% were selected for inclusion in Tables 76-6 to 75-9. A series of n-alkanes (C8-C25) were injected separately to establish first-dimension retention indices (RI1). Experimental retention indices (RI) were calculated using the n-alkanes RI values and compared to literature values (NIST RI) for further confirmation. A blank run was also performed for background correction of the samples. Lots of volatile organic compounds (VOCs) are identified in RU40, GRU40 and GRU40-MRP-FTA, respectively.

19 VOCs including alkanes, aldehydes, ketones, esters, alcohols and acids were identified among RU40, GRU40 and GRU40-MRP-FTA (listed in Table 75-6). 16 of these are aroma substances. Aroma substances identified in RU40, GRU40 and GRU40-MRP-FTA are listed in Tables 75-7 to 75-9, respectively.

TABLE 75-6
Volatile compounds identified in RU40, GRU40 and GRU40-MRP-FTA.

| | | Relative percentage (%) | | | |
|---|---|---|---|---|---|
| | | | | GRU40- | |
| Compounds | CAS # | RU40 | GRU40 | MRP-FTA | Odor/flavor |
| Hydrocarbons | | | | | |
| 1,1,3-Trimethyl-1H- | 2177-45-9 | 0.09 | 0.11 | 0.10 | |
| indene | | | | | |
| Aldehyde | | | | | |
| Aliphatic | | | | | |
| Nonanal | 124-19-6 | 0.21 | 0.96 | 0.41 | Odor: waxy |
| | | | | | aldehydic rose fresh |
| | | | | | orris orange peel fatty |
| | | | | | peely |
| | | | | | Flavor: effervescent, |
| | | | | | aldehydic citrus, |
| | | | | | cucumber and melon |
| | | | | | rindy. with raw |
| | | | | | potato and oily nutty |
| | | | | | and coconut like |
| | | | | | nuances |
| 3-Cyclohexene-1- | 29548-14-9 | 1.14 | 0.70 | 1.25 | Odor: spicy herbal |
| acetaldehyde, α,4- | | | | | |
| dimethyl- | | | | | |
| Aromatic | | | | | |
| Benzaldehyde | 100-52-7 | 0.31 | 0.65 | 0.12 | Odor: strong sharp |
| | | | | | sweet bitter almond |
| | | | | | cherry |
| | | | | | Flavor: sweet, oily, |
| | | | | | almond, cherry, nutty |
| | | | | | and woody |
| Monoterpene | | | | | |
| Safranal | 116-26-7 | 0.73 | 0.42 | 0.32 | Odor: fresh herbal |
| | | | | | phenolic metallic |
| | | | | | rosemary tobacco |
| | | | | | spicy |
| | | | | | Flavor: woody, |
| | | | | | medicinal, phenolic, |
| | | | | | spicy and |
| | | | | | camphoraceous with |
| | | | | | a fruity, herbal |
| | | | | | nuance |
| Alcohols | | | | | |
| 2-Ethyl-1-hexanol | 104-76-7 | 0.97 | 0.79 | 0.46 | Odor: citrus fresh |
| | | | | | floral oily sweet |
| | | | | | Flavor: sweet fatty |
| | | | | | fruity |
| 2,3-Butanediol | 513-85-9 | 0.27 | 0.14 | 0.14 | Odor: fruity creamy |
| | | | | | buttery |
| Ocimenol | 5986-38-9 | 0.13 | 0.07 | 0.05 | Odor: fresh citrus |
| | | | | | lemon lime cologne |
| | | | | | sweet mace |
| Linalool | 78-70-6 | 0.30 | 0.37 | 0.43 | Odor: citrus floral |
| | | | | | sweet bois de rose |
| | | | | | woody green |
| | | | | | blueberry |
| | | | | | Flavor: citrus, |
| | | | | | orange, lemon, floral, |
| | | | | | waxy, aldehydic and |
| | | | | | woody |
| Monoterpenes | | | | | |
| α-Terpineol | 7785-53-7 | 0.46 | 1.46 | 0.53 | Odor: pine terpene |
| | | | | | lilac citrus woody |
| | | | | | floral |
| | | | | | Flavor: citrus woody |
| | | | | | with a lemon and |
| | | | | | lime nuance, it has a |
| | | | | | slight soapy mouth |
| | | | | | feel |
| Furan derivatives | | | | | |
| Dehydralinalool | 29957-43-5 | 0.30 | 0.12 | 0.08 | Odor: moldy |
| 2-Furanmethanol | 98-00-0 | 0.06 | 0.05 | 0.72 | Odor: alcoholic |
| | | | | | chemical musty |
| | | | | | sweet caramel bread |
| | | | | | coffee |
| | | | | | Flavor: burnt, sweet, |
| | | | | | caramellic, brown |
| Ketones | | | | | |
| (E)-6-Methyl-3,5- | 16647-04-4 | 1.07 | 0.46 | 0.07 | |
| heptadien-2-one | | | | | |
| 2,6,6-Trimethyl-2- | 1125-21-9 | 0.87 | 0.81 | 0.49 | Odor: musty woody |
| cyclohexene-1,4-dione | | | | | sweet tea tobacco leaf |
| | | | | | Flavor: citrus, floral, |
| | | | | | musty, tea like with |
| | | | | | green sweet fruity |
| | | | | | nuances |
| 4-Methyleneisophorone | 20548-00-9 | 0.26 | 0.16 | 0.34 | |
| (E)-beta-damascenone | 23726-93-4 | 0.43 | 0.38 | 0.14 | Odor: apple rose |
| | | | | | honey tobacco sweet |
| 2-Cyclohexen-1-one, 4- | 34318-21-3 | 0.11 | 0.20 | 0.10 | Odor: spicy |
| (3-hydroxy-1-butenyl)- | | | | | |
| 3,5,5-trimethyl- | | | | | |
| Acids | | | | | |
| Acetic acid | 64-19-7 | 1.11 | 1.51 | 3.10 | Odor: sharp pungent |
| | | | | | sour vinegar |
| | | | | | Flavor: pungent sour |
| | | | | | overripe fruit |

TABLE 75-7
Aroma substances identified in RU40.

| | | Rel. | | Odor |
|---|---|---|---|---|
| Compounds | CAS # | (%) | Odor/flavor | strength |
| Hydrocarbons | | | | |
| o-Xylene | 95-47-6 | 0.22 | Odor: geranium | |
| Aldehyde | | | | |
| Aliphatic | | | | |
| (E)-2-Methyl-2- | 497-03-0 | 0.14 | Odor: strong green fruit | high |
| Butenal | | | | |
| Nonanal | 124-19-6 | 0.21 | Odor: waxy aldehydic rose fresh | high |
| | | | orris orange peel fatty peely | |
| | | | Flavor: effervescent, aldehydic | |
| | | | citrus, cucumber and melon rindy, | |
| | | | with raw potato and oily nutty and | |
| | | | coconut like nuances | |
| 2-Hexenal | 505-57-7 | 0.06 | Odor: sweet almond fruity green | medium |
| | | | leafy apple plum vegetable | |
| 3-Cyclohexene-1- | 29548-14-9 | 1.14 | Odor: spicy herbal | high |
| acetaldehyde, α,4- | | | | |
| dimethyl- | | | | |
| α-Campholenal | 4501-58-0 | 0.12 | Odor: herbal green woody amber | high |
| | | | leafy | |
| | | | Flavor: green spicy herbal | |
| | | | chrysanthemum leafy cilantro | |
| | | | woody | |
| Aromatic | | | | |
| Benzaldehyde | 100-52-7 | 0.31 | Odor: strong sharp sweet bitter | high |
| | | | almond cherry | |
| | | | Flavor: sweet, oily, almond, | |
| | | | cherry, nutty and woody | |
| Furan derivatives | | | | |
| 1- | 620-02-0 | 0.92 | Odor: spice caramel maple | medium |
| Furancarboxaldehyde, | | | Flavor: sweet, brown, caramellic, | |
| 5-methyl- | | | grain, maple-like | |
| Monoterpene | | | | |
| Safranal | 116-26-7 | 0.73 | Odor: fresh herbal phenolic | high |
| | | | metallic rosemary tobacco spicy | |
| | | | Flavor: woody, medicinal, | |
| | | | phenolic, spicy and | |
| | | | camphoraceous with a fruity, | |
| | | | herbal nuance | |
| Alcohols | | | | |
| Ethanol | 64-17-5 | 0.55 | Odor: strong alcoholic ethereal | medium |
| | | | medical | |
| 1-Butanol | 71-36-3 | 0.09 | Odor: fuel oil sweet balsam | medium |
| | | | whiskey | |
| | | | Flavor: banana fusel | |
| 2-Butanol | 78-92-2 | 0.28 | Odor: sweet apricot | medium |
| 2-Methyl-1- | 137-32-6 | 0.16 | Odor: roasted wine onion fruity | medium |
| butanol | | | fusel alcoholic whiskey | |
| 1-Pentanol | 71-41-0 | 0.18 | Odor: fuel oil sweet balsam | high |
| | | | Flavor: intense fusel, fermented, | |
| | | | bready and cereal with a fruity | |
| | | | undernote | |
| 3-Pentanol | 584-02-1 | 0.15 | Odor: sweet herbal oily nutty | high |
| 1-Hexanol | 111-27-3 | 0.31 | Odor: ethereal fuel oil fruity | medium |
| | | | alcoholic sweet green | |
| | | | Flavor: green, fruity, apple-skin | |
| | | | and oily | |
| (S)-2-Hexanol | 52019-78-0 | 0.12 | Odor: mushroom green ripe berry | medium |
| | | | astringent metallic | |
| 3-Hexanol | 623-37-0 | 0.13 | Odor: alcoholic medicinal ethereal | high |
| | | | Flavor: alcoholic solvent like, | |
| | | | fusel notes of rum, eggnog and | |
| | | | whiskey, green fruity nuances of | |
| | | | guava and apple | |
| 2-Ethyl-1-hexanol | 104-76-7 | 0.97 | Odor: citrus fresh floral oily sweet | medium |
| | | | Flavor: sweet fatty fruity | |
| 2-Heptanol | 543-49-7 | 0.65 | Odor: fresh lemon grass herbal | medium |
| | | | sweet floral fruity green | |
| | | | Flavor: fruity green earthy bitter | |
| 2,3-Butanediol | 513-85-9 | 0.27 | Odor: fruity creamy buttery | medium |
| Eucalyptol | 470-82-6 | 1.91 | Odor: eucalyptus herbal camphor | high |
| | | | medicinal | |
| | | | Flavor: minty camphoraceous | |
| | | | cooling eucalyptus medicinal | |
| Ocimenol | 5986-38-9 | 0.13 | Odor: fresh citrus lemon lime | medium |
| | | | cologne sweet mace | |
| Myrcenol | 543-39-5 | 0.10 | Odor: fresh floral lavender citrus | medium |
| Monoterpene | | | | |
| Linalool | 78-70-6 | 0.30 | Odor: citrus floral sweet bois de | medium |
| | | | rose woody green blueberry | |
| | | | Flavor: citrus, orange, lemon, | |
| | | | floral, waxy, aldehydic and woody | |
| α-Terpineol | 7785-53-7 | 0.46 | Odor: pine terpene lilac citrus | medium |
| | | | woody floral | |
| | | | Flavor: citrus woody with a lemon | |
| | | | and lime nuance; has a slight | |
| | | | soapy mouth feel | |
| Dehydralinalool | 29957-43-5 | 0.30 | Odor: moldy | |
| E-Linalool oxide | 34995-77-2 | 1.23 | Odor: floral | |
| (furanoid) | | | | |
| Z-Linalool oxide | 5989-33-3 | 3.64 | Odor: earthy floral sweet woody | medium |
| (furanoid) | | | | |
| Furan derivatives | | | | |
| 2-Furanmethanol | 98-00-0 | 0.06 | Odor: alcoholic chemical musty | medium |
| | | | sweet caramel bread coffee | |
| | | | Flavor: burnt, sweet, caramellic, | |
| | | | brown | |
| Aromatic | | | | |
| Benzyl alcohol | 100-51-6 | 0.34 | Odor: floral rose phenolic | medium |
| | | | balsamic | |
| | | | Flavor: chemical fruity cherry | |
| | | | almond balsamic bitter | |
| Phenylethyl | 60-12-8 | 0.17 | Odor: floral rose dried rose flower | medium |
| Alcohol | | | rose water | |
| | | | Flavor: floral, sweet, rosy and | |
| | | | bready | |
| Esters | | | | |
| Ethyl acetate | 141-78-6 | 0.31 | Odor: ethereal fruity sweet weedy | high |
| | | | green | |
| | | | Flavor: ethereal, fruity, sweet, | |
| | | | with a grape and cherry nuance | |
| Methyl butyrate | 623-42-7 | 0.92 | Odor: fruity apple sweet banana | medium |
| | | | pineapple | |
| | | | Flavor: impacting, fusel, fruity | |
| | | | and estery with a cultured dairy, | |
| | | | acidic depth | |
| Methyl 2-methyl | 868-57-5 | 0.60 | Odor: ethereal estery fruity tutti | medium |
| butyrate | | | frutti green apple lily of the valley | |
| | | | powdery fatty | |
| | | | Flavor: ethereal estery fruity apple | |
| | | | green pear tropical floral | |
| Methyl valerate | 624-24-8 | 0.95 | Odor: sweet green fruity apple | medium |
| | | | pineapple nutty | |
| | | | Flavor: sweet, ripe, fruity with | |
| | | | sweaty dairy and cheese nuances | |
| Methyl isovalerate | 556-24-1 | 0.07 | Odor: strong apple fruity | medium |
| | | | pineapple | |
| | | | Flavor: fruity pineapple, apple | |
| | | | with a juicy fruit-like nuance | |
| Ethyl lactate | 97-64-3 | 0.07 | Odor: sharp tart fruity buttery | high |
| | | | butterscotch | |
| | | | Flavor: sweet, fruity, creamy, | |
| | | | pineapple-like with a caramellic | |
| | | | brown nuance | |
| Allyl acetate | 591-87-7 | 0.07 | Odor: fruity | |
| Butyl acetate | 123-86-4 | 0.30 | Odor: ethereal solvent fruity | high |
| | | | banana | |
| | | | Flavor: sweet, ripe banana, tutti | |
| | | | frutti, tropical and candy-like with | |
| | | | green nuances | |
| 6-methyloxan-2- | 823-22-3 | 0.06 | Flavor: creamy spicy coconut | medium |
| one | | | | |
| Ketones | | | | |
| 2-Butanone | 78-93-3 | 0.20 | Odor: acetone-like ethereal fruity | high |
| | | | camphor | |
| | | | Flavor: chemical-like and slightly | |
| | | | fruity green | |
| 3-Methyl-2- | 563-80-4 | 1.49 | Odor: camphor | high |
| butanone | | | | |
| 2-Methyl-3- | 565-69-5 | 0.43 | Odor: mint | |
| pentanone | | | | |
| 3-Hexanone | 589-38-8 | 0.33 | Odor: sweet fruity waxy rum | medium |
| | | | grape | |
| | | | Flavor: sweet, fruity and waxy | |
| | | | with rum notes | |
| Methyl heptenone | 110-93-0 | 0.21 | Odor: citrus green musty | medium |
| | | | lemongrass apple | |
| | | | Flavor: green, vegetative, musty, | |
| | | | apple, banana and green bean-like | |
| 2- | 577-16-2 | 0.17 | Odor: sweet hawthorn powdery | |
| Methylacetophenone | | | anisic coumarinic phenolic burnt | |
| | | | nutty honey | |
| | | | Flavor: sweet anisic coumarinic | |
| | | | phenolic burnt nutty nut flesh | |
| | | | almond powdery | |
| 2-Acetyl-5- | 1193-79-9 | 0.09 | Odor: strong musty nutty hay | high |
| methylfuran | | | coconut coumarin milky | |
| | | | Flavor: nutty cocoa-like with a | |
| | | | toasted bready nuance | |
| 2,2,6-Trimethyl- | 2408-37-9 | 1.31 | Odor: pungent thujonic labdanum | high |
| cyclohexanone | | | honey cistus | |
| Isophorone | 78-59-1 | 0.22 | Odor: cooling woody sweet green | medium |
| | | | camphor fruity musty cedarwood | |
| | | | tobacco leather | |
| | | | Flavor: sweet, green, waxy, | |
| | | | woody, cooling pulpy mouthfeel | |
| | | | and citrus | |
| 2,6,6-Trimethyl-2- | 1125-21-9 | 0.87 | Odor: musty woody sweet tea | medium |
| cyclohexene-1,4- | | | tobacco leaf | |
| dione | | | Flavor: citrus, floral, musty, tea | |
| | | | like with green sweet fruity | |
| | | | nuances | |
| (E)-beta- | 23726-93-4 | 0.43 | Odor: apple rose honey tobacco | high |
| damascenone | | | sweet | |
| 2-Cyclohexen-1- | 34318-21-3 | 0.11 | Odor: spicy | |
| one, 4-(3-hydroxy- | | | | |
| 1-butenyl)-3,5,5- | | | | |
| trimethyl- | | | | |
| Acids | | | | |
| Acetic acid | 64-19-7 | 1.11 | Odor: sharp pungent sour vinegar | high |
| | | | Flavor: pungent sour overripe fruit | |
| Butanoic acid, 3- | 503-74-2 | 0.09 | Odor: sour stinky feet sweaty | high |
| methyl- | | | cheesy tropical | |
| | | | Flavor: cheesy, daily; creamy, | |
| | | | fermented, sweet, waxy and berry | |
| Others | | | | |
| 2-Ethylfuran | 3208-16-0 | 0.11 | Odor: sweet burnt earthy malty | high |
| | | | Flavor: solvent-like with a dirty | |
| | | | musty brown earthy nuance | |

TABLE 75-8
Aroma substances identified in GRU40.

| | | Rel. | | Odor |
|---|---|---|---|---|
| Compounds | CAS # | (%) | Odor/flavor | strength |
| Hydrocarbons | | | | |
| trans-α- | 13474-59-4 | 4.74 | Odor: woody warm tea | medium |
| Bergamotene | | | | |
| Isocaryophyllene | 118-65-0 | 3.50 | Odor: woody spicy | medium |
| (E)-β-Farnesene | 18794-84-8 | 0.13 | Odor: woody citrus herbal sweet | medium |
| β-Bisabolene | 495-61-4 | 5.18 | Odor: balsamic woody | medium |
| Benzene, 1-(1,5- | 644-30-4 | 0.10 | Odor: herbal | |
| dimethyl-4- | | | | |
| hexenyl)-4- | | | | |
| methyl- | | | | |
| Aldehyde | | | | |
| Aliphatic | | | | |
| Hexanal | 66-25-1 | 0.09 | Odor: fresh green fatty aldehydic grass leafy | high |
| | | | fruity sweaty | |
| | | | Flavor: green, woody, vegetative, apple, grassy, | |
| | | | citrus and orange with a fresh, lingering | |
| | | | aftertaste | |
| Nonanal | 124-19-6 | 0.96 | Odor: waxy aldehydic rose fresh orris orange | high |
| | | | peel fatty peely | |
| | | | Flavor: effervescent, aldehydic citrus, | |
| | | | cucumber and melon rindy, with raw potato and | |
| | | | oily nutty and coconut like nuances | |
| Decanal | 112-31-2 | 0.23 | Odor: sweet aldehydic waxy orange peel citrus | high |
| | | | floral | |
| | | | Flavor: waxy, fatty, citrus and orange peel with | |
| | | | a slight green melon nuance | |
| Undecanal | 112-44-7 | 0.08 | Odor: waxy soapy floral aldehydic citrus green | high |
| | | | fatty fresh laundry | |
| | | | Flavor: waxy, aldehydic, soapy with a citrus | |
| | | | note and slight laundry detergent nuance | |
| 3-Cyclohexene- | 29548-14-9 | 0.70 | Odor: spicy herbal | high |
| 1-acetaldehyde, | | | | |
| α,4-dimethyl- | | | | |
| α-Campholenal | 4501-58-0 | 0.08 | Odor: herbal green woody amber leafy | high |
| | | | Flavor: green spicy herbal chrysanthemum | |
| | | | leafy cilantro woody | |
| (Z)-Citral | 106-26-3 | 0.58 | Odor: sweet citral lemon peel | medium |
| | | | Flavor: lemon | |
| 2,6-Octadienal, | 141-27-5 | 3.15 | Odor: citrus lemon | medium |
| 3,7-dimethyl-, (E)- | | | Flavor: citrus lemon | |
| Laevo- | 18031-40-8 | 0.11 | Odor: fresh green oily grassy fatty mint cherry | medium |
| perillaldehyde | | | Flavor: aromatic sweet woody spicy waxy | |
| | | | orange lime aldehydic | |
| Furan derivatives | | | | |
| 2- | 620-02-0 | 0.28 | Odor: spice caramel maple | medium |
| Furancarboxaldehyde, | | | Flavor: sweet, brown, caramellic. grain, maple- | |
| 5-methyl- | | | like | |
| Aromatic | | | | |
| Benzaldehyde | 100-52-7 | 0.65 | Odor: strong sharp sweet bitter almond cherry | high |
| | | | Flavor: sweet, oily, almond, cherry, nutty and | |
| | | | woody | |
| Monoterpene | | | | |
| β-Myrcene | 123-35-3 | 2.37 | Odor: peppery terpene spicy balsam plastic | high |
| | | | Flavor: woody, vegetative, citrus, fruity with a | |
| | | | tropical mango and slight leafy minty nuances | |
| Safranal | 116-26-7 | 0.42 | Odor: fresh herbal phenolic metallic rosemary | high |
| | | | tobacco spicy | |
| | | | Flavor: woody, medicinal, phenolic, spicy and | |
| | | | camphoraceous with a fruity, herbal nuance | |
| Alcohols | | | | |
| 2-Ethyl-1- | 104-76-7 | 0.79 | Odor: citrus fresh floral oily sweet | medium |
| hexanol | | | Flavor: sweet fatty fruity | |
| 2,3-Butanediol | 513-85-9 | 0.14 | Odor: fruity creamy buttery | medium |
| myrcenol | 543-39-5 | 0.05 | Odor: fresh floral lavender citrus | medium |
| (R)-(+)-β- | 1117-61-9 | 0.06 | Odor: citronella oil rose leaf oily petal | medium |
| Citronellol | | | | |
| Ocimenol | 5986-38-9 | 0.07 | Odor: fresh citrus lemon lime cologne sweet | medium |
| | | | mace | |
| 2,6-Octadien-1- | 106-25-2 | 0.17 | Odor: sweet natural neroli citrus magnolia | |
| ol, 3,7-dimethyl-, | | | Flavor: lemon, bitter, green and fruity with a | |
| (Z)- | | | terpy nuance | |
| Aromatic | | | | |
| Benzyl alcohol | 100-51-6 | 0.22 | Odor: floral rose phenolic balsamic | medium |
| | | | Flavor: chemical fruity cherry almond balsamic | |
| | | | bitter | |
| Monoterpene | | | | |
| Linalool | 78-70-6 | 0.37 | Odor: citrus floral sweet bois de rose woody | medium |
| | | | green blueberry | |
| | | | Flavor: citrus, orange, lemon, floral, waxy, | |
| | | | aldehydic and woody | |
| α-Terpineol | 7785-53-7 | 1.46 | Odor: pine terpene lilac citrus woody floral | medium |
| | | | Flavor: citrus woody with a lemon and lime | |
| | | | nuance, it has a slight soapy mouth feel | |
| Dehydralinalool | 29957-43-5 | 0.12 | Odor: moldy | |
| E-Linalool oxide | 34995-77-2 | 1.27 | Odor: floral | |
| (furanoid) | | | | |
| Furan derivatives | | | | |
| 2- | 98-00-0 | 0.05 | Odor: alcoholic chemical musty sweet caramel | medium |
| Furanmethanol | | | bread coffee | |
| | | | Flavor: burnt, sweet, caramellic, brown | |
| Esters | | | | |
| 2,6-Octadien-1- | 141-12-8 | 9.07 | Odor: floral rose soapy citrus dewy pear | medium |
| ol, 3,7-dimethyl-, | | | Flavor: floral, rosy, soapy, fruity, pear and | |
| acetate, (Z)- | | | tropical | |
| (S)- | 17092-92-1 | 0.40 | Odor: musk coumarin | |
| Dihydroactinidiolide | | | | |
| Gerannyl acetate | 105-87-3 | 8.10 | Odor: floral rose lavender green waxy | medium |
| | | | Flavor: waxy, green, floral, oily and soapy with | |
| | | | citrus and winey, rum nuances | |
| Ketones | | | | |
| Methyl | 110-93-0 | 0.09 | Odor: citrus green musty lemongrass apple | medium |
| heptenone | | | Flavor: green, vegetative, musty, apple, banana | |
| | | | and green bean-like | |
| 2,2,6-Trimethyl- | 2408-37-9 | 0.29 | Odor: pungent thujonic labdanum honey cistus | high |
| cyclohexanone | | | | |
| 2,6,6-Trimethyl- | 1125-21-9 | 0.81 | Odor: musty woody sweet tea tobacco leaf | medium |
| 2-cyclohexene- | | | Flavor: citrus, floral, musty, tea like with green | |
| 1,4-dione | | | sweet fruity nuances | |
| (E)-beta- | 23726-93-4 | 0.38 | Odor: apple rose honey tobacco sweet | high |
| damascenone | | | | |
| Carvone | 99-49-0 | 0.05 | Odor: minty licorice | medium |
| 2-Cyclohexen-1- | 34318-21-3 | 0.20 | Odor: spicy | |
| one, 4-(3-hydroxy-1- | | | | |
| butenyl)-3,5,5- | | | | |
| trimethyl- | | | | |
| Acids | | | | |
| Acetic acid | 64-19-7 | 1.51 | Odor: sharp pungent sour vinegar | high |
| | | | Flavor: pungent sour overripe fruit | |

TABLE 75-9
Aroma substances identified in GRU40-MRP-FTA.

| | | Rel. | | Odor |
|---|---|---|---|---|
| Compounds | CAS # | (%) | Odor/flavor | strength |
| Hydrocarbons | | | | |
| (E)-β-Farnesene | 18794-84-8 | 0.06 | Odor: woody citrus herbal sweet | medium |
| β-Bisabolene | 495-61-4 | 4.34 | Odor: balsamic woody | medium |
| Benzene, 1-(1,5- | 644-30-4 | 0.10 | Odor: herbal | |
| dimethyl-4- | | | | |
| hexenyl)-4- | | | | |
| methyl- | | | | |
| β-Myrcene | 123-35-3 | 0.67 | Odor: peppery terpene spicy balsam plastic | high |
| | | | Flavor: woody, vegetative, citrus, fruity | |
| | | | with a tropical mango and slight leafy | |
| | | | minty nuances | |
| trans-β-Ocimene | 3779-61-1 | 0.63 | Odor: sweet herbal | medium |
| Aldehyde | | | | |
| Aliphatic | | | | |
| Hexanal | 66-25-1 | 0.15 | Odor: fresh green fatty aldehydic grass | high |
| | | | leafy fruity sweaty | |
| | | | Flavor: green, woody, vegetative, apple, | |
| | | | grassy, citrus and orange with a fresh, | |
| | | | lingering aftertaste | |
| Nonanal | 124-19-6 | 0.41 | Odor: waxy aldehydic rose fresh orris | high |
| | | | orange peel fatty peely | |
| | | | Flavor: effervescent, aldehydic citrus, | |
| | | | cucumber and melon rindy, with raw potato | |
| | | | and oily nutty and coconut like nuances | |
| Decanal | 112-31-2 | 0.27 | Odor: sweet aldehydic waxy orange peel | high |
| | | | citrus floral | |
| | | | Flavor: waxy, fatty, citrus and orange peel | |
| | | | with a slight green melon nuance | |
| 2,6-Octadienal, | 141-27-5 | 0.40 | Odor: citrus lemon | medium |
| 3,7-dimethyl-, | | | Flavor: citrus lemon | |
| (E)- | | | | |
| 3-Cyclohexene-1- | 29548-14-9 | 1.25 | Odor: spicy herbal | high |
| acetaldehyde, | | | | |
| α,4-dimethyl- | | | | |
| Furan derivatives | | | | |
| 2- | 620-02-0 | 0.46 | Odor: spice caramel maple | medium |
| Furancarboxaldehyde, | | | Flavor: sweet, brown, caramellic. grain, | |
| 5-methyl- | | | maple-like | |
| Aromatic | | | | |
| Benzaldehyde | 100-52-7 | 0.12 | Odor: strong sharp sweet bitter almond | high |
| | | | cherry | |
| | | | Flavor: sweet, oily, almond, cherry, nutty | |
| | | | and woody | |
| Monoterpene | | | | |
| Safranal | 116-26-7 | 0.32 | Odor: fresh herbal phenolic metallic | high |
| | | | rosemary tobacco spicy | |
| | | | Flavor: woody, medicinal, phenolic, spicy | |
| | | | and camphoraceous with a fruity, herbal | |
| | | | nuance | |
| Alcohols | | | | |
| 2-Ethyl-1- | 104-76-7 | 0.46 | Odor: citrus fresh floral oily sweet | medium |
| hexanol | | | Flavor: sweet fatty fruity | |
| 2,3-Butanediol | 513-85-9 | 0.14 | Odor: fruity creamy buttery | medium |
| Ocimenol | 5986-38-9 | 0.05 | Odor: fresh citrus lemon lime cologne | medium |
| | | | sweet mace | |
| Aromatic | | | | |
| Benzyl alcohol | 100-51-6 | 0.12 | Odor: floral rose phenolic balsamic | medium |
| | | | Flavor: chemical fruity cherry almond | |
| | | | balsamic bitter | |
| Monoterpene | | | | |
| Linalool | 78-70-6 | 0.43 | Odor: citrus floral sweet bois de rose | medium |
| | | | woody green blueberry | |
| | | | Flavor: citrus, orange, lemon, floral, waxy, | |
| | | | aldehydic and woody | |
| α-Terpineol | 7785-53-7 | 0.53 | Odor: pine terpene lilac citrus woody floral | medium |
| | | | Flavor: citrus woody with a lemon and lime | |
| | | | nuance, it has a slight soapy mouth feel | |
| Dehydralinalool | 29957-43-5 | 0.08 | Odor: moldy | |
| Furan derivatives | | | | |
| 2-Furanmethanol | 98-00-0 | 0.72 | Odor: alcoholic chemical musty sweet | medium |
| | | | caramel bread coffee | |
| | | | Flavor: burnt, sweet, caramellic, brown | |
| Esters | | | | |
| 2,6-Octadien-1- | 141-12-8 | 4.98 | Odor: floral rose soapy citrus dewy pear | medium |
| ol, 3,7-dimethyl-, | | | Flavor: floral, rosy, soapy, fruity, pear and | |
| acetate, (Z)- | | | tropical | |
| (S)- | 17092-92-1 | 0.33 | Odor: musk coumarin | |
| Dihydroactinidiolide | | | | |
| Ketones | | | | |
| Ethanone, 1-(2- | 1192-62-7 | 0.49 | Odor: sweet balsam almond cocoa caramel | high |
| furanyl)- | | | coffee | |
| | | | Flavor: sweet, nutty and roasted with a | |
| | | | sweet, baked-goods body | |
| 2,6,6-Trimethyl- | 1125-21-9 | 0.49 | Odor: musty woody sweet tea tobacco leaf | medium |
| 2-cyclohexene- | | | Flavor: citrus, floral, musty, tea like with | |
| 1,4-dione | | | green sweet fruity nuances | |
| (E)-beta- | 23726-93-4 | 0.14 | Odor: apple rose honey tobacco sweet | high |
| damascenone | | | | |
| Ethanone, 1-(4- | 122-00-9 | 0.22 | Odor: hawthorn sweet mimosa coumarin | medium |
| methylphenyl)- | | | cherry acetophenone | |
| | | | Flavor: sweet, creamy, fruity, cherry and | |
| | | | heliotropine-like | |
| 2-Cyclohexen-1- | 34318-21-3 | 0.10 | Odor: spicy | |
| one, 4-(3- | | | | |
| hydroxy-1- | | | | |
| butenyl)-3,5,5- | | | | |
| trimethyl- | | | | |
| Acids | | | | |
| Acetic acid | 64-19-7 | 3.10 | Odor: sharp pungent sour vinegar | high |
| | | | Flavor: pungent sour overripe fruit | |
| Butanoic acid | 107-92-6 | 0.08 | Odor: sharp acetic cheese butter fruit | high |
| | | | Flavor: acidic sour, cheesy, dairy, creamy | |
| | | | with a fruity nuance | |
| Butanoic acid, 3- | 503-74-2 | 0.09 | Odor: sour stinky feet sweaty cheese | high |
| methyl- | | | tropical | |
| | | | Flavor: cheesy, dairy, creamy, fermented, | |
| | | | sweet, waxy and berry | |

Conclusion: The sweet tea extract RU40 and its glycosylated and Maillard reaction products contain many VOCs, including hydrocarbons, ketones, aldehydes, alcohols and esters. The aroma substances among these VOCs play an important role in the flavor of the product.

FIGS. 80A-80C show total ion chromatograms (TICs) of the RU90, GRU90 and GRU90-MRA-FTA samples detected by SPME-GCxGC-TOFMS, respectively.

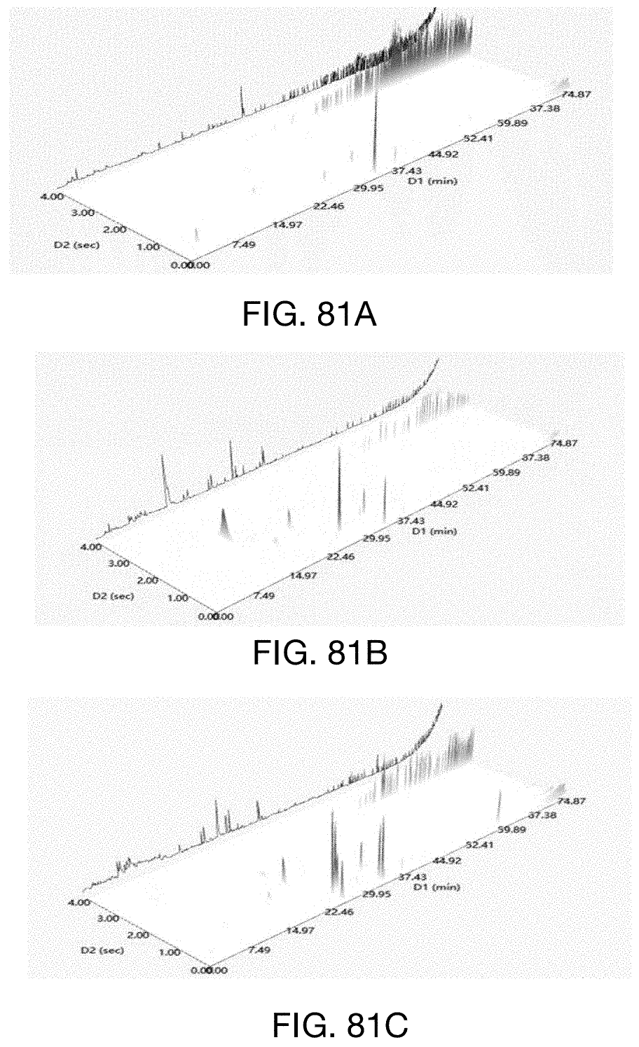

FIGS. 81A-81C show 3D surface plots of the RU90, GRU90 and GRU90-MRA-FTA samples detected by SPME-GCxGC-TOFMS, respectively.

Data processing was performed using Canvas GC×GC Data Processing Software (J&X Technologies. Version 1.8). Compound identification was achieved based on mass spectra comparison with NIST 17. Compounds with forward and reverse matching degrees ≥750 and a peak area percentages ≥0.05% were selected for inclusion in (Tables 75-10 to 75-13). A series of n-alkanes (C8-C25) were injected separately to establish first-dimension retention indices (RI1). Experimental retention indices (RI) were calculated using the n-alkanes RI values and compared to literature values (NIST RI) for further confirmation. A blank run was also performed for background correction of the samples. Lots of volatile organic compounds (VOCs) are identified in RU90, GRU90 and GRU90-MRA-FTA, respectively.

3 VOCs including alkanes, aldehydes, ketones, esters, alcohols and acids were identified among RU90, GRU90 and GRU90-MRA-FTA (listed in Table 75-10). All of them are aroma substances. Aroma substances identified in RU90, GRU90 and GRU90-MRA-FTA were listed in Tables 75-11 to 75-13, respectively.

TABLE 75-10
Volatile compounds identified in RU90, GRU90 and GRU90-MRA-FTA.

| | | Relative percentage (%) | | | |
|---|---|---|---|---|---|
| | | | | GRU90- | |
| Compounds | CAS # | RU90 | GRU90 | MRP-FTA | Odor/flavor |
| Aldehyde | | | | | |
| Aliphatic | | | | | |
| Nonanal | 124-19-6 | 1.28 | 5.55 | 11.83 | Odor: waxy aldehydic rose |
| | | | | | fresh orris orange peel fatty |
| | | | | | peely |
| | | | | | Flavor: effervescent, |
| | | | | | aldehydic citrus, cucumber |
| | | | | | and melon rindy. with raw |
| | | | | | potato and oily nutty and |
| | | | | | coconut like nuances |
| Aromatic | | | | | |
| Benzaldehyde | 100-52-7 | 5.29 | 0.38 | 9.32 | Odor: strong sharp sweet |
| | | | | | bitter almond cherry |
| | | | | | Flavor: sweet, oily, almond, |
| | | | | | cherry, nutty and woody |
| Alcohols | | | | | |
| Benzyl alcohol | 100-51-6 | 1.94 | 0.31 | 0.56 | Odor: floral rose phenolic |
| | | | | | balsamic |
| | | | | | Flavor: chemical fruity |
| | | | | | cherry almond balsamic |
| | | | | | bitter |

TABLE 75-11
Aroma substances identified in RU90.

| | | Rel. | | Odor |
|---|---|---|---|---|
| Compounds | CAS # | (%) | Odor/flavor | strength |
| Hydrocarbons | | | | |
| (E)-β-Farnesene | 18794-84-8 | 3.47 | Odor: woody citrus herbal sweet | medium |
| Alcohols | | | | |
| Aromatic | | | | |
| Benzyl alcohol | 100-51-6 | 1.94 | Odor: floral rose phenolic balsamic | medium |
| | | | Flavor: chemical fruity cherry | |
| | | | almond balsamic bitter | |
| Aldehydes | | | | |
| Nonanal | 124-19-6 | 1.28 | Odor: waxy aldehydic rose fresh | high |
| | | | orris orange peel fatty peely | |
| | | | Flavor: effervescent, aldehydic | |
| | | | citrus, cucumber and melon rindy, | |
| | | | with raw potato and oily nutty and | |
| | | | coconut like nuances | |
| Aromatic | | | | |
| Benzaldehyde | 100-52-7 | 5.29 | Odor: strong sharp sweet bitter | high |
| | | | almond cherry | |
| | | | Flavor: sweet, oily, almond, cherry, | |
| | | | nutty and woody | |
| Esters | | | | |
| Ethyl acetate | 141-78-6 | 15.27 | Odor: ethereal fruity sweet weedy | high |
| | | | green | |
| | | | Flavor: ethereal, fruity, sweet, with | |
| | | | a grape and cherry nuance | |
| Butyl acetate | 123-86-4 | 2.44 | Odor: ethereal solvent fruity banana | high |
| | | | Flavor: sweet, ripe banana, tutti | |
| | | | frutti, tropical and candy-like with | |
| | | | green nuances | |
| Triethyl phosphate | 78-40-0 | 7.56 | Odor: mild cider | |

TABLE 75-12
Aroma substances identified in GRU90.

| Compounds | CAS # | Rel. (%) | Odor/flavor | Odor strength |
|---|---|---|---|---|
| Alcohols | | | | |
| 2-Ethyl-1- | 104-76-7 | 13.86 | Odor: citrus fresh floral oily | medium |
| Hexanol | | | sweet | |
| | | | Flavor: sweet fatty fruity | |
| 1-Octanol | 111-87-5 | 0.20 | Odor: waxy green orange | medium |
| | | | aldehydic rose mushroom | |
| | | | Flavor: waxy, green, citrus, | |
| | | | orange and aldehydic with a | |
| | | | fruity nuance | |
| Monoterpenes | | | | |
| Linalool | 78-70-6 | 0.76 | Odor: citrus floral sweet bois de | medium |
| | | | rose woody green blueberry | |
| | | | Flavor: citrus, orange, lemon, | |
| | | | floral, waxy, aldehydic and | |
| | | | woody | |
| Aromatic | | | | |
| Benzyl alcohol | 100-51-6 | 0.31 | Odor: floral rose phenolic | medium |
| | | | balsamic | |
| | | | Flavor: chemical fruity cherry | |
| | | | almond balsamic bitter | |
| Aldehydes | | | | |
| Nonanal | 124-19-6 | 5.55 | Odor: waxy aldehydic rose fresh | high |
| | | | orris orange peel fatty peely | |
| | | | Flavor: effervescent, aldehydic | |
| | | | citrus, cucumber and melon | |
| | | | rindy, with raw potato and oily | |
| | | | nutty and coconut like nuances | |
| Decanal | 112-31-2 | 1.18 | Odor: sweet aldehydic waxy | high |
| | | | orange peel citrus floral | |
| | | | Flavor: waxy, fatty, citrus and | |
| | | | orange peel with a slight green | |
| | | | melon nuance | |
| Aromatic | | | | |
| Benzaldehyde | 100-52-7 | 0.38 | Odor: strong sharp sweet bitter | high |
| | | | almond cherry | |
| | | | Flavor: sweet, oily, almond, | |
| | | | cherry, nutty and woody | |
| Ketones | | | | |
| Acetone | 67-64-1 | 0.61 | Odor: solvent ethereal apple pear | high |

TABLE 75-13
Aroma substances identified in GRU90-MRP-FTA.

| Compounds | CAS # | Rel. (%) | Odor/flavor | Odor strength |
|---|---|---|---|---|
| Alcohols | | | | |
| 2-Ethyl-1-Hexanol | 104-76-7 | 7.91 | Odor: citrus fresh floral oily sweet | medium |
| | | | Flavor: sweet fatty fruity | |
| Monoterpenes | | | | |
| Linalool | 78-70-6 | 0.63 | Odor: waxy green orange aldehydic | medium |
| | | | rose mushroom | |
| | | | Flavor: waxy, green, citrus, orange | |
| | | | and aldehydic with a fruity nuance | |
| α-Terpineol | 7785-53-7 | 0.76 | Odor: pine terpene lilac citrus | medium |
| | | | woody floral | |
| | | | Flavor: citrus woody with a lemon | |
| | | | and lime nuance. it has a slight | |
| | | | soapy mouth feel | |
| Furan derivatives | | | | |
| 2-Furanmethanol | 98-00-0 | 7.72 | Odor: alcoholic chemical musty | medium |
| | | | sweet caramel bread coffee | |
| | | | Flavor: burnt, sweet, caramellic, | |
| | | | brown | |
| Aromatic | | | | |
| Benzyl alcohol | 100-51-6 | 0.56 | Odor: floral rose phenolic balsamic | medium |
| | | | Flavor: chemical fruity cherry | |
| | | | almond balsamic bitter | |
| Aldehydes | | | | |
| Nonanal | 124-19-6 | 11.83 | Odor: waxy aldehydic rose fresh | high |
| | | | orris orange peel fatty peely | |
| | | | Flavor: effervescent, aldehydic | |
| | | | citrus, cucumber and melon rindy, | |
| | | | with raw potato and oily nutty and | |
| | | | coconut like nuances | |
| Decanal | 112-31-2 | 1.38 | Odor: sweet aldehydic waxy orange | high |
| | | | peel citrus floral | |
| | | | Flavor: waxy, fatty, citrus and | |
| | | | orange peel with a slight green | |
| | | | melon nuance | |
| Furan derivatives | | | | |
| 5- | 67-47-0 | 4.22 | Odor: fatty buttery musty waxy | high |
| Hydroxymethylfurfural | | | caramellic | |
| | | | Flavor: herbal hay tobacco | |
| Aromatic | | | | |
| Benzaldehyde | 100-52-7 | 9.32 | Odor: strong sharp sweet bitter | high |
| | | | almond cherry | |
| | | | Flavor: sweet, oily, almond, cherry, | |
| | | | nutty and woody | |
| Ketones | | | | |
| 2-Acetyl furan | 1192-62-7 | 4.81 | Odor: sweet balsam almond cocoa | high |
| | | | caramel coffee | |
| | | | Flavor: sweet, nutty and roasted | |
| | | | with a sweet, baked-goods body | |
| Acids | | | | |
| Acetic acid | 64-19-7 | 14.41 | Odor: sharp pungent sour vinegar | high |
| | | | Flavor: pungent sour overripe fruit | |
| 2-Methylpropanoic | 79-31-2 | 0.32 | Odor: acidic sour cheese dairy | |
| acid | | | buttery rancid | |
| | | | Flavor: acidic sour cheesy limburger | |
| | | | cheese dairy creamy | |
| Butanoic acid, 3- | 503-74-2 | 2.41 | Odor: sour stinky feet sweaty cheese | high |
| methyl- | | | tropical | |
| | | | Flavor: cheesy, dairy, creamy, | |
| | | | fermented, sweet, waxy and berry | |

Conclusion: Although the sweet tea extract RU90 and its glycosylated product and Maillard reaction product contain less VOCs than RU10 and RU 40, there still are several VOCs in them, including hydrocarbons, ketones, aldehydes, alcohols and esters. The aroma substances among these VOCs play an important role in the flavor of the product.

### Example 76. Preparation of GRU40-MRP-FTA from GRU40, Fructose, Glutamic Acid and Butter Hydrolysate

GRU40: the product of Ex. 58.

Butter: Anchor Unsalted Pure New Zealand Butter; ingredients: pasteurized cream (from cow's milk); available from: Fonterra Co-operative Group Ltd.

Lipase: Lipase AK “Amano”; available from Amano Enzyme Inc., lot number: LAKL1252009.

Butter hydrolysate: the butter and water were weighed and mixed as follows:

TABLE 76-1
Composition of butter and water in the process of butter hydrolysis

| Weight of butter (g) | Weight of water (g) |
|---|---|
| 4.5 | 9 |

The mixture was first incubated in a water-bath at 40-60° C. to melt the butter, resulting in a suspension of water and butter. The mixture was then sterilized at 90° C. for 15 min. The mixture was then cooled until the temperature dropped to under 45° C.; 0.045 g of lipase was added, and the mixture was water-bathed at 45° C. for a duration of 160 min; the lipase was then deactivated by placing the mixture in the drying oven at 90° C. for 30 min. The hydrolysate was shaken well before preparation of the samples as described in Table 76-2.

GRU40, fructose, glutamic acid, butter hydrolysate and water were weighed and mixed as described in Table 76-2. The solution were then heated at about 100 degree centigrade for 1.5 hours. When the reaction was completed, the solution was filtered through filter paper, producing a filtrate that was dried with a spray dryer, thereby resulting in product 76-01 product as a powder.

TABLE 76-2
Sample composition

| | | | Weight | | Weight |
|---|---|---|---|---|---|
| | Weight | Weight | of glutamic | Weight | of butter |
| Product | of GRU40 | of fructose | acid | of water | hydrolysate |
| No. | (g) | (g) | (g) | (mL) | (g) |
| 76-01 | 6 | 3.696 | 0.308 | 5 | 0.125 |

### Example 77. GRU40-MRP-FTA Improves the Taste Profile of Raw Soymilk

Commercial raw soymilk: Plant selected plant-based milk, available from Inner Mongolia Yili Industrial Group Co., Ltd, Lot #:20200612 C4

Ingredients: potable water, soybean (non-GMO).

Process: GRU40-MRP-FTA (product in Ex. 76) powder was dissolved in the commercial raw soymilk as described in Table 77-1 below.

TABLE 77-1
Sample compositions.

| | Weight of | | Concentration of |
|---|---|---|---|
| | GRU40-MRP- | Volume of | GRU40-MRP- |
| Sample | FTA (mg) | soymilk (mL) | FTA (ppm) |
| Base | — | 100 | — |
| 77-01 | 5.0 | 100 | 50 |

Experiment: Each sample in Table 77-1 was evaluated according to the sensory evaluation method in Ex. 5. Average scores from the test panel for each sensory criterion were recorded as the evaluation test results. Taste profiles of the samples are shown in Table 77-2.

TABLE 77-2
Sensory evaluation results.

| | Overall | | | |
|---|---|---|---|---|
| | likability | Flavor | Mouth feel | Creaminess |
| Base | 2.5 | 3.0 | 1.5 | 2.5 |
| 77-01 | 3.5 | 4.0 | 2.5 | 3.5 |

Conclusion: GRU40-MRP-FTA (product in Ex. 76) significantly enhanced the creaminess, milk flavor and mouth feel of the raw soymilk, resulting in an improved overall likability of the modified raw soymilk product (77-01). The results showed that glycosylated rubusoside-based Maillard reaction products can improve the taste profile of raw soymilk.

### Example 78. GRU40-MRP-FTA Improves the Taste Profile of a Commercial Dairy Product

Commercial dairy product: full-fat milk, available from Inner Mongolia Yili Industrial Group Co., Ltd. Lot #:20200615

Ingredients: raw milk.

Process: GRU40-MRP-FTA (Ex. 76, 76-01) powder was dissolved in full-fat milk as described in Table 78-1 below.

TABLE 78-1
Sample compositions.

| | Weight of | Volume of | Concentration of |
|---|---|---|---|
| | GRU40-MRP- | full-fat | GRU40-MRP- |
| Sample | FTA (mg) | milk (mL) | FTA (ppm) |
| Base | — | 100 | — |
| 78-01 | 5.0 | 100 | 50 |

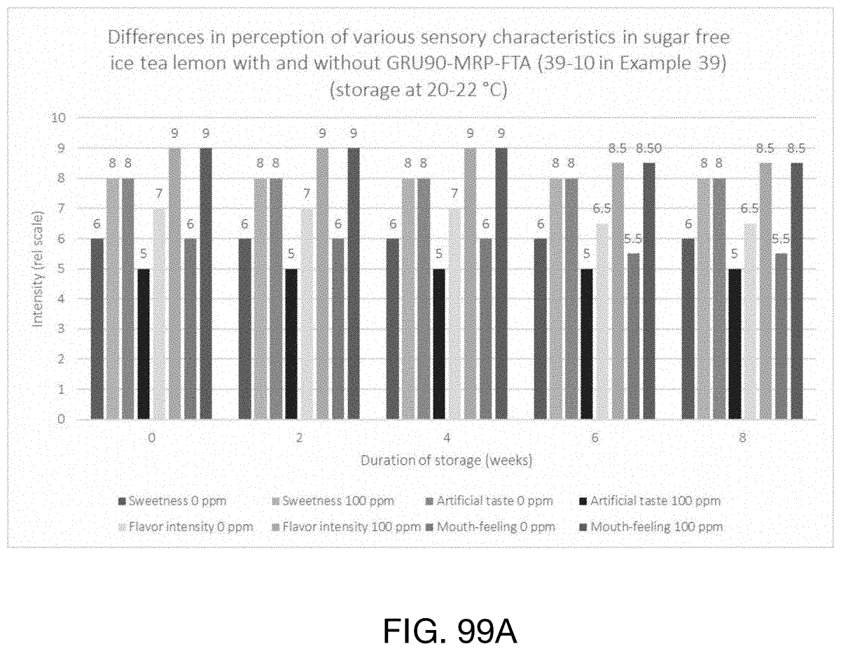

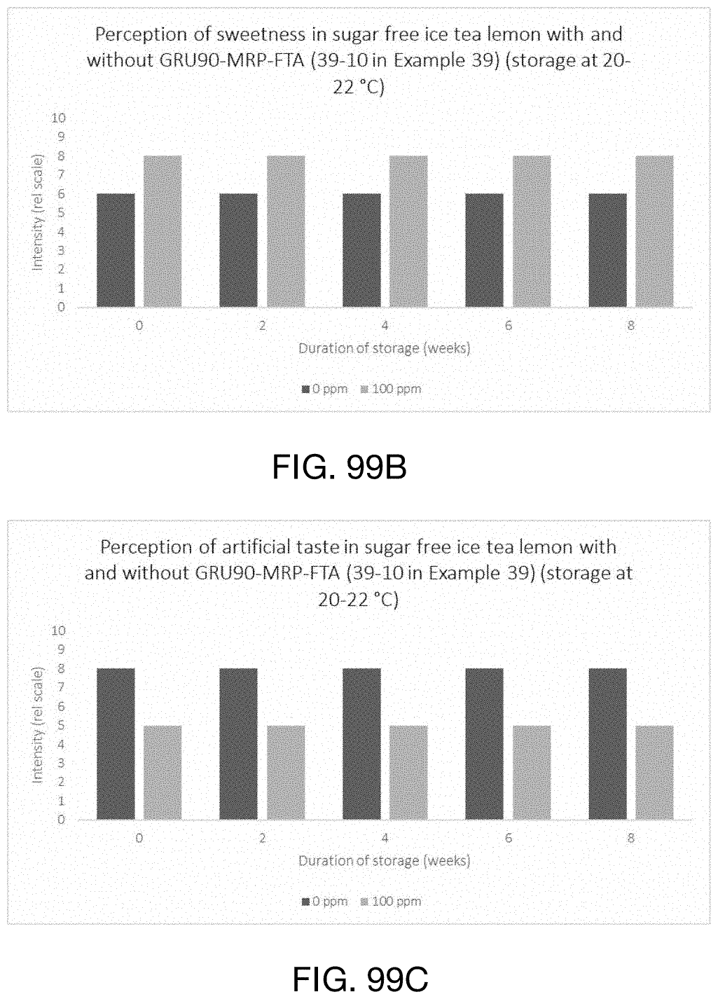

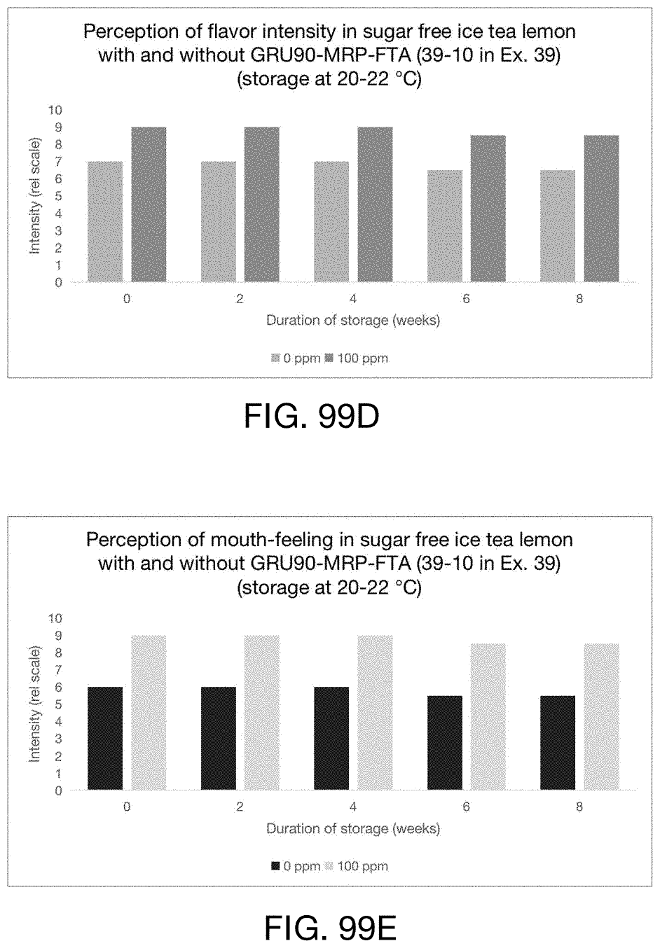

Experiment: Each sample composition in Table 78-1 was evaluated according to the sensory evaluation methods in Ex. 5. Average scores from the test panel for each sensory criterion were recorded as the evaluation test results. The taste profiles of each product sample are shown in Table 78-2 and FIG. 99 below.

TABLE 78-2
Sensory evaluation results.

| | Overall | | | |
|---|---|---|---|---|
| | likability | Flavor | Mouth feel | Creaminess |
| Base | 3 | 3.0 | 3 | 2 |
| 78-01 | 4 | 4 | 4 | 4.5 |

Conclusion: GRU40-MRP-FTA (Ex. 76, 76-01) significantly enhanced the creaminess, milk flavor and mouth feel of the full-fat milk, which resulted in an improved overall likability of the full-fat milk. The results showed that glycosylated rubusoside-based Maillard reaction products can improve the taste profile of the dairy products.

### Example 79. Conversion of Rubusoside from Steviol Glycosides

TABLE 79-1
Sample materials

| Sample | Source | Lot No. | Composition |
|---|---|---|---|
| 79-01 | Sweet Green | 20191122-23 | STV 60.36%, |
| | Fields | | TSG(9)93.18% |
| 79-02 | | 20170802 | STV 85%, TSG(9)95% |

Total steviol glycosides (TSG(9)) include Rebaudioside A, Rebaudioside B, Rebaudioside C, Rebaudioside D, Rebaudioside F, stevioside, steviolbioside, rubusoside, and dulcoside A.

Process: 100 mL of the STV/TSG solution (80 g/L) and β-galactosidase (0.8 kU/g stevioside) were mixed in a 250 mL flask and stirred at 60° C. for 8 h. The reaction mixture was then boiled for 3 min to deactivate the enzyme, which was then precipitated and removed by centrifugation. The resulting supernatant was spray-dried, resulting in a powder containing the RU and TSG contents described in Table 79-2.

TABLE 79-2

| Original material | Content of resulting materials |
|---|---|
| 79-01 | RU 55.21%, TSG(9) 87.87% |
| 79-02 | RU 82.31%, TSG(9) 90.2% |

Conclusion: Stevioside can be converted to rubusoside using β-galactosidase. Under certain conditions, the conversion rate can be close to 100%. Depending on the content of stevioside in the original material, the stevia glycosides converted into rubusosides can be used for modifying the taste of high intensity sweeteners, food ingredients etc.

### Example 80. Preparation of Glycosylated Rubusoside Derived from Steviol Glycoside Conversion

A glycosylated reaction product composition was prepared by steviol glycoside conversion according to the following method:

(i) 15 g maltodextrin (BAOLINGBAO BIOLOGY Co., Ltd) was dissolved in 45 mL deionized water

(ii) 15 g rubusoside derived from steviol glycosides conversion (Ex. 79, 79-02) was added to the dissolved dextrin solution to form a mixture.

(iii) 0.75 mL CGTase enzyme (Amano Enzyme, Inc.) and 15 mL deionized water were added to the mixture and incubated at 69° C. for 20 hours to glycosylate the rubusoside from steviol glycoside conversion with glucose molecules derived from maltodextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 25 g glycosylated rubusoside derived from steviol glycosides (GRUds) as a white powder (Ex. 80).

### Example 81. Preparation of GRUdGSG-MRP-FTA from GRUds, Fructose, Glutamic Acid

GRUds: the product of Ex. 80.

9 g GRUds, 0.5 g fructose and 0.5 g glutamic acid were weighed and mixed. The ratio of fructose to glutamic acid was 1:1 and the ratio of GRUds to the mixture of fructose and glutamic acid was 9:1. The mixture obtained was then dissolved in 5 g pure water without pH adjustment. The solution was then heated at about 100° C. for 1.5 hours. When the reaction was completed, the solution was filtered through filter paper and the filtrate was dried with a spray dryer, thereby resulting in about 8.2 g of GRUdGSG-MRP-FTA as an off white powder (product of Ex. 81).

### Example 82. GRUdGSG-MRP-FTA Improves the Taste Profile of an Energy Drink

Commercial energy drink: Monster Energy Ultra, available from CocaCola Beijing Co., Ltd, Lot #:20200508. Ingredients: water, maltodextrin, erythritol, citric acid, sodium citrate, food flavoring (contain guarana extract), carbon dioxide, carnitine sodium tartrate, black tea concentrate, taurine, panax powder, sucralose, green tea concentrate, coffee bean concentrate, sodium benzoate, inosite, potassium acetylsulfonate, sodium chloride, nicotinamide, pantothenic acid, vitamin B6, vitamin B12.

Process: GRUdGSG-MRP-FTA (product of Ex. 81) powder was dissolved in the commercial Monster Energy Ultra as described in Table 82-1.

TABLE 82-1
Sample compositions.

| | Weight of | | Concentration of |
|---|---|---|---|
| | GRUdGSG- | Volume of | GRUdGSG- |
| | MRP-FTA | Monster drink | MRP-FTA |
| Sample | (mg) | (mL) | (ppm) |
| Base | — | 100 | — |
| GRUdGSG-MRP-FTA | 5.0 | 100 | 50 |

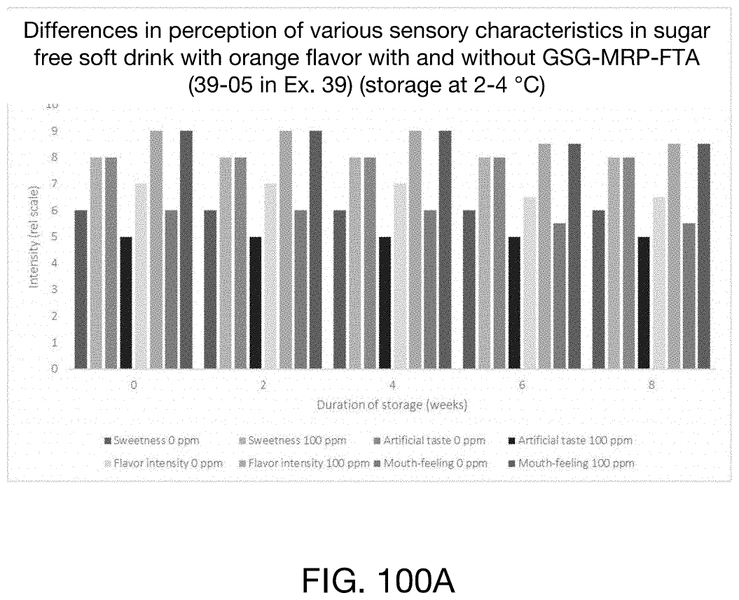

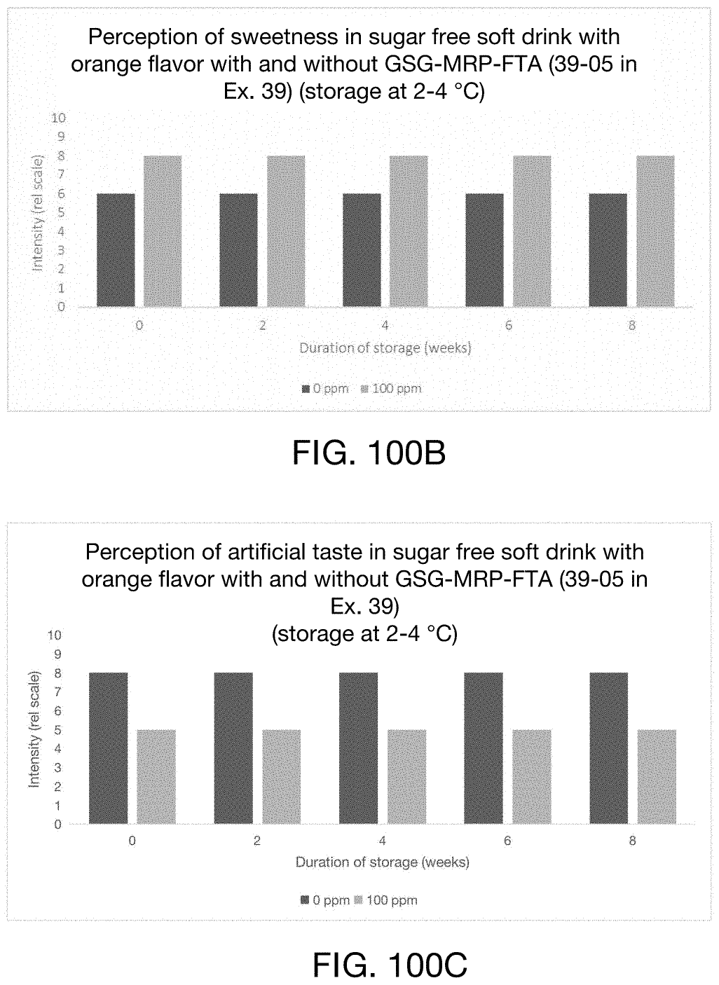

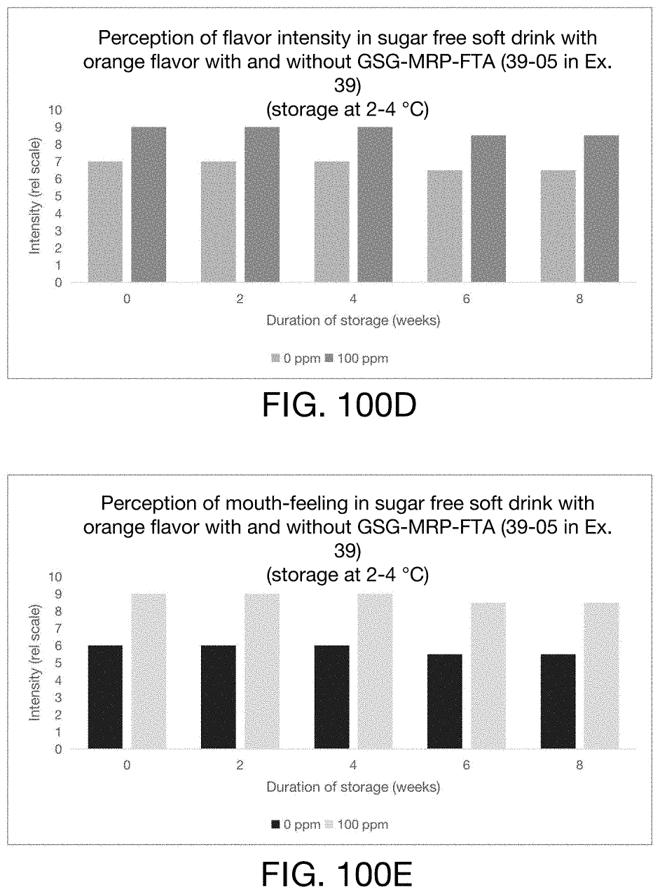

Experiment: Each sample composition in Table 82-1 was evaluated according to the sensory evaluation method in Ex. 5. Average scores from the test panel for each sensory criterion were recorded as the evaluation test results. The taste profiles for each beverage product sample are shown in Table 82-2 and FIG. 100.

TABLE 82-2
Sensory evaluation results.

| | Overall | | | Metallic | Sweet |
|---|---|---|---|---|---|
| | likability | Flavor | Mouth feel | aftertaste | lingering |
| Base | 2.5 | 3.0 | 1.5 | 2.5 | 3.0 |
| GRUdGSG- | 3.5 | 3.5 | 1.5 | 1.2 | 1.5 |
| MRP-FTA | | | | | |

Conclusion: GRUdGSG-MRP-FTA significantly reduced the sweet lingering and metallic aftertaste in the Monster energy drink. GRUdGSG-MRP-FTA provided a pleasant fruit flavor, resulting in better overall likability than the Monster drink alone. The results show that glycosylated rubusoside-based MRPs can improve the taste profile of energy drinks.

### Example 83. Preparation of GSG-MRP-CA, GSG-MRP-TN, GSG-MRP-HO from GSGs, Reducing Sugars and Amino Acids

Raw Materials:

GRU90: the product of Ex. 7.

GSGs (glycosylated stevia extract comprises unreacted stevia glycosides), available from Sweet Green Fields. Lot #: 3080191. The preparation procedure was similar to Ex. 7, except that the RU90 was replaced with stevia extract.

Process: GSGs, reducing sugar, amino acid, water were weighed and mixed as described in Table 83-1. When the reaction was completed, the solution was filtered through filter paper and the filtrate was dried with a spray dryer, resulting in MRP products GSG-MRP-CA, GSG-MRP-TN, and GSG-MRP-HO as off white powders.

TABLE 83-1

| | | Weight of | Weight of | | | | |
|---|---|---|---|---|---|---|---|
| Product | Weight of | reducing | amino acid | Vitamin | Weight of | Temp. | Time |
| name | GSGs (g) | sugar (g) | (g) | C | water (mL) | (° C.) | (h) |
| GSG- | 6 | Xylose | Alanine | | 60 | 95 | 2 |
| MRP-CA, | | 3 | 1 | | | | |
| GSG- | 9 | Fructose | Glutamic acid | 0.08 | 5 | 100 | 2.5 |
| MRP-TN | | 0.75 | 0.25 | | | | |
| GSG- | 8 | Xylose | Phenylalanine | | 5 | 100 | 1 |
| MRP-HO | | 1.33 | 0.67 | | | | |

### Example 84. GSG-MRP-CA, GSG-MRP-TN, and GSG-MRP-HO Improve the Taste Profile of Commercial Carbonated Beverages

Commercial carbonated beverages: details are shown in Table 84-1.

TABLE 84-1

| Flavor | | | | |
|---|---|---|---|---|
| type | Product | Company | Lot# | Ingredients |
| Lemon | Sanpellegrino | Sanpellegrino | 20190808 | Water, concentrated lemon juice, |
| | sparkling | S.p.A. | | glucose syrup , fructose, sugar, |
| | lemon | | | carbon dioxide, citric acid, |
| | beverage | | | flavoring agent |
| Orange | Sanpellegrino | Sanpellegrino | 20190809 | Water, concentrated sweet orange |
| | sparkling | S.p.A. | | juice, glucose syrup , fructose, sugar, |
| | orange | | | carbon dioxide, citric acid, flavoring |
| | beverage | | | agent |
| Ginger | Sanpellegrino | Sanpellegrino | 20191118 | Water, carbon dioxide , high fructose |
| | sparkling | S.p.A. | | corn syrup, citric acid, concentrated |
| | ginger | | | ginger juice, flavoring agent, sodium |
| | beverage | | | sorbate, caramel color, sodium |
| | | | | benzoate |

Process: Each of the GSG-MRP-CA, GSG-MRP-TN, and GSG-MRP-HO samples (as powders) were separately dissolved in each carbonated beverage as described in Table 84-2.

TABLE 84-2
Sample compositions.

| | Weight of GSG-MRP- | Volume of | |
|---|---|---|---|
| | CA, GSG-MRP-TN, | carbonated | |
| | GSG-MRP-HO | beverages | Concentration |
| Components | (mg) | (mL) | (ppm) |
| Base | — | 100 | — |
| GSG-MRP-CA, | 5 | 100 | 50 |
| GSG-MRP-TN | 5 | 100 | 50 |
| GSG-MRP-HO | 5 | 100 | 50 |

Experiment: Each sample composition in Table 84-2 was evaluated according to the sensory evaluation method in Ex. 5. Average scores from the test panel for each sensory criterion were recorded as the evaluation test results. Taste profiles of the beverage product samples are shown in Table 84-2 and FIG. 82.

TABLE 84-3
Sensory evaluation results.

| | | | | GSG- | GSG- | GSG- | |
|---|---|---|---|---|---|---|---|
| | Flavor | Sensory | | MRP- | MRP- | MRP- | |
| | type | criterion | Base | CA | TN | HO | Evaluation |
| Carbonated | Lemon | Juiciness | 2 | 2.5 | 3 | 2 | GSG-MRP-CA, GSG- |
| beverage | | Mouth feel | 3 | 3.5 | 3 | 4 | MRP-TN, GSG-MRP- |
| | | Flavor | 3.5 | 4 | 4 | 2.5 | HO all can improve the |
| | | Bitterness | 2 | 1.5 | 1.5 | 1.8 | taste profile of lemon |
| | | Overall | 3 | 3.5 | 4 | 3.2 | carbonated beverages. |
| | | likability | | | | | Preferably, GSG-MRP- |
| | | | | | | | TN can significantly |
| | | | | | | | reduce the bitterness, |
| | | | | | | | improve juiciness, and |
| | | | | | | | enhance the lemon |
| | | | | | | | flavor of the beverage. |
| | Orange | Juiciness | 3 | 3 | 3.5 | 3 | GSG-MRP-TN, GSG- |
| | | Mouth feel | 2.5 | 3 | 2.5 | 4 | MRP-HO both can |
| | | Flavor | 3 | 3 | 4.2 | 4 | improve the taste |
| | | Overall | 2.8 | 2.8 | 4 | 3.5 | profile of orange |
| | | likability | | | | | carbonated beverages. |
| | | | | | | | GSG-MRP-TN |
| | | | | | | | significantly improved |
| | | | | | | | juiciness and mouth |
| | | | | | | | feel and enhanced the |
| | | | | | | | orange flavor of the |
| | | | | | | | beverage. |
| | Ginger | Juiciness | 2.5 | 4 | 3 | 2.8 | GSG-MRP-CA and |
| | | Mouth feel | 3 | 3.5 | 3.5 | 4 | GSG-MRP-TN |
| | | Flavor | 3 | 4 | 3.5 | 2.8 | improved the taste |
| | | Overall | 2.8 | 4 | 3 | 2.8 | profile of carbonated |
| | | likability | | | | | ginger beverages. |
| | | | | | | | GSG-MRP-CA |
| | | | | | | | significantly improved |
| | | | | | | | juiciness and mouth |
| | | | | | | | feel and enhanced the |
| | | | | | | | ginger flavor of the |
| | | | | | | | beverage. |

FIG. 82 shows the overall likability of GSG-MRP-CA, GSG-MRP-TN, and GSG-MRP-HO in commercial carbonated beverages, based on the sensory evaluation results in Table 84-3.

Conclusion: Each of GSG-MRP-CA, GSG-MRP-TN, and GSG-MRP-HO improved the taste profile of the flavored carbonated beverages. GSG-MRP-TN significantly improved juiciness, mouth feel and the flavor of lemon and orange carbonated beverages; GSG-MRP-CA had the highest compatibility with the ginger flavor. The results show that glycosylated rubusoside-based MRPs can improve the taste profile of fruit flavor carbonated beverages.

### Example 85. GSG-MRP-CA, GSG-MRP-TN, and GSG-MRP-HO Improve the Taste Profile of Commercial Flavored Soft Drinks

Commercial flavored water beverage: details are shown in Table 85-1.

TABLE 85-1

| Flavor | | | | |
|---|---|---|---|---|
| type | Product | Company | Lot# | Ingredients |
| Peach | Glinter | Coca-Cola | 20191105 | Water, fructose, carbon |
| | peach | Malaysia | | dioxide, citric acid, DL- |
| | flavor | Co., Ltd | | malic acid, acesulfame-K, |
| | soft | | | aspartame, sodium citrate, |
| | drink | | | sodium sorbate, flavoring |
| | | | | agent (Peach flavor) |
| Lychee | Glinter | Coca-Cola | 20191104 | fructose, carbon dioxide, |
| | lychee | Malaysia | | citric acid, DL- malic acid, |
| | flavor | Co., Ltd | | acesulfame-K, aspartame, |
| | soft | | | sodium citrate, sodium |
| | drink | | | sorbate, flavoring agent |
| | | | | (lychee flavor). |
| Lemon | Glinter | Coca-Cola | 20191106 | fructose, carbon dioxide, |
| | lemon | Malaysia | | citric acid, DL- malic acid, |
| | flavor | Co., Ltd | | acesulfame-K, aspartame, |
| | soft | | | sodium citrate, sodium |
| | drink | | | sorbate, flavoring agent |
| | | | | (lemon flavor). |

Process: Each of the GSG-MRP-CA, GSG-MRP-TN, and GSG-MRP-HO samples (as powder) were separately dissolved into each of the flavored water beverages as described in Table 85-2.

TABLE 85-2
Sample compositions.

| | Weight of GSG- | Volume of | Concentration of |
|---|---|---|---|
| | MRP-CA, GSG- | flavored | GSG-MRP-CA, |
| | MRP-TN or | water | GSG-MRP-TN or |
| | GSG-MRP-HO | beverage | GSG-MRP-HO |
| Component | (mg) | (mL) | (ppm) |
| Base | — | 100 | |
| GSG-MRP-CA | 5 | 100 | 50 |
| GSG-MRP-TN | 5 | 100 | 50 |
| GSG-MRP-HO | 5 | 100 | 50 |

Experiment: Each beverage sample composition in Table 85-2 was evaluated according to the sensory evaluation method in Ex. 5. Average scores from the test panel for each sensory criterion were recorded as the evaluation test results. Taste profiles for each beverage product sample are shown in Table 85-3 and FIG. 83.

TABLE 85-3
Sensory evaluation results.

| | | | | GSG- | GSG- | GSG- | |
|---|---|---|---|---|---|---|---|
| | Flavor | Sensory | | MRP- | MRP- | MRP- | |
| | type | criterion | Base | CA | TN | HO | Evaluation |
| Flavored | Lychee | Juiciness | 2 | 3.5 | 3 | 2.5 | GSG-MRP-CA, GSG- |
| water | | Mouth feel | 2 | 3 | 2.5 | 3.5 | MRP-TN both can |
| beverage | | Flavor | 3 | 4 | 3.5 | 2 | improve the taste |
| | | Overall | 2.8 | 4 | 3.5 | 2.5 | profile of lychee |
| | | likability | | | | | flavored water |
| | | | | | | | beverage. GSG-MRP- |
| | | | | | | | CA significantly |
| | | | | | | | improved juiciness and |
| | | | | | | | enhanced the lychee |
| | | | | | | | flavor and refreshing |
| | | | | | | | feeling. |
| | Lemon | Juiciness | 2.5 | 3.5 | 3 | 2.8 | GSG-MRP-CA, GSG- |
| | | Mouth feel | 3 | 2.8 | 4 | 2.5 | MRP-TN both can |
| | | Flavor | 3 | 3.5 | 3.8 | 3 | improve the taste |
| | | Overall | 2.8 | 3.5 | 4 | 2.5 | profile of the lemon |
| | | likability | | | | | flavored water |
| | | | | | | | beverage. GSG-MRP- |
| | | | | | | | TN significantly |
| | | | | | | | improved juiciness and |
| | | | | | | | enhanced the lemon |
| | | | | | | | flavor and refreshing |
| | | | | | | | feeling. |

FIG. 83 shows the overall likability of GSG-MRP-CA, GSG-MRP-TN, and GSG-MRP-HO in commercial flavored water beverages, based on the sensory evaluation results in Table 85-3.

Conclusion: GSG-MRP-CA and GSG-MRP-TN improve the taste profile of commercial flavored water beverages. GSG-MRP-CA can significantly improve juiciness, mouth feel and flavor of the commercial lychee flavored water beverage; GSG-MRP-TN exhibited highest compatibility with the lemon flavored soft drink. The results show that glycosylated rubusoside based MRPs can improve the taste profile of fruit flavored soft drinks.

### Example 86. GSG-MRP-CA, GSG-MRP-TN and GSG-MRP-HO Improve the Taste Profile of Commercial Fruit and Vegetable Juices

Commercial fruit and vegetable juice: details are shown in Table 86-1.

TABLE 86-1

| Flavor | | | | |
|---|---|---|---|---|
| type | Product | Company | Lot# | Ingredients |
| Apple | [symbol] | Pepsi | 20200317 | Concentrated apple |
| | apple juice | (Russia) | | juice, high fructose |
| | | Co., Inc. | | corn syrup, citric |
| | | | | acid, water. |
| Peach | KEO peach | KEO Group | 20200124 | Concentrated peach |
| | juice | Plc. | | juice, citric acid, |
| | | | | ascorbic acid, |
| | | | | flavoring agent |
| Pineapple | KEO | KEO Group | 20190916 | Water, concentrated |
| | pineapple | Plc. | | pineapple juice, |
| | juice | | | ascorbic acid |
| Coconut | Foco roasted | Thai Agri | 20191010 | Coconut juice, |
| juice | coconut juice | Foods Public | | coconut pulps, |
| | | Co., Ltd | | sugar, water. |

Process: Each of the GSG-MRP-CA, GSG-MRP-TN, and GSG-MRP-HO samples (as powder) were separately dissolved into each fruit or vegetable juice as described in Table 86-2.

TABLE 86-2
Sample compositions.

| | Weight of GSG- | Volume of | Concentration of |
|---|---|---|---|
| | MRP-CA GSG- | fruit or | GSG- MRP-CA |
| | MRP-TN or GSG- | vegetable | GSG-MRP-TN or |
| Components | MRP-HO (mg) | juice (mL) | GSG-MRP-HO (ppm) |
| Base | — | 100 | — |
| GSG-MRP-CA | 5 | 100 | 50 |
| GSG-MRP-TN | 5 | 100 | 50 |
| GSG-MRP-HO | 5 | 100 | 50 |

Experiment: Each juice product sample was evaluated according to the sensory evaluation method in Ex. 5. Average scores from the test panel for each sensory criterion were recorded as the evaluation test results. The resulting taste profiles for each mixture are shown in Table 86-3 and FIG. 84.

TABLE 86-3
Sensory evaluation results.

| | | | | GSG- | GSG- | GSG- | |
|---|---|---|---|---|---|---|---|
| | Flavor | Sensory | | MRP- | MRP- | MRP- | |
| | type | criterion | Base | CA | TN | HO | Evaluation |
| Fruit and | Apple | Juiciness | 3 | 3 | 3.2 | 3 | GSG-MRP-CA and |
| vegetable | | Refreshing | 2 | 2 | 3.5 | 1.5 | GSG-MRP-TN |
| juice | | Flavor | 3.5 | 3.8 | 4 | 3.5 | Both can improve the |
| | | Overall | 3 | 3.2 | 4 | 2.8 | taste profile of apple |
| | | likability | | | | | juice. |
| | | | | | | | GSG-MRP-TN can |
| | | | | | | | significantly improve |
| | | | | | | | juiciness and |
| | | | | | | | refreshing and can |
| | | | | | | | enhance the apple |
| | | | | | | | flavor. |
| | Peach | Juiciness | 2 | 2.5 | 2.5 | 3 | Each of GSG-MRP- |
| | | Mouth feel | 3 | 3.5 | 3.2 | 4 | CA, GSG-MRP-TN |
| | | Flavor | 3 | 3.5 | 3.5 | 4 | and GSG-MRP-HO |
| | | Overall | 2.8 | 3.5 | 3.2 | 3.8 | improved the taste |
| | | likability | | | | | profile peach juice. |
| | | | | | | | GSG-MRP-HO can |
| | | | | | | | enhance the juiciness, |
| | | | | | | | mouth feel and peach |
| | | | | | | | flavor. |
| | Pineapple | Juiciness | 3 | 3.2 | 3 | 3.5 | Each of GSG-MRP- |
| | | Mouth feel | 3 | 3.5 | 3 | 4 | CA, GSG-MRP-TN |
| | | Flavor | 3 | 3 | 3.5 | 3.5 | and GSG-MRP-HO |
| | | Overall | 3 | 3.2 | 3.2 | 4 | improved the taste |
| | | likability | | | | | profile of pineapple |
| | | | | | | | juice. GSG-MRP-HO |
| | | | | | | | can significantly |
| | | | | | | | improve juiciness, |
| | | | | | | | and enhance the |
| | | | | | | | pineapple flavor and |
| | | | | | | | mouth feel. |
| | Coconut | Juiciness | 3 | 3 | 3 | 3 | Each of GSG-MRP- |
| | | Mouth feel | 3 | 3.2 | 3 | 3.5 | CA, GSG-MRP-TN |
| | | Flavor | 3 | 4 | 3 | 2 | improved the taste |
| | | Overall | 3 | 3.5 | 3 | 2.8 | profile of coconut |
| | | likability | | | | | juice. GSG-MRP-CA |
| | | | | | | | can improve juiciness |
| | | | | | | | and can enhance the |
| | | | | | | | coconut flavor and |
| | | | | | | | mouth feel. |

FIG. 84 shows the overall likability of GSG-MRP-CA, GSG-MRP-TN and GSG-MRP-HO in commercial fruit and vegetable juice based on the sensory evaluation results in Table 86-3.

Conclusion: Each of GSG-MRP-CA, GSG-MRP-TN and GSG-MRP-HO improved the taste profiles of commercial fruit and vegetable juices. GSG-MRP-TN significantly improved juiciness, refreshing, flavor and overall likability of apple juice. GSG-MRP-HO matched or exceeded mouth feel, juiciness, flavor and overall likability in the peach and pineapple juices. GSG-MRP-CA matched or exceeded juiciness, refreshing, and flavor in coconut juice. The results show that glycosylated rubusoside based MRPs can improve the taste profile of fruit and vegetable juices.

### Example 87. GSG-MRP-CA, GSG-MRP-TN and GSG-MRP-HO Improve the Taste Profile of a Commercial Functional Beverage

Commercial functional beverage: details are shown in Table 87-1.

TABLE 87-1
Sample beverage details

| Flavor | | | | |
|---|---|---|---|---|
| type | Product | Company | Lot# | Ingredients |
| Orange | Gatorade | Pepsi Co | 20190929 | Water, sugar, |
| | orange | (China). | | edible glucose, |
| | flavor | Inc. | | food additives |
| | energy | | | (citric acid, |
| | drink | | | sodium citrate, |
| | | | | monopotassium |
| | | | | phosphate, food |
| | | | | flavoring, sunset |
| | | | | yellow FCF), |
| | | | | edible salt. |

Process: Each of the GSG-MRP-CA, GSG-MRP-TN and GSG-MRP-HO samples (as a powder) were dissolved in the commercial functional beverage (Gatorade) as described in Table 87-2.

TABLE 87-2
Sample compositions.

| | Weight of GSG- | Volume of | |
|---|---|---|---|
| | MRP-CA, GSG- | commercial | |
| | MRP-TN, GSG- | functional | Concentra- |
| Component | MRP-HO (mg) | beverage (mL) | tion (ppm) |
| Base | — | 100 | — |
| GSG-MRP-CA | 5 | 100 | 50 |
| GSG-MRP-TN | 5 | 100 | 50 |
| GSG-MRP-HO | 5 | 100 | 50 |

Experiment: Each product sample was evaluated according to the sensory evaluation method in Ex. 5. Average scores from the test panel for each sensory criterion were recorded as the evaluation test results. The taste profiles of each beverage product sample are shown in Table 87-3 and FIG. 85.

TABLE 87-3
Sensory evaluation results.

| | | | | GSG- | GSG- | GSG- | |
|---|---|---|---|---|---|---|---|
| | Flavor | Sensory | | MRP- | MRP- | MRP- | |
| | type | criterion | Base | CA | TN | HO | Evaluation |
| Functional | Orange | Juiciness | 3 | 3.2 | 3.5 | 3 | GSG-MRP-CA and GSG- |
| beverage | | Refreshing | 3 | 3 | 4 | 2.8 | MRP-TN improved the |
| | | Flavor | 2.5 | 3 | 3.5 | 3 | taste profile of the orange |
| | | Overall | 3 | 3.2 | 3.8 | 3 | flavored functional |
| | | likability | | | | | beverage. GSG-MRP-TN |
| | | | | | | | significantly improved |
| | | | | | | | juiciness and refreshing and |
| | | | | | | | enhanced the orange flavor. |

FIG. 85 shows the overall likability of GSG-MRP-CA, GSG-MRP-TN and GSG-MRP-HO in a functional Gatorade beverage based on the sensory evaluation results in Table 87-3.

Conclusion: GSG-MRP-CA and GSG-MRP-TN both can improve the taste profile of commercial functional beverages. GSG-MRP-TN significantly improved juiciness and refreshing, and showed highest compatibility with the orange flavored functional beverage. The results show that glycosylated rubusoside-based MRPs can improve the taste profile of functional beverages.

### Example 88A. Sensory Evaluation of Food Products Containing MRPs

The study addresses the effects of different MRPs on flavor perception in various foods and beverages.

To perform this study, the following MRPs were used:

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

A variety of foods and beverages were taste-tested following addition of MRPs thereto, including dressings (e.g., yogurt dressing, olive oil balsamic dressing), soft cheeses, spreads and delicatessen salads (e.g., cream cheeses, egg salad, tuna salad, chicken spread), sour goods (e.g., pickles, beet salad, marinated mushrooms), tomato products (tomato sauce, spicy tomato sauce with meat), ready-to-eat meals (e.g., beef goulash, canned soups

Before tasting, the tasters discussed the series of samples to be tasted and first tasted regular samples without added flavor from MRPs to develop a sense for features characteristic of these samples. Thereafter the treated samples are tasted at the use level to develop a means for describing the flavors (taste, smell, intensity). Then the “trained” tasters (4-5) independently blind-tasted the samples. The tasters were allowed to re-taste and take notes regarding the sensory attributes perceived. In the last step, the attributes noted were openly discussed to reach a consensus description. In cases where more than one taster disagreed with the compromise, the tasting was repeated.

Triangle tests were performed according to the standard procedure (3-AFC test design) with 5 tasters. The tasters were randomly allocated the following sequences of the two samples A and B: ABB, BAA, AAB, ABA and BAB. The samples themselves were marked with random 3 digit numbers. All tasters filled out the following chart in Table 88-1:

TABLE 88-1
(Blank template)

| | | |
|---|---|---|
| | Which one is | Describe the |
| Sensory code | different? | difference |

/ /

Correct identification of the different samples by the tasters were counted and compared to the total number of test persons. The statistical decision was based on published Tables for the minimum required correct answers in dependence on the number of tasters and the significance level. Briefly, a published Tables specifies the minimum number of people who need to correctly distinguish the samples based on the total number of people tested. If the number of people who can actually distinguish the samples correctly is less than this minimum, then there is no difference between the samples.

Application 1: Yogurt Dressing

Source material: “Simply Good Yoghurt Dressing”, 20.05.20 112 09:28

Test design: 100 ppm of each MRP was added to the commercial yogurt dressing (150 ml cup, Brand: Simply Good, sweetened with sugar (5.7 g/100 ml)). Then the samples were tasted and subjected to a sensory evaluation, the results of which are shown in Table 88-2.

TABLE 88-2
Sensory evaluation of yogurt dressing with MRPs

| Sample | Sensory evaluation |
|---|---|
| Control | Appropriate creamy texture, too sour, |
| | fresh taste |
| 100 ppm GRU20-MRP-CA | Appropriate creamy texture, less sour, |
| | milder, pleasant |
| 100 ppm GRU20-MRP-TA | Appropriate creamy texture, less sour, |
| | milder, pleasant |
| 100 ppm GTRU20-MRP-CA | Appropriate creamy texture, less sour, |
| | milder, pleasant |
| 100 ppm GTRU20-MRP-HO | Appropriate creamy texture, less sour, |
| | milder, pleasant |
| 100 ppm GRU90-MRP-CA | Appropriate creamy texture, sweeter than |
| | the control, less sour, milder, pleasant |
| 100 ppm GRU90-MRP-HO | Appropriate creamy texture, very sweet, |
| | flowery aftertaste, not sour |
| 100 ppm GRU90-MRP-TA | Appropriate creamy texture, sweeter than |
| | the control, less sour, milder, pleasant |

Application 2: Olive Oil Balsamic Vinegar Dressing

Source material: Olive oil balsamic vinegar dressing “Simply Good Balsamico Olivenol”, 20.05.20 112 11:51

Test design: 100 ppm of each MRP was added to the commercial olive oil balsamic vinegar dressing (150 ml cup, Brand: Simply Good, sweetened with sugar (6.2 g/100 ml)). Then the samples were subjected to a sensory evaluation, the results of which are shown in Table 88-3.

TABLE 88-3
Sensory evaluation of olive oil balsamic
vinegar dressing with MRPs.

| Sample | Sensory evaluation |
|---|---|
| Control | Dark brown color, very acidic, very |
| | pungent, spicy |
| 100 ppm GRU20-MRP-CA | Dark brown color, less acidic, milder, less |
| | pungent, spicy, more pleasant overall taste |
| 100 ppm GRU20-MRP-TA | Dark brown color, less acidic, milder, less |
| | pungent, spicy, more pleasant overall taste |
| 100 ppm GTRU20-MRP-CA | Dark brown color, less acidic, milder, less |
| | pungent, spicy, more pleasant overall taste |
| 100 ppm GTRU20-MRP-HO | Dark brown color, less acidic, milder, less |
| | pungent, spicy, more pleasant overall taste |
| 100 ppm GRU90-MRP-CA | Dark brown color, a little bit sweeter, |
| | milder, less pungent, caramel-like notes, |
| | spicy, more pleasant overall taste |
| 100 ppm GRU90-MRP-HO | Dark brown color, a little bit sweeter, |
| | less pungent, more pleasant overall taste |
| 100 ppm GRU90-MRP-TA | Dark brown color, a little bit sweeter, |
| | less pungent, spicy, more pleasant overall |
| | taste |

Application 3: Light Cream Cheese with Herbs

Cream cheese source: Philadelphia cream cheese with herbs (30% less fat), F1C01:26, 11.06.20, Mondelez GmbH

Test design: 100 ppm of each MRP was added to the commercial herb cream cheese, 30% less fat (175 g cup, Brand: Philadelphia, sugar content: 5.2 g/100 g, fat content: 9.9 g/100 g). Then the samples were subjected to a sensory evaluation, the results of which are shown in Table 88-4.

TABLE 88-4
Sensory evaluation of cream cheese with MRPs.

| Sample | Sensory evaluation |
|---|---|
| Control | Slightly yellow color, homogenized |
| | creamy texture with added herbs, aromatic |
| | herb flavor, sour, savory taste |
| 100 ppm GRU20-MRP-CA | Enhanced creaminess and herb flavor, |
| | more soft and fresh taste, less sour |
| 100 ppm GRU20-MRP-TA | Enhanced creaminess and herb flavor, |
| | more soft and fresh taste, less sour |
| 100 ppm GTRU20-MRP-CA | Enhanced creaminess and herb flavor, |
| | more soft and fresh taste, less sour |
| 100 ppm GTRU20-MRP-HO | Enhanced creaminess and herb flavor, |
| | more soft and fresh taste, less sour |
| 100 ppm GRU90-MRP-CA | Very sweet for cream cheese |
| 100 ppm GRU90-MRP-HO | Very sweet for cream cheese |
| 100 ppm GRU90-MRP-TA | Very sweet for cream cheese |

Application 4: Light Cream Cheese Mascarino (Austrian Mascarpone)

Source material: Mascarino (500 g cup, Brand: Schärdinger, fat content 60%; 02.07. 20/128 08:17,

Test design: 100 ppm of each MRP was added to the commercial light cream cheese Mascarino (500 g cup, Brand: Schärdinger, fat content 60%). Then the samples were subjected to a sensory evaluation, the results of which are shown in Table 88-5.

TABLE 88-5
Sensory evaluation of Mascarino with MRPs.

| Sample | Sensory evaluation |
|---|---|
| Control | Homogenized creamy/buttery texture, |
| | smooth, slightly sweet, fatty |
| 100 ppm GRU20-MRP-CA | No differences |
| 100 ppm GRU20-MRP-TA | No differences |
| 100 ppm GTRU20-MRP-CA | Enhanced milky aroma and enhanced |
| | creamy taste |
| 100 ppm GTRU20-MRP-HO | Enhanced milky aroma and enhanced |
| | creamy taste |
| 100 ppm GRU90-MRP-CA | Enhanced milky aroma and enhanced |
| | creamy taste |
| 100 ppm GRU90-MRP-HO | Enhanced milky aroma and enhanced |
| | creamy taste |
| 100 ppm GRU90-MRP-TA | Enhanced milky aroma and enhanced |
| | creamy taste |

Application 5: Egg Salad Spread

Source material: Wojnar's EI-salat (200 g cup, Brand: Wojner's, contains 14% of egg white, sweetened with sugar and saccharin; 15.06.20 135 18:11)

Test design: 100 ppm of each MRP was added to the commercial delicatessen salad with eggs. Then the samples were subjected to a sensory evaluation, the results of which are shown in Table 88-6.

TABLE 88-6
Sensory evaluation of egg salad spread with MRPs.

| Sample | Sensory evaluation |
|---|---|
| Control | Yellow color, pasty consistency, with |
| | egg white pieces, typical boiled egg |
| | flavor, spicy, salty, slightly sweet |
| 100 ppm GRU20-MRP-CA | More intensive egg taste, more spicy |
| 100 ppm GRU20-MRP-TA | More intensive egg taste, more spicy |
| 100 ppm GTRU20-MRP-CA | More intensive egg taste, more spicy |
| 100 ppm GTRU20-MRP-HO | More intensive egg taste, more spicy |
| 100 ppm GRU90-MRP-CA | More intensive egg taste, more spicy, |
| | enhanced sweet taste, very pleasant |
| 100 ppm GRU90-MRP-HO | More intensive egg taste, more spicy, |
| | enhanced sweet taste, very pleasant |
| 100 ppm GRU90-MRP-TA | More intensive egg taste, more spicy, |
| | enhanced sweet taste, very pleasant |

Application 6: Tuna Salad Spread

Tuna salad source: “Wojnar's Thunfisch-Salat” (200 g cup, sweetened with sugar and saccharin) 26.06.20 136 10:01.

Test design: 100 ppm of each MRP was added to the commercial delicatessen salad with 25% tuna salad spread. Then the samples were subjected to a sensory evaluation, the results of which are shown in Table 88-7.

TABLE 88-7
Sensory evaluation of tuna salad spread with MRPs.

| Sample | Sensory evaluation |
|---|---|
| Control | Beige color, pasty consistency, with corn, |
| | pickles and paprika pieces, typical tuna |
| | flavor, very sour, acidic taste, spicy, salty |
| 100 ppm GRU20-MRP-CA | Smoother taste, enhanced spicy taste, less |
| | acidic |
| 100 ppm GRU20-MRP-TA | Smoother taste, enhanced spicy taste, less |
| | acidic |
| 100 ppm GTRU20-MRP-CA | Smoother taste, enhanced spicy taste, less |
| | acidic |
| 100 ppm GTRU20-MRP-HO | Smoother taste, enhanced spicy taste, less |
| | acidic |
| 100 ppm GRU90-MRP-CA | Enhanced sweetness, smoother taste, |
| | enhanced tuna flavor, less acidic |
| 100 ppm GRU90-MRP-HO | Enhanced sweetness, smoother taste, |
| | enhanced tuna flavor, less acidic |
| 100 ppm GRU90-MRP-TA | Enhanced sweetness, smoother taste, |
| | enhanced tuna flavor, less acidic |

Application 7: Chicken Spread with MRPs

Source material: Wojnar's Delicata Chicken Spread, Kreis Industriehandel GmbH, DHAC 4 L (95 g can, sweetened with sugar, contains 30% of chicken meat) 060220 06.02.23

Test design: 100 ppm of each MRP was added to the commercial chicken spread. Then the samples were subjected to a sensory evaluation, the results of which are shown in Table 88-7.

TABLE 88-7
Sensory evaluation of chicken spread with MRPs.

| Sample | Sensory evaluation |
|---|---|
| Control | Beige color, homogeneous texture, |
| | creamy, meat flavor, spicy, dry |
| | mouth feeling |
| 100 ppm GRU20-MRP-CA | Enhanced creaminess and meat flavor, |
| | more spicy |
| 100 ppm GRU20-MRP-TA | Enhanced creaminess and meat flavor, |
| | more spicy |
| 100 ppm GTRU20-MRP-CA | Enhanced creaminess and meat flavor, |
| | more spicy |
| 100 ppm GTRU20-MRP-HO | Enhanced creaminess and meat flavor, |
| | more spicy |
| 100 ppm GRU90-MRP-CA | Enhanced sweetness and meat flavor, |
| | smoother and richer overall taste |
| 100 ppm GRU90-MRP-HO | Enhanced sweetness and meat flavor, |
| | smoother and richer overall taste |
| 100 ppm GRU90-MRP-TA | Enhanced sweetness and meat flavor, |
| | smoother and richer overall taste |

Application 8: Pickles with MRPs

Pickle source: Efko brand “Delikatess Gurken” (330 g jar, sweetened with sucralose), 09.2022/030239071632.

Test design: 100 ppm of each MRP was added to the commercial pickles. Then the samples were tasted and sensory evaluated. Each sample contained 7 g of pickles and 20 ml of pickle liquid. The samples were stored for 24 h at 5° C. and then subjected to a sensory evaluation, the results of which are shown in Table 88-8.

TABLE 88-8
Sensory evaluation of pickles with MRPs.

| Sample | Sensory evaluation |
|---|---|
| Control | Very salty, very sour, crunchy |
| 100 ppm GRU20-MRP-CA | Milder and smoother taste, less sour, |
| | crunchy |
| 100 ppm GRU20-MRP-TA | Milder and smoother taste, less sour, |
| | crunchy |
| 100 ppm GTRU20-MRP-CA | Milder and smoother taste, less sour, |
| | crunchy |
| 100 ppm GTRU20-MRP-HO | Milder and smoother taste, less sour, |
| | crunchy |
| 100 ppm GRU90-MRP-CA | Milder and smoother taste, less sour, |
| | crunchy |
| 100 ppm GRU90-MRP-HO | Milder and smoother taste, less sour, |
| | crunchy |
| 100 ppm GRU90-MRP-TA | Milder and smoother taste, less sour, |
| | crunchy |

Application 9: Beet Salad with MRPs

Source material: Efko brand “Rote Ruben Salat” (340 g jar, Brand: Efko, sugar content: 8.8 g/100 g) 12.2022/030139110539.

Test design: 100 ppm of each MRP was added to the commercial beet salad, pickled in acid vinegar with table salt and aroma. After adding of MRPs the samples were stored for 24 h at 5° C. Then the samples were samples were subjected to a sensory evaluation, the results of which are shown in Table 88-9.

TABLE 88-9
Sensory evaluation of beet salad with MRPs.

| Sample | Sensory evaluation |
|---|---|
| Control | Deep red color, beet flavor, earthy, sour, |
| | sweet-salty taste |
| 100 ppm GRU20-MRP-CA | Enhanced sweetness, less sour, well- |
| | balanced sweet-salty taste |
| 100 ppm GRU20-MRP-TA | Enhanced sweetness, less sour, well- |
| | balanced sweet-salty taste |
| 100 ppm GTRU20-MRP-CA | Enhanced sweetness, less sour, well- |
| | balanced sweet-salty taste |
| 100 ppm GTRU20-MRP-HO | Enhanced sweetness, less sour, well- |
| | balanced sweet-salty taste |
| 100 ppm GRU90-MRP-CA | Too sweet, slightly sour |
| 100 ppm GRU90-MRP-HO | Too sweet, slightly sour |
| 100 ppm GRU90-MRP-TA | Too sweet, slightly sour |

Application 10: Marinated Mushrooms with MRPs

Source material: Billa AG brand “Junge Champignons Ganze Kopfe” (280 g jar, without added sugar) 314 F1901 51, 26.11.2022, PSG 48/15 20:09.

Test design: 100 ppm of each MRP was added to the commercial champignons (mushrooms). Each sample contained 6 g champignons and 20 ml of champignon liquid. The samples were stored for 24 h at 5° C. and were subjected to a sensory evaluation, the results of which are shown in Table 88-10.

TABLE 88-10
Sensory evaluation of marinated mushrooms with MRPs.

| Sample | Sensory evaluation |
|---|---|
| Control | Not enough taste, thin mouth-feeling |
| 100 ppm GRU20-MRP-CA | Better overall taste, enhanced champignon |
| | flavor, round mouth-feeling |
| 100 ppm GRU20-MRP-TA | Better overall taste, enhanced champignon |
| | flavor, round mouth-feeling |
| 100 ppm GTRU20-MRP-CA | Better overall taste, enhanced champignon |
| | flavor, round mouth-feeling |
| 100 ppm GTRU20-MRP-HO | Better overall taste, enhanced champignon |
| | flavor, round mouth-feeling |
| 100 ppm GRU90-MRP-CA | Very good taste, enhanced sweetness and |
| | champignon flavor, round mouth-feeling |
| 100 ppm GRU90-MRP-HO | Very good taste, enhanced sweetness and |
| | champignon flavor, round mouth-feeling |
| 100 ppm GRU90-MRP-TA | Very good taste, enhanced sweetness and |
| | champignon flavor, round mouth-feeling |

Application 11: Tomato Sauce with MRPs

Source material: Felix brand “5 Krauter” tomato sauce with 5 herbs (360 g jar, sugar content: 5.9 g/100 g), Felix Austria GmbH, P 13022/11**01/19**FX/525-Q**.

Test design: 100 ppm of each MRP was added to the commercial tomato sauce. Then the samples were subjected to a sensory evaluation, the results of which are shown in Table 88-11.

TABLE 88-11
Sensory evaluation of tomato sauce with MRPs.

| Sample | Sensory evaluation |
|---|---|
| Control | Homogeneous texture with small tomato |
| | pieces, spicy with a sour/acidic aftertaste |
| 100 ppm GRU20-MRP-CA | Enhanced tomato flavor, smoother, less |
| | acidic, pleasant well-balanced overall taste |
| 100 ppm GRU20-MRP-TA | Enhanced tomato flavor, smoother, less |
| | acidic, pleasant well-balanced overall taste |
| 100 ppm GTRU20-MRP-CA | Enhanced tomato flavor, smoother, less |
| | acidic, pleasant well-balanced overall taste |
| 100 ppm GTRU20-MRP-HO | Enhanced tomato flavor, smoother, less |
| | acidic, pleasant well-balanced overall taste |
| 100 ppm GRU90-MRP-CA | Too much sweetness, not acidic, smooth, |
| | enhanced tomato flavor |
| 100 ppm GRU90-MRP-HO | Too much sweetness, not acidic, smooth, |
| | enhanced tomato flavor |
| 100 ppm GRU90-MRP-TA | Too much sweetness, not acidic, smooth, |
| | enhanced tomato flavor |

Application 12: Spicy Tomato Sauce with Meat and MRPs

Source material: Felix brand “Sugo Fleisch Pikant” (Spicy tomato sauce with meat; 360 g jar, sugar content: 6.5 g/100 g), Felix Austria GmbH, P 13021/13**12/19**FX/449-Q.

Test design: 100 ppm of each MRP was added to the commercial tomato sauce Sugo with meat. Then the samples were subjected to a sensory evaluation, the results of which are shown in Table 88-12.

TABLE 88-12
Sensory evaluation of spicy tomato sauce with meat and MRPs.

| Sample | Sensory evaluation |
|---|---|
| Control | Homogeneous texture, meaty & tomato |
| | flavor, spicy, acidic aftertaste |
| 100 ppm GRU20-MRP-CA | Enhanced meaty & tomato flavor, less |
| | acidic, well-balanced overall taste |
| 100 ppm GRU20-MRP-TA | Enhanced meaty & tomato flavor, less |
| | acidic, well-balanced overall taste |
| 100 ppm GTRU20-MRP-CA | Enhanced meaty & tomato flavor, less |
| | acidic, well-balanced overall taste |
| 100 ppm GTRU20-MRP-HO | Enhanced meaty & tomato flavor, less |
| | acidic, well-balanced overall taste |
| 100 ppm GRU90-MRP-CA | Enhanced meaty & tomato flavor, less |
| | acidic, well-balanced overall taste, |
| | very pleasant, smooth |
| 100 ppm GRU90-MRP-HO | Enhanced meaty & tomato flavor, less |
| | acidic, well-balanced overall taste, |
| | very pleasant, smooth |
| 100 ppm GRU90-MRP-TA | Enhanced meaty & tomato flavor, less |
| | acidic, well-balanced overall taste |

Application 13: Beef Goulash with MRPs

Source material: Knorr brand “Gulasch” (500 g can, sugar content: 2 g/100 g; fat content: 4 g/100 g), 03 2023 L007222870 17:392303.

Test design. 100 ppm of each MRP was added to the commercial beef goulash. Then the samples were subjected to a sensory evaluation, the results of which are shown in Table 88-13.

TABLE 88-13
Sensory evaluation of beef goulash with MRPs.

| Sample | Sensory evaluation |
|---|---|
| Control | Viscous texture, with meat and potato |
| | pieces, spicy, tomato-meat & roasted |
| | onion flavor with a slightly sour aftertaste |
| 100 ppm GRU20-MRP-CA | Milder and smoother mouth-feeling, |
| | without a sour aftertaste, enhanced overall |
| | taste |
| 100 ppm GRU20-MRP-TA | Milder and smoother mouth-feeling, |
| | without a sour aftertaste, enhanced overall |
| | taste |
| 100 ppm GTRU20-MRP-CA | Milder and smoother mouth-feeling, |
| | without a sour aftertaste, enhanced overall |
| | taste |
| 100 ppm GTRU20-MRP-HO | Milder and smoother mouth-feeling, |
| | without a sour aftertaste, enhanced overall |
| | taste |
| 100 ppm GRU90-MRP-CA | Very sweet |
| 100 ppm GRU90-MRP-HO | Very sweet |
| 100 ppm GRU90-MRP-TA | Very Sweet |

Application 14: Chili Con Carne with MRPs

Source material: Knorr brand “Chili con Carne” (500 g can, sugar content: 1.7 g/100 g, fat content: 4.3 g/100 g) Knorr, 12 2022 L934512870 09:412305.

Test design: 100 ppm of MRPs were added to the commercial ready-meal Chili con Came. Then the samples were subjected to a sensory evaluation, the results of which are shown in Table 88-14.

TABLE 88-14
Sensory evaluation of Chili con Carne with MRPs.

| Sample | Sensory evaluation |
|---|---|
| Control | Very spicy, very hot, with beans, corn and |
| | minced meat in dark red sauce, viscous |
| | texture, tomato-bean meaty flavor |
| 100 ppm GRU20-MRP-CA | Milder, enhanced tomato flavor, not too |
| | hot, tender, smooth and round taste |
| 100 ppm GRU20-MRP-TA | Milder, enhanced tomato flavor, not too |
| | hot, tender, smooth and round taste |
| 100 ppm GTRU20-MRP-CA | Milder, enhanced tomato flavor, not too |
| | hot, tender, smooth and round taste |
| 100 ppm GTRU20-MRP-HO | Milder, enhanced tomato flavor, not too |
| | hot, tender, smooth and round taste |
| 100 ppm GRU90-MRP-CA | A little bit too much sweet, enhanced |
| | tomato flavor, not too hot, tender, |
| | smooth and round taste |
| 100 ppm GRU90-MRP-HO | Very sweet |
| 100 ppm GRU90-MRP-TA | Very sweet |

Application 15: Italian Vegetable Soup (Minestrone) with MRPs

Source material: Weight Watchers brand “Italiensiche Gemusesuppe mit Krautern” (Italian vegetable soup with herbs), 400 ml can, sugar content: 2.3 g/100 ml, fat content: 0.2 g/100 ml), H.J. Heinz GmbH, 02-2023, 081200149 NL43 EG.

Test design: 100 ppm of MRPs were added to the commercial Italian vegetable soup with herbs (minestrone). Then the samples were subjected to a sensory evaluation, the results of which are shown in Table 88-15.

TABLE 88-15
Sensory evaluation of Italian vegetable
soup (minestrone) with MRPs.

| Sample | Sensory evaluation |
|---|---|
| Control | Liquid consistency, red color, with |
| | tomato, green peas, carrot, onion and |
| | noodles, watery mouth-feeling, empty |
| | taste |
| 100 ppm GRU20-MRP-CA | Enhanced tomato flavor, improved- |
| | feeling, milder and smoother overall taste |
| 100 ppm GRU20-MRP-TA | Enhanced tomato flavor, improved- |
| | feeling, milder and smoother overall taste |
| 100 ppm GTRU20-MRP-CA | Enhanced tomato flavor, improved- |
| | feeling, milder and smoother overall taste |
| 100 ppm GTRU20-MRP-HO | Enhanced tomato flavor, improved- |
| | feeling, milder and smoother overall taste |
| 100 ppm GRU90-MRP-CA | Enhanced sweetness and tomato flavor, |
| | improved-feeling, milder and smoother |
| | overall taste |
| 100 ppm GRU90-MRP-HO | Enhanced sweetness and tomato flavor, |
| | improved-feeling, milder and smoother |
| | overall taste |
| 100 ppm GRU90-MRP-TA | Enhanced sweetness and tomato flavor, |
| | improved-feeling, milder and smoother |
| | overall taste |

Application 16: Potato Cream Soup with MRPs

Source material: Weight Watchers brand “Kartoffel Cremesuppe” (Potato cream soup with carrots and leeks; 400 ml can, sugar content: 1.6 g/100 ml, fat content: 0.3 g/100 ml, H.J. Heinz GmbH, 01-2023, 051200701 NL43 EG).

Test design: 100 ppm of MRPs were added to the commercial potato cream soup with herbs. Then the samples were subjected to a sensory evaluation, the results of which are shown in Table 88-16.

TABLE 88-16
Sensory evaluation of potato cream soup with MRPs.

| Sample | Sensory evaluation |
|---|---|
| Control | Viscous consistency, with carrots and |
| | onion, potato flavor, empty taste, |
| | flat mouth-feeling |
| 100 ppm GRU20-MRP-CA | Enhanced potato flavor, improved mouth- |
| | feeling, smoother overall taste |
| 100 ppm GRU20-MRP-TA | Enhanced potato flavor, improved mouth- |
| | feeling, smoother overall taste |
| 100 ppm GTRU20-MRP-CA | Enhanced potato flavor, improved mouth- |
| | feeling, smoother overall taste |
| 100 ppm GTRU20-MRP-HO | Enhanced potato flavor, improved mouth- |
| | feeling, smoother overall taste |
| 100 ppm GRU90-MRP-CA | Enhanced sweetness and potato flavor, |
| | improved mouth-feeling, smoother overall |
| | taste |
| 100 ppm GRU90-MRP-HO | Enhanced sweetness and potato flavor, |
| | improved mouth-feeling, smoother overall |
| | taste |
| 100 ppm GRU90-MRP-TA | Enhanced sweetness and potato flavor, |
| | improved mouth-feeling, smoother overall |
| | taste |

Application 17: Asian Vegetable Soup with Chicken and MRPs

Source material: Weight Watchers brand, (Asian vegetable soup with chicken, “Asiatische Gemusesuppe”, 400 ml can, sugar content: 0.7 g/100 ml, fat content: 0.5 g/100 ml, H.J. Heinz GmbH 12-2022, 511191147 NL43 EG).

Test design: 100 ppm of MRPs were added to the commercial Asian vegetable soup with chicken. Then the samples were subjected to a sensory evaluation, the results of which are shown in Table 88-17.

TABLE 88-17
Sensory evaluation of Asian vegetable
soup with chicken and MRPs.

| Sample | Sensory evaluation |
|---|---|
| Control | Liquid consistency, oily, with mung |
| | beans, bamboo shoots, carrots, celery, |
| | mu-err mushrooms, spring onions and |
| | glass noodles, spicy, too salty, too |
| | flavored |
| 100 ppm GRU20-MRP-CA | Enhanced sweetness, more balanced |
| | sweet-salty taste, well-balanced flavor |
| 100 ppm GRU20-MRP-TA | Enhanced sweetness, more balanced |
| | sweet-salty taste, well-balanced flavor |
| 100 ppm GTRU20-MRP-CA | Enhanced sweetness, more balanced |
| | sweet-salty taste, well-balanced flavor |
| 100 ppm GTRU20-MRP-HO | Enhanced sweetness, more balanced |
| | sweet-salty taste, well-balanced flavor |
| 100 ppm GRU90-MRP-CA | Very sweet |
| 100 ppm GRU90-MRP-HO | Very sweet |
| 100 ppm GRU90-MRP-TA | Very sweet |

Application 18: Garlic Cream Soup with MRPs

Source material: Knorr brand “Knoblauchcreme Suppe” (Powdered garlic cream-soup, 91 g bag, sugar content: 1.3 g/100 g, fat content: 2.3 g/100 g, 02 2021, L0035C9816*01).

Test design: 100 ppm of MRPs were added to the commercial powdered garlic cream soup. Then the samples were subjected to a sensory evaluation, the results of which are shown in Table 88-18.

Preparation of the powdered soup: 1) Stir the contents of the bag with a whisk in 750 ml of warm water. Bring to the boil while stirring. 2) Simmer for 5 minutes, stirring occasionally.

TABLE 88-18
Sensory evaluation of garlic cream soup with MRPs.

| Sample | Sensory evaluation |
|---|---|
| Control | Intensive garlic flavor, viscous, creamy |
| | consistency, with garlic and spring |
| | onions, over flavored, artificial taste, |
| | flat mouth-feeling |
| 100 ppm GRU20-MRP-CA | Enhanced and well-balanced flavor |
| | perception, less artificial taste, round |
| | mouth-feeling |
| 100 ppm GRU20-MRP-TA | Enhanced and well-balanced flavor |
| | perception, less artificial taste, round |
| | mouth-feeling |
| 100 ppm GTRU20-MRP-CA | Enhanced and well-balanced flavor |
| | perception, less artificial taste, round |
| | mouth-feeling |
| 100 ppm GTRU20-MRP-HO | Enhanced and well-balanced flavor |
| | perception, less artificial taste, round |
| | mouth-feeling |
| 100 ppm GRU90-MRP-CA | Very sweet |
| 100 ppm GRU90-MRP-HO | Very sweet |
| 100 ppm GRU90-MRP-TA | Very sweet |

Application 19: Broccoli Cream Soup with MRPs

Source material: Knorr brand “Broccolicreme Suppe” (powdered broccoli cream-soup, 91 g package, Brand: Knorr, sugar content: 1.3 g/100 ml, fat content: 3.4 g/100 ml, 06 2021, L0071AS816*10).

Test design: 100 ppm of MRPs were added to the commercial powdered broccoli cream soup. Then the samples were subjected to a sensory evaluation, the results of which are shown in Table 88-19.

Preparation of the powdered soup: 1) Bring 500 ml of water to a boil. Remove the pan from the hob. 2) Stir in the contents of the bag with a whisk. Let stand for ½ minute, stir.

TABLE 88-19
Sensory evaluation of broccoli cream soup with MRPs.

| Sample | Sensory evaluation |
|---|---|
| Control | Viscous, creamy consistency, with |
| | broccoli and croutons, flat mouth- |
| | feeling, void taste, over flavored |
| 100 ppm GRU20-MRP-CA | Enhanced and well-balanced flavor |
| | perception, less artificial taste, |
| | round mouth-feeling |
| 100 ppm GRU20-MRP-TA | Enhanced and well-balanced flavor |
| | perception, less artificial taste, |
| | round mouth-feeling |
| 100 ppm GTRU20-MRP-CA | Enhanced and well-balanced flavor |
| | perception, less artificial taste, |
| | round mouth-feeling |
| 100 ppm GTRU20-MRP-HO | Enhanced and well-balanced flavor |
| | perception, less artificial taste, |
| | round mouth-feeling |
| 100 ppm GRU90-MRP-CA | Very sweet |
| 100 ppm GRU90-MRP-HO | Very sweet |
| 100 ppm GRU90-MRP-TA | Very sweet |

Application 20: Porcini Mushroom Soup with MRPs

Source material: Knorr brand “Steinpilz Suppe” (Powdered porcini mushroom soup, 91 g package, sugar content: 1.3 g/100 g, 05 2021 L93180B803 2 16:21).

Test design: 100 ppm of MRPs were added to the commercial powdered porcini mushroom soup. Then the samples were subjected to a sensory evaluation, the results of which are shown in Table 88-20.

Preparation of the powdered soup: (1) Stir the contents of the bag into a liter of warm water with a whisk and bring to the boil; (2) Let the soup cook for 8 minutes, stirring occasionally.

TABLE 88-20
Sensory evaluation of porcini mushroom soup with MRPs.

| Sample | Sensory evaluation |
|---|---|
| Control | Creamy consistency, slightly brown color, |
| | with onions and herbs, mushroom flavor, |
| | over flavored (artificial), void taste, |
| | not enough salty |
| 100 ppm GRU20-MRP-CA | Enhanced and well-balanced flavor |
| | perception, less artificial taste, round |
| | mouth-feeling |
| 100 ppm GRU20-MRP-TA | Enhanced and well-balanced flavor |
| | perception, less artificial taste, round |
| | mouth-feeling |
| 100 ppm GTRU20-MRP-CA | Enhanced and well-balanced flavor |
| | perception, less artificial taste, round |
| | mouth-feeling |
| 100 ppm GTRU20-MRP-HO | Enhanced and well-balanced flavor |
| | perception, less artificial taste, round |
| | mouth-feeling |
| 100 ppm GRU90-MRP-CA | Very sweet |
| 100 ppm GRU90-MRP-HO | Very sweet |
| 100 ppm GRU90-MRP-TA | Very sweet |

Conclusion: Adding all different types of GSTE-MRPs and GSTC-MRPs to foods, such as dressings, soft cheeses, spreads, delicatessen salads, sour goods, tomato sauce products, and ready-to-eat meals, including soups, can significantly improve the palatability of foods, enhance and harmonize flavor and taste perception, increase mouth-feel, reduce sourness, and minimize artificial aftertastes. The usage could be extended from 1 ppm to 10,000 ppm.

### Example 88B. Sensory Evaluation of Beverage Products Containing MRPs

The following examples address the effects of different MRPs on sweetness and flavor perception in carbonated reduced sugar soft drinks.

In these examples, the following MRPs were used:

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

Application 1: Low Sugar Strawberry-Pepper Flavored Soft Drink with MRPs

Beverage source: Voslauer brand strawberry-pepper flavored soft drink (0.75 liter bottle, sugar content: 1.9 g/100 ml, Voslauer Mineralwasser GmbH, 05.20, L93242218).

Test design: 100 ppm of MRPs were added to the commercial soft drink with strawberry-pepper flavor. Then the samples were subjected to a sensory evaluation, the results of which are shown in Table 88-21.

TABLE 88-21
Sensory evaluation of strawberry-pepper
flavored soft drink with MRPs.

| Sample | Sensory evaluation |
|---|---|
| Control | Strawberry flavor, not enough sweet, |
| | sour, watery mouth-feeling |
| 100 ppm GRU20-MRP-CA | Enhanced mouth-feeling, less sour, |
| | smoother, pleasant overall taste |
| 100 ppm GRU20-MRP-TA | Enhanced mouth-feeling, less sour, |
| | smoother, pleasant overall taste |
| 100 ppm GTRU20-MRP-CA | Enhanced mouth-feeling, less sour, |
| | smoother, pleasant overall taste |
| 100 ppm GTRU20-MRP-HO | Enhanced mouth-feeling, less sour, |
| | smoother, pleasant overall taste |
| 100 ppm GRU90-MRP-CA | A little bit sweeter, enhanced mouth- |
| | feeling, less sour, smoother, well- |
| | balanced overall taste |
| 100 ppm GRU90-MRP-HO | A little bit sweeter, enhanced mouth- |
| | feeling, less sour, smoother, well- |
| | balanced overall taste |
| 100 ppm GRU90-MRP-TA | A little bit sweeter, enhanced mouth- |
| | feeling, less sour, smoother, well- |
| | balanced overall taste |

Application 2: Low Sugar Raspberry-Lemon Flavored Soft Drink with MRPs

Beverage source: Voslauer brand raspberry-lemon flavored soft drink (0.75 liter bottle, sugar content: 2.4 g/100 ml, Voslauer Mineralwasser GmbH, 05.20, L93240835).

Test design: 100 ppm of MRPs were added to the commercial raspberry-lemon flavored soft drink. Then the samples were subjected to a sensory evaluation, the results of which are shown in Table 88-22.

TABLE 88-22
Sensory evaluation of raspberry-lemon
flavored soft drink with MRPs.

| Sample | Sensory evaluation |
|---|---|
| Control | Raspberry flavor, not enough sweet, very |
| | sour, watery mouth-feeling, too strong |
| | flavored |
| 100 ppm GRU20-MRP-CA | Enhanced mouth-feeling, well-balanced |
| | raspberry flavor, less sour, smoother, |
| | pleasant overall taste |
| 100 ppm GRU20-MRP-TA | Enhanced mouth-feeling, well-balanced |
| | raspberry flavor, less sour, smoother, |
| | pleasant overall taste |
| 100 ppm GTRU20-MRP-CA | Enhanced mouth-feeling, well-balanced |
| | raspberry flavor, less sour, smoother, |
| | pleasant overall taste |
| 100 ppm GTRU20-MRP-HO | Enhanced mouth-feeling, well-balanced |
| | raspberry flavor, less sour, smoother, |
| | pleasant overall taste |
| 100 ppm GRU90-MRP-CA | A little bit sweeter, enhanced mouth- |
| | feeling, less sour, smoother, well- |
| | balanced overall taste |
| 100 ppm GRU90-MRP-HO | A little bit sweeter, enhanced mouth- |
| | feeling, less sour, smoother, well- |
| | balanced overall taste |
| 100 ppm GRU90-MRP-TA | A little bit sweeter, enhanced mouth- |
| | feeling, less sour, smoother, well- |
| | balanced overall taste |

Application 3: Low-Sugar Apple-Cranberry Flavored Soft Drink with MRPs

Beverage source: Voslauer brand apple-cranberry flavored soft drink (0.75 liter bottle, sugar content: 2.1 g/100 ml, Voslauer Mineralwasser GmbH, 06.20, L93400258).

Test design: 100 ppm of MRPs were added to the commercial apple-cranberry flavored soft drink. Then the samples were subjected to a sensory evaluation, the results of which are shown in Table 88-23.

TABLE 88-23
Sensory evaluation of apple-cranberry
flavored soft drink with MRPs.

| Sample | Sensory evaluation |
|---|---|
| Control | Fruity flavor, not enough sweet, watery |
| | mouth-feeling, too strong flavored |
| 100 ppm GRU20-MRP-CA | Enhanced mouth-feeling, well-balanced |
| | fruity flavor, less sour, smoother, pleasant |
| | overall taste with slight caramel notes |
| 100 ppm GRU20-MRP-TA | Enhanced mouth-feeling, well-balanced |
| | fruity flavor, less sour, smoother, |
| | pleasant overall taste |
| 100 ppm GTRU20-MRP-CA | Enhanced mouth-feeling, well-balanced |
| | fruity flavor, less sour, smoother, |
| | pleasant overall taste |
| 100 ppm GTRU20-MRP-HO | Enhanced mouth-feeling, well-balanced |
| | fruity flavor, less sour, smoother, |
| | pleasant overall taste |
| 100 ppm GRU90-MRP-CA | A little bit sweeter, enhanced mouth- |
| | feeling, less sour, smoother, well-balanced |
| | overall taste |
| 100 ppm GRU90-MRP-HO | A little bit sweeter, enhanced mouth- |
| | feeling, less sour, smoother, well-balanced |
| | overall taste |
| 100 ppm GRU90-MRP-TA | A little bit sweeter, enhanced mouth- |
| | feeling, less sour, smoother, well-balanced |
| | overall taste |

Application 4: Low-Sugar Red Grape Flavored Soft Drink with MRPs

Beverage source: Voslauer brand red grape flavored soft drink (0.75 liter bottle, sugar content: 1.9 g/100 ml, Voslauer Mineralwasser GmbH, 06.20, L93400258).

Test design: 100 ppm of MRPs were added to the commercial red grape flavored soft drink. Then the samples were subjected to a sensory evaluation, the results of which are shown in Table 88-24.

TABLE 88-24
Sensory evaluation of red grape flavored soft drink with MRPs.

| Sample | Sensory evaluation |
|---|---|
| Control | Grape flavor, not enough sweet, watery |
| | mouth-feeling, too strong flavored |
| 100 ppm GRU20-MRP-CA | Enhanced mouth-feeling, well-balanced |
| | grape flavor, less sour, smoother, |
| | pleasant overall taste |
| 100 ppm GRU20-MRP-TA | Enhanced mouth-feeling, well-balanced |
| | grape flavor, less sour, smoother, |
| | pleasant overall taste |
| 100 ppm GTRU20-MRP-CA | Enhanced mouth-feeling, well-balanced |
| | grape flavor, less sour, smoother, |
| | pleasant overall taste |
| 100 ppm GTRU20-MRP-HO | Enhanced mouth-feeling, well-balanced |
| | grape flavor, less sour, smoother, |
| | pleasant overall taste |
| 100 ppm GRU90-MRP-CA | A little bit sweeter, enhanced mouth- |
| | feeling, less sour, smoother, well- |
| | balanced overall taste |
| 100 ppm GRU90-MRP-HO | A little bit sweeter, enhanced mouth- |
| | feeling, less sour, smoother, well- |
| | balanced overall taste |
| 100 ppm GRU90-MRP-TA | A little bit sweeter, enhanced mouth- |
| | feeling, less sour, smoother, well- |
| | balanced overall taste |

Conclusion: Adding GSTE-MRPs and GSTC-MRPs to a low sugar beverage enhances the sweetness and mouthfeel, harmonizes the flavor, reduces sourness, and provides an overall taste and flavor that is pleasant and palatable.

### Example 88C. Sensory Evaluation of Beverage Products Replacing Sugar with MRPs

The following examples reflect a study in which the sugar content of commercial beverage products (up to 50%) are replaced with MRPs. In this study, the following MRPs were used:

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

Steviol glycoside RA50, Lot #20180823-1

Application 1: Lemonade with MRPs

Beverage source: Alnatura brand “Zitronen Saft” (100% direct lemon juice, Alnatura, 24.03.2021, 14:07, 81321)

Test design: The 100% lemon juice (brand name: Alnatura) was diluted 1:5 with water and 6% sugar was added to serve as a control beverage. For each test beverage sample, lemonade was diluted 1:5 with water and 6% sugar (50% less sugar) was added along with RA50 and an MRP as indicated in Tables 88-25 and 88-26 below.

The sensory evaluations consisted of comparable sweetness, flavor and acidity intensity (each test sample compared to control), the results of which are shown in Tables 88-25 and 88-26.

TABLE 88-25
Sensory evaluation.

| | | | GRU20- | GRU20- | GTRU20- | GTRU20- | |
|---|---|---|---|---|---|---|---|
| | Sugar | RA50 | MRP-CA | MRP-TA | MRP-CA | MRP-HO | |
| | [g/L] | [mg/L] | [mg/L] | [mg/L] | [mg/L] | [mg/L] | Sensory evaluation |
| 100% sugar | 60 | | | | | | Refreshing lemon |
| | | | | | | | flavor, very sour, very |
| | | | | | | | quick onset of acidity, |
| | | | | | | | tangy, citrus taste, |
| | | | | | | | strong astringent |
| | | | | | | | aftertaste |
| 50% sugar | 30 | 130 | 130 | | | | Enhanced sweetness |
| | | | | | | | and lemon flavor, |
| | | | | | | | smoother, pleasant |
| | | | | | | | sour, mild acidic |
| | | | | | | | aftertaste |
| 50% sugar | 30 | 130 | | 130 | | | Enhanced sweetness |
| | | | | | | | and lemon flavor, |
| | | | | | | | smoother, pleasant |
| | | | | | | | sour, mild acidic |
| | | | | | | | aftertaste |
| 50% sugar | 30 | 130 | | | 130 | | Enhanced sweetness |
| | | | | | | | and lemon flavor, |
| | | | | | | | smoother, pleasant |
| | | | | | | | sour, mild acidic |
| | | | | | | | aftertaste |
| 50% sugar | 30 | 130 | | | | 130 | Enhanced sweetness |
| | | | | | | | and lemon flavor, |
| | | | | | | | smoother, pleasant |
| | | | | | | | sour, mild acidic |
| | | | | | | | aftertaste with flowery |
| | | | | | | | notes |

TABLE 88-25
Sensory evaluation.

| | | | GRU90- | GRU90- | GRU90- | |
|---|---|---|---|---|---|---|
| | Sugar | RA 50 | MRP-CA | MRP-HO | MRP-TA | |
| | [g/L] | [mg/L] | [mg/L] | [mg/L] | [mg/L] | Sensory evaluation |
| 50% sugar | 30 | 90 | 90 | | | Enhanced sweetness and lemon |
| | | | | | | flavor, smoother, pleasant sour, |
| | | | | | | mild acidic aftertaste |
| 50% sugar | 30 | 90 | | 90 | | Enhanced sweetness and lemon |
| | | | | | | flavor, smoother, pleasant sour, |
| | | | | | | mild acidic aftertaste with |
| | | | | | | flowery notes |
| 50% sugar | 30 | 90 | | | 90 | Enhanced sweetness and lemon |
| | | | | | | flavor, smoother, pleasant sour, |
| | | | | | | mild acidic aftertaste |

Application 2: Iced Tea with MRPs

Materials:

Black tea extract, kwl, Ref. Nr: K245856

Steviol glycoside RA50, Lot #20180823-1

27102 Citric acid monohydrate gritty, puriss, Lot 60960, Riedel-de Haën

01602636 Peach Aroma, Akras Flavours GmbH

Test design: Flavored iced tea was prepared as described in Table 88-26. Sensory evaluation tests of the prepared samples are described in Tables 88.27 and 88.28.

TABLE 88-26
Basic iced tea recipe.

| Ingredients | | 100% sugar | 50% sugar |
|---|---|---|---|
| Black tea extract | [g/L] | 2 | 2 |
| Sucrose | [g/L] | 70 | 35 |
| 01602636 Peach flavor | [μl/L] | 100 | 100 |
| Citric acid monohydrate | [g/L] | 1.5 | 1.5 |

The reference sample contains 7 g sugar per 100 ml; the test sample contains 3.5 g per 100 ml.

TABLE 88-27
Sensory evaluation test results.

| | | | Citric | | GRU20- | GRU20- | GTRU20- | GTRU20- | |
|---|---|---|---|---|---|---|---|---|---|
| | Black tea | Sugar | acid | RA 50 | MRP-CA | MRP-TA | MRP-CA | MRP-HO | |
| | extract [g/L] | [g/L] | [g/L] | [mg/L] | [mg/L] | [mg/L] | [mg/L] | [mg/L] | Sensory evaluation |
| 100% sugar | 2 | 70 | 1.5 | | | | | | Peach flavor, sweet, only |
| | | | | | | | | | sweet, light sour, pleasant |
| 50% sugar | 2 | 35 | 1.5 | 110 | 100 | | | | Enhanced sweetness, well- |
| | | | | | | | | | balanced sweetness-acidity |
| | | | | | | | | | perception, overall taste |
| | | | | | | | | | very similar to 100% sugar |
| 50% sugar | 2 | 35 | 1.5 | 110 | | 100 | | | Enhanced sweetness, well- |
| | | | | | | | | | balanced sweetness-acidity |
| | | | | | | | | | perception, overall taste |
| | | | | | | | | | very similar to 100% sugar |
| 50% sugar | 2 | 35 | 1.5 | 110 | | | 100 | | Enhanced sweetness, well- |
| | | | | | | | | | balanced sweetness-acidity |
| | | | | | | | | | perception, overall taste |
| | | | | | | | | | very similar to 100% sugar |
| 50% sugar | 2 | 35 | 1.5 | 110 | | | | 100 | Enhanced sweetness, well- |
| | | | | | | | | | balanced sweetness-acidity |
| | | | | | | | | | perception, overall taste |
| | | | | | | | | | very similar to 100% sugar, |
| | | | | | | | | | flowery notes |

TABLE 88-28
Sensory evaluation test results.

| | | | Citric | | GRU90- | GRU90- | GTRU20- | |
|---|---|---|---|---|---|---|---|---|
| | Black tea | Sugar | acid | RA 50 | MRP-CA | MRP-HO | MRP-TA | |
| | extract [g/L] | [g/L] | [g/L] | [mg/L] | [mg/L] | [mg/L] | [mg/L] | Sensory evaluation |
| 50% sugar | 2 | 35 | 1.5 | 85 | 85 | | | Enhanced sweetness, well- |
| | | | | | | | | balanced sweetness-acidity |
| | | | | | | | | perception, overall taste very |
| | | | | | | | | similar to 100% sugar |
| 50% sugar | 2 | 35 | 1.5 | 85 | | 85 | | Enhanced sweetness, well- |
| | | | | | | | | balanced sweetness-acidity |
| | | | | | | | | perception, overall taste very |
| | | | | | | | | similar to 100% sugar, |
| | | | | | | | | flowery notes |
| 50% sugar | 2 | 35 | 1.5 | 85 | | | 85 | Enhanced sweetness, well- |
| | | | | | | | | balanced sweetness-acidity |
| | | | | | | | | perception, overall taste very |
| | | | | | | | | similar to 100% sugar |

Conclusion: Stevia extracts and stevia glycosides are characterized by slow sweetness onset, lingering, bitterness, and metallic and/or synthetic aftertastes. Adding GSTE-MRPs, GSTC-MRPs improves the taste profile of stevia extracts or stevia glycosides in beverages. GSTE-MRPs, GSTC-MRPs can enhance the sweetness, harmonize sweetness/acidity perception, reduce acidity, and minimize the lingering, bitterness, metallic and synthetic aftertaste of stevia extracts and stevia glycosides. A stevia composition for use in such applications can comprise any of the stevia extracts and/or stevia glycosides described in the specification, including stevia glycosides selected from Reb A, Reb B, Reb C, Reb D, Reb E, Reb M, Reb N, Reb O, and Stevioside.

### Example 89. Dose-Effect Relationships of Added GRU-MRPs

Application 1: Coca Cola Zero

Materials:

Coca Cola Zero, 12.11.2020 L13E18:31 WP, Coca Cola HBC Austria GmbH;

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

Concentrations of steviol-glycosides and glycosylated steviol-glycosides are described in Tables 89-22 to 89-29.

Test design: To examine the dose-effect relationship of GRU MRP samples added to a commercial carbonated, sugar free flavored beverage (0.5 liter bottles, Brand: Coca Cola, sweetener: sodium cyclamate, Ace-K, aspartame), various amounts of GRU MRPs (1-1000 ppm) were added to beverage and subjected to a sensory evaluation, the results of which are shown in Tables 89-1 to 89-7.

TABLE 89-1
GRU20-MRP-CA sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | more balanced overall taste |
| 50 | ppm | Sweet, typical product | Sweet, less lingering aftertaste, |
| | | flavor, refreshing | more balanced overall taste |
| 100 | ppm | Sweet, typical product | More sweet, less lingering |
| | | flavor, refreshing | aftertaste, more balanced overall |
| | | | taste |
| 200 | ppm | Sweet, typical product | Sweeter than 100 ppm, very |
| | | flavor, refreshing | slight caramel aftertaste, less |
| | | | lingering aftertaste |
| 300 | ppm | Sweet, typical product | Very sweet, slight lingering |
| | | flavor, refreshing | caramel aftertaste |
| 400 | ppm | Sweet, typical product | Very sweet, medium lingering |
| | | flavor, refreshing, | caramel aftertaste |
| | | slight herbal notes | |
| 500 | ppm | Sweet, typical product | Very sweet, strong lingering |
| | | flavor, refreshing, | caramel aftertaste |
| | | slight herbal notes | |
| 1000 | ppm | Sweet, typical product | Very sweet, very strong |
| | | flavor, refreshing, | lingering caramel aftertaste |
| | | herbal notes | |

TABLE 89-2
GRU20-MRP-TA sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, reduced lingering |
| | | flavor, refreshing | aftertaste, more balanced overall |
| | | | taste |
| 50 | ppm | Sweet, typical product | Sweet, reduced lingering |
| | | flavor, refreshing | aftertaste, more balanced overall |
| | | | taste |
| 100 | ppm | Sweet, typical product | More sweet, reduced lingering |
| | | flavor, refreshing | aftertaste |
| 200 | ppm | Sweet, typical product | Slightly sweeter than 100 ppm, |
| | | flavor, refreshing | reduced lingering aftertaste |
| 300 | ppm | Sweet, typical product | Very sweet, slight herbal and |
| | | flavor, refreshing | slight bitter aftertaste |
| 400 | ppm | Sweet, typical product | Very sweet, herbal and slight |
| | | flavor, slight herbal | bitter aftertaste |
| 500 | ppm | Sweet, typical product | Very sweet, herbal and bitter |
| | | flavor, herbal notes | aftertaste |
| 1000 | ppm | Sweet, typical product | Very sweet, strong herbal and |
| | | flavor, strong herbal | bitter aftertaste |
| | | notes | |

TABLE 89-3
GTRU20-MRP-CA sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | more balanced overall taste |
| 50 | ppm | Sweet, typical product | Sweet, less lingering aftertaste, |
| | | flavor, refreshing | more balanced overall taste |
| 100 | ppm | Sweet, typical product | More sweet, less lingering |
| | | flavor, refreshing | aftertaste, more balanced overall |
| | | | taste |
| 200 | ppm | Sweet, typical product | Sweeter than 100 ppm, very |
| | | flavor, refreshing | slight caramel aftertaste, |
| | | | less lingering aftertaste |
| 300 | ppm | Sweet, typical product | Very sweet, lingering caramel |
| | | flavor, refreshing | aftertaste |
| 400 | ppm | Sweet, typical product | Very sweet, medium lingering |
| | | flavor, refreshing, | caramel aftertaste |
| | | slight herbal notes | |
| 500 | ppm | Sweet, typical product | Very sweet, strong lingering |
| | | flavor, slight herbal | caramel aftertaste |
| | | notes | |
| 1000 | ppm | Sweet, typical product | Very sweet, strong lingering |
| | | flavor, herbal notes | caramel aftertaste |

TABLE 89-4
GTRU20-MRP-HO sensory evaluation.

| Concentration | | Sensory evaluation | |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | less artificial, more balanced |
| | | | overall taste |
| 50 | ppm | Sweet, typical product | Slightly sweeter than 10 ppm, |
| | | flavor, refreshing | reduced lingering aftertaste, less |
| | | | artificial, more balanced |
| 100 | ppm | Sweet, typical product | Slightly sweeter than 50 ppm, |
| | | flavor, refreshing | reduced lingering aftertaste, less |
| | | | artificial, more balanced |
| 200 | ppm | Sweet, typical product | Slightly sweeter than 100 ppm, |
| | | flavor, refreshing | reduced lingering aftertaste, very |
| | | | slight flowery notes |
| 300 | ppm | Sweet, typical product | Very sweet, slight flowery |
| | | flavor, refreshing | lingering aftertaste |
| 400 | ppm | Sweet, typical product | Very sweet, medium flowery |
| | | flavor, slight flowery | lingering aftertaste |
| | | notes | |
| 500 | ppm | Sweet, typical product | Very sweet, strong flowery |
| | | flavor, refreshing, | lingering aftertaste |
| | | flowery notes | |
| 1000 | ppm | Sweet, typical product | Very sweet, strong flowery |
| | | flavor, strong herbal | lingering aftertaste |
| | | notes | |

TABLE 89-5
GRU90-MRP-CA sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | less artificial, more balanced |
| | | | overall taste |
| 50 | ppm | Sweet, typical product | Slightly sweeter than 10 ppm, |
| | | flavor, refreshing | reduced lingering aftertaste, less |
| | | | artificial |
| 100 | ppm | Sweet, typical product | Slightly sweeter than 50 ppm, |
| | | flavor, refreshing | reduced lingering aftertaste, less |
| | | | artificial, more balanced |
| 200 | ppm | Sweet, typical product | Sweeter than 100 ppm, reduced |
| | | flavor, refreshing | lingering aftertaste, slight |
| | | | caramel notes |
| 300 | ppm | Sweet, typical product | Very sweet, medium lingering |
| | | flavor, refreshing | caramel aftertaste |
| 400 | ppm | Sweet, typical product | Very sweet, strong lingering |
| | | flavor, slight caramel | caramel aftertaste |
| | | notes | |
| 500 | ppm | Sweet, typical product | Very sweet, strong lingering |
| | | flavor, caramel notes | caramel aftertaste |
| 1000 | ppm | Sweet, typical product | Very sweet, very strong |
| | | flavor, strong caramel | lingering caramel aftertaste |
| | | notes | |

TABLE 89-6
GRU90-MRP-TA sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | less artificial, more balanced |
| | | | overall taste |
| 50 | ppm | Sweet, typical product | Slightly sweeter than 10 ppm, |
| | | flavor, refreshing | reduced lingering aftertaste, less |
| | | | artificial |
| 100 | ppm | Sweet, typical product | Slightly sweeter than 50 ppm, |
| | | flavor, refreshing | reduced lingering aftertaste, less |
| | | | artificial, more balanced |
| 200 | ppm | Sweet, typical product | Slightly sweeter than 100 ppm, |
| | | flavor, refreshing | reduced lingering aftertaste, very |
| | | | slight herbal notes |
| 300 | ppm | Sweet, typical product | Slightly sweeter than 200 ppm, |
| | | flavor, refreshing | reduced lingering aftertaste, |
| | | | herbal notes |
| 400 | ppm | Sweet, typical product | Very sweet, strong herbal |
| | | flavor, slight herbal | lingering aftertaste |
| | | notes | |
| 500 | ppm | Sweet, typical product | Very sweet, strong herbal |
| | | flavor, herbal notes | lingering aftertaste |
| 1000 | ppm | Sweet, typical product | Very sweet, very strong herbal |
| | | flavor, strong herbal | lingering aftertaste |
| | | notes | |

TABLE 89-7
GRU90-MRP-HO sensory evaluation.

| Concentration | | Aroma | Taste |
|---|---|---|---|
| None (Control) | | Sweet, typical product | Sweet, slight lingering aftertaste, |
| | | flavor, refreshing | artificial, void |
| 5 | ppm | Sweet, typical product | Sweet, slight lingering aftertaste, |
| | | flavor, refreshing | artificial, void |
| 10 | ppm | Sweet, typical product | Sweet, less lingering aftertaste, |
| | | flavor, refreshing | less artificial, more balanced |
| | | | overall taste |
| 50 | ppm | Sweet, typical product | Slightly sweeter than 10 ppm, |
| | | flavor, refreshing | reduced lingering aftertaste, less |
| | | | artificial |
| 100 | ppm | Sweet, typical product | Slightly sweeter than 50 ppm, |
| | | flavor, refreshing | reduced lingering aftertaste, less |
| | | | artificial, more balanced |
| 200 | ppm | Sweet, typical product | Sweeter than 100 ppm, reduced |
| | | flavor, refreshing | lingering aftertaste, slight |
| | | | flowery aftertaste |
| 300 | ppm | Sweet, typical product | Very sweet, lingering flowery |
| | | flavor, refreshing | aftertaste |
| 400 | ppm | Sweet, typical product | Very sweet, strong lingering |
| | | flavor, slight flowery | flowery aftertaste |
| | | notes | |
| 500 | ppm | Sweet, typical product | Very sweet, strong lingering |
| | | flavor, flowery notes | flowery aftertaste |
| 1000 | ppm | Sweet, typical product | Very sweet, very strong |
| | | flavor, strong flowery | lingering flowery aftertaste |
| | | notes | |

Application 2: Banana Flavored High Protein Drink

Materials:

Banana Flavored High Protein Drink, 12.02.2020, 3211702:19101, Nom AG

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

Concentrations of steviol-glycosides and glycosylated steviol-glycosides are described in Tables 89-22 to 89-29.

Test design: To examine the dose-effect relationship of GRU MRP samples, a commercial sugar free protein drink with banana flavor (0.451 bottles, Brand: Nom, sweetener: sucralose) was selected. Various amounts of GRU MRPs (1-1000 ppm) were added to the protein drink, and the resulting samples were subjected to a sensory evaluation, the results of which are shown in Tables 89-8 to 89-14.

TABLE 89-8
GRU20-MRP-CA sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweet, enhanced creamy |
| | | banana flavor | mouth feeling |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste |
| 300 | ppm | Milky, enhanced | Very sweet, very slight caramel |
| | | banana flavor | lingering aftertaste |
| 400 | ppm | Milky, banana | Very sweet, slight caramel lingering |
| | | flavor, caramel | aftertaste |
| | | notes | |
| 500 | ppm | Milky, banana | Very sweet, caramel lingering |
| | | flavor, strong | aftertaste |
| | | caramel notes | |
| 1000 | ppm | Milky, banana | Very sweet, strong caramel lingering |
| | | flavor, very | aftertaste |
| | | strong caramel | |
| | | notes | |

TABLE 89-9
GRU20-MRP-TA sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweet, enhanced creamy |
| | | banana flavor | mouth feeling, more balanced overall |
| | | | taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Sweeter than 50 ppm, enhanced |
| | | banana flavor | creamy mouth feeling, well balanced |
| | | | overall taste |
| 200 | ppm | Milky, enhanced | Sweeter than 100 ppm, enhanced |
| | | banana flavor | creamy mouth feeling, well balanced |
| | | | overall taste |
| 300 | ppm | Milky, enhanced | Sweeter than 200 ppm, very sweet, |
| | | banana flavor | slight herbal aftertaste |
| 400 | ppm | Milky, banana | Very sweet, herbal lingering |
| | | flavor, slight | aftertaste |
| | | herbal notes | |
| 500 | ppm | Milky, banana | Very sweet, strong herbal lingering |
| | | flavor, strong | aftertaste |
| | | herbal notes | |
| 1000 | ppm | Milky, banana | Very sweet, very strong herbal |
| | | flavor, very | lingering aftertaste |
| | | strong herbal | |
| | | notes | |

TABLE 89-10
GTRU20-MRP-CA sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweeter than control, |
| | | banana flavor | enhanced creamy mouth feeling, |
| | | | more balanced overall taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste, very slight caramel |
| | | | notes |
| 300 | ppm | Milky, enhanced | Very sweet, slight caramel lingering |
| | | banana flavor | aftertaste |
| 400 | ppm | Milky, banana | Very sweet, caramel lingering |
| | | flavor, slight | aftertaste |
| | | caramel notes | |
| 500 | ppm | Milky, banana | Very sweet, strong caramel lingering |
| | | flavor, strong | aftertaste |
| | | caramel notes | |
| 1000 | ppm | Milky, banana | Very sweet, very strong caramel |
| | | flavor, strong | lingering aftertaste |
| | | caramel notes | |

TABLE 89-11
GTRU20-MRP-HO sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweeter than control, |
| | | banana flavor | enhanced creamy mouth feeling, |
| | | | more balanced overall taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste, very slight flowery |
| | | | notes |
| 300 | ppm | Milky, enhanced | Very sweet, slight flowery lingering |
| | | banana flavor | aftertaste |
| 400 | ppm | Milky, banana | Very sweet, flowery lingering |
| | | flavor, slight | aftertaste |
| | | flowery notes | |
| 500 | ppm | Milky, banana | Very sweet, strong flowery lingering |
| | | flavor, strong | aftertaste |
| | | flowery notes | |
| 1000 | ppm | Milky, banana | Very sweet, very strong flowery |
| | | flavor, very | lingering aftertaste |
| | | strong flowery | |
| | | notes | |

TABLE 89-12
GRU90-MRP-CA sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweeter than control, |
| | | banana flavor | enhanced creamy mouth feeling, |
| | | | more balanced overall taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste |
| 300 | ppm | Milky, enhanced | Very sweet, slight caramel lingering |
| | | banana flavor | aftertaste |
| 400 | ppm | Milky, banana | Very sweet, caramel lingering |
| | | flavor, caramel | aftertaste |
| | | notes | |
| 500 | ppm | Milky, banana | Very sweet, strong caramel lingering |
| | | flavor, strong | aftertaste |
| | | caramel | |
| 1000 | ppm | Milky, banana | Very sweet, very strong caramel |
| | | flavor, very | lingering aftertaste |
| | | strong caramel | |
| | | notes | |

TABLE 89-13
GRU90-MRP-TA sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweeter than control, |
| | | banana flavor | enhanced creamy mouth feeling, |
| | | | more balanced overall taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste |
| 300 | ppm | Milky, banana | Very sweet, herbal lingering |
| | | flavor, slight | aftertaste |
| | | herbal notes | |
| 400 | ppm | Milky, banana | Very sweet, strong herbal lingering |
| | | flavor, strong | aftertaste |
| | | herbal notes | |
| 500 | ppm | Milky, banana | Very sweet, very strong herbal |
| | | flavor, very | lingering aftertaste |
| | | strong herbal | |
| | | notes | |
| 1000 | ppm | Milky, banana | Very sweet, herbal lingering |
| | | flavor, slight | aftertaste |
| | | herbal notes | |

TABLE 89-14
GRU90-MRP-HO sensory evaluations.

| Concentration | | Aroma | Taste |
|---|---|---|---|
| None (Control) | | Milky, typical | Slightly sweet, lack of body, lack of |
| | | banana flavor | creaminess, void |
| 5 | ppm | Milky, typical | Slightly sweet, lack of body, lack of |
| | | banana flavor | creaminess, void |
| 10 | ppm | Milky, enhanced | Slightly sweeter than control, |
| | | banana flavor | enhanced creamy mouth feeling, |
| | | | more balanced overall taste |
| 50 | ppm | Milky, enhanced | Slightly sweeter than 10 ppm, |
| | | banana flavor | enhanced creamy mouth feeling, |
| | | | more balanced overall taste |
| 100 | ppm | Milky, enhanced | Slightly sweeter than 50 ppm, |
| | | banana flavor | enhanced creamy mouth feeling, |
| | | | well balanced overall taste |
| 200 | ppm | Milky, enhanced | Sweeter than 100 ppm, enhanced |
| | | banana flavor | creamy mouth feeling, well balanced |
| | | | overall taste, very slight flowery |
| | | | notes |
| 300 | ppm | Milky, enhanced | Very sweet, slight flowery lingering |
| | | banana flavor | aftertaste |
| 400 | ppm | Milky, banana | Very sweet, flowery lingering |
| | | flavor, slight | aftertaste |
| | | flowery notes | |
| 500 | ppm | Milky, banana | Very sweet, strong flowery lingering |
| | | flavor, strong | aftertaste |
| | | flowery notes | |
| 1000 | ppm | Milky, banana | Very sweet, very strong flowery |
| | | flavor, very | lingering aftertaste |
| | | strong flowery | |
| | | notes | |

Application 3: Reduced Sugar Apricot Jam

Materials:

Reduced Sugar (67% less) Apricot Jam, 09.04.2022 L100 0 20:20, Darbo AG

GRU20-MRP-CA, Lot #EPC-303-56-01, EPC Lab

GRU20-MRP-TA, Lot #EPC-303-56-02, EPC Lab

GTRU20-MRP-CA, Lot #EPC-303-59-01, EPC Lab

GTRU20-MRP-HO, Lot #EPC-303-59-02, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

Concentrations of steviol-glycosides and glycosylated steviol-glycosides are described in Tables 89-22 to 89-29.

Test design: To examine the dose-effect relationship of GRU MRP samples, a commercial, sugar reduced (67% less calories) apricot jam (220 g jar, Brand: Darbo, sweetener: erythritol, Ace-K) was selected. Various amounts of GRU MRPs (1-1000 ppm) were added to the apricot jam, and the resulting samples were subjected to a sensory evaluation, the results of which are shown in Tables 89-15 to 89-21.

TABLE 89-15
Sensory evaluations of apricot jam with GRU20-MRP-CA.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweet, enhanced mouth |
| | | apricot flavor | feeling, less sour, milder |
| 100 | ppm | Sweet, enhanced | Slightly sweet, enhanced mouth |
| | | apricot flavor | feeling, less sour, milder |
| 200 | ppm | Sweet, enhanced | Sweeter than 100 ppm, enhanced |
| | | apricot flavor | mouth feeling, less sour, milder, |
| | | | more balanced overall taste |
| 300 | ppm | Sweet, enhanced | Sweeter than 200 ppm, enhanced |
| | | apricot flavor | mouth feeling, less sour, milder, |
| | | | more balanced overall taste |
| 400 | ppm | Sweet, enhanced | Sweeter than 300 ppm, enhanced |
| | | apricot flavor | mouth feeling, less sour, milder, |
| | | | well-balanced overall taste |
| 500 | ppm | Sweet, enhanced | Sweeter than 400 ppm, enhanced |
| | | apricot flavor | mouth feeling, less sour, milder, |
| | | | well-balanced overall taste |
| 600 | ppm | Sweet, enhanced | Sweeter than 500 ppm, enhanced |
| | | apricot flavor | mouth feeling, less sour, milder, |
| | | | well-balanced overall taste, slight |
| | | | caramel notes |
| 700 | ppm | Sweet, enhanced | Very sweet, caramel lingering |
| | | apricot flavor | aftertaste |
| 1000 | ppm | Sweet, enhanced | Very sweet, strong caramel lingering |
| | | apricot flavor | aftertaste |

TABLE 89-16
Sensory evaluations of apricot jam with GRU20-MRP-TA.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweet, enhanced mouth |
| | | apricot flavor | feeling, less sour, milder |
| 100 | ppm | Sweet, enhanced | Slightly sweet, enhanced mouth |
| | | apricot flavor | feeling, less sour, milder |
| 200 | ppm | Sweet, enhanced | Sweeter than 100 ppm, enhanced |
| | | apricot flavor | mouth feeling, less sour, milder, |
| | | | more balanced overall taste |
| 300 | ppm | Sweet, enhanced | Sweeter than 200 ppm, enhanced |
| | | apricot flavor | mouth feeling, less sour, milder, |
| | | | more balanced overall taste |
| 400 | ppm | Sweet, enhanced | Sweeter than 300 ppm, enhanced |
| | | apricot flavor | mouth feeling, less sour, milder, |
| | | | well-balanced overall taste |
| 500 | ppm | Sweet, enhanced | Sweeter than 400 ppm, enhanced |
| | | apricot flavor | mouth feeling, less sour, milder, |
| | | | well-balanced overall taste |
| 600 | ppm | Sweet, enhanced | Sweeter than 500 ppm, enhanced |
| | | apricot flavor | mouth feeling, less sour, milder, |
| | | | well-balanced overall taste, slight |
| | | | caramel notes |
| 700 | ppm | Sweet, enhanced | Very sweet, herbal lingering |
| | | apricot flavor | aftertaste |
| 1000 | ppm | Sweet, enhanced | Very sweet, strong herbal lingering |
| | | apricot flavor | aftertaste |

TABLE 89-17
Sensory evaluations of apricot jam with GTRU20-MRP-CA.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweeter than 10 ppm, |
| | | apricot flavor | enhanced mouth feeling, less sour, |
| | | | milder, more balanced overall taste |
| 100 | ppm | Sweet, enhanced | Slightly sweeter than 50 ppm, |
| | | apricot flavor | enhanced mouth feeling, less sour, |
| | | | milder, more balanced overall taste |
| 200 | ppm | Sweet, enhanced | Sweeter than 100 ppm, enhanced |
| | | apricot flavor | mouth feeling, less sour, milder, |
| | | | well- balanced overall taste |
| 300 | ppm | Sweet, enhanced | Sweeter than 200 ppm, enhanced |
| | | apricot flavor | mouth feeling, less sour, milder, |
| | | | well-balanced overall taste |
| 400 | ppm | Sweet, enhanced | Very sweet, slight caramel |
| | | apricot flavor, slight | lingering aftertaste |
| | | caramel notes | |
| 500 | ppm | Sweet, apricot | Very sweet, caramel lingering |
| | | flavor, caramel | aftertaste |
| | | notes | |
| 1000 | ppm | Sweet, apricot | Very sweet, strong caramel |
| | | flavor, strong | lingering aftertaste |
| | | caramel notes | |

TABLE 89-18
Sensory evaluations of apricot jam with GTRU20-MRP-HO.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweeter than 10 ppm, |
| | | apricot flavor | enhanced mouth feeling, less sour, |
| | | | milder, more balanced overall taste |
| 100 | ppm | Sweet, enhanced | Slightly sweeter than 50 ppm, |
| | | apricot flavor | enhanced mouth feeling, less sour, |
| | | | milder, well-balanced overall taste |
| 200 | ppm | Sweet, enhanced | Sweeter than 100 ppm, enhanced |
| | | apricot flavor | mouth feeling, less sour, milder, |
| | | | slight flowery aftertaste |
| 300 | ppm | Sweet, enhanced | Very sweet, slight flowery |
| | | apricot flavor, | lingering aftertaste |
| | | slight flowery notes | |
| 400 | ppm | Sweet, enhanced | Very sweet, flowery lingering |
| | | apricot flavor, | aftertaste |
| | | flowery notes | |
| 500 | ppm | Sweet, apricot | Very sweet, strong flowery |
| | | flavor, strong | lingering aftertaste |
| | | flowery notes | |
| 1000 | ppm | Sweet, apricot | Very sweet, very strong flowery |
| | | flavor, very strong | lingering aftertaste |
| | | caramel notes | |

TABLE 89-19
Sensory evaluations of apricot jam with GRU90-MRP-CA.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweeter than 10 ppm, |
| | | apricot flavor | enhanced mouth feeling, less sour, |
| | | | milder, more balanced overall taste |
| 100 | ppm | Sweet, enhanced | Slightly sweeter than 50 ppm, |
| | | apricot flavor | enhanced mouth feeling, less sour, |
| | | | milder, more balanced overall taste |
| 200 | ppm | Sweet, enhanced | Sweeter than 100 ppm, enhanced |
| | | apricot flavor | mouth feeling, less sour, milder, |
| | | | well- balanced overall taste |
| 300 | ppm | Sweet, enhanced | Sweeter than 200 ppm, enhanced |
| | | apricot flavor | mouth feeling, less sour, milder, |
| | | | well-balanced overall taste |
| 400 | ppm | Sweet, enhanced | Very sweet, slight caramel |
| | | apricot flavor, | lingering aftertaste |
| | | slight caramel notes | |
| 500 | ppm | Sweet, apricot | Very sweet, caramel lingering |
| | | flavor, caramel | aftertaste |
| | | notes | |
| 1000 | ppm | Sweet, apricot | Very sweet, strong caramel |
| | | flavor, strong | lingering aftertaste |
| | | caramel notes | |

TABLE 89-20
Sensory evaluations of apricot jam with GRU90-MRP-TA.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweeter than 10 ppm, |
| | | apricot flavor | enhanced mouth feeling, less sour, |
| | | | milder, more balanced overall taste |
| 100 | ppm | Sweet, enhanced | Slightly sweeter than 50 ppm, |
| | | apricot flavor | enhanced mouth feeling, less sour, |
| | | | milder, more balanced overall taste |
| 200 | ppm | Sweet, enhanced | Sweeter than 100 ppm, enhanced |
| | | apricot flavor | mouth feeling, less sour, milder, |
| | | | well- balanced overall taste |
| 300 | ppm | Sweet, enhanced | Sweeter than 200 ppm, enhanced |
| | | apricot flavor | mouth feeling, less sour, milder, |
| | | | well-balanced overall taste |
| 400 | ppm | Sweet, enhanced | Very sweet, slight herbal lingering |
| | | apricot flavor, | aftertaste |
| | | slight herbal notes | |
| 500 | ppm | Sweet, apricot | Very sweet, herbal lingering |
| | | flavor, herbal notes | aftertaste |
| 1000 | ppm | Sweet, apricot | Very sweet, strong herbal lingering |
| | | flavor, strong | aftertaste |
| | | herbal notes | |

TABLE 89-21
Sensory evaluations of apricot jam with GRU90-MRP-HO.

| Concentration | | Aroma | Taste |
|---|---|---|---|
| None (Control) | | Sweet, typical | Slightly sweet, lack of mouth |
| | | apricot flavor | feeling, sour |
| 5 | ppm | Sweet, typical | Slightly sweet, lack of mouth |
| | | apricot flavor | feeling, sour |
| 10 | ppm | Sweet, enhanced | Slightly sweet, enhanced mouth |
| | | apricot flavor | feeling, less sour, milder |
| 50 | ppm | Sweet, enhanced | Slightly sweeter than 10 ppm, |
| | | apricot flavor | enhanced apricot flavor, less sour, |
| | | | milder taste |
| 100 | ppm | Sweet, enhanced | Slightly sweeter than 50 ppm, |
| | | apricot flavor | enhanced apricot flavor, less sour, |
| | | | milder taste |
| 200 | ppm | Sweet, enhanced | Sweeter than 100 ppm, enhanced |
| | | apricot flavor | apricot flavor, less sour, slight |
| | | | flowery aftertaste |
| 300 | ppm | Sweet, enhanced | Very sweet, slight flowery |
| | | apricot flavor, | lingering aftertaste |
| | | slight flowery notes | |
| 400 | ppm | Sweet, enhanced | Very sweet, flowery lingering |
| | | apricot flavor, | aftertaste |
| | | flowery notes | |
| 500 | ppm | Sweet, apricot | Very sweet, strong flowery |
| | | flavor, strong | lingering aftertaste |
| | | flowery notes | |
| 1000 | ppm | Sweet, apricot | Very sweet, very strong flowery |
| | | flavor, very strong | lingering aftertaste |
| | | flowery notes | |

TABLE 89-22

| | | Concentration in mg/l at in use concentration of 5 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 0.096 | 0.088 | 0.049 | 0.041 | 0.096 | 0.088 | 0.018 |
| Ru-5Glc A | 1452 | 0.012 | 0.016 | 0.014 | 0.017 | 0.050 | 0.058 | 0.037 |
| Ru-5Glc B | 1452 | 0.022 | 0.026 | 0.022 | 0.026 | 0.086 | 0.104 | 0.072 |
| Ru-4Glc A | 1289 | 0.044 | 0.040 | 0.048 | 0.041 | 0.188 | 0.162 | 0.112 |
| Ru-4Glc B | 1289 | 0.070 | 0.065 | 0.068 | 0.062 | 0.300 | 0.276 | 0.207 |
| Ru-3Glc A | 1127 | 0.015 | 0.016 | 0.012 | 0.013 | 0.055 | 0.057 | 0.043 |
| Ru-3Glc B | 1127 | 0.021 | 0.018 | 0.021 | 0.019 | 0.081 | 0.072 | 0.057 |
| Ru-2Glc A | 965 | 0.059 | 0.056 | 0.052 | 0.049 | 0.218 | 0.207 | 0.154 |
| Ru-2Glc B | 965 | 0.108 | 0.092 | 0.093 | 0.084 | 0.428 | 0.385 | 0.304 |
| Ru-1Glc | 803 | 0.197 | 0.198 | 0.186 | 0.173 | 0.752 | 0.700 | 0.565 |
| A/B | | | | | | | | |
| Ru | 641 | 0.107 | 0.101 | 0.117 | 0.037 | 0.535 | 0.500 | 0.396 |
| Stev-Mono | 479 | 0.040 | 0.026 | 0.002 | 0.002 | 0.024 | 0.015 | 0.032 |
| | Sum: | 0.789 | 0.740 | 0.682 | 0.561 | 2.810 | 2.622 | 1.996 |

TABLE 89-23

| | | Concentration in mg/l at in use concentration of 10 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 0.192 | 0.175 | 0.098 | 0.081 | 0.192 | 0.175 | 0.036 |
| Ru-5Glc A | 1452 | 0.024 | 0.031 | 0.028 | 0.033 | 0.099 | 0.116 | 0.074 |
| Ru-5Glc B | 1452 | 0.044 | 0.051 | 0.043 | 0.052 | 0.171 | 0.208 | 0.144 |
| Ru-4Glc A | 1289 | 0.087 | 0.079 | 0.096 | 0.082 | 0.376 | 0.323 | 0.224 |
| Ru-4Glc B | 1289 | 0.140 | 0.130 | 0.135 | 0.124 | 0.599 | 0.551 | 0.414 |
| Ru-3Glc A | 1127 | 0.029 | 0.032 | 0.024 | 0.025 | 0.110 | 0.114 | 0.086 |
| Ru-3Glc B | 1127 | 0.042 | 0.036 | 0.042 | 0.038 | 0.161 | 0.144 | 0.113 |
| Ru-2Glc A | 965 | 0.117 | 0.112 | 0.103 | 0.097 | 0.435 | 0.413 | 0.308 |
| Ru-2Glc B | 965 | 0.216 | 0.184 | 0.185 | 0.167 | 0.856 | 0.770 | 0.608 |
| Ru-1Glc | 803 | 0.394 | 0.396 | 0.371 | 0.346 | 1.503 | 1.400 | 1.130 |
| A/B | | | | | | | | |
| Ru | 641 | 0.214 | 0.202 | 0.234 | 0.073 | 1.070 | 1.000 | 0.791 |
| Stev-Mono | 479 | 0.080 | 0.053 | 0.004 | 0.004 | 0.048 | 0.029 | 0.063 |
| | Sum: | 1.579 | 1.481 | 1.363 | 1.123 | 5.620 | 5.243 | 3.991 |

TABLE 89-24

| | | Concentration in mg/l at in use concentration of 50 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 0.960 | 0.875 | 0.491 | 0.407 | 0.960 | 0.875 | 0.180 |
| Ru-5Glc A | 1452 | 0.120 | 0.155 | 0.140 | 0.165 | 0.495 | 0.580 | 0.370 |
| Ru-5Glc B | 1452 | 0.220 | 0.255 | 0.215 | 0.260 | 0.855 | 1.040 | 0.720 |
| Ru-4Glc A | 1289 | 0.435 | 0.395 | 0.480 | 0.410 | .880 | 1.615 | 1.120 |
| Ru-4Glc B | 1289 | 0.700 | 0.650 | 0.675 | 0.620 | .995 | 2.755 | 2.070 |
| Ru-3Glc A | 1127 | 0.145 | 0.160 | 0.120 | 0.125 | .550 | 0.570 | 0.430 |
| Ru-3Glc B | 1127 | 0.210 | 0.180 | 0.210 | 0.190 | .805 | 0.720 | 0.565 |
| Ru-2Glc A | 965 | 0.585 | 0.560 | 0.515 | 0.485 | .175 | 2.065 | 1.540 |
| Ru-2Glc B | 965 | 1.080 | 0.920 | 0.925 | 0.835 | .280 | 3.850 | 3.040 |
| Ru-1Glc | 803 | 1.970 | 1.980 | 1.855 | 1.730 | .515 | 7.000 | 5.650 |
| A/B | | | | | | | | |
| Ru | 641 | 1.070 | 1.010 | 1.170 | 0.365 | .350 | 5.000 | 3.955 |
| Stev-Mono | 479 | 0.399 | 0.263 | 0.020 | 0.021 | .240 | 0.145 | 0.315 |
| | Sum: | 7.894 | 7.403 | 6.816 | 5.613 | 8.100 | 26.215 | 19.955 |

TABLE 89-25

| | | Concentration in mg/l at in use concentration of 100 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 1.920 | 1.750 | 0.982 | 0.814 | 1.920 | 1.750 | 0.360 |
| Ru-5Glc A | 1452 | 0.240 | 0.310 | 0.280 | 0.330 | 0.990 | 1.160 | 0.740 |
| Ru-5Glc B | 1452 | 0.440 | 0.510 | 0.430 | 0.520 | 1.710 | 2.080 | 1.440 |
| Ru-4Glc A | 1289 | 0.870 | 0.790 | 0.960 | 0.820 | 3.760 | 3.230 | 2.240 |
| Ru-4Glc B | 1289 | 1.400 | 1.300 | 1.350 | 1.240 | 5.990 | 5.510 | 4.140 |
| Ru-3Glc A | 1127 | 0.290 | 0.320 | 0.240 | 0.250 | 1.100 | 1.140 | 0.860 |
| Ru-3Glc B | 1127 | 0.420 | 0.360 | 0.420 | 0.380 | 1.610 | 1.440 | 1.130 |
| Ru-2Glc A | 965 | 1.170 | 1.120 | 1.030 | 0.970 | 4.350 | 4.130 | 3.080 |
| Ru-2Glc B | 965 | 2.160 | 1.840 | 1.850 | 1.670 | 8.560 | 7.700 | 6.080 |
| Ru-1Glc | 803 | 3.940 | 3.960 | 3.710 | 3.460 | 15.030 | 14.000 | 11.300 |
| A/B | | | | | | | | |
| Ru | 641 | 2.140 | 2.020 | 2.340 | 0.730 | 10.700 | 10.000 | 7.910 |
| Stev-Mono | 479 | 0.797 | 0.525 | 0.040 | 0.042 | 0.480 | 0.290 | 0.630 |
| | Sum: | 15.787 | 14.805 | 13.632 | 11.226 | 56.200 | 52.430 | 39.910 |

TABLE 89-26

| | | Concentration in mg/l at in use concentration of 250 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 4.800 | 4.375 | 2.455 | 2.035 | 4.800 | 4.375 | 0.900 |
| Ru-5Glc A | 1452 | 0.600 | 0.775 | 0.700 | 0.825 | 2.475 | 2.900 | 1.850 |
| Ru-5Glc B | 1452 | 1.100 | 1.275 | 1.075 | 1.300 | 4.275 | 5.200 | 3.600 |
| Ru-4Glc A | 1289 | 2.175 | 1.975 | 2.400 | 2.050 | 9.400 | 8.075 | 5.600 |
| Ru-4Glc B | 1289 | 3.500 | 3.250 | 3.375 | 3.100 | 14.975 | 13.775 | 10.350 |
| Ru-3Glc A | 1127 | 0.725 | 0.800 | 0.600 | 0.625 | 2.750 | 2.850 | 2.150 |
| Ru-3Glc B | 1127 | 1.050 | 0.900 | 1.050 | 0.950 | 4.025 | 3.600 | 2.825 |
| Ru-2Glc A | 965 | 2.925 | 2.800 | 2.575 | 2.425 | 10.875 | 10.325 | 7.700 |
| Ru-2Glc B | 965 | 5.400 | 4.600 | 4.625 | 4.175 | 21.400 | 19.250 | 15.200 |
| Ru-1Glc | 803 | 9.850 | 9.900 | 9.275 | 8.650 | 37.575 | 35.000 | 28.250 |
| A/B | | | | | | | | |
| Ru | 641 | 5.350 | 5.050 | 5.850 | 1.825 | 26.750 | 25.000 | 19.775 |
| Stev-Mono | 479 | 1.993 | 1.313 | 0.101 | 0.105 | 1.200 | 0.725 | 1.575 |
| | Sum: | 39.468 | 37.013 | 34.081 | 28.065 | 140.500 | 131.075 | 99.775 |

TABLE 89-27

| | | Concentration in mg/l at in use concentration of 500 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 9.600 | 8.750 | 4.910 | 4.070 | 9.600 | 8.750 | 1.800 |
| Ru-5Glc A | 1452 | 1.200 | 1.550 | 1.400 | 1.650 | 4.950 | 5.800 | 3.700 |
| Ru-5Glc B | 1452 | 2.200 | 2.550 | 2.150 | 2.600 | 8.550 | 10.400 | 7.200 |
| Ru-4Glc A | 1289 | 4.350 | 3.950 | 4.800 | 4.100 | 18.800 | 16.150 | 11.200 |
| Ru-4Glc B | 1289 | 7.000 | 6.500 | 6.750 | 6.200 | 29.950 | 27.550 | 20.700 |
| Ru-3Glc A | 1127 | 1.450 | 1.600 | 1.200 | 1.250 | 5.500 | 5.700 | 4.300 |
| Ru-3Glc B | 1127 | 2.100 | 1.800 | 2.100 | 1.900 | 8.050 | 7.200 | 5.650 |
| Ru-2Glc A | 965 | 5.850 | 5.600 | 5.150 | 4.850 | 21.750 | 20.650 | 15.400 |
| Ru-2Glc B | 965 | 10.800 | 9.200 | 9.250 | 8.350 | 42.800 | 38.500 | 30.400 |
| Ru-1Glc | 803 | 19.700 | 19.800 | 18.550 | 17.300 | 75.150 | 70.000 | 56.500 |
| A/B | | | | | | | | |
| Ru | 641 | 10.700 | 10.100 | 11.700 | 3.650 | 53.500 | 50.000 | 39.550 |
| Stev-Mono | 479 | 3.985 | 2.625 | 0.201 | 0.211 | 2.400 | 1.450 | 3.150 |
| | Sum: | 78.935 | 74.025 | 68.161 | 56.131 | 281.000 | 262.150 | 199.550 |

TABLE 89-28

| | | Concentration in mg/l at in use concentration of 1,000 ppm | | | | | | |
|---|---|---|---|---|---|---|---|---|
| Tentative | | GRU20- | GRU20- | GTRU20- | GTRU20- | GRU90- | GRU90- | GRU90- |
| Structure | m/z | MRP-TA | MRP-CA | MRP-HO | MRP-CA | MRP-TA | MRP-HO | MRP-CA |
| Related (as Ru) | | 19.200 | 17.500 | 9.820 | 8.140 | 19.200 | 17.500 | 3.600 |
| Ru-5Glc A | 1452 | 2.400 | 3.100 | 2.800 | 3.300 | 9.900 | 11.600 | 7.400 |
| Ru-5Glc B | 1452 | 4.400 | 5.100 | 4.300 | 5.200 | 17.100 | 20.800 | 14.400 |
| Ru-4Glc A | 1289 | 8.700 | 7.900 | 9.600 | 8.200 | 37.600 | 32.300 | 22.400 |
| Ru-4Glc B | 1289 | 14.000 | 13.000 | 13.500 | 12.400 | 59.900 | 55.100 | 41.400 |
| Ru-3Glc A | 1127 | 2.900 | 3.200 | 2.400 | 2.500 | 11.000 | 11.400 | 8.600 |
| Ru-3Glc B | 1127 | 4.200 | 3.600 | 4.200 | 3.800 | 16.100 | 14.400 | 11.300 |
| Ru-2Glc A | 965 | 11.700 | 11.200 | 10.300 | 9.700 | 43.500 | 41.300 | 30.800 |
| Ru-2Glc B | 965 | 21.600 | 18.400 | 18.500 | 16.700 | 85.600 | 77.000 | 60.800 |
| Ru-1Glc | 803 | 39.400 | 39.600 | 37.100 | 34.600 | 150.300 | 140.000 | 113.000 |
| A/B | | | | | | | | |
| Ru | 641 | 21.400 | 20.200 | 23.400 | 7.300 | 107.000 | 100.000 | 79.100 |
| Stev-Mono | 479 | 7.970 | 5.250 | 0.402 | 0.421 | 4.800 | 2.900 | 6.300 |
| | Sum: | 157.870 | 148.050 | 136.322 | 112.261 | 562.000 | 524.300 | 399.100 |

Conclusion: Consumables comprising GSTE-MRPs or GSTC-MRPs can significantly improve their overall palatability as reflected in increased sweetness, enhanced flavor, and reduced sourness and/or unpleasant aftertaste. A consumable product may include GSTE-MRPs or GSTC-MRPs in a range from 5 ppm to 1,000 ppm, where total amount of rubusoside and glycosylated rubusoside can be in a range of 0.1 ppm to 600 ppm. Depending on the application, the added amount of GSTE-MRPs or GSTC-MRPs can be increased further, for instance, 1,500 ppm, 5,000 ppm, 10,000 ppm etc., and the corresponding amount of total rubusosides and glycosylated rubusosides can be increased proportionally.

### Example 90. Application of GSG-MRP—in Full Sugar Version: Flavor Pairing

Materials:

GSG-MRP—Caramel, Part Number 14041-01, Lot #20190801

GSG-MRP—Honey, Part Number 14041-02, Lot #20190704

GSG-MRP—Tangerine, Part Number 14041-08, Lot #20191205

Happy Day Sprizz Apple, 14.02.2021 07:22/4A6, Rauch Fruchtsäfte GmbH & Co OG:

Lemon Iced Tea, 03.03.2021 14:3/2A2, Rauch Fruchtsäfte GmbH & Co OG:

Frucade Orange lemonade, 200221F0 0.56 21.10.20 (10:06), DrinkStar GmbH:

Coca Cola Original, 11.11.2020 L12E00:19 WP, Coca Cola HBC Austria GmbH:

Test design: The following commercial beverages (underlined) were selected to perform flavor pairing test of GSG-MRP-Caramel, GSG-MRP-Honey and GSG-MRP-Tangerine:

Commercial sparkling apple nectar from concentrate (0.5 liter bottle, Brand: Happy Day Apple Sprizz, Rauch; ingredients: 55% apple juice from concentrate, natural mineral water, lemon juice concentrate, carbon dioxide; sugar content: 5.6 g/100 ml).

Commercial lemon iced tea (0.5 liter bottle, Brand: Rauch; ingredients: infusion of black tea and rose hip (water, black tea, rose hip), sugar, 1.5% lemon juice from concentrate, acid: citric acid, acidity regulator: sodium citrates, aroma. Tea extract: min 1.5 g/L; Sugar content: 6.7 g/100 ml).

Commercial orange fruit lemonade (0.5 liter bottle, Brand: Frucade, DrinkStar GmbH; ingredients: water, sugar, orange- and lemon juice concentrate, carbon dioxide, natural orange extract, acid: citric acid, natural aroma, stabilizer: pectin and guaran, antioxidant: ascorbic acid; fruit content: 10% (8% orange), sugar content: 9.9 g/100 ml).

Commercial Coca Cola soft drink (original) (0.5 liter bottle, Brand: Coca Cola HBC Austria GmbH; ingredients: water, sugar, carbon dioxide, caramel color E150d, acid: E338, natural aroma inclusive caffeine; sugar content: 10.6 g/100 ml).

5-50 ppm of GSG-MRP-Caramel, GSG-MRP-Honey or GSG-MRP-Tangerine were added to each commercial beverage. Then the samples were subjected to sensory evaluations, the results of which are shown in Tables 90-1 to 90-12. A beverage sample without the addition of GSG-MRP was used as a control. All recognizable flavor differences between control and test samples were noted in the test protocol.

TABLE 90-1
Happy Day Apple Sprizz with GSG-MRP- Caramel

| | |
|---|---|
| Concentration | Sensory evaluation |

| | | |
|---|---|---|
| 0 | ppm | Fruity, apple flavor, very sour, acidic, astringent |
| 5 | ppm | Reduced sourness, reduced astringency, smooth |
| 10 | ppm | Reduced sourness, reduced astringency, smooth, |
| | | enhanced fruity/apple flavor |
| 25 | ppm | Reduced sourness, reduced astringency, smooth, |
| | | enhanced fruity/apple flavor |

TABLE 90-2
Happy Day Apple Sprizz with GSG-MRP- Honey

| Concentration | | Sensory evaluation |
|---|---|---|
| 0 | ppm | Fruity, apple flavor, very sour, acidic, astringent |
| 5 | ppm | Reduced sourness, enhanced fruity/apple flavor, more |
| | | fresh notes |
| 10 | ppm | Reduced sourness, enhanced fruity/apple flavor, more |
| | | fresh notes |
| 25 | ppm | Reduced sourness, enhanced fruity/apple flavor, more |
| | | fresh notes, flowery aroma |

TABLE 90-3
Happy Day Apple Sprizz with GSG-MRP- Tangerine

| Concentration | | Sensory evaluation |
|---|---|---|
| 0 | ppm | Fruity, apple flavor, very sour, acidic, astringent |
| 5 | ppm | Slightly reduced sourness, fruity flavor |
| 10 | ppm | Reduced sourness, smoother taste |
| 25 | ppm | Reduced sourness, smooth, enhanced fruity taste and |
| | | apple flavor |
| 50 | ppm | Reduced sourness, smooth, enhanced fruity taste and |
| | | apple flavor |

TABLE 90-4
Iced tea Lemon with GSG-MRP- Caramel

| Concentration | | Sensory evaluation |
|---|---|---|
| 0 | ppm | Pleasant sweet-sour taste, lemon flavor, more fresh notes |
| 5 | ppm | Enhanced lemon flavor, more fresh notes |
| 10 | ppm | Enhanced lemon flavor, more fresh notes |
| 25 | ppm | Slightly enhanced sweetness, enhanced lemon flavor, |
| | | pleasant |

TABLE 90-5
Lemon Iced tea with GSG-MRP- Honey

| Concentration | | Sensory evaluation |
|---|---|---|
| 0 | ppm | Pleasant sweet-sour taste, lemon flavor, more fresh notes |
| 5 | ppm | Enhanced lemon flavor, well-balanced sweet-sour taste, |
| | | more fresh notes |
| 10 | ppm | Enhanced lemon flavor, well-balanced sweet-sour taste, |
| | | more fresh notes |
| 25 | ppm | Slightly flowery aftertaste, more fresh notes |

TABLE 90-6
Lemon Iced tea with GSG-MRP-Tangerine

| Concentration | | Sensory evaluation |
|---|---|---|
| 0 | ppm | Pleasant sweet-sour taste, lemon flavor, more fresh notes |
| 5 | ppm | Less sour, enhanced lemon flavor |
| 10 | ppm | Less sour, enhanced lemon flavor, more fresh notes |
| 25 | ppm | Less sour, enhanced lemon flavor, more fresh notes |
| 50 | ppm | Slightly enhanced sweetness, richer taste, enhanced |
| | | lemon flavor, refreshing |

TABLE 90-7
Frucade with GSG-MRP-Caramel

| | |
|---|---|
| Concentration | Sensory evaluation |

| | | |
|---|---|---|
| 0 | ppm | Fruity, orange taste, very sweet, acidic, pleasant |
| 5 | ppm | Very similar taste, less acidic, smoother mouth- |
| | | feeling, pleasant |
| 10 | ppm | Very similar taste, less acidic, enhanced orange |
| | | flavor, smoother mouth-feeling, pleasant |
| 25 | ppm | Very similar taste, less acidic, enhanced orange |
| | | flavor, smoother mouth-feeling, pleasant |

TABLE 90-8
Frucade with GSG-MRP-Honey

| | |
|---|---|
| Concentration | Sensory evaluation |

| | | |
|---|---|---|
| 0 | ppm | Fruity, orange taste, very sweet, acidic, pleasant |
| 5 | ppm | Very similar taste, less acidic, smoother mouth- |
| | | feeling, pleasant |
| 10 | ppm | Very similar taste, less acidic, enhanced orange |
| | | flavor, smoother mouth-feeling, enhanced orange |
| | | flavor, more fresh notes, pleasant |
| 25 | ppm | Very similar taste, less acidic, enhanced orange |
| | | flavor, smoother mouth-feeling, enhanced orange |
| | | flavor, more fresh notes, pleasant |
| 50 | ppm | Very similar taste, less acidic, enhanced orange |
| | | flavor, smoother mouth-feeling, enhanced orange |
| | | flavor, more fresh notes, pleasant |

TABLE 90-9
Frucade with GSG-MRP-Tangerine

| Concentration | Sensory evaluation |
|---|---|
| 0 ppm | Fruity, orange taste, very sweet, acidic, |
| | pleasant |
| 5 ppm | Very similar taste, less acidic, smoother mouth-feeling, |
| | pleasant |
| 10 ppm | Very similar taste, less acidic, enhanced orange flavor, |
| | smoother mouth-feeling, pleasant |
| 25 ppm | Very similar taste, less acidic, enhanced orange flavor, |
| | smoother mouth-feeling, enhanced orange flavor, |
| | pleasant |
| 50 ppm | Very similar taste, less acidic, enhanced orange flavor, |
| | smoother mouth-feeling, enhanced orange flavor, |
| | pleasant |

TABLE 90-10
Coca Cola Original. GSG-MRP-Caramel

| Concentration | Sensory evaluation |
|---|---|
| 0 ppm | Appropriate cola taste, very sweet, acidic, pleasant |
| 5 ppm | Very similar taste, but less acidic, more caramel |
| | flavor compared to control, pleasant |
| 10 ppm | Very similar taste, but less acidic, more caramel |
| | flavor compared to 5 ppm, pleasant |

TABLE 90-11
Coca Cola Original. GSG-MRP-Honey

| Concentration | Sensory evaluation |
|---|---|
| 0 ppm | Appropriate cola taste, very sweet, acidic, pleasant |
| 5 ppm | Very similar taste, but less acidic, pleasant, more |
| | fresh notes |
| 10 ppm | Very similar taste, but less acidic, pleasant, more |
| | fresh notes |
| 25 ppm | Very similar taste, but less acidic, pleasant, more |
| | fresh notes, slight flowery aftertaste |

TABLE 90-12
Coca Cola Original. GSG-MRP-Tangerine

| Concentration | Sensory evaluation |
|---|---|
| 0 ppm | Appropriate cola taste, very sweet, acidic, pleasant |
| 5 ppm | Very similar taste, but less acidic, pleasant, more |
| | fresh notes |
| 10 ppm | Very similar taste, but less acidic, pleasant, more |
| | fresh notes |
| 25 ppm | Very similar taste, but less acidic, pleasant, more |
| | fresh notes |
| 50 ppm | Very similar taste, but less acidic, pleasant, more |
| | fresh notes |

Conclusion: Addition of GSG-MRPs improves the freshness and palatability of consumable beverage products. These examples can be extended to any types of GSG-MRPs, G-ST-MRPs or GSC-MRPs for any types of consumable beverage products.

### Example 91. Preparation of MRPs from GTRU20, GRU90 and Various Amino Acids and/or Reducing Sugars, and Analysis of Orthonasal Flavors Therefrom

Materials:

GTRU20, Lot #EPC-303-73-01, EPC Lab

GRU90, Lot #EPC-303-89-03, EPC Lab

DL-Asparagine monohydrate, 98%, Lot 69H1152, Sigma Aldrich

Glycine anhydride, Lot 090K5432, Sigma Aldrich

L-Isoleucine, 99%, 0072206, Merck

L-(+)-Lysine, Lot 0001442572, Sigma Aldrich

DL-Proline, 99%, Lot 17H0844, Sigma Aldrich

D-(+)-Galactose, ≥99%, Lot 039K00592V, Sigma Aldrich

D-(+)-Glucose monohydrate, ≥99.5%, Lot 1362591 51108254, Fluka

D-(+)-Xylose, ≥99.5%, Lot 024K00312, Sigma Aldrich

Test design: A series of experiments was performed using sealed 10 ml Pyrex-vials. The reaction partners (amino acid, carbohydrate source) were dissolved/suspended in a reaction solvent. The ratio of reducing sugar to amino acid was 2:1 and the ratio of sweet tea extract to the sugar/amino acid mixture was 10:3. The prepared samples were transferred into a glass beaker filled with sand pre-heated for at least 30 minutes at the reaction temperature in a drying oven. After the planned reaction time, the vials were transferred into ice water. After cooling to room temperature, sensory analysis for orthonasal flavors was performed.

Reaction Conditions:

Reaction solvent: water

Heating temperature: 100° C., drying oven

Heating time: 2 h

Abbreviations:

| | | | |
|---|---|---|---|
| Asparagine | Asp | Galactose | Gal |
| Glycine | Gly | Glucose | Glc |
| Isoleucine | Ile | Xylose | Xyl |
| Lysine | Lys | | |
| Proline | Pro | | |

TABLE 91.1
Sensory evaluation test results.

| Sample | Color | Orthonasal Flavor |
|---|---|---|
| 50 mg GTRU20 + 225 μl H₂O | brown | Bitter, herbal |
| 50 mg GRU90 + 225 μl H₂O | light | Odorless |
| | yellow | |
| 10 mg Glc + 225 μl water | colorless | Odorless |
| 10 mg Xyl + 225 μl water | colorless | Odorless |
| 10 mg Gal + 225 μl water | colorless | Odorless |
| 5 mg Ile + 225 μl water | colorless | Odorless |
| 5 mg Pro + 225 μl water | colorless | Odorless |
| 5 mg Lys + 225 μl water | light | Characteristic amino acid |
| | yellow | |
| 5 mg Gly + 225 μl water | colorless | Odorless |
| 5 mg Asp + 225 μl water | colorless | Odorless |
| 5 mg Ile + 10 mg Glc + | light | Sweetish, dried fruits |
| 225 μl water | yellow | |
| 5 mg Pro + 10 mg Glc + | yellow | Sweet, popcorn |
| 225 μl water | | |
| 5 mg Lys + 10 mg Glc + | dark | Sweet, caramel-like |
| 225 μl water | brown | |
| 5 mg Gly + 10 mg Glc + | colorless | Medical |
| 225 μl water | | |
| 5 mg Asp + 10 mg Glc + | colorless | Sweetish, practically |
| 225 μl water | | aroma-less |
| 5 mg Ile + 10 mg Xyl + | light | Sweetish, dried fruits |
| 225 μl water | brown | |
| 5 mg Pro + 10 mg Xyl + | yellow | Sweet, popcorn |
| 225 μl water | | |
| 5 mg Lys + 10 mg Xyl + | dark | Burnt sugar |
| 225 μl water | brown | |
| 5 mg Gly + 10 mg Xyl + | colorless | Chemical, plastic |
| 225 μl water | | |
| 5 mg Asp + 10 mg Xyl + | brown | Chemical, plastic |
| 225 μl water | | |
| 5 mg Ile + 10 mg Gal + | yellow | Sweetish, dried fruits |
| 225 μl water | | |
| 5 mg Pro + 10 mg Gal + | yellow | Sweet, popcorn |
| 225 μl water | | |
| 5 mg Lys + 10 mg Gal + | dark | Sweet, caramel-like, |
| 225 μl water | brown | intensive |
| 5 mg Gly + 10 mg Gal + | colorless | Chemical, plastic |
| 225 μl water | | |
| 5 mg Asp + 10 mg Gal + | light | Odorless |
| 225 μl water | yellow | |
| 50 mg GTRU20 + 5 mg Ile + | brown | Burnt, prune (dried |
| 10 mg Glc + 225 μl water | | plum), fruity |
| 50 mg GTRU20 + 5 mg Pro + | brown | Sweet, popcorn |
| 10 mg Glc + 225 μl water | | |
| 50 mg GTRU20 + 5 mg Lys + | brown | Sweet, popcorn, |
| 10 mg Glc + 225 μl water | | caramel-like |
| 50 mg GTRU20 + 5 mg Gly + | yellow | Herbal tea, sour |
| 10 mg Glc + 225 μl water | | |
| 50 mg GTRU20 + 5 mg Asp + | brown | Chemical, chlorine-like |
| 10 mg Glc + 225 μl water | | |
| 50 mg GTRU20 + 5 mg Ile + | brown | Burnt, prune (dried plum), |
| 10 mg Xyl + 225 μl water | | fruity, intensive |
| 50 mg GTRU20 + 5 mg Pro + | brown | Sweet, popcorn, herbal |
| 10 mg Xyl + 225 μl water | | notes |
| 50 mg GTRU20 + 5 mg Lys + | brown | Herbal, fruity, dried |
| 10 mg Xyl + 225 μl water | | fruits |
| 50 mg GTRU20 + 5 mg Gly + | brown | Sour, fruity, dried |
| 10 mg Xyl + 225 μl water | | fruits |
| 50 mg GTRU20 + 5 mg Asp + | brown | Coffee-like |
| 10 mg Xyl + 225 μl water | | |
| 50 mg GTRU20 + 5 mg Ile + | brown | Burnt |
| 10 mg Gal + 225 μl water | | |
| 50 mg GTRU20 + 5 mg Pro + | brown | Sweet, popcorn, intensive |
| 10 mg Gal + 225 μl water | | |
| 50 mg GTRU20 + 5 mg Lys + | brown | Sour, popcorn, herbal |
| 10 mg Gal + 225 μl water | | |
| 50 mg GTRU20 + 5 mg Gly + | yellow | Herbal tea, sweet |
| 10 mg Gal + 225 μl water | | |
| 50 mg GTRU20 + 5 mg Asp + | brown | Chemical, chlorine-like |
| 10 mg Gal + 225 μl water | | |
| 50 mg GRU90 + 5 mg Ile + 10 | yellow | Bitter, herbal |
| mg Glc + 225 μl water | | |
| 50 mg GRU90 + 5 mg Pro + 10 | light | Sweet, popcorn, very |
| mg Glc + 225 μl water | yellow | intensive |
| 50 mg GRU90 + 5 mg Lys + 10 | dark | Sweet, caramel-like |
| mg Glc + 225 μl water | brown | |
| 50 mg GRU90 + 5 mg Gly + 10 | light | Slightly honey, slight |
| mg Glc + 225 μl water | yellow | flowery |
| 50 mg GRU90 + 5 mg Asp + 10 | light | Sweet, cotton candy |
| mg Glc + 225 μl water | yellow | |
| 50 mg GRU90 + 5 mg Ile + 10 | brown | Sweet-sour, honey |
| mg Xyl + 225 μl water | | |
| 50 mg GRU90 + 5 mg Pro + 10 | yellow | Sweet, popcorn, intensive |
| mg Xyl + 225 μl water | | |
| 50 mg GRU90 + 5 mg Lys + 10 | dark | Sweet, caramel-like, |
| mg Xyl + 225 μl water | brown | cotton candy |
| 50 mg GRU90 + 5 mg Gly + 10 | colorless | Slight flowery |
| mg Xyl + 225 μl water | | |
| 50 mg GRU90 + 5 mg Asp + 10 | brown | Sweet, buttery, fruity, like |
| mg Xyl + 225 μl water | | frozen yogurt |
| 50 mg GRU90 + 5 mg Ile + 10 | yellow | Sweet, cotton candy, |
| mg Gal + 225 μl water | | biscuit-like |
| 50 mg GRU90 + 5 mg Pro + 10 | yellow | Sweet, popcorn, intensive |
| mg Gal + 225 μl water | | |
| 50 mg GRU90 + 5 mg Lys + 10 | dark | Sweet, cardboard, herbal |
| mg Gal + 225 μl water | brown | |
| 50 mg GRU90 + 5 mg Gly + 10 | slight | Slight bitter, herbal tea |
| mg Gal + 225 μl water | yellow | |
| 50 mg GRU90 + 5 mg Asp + 10 | yellow | Chemical, chlorine-like |
| mg Gal + 225 μl water | | |

Conclusion: Different types and ratios of reactants, including water, sugar donor, amine donor, and GRU-MRPs together generate a variety of useful flavors, colorants, and taste products. The types and ratios of reactants described in this example can be extended to other types and ratios of reactants described in the specification.

### Example 92. Preparation of MRPs from GTRU20, Valine and Xylose and Analysis of Orthonasal Flavors Therefrom

Materials:

Potassium dihydrogen phosphate, ≥99.5%, Charge/Lot A433272318, Merck

GTRU20, Lot #EPC-303-73-01, EPC Lab

D-Valine, 98%, Lot 20H0295, Sigma Aldrich

D-(+)-Xylose, ≥99.5%, Lot 024K00312, Sigma Aldrich

Test design: A series of experiments was performed in sealed 10 ml Pyrex-Vials. The reaction partner (amino acid, carbohydrate source) were dissolved/suspended in 5 ml of reaction solvent. The prepared samples were transferred into a glass beaker filled with sand pre-heated for at least 30 minutes at the reaction temperature in a drying oven. After the planned reaction time, the vials were transferred into ice water. After cooling to room temperature, sensory analysis was performed.

Conditions:

Reaction solvent: 0.2 M Phosphate buffer, pH 8.0

Heating temperature: 100° C., drying oven

Heating time: 10, 20, 30, 45, 60, 90, 120 min

TABLE 92.1
Sample compositions and sensory evaluations.

| | Heating | | |
|---|---|---|---|
| Sample | time, min | Color | Flavor |
| 5 mg Val + 10 mg | 10 | yellow | sweet, fresh, herbal tea |
| Xyl + 50 mg GTRU20 | | | |
| 5 mg Val + 10 mg | 20 | yellow | sweetish with bitter |
| Xyl + 50 mg GTRU20 | | | notes, herbal tea |
| 5 mg Val + 10 mg | 30 | yellow | sweet, fresh, herbal tea |
| Xyl + 50 mg GTRU20 | | | |
| 5 mg Val + 10 mg | 45 | yellow | sweet, honey, intensive |
| Xyl + 50 mg GTRU20 | | | |
| 5 mg Val + 10 mg | 60 | yellow | sweet, herbal tea |
| Xyl + 50 mg GTRU20 | | | |

### Example 93. Preparation of MRPs from RU20, GRU20, TRU20, GTRU20, RU90 or GRU90 with Xylose, Threonine, Arginine, and/or Valine and Analysis of Orthonasal Flavors Therefrom

Materials:

L-Arginine, ≥98%, Batch #MKBC7640, Sigma Aldrich

L-Threonine, ≥98%, Lot #SLBJ1992V, Sigma Aldrich

D-Valine, 98%, Lot 20H0295, Sigma Aldrich

D-(+)-Xylose, ≥99.5%, Lot 024K00312, Sigma Aldrich

RU20, Lot #STL02-151005, EPC Lab

GRU20, Lot #EPC-303-89-03, EPC Lab

TRU20, Lot #EPC-303-74-01, EPC Lab

GTRU20, Lot #EPC-303-73-01, EPC Lab

RU90, Lot #EPC-238-34-03, EPC Lab

GRU90, Lot #EPC-303-89-03, EPC Lab

Test design: A series of experiments were performed using sealed 10 ml Pyrex vials. The reaction partners (amino acid, carbohydrate source) were dissolved/suspended in a reaction solvent. The ratio of reducing sugar to amino acid was 2:1 and the ratio of sweet tea extract to the sugar/amino acid mixture was 10:3. The prepared samples were transferred into a glass beaker filled with and pre-heated for at least 30 minutes at the reaction temperature in a drying oven. After the planned reaction time, the vials were transferred into ice water. After cooling to room temperature, sensory analysis was performed.

Conditions:

Reaction Solvents:

0.2 M Phosphate buffer, pH 8.0

0.2 M Phosphate buffer, pH 6.0

Heating temperature: 100° C., drying oven

Heating time: 2 h

TABLE 93-1
Preparation of test samples and sensory evaluation test results.

| Sample | Buffer | Color | Flavor |
|---|---|---|---|
| 10 mg Xyl | +225 μl | Light yellow | Odorless |
| 5 mg Thr | 0.2M KH₂PO₄, | Colorless | Odorless |
| 5 mg Thr + 10 mg Xyl | pH 8.0 | Light yellow | Burnt |
| 5 mg Thr + 10 mg | | Brown | Herbal, very |
| Xyl + 50 mg RU20 | | | intensive |
| 5 mg Thr + 10 mg | | Brown | Herbal |
| Xyl + 50 mg GRU20 | | | |
| 5 mg Thr + 10 mg | | Brown | Herbal |
| Xyl + 50 mg TRU20 | | | |
| 5 mg Thr + 10 mg | | Brown | Herbal, sour |
| Xyl + 50 mg GTRU20 | | | |
| 5 mg Thr + 10 mg | | Brown | Caramel-like, cookie, |
| Xyl + 50 mg RU90 | | | pleasant |
| 5 mg Thr + 10 mg | | Brown | Caramel-like, pleasant |
| Xyl + 50 mg GRU90 | | | |
| 10 mg Xyl | +225 μl | Colorless | Odorless |
| 5 mg Thr | 0.2M KH₂PO₄, | Colorless | Odorless |
| 5 mg Thr + 10 mg Xyl | pH 6.0 | Light yellow | Slight like nutmeg |
| 5 mg Thr + 10 mg | | Brown | Herbal, not very |
| Xyl + 50 mg RU20 | | | intensive |
| 5 mg Thr + 10 mg | | Brown | Fresh, fruity, dried |
| Xyl + 50 mg GRU20 | | | fruity |
| 5 mg Thr + 10 mg | | Brown | Herbal, bitter |
| Xyl + 50 mg TRU20 | | | |
| 5 mg Thr + 10 mg | | Brown | Milky, biscuit, cookie |
| Xyl + 50 mg GTRU20 | | | |
| 5 mg Thr + 10 mg | | Brown | Caramel-like, pleasant |
| Xyl + 50 mg RU90 | | | |
| 5 mg Thr + 10 mg | | Brown | Caramel-like, pleasant |
| Xyl + 50 mg GRU90 | | | |
| 5 mg Arg | +225 μl | Colorless | Odorless |
| 5 mg Arg + 10 mg Xyl | 0.2M KH₂PO₄, | Light yellow | Vanillic |
| 5 mg Arg + 10 mg | pH 8.0 | Brown | Sulfur smell |
| Xyl + 50 mg RU20 | | | |
| 5 mg Arg + 10 mg | | Brown | Sulfur smell, bitter |
| Xyl + 50 mg GRU20 | | | |
| 5 mg Arg + 10 mg | | Brown | Sour, herbal tea |
| Xyl + 50 mg TRU20 | | | |
| 5 mg Arg + 10 mg | | Brown | Sweetish, herbal tea |
| Xyl + 50 mg GTRU20 | | | |
| 5 mg Arg + 10 mg | | Brown | Sweet, caramel-like, |
| Xyl + 50 mg RU90 | | | cookie, pleasant |
| 5 mg Arg + 10 mg | | Brown | Sweet, caramel-like, |
| Xyl + 50 mg GRU90 | | | cookie, pleasant |
| 5 mg Arg | +225 μl | Colorless | Odorless |
| 5 mg Arg + 10 mg Xyl | 0.2M KH₂PO₄, | Light yellow | Slight vanillic |
| 5 mg Arg + 10 mg | pH 6.0 | Brown | Sulfur smell |
| Xyl + 50 mg RU20 | | | |
| 5 mg Arg + 10 mg | | Brown | Menthol-like, fresh, |
| Xyl + 50 mg GRU20 | | | later herbal notes |
| 5 mg Arg + 10 mg | | Brown | Herbal, bitter |
| Xyl + 50 mg TRU20 | | | |
| 5 mg Arg + 10 mg | | Brown | Herbal, sour, unpleasant |
| Xyl + 50 mg GTRU20 | | | |
| 5 mg Arg + 10 mg | | Brown | Sweet, caramel-like, |
| Xyl + 50 mg RU90 | | | cookie, pleasant |
| 5 mg Arg + 10 mg | | Brown | Sweet, caramel-like, cotton |
| Xyl + 50 mg GRU90 | | | candy, cookie, pleasant |
| 5 mg Val | +225 μl | Colorless | Odorless |
| 5 mg Val + 10 mg Xyl | 0.2M KH₂PO₄, | Light yellow | Odorless |
| 5 mg Val + 10 mg | pH 8.0 | Brown | Sulfur smell |
| Xyl + 50 mg RU20 | | | |
| 5 mg Val + 10 mg | | Brown | Sulfur smell |
| Xyl + 50 mg GRU20 | | | |
| 5 mg Val + 10 mg | | Brown | Herbal tea, sour, |
| Xyl + 50 mg TRU20 | | | bitter notes |
| 5 mg Val + 10 mg | | Brown | Sweet with bitter notes, |
| Xyl + 50 mg GTRU20 | | | herbal tea |
| 5 mg Val + 10 mg | | Brown | Sweet with bitter notes, |
| Xyl + 50 mg RU90 | | | herbal tea |
| 5 mg Val + 10 mg | | Brown | Sweet, cookie, caramel- |
| Xyl + 50 mg GRU90 | | | like, intensive |
| 5 mg Val | +225 μl | Colorless | Odorless |
| 5 mg Val + 10 mg Xyl | 0.2M KH₂PO₄, | Light yellow | Very slight vanillic |
| 5 mg Val + 10 mg | pH 6.0 | Brown | Sulfur smell |
| Xyl + 50 mg RU20 | | | |
| 5 mg Val + 10 mg | | Brown | Sulfur Smell |
| Xyl + 50 mg GRU20 | | | |
| 5 mg Val + 10 mg | | Brown | Bitter herbal notes |
| Xyl + 50 mg TRU20 | | | |
| 5 mg Val + 10 mg | | Brown | Sweet, fruity, energy |
| Xyl + 50 mg GTRU20 | | | drink, very pleasant |
| 5 mg Val + 10 mg | | Brown | Sweetish, caramel-like |
| Xyl + 50 mg RU90 | | | |
| 5 mg Val + 10 mg | | Brown | Sweetish, caramel-like |
| Xyl + 50 mg GRU90 | | | |

Conclusion: Using different types and ratios of reactants, such as sugar donor, amine donor, STC, STE, GSTC and GSTE under different reaction conditions, such as temperature, pressure, and pH can create a variety of useful flavors, which can be used for consumables, pharmaceuticals, cosmetics, pet foods etc. The types and ratios of reactants and reaction conditions can be varied and are not limited to these examples.

### Example 94. Analytical Investigations with Zhengyuan Co. Ltd. Volatile Concentrates

Liquid samples (Ref. Y0034434 Lemon Juice Volatiles Conc. Extract or Ref. 71025597 Orange Juice Volatiles Conc. Extract) were diluted 1:20 with ethanol/water for Head Space MS or 1:20 with dichloromethane for liquid extraction.

Both, head space and liquid extraction were calibrated with limonene. Quantification of all identified compounds was based on limonene. This approach includes the consideration that all compounds do have a similar response during analysis (i.e. the area recorded for each peak can be quantified against limonene).

Head Space analysis was performed after incubation and equilibration at 80° C. and was performed to identify and quantify the smell/aroma active fraction. Liquid injection was performed to identify and to quantify the total amount of essential oil compounds.

Find on the following Tables and Chromatograms the analytical test results.

Below the principal results are shown.

Ref Y0034434 Lemon Juice Volatiles Conc. Extract contains 15.5 g/l smell/aroma active principles and the total content was calculated to 565 g/l. The corresponding numbers for Ref. 71025597 Orange Juice Volatiles Conc. Extract are 11.1 g/l and 613 g/l, respectively.

TABLE 94-1
Quantitative Results from Head Space GC/MS Analysis
of Ref. Y0034434 Lemon Juice Volatiles Conc. Extract.

| Peak | R. | | Area | | Height | | | |
|---|---|---|---|---|---|---|---|---|
| # | Time | Area | % | Height | % | A/H | Compound | mg/l |
| 1 | 9.03 | 82573002 | 3.37 | 49333355 | 4.07 | 1.67 | beta Myrcene | 0.523 |
| 2 | 9.37 | 28464122 | 1.16 | 13231296 | 1.09 | 2.15 | Carveol | 0.180 |
| 3 | 9.80 | 60751655 | 2.48 | 29354625 | 2.42 | 2.07 | 1,3.8-p- | 0.385 |
| | | | | | | | Menthatriene | |
| 4 | 9.94 | 503023151 | 20.53 | 133819053 | 11.03 | 3.76 | D-limonene | 3.189 |
| 5 | 10.04 | 28120985 | 1.15 | 20538831 | 1.69 | 1.37 | trans-beta- | 0.178 |
| | | | | | | | Ocimene | |
| 6 | 10.25 | 57809424 | 2.36 | 40887611 | 3.37 | 1.41 | beta Ocimene | 0.366 |
| 7 | 10.50 | 219626869 | 8.97 | 128548823 | 10.60 | 1.71 | gamma Terpinene | 1.392 |
| 8 | 11.02 | 39285895 | 1.60 | 29296375 | 2.42 | 1.34 | Cyclohexene, | 0.249 |
| | | | | | | | 1-methyl-4(1- | |
| | | | | | | | methyl | |
| 9 | 11.28 | 24291637 | 0.99 | 17987638 | 1.48 | 1.35 | Linalool formate | 0.154 |
| 10 | 11.37 | 18254976 | 0.75 | 13970415 | 1.15 | 1.31 | Nonanal | 0.116 |
| 11 | 12.96 | 98688515 | 4.03 | 72554504 | 5.98 | 1.36 | alpha Terpineol | 0.626 |
| 12 | 13.10 | 15546460 | 0.63 | 12134032 | 1.00 | 1.28 | Decanal | 0.099 |
| 13 | 13.39 | 18979985 | 0.77 | 12858352 | 1.06 | 1.48 | 3-Carene | 0.120 |
| 14 | 13.63 | 282223594 | 11.52 | 133064076 | 10.97 | 2.12 | Cis Verbenol | 1.789 |
| 15 | 14.09 | 354205395 | 14.46 | 132857859 | 10.95 | 2.67 | Citral | 2.245 |
| 16 | 15.36 | 47696021 | 1.95 | 37416831 | 3.08 | 1.27 | 3-Carene | 0.302 |
| 17 | 15.63 | 25988934 | 1.06 | 20288727 | 1.67 | 1.28 | beta Myrcene | 0.165 |
| 18 | 16.34 | 113781780 | 4.64 | 77259537 | 6.37 | 1.47 | Carophyllene | 0.721 |
| 19 | 16.47 | 223193212 | 9.11 | 128152642 | 10.57 | 1.74 | trans alpha | 1.415 |
| | | | | | | | Bergamotene | |
| 20 | 17.43 | 207195961 | 8.46 | 109311048 | 9.01 | 1.90 | beta Bisabolene | 1.313 |

| | | | | | |
|---|---|---|---|---|---|
| Sum: | 2449701573 | 100 | 1212865630 | 100 | 15.529 |

TABLE 94-2
Quantitative Results from Liquid Injection of Ref.
Y0034434 Lemon Juice Volatiles Conc. Extract.

| Peak | R. | | Area | | Height | | | |
|---|---|---|---|---|---|---|---|---|
| # | Time | Area | % | Height | % | A/H | Compound | mg/1 |
| 1 | 9.91 | 248160891 | 5.91 | 116551902 | 6.27 | 2.13 | D-limonene | 33.383 |
| 2 | 10.49 | 56531407 | 1.35 | 41517143 | 2.23 | 1.36 | γ-Terpinene | 7.605 |
| 3 | 11.28 | 17518497 | 0.42 | 16041202 | 0.86 | 1.09 | Linalool | 2.357 |
| 4 | 12.97 | 209859064 | 5.00 | 126259320 | 6.79 | 1.66 | α-Terpineol | 28.230 |
| 5 | 13.10 | 16559046 | 0.39 | 13078717 | 0.70 | 1.27 | Decanal | 2.228 |
| 6 | 13.40 | 129350650 | 3.08 | 79016365 | 4.25 | 1.64 | 3-Carene | 17.400 |
| 7 | 13.65 | 410667320 | 9.78 | 131176897 | 7.06 | 3.13 | Carveol | 55.243 |
| 8 | 13.79 | 53341848 | 1.27 | 33253705 | 1.79 | 1.60 | cis-Verbenol | 7.176 |
| 9 | 14.12 | 559584181 | 13.33 | 131440579 | 7.07 | 4.26 | Citral | 75.276 |
| 10 | 14.24 | 23462451 | 0.56 | 16494277 | 0.89 | 1.42 | β Pinene | 3.156 |
| 11 | 14.66 | 24829062 | 0.59 | 19436308 | 1.05 | 1.28 | Undecanal | 3.340 |
| 12 | 15.23 | 20931742 | 0.50 | 14403671 | 0.77 | 1.45 | 2,6-Octadiene, | 2.816 |
| | | | | | | | 2,6-dimethyl- | |
| 13 | 15.38 | 353274954 | 8.41 | 131779840 | 7.09 | 2.68 | 3-Carene | 47.523 |
| 14 | 15.65 | 290360769 | 6.91 | 132610872 | 7.13 | 2.19 | beta Myrcene | 39.060 |
| 15 | 16.20 | 50913167 | 1.21 | 38216172 | 2.06 | 1.33 | trans-α- | 6.849 |
| | | | | | | | Bergamotene | |
| 16 | 16.36 | 280968983 | 6.69 | 132910314 | 7.15 | 2.11 | Caryophyllene | 37.796 |
| 17 | 16.48 | 354807224 | 8.45 | 131264902 | 7.06 | 2.70 | trans alpha | 47.729 |
| | | | | | | | Bergamotene | |
| 18 | 16.52 | 31475270 | 0.75 | 27265517 | 1.47 | 1.15 | Caryophyllene | 4.234 |
| 19 | 16.66 | 72001376 | 1.71 | 54024139 | 2.91 | 1.33 | cis-3-Farnesene | 9.686 |
| 20 | 16.82 | 78596437 | 1.87 | 50423125 | 2.71 | 1.56 | Bicyclo[2.2.1]heptane, | 10.573 |
| | | | | | | | 2-methyl-3-m | |
| 21 | 17.04 | 15476732 | 0.37 | 12077187 | 0.65 | 1.28 | (R,Z)-2-Methyl-6- | 2.082 |
| | | | | | | | (4-methylcyclohex | |
| 22 | 17.15 | 55838862 | 1.33 | 41245751 | 2.22 | 1.35 | Cyclohexene, | 7.512 |
| | | | | | | | 3-(1,5-dimethyl-4- | |
| | | | | | | | hex | |
| 23 | 17.32 | 192255439 | 4.58 | 95017863 | 5.11 | 2.02 | cis alpha | 25.862 |
| | | | | | | | Bisabolene | |
| 24 | 17.45 | 448052357 | 10.67 | 132558101 | 7.13 | 3.38 | beta Bisabolene | 60.272 |
| 25 | 17.82 | 37056665 | 0.88 | 28544478 | 1.54 | 1.30 | Cyclohexene, 4- | 4.985 |
| | | | | | | | [(1E)-1,5- | |
| | | | | | | | dimethyl-1 | |
| 26 | 18.81 | 20348248 | 0.48 | 14061619 | 0.76 | 1.45 | 1H- | 2.737 |
| | | | | | | | Benzocycloheptene, | |
| | | | | | | | 2,4a,5,6,7,8 | |
| 27 | 19.33 | 44857669 | 1.07 | 25948925 | 1.40 | 1.73 | Bicyclo[2.2.1]heptane, | 6.034 |
| | | | | | | | 2-methyl-3-m | |
| 28 | 19.46 | 29226423 | 0.70 | 20400606 | 1.10 | 1.43 | Tricyclo[2.2.1.0(2,6)] | 3.932 |
| | | | | | | | heptane, 1,7-di | |
| 29 | 19.60 | 72847029 | 1.73 | 51624380 | 2.78 | 1.41 | β-Bisabolene | 9.799 |

| | | | | | |
|---|---|---|---|---|---|
| Sum: | 4199153763 | 100 | 1858643877 | 100 | 564.875 |

TABLE 94-3
Quantitative Results from Head Space GC/MS Analysis of
Ref. 71025597 Orange Juice Volatiles Conc. Extract.

| Peak | R. | | Area | | Height | | | |
|---|---|---|---|---|---|---|---|---|
| # | Time | Area | % | Height | % | A/H | Compound | mg/l |
| 1 | 9.03 | 48669201 | 2.06 | 32057619 | 2.5 | 1.52 | β-Myrcene | 0.230 |
| 2 | 9.37 | 23198541 | 0.98 | 14469726 | 1.1 | 1.60 | Carveol | 0.110 |
| 3 | 9.94 | 499401309 | 21.19 | 133571608 | 10.4 | 3.74 | D-limonene | 2.358 |
| 4 | 12.96 | 28192878 | 1.20 | 20955922 | 1.6 | 1.35 | α-Terpineol | 0.133 |
| 5 | 13.12 | 301555921 | 12.79 | 133484539 | 10.4 | 2.26 | Decanal | 1.424 |
| 6 | 13.61 | 99151284 | 4.21 | 75811377 | 5.9 | 1.31 | cis-Verbenol | 0.468 |
| 7 | 14.07 | 180906368 | 7.68 | 122080494 | 9.5 | 1.48 | Citral | 0.854 |
| 8 | 14.23 | 44093892 | 1.87 | 30023884 | 2.3 | 1.47 | 1-Cyclohexene-1- | 0.208 |
| | | | | | | | carboxaldehyde, 4 | |
| 9 | 14.66 | 47214599 | 2.00 | 36678873 | 2.9 | 1.29 | Undecanal | 0.223 |
| 10 | 15.71 | 96201091 | 4.08 | 69109129 | 5.4 | 1.39 | Copaene | 0.454 |
| 11 | 15.88 | 76409659 | 3.24 | 56170396 | 4.4 | 1.36 | Cyclohexane, | 0.361 |
| 12 | 16.09 | 169152393 | 7.18 | 111660574 | 8.7 | 1.51 | Dodecanal | 0.799 |
| 13 | 16.34 | 89372558 | 3.79 | 59478876 | 4.6 | 1.50 | Caryophyllene | 0.422 |
| 14 | 16.46 | 74989145 | 3.18 | 50841759 | 4.0 | 1.47 | β-copaene | 0.354 |
| 15 | 16.66 | 16636312 | 0.71 | 11740531 | 0.9 | 1.42 | (E)-β-Farnesene | 0.079 |
| 16 | 16.71 | 28641048 | 1.22 | 15135646 | 1.2 | 1.89 | cis-muurola-3,5- | 0.135 |
| | | | | | | | diene | |
| 17 | 16.82 | 17214369 | 0.73 | 12162150 | 1.0 | 1.42 | Humulene | 0.081 |
| 18 | 17.03 | 26316272 | 1.12 | 20030026 | 1.6 | 1.31 | γ-Muurolene | 0.124 |
| 19 | 17.18 | 15484676 | 0.66 | 10644048 | 0.8 | 1.45 | Aristolochene | 0.073 |
| 20 | 17.30 | 279343023 | 11.85 | 132751826 | 10.4 | 2.10 | Aromandendrene | 1.319 |
| 21 | 17.33 | 75956229 | 3.22 | 46634969 | 3.6 | 1.63 | α-Guaiene | 0.359 |
| 22 | 17.58 | 85056738 | 3.61 | 63272720 | 4.9 | 1.34 | Naphthalene, | 0.402 |
| | | | | | | | 1,2,4a,5,8,8a- | |
| | | | | | | | hexahydro | |
| 23 | 17.64 | 20493237 | 0.87 | 12306004 | 1.0 | 1.67 | (−)-α-Panasinsen | 0.097 |
| 24 | 17.77 | 13429978 | 0.57 | 10362940 | 0.8 | 1.30 | Naphthalene, | 0.063 |
| | | | | | | | 1,2,3,4,4a,7- | |
| | | | | | | | hexahydro | |
| | Sum: | 2357080721 | 100.00 | 1281435636 | 100.0 | | | 11.127 |

TABLE 94-4
Quantitative Results from Liquid Injection of GC/MS
Ref. 71025597 Orange Juice Volatiles Conc. Extract.

| Peak | R. | | Area | | Height | | | |
|---|---|---|---|---|---|---|---|---|
| # | Time | Area | % | Height | % | A/H | Compound | mg/l |
| 1 | 9.89 | 185991681 | 4.08 | 124851325 | 5.44 | 1.49 | D-limonene | 25.020 |
| 2 | 12.96 | 36159770 | 0.79 | 27845966 | 1.21 | 1.30 | α-Terpineol | 4.864 |
| 3 | 13.12 | 236667914 | 5.20 | 124526548 | 5.43 | 1.90 | Decanal | 31.837 |
| 4 | 13.39 | 48168920 | 1.06 | 21169285 | 0.92 | 2.28 | 3-Carene | 6.480 |
| 5 | 13.62 | 124325100 | 2.73 | 89334220 | 3.89 | 1.39 | cis-p-Mentha- | 16.724 |
| | | | | | | | 2,8-dien-1-ol | |
| 6 | 13.78 | 27354254 | 0.60 | 20181847 | 0.88 | 1.36 | 3-Carene | 3.680 |
| 7 | 14.08 | 234634837 | 5.15 | 123766931 | 5.39 | 1.90 | Citral | 31.563 |
| 8 | 14.11 | 44473154 | 0.98 | 26288700 | 1.15 | 1.69 | 2-Decenal | 5.983 |
| 9 | 14.23 | 53340486 | 1.17 | 39233204 | 1.71 | 1.36 | 1-Cyclohexene- | 7.175 |
| | | | | | | | 1- | |
| | | | | | | | carboxaldehyde, 4 | |
| 10 | 14.44 | 50787422 | 1.12 | 35578575 | 1.55 | 1.43 | p-Mentha- | 6.832 |
| | | | | | | | 1(7),8(10)- | |
| | | | | | | | dien-9-ol | |
| 11 | 14.66 | 77567337 | 1.70 | 58161711 | 2.53 | 1.33 | Undecanal | 10.434 |
| 12 | 15.23 | 86796401 | 1.91 | 55209676 | 2.41 | 1.57 | Cyclohexanol, | 11.676 |
| | | | | | | | 2-methyl-5-(1- | |
| | | | | | | | methy | |
| 13 | 15.36 | 66748985 | 1.47 | 49645192 | 2.16 | 1.34 | D-limonenee | 8.979 |
| 14 | 15.63 | 69214889 | 1.52 | 49760956 | 2.17 | 1.39 | 3-Carene | 9.311 |
| 15 | 15.71 | 121700773 | 2.67 | 83483767 | 3.64 | 1.46 | Copaene | 16.371 |
| 16 | 15.88 | 236037969 | 5.18 | 112698856 | 4.91 | 2.09 | Cyclohexane, | 31.752 |
| | | | | | | | 1-ethenyl-1- | |
| | | | | | | | methyl-2, | |
| 17 | 16.11 | 366460120 | 8.05 | 131043788 | 5.71 | 2.80 | cis para meta | 49.297 |
| | | | | | | | 1(7), 8-dien-2- | |
| | | | | | | | ol | |
| 18 | 16.35 | 217591332 | 4.78 | 104181683 | 4.54 | 2.09 | Caryophyllene | 29.271 |
| 19 | 16.47 | 234817383 | 5.16 | 126653559 | 5.52 | 1.85 | β copaene | 31.588 |
| 20 | 16.67 | 91653298 | 2.01 | 60437474 | 2.63 | 1.52 | cis-β-Farnesene | 12.329 |
| 21 | 16.71 | 61079942 | 1.34 | 31136703 | 1.36 | 1.96 | Cedrene | 8.217 |
| 22 | 16.82 | 61120796 | 1.34 | 41254488 | 1.80 | 1.48 | Humulene | 8.222 |
| 23 | 17.04 | 44842395 | 0.98 | 27881688 | 1.21 | 1.61 | γ-Muurolene | 6.032 |
| 24 | 17.08 | 39337992 | 0.86 | 24226620 | 1.06 | 1.62 | Alloaromadendrene | 5.292 |
| 25 | 17.15 | 150574596 | 3.31 | 95428024 | 4.16 | 1.58 | Isoledene | 20.255 |
| 26 | 17.18 | 75870582 | 1.67 | 48046629 | 2.09 | 1.58 | Aristolochene | 10.206 |
| 27 | 17.35 | 729532491 | 16.02 | 130221316 | 5.67 | 5.60 | Eremophila- | 98.137 |
| | | | | | | | 1(10), 11-diene | |
| 28 | 17.42 | 65765634 | 1.44 | 42555562 | 1.85 | 1.55 | 4-Methyl- | 8.847 |
| | | | | | | | dodecan-1-ol | |
| 29 | 17.59 | 271951867 | 5.97 | 129113001 | 5.63 | 2.11 | Cadina- | 36.583 |
| | | | | | | | 1(10),4-diene | |
| 30 | 17.65 | 107653267 | 2.36 | 57406718 | 2.50 | 1.88 | (−)-α- | 14.482 |
| | | | | | | | Panasinsen | |
| 31 | 17.95 | 50145613 | 1.10 | 35537245 | 1.55 | 1.41 | α-Panasinsene | 6.746 |
| 32 | 18.34 | 46308411 | 1.02 | 22359620 | 0.97 | 2.07 | γ muurolene | 6.229 |
| 33 | 18.44 | 102164935 | 2.24 | 56991188 | 2.48 | 1.79 | 2- | 13.743 |
| | | | | | | | Naphthaleneethanol, | |
| | | | | | | | decahydro-4a | |
| 34 | 19.65 | 95318599 | 2.09 | 61908238 | 2.70 | 1.54 | 2,6,11- | 12.822 |
| | | | | | | | Dodecatrienal, | |
| | | | | | | | 2,6-dimethyl- | |
| 35 | 20.27 | 41682989 | 0.92 | 26966174 | 1.17 | 1.55 | 2,6,9,11- | 5.607 |
| | | | | | | | Dodecatetraenal, | |
| | | | | | | | 2,6,10- | |
| | | | | | | | trimethyl | |
| | Sum: | 4553842134 | 100.00 | 2295086477 | 100.00 | | | 612.588 |

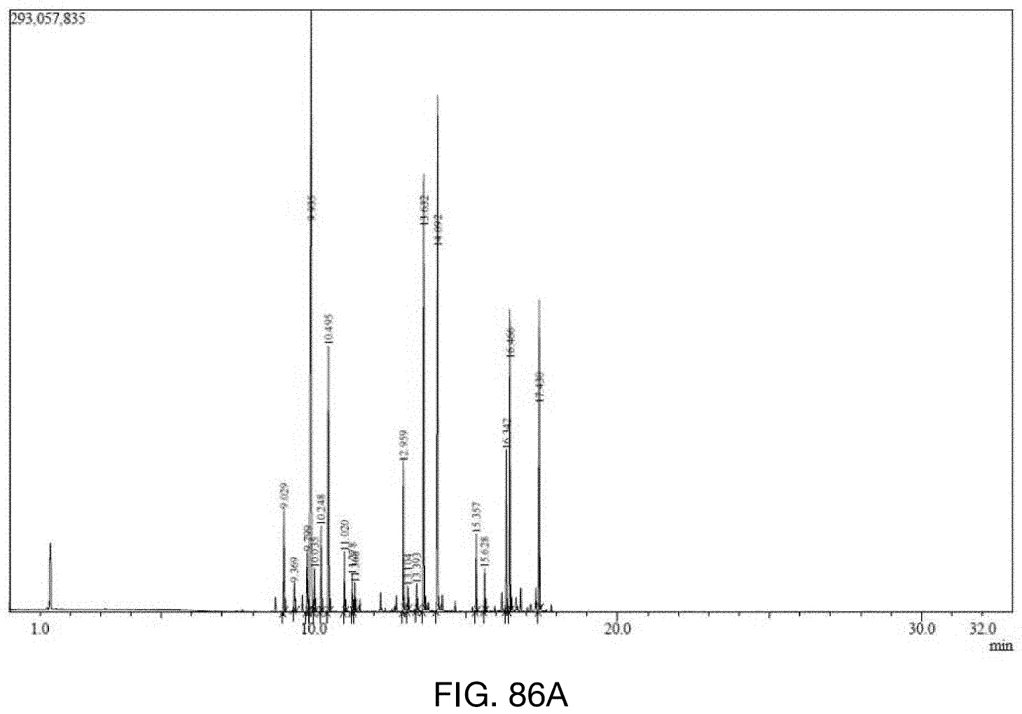

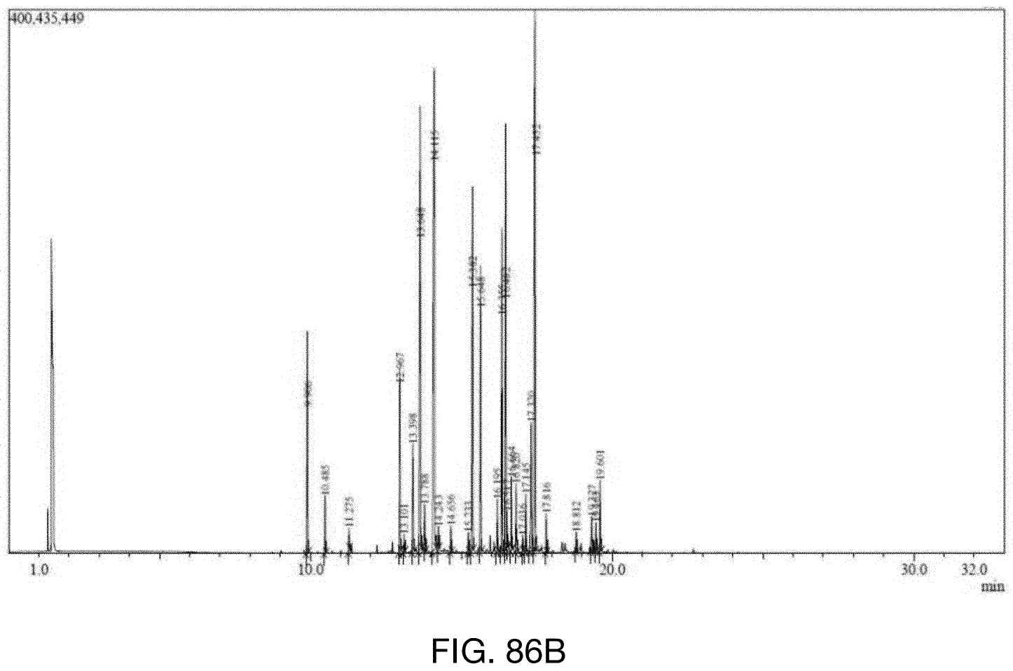

FIG. 86A shows a chromatogram from the Head Space GC/MS Analysis of Ref. Y0034434 Lemon Juice Volatiles Conc. Extract. FIG. 86B shows a chromatogram from the Liquid Injection GC/MS Analysis of Ref. Y0034434 Lemon Juice Volatiles Conc. Extract.

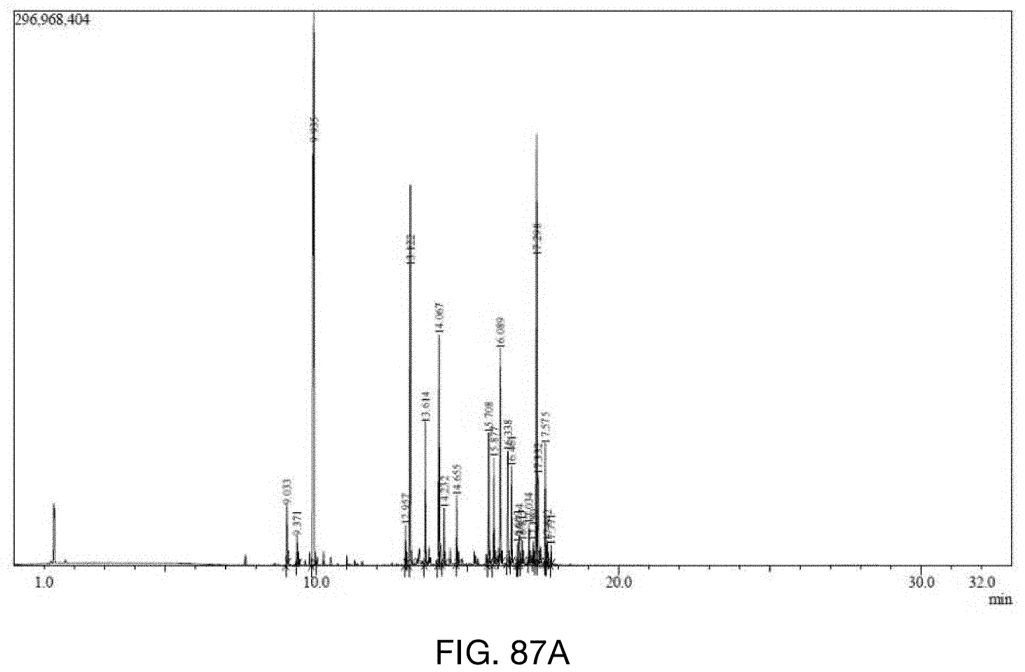

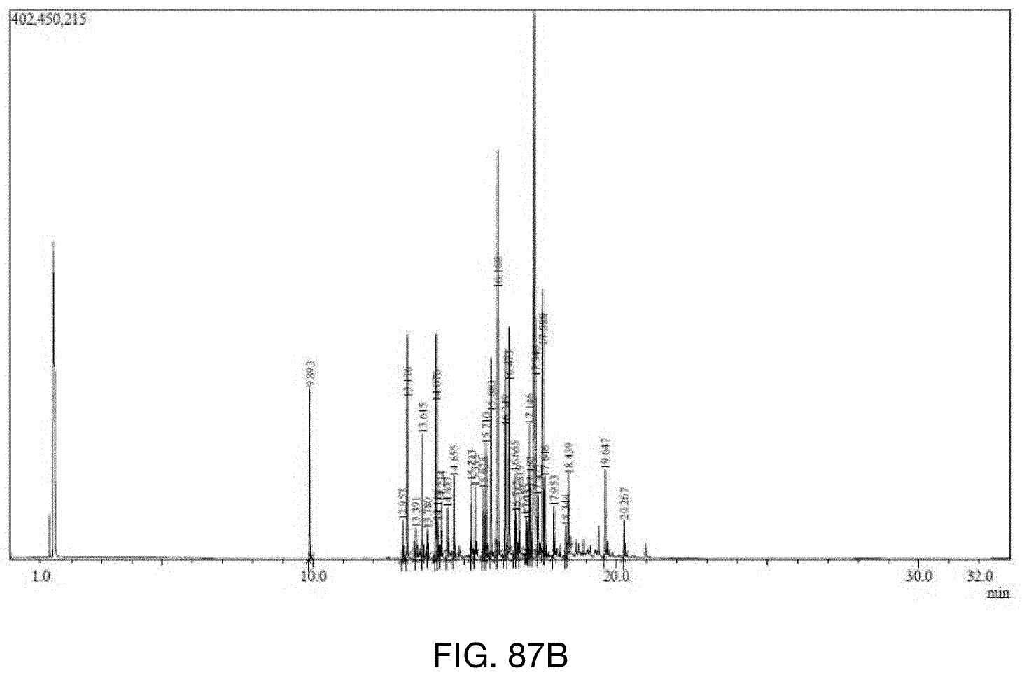

FIG. 87A shows a chromatogram from the Head Space GC/MS Ref. analysis of 71025597 Orange Juice Volatiles Conc. Extract. FIG. 87B shows a chromatogram from the liquid injection GC/MS analysis of Ref. 71025597 Orange Juice Volatiles Conc. Extract.

Conclusion: In some embodiments, a composition comprises one or more substances selected from STCs, STEs, GSTCs, GSTEs, ST-MRPs and G-ST-MRPs and one of substances selected from any one of the above-described flavors, thereby producing a composition with soluble flavors and increased flavor intensity.

### Example 95. Preparation of Flavored RU90 MRPs or GRU90 MRPs Formed from Addition of Xylose Alone or Xylose with Lysine or Arginine, or Flavored RU90 or GRU90 Blended with MRPs Formed from Xylose Alone or Xylose with Lysine or Arginine, Including Analysis of Orthonasal Therefrom, and their Use in Taste Modification of Beverage Products

Materials:

RU90, Lot #EPC-238-34-03, EPC Lab

GRU90, Lot #EPC-303-89-03, EPC Lab

L-Arginine, ≥98%, Batch #MKBC7640, Sigma Aldrich

L-(+)-Lysine, Lot 0001442572, Sigma Aldrich

D-(+)-Xylose, ≥99.5%, Lot 024K00312, Sigma Aldrich

Test design: A series of experiments was performed in sealed 10 ml Pyrex-vials. The MRPs were prepared with\without the addition of RU and GRU. The experiments were performed under the following conditions:

Reaction solvent: deionized water

Heating temperature: 100° C., drying oven

Heating time: 1 h

### Experiment 1—MRPs Heated with RU90 or GRU90

Reaction partners (5 mg of amino acid, 10 mg of reducing sugar, 50 mg of RU90 or GRU90) were dissolved/suspended 225 μl of reaction solvent. The prepared samples were transferred into a glass beaker filled with sand pre-heated for at least 30 minutes at the reaction temperature in a drying oven. After the planned reaction time, the vials were transferred into ice water. After cooling to room temperature, sensory analysis was performed.

### Experiment 2—MRPs Heated without RU90 or GRU90

The reaction partner (5 mg of amino acid, 10 mg of reducing sugar) were dissolved/suspended in 225 μl of reaction solvent. The prepared samples were transferred into a glass beaker filled with sand pre-heated for at least 30 minutes at the reaction temperature in a drying oven. After the planned reaction time, the vials were transferred into ice water. After cooling to room temperature, the samples were blended with 50 mg of RU90 or GRU90 and a sensory analysis was performed.

TABLE 95-1
Sensory evaluation of MRPs formed from heat treatment
of amino acids, sugars and RU or GRU (Experiment 1).

| MR reactants | Color | Odor |
|---|---|---|
| 5 mg Lys + 10 mg Xyl | Brown | Sweet, caramel-like, cookie |
| 5 mg Lys + 10 mg | Brown | Sweet, more caramel-like, |
| Xyl + 50 mg RU90 | | cookie, pleasant |
| 5 mg Lys + 10 mg | Brown | Sweet, more caramel-like, |
| Xyl + 50 mg GRU90 | | cookie, pleasant |
| 5 mg Arg + 10 mg Xyl | Brown | Sweet, slight vanilla-like |
| 5 mg Arg + 10 mg | Brown | Sweet, vanilla-like |
| Xyl + 50 mg RU90 | | |
| 5 mg Arg + 10 mg | Brown | Sweet, fruity, grape |
| Xyl + 50 mg GRU90 | | |

TABLE 95-2
Sensory evaluation of MRPs combined with RU or
GRU after Maillard reaction (Experiment 2).

| | Added after | | |
|---|---|---|---|
| Amine, sugar donors | heating | Color | Odor |
| 5 mg Lys + | +50 mg RU90 | Brown | Sweet, caramel-like, |
| 10 mg Xyl | | | less intensive aroma |
| 5 mg Lys + | +50 mg GRU90 | Brown | Sweet, caramel-like, |
| 10 mg Xyl | | | less intensive aroma |
| 5 mg Arg + | +50 mg RU90 | Brown | Sweet, vanilla-like, |
| 10 mg Xyl | | | less intensive aroma |
| 5 mg Arg + | +50 mg GRU90 | Brown | Sweet, vanilla-like, |
| 10 mg Xyl | | | less intensive aroma |

Conclusion: The use of different amine donors creates different flavors; one or more substances selected from STCs, STEs, GSTCs, and GSTEs can act as sugar donor(s) to react with amine donor(s) directly, or they can be added together with sugar and amine donors, or they can be added after reaction of standard sugar and amine donors. The final products generate pleasant tasting flavors which can be used for consumables, cosmetics, pharmaceuticals, pet foods etc. The sugar donor(s), amine donor(s), STCs, GTSCs, STEs, and/or GSTEs can be varied in different ratios. The sugar and amine donors can be any substances disclosed in the specification without limitation.

Application 1: Taste Modification of Lemonade

Lemonade composition: 100% lemon juice from concentrate, 20.04.2021 23:32/4A1, Rauch Fruchtsäfte GmbH

Test design: Non-commercial lemonade made from lemon juice concentrate (ratio 1:5, blended with deionized water) and sweetened with 5% of sugar was selected to perform a flavor perception test of prepared MRPs. 100 ppm of each MRP was added to the test samples. Then the samples were subjected to a sensory evaluation, the results of which are described in Table 95-3.

TABLE 95-3
Sensory evaluation of lemonade subjected to Maillard reaction
with amino acids, sugars and RU90 or GRU90 (Experiment 1).

| No. | MR reactants | Sensory evaluation |
|---|---|---|
| 1 | Control (without added | Odor: lemon, acidic, not very intensive |
| | MRPs) | Taste: Lack of sweetness, very acidic |
| 2 | 5 mg Lys + 10 mg Xyl | Odor: lemon, acidic, not very intensive |
| | | Taste: Slightly sweeter than sample 1, less |
| | | acidic |
| 3 | 5 mg Lys + 10 mg | Odor: Fresher, enhanced lemon |
| | Xyl + 50 mg RU90 | Taste: Sweeter than sample 1, less acidic, |
| | | enhanced mouth-feeling, smoother and |
| | | fresher taste |
| 4 | 5 mg Lys + 10 mg | Odor: Fresher, enhanced lemon flavor |
| | Xyl + 50 mg GRU90 | Taste: Sweeter than sample 1, less acidic, |
| | | enhanced mouth-feeling, smoother and |
| | | fresher taste |
| 5 | 5 mg Arg + 10 mg Xyl | Odor: Fresher, enhanced lemon flavor |
| | | Taste: Slightly sweeter than sample 1, less |
| | | acidic, slight bitter aftertaste |
| 6 | 5 mg Arg + 10 mg | Odor: Fresher, enhanced lemon flavor |
| | Xyl + 50 mg RU90 | Taste: Sweeter than sample 1, less acidic, |
| | | no bitter aftertaste, fresh and smooth |
| 7 | 5 mg Arg + 10 mg | Odor: Fresher, enhanced lemon flavor |
| | Xyl + 50 mg GRU90 | Taste: Sweeter than sample 1, less acidic, |
| | | no bitter aftertaste, fresh and smooth |

Conclusion: standard MRPs and ST-MRPs can significantly improve the taste and flavor of lemonade. Types and ratios of amine donor, sugar donor, STE, STC, GSTE, and/or GSTC in the Maillard reaction can be modified in a consumable in any amount mentioned in the specification.

TABLE 95-4
Sensory evaluation of lemonade subjected to Maillard reaction and then
combined with RU90 or GRU90 after heat treatment (Experiment 2).

| | Amine and sugar | Added after MR | |
|---|---|---|---|
| No. | donors in MR | (100 ppm) | Sensory evaluation |
| 8 | 5 mg Lys + | +50 mg RU90 | Odor: Fresher, enhanced lemon flavor |
| | 10 mg Xyl | | Taste: Less sweet than sample 3, but |
| | | | still pleasant fresh and smooth mouth- |
| | | | feeling |
| 9 | 5 mg Lys + | +50 mg GRU90 | Odor: Fresher, enhanced lemon flavor |
| | 10 mg Xyl | | Taste: Less sweet than sample 4, but |
| | | | still pleasant fresh and smooth mouth- |
| | | | feeling |
| 10 | 5 mg Arg + | +50 mg RU90 | Odor: Fresher, enhanced lemon flavor |
| | 10 mg Xyl | | Taste: Less sweet than sample 6, but |
| | | | still pleasant, fresh and smooth mouth- |
| | | | feeling |
| 11 | 5 mg Arg + | +50 mg GRU90 | Odor: Fresher, enhanced lemon flavor |
| | 10 mg Xyl | | Taste: Less sweet than sample 7, but |
| | | | still pleasant fresh and smooth mouth- |
| | | | feeling |

Conclusion: Combining standard MRPs with STE, STC, GSTE and/or GSTC can provide another level of improved changes to lemonade or other beverages in terms of taste and flavor. Types and ratios of amine donor, sugar donor, STE, STC, GSTE, and/or GSTC in the reaction can be modified in a consumable in any amount mentioned in the specification.

Application 2: Taste Modification of Low Fat Yogurt Drink

Yogurt drink: Yogurt drink with strawberry juice, 0.1% fat, 31 16204:04 15.07.2020

Test design: Commercial yogurt drink made from skim milk with strawberry juice (Brand: Nom, fat content 0.1%, without added sugar, sweetened with sucralose, Ace-K) was selected to perform a flavor perception test of prepared MRPs. 100 ppm of each MRP was added to each test sample. Then the samples were subjected to a sensory evaluation, the results of which are described in Tables 95-5 and 95-6.

TABLE 95-5
Sensory evaluation of yogurt drink subjected to Maillard reaction
with amino acids, sugars and RU90 or GRU90 (Experiment 1).

| No. | MR reactants | Sensory evaluation |
|---|---|---|
| 1 | Control (without | Odor: Milky, strawberry flavor |
| | added MRPs) | Taste: Lack of sweetness, artificial aftertaste, |
| | | watery mouth-feeling |
| 2 | 5 mg Lys + | Odor: Milky, strawberry flavor |
| | 10 mg Xyl | Taste: Slightly sweeter than control, less |
| | | artificial aftertaste, still some watery mouth- |
| | | feeling |
| 3 | 5 mg Lys + 10 mg | Odor: Enhanced strawberry flavor |
| | Xyl + 50 mg RU90 | Taste: Sweeter than control, pleasant sweet, |
| | | no artificial aftertaste, well-balanced |
| | | strawberry flavor, enhanced mouth-feeling |
| 4 | 5 mg Lys + 10 mg | Odor: Enhanced strawberry flavor |
| | Xyl + 50 mg | Taste: Sweeter than control, pleasant sweet, |
| | GRU90 | no artificial aftertaste, well-balanced |
| | | strawberry flavor, enhanced mouth-feeling |
| 5 | 5 mg Arg + | Odor: Milky, strawberry flavor |
| | 10 mg Xyl | Taste: Slightly sweeter than control, less |
| | | artificial aftertaste, still some watery mouth- |
| | | feeling |
| 6 | 5 mg Arg + 10 mg | Odor: Enhanced strawberry flavor |
| | Xyl + 50 mg RU90 | Taste: Sweeter than control, pleasant sweet, |
| | | no artificial aftertaste, well-balanced |
| | | strawberry flavor, enhanced mouth-feeling |
| 7 | 5 mg Arg + 10 mg | Odor: Enhanced strawberry flavor |
| | Xyl + 50 mg | Taste: Sweeter than control, pleasant sweet, |
| | GRU90 | no artificial aftertaste, well-balanced |
| | | strawberry flavor, enhanced mouth-feeling |

Conclusion: MRPs, ST-MRPs, and G-ST-MRPs can significantly improve the taste of yogurt drinks when used. Types and ratios of amine donor, sugar donor, STE, STC, GSTE, and/or GSTC in the Maillard reaction can be modified in a consumable in any amount mentioned in the specification.

TABLE 95-6
Sensory evaluation of yogurt subjected to Maillard reaction and then
combined with RU90 or GRU90 after heat treatment (Experiment 2).

| | Amine, sugar donors | Added after MR | |
|---|---|---|---|
| No. | for MR | (100 ppm) | Sensory evaluation |
| 8 | 5 mg Lys + | +50 mg RU90 | Odor: Enhanced strawberry flavor |
| | 10 mg Xyl | | Taste: Enhanced sweetness, but |
| | | | less sweet than sample 3, better |
| | | | mouth-feeling compared to control, |
| | | | well-balanced strawberry flavor |
| 9 | 5 mg Lys + | +50 mg GRU90 | Odor: Enhanced strawberry flavor |
| | 10 mg Xyl | | Taste: Enhanced sweetness, but |
| | | | less sweet than sample 4, better |
| | | | mouth-feeling compared to control, |
| | | | well-balanced strawberry flavor |
| 10 | 5 mg Arg + | +50 mg RU90 | Odor: Enhanced strawberry flavor |
| | 10 mg Xyl | | Taste: Enhanced sweetness, but |
| | | | less sweet than sample 6, better |
| | | | mouth-feeling compared to control, |
| | | | well-balanced strawberry flavor |
| 11 | 5 mg Arg + | +50 mg GRU90 | Odor: Enhanced strawberry flavor |
| | 10 mg Xyl | | Taste: Enhanced sweetness, but |
| | | | less sweet than sample 7, better |
| | | | mouth-feeling compared to control, |
| | | | well-balanced strawberry flavor |

Conclusion: Combining standard MRPs with STE, STC, GSTE and/or GSTC can provide another level of improved changes to yogurt drinks in terms of taste and flavor. Types and ratios of amine donor, sugar donor, STE, STC, GSTE, and/or GSTC in the reaction can be modified in a consumable in any amount mentioned in the specification.

### Example 96. Preparation of Flavored RU90 MRPs or GRU90 MRPs Formed from Addition of Fructose Alone or Fructose with Various Amino Acids, or RU90 or GRU90 Blended with MRPs Formed Fructose Alone or Fructose with Various Amino Acids, Including Analysis of Orthonasal Therefrom, and their Use in Taste Modification of Beverage Products

Materials:

RU90, Lot #EPC-238-34-03, EPC Lab

GRU90, Lot #EPC-303-89-03, EPC Lab

L-Alanine, Lot #0001388605, Fluka

L-Arginine, ≥98%, Batch #MKBC7640, Sigma Aldrich

DL-Asparagine monohydrate, 98%, Lot 69H1152, Sigma Aldrich

Glycine anhydride, Lot 090K5432, Sigma Aldrich

L-Leucine, Lot #61819, Fluka

L-(+)-Lysine, Lot 0001442572, Sigma Aldrich

DL-Phenylalanine, min. 98%, Lot #51K1696, Sigma Aldrich

DL-Proline, 99%, Lot 17H0844, Sigma Aldrich

L-Threonine, ≥98%, Lot #SLBJ1992V, Sigma Aldrich

DL-Tyrosine, Lot #49H0632, Sigma Aldrich

D-Valine, 98%, Lot 20H0295, Sigma Aldrich

D-(−)-Fructose, Lot #BCBC1225, Sigma Aldrich

Test design: A series of experiments was performed in sealed 10 ml Pyrex vials. The MRPs were prepared with or without the addition of RU and GRU. The experiments were performed under the following conditions:

Reaction solvent: deionized water

Heating temperature: 100° C., drying oven

Heating time: 1 h

### Experiment 1. MRPs Heated with RU90 or GRU90

The reaction partner (5 mg of amino acid, 10 mg of reducing sugar, 50 mg of RU90 or GRU90) were dissolved/suspended 225 μl of reaction solvent. The prepared samples were transferred into a glass beaker filled with sand pre-heated for at least 30 minutes at the reaction temperature in a drying oven. After the planned reaction time, the vials were transferred into ice water. After cooling to room temperature, sensory analysis was performed.

### Experiment 2. MRPs Heated without RU90 or GRU90

The reaction partners (5 mg of amino acid, 10 mg of reducing sugar) were dissolved/suspended in 225 μl of reaction solvent. The prepared samples were transferred into a glass beaker filled with sand pre-heated for at least 30 minutes at the reaction temperature in a drying oven. After the planned reaction time, the vials were transferred into ice water. After cooling to room temperature, the samples were blended with 50 mg of RU90 or GRU90 and a sensory analysis was performed.

TABLE 96-1
Sensory evaluation of MRPs formed from amino and sugar donors
in combination with RU90 or GRU90 (Experiment 1).

| MR reaction contents | Color | Odor |
|---|---|---|
| 5 mg Ala + 10 mg Fru | Colorless | Slight fruity |
| 5 mg Ala + 10 mg | Colorless | Enhanced fruity with honey |
| Fru + 50 mg RU90 | | notes, pleasant |
| 5 mg Ala + 10 mg | Colorless | Fruity with honey notes, |
| Fru + 50 mg GRU90 | | slight oily |
| 5 mg Leu + 10 mg Fru | Colorless | Neutral |
| 5 mg Leu + 10 mg | Colorless | Enhanced fruity, energy |
| Fru + 50 mg RU90 | | drink -like, very pleasant |
| 5 mg Leu + 10 mg | Colorless | Fruity, slight oily |
| Fru + 50 mg GRU90 | | |
| 5 mg Tyr + 10 mg Fru | Colorless, | Neutral |
| | white | |
| | precipitation | |
| 5 mg Tyr + 10 mg | Colorless, | Slight fruity |
| Fru + 50 mg RU90 | white | |
| | precipitation | |
| 5 mg Tyr + 10 mg | Colorless, | Slight fruity |
| Fru + 50 mg GRU90 | white | |
| | precipitation | |
| 5 mg Phe + 10 mg Fru | Light yellow | Honey |
| 5 mg Phe + 10 mg | Light yellow | Sweet, honey, intensive, |
| Fru + 50 mg RU90 | | with flowery notes |
| 5 mg Phe + 10 mg | Light yellow | Sweet, honey, less intensive, |
| Fru + 50 mg GRU90 | | with flowery notes |
| 5 mg Gly + 10 mg Fru | Colorless, | Sweetish, slight honey |
| | white | |
| | precipitation | |
| 5 mg Gly + 10 mg | Light yellow | Sweetish, fresh, lotus |
| Fru + 50 mg RU90 | | |
| 5 mg Gly + 10 mg | Light yellow | Sweet, honey |
| Fru + 50 mg GRU90 | | |
| 5 mg Val + 10 mg Fru | Colorless | Neutral |
| 5 mg Val + 10 mg | Colorless | Slight honey |
| Fru + 50 mg RU90 | | |
| 5 mg Val + 10 mg | Colorless | Herbal honey |
| Fru + 50 mg GRU90 | | |
| 5 mg Lys + 10 mg Fru | Brown | Buttery, caramel-like, cookie |
| 5 mg Lys + 10 mg | Brown | Buttery, caramel-like, cookie |
| Fru + 50 mg RU90 | | |
| 5 mg Lys + 10 mg | Brown | Buttery, caramel-like, cookie |
| Fru + 50 mg GRU90 | | |
| 5 mg Pro + 10 mg Fru | Light yellow | Neutral |
| 5 mg Pro + 10 mg | Light yellow | Popcorn |
| Fru + 50 mg RU90 | | |
| 5 mg Pro + 10 mg | Light yellow | Popcorn |
| Fru + 50 mg GRU90 | | |
| 5 mg Asp + 10 mg Fru | Light yellow | Sweet, fruity |
| 5 mg Asp + 10 mg | Light yellow | Sulfuric |
| Fru + 50 mg RU90 | | |
| 5 mg Asp + 10 mg | Light yellow | Nutty |
| Fru + 50 mg GRU90 | | |
| 5 mg Thr + 10 mg Fru | Colorless | Neutral |
| 5 mg Thr + 10 mg | Colorless | Neutral |
| Fru + 50 mg RU90 | | |
| 5 mg Thr + 10 mg | Colorless | Neutral, sweetish |
| Fru + 50 mg GRU90 | | |
| 5 mg Arg + 10 mg Fru | Brown | Sweetish, caramel-like |
| 5 mg Arg + 10 mg | Brown | Sweet, herbal honey, pleasant |
| Fru + 50 mg RU90 | | |
| 5 mg Arg + 10 mg | Brown | Sweet, cotton candy, pleasant |
| Fru + 50 mg GRU90 | | |

Conclusion: Combining STC, STE, GSTC and/or GSTE together with different sugar donors and amine donors in a Maillard reaction (MR) generates a variety of interesting flavors which can be used in consumable products, including foods beverages.

TABLE 96-2
Sensory evaluation of MRPs supplemented with
RU90 or GRU90 after the MR (Experiment 2).

| MR reaction | Added after MR | | |
|---|---|---|---|
| contents | (100 ppm) | Color | Odor |
| 5 mg Ala + | +50 mg RU90 | Colorless | Slight fruity |
| 10 mg Fru | | | |
| 5 mg Ala + | +50 mg GRU90 | Colorless | Slight fruity |
| 10 mg Fru | | | |
| 5 mg Leu + | +50 mg RU90 | Colorless | Sweetish, slight fruity |
| 10 mg Fru | | | |
| 5 mg Leu + | +50 mg GRU90 | Colorless | Sweetish, slight fruity |
| 10 mg Fru | | | |
| 5 mg Tyr + | +50 mg RU90 | Colorless | Neutral |
| 10 mg Fru | | | |
| 5 mg Tyr + | +50 mg GRU90 | Colorless | Neutral |
| 10 mg Fru | | | |
| 5 mg Phe + | +50 mg RU90 | Colorless | Fruity, less intensive |
| 10 mg Fru | | | |
| 5 mg Phe + | +50 mg GRU90 | Colorless | Herbal honey, less intensive |
| 10 mg Fru | | | |
| 5 mg Gly + | +50 mg RU90 | Colorless | Sweetish, fresh, lotus, |
| 10 mg Fru | | | less intensive |
| 5 mg Gly + | +50 mg GRU90 | Colorless | Sweetish, honey-like, |
| 10 mg Fru | | | less intensive |
| 5 mg Val + | +50 mg RU90 | Colorless | Neutral, slightly sweet |
| 10 mg Fru | | | |
| 5 mg Val + | +50 mg GRU90 | Colorless | Neutral, slightly sweet |
| 10 mg Fru | | | |
| 5 mg Lys + | +50 mg RU90 | Brown | Sweet, caramel-like |
| 10 mg Fru | | | |
| 5 mg Lys + | +50 mg GRU90 | Brown | Sweet, caramel-like |
| 10 mg Fru | | | |
| 5 mg Pro + | +50 mg RU90 | Colorless | Popcorn |
| 10 mg Fru | | | |
| 5 mg Pro + | +50 mg GRU90 | Colorless | Popcorn |
| 10 mg Fru | | | |
| 5 mg Asp + | +50 mg RU90 | Colorless | Sweet, honey |
| 10 mg Fru | | | |
| 5 mg Asp + | +50 mg GRU90 | Colorless | Sweet, honey |
| 10 mg Fru | | | |
| 5 mg Thr + | +50 mg RU90 | Colorless | Herbal |
| 10 mg Fru | | | |
| 5 mg Thr + | +50 mg GRU90 | Colorless | Herbal |
| 10 mg Fru | | | |
| 5 mg Arg + | +50 mg RU90 | Brown | Caramel-like, less intensive |
| 10 mg Fru | | | |
| 5 mg Arg + | +50 mg GRU90 | Brown | Caramel-like, less intensive |
| 10 mg Fru | | | |

Conclusion: Blending standard MRPs formed from different sugar and amine donors with STC, STE, GSTC and/or GSTE generates a variety of interesting flavors and/or sweeteners which can be used in consumable products, including food and beverage products.

Application 1. Taste Modification of Lemonade

Lemonade source: 100% Lemon juice from concentrate, 20.04.2021 23:32/4A1, Rauch Fruchtsäfte GmbH

Test design: Non-commercial lemonade made from lemon juice concentrate (ratio 1:5, blended with deionized water) and sweetened with 5% of sugar was selected to perform a flavor perception test of prepared MRPs. 100 ppm of each MRP was added to each test sample, unless otherwise noted. The samples were tasted and subjected to sensory evaluations, the results of which are described in Table 96-3.

TABLE 96-3
Sensory evaluation of lemonade modified with MRPs formed from amino
acids and sugars in combination with RU90 or GRU90 (Experiment 1).

| No. | MR reaction contents | Sensory evaluation |
|---|---|---|
| 1 | Control (without added | Odor: Lemon, acidic, not very intensive |
| | MRPs) | Taste: Lack of sweetness, very acidic, watery |
| | | mouth-feeling |
| 2 | 5 mg Ala + 10 mg Fru | Odor: Lemon, acidic, not very intensive |
| | | Taste: Slightly sweeter than control, less acidic |
| 3 | 5 mg Ala + 10 mg Fru + | Odor: Fresher, enhanced Lemon |
| | 50 mg RU90 | Taste: Sweeter than control, less acidic, |
| | | enhanced mouth-feeling, smoother and fresher |
| | | taste |
| 4 | 5 mg Ala + 10 mg Fru + | Odor: Fresher, enhanced Lemon flavor |
| | 50 mg GRU90 | Taste: Sweeter than control, less acidic, |
| | | enhanced mouth-feeling, smoother and fresher |
| | | taste |
| 5 | 5 mg Leu + 10 mg Fru | Odor: Lemon, acidic, not very intensive |
| | | Taste: Slightly sweeter than control, less |
| | | acidic, still some watery mouth-feeling |
| 6 | 5 mg Leu + 10 mg Fru + | Odor: Fresher, enhanced Lemon |
| | 50 mg RU90 | Taste: Sweeter than control, less acidic, |
| | | enhanced mouth-feeling, smoother and fresher |
| | | taste |
| 7 | 5 mg Leu + 10 mg Fru + | Odor: Fresher, enhanced Lemon flavor |
| | 50 mg GRU90 | Taste: Sweeter than control, less acidic, |
| | | enhanced mouth-feeling, smoother and fresher |
| | | taste |
| 8 | 5 mg Tyr + 10 mg Fru | Odor: Lemon, acidic, not very intensive |
| | | Taste: Same sweet as control, less acidic, |
| | | still some watery mouth-feeling |
| 9 | 5 mg Tyr + 10 mg Fru + | Odor: Fresher, enhanced Lemon |
| | 50 mg RU90 | Taste: Sweeter than control, less acidic, |
| | | enhanced mouth-feeling, smoother and fresher |
| | | taste |
| 10 | 5 mg Tyr + 10 mg Fru + | Odor: Fresher, enhanced Lemon flavor |
| | 50 mg GRU90 | Taste: Sweeter than control, less acidic, |
| | | enhanced mouth-feeling, smoother and fresher |
| | | taste |
| 11 | 5 mg Phe + 10 mg Fru | Odor: Lemon, acidic, not very intensive |
| | | Taste: Slightly sweeter than control, less |
| | | acidic, slightly better mouth-feeling |
| 12 | 5 mg Phe + 10 mg Fru + | Odor: Fresher, enhanced Lemon |
| | 50 mg RU90 | Taste: Sweeter than control, less acidic, |
| | | enhanced mouth-feeling, smoother and fresher |
| | | taste |
| 13 | 5 mg Phe + 10 mg Fru + | Odor: Fresher, enhanced Lemon flavor |
| | 50 mg GRU90 | Taste: Sweeter than control, less acidic, |
| | | enhanced mouth-feeling, smoother and fresher |
| | | taste |
| 14 | 5 mg Gly + 10 mg Fru | Odor: Lemon, acidic, not very intensive |
| | | Taste: Slightly sweeter than control, less |
| | | acidic, slightly better mouth-feeling |
| 15 | 5 mg Gly + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 16 | 5 mg Gly + 10 mg | Odor: Fresher, enhanced Lemon flavor |
| | Fru + 50 mg GRU90 | Taste: Sweeter than control, less acidic, |
| | | enhanced mouth-feeling, smoother and fresher |
| | | taste |
| 17 | 5 mg Val + 10 mg Fru | Odor: Lemon, acidic, not very intensive |
| | | Taste: Same sweet as control, less acidic, |
| | | still some watery mouth-feeling |
| 18 | 5 mg Val + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 19 | 5 mg Val + 10 mg | Odor: Fresher, enhanced Lemon flavor |
| | Fru 50 mg GRU90 | Taste: Sweeter than control, less acidic, |
| | | enhanced mouth-feeling, smoother and fresher |
| | | taste |
| 20 | 5 mg Lys + 10 mg Fru | Odor: Lemon, acidic, not very intensive |
| | | Taste: Slightly sweeter than control, less |
| | | acidic, slightly better mouth-feeling |
| 21 | 5 mg Lys + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 22 | 5 mg Lys + 10 mg | Odor: Fresher, enhanced Lemon flavor |
| | Fru + 50 mg GRU90 | Taste: Sweeter than control, less acidic, |
| | | enhanced mouth-feeling, smoother and fresher |
| | | taste |
| 23 | 5 mg Pro + 10 mg Fru | Odor: Lemon, acidic, not very intensive |
| | | Taste: Slightly sweeter than control, less |
| | | acidic, slightly better mouth-feeling |
| 24 | 5 mg Pro + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 25 | 5 mg Pro + 10 mg | Odor: Fresher, enhanced Lemon flavor |
| | Fru + 50 mg GRU90 | Taste: Sweeter than control, less acidic, |
| | | enhanced mouth-feeling, smoother and fresher |
| | | taste |
| 26 | 5 mg Asp + 10 mg Fru | Odor: Lemon, acidic, not very intensive |
| | | Taste: Slightly sweeter than control, less |
| | | acidic, slightly better mouth-feeling |
| 27 | 5 mg Asp + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 28 | 5 mg Asp + 10 mg | Odor: Fresher, enhanced Lemon flavor |
| | Fru + 50 mg GRU90 | Taste: Sweeter than control, less acidic, |
| | | enhanced mouth-feeling, smoother and fresher |
| | | taste |
| 29 | 5 mg Arg + 10 mg Fru | Odor: Lemon, acidic, not very intensive |
| | | Taste: Slightly sweeter than control, less |
| | | acidic, slightly better mouth-feeling |
| 30 | 5 mg Arg + 10 mg | Odor: Fresher, enhanced Lemon |
| | Fru + 50 mg RU90 | Taste: Sweeter than control, less acidic, |
| | | enhanced mouth-feeling, smoother and fresher |
| | | taste |
| 31 | 5 mg Arg + 10 mg | Odor: Fresher, enhanced Lemon flavor |
| | Fru + 50 mg GRU90 | Taste: Sweeter than control, less acidic, |
| | | enhanced mouth-feeling, smoother and fresher |
| | | taste |

Conclusion: When combined with lemonade, ST-MRPs enhance the flavor, improve the sweetness, reduce the acidity, enhance the mouthfeel, and increase the recognition of sweetness and flavor quicker.

TABLE 96-4
Sensory evaluation of lemonade separately combined with
standard MRPs and either RU90 or GRU90 (Experiment 2).

| | MR reaction | Added after MR | |
|---|---|---|---|
| No. | contents | (100 ppm) | Sensory evaluation |
| 1 | 5 mg Ala + | +50 mg RU90 | Odor: Fresher, enhanced Lemon flavor |
| | 10 mg Fru | | Taste: Less sweet than sample 3 from |
| | | | experiment 1, but still pleasant fresh |
| | | | and smooth mouth-feeling |
| 2 | 5 mg Ala + | +50 mg GRU90 | Odor: Fresher, enhanced Lemon flavor |
| | 10 mg Fru | | Taste: Less sweet than sample 4 from |
| | | | experiment 1, but still pleasant fresh |
| | | | and smooth mouth-feeling |
| 3 | 5 mg Leu + | +50 mg RU90 | Odor: Fresher, enhanced Lemon flavor |
| | 10 mg Fru | | Taste: Less sweet than sample 6 from |
| | | | experiment 1, but still pleasant, fresh |
| | | | and smooth mouth-feeling |
| 4 | 5 mg Leu + | +50 mg GRU90 | Odor: Fresher, enhanced Lemon flavor |
| | 10 mg Fru | | Taste: Less sweet than sample 7 from |
| | | | experiment 1, but still pleasant fresh |
| | | | and smooth mouth-feeling |
| 5 | 5 mg Tyr + | +50 mg RU90 | Odor: Fresher, enhanced Lemon flavor |
| | 10 mg Fru | | Taste: Less sweet than sample 9 from |
| | | | experiment 1, but still pleasant fresh |
| | | | and smooth mouth-feeling |
| 6 | 5 mg Tyr + | +50 mg GRU90 | Odor: Fresher, enhanced Lemon flavor |
| | 10 mg Fru | | Taste: Less sweet than sample 10 from |
| | | | experiment 1, but still pleasant fresh |
| | | | and smooth mouth-feeling |
| 7 | 5 mg Phe + | +50 mg RU90 | Odor: Fresher, enhanced Lemon flavor |
| | 10 mg Fru | | Taste: Less sweet than sample 12 from |
| | | | experiment 1, but still pleasant, fresh |
| | | | and smooth mouth-feeling |
| 8 | 5 mg Phe + | +50 mg GRU90 | Odor: Fresher, enhanced Lemon flavor |
| | 10 mg Fru | | Taste: Less sweet than sample 13 from |
| | | | experiment 1, but still pleasant fresh |
| | | | and smooth mouth-feeling |
| 9 | 5 mg Gly + | +50 mg RU90 | Odor: Fresher, enhanced Lemon flavor |
| | 10 mg Fru | | Taste: Less sweet than sample 15 from |
| | | | experiment 1, but still pleasant fresh |
| | | | and smooth mouth-feeling |
| 10 | 5 mg Gly + | +50 mg GRU90 | Odor: Fresher, enhanced Lemon flavor |
| | 10 mg Fru | | Taste: Less sweet than sample 16 from |
| | | | experiment 1, but still pleasant fresh |
| | | | and smooth mouth-feeling |
| 11 | 5 mg Val + | +50 mg RU90 | Odor: Fresher, enhanced Lemon flavor |
| | 10 mg Fru | | Taste: Less sweet than sample 18 from |
| | | | experiment 1, but still pleasant, fresh |
| | | | and smooth mouth-feeling |
| 12 | 5 mg Val + | +50 mg GRU90 | Odor: Fresher, enhanced Lemon flavor |
| | 10 mg Fru | | Taste: Less sweet than sample 19 from |
| | | | experiment 1, but still pleasant fresh |
| | | | and smooth mouth-feeling |
| 13 | 5 mg Lys + | +50 mg RU90 | Odor: Fresher, enhanced Lemon flavor |
| | 10 mg Fru | | Taste: Less sweet than sample 21 from |
| | | | experiment 1, but still pleasant fresh |
| | | | and smooth mouth-feeling |
| 14 | 5 mg Lys + | +50 mg GRU90 | Odor: Fresher, enhanced Lemon flavor |
| | 10 mg Fru | | Taste: Less sweet than sample 22 from |
| | | | experiment 1, but still pleasant fresh |
| | | | and smooth mouth-feeling |
| 15 | 5 mg Pro + | +50 mg RU90 | Odor: Fresher, enhanced Lemon flavor |
| | 10 mg Fru | | Taste: Less sweet than sample 24 from |
| | | | experiment 1, but still pleasant, fresh |
| | | | and smooth mouth-feeling |
| 16 | 5 mg Pro + | +50 mg GRU90 | Odor: Fresher, enhanced Lemon flavor |
| | 10 mg Fru | | Taste: Less sweet than sample 25 from |
| | | | experiment 1, but still pleasant fresh |
| | | | and smooth mouth-feeling |
| 17 | 5 mg Asp + | +50 mg RU90 | Odor: Fresher, enhanced Lemon flavor |
| | 10 mg Fru | | Taste: Less sweet than sample 27 from |
| | | | experiment 1, but still pleasant fresh |
| | | | and smooth mouth-feeling |
| 18 | 5 mg Asp + | +50 mg GRU90 | Odor: Fresher, enhanced Lemon flavor |
| | 10 mg Fru | | Taste: Less sweet than sample 28 from |
| | | | experiment 1, but still pleasant fresh |
| | | | and smooth mouth-feeling |
| 19 | 5 mg Arg + | +50 mg RU90 | Odor: Fresher, enhanced Lemon flavor |
| | 10 mg Fru | | Taste: Less sweet than sample 30 from |
| | | | experiment 1, but still pleasant, fresh |
| | | | and smooth mouth-feeling |
| 20 | 5 mg Arg + | +50 mg GRU90 | Odor: Fresher, enhanced Lemon flavor |
| | 10 mg Fru | | Taste: Less sweet than sample 31 from |
| | | | experiment 1, |
| | | | but still pleasant fresh and smooth |
| | | | mouth-feeling |

Conclusion: Combing standard MRPs formed from sugar and amine donors together with STC, STE, GSTC and/or GSTE enhances the flavor intensity, improves the sweetness and mouthfeel, and freshness of flavor of lemonade.

Application 2. Taste Modification of Low Fat Yogurt Drink

Yogurt drink: Yogurt drink with apple-carrot juice, 0.1% fat, 54 16204:04 03.08.2020.

Test design: A commercial yogurt drink made from skim milk with apple-carrot juice (Brand: Nom, fat content 0.1%, without added sugar, sweetened with sucralose, Ace-K) was selected to perform a flavor perception test of prepared MRPs. 100 ppm of each MRP was added to the test samples. The samples were tasted and sensory evaluated.

TABLE 96-5
Sensory evaluation of yogurt drink modified with MRPs formed from amino
acids and sugars in combination with RU90 or GRU90 (Experiment 1).

| No. | MR reaction contents | Sensory evaluation |
|---|---|---|
| 1 | Control (without added | Odor: Milky, apple-carrot flavor |
| | MRPs) | Taste: Not enough sweet, sour, watery mouth- |
| | | feeling artificial aftertaste, |
| 2 | 5 mg Ala + 10 mg Fru | Odor: Milky, apple-carrot flavor |
| | | Taste: Slightly sweeter than control, less artificial |
| | | aftertaste, still some watery mouth-feeling |
| 3 | 5 mg Ala + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 4 | 5 mg Ala + 10 mg | Odor: Enhanced apple-carrot flavor |
| | Fru 50 mg GRU90 | Taste: Sweeter than control, pleasant sweet, no |
| | | artificial aftertaste, well-balanced apple-carrot |
| | | flavor, enhanced mouth-feeling |
| 5 | 5 mg Leu + 10 mg Fru | Odor: Milky, apple-carrot flavor |
| | | Taste: Slightly sweeter than control, less artificial |
| | | aftertaste, still some watery mouth-feeling |
| 6 | 5 mg Leu + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 7 | 5 mg Leu + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 8 | 5 mg Tyr + 10 mg Fru | Odor: Milky, apple-carrot flavor |
| | | Taste: Same sweet as control, less artificial |
| | | aftertaste, still some watery mouth-feeling |
| 9 | 5 mg Tyr + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 10 | 5 mg Tyr + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 11 | 5 mg Phe + 10 mg Fru | Odor: Milky, apple-carrot flavor |
| | | Taste: Slightly sweeter than control, less artificial |
| | | aftertaste, still some watery mouth-feeling |
| 12 | 5 mg Phe + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 13 | 5 mg Phe + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 14 | 5 mg Gly + 10 mg Fru | Odor: Milky, apple-carrot flavor |
| | | Taste: Slightly sweeter than control, less artificial |
| | | aftertaste, still some watery mouth-feeling |
| 15 | 5 mg Gly + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 16 | 5 mg Gly + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 17 | 5 mg Val + 10 mg Fru | Odor: Milky, apple-carrot flavor |
| | | Taste: Same sweet as control, less artificial |
| | | aftertaste, still some watery mouth-feeling |
| 18 | 5 mg Val + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 19 | 5 mg Val + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 20 | 5 mg Lys + 10 mg Fru | Odor: Milky, apple-carrot flavor |
| | | Taste: Slightly sweeter than control, less artificial |
| | | aftertaste, still some watery mouth-feeling |
| 21 | 5 mg Lys + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 22 | 5 mg Lys + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 23 | 5 mg Pro + 10 mg Fru | Odor: Milky, apple-carrot flavor |
| | | Taste: Slightly sweeter than control, less artificial |
| | | aftertaste, still some watery mouth-feeling |
| 24 | 5 mg Pro + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 25 | 5 mg Pro + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 26 | 5 mg Asp + 10 mg Fru | Odor: Milky, apple-carrot flavor |
| | | Taste: Slightly sweeter than control, less artificial |
| | | aftertaste, still some watery mouth-feeling |
| 27 | 5 mg Asp + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 28 | 5 mg Asp + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |
| 29 | 5 mg Arg + 10 mg Fru | Odor: Milky, apple-carrot flavor |
| | | Taste: Slightly sweeter than control, less artificial |
| | | aftertaste, still some watery mouth-feeling |
| 30 | 5 mg Arg + 10 mg | Odor: Enhanced apple-carrot flavor |
| | Fru + 50 mg RU90 | Taste: Sweeter than control, pleasant sweet, no |
| | | artificial aftertaste, well-balanced apple-carrot |
| | | flavor, enhanced mouth-feeling |
| 31 | 5 mg Arg + 10 mg | Odor: Enhanced apple-carrot flavor |
| | Fru + 50 mg GRU90 | Taste: Sweeter than control, pleasant sweet, no |
| | | artificial aftertaste, well-balanced apple-carrot |
| | | flavor, enhanced mouth-feeling |

Conclusion: ST-MRPs could enhance the flavor, improve the sweetness, reduce the aftertaste such as artificial taste, and enhance the mouthfeel in commercial beverage products.

TABLE 96.6
Sensory evaluation of yogurt drink modified with standard
MRPs and either RU90 or GRU90 (Experiment 2).

| | MR reaction | Added after MR | |
|---|---|---|---|
| No. | contents | (100 ppm) | Sensory evaluation |
| 1 | 5 mg Ala + | +50 mg RU90 | Odor: Enhanced apple-carrot flavor |
| | 10 mg Fru | | Taste: Enhanced sweetness, but less sweet than |
| | | | sample 3 from experiment 1, better mouth- |
| | | | feeling compared to control, well-balanced |
| | | | apple-carrot flavor |
| 2 | 5 mg Ala + | +50 mg GRU90 | Odor: Enhanced apple-carrot flavor |
| | 10 mg Fru | | Taste: Enhanced sweetness, but less sweet than |
| | | | sample 4 from experiment 1, better mouth- |
| | | | feeling compared to control, well-balanced |
| | | | apple-carrot flavor |
| 3 | 5 mg Leu + | +50 mg RU90 | Odor: Enhanced apple-carrot flavor |
| | 10 mg Fru | | Taste: Enhanced sweetness, but less sweet than |
| | | | sample 6 from experiment 1, better mouth- |
| | | | feeling compared to control, well-balanced |
| | | | apple-carrot flavor |
| 4 | 5 mg Leu + | +50 mg GRU90 | Odor: Enhanced apple-carrot flavor |
| | 10 mg Fru | | Taste: Enhanced sweetness, but less sweet than |
| | | | sample 7 from experiment 1, better mouth- |
| | | | feeling compared to control, well-balanced |
| | | | apple-carrot flavor |
| 5 | 5 mg Tyr + | +50 mg RU90 | Odor: Enhanced apple-carrot flavor |
| | 10 mg Fru | | Taste: Enhanced sweetness, but less sweet than |
| | | | sample 9 from experiment 1, better mouth- |
| | | | feeling compared to control, well-balanced |
| | | | apple-carrot flavor |
| 6 | 5 mg Tyr + | +50 mg GRU90 | Odor: Enhanced apple-carrot flavor |
| | 10 mg Fru | | Taste: Enhanced sweetness, but less sweet than |
| | | | sample 10 from experiment 1, better mouth- |
| | | | feeling compared to control, well-balanced |
| | | | apple-carrot flavor |
| 7 | 5 mg Phe + | +50 mg RU90 | Odor: Enhanced apple-carrot flavor |
| | 10 mg Fru | | Taste: Enhanced sweetness, but less sweet than |
| | | | sample 12 from experiment 1, better mouth- |
| | | | feeling compared to control, well-balanced |
| | | | apple-carrot flavor |
| 8 | 5 mg Phe + | +50 mg GRU90 | Odor: Enhanced apple-carrot flavor |
| | 10 mg Fru | | Taste: Enhanced sweetness, but less sweet than |
| | | | sample 13 from experiment 1, better mouth- |
| | | | feeling compared to control, well-balanced |
| | | | apple-carrot flavor |
| 9 | 5 mg Gly + | +50 mg RU90 | Odor: Enhanced apple-carrot flavor |
| | 10 mg Fru | | Taste: Enhanced sweetness, but less sweet than |
| | | | sample 15 from experiment 1, better mouth- |
| | | | feeling compared to control, well-balanced |
| | | | apple-carrot flavor |
| 10 | 5 mg Gly + | +50 mg GRU90 | Odor: Enhanced apple-carrot flavor |
| | 10 mg Fru | | Taste: Enhanced sweetness, but less sweet than |
| | | | sample 16 from experiment 1, better mouth- |
| | | | feeling compared to control, well-balanced |
| | | | apple-carrot flavor |
| 11 | 5 mg Val + | +50 mg RU90 | Odor: Enhanced apple-carrot flavor |
| | 10 mg Fru | | Taste: Enhanced sweetness, but less sweet than |
| | | | sample 18 from experiment 1, better mouth- |
| | | | feeling compared to control, well-balanced |
| | | | apple-carrot flavor |
| 12 | 5 mg Val + | +50 mg GRU90 | Odor: Enhanced apple-carrot flavor |
| | 10 mg Fru | | Taste: Enhanced sweetness, but less sweet than |
| | | | sample 19 from experiment 1, better mouth- |
| | | | feeling compared to control, well-balanced |
| | | | apple-carrot flavor |
| 13 | 5 mg Lys + | +50 mg RU90 | Odor: Enhanced apple-carrot flavor |
| | 10 mg Fru | | Taste: Enhanced sweetness, but less sweet than |
| | | | sample 21 from experiment 1, better mouth- |
| | | | feeling compared to control, well-balanced |
| | | | apple-carrot flavor |
| 14 | 5 mg Lys + | +50 mg GRU90 | Odor: Enhanced apple-carrot flavor |
| | 10 mg Fru | | Taste: Enhanced sweetness, but less sweet than |
| | | | sample 22 from experiment 1, better mouth- |
| | | | feeling compared to control, well-balanced |
| | | | apple-carrot flavor |
| 15 | 5 mg Pro + | +50 mg RU90 | Odor: Enhanced apple-carrot flavor |
| | 10 mg Fru | | Taste: Enhanced sweetness, but less sweet than |
| | | | sample 24 from experiment 1, better mouth- |
| | | | feeling compared to control, well-balanced |
| | | | apple-carrot flavor |
| 16 | 5 mg Pro + | +50 mg GRU90 | Odor: Enhanced apple-carrot flavor |
| | 10 mg Fru | | Taste: Enhanced sweetness, but less sweet than |
| | | | sample 25 from experiment 1, better mouth- |
| | | | feeling compared to control, well-balanced |
| | | | apple-carrot flavor |
| 17 | 5 mg Asp + | +50 mg RU90 | Odor: Enhanced apple-carrot flavor |
| | 10 mg Fru | | Taste: Enhanced sweetness, but less sweet than |
| | | | sample 27 from experiment 1, better mouth- |
| | | | feeling compared to control, well-balanced |
| | | | apple-carrot flavor |
| 18 | 5 mg Asp + | +50 mg GRU90 | Odor: Enhanced apple-carrot flavor |
| | 10 mg Fru | | Taste: Enhanced sweetness, but less sweet than |
| | | | sample 28 from experiment 1, better mouth- |
| | | | feeling compared to control, well-balanced |
| | | | apple-carrot flavor |
| 19 | 5 mg Arg + | +50 mg RU90 | Odor: Enhanced apple-carrot flavor |
| | 10 mg Fru | | Taste: Enhanced sweetness, but less sweet than |
| | | | sample 30 from experiment 1, better mouth- |
| | | | feeling compared to control, well-balanced |
| | | | apple-carrot flavor |
| 20 | 5 mg Arg + | +50 mg GRU90 | Odor: Enhanced apple-carrot flavor |
| | 10 mg Fru | | Taste: Enhanced sweetness, but less sweet than |
| | | | sample 31 from experiment 1, better mouth- |
| | | | feeling compared to control, well-balanced |
| | | | apple-carrot flavor |

Conclusion: Combining standard MRPs formed from different sugar and amine donors together with STC, STE, GSTC and/or GSTE can enhance flavor, increase sweetness, and improve the mouthfeel of commercial beverage products.

### Example 97. Taste Improvement of Vegan Burgers Using GSG-MRP-CA and GSG-MRP-PC

Materials:

GSG-MRP-CA, Part Number 14041-01, Lot #20190801, EPC

GSG-MRP-PC, Part Number 14041-03, Lot #20190703, EPC

Vegan burger, Garden Gourmet “Sensational burger”, L01886702, 26.07.2020, Garden Gourmet, Tivall Deutschland GmbH

Test design: A commercial vegan burger based on soy protein and wheat protein (raw, thawed) (226 g pack, Brand: Garden Gourmet) was selected to perform a taste improvement test using GSG-MRP-CA and GSG-MRP-PC. 25, 50, 100, 150 and 200 ppm GSG-MRP-CA or GSG-MRP-PC were added to each test sample. Then the samples were tasted and subjected to sensory evaluations, the results of which are described in Table 97-1.

TABLE 97-1
Vegan burger/GSG-MRP-PC sensory evaluation.

| Concentration of | | | |
|---|---|---|---|
| GSG-MRP-PC | Consistency/Appearance | Odor/Flavor | Taste/Mouth-feeling |
| 0 ppm | Raw: smooth, moist, | Spicy, smoked | Spicy, slightly meaty- |
| | elastic, meaty-like | | like, dry mouth- |
| | Prepared: smooth, meaty- | | feeling |
| | like | | |
| 25 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling |
| 50 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling |
| 100 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling, |
| | | | slightly sweet |
| 150 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, very sweet |
| | like | | |
| 200 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, very sweet |
| | like | | |

The samples with 25 and 50 ppm of GSG-MRP-PC represent the favored samples preferably due to a balanced spicy flavor, enhanced natural meaty-like taste and substantially better mouth-feeling.

TABLE 97-2
Vegan burger/GSG-MRP-CA Sensory Evaluation

| Concentration of | | | |
|---|---|---|---|
| GSG-MRP-CA | Consistency/Appearance | Odor/Flavor | Taste/Mouth-feeling |
| 0 ppm | Raw: smooth, moist, | Spicy, smoked | Spicy, slightly meaty- |
| | elastic, meaty-like | | like, dry mouth- |
| | Prepared: smooth, meaty- | | feeling |
| | like | | |
| 25 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling |
| 50 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling |
| 100 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, improved |
| | like | | mouth-feeling, |
| | | | slightly sweet |
| 150 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, very sweet |
| | like | | |
| 200 ppm | Raw: smooth, moist, | Enhanced spicy, | Enhanced spicy, |
| | elastic, meaty-like | smoked, | enhanced meaty-like |
| | Prepared: smooth, meaty- | flavorful | taste, very sweet |
| | like | | |

The samples with 25 and 50 ppm of GSG-MRP-CA represent preferred samples due to a balanced spicy flavor, enhanced natural meaty-like taste and substantially better mouth-feeling.

### Example 98. Stevia Glycoside Contents in Compositions Enriched in Rubusosides by Hydrolysis of Stevia Glycosides Rich in Stevioside

Materials: Lot numbers: EPC-308-50-03, EPC-311-02-02, EPC-308-76-03

TABLE 98-1

| | | EPC-308-50-03 | EPC-311-02-02 | EPC-308-76-03 |
|---|---|---|---|---|
| Compound (class) | Molar mass | % (m/m) | | |
| Steviol-momoglucoside | 480 | 0.0155 | 0.0220 | 0.0171 |
| Reb-A | 967 | 27.2 | 12.3 | 8.98 |
| Rubusoside | 642 | 61.6 | 73.8 | 81.5 |
| Σ Suaviosides¹ | 788, 658, | 6.68 | 8.96 | 4.76 |
| | 804, 480 | | | |
| | Sum: | 95.5 | 95.1 | 95.2 |

The enriched rubusosides from hydrolysis of stevia glycosides could be further purified to obtain products such as rubusosides above 85%, 90%, 95%, and 99%. All products including rubusosides originated from such method such as 5%, 10%, 20%, 30%, 50%, 60%, 70%, 80%, 90%, 95%, 99% rubusoside could be used as raw material for glycosylation. An embodiment of glycosylated rubusosides by using raw material from hydrolysis of stevioside from stevia glycosides, where the stevioside content is above 5%, 10%, 20%, 30%, 50%, 60%, 70%, 80%, 85%, 90%, 95%, 99%. An embodiment of glycosylated stevia glycosides contain glycosylated rubusosides, where the glycosylated rubusosides are above 1%, 5%, 10%, 20%, 30%, 50%, 70%, 85%, 90%, 95%, 99%. An embodiment of glycosylated stevia glycosides contain glycosylated rubusosides and glycosylated Reb A, where glycosylated Reb A content is less than 99%, 80%, 50%, 30%, 20%, 10%, 5%, 1%. An embodiment of glycosylated stevia glycosides contain glycosylated rubusosides and glycosylated suaviosides, where glycosylated suaviosides is less than 50%, 30%, 10%, 5%, 1%. An embodiment of glycosylated stevia glycosides contain glycosylated rubusosides and glycosylated suaviosides, where glycosylated suaviosides is higher than 1%, 10%, 30%, 50%. An embodiment of glycosylated stevia glycosides contain glycosylated rubusosides, unreacted stevia glycosides selected from one or more of Reb A, stevioside, rubusoside, sauviosides, where unreacted rubusoside is less than 50%, 30%, 20%, 10%, 5%, 1%.

### Example 99. Analytical Investigation of Flavoring Agents (e.g., Essential Oils/Essences Used in Examples 39 and 61)

The testing method used in this example is the same as in Ex. 94.

TABLE 99-1
Headspace GC/MS results for Orange 71025597.

| Peak | R. | | Area | | Height | | |
|---|---|---|---|---|---|---|---|
| # | Time | Area | % | Height | % | Compound | g/l* |
| 1 | 9.03 | 48669201 | 2.1 | 32057619 | 3 | β-Myrcene | 0.230 |
| 2 | 9.37 | 23198541 | 1.0 | 14469726 | 1 | Carveol | 0.110 |
| 3 | 9.94 | 499401309 | 21.2 | 133571608 | 10 | D-limonene | 2.36 |
| 4 | 12.96 | 28192878 | 1.2 | 20955922 | 2 | α-Terpineol | 0.133 |
| 5 | 13.12 | 301555921 | 12.8 | 133484539 | 10 | Decanal | 1.42 |
| 6 | 13.61 | 99151284 | 4.2 | 75811377 | 6 | cis-Verbenol | 0.468 |
| 7 | 14.07 | 180906368 | 7.7 | 122080494 | 10 | Citral | 0.854 |
| 8 | 14.23 | 44093892 | 1.9 | 30023884 | 2 | 1-Cyclohexene-1- | 0.208 |
| | | | | | | carboxaldehyde, 4 | |
| 9 | 14.66 | 47214599 | 2.0 | 36678873 | 3 | Undecanal | 0.223 |
| 10 | 15.71 | 96201091 | 4.1 | 69109129 | 5 | Copaene | 0.454 |
| 11 | 15.88 | 76409659 | 3.2 | 56170396 | 4 | Cyclohexane, | 0.361 |
| 12 | 16.09 | 169152393 | 7.2 | 111660574 | 9 | Dodecanal | 0.799 |
| 13 | 16.34 | 89372558 | 3.8 | 59478876 | 5 | Caryophyllene | 0.422 |
| 14 | 16.46 | 74989145 | 3.2 | 50841759 | 4 | β-copaene | 0.354 |
| 15 | 16.66 | 16636312 | 0.7 | 11740531 | 1 | (E)-β-Farnesene | 0.0785 |
| 16 | 16.71 | 28641048 | 1.2 | 15135646 | 1 | cis-muurola-3,5-diene | 0.135 |
| 17 | 16.82 | 17214369 | 0.7 | 12162150 | 1 | Humulene | 0.0813 |
| 18 | 17.03 | 26316272 | 1.1 | 20030026 | 2 | γ-Muurolene | 0.124 |
| 19 | 17.18 | 15484676 | 0.7 | 10644048 | 1 | Aristolochene | 0.0731 |
| 20 | 17.30 | 279343023 | 11.9 | 132751826 | 10 | Aromandendrene | 1.32 |
| 21 | 17.33 | 75956229 | 3.2 | 46634969 | 4 | α-Guaiene | 0.359 |
| 22 | 17.58 | 85056738 | 3.6 | 63272720 | 5 | Naphthalene, | 0.402 |
| | | | | | | 1,2,4a,5,8,8a- | |
| | | | | | | hexahydro | |
| 23 | 17.64 | 20493237 | 0.9 | 12306004 | 1 | (−)-α-Panasinsen | 0.0967 |
| 24 | 17.77 | 13429978 | 0.6 | 10362940 | 1 | Naphthalene, | 0.0634 |
| | | | | | | 1,2,3,4,4a,7-hexahydro | |
| Sum: | | 2357080721 | 100 | 1281435636 | 100 | | 11.13 |

*expressed as D Limonen

TABLE 99-2
Liquid Injection GC/MS results for Orange 71025597.

| Peak | R. | | Area | | Height | | |
|---|---|---|---|---|---|---|---|
| # | Time | Area | % | Height | % | Compound | g/l* |
| 1 | 9.89 | 185991681 | 4.08 | 124851325 | 5.44 | D-limonene | 14.0 |
| 2 | 12.96 | 36159770 | 0.79 | 27845966 | 1.21 | α-Terpineol | 2.72 |
| 3 | 13.12 | 236667914 | 5.20 | 124526548 | 5.43 | Decanal | 17.8 |
| 4 | 13.39 | 48168920 | 1.06 | 21169285 | 0.92 | 3-Carene | 3.62 |
| 5 | 13.62 | 124325100 | 2.73 | 89334220 | 3.89 | cis-p-Mentha-2,8-dien- | 9.34 |
| | | | | | | 1-ol | |
| 6 | 13.78 | 27354254 | 0.60 | 20181847 | 0.88 | 3-Carene | 2.05 |
| 7 | 14.08 | 234634837 | 5.15 | 123766931 | 5.39 | Citral | 17.6 |
| 8 | 14.11 | 44473154 | 0.98 | 26288700 | 1.15 | 2-Decenal | 3.34 |
| 9 | 14.23 | 53340486 | 1.17 | 39233204 | 1.71 | 1-Cyclohexene-1- | 4.01 |
| | | | | | | carboxaldehyde, 4 | |
| 10 | 14.44 | 50787422 | 1.12 | 35578575 | 1.55 | p-Mentha-1(7),8(10)- | 3.81 |
| | | | | | | dien-9-ol | |
| 11 | 14.66 | 77567337 | 1.70 | 58161711 | 2.53 | Undecanal | 5.83 |
| 12 | 15.23 | 86796401 | 1.91 | 55209676 | 2.41 | Cyclohexanol, 2- | 6.52 |
| | | | | | | methyl-5-(1-methy | |
| 13 | 15.36 | 66748985 | 1.47 | 49645192 | 2.16 | D-limonenee | 5.01 |
| 14 | 15.63 | 69214889 | 1.52 | 49760956 | 2.17 | 3-Carene | 5.20 |
| 15 | 15.71 | 121700773 | 2.67 | 83483767 | 3.64 | Copaene | 9.14 |
| 16 | 15.88 | 236037969 | 5.18 | 112698856 | 4.91 | Cyclohexane, 1-ethenyl- | 17.7 |
| | | | | | | 1-methyl-2, | |
| 17 | 16.11 | 366460120 | 8.05 | 131043788 | 5.71 | cis para meta 1(7), 8- | 27.5 |
| | | | | | | dien-2-ol | |
| 18 | 16.35 | 217591332 | 4.78 | 104181683 | 4.54 | Caryophyllene | 16.3 |
| 19 | 16.47 | 234817383 | 5.16 | 126653559 | 5.52 | beta copaene | 17.6 |
| 20 | 16.67 | 91653298 | 2.01 | 60437474 | 2.63 | cis-β-Farnesene | 6.88 |
| 21 | 16.71 | 61079942 | 1.34 | 31136703 | 1.36 | Cedrene | 4.59 |
| 22 | 16.82 | 61120796 | 1.34 | 41254488 | 1.80 | Humulene | 4.59 |
| 23 | 17.04 | 44842395 | 0.98 | 27881688 | 1.21 | γ-Muurolene | 3.37 |
| 24 | 17.08 | 39337992 | 0.86 | 24226620 | 1.06 | Alloaromadendrene | 2.95 |
| 25 | 17.15 | 150574596 | 3.31 | 95428024 | 4.16 | isoledene | 11.3 |
| 26 | 17.18 | 75870582 | 1.67 | 48046629 | 2.09 | Aristolochene | 5.70 |
| 27 | 17.35 | 729532491 | 16.02 | 130221316 | 5.67 | Eremophila-1(10),11- | 54.8 |
| | | | | | | diene | |
| 28 | 17.42 | 65765634 | 1.44 | 42555562 | 1.85 | 4-Methyl-dodecan-1-ol | 4.94 |
| 29 | 17.59 | 271951867 | 5.97 | 129113001 | 5.63 | Cadina-1(10),4-diene | 20.4 |
| 30 | 17.65 | 107653267 | 2.36 | 57406718 | 2.50 | (−)-α-Panasinsen | 8.08 |
| 31 | 17.95 | 50145613 | 1.10 | 35537245 | 1.55 | α-Panasinsene | 3.77 |
| 32 | 18.34 | 46308411 | 1.02 | 22359620 | 0.97 | gamma muurolene | 3.48 |
| 33 | 18.44 | 102164935 | 2.24 | 56991188 | 2.48 | 2-Naphthaleneethanol, | 7.67 |
| | | | | | | decahydro-4a | |
| 34 | 19.65 | 95318599 | 2.09 | 61908238 | 2.70 | 2,6,11-Dodecatrienal, | 7.16 |
| | | | | | | 2,6-dimethyl- | |
| 35 | 20.27 | 41682989 | 0.92 | 26966174 | 1.17 | 2,6,9,11- | 3.13 |
| | | | | | | Dodecatetraenal, 2,6,10- | |
| | | | | | | trimethyl | |
| Sum: | | 4553842134 | 100 | 2295086477 | 100 | | 342 |

*expressed as average response factor D-limonene, α-Pinene, γ-Terpineol

TABLE 99-3
Headspace GC/MS results for Mandarin 91026464.

| Peak | R. | | Area | | Height | | |
|---|---|---|---|---|---|---|---|
| # | Time | Area | % | Height | % | Compound | g/l* |
| 1 | 6.78 | 729348 | 0.4 | 357132 | 0.3 | 1-Octanol,2-butyl- | 0.765 |
| 2 | 7.49 | 1332716 | 0.7 | 653369 | 0.6 | α-Phellandrene | 1.40 |
| 3 | 7.67 | 5004884 | 2.7 | 2496473 | 2.4 | α-Pinene | 5.25 |
| 4 | 8.76 | 877720 | 0.5 | 525203 | 0.5 | β-Ocimene | 0.921 |
| 5 | 9.04 | 722137 | 0.4 | 489136 | 0.5 | β-Myrcene | 0.758 |
| 6 | 9.37 | 5512021 | 3.0 | 3782041 | 3.6 | Octanal | 5.78 |
| 7 | 9.82 | 1516297 | 0.8 | 821147 | 0.8 | o-Cymene | 1.59 |
| 8 | 9.96 | 133021639 | 71.7 | 69767664 | 66.5 | Limonene | 140 |
| 9 | 10.52 | 14325143 | 7.7 | 10273711 | 9.8 | γ-Terpinene | 15.0 |
| 10 | 11.03 | 473617 | 0.3 | 360725 | 0.3 | Cyclohexene, 1-methyl- | 0.497 |
| | | | | | | 4-(1-me | |
| 11 | 11.30 | 1608355 | 0.9 | 1230139 | 1.2 | 1,6-Octadien-3-ol, 3,7- | 1.69 |
| | | | | | | dimethyl | |
| 12 | 12.22 | 347685 | 0.2 | 277108 | 0.3 | Citronellal | 0.365 |
| 13 | 12.74 | 1664222 | 0.9 | 1193760 | 1.1 | Bicyclo[3.1.0]hexan-2- | 1.75 |
| | | | | | | ol, 2-me | |
| 14 | 12.99 | 7784624 | 4.2 | 5125932 | 4.9 | α-Terpineol | 8.17 |
| 15 | 13.12 | 2018537 | 1.1 | 1524824 | 1.5 | Decanal | 2.12 |
| 16 | 14.25 | 1460829 | 0.8 | 896103 | 0.9 | 1-Cyclohexene-1- | 1.53 |
| | | | | | | carboxaldehy | |
| 17 | 14.28 | 595325 | 0.3 | 573984 | 0.6 | Allylisovalerate | 0.625 |
| 18 | 16.12 | 755032 | 0.4 | 493725 | 0.5 | Benzoic acid, 2- | 0.792 |
| | | | | | | (methylamino)- | |
| 19 | 16.36 | 5127629 | 2.8 | 3766470 | 3.6 | Caryophyllene | 5.38 |
| 20 | 17.35 | 630645 | 0.3 | 384223 | 0.4 | Naphthalene, | 0.662 |
| | | | | | | 1,2,3,4,4a,5,6,8a- | |
| Sum: | | 185508405 | 100 | 104992869 | 100 | | 195 |

*expressed as D-limonene

TABLE 99-4
Liquid Injection GC/MS results for Mandarin 91026464.

| Peak | R. | | Area | | Height | | |
|---|---|---|---|---|---|---|---|
| # | Time | Area | % | Height | % | Compound | g/l* |
| 1 | 9.35 | 5084302 | 0.8 | 2520588 | 0.6 | Octanal | 2.41 |
| 2 | 9.80 | 2257626 | 0.4 | 1393171 | 0.3 | Benzene, 1-methyl-3-(1- | 1.07 |
| | | | | | | methyl) | |
| 3 | 9.90 | 81369937 | 13.2 | 55675637 | 13.7 | D-limonenee | 38.6 |
| 4 | 10.50 | 18913004 | 3.1 | 13631018 | 3.4 | γ-Terpinene | 8.96 |
| 5 | 11.29 | 7720081 | 1.3 | 5353147 | 1.3 | 1,6-Octadien-3-ol, 3,7- | 3.66 |
| | | | | | | diene | |
| 6 | 11.32 | 6408207 | 1.0 | 3661843 | 0.9 | γ-Terpinene | 3.04 |
| 7 | 12.22 | 1311799 | 0.2 | 969535 | 0.2 | Citronellal | 0.621 |
| 8 | 12.74 | 20775694 | 3.4 | 12009648 | 3.0 | Bicyclo[3.1.0]hexan-2- | 9.84 |
| | | | | | | ol | |
| 9 | 12.97 | 152514490 | 24.8 | 99469753 | 24.4 | α-Terpineol | 72.3 |
| 10 | 13.11 | 18510748 | 3.0 | 11250148 | 2.8 | Decanal | 8.77 |
| 11 | 13.42 | 9152509 | 1.5 | 5670509 | 1.4 | Citronellol | 4.34 |
| 12 | 14.25 | 23536015 | 3.8 | 16243356 | 4.0 | 1-Cyclohexene-1- | 11.2 |
| | | | | | | carboxa | |
| 13 | 14.39 | 48958432 | 7.9 | 26850312 | 6.6 | Thymol | 23.2 |
| 14 | 14.45 | 5896345 | 1.0 | 2968362 | 0.7 | p-Mentha-1(7),8(10)- | 2.79 |
| | | | | | | dien | |
| 15 | 15.37 | 4711271 | 0.8 | 2820902 | 0.7 | 3-Carene | 2.23 |
| 16 | 15.64 | 2678542 | 0.4 | 1614733 | 0.4 | β-Myrcene | 1.27 |
| 17 | 15.72 | 5266303 | 0.9 | 3912468 | 1.0 | .alfa.-Copaene | 2.50 |
| 18 | 15.88 | 4511923 | 0.7 | 2421121 | 0.6 | Cyclohexane, 1- | 2.14 |
| | | | | | | ethenyl-1 | |
| 19 | 16.12 | 57035687 | 9.3 | 39418030 | 9.7 | Benzoic acid, 2- | 27.0 |
| | | | | | | (methyla | |
| 20 | 16.35 | 96860662 | 15.7 | 68628013 | 16.9 | Caryophyllene | 45.9 |
| 21 | 16.83 | 3921165 | 0.6 | 2817595 | 0.7 | Humulene | 1.86 |
| 22 | 16.97 | 11579797 | 1.9 | 9392749 | 2.3 | 2,2-Dimethylpropionic | 5.49 |
| | | | | | | acid | |
| 23 | 17.35 | 27357313 | 4.4 | 18521171 | 4.6 | Guaia-1(10),11-diene | 13.0 |
| Sum: | | 616331852 | 100 | 407213809 | 100 | | 292 |

*expressed as average response factor D-limonene, α-Pinene, γ-Terpineol

TABLE 99-5
Headspace GC/MS results for Lemon 71026465.

| Peak | R. | | Area | | Height | | |
|---|---|---|---|---|---|---|---|
| # | Time | Area | % | Height | % | Compound | g/l* |
| 1 | 9.36 | 2584664 | 4.9 | 1726158 | 4.8 | Octanal | 2.72 |
| 2 | 9.81 | 189298 | 0.4 | 122744 | 0.3 | trans-3-Caren-2-ol | 0.199 |
| 3 | 9.91 | 1844443 | 3.5 | 1283403 | 3.6 | Cyclohexene, 1-methyl- | 1.94 |
| | | | | | | 4-(1-meth | |
| 4 | 10.50 | 693991 | 1.3 | 511246 | 1.4 | Cyclohexene, 1-methyl- | 0.729 |
| | | | | | | 3-(1-meth | |
| 5 | 11.31 | 3998634 | 7.5 | 2683355 | 7.4 | 1,6-Octadien-3-ol, 3,7- | 4.20 |
| | | | | | | dimethyl-, | |
| 6 | 11.39 | 4404686 | 8.3 | 3123724 | 8.6 | 2-Nonen-1-ol, (E)- | 4.63 |
| 7 | 12.22 | 742824 | 1.4 | 529401 | 1.5 | Citronellal | 0.780 |
| 8 | 12.74 | 293482 | 0.6 | 201729 | 0.6 | Bergamotol, Z-α-trans- | 0.308 |
| 9 | 12.98 | 3436979 | 6.5 | 2353691 | 6.5 | α-Terpineol | 3.61 |
| 10 | 13.12 | 591109 | 1.1 | 473005 | 1.3 | Decanal | 0.621 |
| 11 | 13.42 | 2721485 | 5.1 | 1927694 | 5.3 | Limonene | 2.86 |
| 12 | 13.66 | 10630314 | 19.9 | 6596107 | 18.3 | 2(1H)-Naphthalenone, | 11.2 |
| | | | | | | 4a,5,8,8a- | |
| 13 | 13.80 | 373806 | 0.7 | 281122 | 0.8 | β-Ocimene | 0.393 |
| 14 | 14.11 | 14023816 | 26.3 | 9427627 | 26.1 | Citral | 14.7 |
| 15 | 14.25 | 244428 | 0.5 | 156873 | 0.4 | 1-Cyclohexene-1- | 0.257 |
| | | | | | | carboxaldehyde | |
| 16 | 14.67 | 218803 | 0.4 | 148383 | 0.4 | Undecanal | 0.230 |
| 17 | 15.37 | 1352792 | 2.5 | 991050 | 2.7 | Limonene | 1.42 |
| 18 | 15.64 | 569623 | 1.1 | 407158 | 1.1 | β-Pinene | 0.598 |
| 19 | 16.35 | 1679588 | 3.2 | 1185123 | 3.3 | Bicyclo[7.2.0]undec-4- | 1.76 |
| | | | | | | ene, 4,11, | |
| 20 | 16.47 | 2714076 | 5.1 | 2013970 | 5.6 | trans-α-Bergamotene | 2.85 |
| Sum: | | 53308841 | 100 | 36143563 | 100 | | 56.0 |

*expressed as D-limonene

TABLE 99-6
Liquid Injection GC/MS results for Lemon 71026465.

| Peak | R. | | Area | | Height | | |
|---|---|---|---|---|---|---|---|
| # | Time | Area | % | Height | % | Compound | g/l* |
| 1 | 9.35 | 5163935 | 0.3 | 2562395 | 0.2 | Octanal | 2.17 |
| 2 | 9.90 | 5041049 | 0.3 | 3135708 | 0.3 | D-limonenee | 2.12 |
| 3 | 10.49 | 3494498 | 0.2 | 2147513 | 0.2 | γ-Terpinene | 1.47 |
| 4 | 11.29 | 76010607 | 4.0 | 52324435 | 4.7 | 1,6-Octadien-3-ol,3,7- | 32.0 |
| | | | | | | dimethyl | |
| 5 | 11.38 | 45688827 | 2.4 | 30603998 | 2.7 | Nonanal | 19.2 |
| 6 | 12.22 | 10966712 | 0.6 | 7029948 | 0.6 | Citronellal | 4.61 |
| 7 | 12.60 | 1942213 | 0.1 | 1626803 | 0.1 | Bicyclo[2.2.1]heptan-2- | 0.82 |
| | | | | | | ol, 1,7, | |
| 8 | 12.73 | 9304593 | 0.5 | 5423891 | 0.5 | Bicyclo[3.1.0]hexan-2- | 3.91 |
| | | | | | | ol, 2-methyl | |
| 9 | 12.97 | 169372260 | 8.9 | 106442724 | 9.5 | α-Terpineol | 71.3 |
| 10 | 13.11 | 15118570 | 0.8 | 9523905 | 0.9 | Decanal | 6.36 |
| 11 | 13.41 | 232101733 | 12.2 | 140696163 | 12.5 | Cyclohexene, 4- | 97.6 |
| | | | | | | isopropenyl-1- | |
| 12 | 13.64 | 374053259 | 19.7 | 210010278 | 18.7 | cis-p-Mentha-2,8-dien- | 157 |
| | | | | | | 1-ol | |
| 13 | 13.80 | 64373000 | 3.4 | 38863967 | 3.5 | β-Myrcene | 27.1 |
| 14 | 14.10 | 497062018 | 26.2 | 246815689 | 21.9 | cis-Verbenol | 209 |
| 15 | 14.25 | 10703676 | 0.6 | 6673807 | 0.6 | 1-Cyclohexene-1- | 4.50 |
| | | | | | | carboxaldehy | |
| 16 | 14.67 | 11211796 | 0.6 | 6494359 | 0.6 | Undecanal | 4.72 |
| 17 | 15.37 | 106519007 | 5.6 | 75917168 | 6.7 | D-limonenee | 44.8 |
| 18 | 15.64 | 56091319 | 3.0 | 39660783 | 3.5 | β-Myrcene | 23.6 |
| 19 | 15.96 | 3983023 | 0.2 | 3021211 | 0.3 | Tetradecane | 1.68 |
| 20 | 16.20 | 7615733 | 0.4 | 5528704 | 0.5 | Bicyclo[3.1.1]hept-2- | 3.20 |
| | | | | | | ene, | |
| 21 | 16.29 | 3039432 | 0.2 | 2370030 | 0.2 | Tricyclo[2.2.1.0(2,6)]heptane, | 1.28 |
| | | | | | | 2,6-d | |
| 22 | 16.34 | 64778605 | 3.4 | 44137612 | 3.9 | Caryophyllene | 27.3 |
| 23 | 16.46 | 113932601 | 6.0 | 79080321 | 7.0 | Bicyclo[3.1.1]hept-2- | 47.9 |
| | | | | | | ene, 2,6-d | |
| 24 | 16.52 | 5477438 | 0.3 | 2938350 | 0.3 | Caryophyllene | 2.30 |
| 25 | 16.82 | 3816933 | 0.2 | 2550920 | 0.2 | Humulene | 1.61 |
| Sum: | | 1896862837 | 100 | 1125580682 | 100 | | 798 |

*expressed as average response factor D-limonene, α-Pinene, γ-Terpineol

TABLE 99-7
Headspace GC/MS results for Bitter Orange 71026466.

| Peak | R. | | Area | | Height | | |
|---|---|---|---|---|---|---|---|
| # | Time | Area | % | Height | % | Compound | g/l* |
| 1 | 7.64 | 469634 | 0.2 | 229354 | 0.2 | α-Phellandrene | 0.493 |
| 2 | 7.69 | 3186862 | 1.1 | 1674440 | 1.3 | α-Pinene | 3.35 |
| 3 | 8.77 | 3177321 | 1.1 | 1514490 | 1.2 | β-Pinene | 3.34 |
| 4 | 9.06 | 5447949 | 1.9 | 2482057 | 1.9 | β-Myrcene | 5.72 |
| 5 | 9.98 | 222162016 | 77.8 | 89145999 | 69.7 | Limonene | 233 |
| 6 | 11.31 | 7337288 | 2.6 | 4477854 | 3.5 | 1,6-Octadien-3-ol, 3,7- | 7.71 |
| | | | | | | dimethyl-, | |
| 7 | 11.39 | 461132 | 0.2 | 295855 | 0.2 | 2-Nonen-1-ol, (E)- | 0.484 |
| 8 | 11.54 | 306083 | 0.1 | 186147 | 0.2 | (E)-4,8-Dimethylnona- | 0.322 |
| | | | | | | 1,3,7-triene | |
| 9 | 11.98 | 360645 | 0.1 | 204596 | 0.2 | p-Mentha-1,8-dien-7-ol | 0.379 |
| 10 | 12.99 | 6186479 | 2.2 | 3917904 | 3.1 | α-Terpineol | 6.50 |
| 11 | 13.06 | 286750 | 0.1 | 169878 | 0.1 | Santalol, E-cis,epi-β- | 0.301 |
| 12 | 13.13 | 8283433 | 2.9 | 4410302 | 3.5 | Decanal | 8.70 |
| 13 | 13.63 | 587742 | 0.2 | 375789 | 0.3 | Carveol | 0.617 |
| 14 | 13.81 | 20024697 | 7.0 | 13849087 | 10.8 | 1,3,7-Octatriene, 3,7- | 21.0 |
| | | | | | | dimethyl- | |
| 15 | 14.08 | 920767 | 0.3 | 636430 | 0.5 | Citral | 0.967 |
| 16 | 14.26 | 504028 | 0.2 | 332605 | 0.3 | 1-Cyclohexene-1- | 0.530 |
| | | | | | | carboxaldehyde, 4 | |
| 17 | 15.37 | 512353 | 0.2 | 350775 | 0.3 | Limonene | 0.538 |
| 18 | 15.64 | 2028361 | 0.7 | 1492575 | 1.2 | β-Myrcene | 2.13 |
| 19 | 16.35 | 2722889 | 1.0 | 1819177 | 1.4 | Caryophyllene | 2.86 |
| 20 | 17.15 | 591780 | 0.2 | 370327 | 0.3 | Germacrene D | 0.622 |
| Sum: | | 285558209 | 100.01 | 127935641 | 100 | | 300 |

*expressed as D-limonene

TABLE 99-8
Liquid Injection GC/MS results for Bitter Orange 71026466.

| Peak | R. | | Area | | Height | | |
|---|---|---|---|---|---|---|---|
| # | Time | Area | % | Height | % | Compound | g/l* |
| 1 | 7.65 | 639360 | 0.1 | 399375 | 0.1 | α-Pinene | 0.252 |
| 2 | 8.75 | 495581 | 0.0 | 450357 | 0.1 | Bicyclo[3.1.1]heptane, | 0.195 |
| | | | | | | 6,6-dimethyl | |
| 3 | 9.04 | 1372917 | 0.1 | 849337 | 0.1 | β-Myrcene | 0.540 |
| 4 | 9.90 | 175185595 | 14.0 | 110200288 | 13.7 | Limonen | 68.9 |
| 5 | 10.74 | 1464439 | 0.1 | 721522 | 0.1 | 4-Tridecene, (Z)- | 0.576 |
| 6 | 11.28 | 66839129 | 5.4 | 49414433 | 6.1 | 1,6-Octadien-3-ol, 3,7- | 26.3 |
| | | | | | | dimethyl | |
| 7 | 11.38 | 4281162 | 0.3 | 1779564 | 0.2 | Nonanal | 1.68 |
| 8 | 11.70 | 2436083 | 0.2 | 1498470 | 0.2 | Carveol | 0.958 |
| 9 | 11.90 | 1641242 | 0.1 | 1111924 | 0.1 | cis-(−)-1,2-Epoxy-p- | 0.646 |
| | | | | | | menth-8-en | |
| 10 | 11.97 | 4283116 | 0.3 | 2167682 | 0.3 | Hexane, 1-chloro-5- | 1.69 |
| | | | | | | methyl- | |
| 11 | 12.97 | 175741152 | 14.1 | 108032267 | 13.4 | α-Terpineol | 69.1 |
| 12 | 13.11 | 79154329 | 6.3 | 57981611 | 7.2 | Decanal | 31.1 |
| 13 | 13.16 | 23871360 | 1.9 | 14166739 | 1.8 | Acetic acid, octylester | 9.39 |
| 14 | 13.62 | 16398850 | 1.3 | 10955116 | 1.4 | Carveol | 6.45 |
| 15 | 13.78 | 241868036 | 19.4 | 147790564 | 18.3 | Cyclohexene, 4- | 95.2 |
| | | | | | | isopropenyl-1-methyl | |
| 16 | 13.99 | 3973440 | 0.3 | 2306989 | 0.3 | 2-Decenal, (E)- | 1.56 |
| 17 | 14.07 | 41758457 | 3.4 | 22045441 | 2.7 | Citral | 16.4 |
| 18 | 14.24 | 16115871 | 1.3 | 9468640 | 1.2 | 1-Cyclohexene-1- | 6.34 |
| | | | | | | carboxaldehy | |
| 19 | 14.66 | 6866571 | 0.6 | 4435679 | 0.6 | Undecanal | 2.70 |
| 20 | 15.12 | 4013881 | 0.3 | 3236135 | 0.4 | Cyclohexene, 4- | 1.58 |
| | | | | | | isopropenyl-1-methyl | |
| 21 | 15.24 | 7090259 | 0.6 | 3955272 | 0.5 | 4-Hexen-1-ol, 5-methyl- | 2.79 |
| | | | | | | 2-(1-methyl) | |
| 22 | 15.36 | 19604091 | 1.6 | 14856502 | 1.8 | 3-Carene | 7.71 |
| 23 | 15.64 | 98962892 | 7.9 | 70065923 | 8.7 | Santolinatriene | 38.9 |
| 24 | 15.89 | 9122612 | 0.7 | 3895607 | 0.5 | Cyclohexane, 1-ethenyl- | 3.59 |
| | | | | | | 1-methyl | |
| 25 | 16.06 | 6267897 | 0.5 | 4531633 | 0.6 | Acetic acid, decyl ester | 2.47 |
| 26 | 16.10 | 19056230 | 1.5 | 10377700 | 1.3 | Dodecanal | 7.50 |
| 27 | 16.25 | 1171913 | 0.1 | 925822 | 0.1 | Spiro[4.4]nonane, 1- | 0.461 |
| | | | | | | methylene- | |
| 28 | 16.35 | 83621531 | 6.7 | 57892106 | 7.2 | Caryophyllene | 32.9 |
| 29 | 16.44 | 18110197 | 1.5 | 10681700 | 1.3 | 2,6-Dimethyl-1,3,5,7- | 7.12 |
| | | | | | | octatetrae | |
| 30 | 16.82 | 6880464 | 0.6 | 4834998 | 0.6 | Humulene | 2.71 |
| 31 | 16.86 | 12002239 | 1.0 | 6473674 | 0.8 | 2-Dodecenal, (E)- | 4.72 |
| 32 | 17.15 | 61628651 | 4.9 | 44468062 | 5.5 | β-copaene | 24.2 |
| 33 | 17.34 | 3535213 | 0.3 | 2939062 | 0.4 | 1,3,6,10- | 1.39 |
| | | | | | | Cyclotetradecatetraene | |
| 34 | 17.58 | 1929268 | 0.2 | 1640756 | 0.2 | Naphthalene, | 0.759 |
| | | | | | | 1,2,3,5,6,8a-hexah | |
| 35 | 18.06 | 18765945 | 1.5 | 12796520 | 1.6 | Nerolidyl acetate | 7.38 |
| 36 | 18.15 | 4980087 | 0.4 | 2833064 | 0.4 | 1H- | 1.96 |
| | | | | | | Cycloprop[e]azulene, | |
| | | | | | | 1a,2,3 | |
| 37 | 18.20 | 1936859 | 0.2 | 1174119 | 0.2 | (3E,7E)-4,8,12- | 0.762 |
| | | | | | | Trimethyltrideca | |
| 38 | 18.44 | 2954352 | 0.2 | 1512414 | 0.2 | Caryophyllene oxide | 1.16 |
| 39 | 18.95 | 2042707 | 0.2 | 1285166 | 0.2 | 4a,5-Dimethyl-3-(prop- | 0.804 |
| | | | | | | 1-en-2-y | |
| Sum: | | 1248063978 | 100 | 806152233 | 100 | | 491 |

*expressed as average response factor D-limonene, α-Pinene, γ-Terpineol

TABLE 99-9
Headspace GC/MS results for Blood Orange for 81026463.

| Peak | R. | | Area | | Height | | |
|---|---|---|---|---|---|---|---|
| # | Time | Area | % | Height | % | Compound | g/l* |
| 1 | 9.40 | 29682175 | 12.2 | 14910549 | 13.0 | Octanal | 31.1 |
| 2 | 9.98 | 169909287 | 69.6 | 72222462 | 62.8 | Limonene | 178 |
| 3 | 10.74 | 480245 | 0.2 | 269043 | 0.2 | 1-Octene,3,7-dimethyl- | 0.503 |
| 4 | 11.32 | 10517019 | 4.3 | 6145053 | 5.3 | 1,6-Octadien-3-ol, 3,7-dimethyl- | 11.0 |
| 5 | 11.39 | 780786 | 0.3 | 579568 | 0.5 | Nonanal | 0.818 |
| 6 | 12.22 | 496827 | 0.2 | 315470 | 0.3 | Cyclohexanol, 5-methyl-2-(1- | 0.521 |
| | | | | | | methyl) | |
| 7 | 12.54 | 263237 | 0.1 | 150197 | 0.1 | 1-Nonanol | 0.276 |
| 8 | 12.98 | 1566457 | 0.6 | 989726 | 0.9 | α-Terpineol | 1.64 |
| 9 | 13.14 | 14877033 | 6.1 | 8919600 | 7.8 | Decanal | 15.6 |
| 10 | 13.63 | 1061032 | 0.4 | 757925 | 0.7 | Bicyclopentyl-1,1′-diene | 1.11 |
| 11 | 14.08 | 1255581 | 0.5 | 870915 | 0.8 | Citral | 1.32 |
| 12 | 14.29 | 8599366 | 3.5 | 5751038 | 5.0 | (E)-But-2-en-1-yl, 2- | 9.01 |
| | | | | | | methylbutanoat | |
| 13 | 15.65 | 479515 | 0.2 | 200198 | 0.2 | 1H-Benzocycloheptene, | 0.503 |
| | | | | | | 2,4a,5,6,7, | |
| 14 | 15.72 | 1980889 | 0.8 | 1317441 | 1.2 | α-ylangene | 2.08 |
| 15 | 15.88 | 365817 | 0.2 | 200844 | 0.2 | Cedrene | 0.383 |
| 16 | 16.97 | 1942202 | 0.8 | 1384552 | 1.2 | 2,2-Dimethylpropionic acid, | 2.04 |
| | | | | | | undec | |
| Sum: | | 244257468 | 100 | 114984581 | 100 | | 256 |

*expressed as D-limonene

TABLE 99-10
Liquid Injection GC/MS results for Blood Orange 81026463

| Peak | R. | | Area | | Height | | |
|---|---|---|---|---|---|---|---|
| # | Time | Area | % | Height | % | Compound | g/l* |
| 1 | 9.35 | 12035890 | 3.9 | 6938102 | 3.4 | Octanal | 5.71 |
| 2 | 9.90 | 74184840 | 24.1 | 51563680 | 25.1 | D-limonenee | 35.2 |
| 3 | 10.74 | 1466201 | 0.5 | 695226 | 0.3 | 2- | 0.696 |
| | | | | | | Methylenecyclohexanol | |
| 4 | 11.29 | 29792811 | 9.7 | 20360555 | 9.9 | 1,6-Octadien-3-ol, 3,7- | 14.1 |
| | | | | | | dimethyl-, | |
| 5 | 11.38 | 2615459 | 0.9 | 1187426 | 0.6 | Nonanal | 1.24 |
| 6 | 11.71 | 1437376 | 0.5 | 970508 | 0.5 | Carveol | 0.682 |
| 7 | 11.97 | 1288638 | 0.4 | 778922 | 0.4 | 2,6-Dimethyl-1,3,5,7- | 0.612 |
| | | | | | | octatetraene, E | |
| 8 | 12.22 | 1559236 | 0.5 | 881326 | 0.4 | Citronellal | 0.740 |
| 9 | 12.97 | 18501479 | 6.0 | 11916198 | 5.8 | α-Terpineol | 8.78 |
| 10 | 13.04 | 1370339 | 0.5 | 573571 | 0.3 | Cycloheptane, 1,3,5- | 0.650 |
| | | | | | | tris(methylene)- | |
| 11 | 13.11 | 29927370 | 9.7 | 20940523 | 10.2 | Decanal | 14.2 |
| 12 | 13.15 | 4333187 | 1.4 | 2076911 | 1.0 | Acetic acid, octyl ester | 2.06 |
| 13 | 13.35 | 1230255 | 0.4 | 649751 | 0.3 | cis-p-Mentha-2,8-dien- | 0.584 |
| | | | | | | 1-ol | |
| 14 | 13.41 | 1738311 | 0.6 | 1050834 | 0.5 | D-limonenee | 0.825 |
| 15 | 13.62 | 7861697 | 2.6 | 5130422 | 2.5 | Carveol | 3.73 |
| 16 | 13.75 | 2610964 | 0.9 | 1117922 | 0.5 | (−)-Carvone | 1.24 |
| 17 | 14.07 | 10556139 | 3.4 | 5313580 | 2.6 | Citral | 5.01 |
| 18 | 14.27 | 38202654 | 12.4 | 25127060 | 12.2 | Octane, 1,1-diethoxy- | 18.1 |
| 19 | 15.66 | 2538952 | 0.8 | 1014921 | 0.5 | 1-Undecene, 11,11- | 1.20 |
| | | | | | | diethoxy- | |
| 20 | 15.72 | 9821982 | 3.2 | 7210494 | 3.5 | .alfa.-Copaene | 4.66 |
| 21 | 15.88 | 1688017 | 0.6 | 1126428 | 0.6 | β-copaene | 0.801 |
| 22 | 15.97 | 1294623 | 0.4 | 965492 | 0.5 | dl-Isopulegol | 0.614 |
| 23 | 16.04 | 805953 | 0.3 | 540048 | 0.3 | 1,4-Methano-1H-indene, | 0.382 |
| | | | | | | octahydro- | |
| 24 | 16.10 | 2491006 | 0.8 | 1467913 | 0.7 | Dodecanal | 1.18 |
| 25 | 16.47 | 1065391 | 0.4 | 567588 | 0.3 | β-copaene | 0.506 |
| 26 | 16.97 | 41968582 | 13.6 | 32180079 | 15.6 | 2,2-Dimethylpropionic | 19.92 |
| | | | | | | acid, pentade | |
| 27 | 17.29 | 1357784 | 0.4 | 720577 | 0.4 | Naphthalene, | 0.644 |
| | | | | | | 1,2,3,5,6,7,8,8a-octahyd | |
| 28 | 17.58 | 967197 | 0.3 | 648031 | 0.3 | Naphthalene, | 0.459 |
| | | | | | | 1,2,3,5,6,8a-hexahydro | |
| 29 | 17.95 | 709971 | 0.2 | 516716 | 0.3 | Azulene, | 0.337 |
| | | | | | | 1,2,3,3a,4,5,6,7- | |
| | | | | | | octahydro- | |
| 30 | 19.36 | 2210364 | 0.7 | 1581726 | 0.8 | 1-Undecene, 11,11- | 1.05 |
| | | | | | | diethoxy- | |
| Sum: | | 307632668 | 100 | 205812530 | 100 | | 146 |

*expressed as average response factor D-limonene, α-Pinene, γ-Terpineol

TABLE 99-11
Headspace GC/MS results for Mandarin Juice 81025599.

| Peak | R. | | Area | | Height | | |
|---|---|---|---|---|---|---|---|
| # | Time | Area | % | Height | % | Compound | g/l* |
| 1 | 6.95 | 438180 | 0.3 | 191295 | 0.2 | Phosphine, methyl- | 0.461 |
| 2 | 7.50 | 1308140 | 0.8 | 641884 | 0.7 | α-Phellandrene | 1.38 |
| 3 | 7.68 | 4191358 | 2.4 | 2063011 | 2.3 | (1R)-2,6,6-Trimethylbicyclo[ | 4.41 |
| 4 | 8.76 | 1335404 | 0.8 | 779569 | 0.9 | β-Pinene | 1.40 |
| 5 | 9.05 | 1365533 | 0.8 | 814730 | 0.9 | β-Myrcene | 1.44 |
| 6 | 9.36 | 1716296 | 1.0 | 1072405 | 1.2 | Octanal | 1.80 |
| 7 | 9.82 | 1639335 | 1.0 | 770968 | 0.8 | o-Cymene | 1.72 |
| 8 | 9.97 | 115430066 | 66.7 | 54426782 | 59.6 | Limonene | 121 |
| 9 | 10.54 | 27900657 | 16.1 | 18010129 | 19.7 | γ-Terpinene | 29.3 |
| 10 | 11.03 | 1155837 | 0.7 | 848490 | 0.9 | Cyclohexene, 1-methyl-4-(1- | 1.21 |
| | | | | | | metyhl) | |
| 11 | 11.30 | 1184818 | 0.7 | 828612 | 0.9 | 1,6-Octadien-3-ol, 3,7-dimeth | 1.25 |
| 12 | 11.38 | 612375 | 0.4 | 334459 | 0.4 | 2-Nonen-1-ol, (E)- | 0.644 |
| 13 | 12.22 | 255528 | 0.2 | 189609 | 0.2 | 2-Decyn-1-ol | 0.269 |
| 14 | 12.74 | 721834 | 0.4 | 484842 | 0.5 | Bicyclo[3.1.0]hexan-2-ol, 2- | 0.759 |
| | | | | | | methyl | |
| 15 | 12.99 | 3504550 | 2.0 | 2349722 | 2.6 | α-Terpineol | 3.68 |
| 16 | 13.12 | 1819758 | 1.1 | 1348505 | 1.5 | Decanal | 1.91 |
| 17 | 14.25 | 371990 | 0.2 | 256387 | 0.3 | 1-Cyclohexene-1-carboxaldeh | 0.391 |
| 18 | 16.13 | 3335865 | 1.9 | 2429925 | 2.7 | Benzoic acid, 2-(methylamino) | 3.51 |
| 19 | 16.35 | 2536145 | 1.5 | 1806723 | 2.0 | Caryophyllene | 2.67 |
| 20 | 17.34 | 2323268 | 1.3 | 1616899 | 1.8 | α-Farnesene | 2.44 |
| Sum: | | 173146937 | 100 | 91264946 | 100 | | 182.0 |

*expressed as D-limonene

TABLE 99-12
Liquid Injection GC/MS results for Mandarin Juice 81025599.

| Peak | R. | | Area | | Height | | |
|---|---|---|---|---|---|---|---|
| # | Time | Area | % | Height | % | Compound | g/l* |
| 1 | 9.35 | 5520200 | 0.3 | 3148488 | 0.3 | Octanal | 2.27 |
| 2 | 9.80 | 11105997 | 0.6 | 7253529 | 0.6 | o-Cymene | 4.57 |
| 3 | 9.90 | 196442409 | 10.0 | 119866759 | 10.4 | Limonen | 80.9 |
| 4 | 10.50 | 115586583 | 5.9 | 75667358 | 6.6 | Cyclohexene, 1-methyl- | 47.6 |
| | | | | | | 4-(1-methylen | |
| 5 | 10.74 | 4117796 | 0.2 | 2271157 | 0.2 | Bicyclo[3.1.0]hexan-2- | 1.69 |
| | | | | | | ol, 2-methyl-5 | |
| 6 | 11.02 | 9669189 | 0.5 | 6572719 | 0.6 | Cyclohexene, 1-methyl- | 3.98 |
| | | | | | | 4-(1-methylen | |
| 7 | 11.29 | 37494353 | 1.9 | 14403591 | 1.3 | 1,6-Octadien-3-ol,3,7- | 15.4 |
| | | | | | | dimethyl-, | |
| 8 | 11.38 | 7358362 | 0.4 | 3624739 | 0.3 | Nonanal | 3.03 |
| 9 | 12.22 | 4644295 | 0.2 | 3194697 | 0.3 | Citronellal | 1.91 |
| 10 | 12.74 | 25949509 | 1.3 | 16103158 | 1.4 | Bicyclo[3.1.0]hexan-2- | 10.7 |
| | | | | | | ol, 2-methyl-5 | |
| 11 | 12.82 | 2390341 | 0.1 | 1259077 | 0.1 | Benzene, 1-methyl-4-(1- | 0.984 |
| | | | | | | methylethen | |
| 12 | 12.97 | 179209469 | 9.1 | 109148281 | 9.5 | α-Terpineol | 73.8 |
| 13 | 13.11 | 55818530 | 2.9 | 37077388 | 3.2 | Decanal | 23.0 |
| 14 | 13.42 | 9229271 | 0.5 | 5119115 | 0.4 | Citronellol | 3.80 |
| 15 | 14.07 | 3138736 | 0.2 | 1924626 | 0.2 | Citral | 1.29 |
| 16 | 14.13 | 2752417 | 0.1 | 1672490 | 0.2 | 2-Cyclohexen-1-one, 3- | 1.13 |
| | | | | | | methyl-6-(1-m | |
| 17 | 14.24 | 32481404 | 1.7 | 19232168 | 1.7 | 1-Cyclohexene-1- | 13.4 |
| | | | | | | carboxaldehyde, 4- | |
| 18 | 14.39 | 62453950 | 3.2 | 41747440 | 3.6 | Phenol, 2,3,5,6- | 25.7 |
| | | | | | | tetramethyl- | |
| 19 | 14.67 | 9052757 | 0.5 | 5370313 | 0.5 | Undecanal | 3.73 |
| 20 | 15.64 | 2398139 | 0.1 | 1823210 | 0.2 | β-Myrcene | 0.987 |
| 21 | 15.72 | 12811426 | 0.7 | 9430694 | 0.8 | .alfa.-Copaene | 5.27 |
| 22 | 15.87 | 14365002 | 0.7 | 7286922 | 0.6 | β-copaene | 5.91 |
| 23 | 16.13 | 479177404 | 24.4 | 214438431 | 18.6 | Benzoic acid, 2- | 197 |
| | | | | | | (methylamino) | |
| 24 | 16.35 | 125834103 | 6.4 | 86158641 | 7.5 | Caryophyllene | 51.8 |
| 25 | 16.83 | 12074146 | 0.6 | 8194342 | 0.7 | Humulene | 4.97 |
| 26 | 16.87 | 7680944 | 0.4 | 5248449 | 0.5 | 2-Dodecenal, (E)- | 3.16 |
| 27 | 17.15 | 11469607 | 0.6 | 7805294 | 0.7 | Germacrene | 4.72 |
| 28 | 17.34 | 288601024 | 14.7 | 192935996 | 16.8 | Naphthalene, | 119 |
| | | | | | | 1,2,3,4,4a,5,6,8a-octahy | |
| 29 | 17.58 | 28456175 | 1.5 | 19649467 | 1.7 | 1-Isopropyl-4,7- | 11.7 |
| | | | | | | dimethyl-1,2,3,5,6,8 | |
| 30 | 17.96 | 3581145 | 0.2 | 2393317 | 0.2 | Cyclohexane, 1-ethenyl- | 1.47 |
| | | | | | | 1-methyl-2,4 | |
| 31 | 18.36 | 3785418 | 0.2 | 2372629 | 0.2 | 1H-Cycloprop[e]azulen- | 1.56 |
| | | | | | | 7-ol, decahyd | |
| 32 | 18.45 | 11191732 | 0.6 | 5022088 | 0.4 | 10-12-Pentacosadiynoic | 4.61 |
| | | | | | | acid | |
| 33 | 18.68 | 4163032 | 0.2 | 2654470 | 0.2 | Tetradecanal | 1.71 |
| 34 | 20.28 | 178776441 | 9.1 | 110670725 | 9.6 | 2,6,9,11- | 73.6 |
| | | | | | | Dodecatetraenal, 2,6,10- | |
| | | | | | | trim | |
| 35 | 20.99 | 1897805 | 0.1 | 1325894 | 0.1 | Octadecanal | 0.781 |
| Sum: | | 1960679111 | 100 | 1152067662 | 100 | | 807 |

*expressed as average response factor D-limonene, α-Pinene, γ-Terpineol

### Example 100. Evaluation of Taste Profiles and Aroma of GRU90-MRPs Prepared from GRU90 with Different Amino Acids

Raw material: GRU90: the product of Ex. 7.

Process: GRU90, glucose, amino acids, water were weighed as Table 86-1. All the ingredients were mixed and fully dissolved in the water. The solution was then heated at about 100° C. for an hour. When the reaction was completed, the solution was filtered through filter paper and the filtrate was dried with a spray dryer, resulting in products 86-01 to 86-09 as powders.

TABLE 100-1
Sample compositions.

| | | | Amino acid | | | | |
|---|---|---|---|---|---|---|---|
| | Weight of | Sugar donor | | Weight/ | | | |
| Product | GRU90 | Weight/glucose | Type of | amino acid | Weight/ | | Taste |
| No. | (g) | (g) | amino acid | (g) | water (mL) | Odor | profile |
| 100-01 | 45 | 3.75 | Phe | 1.25 | 50 | Strong floral | Honey flavor |
| | | | | | | scent | |
| 100-02 | | | Glu | | | Herbal scent | Herbal flavor |
| 100-03 | | | Ala | | | Floral scent | Light honey |
| | | | | | | | flavor |
| 100-04 | | | Thr | | | Herbal scent | Herbal flavor |
| 100-05 | | | Val | | | Paprika/Brown | Light brown |
| | | | | | | sugar scent | sugar flavor |
| 100-06 | | | Thea | | | Black tea | Tea flavor |
| | | | | | | scent | |
| 100-07 | | | Pro | | | Strong popcorn | Caramel flavor |
| | | | | | | scent | |
| 100-08 | | | Ser | | | Popcorn | Caramel flavor |
| | | | | | | scent | |
| 100-09 | | | Cys | | | Egg yolk | Egg flavor |
| | | | | | | scent | |

### Example 101. Evaluation of Taste Profiles of GRU90-MRPs Prepared from GRU90 with Different Sugar Donors

Raw material: GRU90: the product of Ex. 7.

Process: GRU90, glucose, amino acids, water were weighed as table 101-1. All the ingredients were mixed and fully dissolved in the water. The solution was then heated at about 100° C. for 2.5 hour. When the reaction was completed, the solution was filtered through filter paper and the filtrate was dried with a spray dryer, resulting in products 101-01 to 101-18 as powders.

TABLE 101-1
Sample compositions.

| | | Sugar donor | | Amino acid | | |
|---|---|---|---|---|---|---|
| | Weight/ | | Weight/ | | Weight/ | Weight/ |
| Product | GRU90 | Type/ | sugar donor | Type/ | amino acid | water |
| No. | (g) | sugar donor | (g) | amino acid | (g) | (mL) |
| 101-01 | 45 | fructose | 3.75 | glutamic acid | 1.25 | 50 |
| 101-02 | | lactose | | | | |
| 101-03 | | rhamnose | | | | |
| 101-04 | | xylose | | | | |
| 101-05 | | galactose | | | | |
| 101-06 | | maltose | | | | |
| 101-07 | | mannose | | | | |
| 101-08 | | arabinose | | | | |
| 101-09 | | glucose | | | | |
| 101-10 | | fructose | 3.75 | alanine | | |
| 101-11 | | lactose | | | | |
| 101-12 | | rhamnose | | | | |
| 101-13 | | Xylose | | | | |
| 101-14 | | galactose | | | | |
| 101-15 | | maltose | | | | |
| 101-16 | | mannose | | | | |
| 101-17 | | arabinose | | | | |
| 107-18 | | glucose | | | | |

Each sample was evaluated according to the aforementioned sensory evaluation method in Ex. 5. Average scores from the test panel for each sensory criterion were recorded as the evaluation test results. The taste profile for each mixtures is shown in Table 101-2.

TABLE 101-2
Sensory evaluation results.

| | Overall | | | Sweet |
|---|---|---|---|---|
| Sample | likability | Mouth feel | Bitterness | lingering |
| 101-01 | 3.5 | 1.5 | 1 | 1.5 |
| 101-02 | 2.5 | 2 | 1.5 | 2.5 |
| 101-03 | 3 | 2 | 1 | 4 |
| 101-04 | 4 | 3 | 1 | 1.5 |
| 101-05 | 3 | 1.5 | 1.5 | 2 |
| 101-06 | 2.5 | 1.5 | 1.5 | 4 |
| 101-07 | 2.5 | 1.5 | 1.5 | 5 |
| 101-08 | 3 | 3 | 1 | 4.5 |
| 101-09 | 2.5 | 2 | 1 | 5 |
| 101-10 | 3 | 1.5 | 1 | 1.5 |
| 101-11 | 2.5 | 2 | 1 | 2.5 |
| 101-12 | 2.5 | 2.5 | 1 | 2 |
| 101-13 | 2.5 | 2 | 1 | 1.5 |
| 101-14 | 3 | 2.5 | 1 | 1.5 |
| 101-15 | 3.5 | 2 | 1 | 1.5 |
| 101-16 | 3 | 2 | 1 | 1.5 |
| 101-17 | 3.5 | 2 | 1 | 1.5 |
| 101-18 | 2.5 | 2 | 1 | 1.5 |

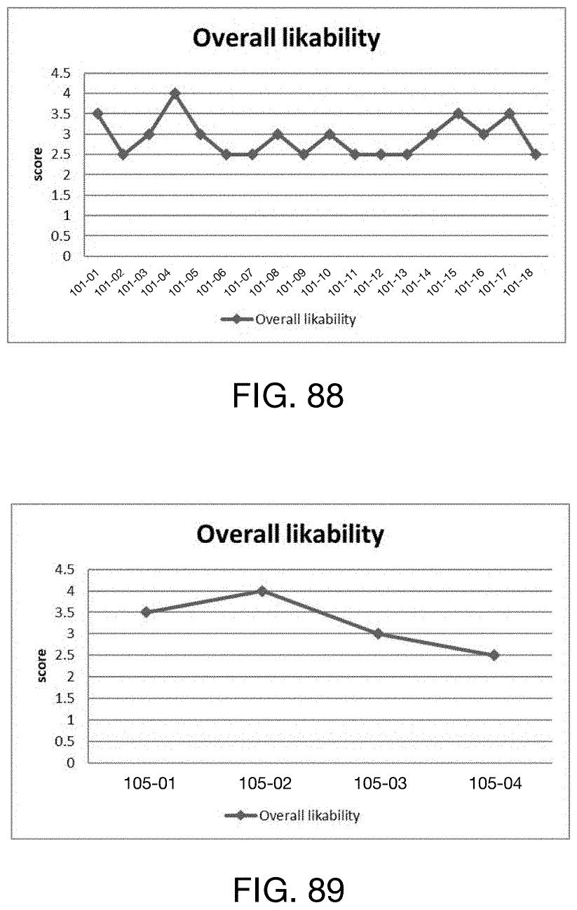

FIG. 88 shows the sensory evaluation results of GRU90-MRPs prepared with different sugar donors.

Conclusion: GRU90-MRPs prepared with different sugar donors and amino acids all exhibited pleasant taste and achieved scores of overall likability above 2.5. The GRU90-MRPs prepared with xylose showed the most pleasant taste and achieved the score of overall likability of 4.

### Example 102. Preparation of GRU90-MRP-FTAs from GRU90 Using Concentrated Fruit Juice as Sugar Donors

Raw material: GRU90 (product of Ex. 7); concentrated fruit juices: 1) Decolorized and deacidified concentrated apple juice (fructose content: 36.77%), available from China Haisheng Fresh Fruit Juice Co., Ltd, Weinan Branch, lot #: 25191005B01-05; 2) Decolorized and deacidified concentrated pear juice (fructose content: 26.67%), available from China Haisheng Fresh Fruit Juice Co., Ltd, Weinan Branch, lot #: 25191005B02-05.

Process: GRU90, concentrated fruit juices, glutamic acid, water were weighed as shown in Table 102-1. All the ingredients were mixed and fully dissolved in the water. The solution was then heated at about 100° C. for 1.5 hours. When the reaction was completed, the solution was filtered through filter paper and the filtrate was dried with a spray dryer, resulting in products 102-01 and 102-02 as off-white powders.

TABLE 102-1

| | | Amino acid | Sugar donor | | | |
|---|---|---|---|---|---|---|
| | Weight of | Weight of | Type of | Weight of | Fructose solid | Weight of |
| Product | GRU90 | glutamic acid | concentrated | fruit juice | equivalent | water |
| No. | (g) | (g) | fruit juice | (g) | (g) | (mL) |
| 102-01 | 18 | 1 | Apple | 2.72 | 1 | 7.28 |
| 102-02 | | | Pear | 3.75 | | 6.25 |

### Example 103. GRU90-MRP-FTAs Improve the Taste Profile of Low-Sugar Carbonated Drink

Commercial carbonated drink: Light Diet Coke, available from Coca-Cola Beijing Co., Ltd, lot #: 20200714.

Ingredients: water, food additives (carbon dioxide, caramel color, phosphoric acid, acesulfame potassium, sodium dihydrogen phosphate, sodium benzoate, caffeine, citric acid, L(+)-tartaric acid, sucralose), food flavoring.

Process: Dissolve a certain amount of GRU90-MRP-FTA (Ex. 102, 102-1, 102-02) powder into the selected carbonated drink. The details are as follows.

TABLE 103-1
Sample compositions.

| | Weight of GRU90- | Volume of Diet | Concentration |
|---|---|---|---|
| Sample | MRP-FTA (mg) | Coke (ml) | (ppm) |
| Base | — | 100 | |
| 102-01 | 5.0 | 100 | 50 |
| 102-02 | 5.0 | 100 | 50 |

Experiment: Each sample was evaluated according to the sensory evaluation method in Ex. 5. Average scores from the test panel for each sensory criterion were recorded as the evaluation test results. The taste profiles of the mixtures are shown in Table 103-2.

TABLE 103-2
Sensory evaluation results.

| | Overall | | | Metallic | Sweet |
|---|---|---|---|---|---|
| Sample | likability | Flavor | Mouth feel | aftertaste | lingering |
| Reference | 2.5 | 3.0 | 1.5 | 2.5 | 3.0 |
| 102-01 | 4.5 | 3.0 | 1.5 | 1 | 1.0 |
| 102-02 | 4.0 | 3.0 | 1.5 | 1.5 | 1.0 |

Conclusion: GRU90-MRP-FTA (Ex. 102, 102-01, 102-02) can significantly cut the unpleasant sweet linger and metallic aftertaste that the diet coke possesses, while maintaining its original caramel-like flavor and mouth feel. Resulting in an improved overall likability of the beverage. The results showed that GRU90-MRP-FTA improved the taste profile of the low-sugar carbonated drink.

### Example 104. Evaluation of Taste Profiles and Aromas of GRU40-MRPs Prepared from GRU40 and a Variety of Different Amino Acids in Combination with Fructose

Raw material: GRU40: product of Ex. 58.

Process: GRU40, glucose, amino acids, water were weighed as shown in Table 104-1. All the ingredients were mixed and fully dissolved in the water. The solution was then heated at about 100° C. for 2.5 hours. When the reaction was completed, the solution was filtered through filter paper and the filtrate was dried with a spray dryer, resulting in products 104-01 to 104-09 as powders.

TABLE 104-1
Sample composition

| | | | Amino acid | | | | |
|---|---|---|---|---|---|---|---|
| | Weight/ | Sugar donor | | Weight/ | Weight/ | | |
| Product | GRU40 | Weight/fructose | Type/ | amino acid | water | | Taste |
| No. | (g) | (g) | amino acid | (g) | (mL) | Odor | profile |
| 104-01 | 45 | 3.75 | Phe | 1.25 | 25 | Strong floral | Honey flavor |
| | | | | | | scent | |
| 104-02 | | | Glu | | | Herbal scent | Herbal flavor |
| 104-03 | | | Ala | | | Chocolate scent | Roasted cocoa |
| | | | | | | | flavor |
| 104-05 | | | Val | | | Paprika/Brown | Light popcorn |
| | | | | | | sugar scent | flavor |
| 104-06 | | | Thea | | | Herbal scent | Herbal flavor |
| 104-07 | | | Pro | | | Popcorn scent | Popcorn flavor |
| 104-08 | | | Ser | | | Light caramel | Herbal flavor |
| | | | | | | scent | |
| 104-09 | | | Arg | | | Herbal scent | Bitter flavor |

### Example 105. Evaluation of Taste Profiles of GRU40-MRPs Prepared from GRU40, Proline and Fructose

Raw material: GRU40: product of Ex. 58.

Process: GRU40, sugar donor, amino acids, water were weighed as Table 105-1. All the ingredients were mixed and fully dissolved in the water. The solution was then heated at about 100° C. for 2 hours. When the reaction was completed, the solution was filtered through filter paper and the filtrate was dried with a spray dryer, resulting in products 105-01 to 105-04 as powders.

TABLE 105-1
Sample composition

| Product | GRU40 | Proline | Fructose | Time |
|---|---|---|---|---|
| No. | (g) | (g) | (g) | (h) |
| 105-01 | 4.5 | 0.125 | 0.375 | 2 |
| 105-02 | 4 | 0.25 | 0.75 | |
| 105-03 | 3.5 | 0.375 | 1.125 | |
| 105-04 | 3 | 0.5 | 1.5 | |

Each sample was evaluated according to the aforementioned sensory evaluation method in Ex. 5. The taste profiles of the mixtures are shown in Table 105-2.

TABLE 105-2
Sensory evaluation results.

| Product | Flavor | | | | Mouth | Overall |
|---|---|---|---|---|---|---|
| No. | type | Flavor | Lingering | Bitterness | feel | likability |
| 105-01 | popcorn | 3.5 | 1.5 | 2 | 3 | 3.5 |
| 105-02 | | 4 | 1.5 | 1.5 | 3 | 4 |
| 105-03 | | 3.2 | 2 | 2 | 2.5 | 3 |
| 105-04 | | 3 | 1.8 | 1.5 | 2.5 | 2.5 |

FIG. 89 shows the overall likability of GRU40-MRPs prepared with different weights of sugar donors, amino acids and GRU40 s based on the results in Table 105-2.

Conclusion: GRU40-MRPs prepared with different weight ratios of sugar donors and amino acids all exhibited pleasant popcorn flavor and achieved scores of overall likability above 2.5. The GRU40-MRPs prepared with the ratio of GRU40: proline:fructose=16:3:1 showed the most pleasant popcorn flavor and achieved the score of overall likability of 4.

### Example 106. Evaluation of Taste Profiles and Aromas of GRU40-MRPs Prepared from GRU40 with Glutamic Acid Alone or with Glutamic and Either Fructose and/or Xylose Under Different Reaction Times

Raw material: GRU40: the product of Ex. 58.

Process: GRU40, sugar donor, amino acids, water were weighed as described in Table 106-1. All the ingredients were mixed and fully dissolved in the water. The solution was then heated at about 100° C. When the reaction was completed, the solution was filtered through filter paper and the filtrate was dried with a spray dryer, resulting in products 106-01 to 106-13 as powders.

TABLE 106-1
Sample compositions.

| Product | GRU40 | Glutamic | Fructose | Xylose | Time |
|---|---|---|---|---|---|
| No. | (g) | acid(g) | (g) | (g) | (h) |
| 106-01 | 3 | 1 | 1 | | 2 |
| 106-02 | | 0.5 | 1.5 | | |
| 106-03 | | 0.33 | 1.66 | | |
| 106-04 | | 0.22 | 1.77 | | |
| 106-05 | | 0.15 | 1.85 | | |
| 106-06 | | 1 | | 1 | |
| 106-07 | | 0.15 | | 1.85 | |
| 106-08 | | | | | 1.5 |
| 106-09 | | | | | 3 |
| 106-10 | 3.5 | | 0.75 | 0.75 | 2 |
| 106-11 | | 0.375 | | 1.125 | |
| 106-12 | | 0.16 | | 1.33 | |
| 106-13 | | 0.115 | | 1.385 | |

Experiment: Each sample was evaluated according to the sensory evaluation method in Ex. 5. Average scores from the test panel for each sensory criterion were recorded as the evaluation test results. The taste profiles of the mixtures are shown in Table 106-2.

TABLE 106-2
Sensory evaluation results.

| Product | | | | Mouth | Overall |
|---|---|---|---|---|---|
| No. | Flavor | Lingering | Bitterness | feel | likability |
| 106-01 | 2 | 3 | 4 | 1.5 | 2.5 |
| 106-02 | 3 | 1.5 | 1.5 | 2 | 4 |
| 106-03 | 2 | 1.5 | 1.5 | 2.5 | 1.8 |
| 106-04 | 1.5 | 1.3 | 1.3 | 1.8 | 2.5 |
| 106-05 | 1.5 | 2 | 2 | 2 | 2.5 |
| 106-06 | 2.5 | 1.3 | 1.2 | 3 | 2.8 |
| 106-07 | 2.8 | 1.3 | 1.1 | 3.5 | 2.8 |
| 106-08 | 3 | 1.3 | 1.1 | 4 | 3.8 |
| 106-09 | 2 | 1.3 | 1.1 | 2.5 | 2.5 |
| 106-10 | 1 | 2.5 | 2 | 2.5 | 2.5 |
| 106-11 | 1 | 2 | 1.5 | 2 | 3 |
| 106-12 | 1.5 | 1.5 | 2 | 1.5 | 3.2 |
| 106-13 | 1.5 | 2 | 1.2 | 2 | 3.5 |

Conclusion: GRU40-MRPs prepared with different weight ratios of sugar donors, amino acids and different times all exhibited pleasant flavor and achieved scores of overall likability above 2.5. The GRU40-MRPs prepared with the ratio of GRU40: glutamic acid:fructose=6:3:1 showed the most pleasant taste and achieved the score of overall likability of 4.

### Example 107. GRU40-MRP-CA (Ex. 106 Product 106-02) Improves the Taste Profile of Commercial Beverages

Commercial beverages: Details are shown in Table 107-1.

TABLE 107-1

| Product | Company | Lot# | Ingredients |
|---|---|---|---|
| Coke | CocaCola | 230519N10308 | Carbonated water, |
| STEVIA, | Singapore | | sucrose, caramel color, |
| 35% less | Beverages | | flavoring, phosphoric |
| sugar | PTE. LTD | | acid, preservative |
| | | | (sodium benzoate), |
| | | | caffeine and steviol |
| | | | glycoside (stevia leaf |
| | | | extract). |
| Genkiforest | Beijing | 20200612 | Water, milk powder, |
| milk tea | Genkiforest | | Crystalline fructose, |
| | Co., Ltd | | erythritol, jasmine tea, |
| | | | Assam black tea, single |
| | | | cream, natrascorb, |
| | | | sodium bicarbonate, |
| | | | stevioside, food |
| | | | flavoring |
| Nescafe | Xiamen Yinlu | 20200602 | Water, milk powder, |
| Silky | Food Group | | sugar, soluble coffee, |
| caramel | Co., Ltd | | food additives(sodium |
| flavor | | | bicarbonate, |
| | | | microcrystalline |
| | | | cellulose, sodium |
| | | | carboxymethylcellulose, |
| | | | sucrose fatty acid ester, |
| | | | sodium |
| | | | hexametaphosphate, |
| | | | sodium citrate), flavoring |

Process: GRU40-MRP-CA (product 106-02 in Ex. 106) powder was dissolved in the above-described beverages as described in Table 107-2 (where beverage=base).

TABLE 107-2
Sample compositions.

| | Weight/ | | |
|---|---|---|---|
| | GRU40- | Volume of | |
| | MRP-CA | beverage | Concentration |
| Components | (mg) | (mL) | (ppm) |
| Base | — | 100 | — |
| GRU40-MRP-CA | 5 | 100 | 50 |

Experiment: Each sample was evaluated according to the sensory evaluation method in Ex. 5. Average scores from the test panel for each sensory criterion were recorded as the evaluation test results. The taste profiles of the mixtures are described in Table 107-3.

TABLE 107-3
Sensory evaluation results.

| | Sensory | | GRU40- | |
|---|---|---|---|---|
| Beverage | characteristic | Base | MRP-CA | Evaluation |
| Coke | Flavor | 2 | 2.3 | GRU40-MRP-CA can |
| STEVIA, | Mouth feel | 2 | 2 | reduce the sweet |
| 35% less | Sweet | 3 | 1 | lingering, improve mouth |
| sugar | lingering | | | feel, and enhance the |
| | Overall | 2 | 2.5 | caramel flavor of the |
| | likability | | | Coke STEVIA, 35% less |
| | | | | sugar. |
| Genkiforest | Flavor | 3 | 3.2 | GRU40-MRP-CA can |
| milk tea | Mouth feel | 3 | 3.2 | improve mouth feel, |
| | Overall | 3 | 3.5 | caramel flavor and |
| | likability | | | overall likeability of |
| | | | | the Genkiforest milk tea |
| Nescafe | Flavor | 2 | 3 | GRU40-MRP-CA can |
| Silky | Mouth feel | 2 | 3 | improve mouth feel, |
| caramel | Sweet | 3 | 1 | caramel flavor, overall |
| flavor | lingering | | | likeability and cut sweet |
| | Overall | 2 | 3 | lingering of the Nescafe |
| | likability | | | Silky caramel flavor |

Conclusion: GRU40-MRP-CA (106-02 in Ex. 106) all can improve the taste profile of beverages such as Coke STEVIA, 35% less sugar, Genkiforest milk tea, Nescafe Silky caramel flavor. GRU40-MRP-CA can significantly improve mouth feel, flavor, cut sweet lingering and reduce bitterness of them. The results showed that glycosylated rubusoside-based Maillard reaction products can improve the taste profile of beverages.

### Example 108. Preparation of GRU40-MRP-FTAs from GRU40, Glucose, Phenylalanine and Essential Oil/Extracts

Raw material: GRU40: product of Ex. 58. Essential oil/natural extracts were obtained as described in Table 108-1.

TABLE 108-1

| Essential oil/ | | | |
|---|---|---|---|
| extract | Flavor type | Company | Lot# |
| Jasmin W | Jasmine | Chongqing Zhengyuan | 0001@081 |
| Rose Wat | Rose | flavor Co., Ltd | 0001@093 |
| Concentrated | Sugarcane | Hangzhou Xulang | G01L |
| sugarcane juice | | Biotechnology Co., LTD | |

Process: GRU40, glucose, phenylalanine, essential oil/extract and water were weighed and combined as set forth in Table 108-2. The resulting solutions were then heated at about 100° C. for an hour. When the reactions were completed, the solutions were filtered through filter paper and the filtrates were dried with a spray dryer, thereby resulting in products 108-01 to 108-03 as off white powders.

TABLE 108-2
Sample compositions.

| | | | | | Weight of | |
|---|---|---|---|---|---|---|
| | Weight of | Weight of | Weight of | Weight of | essential | Type of |
| Product | GRU40 | glucose | phenylalanine | water | oil/extract | essential |
| No. | (g) | (g) | (g) | (mL) | (mL) | oil/extract |
| 108-01 | 45 | 2 | 2 | 25 | 1.2 | Jasmine |
| 108-02 | | | | | | Rose |
| 108-03 | | | | | | Sugarcane |

### Example 109. GRU40-MRP-FTA Improves the Taste Profile of a Flavored Tea Beverage

Flavored tea beverage: Tea 7C Jasmine Tea (grapefruit flavor). Available from Nongfu Spring Co., Ltd. Lot #: 20200508.

Ingredients: water, high fructose corn syrup, granulate sugar, jasmine tea (green tea based), concentrated juice (grapefruit and pomelo), food additives (citric acid, sodium citrate, D-sodium erythorbate, stevioside), food flavoring.

Process: GRU40-MRP-FTA (product of 108-01 of Ex. 108) powder was dissolved in the above-described tea beverage (“Base”) as described in Table 109-1.

TABLE 109-1
Sample compositions.

| | Weight of | | |
|---|---|---|---|
| | GRU40- | Volume of tea | |
| | MRP-FTA | beverage | Concentration |
| Sample | (mg) | (ml) | (ppm) |
| Base | — | 100 | |
| 114-01 | 5.0 | 100 | 50 |

Experiment: Both samples were evaluated according to the sensory evaluation method in Ex. 5. Average scores from the test panel for each sensory criterion were recorded as the evaluation test results. The resulting taste profiles of the mixtures are shown Table 109-2.

TABLE 109-2
Sensory evaluation results.

| | Overall | | Mouth | | Sweet |
|---|---|---|---|---|---|
| Sample | likability | Flavor | feel | Bitterness | lingering |
| Reference | 3.0 | 2.5 | 2.0 | 2.5 | 3.5 |
| 108-01 | 4.0 | 3.5 | 2.5 | 1.5 | 2.0 |

Conclusion: GRU40-MRP-FTA (product 108-01 of Ex. 108) can enhance the mouth feel and jasmine flavor, and can reduce the sweet lingering and bitterness of the grapefruit flavored jasmine tea beverage. This results in an improved overall likability and taste profile of the flavored jasmine tea beverage.

### Example 110. GRU40-MRP-FTA Improves the Taste Profile of a Sugar-Free Tea Beverage

Commercial sugar-free tea beverage: Oriental Leaves Jasmine Tea. Available from Nongfu Spring Co., Ltd. Lot #:20200612.

Ingredients: Jasmine tea (green tea based), water, food additives (vitamin C, sodium bicarbonate).

Process: GRU40-MRP-FTA powder (Ex. 108, 108-01) was dissolved in the above-described tea beverage as described in Table 110-1.

TABLE 110-1
Sample compositions.

| | Weight of | | |
|---|---|---|---|
| | GRU40- | Volume of tea | |
| | MRP-FTA | beverage | Concentration |
| Sample | (mg) | (ml) | (ppm) |
| Base | — | 100 | |
| 108-01 | 5.0 | 100 | 50 |

Experiment: Each sample was evaluated according to the sensory evaluation method in Ex. 5. Average scores from the test panel for each sensory criterion were recorded as the evaluation test results. The resulting taste profile of the mixture is shown in Table 110-2.

TABLE 110-2
Sensory evaluation results.

| | Overall | | Mouth | |
|---|---|---|---|---|
| Sample | likability | Flavor | feel | Bitterness |
| Reference | 3.0 | 3.5 | 1.5 | 2.0 |
| 110-01 | 4.0 | 4.0 | 2.5 | 1.5 |

Conclusion: GRU40-MRP-FTA (Ex. 108, 108-01) can enhance the mouth feel, jasmine flavor, reduce bitterness of the sugar-free jasmine tea beverage. Resulting in an improved overall likability of the product. The results show that GRU40-MRP-FTA improved the taste profile of the sugar-free jasmine tea beverage.

### Example 111. GRU40-MRP-FTA Improves the Taste Profile of a Flavored Tea Beverage

Commercial flavored tea beverage: Tea 7C Black Tea (lychee and rose flavor) beverage.

Ingredients: water, high fructose corn syrup, granulated sugar, black tea, double-petaled rose (2.8 mg/L), concentrated lychee juice, crystallized fructose, food additives (citric acid, vitamin C, sodium citrate, D-sodium erythorbate, stevioside), food flavoring.

Process: GRU40-MRP-FTA (Ex. 108 product 108-02) powder was dissolved in the selected flavored tea beverage as described in Table 111-1.

TABLE 111-1
Sample compositions.

| | Weight of | | |
|---|---|---|---|
| | GRU40- | Volume of tea | |
| | MRP-FTA | beverage | Concentration |
| Sample | (mg) | (ml) | (ppm) |
| Base | — | 100 | |
| 108-02 | 5.0 | 100 | 50 |

Experiment: Each sample was evaluated according to the sensory evaluation method in Ex. 5. Average scores from the test panel for each sensory criterion were recorded as the evaluation test results. The resulting taste profile of the mixture is shown in Table 111-2.

TABLE 111-2
Sensory evaluation results.

| | Overall | | Mouth | | Sweet |
|---|---|---|---|---|---|
| | likability | Flavor | feel | Bitterness | lingering |
| Reference | 2.5 | 2.5 | 2.0 | 2.0 | 3.5 |
| 108-02 | 4.0 | 3.5 | 2.5 | 1.5 | 2.5 |

Conclusion: GRU40-MRP-FTA (product 108-02 of Ex. 108) can enhance the mouth feel and rose flavor, and can reduce bitterness and sweet lingering of the rose and lychee flavored black tea beverage. This improved the overall likability of the product and taste profile of the lychee flavored black tea beverage.

### Example 112. GRU40-MRP-FTA Improves the Taste Profile of a Commercial Carbonated Beverage

Commercial carbonated beverage: Light Diet Coke, available from Coca-Cola Beijing Co., Ltd, lot #: 20200714.

Ingredients: water, food additives (carbon dioxide, caramel color, phosphoric acid, acesulfame potassium, sodium dihydrogen phosphate, sodium benzoate, caffeine, citric acid, L(+)-tartaric acid, sucralose), food flavoring.

Process: Dissolve a certain amount of GRU40-MRP-FTA (product 108-03 of Ex. 108) powder into the selected carbonated drink as described in Table 112-1.

TABLE 112-1
Sample compositions.

| | Weight of | | |
|---|---|---|---|
| | GRU40- | Volume of | |
| | MRP-FTA | Diet Coke | Concentration |
| Sample | (mg) | (ml) | (ppm) |
| Base | — | 100 | |
| 108-03 | 5.0 | 100 | 50 |

Experiment: Each sample was evaluated according to the sensory evaluation method in Ex. 5. Average scores from the test panel for each sensory criterion were recorded as the evaluation test results. The resulting taste profile of the mixture is shown in Table 112-2.

TABLE 112-2
Sensory evaluation results.

| | Overall | | Mouth | Metallic | Sweet |
|---|---|---|---|---|---|
| Sample | likability | Flavor | feel | aftertaste | lingering |
| Reference | 2.5 | 3.0 | 1.5 | 2.5 | 3.0 |
| 108-03 | 3.5 | 3.5 | 1.5 | 1.5 | 1.5 |

Conclusion: GRU40-MRP-FTA can enhance the caramel flavor while significantly reducing the metallic aftertaste and sweet linger of Diet Coke. In addition, by adding GRU40-MRP-FTA, the original mouth feel was maintained, which in turn resulted in an improved overall likability of the product. The results showed that GRU40-MRP-FTA can improve the taste profile of low-sugar carbonated beverages.

### Example 113. Preparation of GRU40-MRP-CA Product Using Xylose Syrup as a Sugar Donor

Raw material: GRU40: the product of Ex. 58.

Xylose syrup (xylose content: 20.186%; solid content: 76.37%), available from China Haisheng Fresh Fruit Juice Co., Ltd, Weinan Branch, lot #: 25191005B01-05. Maltodextrin: available from BAOLINGBAO BIOLOGY Co., Ltd.

Process: GRU40, xylose syrup, glutamic acid, water were weighed as described in Table 113-1. All the ingredients were mixed and fully dissolved in the water. The solution was then heated at about 100° C. for 2 hours. When the reaction was completed, the solution was filtered through filter paper and the filtrate was dried with a spray dryer, resulting in product 113-01 as a brown powder.

TABLE 113-1
Sample compositions.

| | | | Sugar donor | | | |
|---|---|---|---|---|---|---|
| | | Amino acid | Weight/ | | Weight of | |
| Product | Weight of | Weight/ | xylose | Xylose solid | maltodextrin | Weight of |
| No. | GRU40 (g) | alanine (g) | syrup (g) | equivalent (g) | (g) | water (mL) |
| 113-01 | 12 | 2 | 29.72 | 6 | 20 | 3 |

### Example 114. GRU40-MRP-CA Improves the Taste Profile of a Commercial Low-Sugar Carbonated Drink

Commercial carbonated drink: Light Diet Coke, available from Coca-Cola Beijing Co., Ltd, lot #: 20200714.

Ingredients: water, food additives (carbon dioxide, caramel color, phosphoric acid, acesulfame potassium, sodium dihydrogen phosphate, sodium benzoate, caffeine, citric acid, L(+)-tartaric acid, sucralose), food flavoring.

Process: GRU40-MRP-CA (Ex. 113, 113-01) powder was dissolved in the commercial carbonated drink as described in Table 114-1.

TABLE 114-1
Sample compositions.

| | Weight of | Volume of | |
|---|---|---|---|
| | GRU40- | Diet Coke | Concentration |
| Sample | MRP-CA(mg) | (ml) | (ppm) |
| Base | — | 100 | |
| 113-01 | 5.0 | 100 | 50 |

Experiment: Each sample was evaluated according to the sensory evaluation method in Ex. 5. Average scores from the test panel for each sensory criterion were recorded as the evaluation test results. The resulting taste profile of the mixture is shown in Table 114-2.

TABLE 114-2
Sensory evaluation results.

| | Overall | | Mouth | Metallic | Sweet |
|---|---|---|---|---|---|
| | likability | Flavor | feel | aftertaste | lingering |
| Reference | 2.5 | 3.0 | 1.5 | 2.5 | 3.0 |
| 113-01 | 3.5 | 3.5 | 2.0 | 1.5 | 1.5 |

Conclusion: GRU40-MRP-CA (product of Ex. 113) can enhance the caramel flavor and improve the mouth feel of the product while significantly reducing the metallic aftertaste and sweet linger of Diet Coke. The results show that in an improved overall likability of and taste profile the product. The results showed that GRU40-MRP-CA can improve the overall likability and taste profile of a commercial low-sugar carbonated beverage.

### Example 115. Preparation of GRU40-MRP-FTA from GRU40 (Ex. 58 Product), Fructose, Glutamic Acid and Essential Oil/Essence

Raw material: GRU40: the product of Ex. 58.

Essential oils: Lemon Juice Aroma Extract. Company: Chongqing Zhengyuan flavor Co., Ltd. Lot #: Y0034434.

Process: GRU40, fructose, glutamic acid, essential oil, water were weighed as described in Table 115-1. The solution was then heated at about 100° C. for 2 hours. When the reaction was completed, the solution was filtered through filter paper and the filtrate was dried with a spray dryer, thereby resulting in Product 115-01 as an off white powder.

TABLE 115-1
Test sample composition.

| | | | | Weight/ | | |
|---|---|---|---|---|---|---|
| Product | Product | Weight/ | Weight/ | glutamic | Weight/ | Weight/essential |
| name | No. | GRU40 (g) | fructose (g) | acid (g) | water (mL) | oil/essence (mL) |
| GRU40- | 115-01 | 45 | 3.75 | 1.25 | 25 | Lemon Juice |
| MRP-FTA | | | | | | Aroma Extract/1.2 |

### Example 116. GRU40-MRP-FTA Improves the Taste and Mouth Feel of Sucralose when Blended Therewith

Process: GRU40-MRP-FTA (Ex. 115, 115-01) and sucralose (available from Anhui Jinhe Industrial Co., Ltd and Lot # is 201810013) were weighed and dissolved in 100 ml pure water as described in Table 116-1, and subjected to a mouth feel evaluation test, the results of which are described in Table 116-2.

TABLE 116-1
Sample compositions.

| | Sucralose to | | Weight of | |
|---|---|---|---|---|
| | GRU40- | Weight of | GRU40- | Volume of |
| | MRP-FTA | sucralose | MRP-FTA | pure water |
| No. | ratio | (mg) | (mg) | (mL) |
| 116-00 | 10/0 | 15 | 0 | 100 |
| 116-01 | 10/1 | 15 | 1.5 | 100 |
| 116-02 | 10/3 | 15 | 4.5 | 100 |
| 116-03 | 10/5 | 15 | 7.5 | 100 |
| 116-04 | 10/7 | 15 | 10.5 | 100 |
| 116-05 | 10/9 | 15 | 13.5 | 100 |
| 116-06 | 10/10 | 15 | 13 | 100 |
| 116-07 | 10/40 | 15 | 60 | 100 |
| 116-08 | 10/70 | 15 | 105 | 100 |
| 116-09 | 10/100 | 15 | 150 | 100 |

Experiments: Several mixtures of GRU40-MRP-FTA and sucralose were mixed and dissolved in water. Each sample was evaluated according to the sensory evaluation method in Ex. 5. Average scores from the test panel for each sensory criterion were recorded as the evaluation test results. The resulting taste profiles of the mixtures are set forth in Table 116-2. It should be noted that according to the sensory evaluation method, the concentration of sucralose in the sample solutions was the same, 150 ppm.

TABLE 116-2
Sensory evaluation results.

| | Mouth | Sweet | Metallic | Overall |
|---|---|---|---|---|
| No. | feel | lingering | aftertaste | likability |
| 116-00 | 1.00 | 3.00 | 3.50 | 2.25 |
| 116-01 | 1.50 | 3.00 | 2.50 | 2.80 |
| 116-02 | 2.00 | 2.00 | 2.00 | 3.50 |
| 116-03 | 3.00 | 1.50 | 1.50 | 4.00 |
| 116-04 | 3.50 | 1.50 | 1.00 | 4.20 |
| 116-05 | 3.50 | 1 | 1.00 | 4.50 |
| 116-06 | 3.50 | 1 | 1.00 | 4.50 |
| 116-07 | 4.00 | 1.50 | 1.20 | 3.80 |
| 116-08 | 4.20 | 1.50 | 1.50 | 3.50 |
| 116-09 | 4.50 | 1.50 | 2.00 | 3.50 |

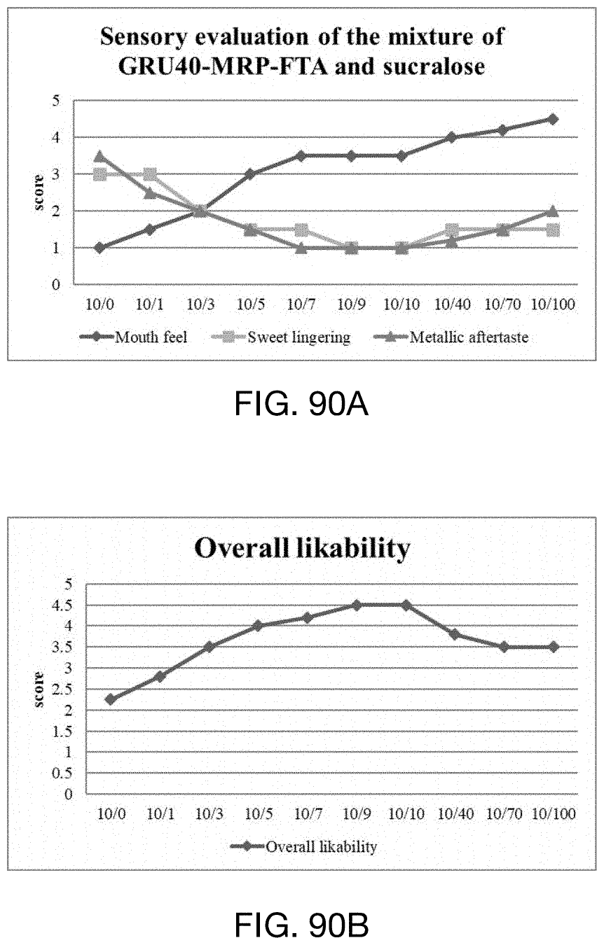

Data analysis: The relationship between the sensory evaluation results to the ratio of sucralose to GRU40-MRP-FTA in this example is shown in FIG. 90A. The relationship between the overall likability results to the ratio of sucralose to GRU40-MRP-FTA in this example is shown in FIG. 90B.

Conclusion: The results show that GRU40-MRP-FTA (Ex. 115, 115-01) can significantly improve the mouth feel, cut the sweet lingering and decrease the metallic aftertaste of sucralose. This effect was observed in all the tested sucralose-to-GRU40-MRP-FTA ratios (from 10:1 to 10:100). These effects can be extended to sucralose-to-GRU40-MRP-FTA ratio ranges of 99:1 to 1:99. This example demonstrates that GRU40-MRP-FTA can improve the taste, flavor intensity and mouth feel of artificial sweeteners, such as sucralose. Such effects can be extended to all artificial sweeteners.

### Example 117. GRU40-MRP-FTA Improves the Taste and Mouth Feel of GSG-MRP-CA

Process: GRU40-MRP-FTA (Ex. 115, 115-01) and GSG-MRP-CA (available from Sweet Green Field, Lot #20200101) were weighed and dissolved in 100 ml pure water according to Table 117-1, and subjected to mouth feel evaluation tests as set forth in Table 117-2.

TABLE 117-1
Sample compositions.

| | GSG- | | | |
|---|---|---|---|---|
| | MRP-CA to | Weight of | Weight of | |
| | GRU40- | GSG- | GRU40- | Volume of |
| | MRP-FTA | MRP-CA | MRP-FTA | pure water |
| No. | ratio | (mg) | (mg) | (mL) |
| 117-00 | 10/0 | 20 | 0 | 100 |
| 117-01 | 10/1 | 20 | 2 | 100 |
| 117-02 | 10/3 | 20 | 6 | 100 |
| 117-03 | 10/5 | 20 | 10 | 100 |
| 117-04 | 10/7 | 20 | 14 | 100 |
| 117-05 | 10/9 | 20 | 18 | 100 |
| 117-06 | 10/10 | 20 | 20 | 100 |
| 117-07 | 10/40 | 20 | 80 | 100 |
| 117-08 | 10/70 | 20 | 140 | 100 |
| 117-09 | 10/100 | 20 | 200 | 100 |

Experiments: Several mixtures of GRU40-MRP-FTA and GSG-MRP-CA were prepared. Each sample was evaluated according to the sensory evaluation method in Ex. 5. Average scores from the test panel for each sensory criterion were recorded as the evaluation test results. The resulting taste profiles of the mixture are shown in Table 117-2. It should be noted that according to the sensory evaluation method, the concentration of GSG-MRP-CA in the sample solutions was the same, 200 ppm.

TABLE 117-2
Sensory evaluation results.

| | Mouth | Sweet | Metallic | Overall |
|---|---|---|---|---|
| No. | feel | lingering | aftertaste | likability |
| 117-00 | 2 | 3.00 | 2.00 | 3 |
| 117-01 | 2.50 | 2.20 | 1.80 | 3.50 |
| 117-02 | 3.00 | 2.00 | 1.50 | 4.00 |
| 117-03 | 3.20 | 1.50 | 1.50 | 4.20 |
| 117-04 | 3.50 | 1.50 | 1.00 | 4.30 |
| 117-05 | 4.00 | 1 | 1.00 | 4.50 |
| 117-06 | 4.00 | 1 | 1.00 | 4.50 |
| 117-07 | 4.00 | 1 | 1.20 | 3.50 |
| 117-08 | 4.20 | 1.50 | 1.50 | 3.50 |
| 117-09 | 4.20 | 1.50 | 2.00 | 3.50 |

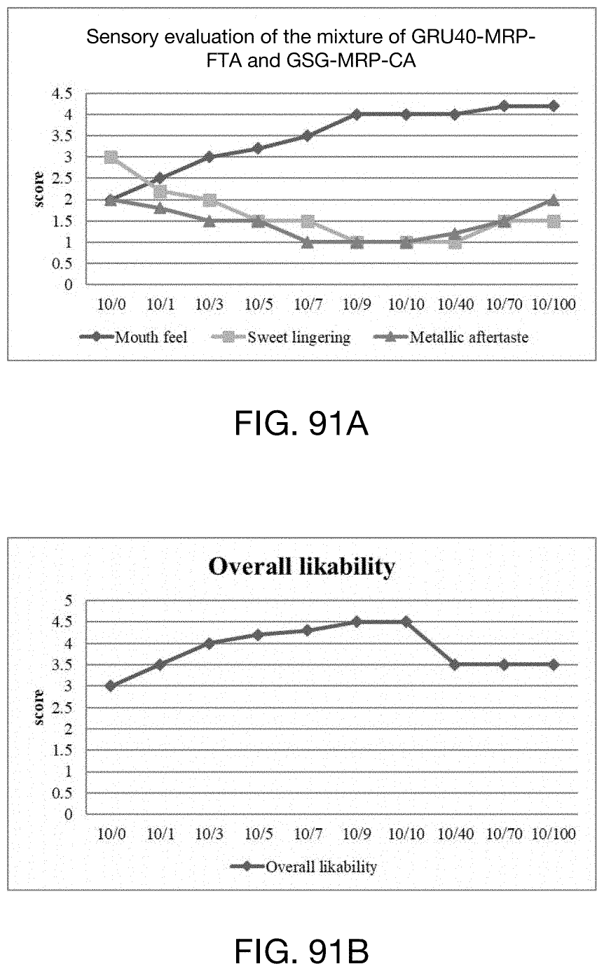

Data analysis: The relationship between the sensory evaluation results to the ratio of GSG-MRP-CA to GRU40-MRP-FTA in this example is shown in FIG. 91A. The relationship between the overall likability results to the ratio of GSG-MRP-CA to GRU40-MRP-FTA in this example is shown in FIG. 911B.

Conclusion: The results show that GRU40-MRP-FTA (Ex. 115, 115-01) can significantly improve the mouth feel and decrease the sweet lingering and metallic aftertaste of GSG-MRP-CA. This effect was observed at all tested GSG-MRP-CA-to-GRU40-MRP-FTA ratios (from 10:1 to 10:100). The effect can be extended to the GSG-MRP-CA-to-GRU40-MRP-FTA ratio range of 99:1 to 1:99. This example demonstrates that GRU40-MRP-FTA can improve the taste, flavor intensity and mouth feel of natural sweeteners, such as GSG-MRP-CA, and can be extended to other artificial sweeteners.

### Example 118. GRU40-MRP-CA Improves the Taste Profile of Thaumatin when Blended Therewith

Process: GRU40-MRP-CA (Ex. 106, 106-02) and thaumatin (available from EPC Natural products CO., Ltd; the content of thaumatin was 93%, Lot #: 20200201) were weighed, mixed, dissolved in 100 ml pure water as set forth in Table 118-1, and subjected to sensory evaluation and time intensity tests as set forth in Tables 118-2 and 118-3, respectively.

TABLE 118-1
Preparation of mixtures of GRU40-MRP-CA and thaumatin.

| | Thaumatin to | | Weight of | |
|---|---|---|---|---|
| Sample | GRU40- | Weight of | GRU40- | Volume of |
| mixture | MRP-CA | thaumatin | MRP-CA | pure water |
| No. | ratio | (mg) | (mg) | (mL) |
| 118-00 | 15/0 | 15 | 0 | 100 |
| 118-01 | 15/5 | 15 | 5 | 100 |
| 118-02 | 15/15 | 15 | 15 | 100 |
| 118-03 | 15/30 | 15 | 30 | 100 |
| 118-04 | 15/45 | 15 | 45 | 100 |
| 118-05 | 15/60 | 15 | 60 | 100 |
| 118-06 | 15/90 | 15 | 90 | 100 |
| 118-07 | 15/150 | 15 | 150 | 100 |
| 118-08 | 15/200 | 15 | 200 | 100 |

Experiments: Several mixtures of GRU40-MRP-CA and thaumatin were prepared according to Table 118-1 and evaluated according to the sensory evaluation methods in Ex. 5. Average scores from the test panel for each sensory criterion were recorded as the evaluation test results, resulting in the taste profiles depicted in Table 118-2. In the sensory evaluations, the concentration of thaumatin in the sample solutions was the same (15 ppm). Time intensity results are shown in 118-3.

TABLE 118-2
Sensory evaluation results.

| Sample | Sweet | Overall |
|---|---|---|
| mixture no. | lingering | likability |
| 118-00 | 5 | 1.5 |
| 118-01 | 4.5 | 1.5 |
| 118-02 | 4 | 2 |
| 118-03 | 3.5 | 2.5 |
| 118-04 | 3 | 3 |
| 118-05 | 3 | 3 |
| 118-06 | 3 | 3 |
| 118-07 | 2.5 | 3.5 |
| 118-08 | 2.5 | 3.5 |

TABLE 118-3
Time-intensity results

| | | | LINGERING | LINGERING |
|---|---|---|---|---|
| Sample | ONSET | MAX | ON | OFF |
| mixture no. | [sec] | [sec] | [sec] | [sec] |
| 118-00 | 5.50 | 17.56 | 24.04 | 37.25 |
| 118-01 | 5.11 | 16.53 | 21.85 | 34.08 |
| 118-02 | 3.25 | 13.87 | 18.27 | 28.32 |
| 118-03 | 3.25 | 11.60 | 17.33 | 26.46 |
| 118-04 | 3.24 | 11.28 | 13.69 | 22.20 |
| 118-05 | 2.86 | 10.78 | 13.60 | 21.18 |
| 118-06 | 2.47 | 10.51 | 13.55 | 20.14 |
| 118-07 | 2.29 | 10.20 | 13.54 | 19.85 |
| 118-08 | 2.17 | 9.98 | 13.40 | 19.26 |

FIG. 92A shows the relationship between the overall likability results as a function of the weight ratio of thaumatin to GRU40-MRP-CA. FIG. 92B shows the time-intensity curves as a function of the weight ratio of thaumatin to GRU40-MRP-CA.

Conclusion: The results show that GRU40-MRP-CA (Ex. 106, 106-02) can significantly reduce the sweet linger and quicken the sweetness onset of the thaumatin solution. This effect was observed at all tested thaumation-to-GRU40-MRP-CA ratios (from 15:1 to 15:150). The effect can be extended to the thaumatin-to-GRU40-MRP-CA ratio range of 99:1 to 1:99. This example demonstrates that GRU40-MRP-CA can improve taste profile and cut sweet linger of the thaumatin solutions.

### Example 119. GRU40-MRP-CA Improves the Taste Profile of Acesulfame-K when Blended Therewith

Process: GRU40-MRP-CA (Ex. 106, 106-02) and acesulfame-K (available from JINGDA PERFUME) were weighed and uniformly mixed according to Table 119-1, dissolved in 100 ml pure water, and subjected to a sensory evaluation tests.

TABLE 119-1
Sample compositions.

| | Acesulfame-K | | Weight of | |
|---|---|---|---|---|
| | to GRU40- | Weight of | GRU40- | Volume of |
| | MRP-CA | acesulfame-K | MRP-CA | pure water |
| No. | ratio | (mg) | (mg) | (mL) |
| 119-00 | 10/0 | 20 | 0 | 100 |
| 119-01 | 10/1 | 20 | 2 | 100 |
| 119-02 | 10/3 | 20 | 6 | 100 |
| 119-03 | 10/5 | 20 | 10 | 100 |
| 119-04 | 10/7 | 20 | 14 | 100 |
| 119-05 | 10/9 | 20 | 18 | 100 |
| 119-06 | 10/10 | 20 | 20 | 100 |
| 119-07 | 10/40 | 20 | 80 | 100 |
| 119-08 | 10/70 | 20 | 140 | 100 |
| 119-09 | 10/100 | 20 | 200 | 100 |

Experiments

Several mixtures of GRU40-MRP-CA and acesulfame-K were prepared. Each sample was evaluated according to the sensory evaluation method in Ex. 5. Average scores from the test panel for each sensory criterion were recorded as the evaluation test results. The taste profiles of the mixtures are set forth in Table 119-2. It should be noted that according to the sensory evaluation method, the concentration of acesulfame-K in the sample solution was the same, 200 ppm.

TABLE 119-2
Sensory evaluation results.

| | Mouth | Sweet | | Metallic | Overall |
|---|---|---|---|---|---|
| No. | feel | lingering | Bitterness | aftertaste | likability |
| 119-00 | 2.00 | 3.00 | 3.00 | 3.00 | 2.50 |
| 119-01 | 2.50 | 2.50 | 3.00 | 2.00 | 2.90 |
| 119-02 | 3.00 | 2.00 | 2.00 | 2.00 | 3.50 |
| 119-03 | 4.00 | 2.00 | 1.50 | 1.50 | 4.20 |
| 119-04 | 4.00 | 2.00 | 1.00 | 1.50 | 4.50 |
| 119-05 | 4.50 | 2.00 | 1.00 | 1.50 | 4.80 |
| 119-06 | 4.50 | 2.00 | 1.50 | 1.50 | 4.30 |
| 119-07 | 4.50 | 2.50 | 2.00 | 1.80 | 4.00 |
| 119-08 | 4.80 | 3.00 | 2.50 | 2.00 | 3.90 |
| 119-09 | 5.00 | 3.00 | 2.50 | 2.00 | 3.50 |

Data analysis: The relationship between the sensory evaluation results to the ratio of acesulfame-K to GRU40-MRP-CA are shown in FIG. 93A. The relationship between the overall likability results to the ratio of acesulfame-K to GRU40-MRP-CA is shown in FIG. 93B.

Conclusion: The results show that GRU40-MRP-CA can significantly improve the mouth feel, and decrease the sweet lingering, metallic aftertaste and bitterness of acesulfame-K. This effect was observed at all the tested acesulfame-K-to-GRU40-MRP-CA ratios (from 10:1 to 10:100). The effect can be extended to acesulfame-K-to-GRU40-MRP-CA ratio ranges of 99:1 to 1:99. This example demonstrates that GRU40-MRP-CA can improve taste and mouth feel of artificial sweeteners, such as acesulfame-K. Such effects can be extended to all artificial sweeteners.

### Example 120. GRU40-MRP-CA (Ex. 106, 106-02) Improves the Taste Profile of RA97

Process: GRU40-MRP-CA and RA97 (available from Sweet Green Fields; the content is 97.15%. Lot #3050123) were weighed and dissolved in 100 ml pure water, and subjected to sensory evaluation tests as set forth in Table 120-1.

TABLE 120-1
Preparation of mixtures of GRU40-MRP-CA and RA97.

| | RA97 to | | Weight of | |
|---|---|---|---|---|
| | GRU40- | Weight of | GRU40- | Volume of |
| | MRP-CA | RA97 | MRP-CA | pure water |
| No. | ratio | (mg) | (mg) | (mL) |
| 120-00 | 10/0 | 20 | 0 | 100 |
| 120-01 | 10/1 | 20 | 2 | 100 |
| 120-02 | 10/3 | 20 | 6 | 100 |
| 120-03 | 10/5 | 20 | 10 | 100 |
| 120-04 | 10/7 | 20 | 14 | 100 |
| 120-05 | 10/9 | 20 | 18 | 100 |
| 120-06 | 10/10 | 20 | 20 | 100 |
| 120-07 | 10/40 | 20 | 80 | 100 |
| 120-08 | 10/70 | 20 | 140 | 100 |
| 120-09 | 10/100 | 20 | 200 | 100 |

Experiment: Several mixtures of RA97 and GRU40-MRP-CA were mixed in this example. Each sample was evaluated according to the sensory evaluation method in Ex. 5. Average scores from the test panel for each sensory criterion were recorded as the evaluation test results. The taste profiles of the resulting mixtures are described in Table 120-2. It should be noted that according to the sensory evaluation method, in these evaluations, the concentration of RA97 in the sample solution was the same, 200 ppm. The results are shown in Table 120-2.

TABLE 120-2
Sensory evaluation results.

| | Mouth | Sweet | | Overall |
|---|---|---|---|---|
| No. | feel | lingering | Bitterness | likability |
| 120-00 | 1 | 3 | 3 | 2 |
| 120-01 | 1.5 | 2.5 | 2.8 | 2.4 |
| 120-02 | 2 | 2 | 2.3 | 3 |
| 120-03 | 3 | 1.5 | 2 | 3.75 |
| 120-04 | 3.5 | 1.5 | 1.3 | 4.5 |
| 120-05 | 4 | 1.5 | 1.5 | 4.3 |
| 120-06 | 4 | 1.5 | 2 | 4.2 |
| 120-07 | 4.5 | 1.5 | 2 | 3.5 |
| 120-08 | 4.5 | 1.5 | 2.5 | 3 |
| 120-09 | 5 | 1.5 | 2.7 | 3 |

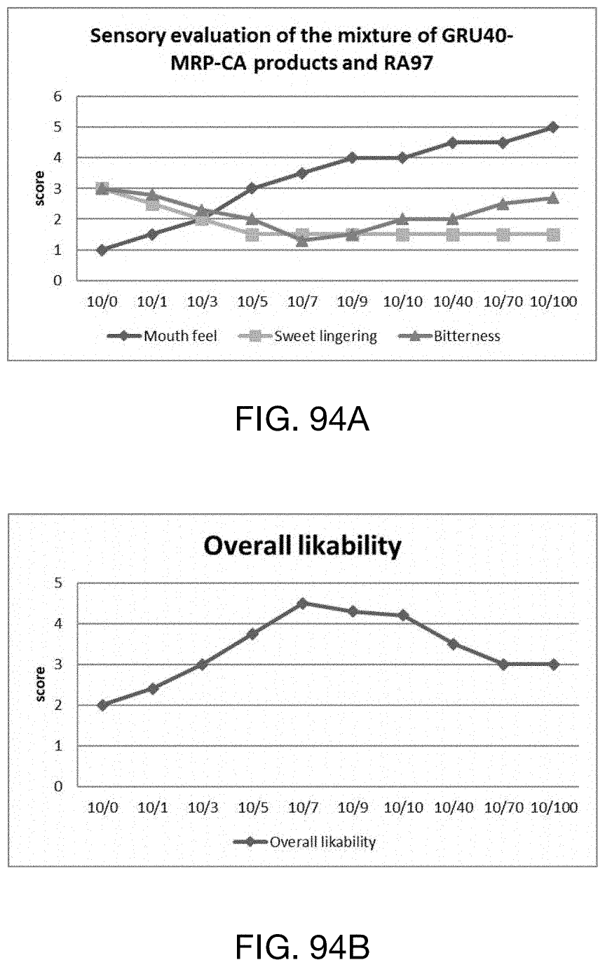

Data analysis: The relationship between the sensory evaluation results to the ratio of RA97 to GRU40-MRP-CA is shown in FIG. 94A. The relationship between the overall likability results to the ratio of RA97 to GRU40-MRP-CA is shown in FIG. 94B.

Conclusion: The result show that GRU40 can significantly improve the mouth feel, reduce the sweet lingering and decrease the bitterness of RA97. These effects were observed at all tested RA97-to-GRU40-MRP-CA ratios (from 10:1 to 10:100) and can be extended to RA97-to-GRU40-MRP-CA ratio ranges of 99:1 to 1:99. This example demonstrates that GRU40-MRP-CA can improve the taste and mouth feel of natural sweeteners, such as RA97 and can be further extended to all natural sweeteners.

### Example 121. Preparation of GRU90-MRP-FTA from GRU90, Fructose, Glutamic Acid and Essential Oil/Essence

Raw materials: GRU90: the product of Ex. 7. Essential oil/essence are available as described in Table 127-1.

TABLE 121-1
Essential oils/essences

| Type | Company | Lot# |
|---|---|---|
| Cucumber Nat pro 200 | Chongqing Zhengyuan | Ref. 26444 |
| | flavor Co., Ltd | |
| Menthe arvensis leaf oil | AA skincare Ltd | 7523500043 |

Process: GRU90, fructose, glutamic acid, essential oil/essence, water were combined as set forth in Table 121-2. The resulting solutions were then heated at about 100° C. for 2 hour. When the reactions were completed, the solutions were filtered through filter paper and the filtrates were dried with a spray dryer, thereby resulting in Products 121-01 to 121-02 as off white powders.

TABLE 121-2
Sample compositions.

| | | | | Weight of | | |
|---|---|---|---|---|---|---|
| Product | Product | Weight of | Weight of | glutamic | Weight of | Weight of essential |
| name | No. | GRU90(g) | fructose(g) | acid(g) | water(mL) | oil/essence (mL) |
| GRU90- | 121-01 | 45 | 3.750 | 1.25 | 25 | Cucumber Nat |
| MRP-FTA | | | | | | pro 200 (0.1 mL) |
| | 121-02 | | 4.375 | 0.625 | | Menthe arvensis |
| | | | | | | Leaf oil (0.05 mL) |

Conclusion: All products obtained from above process were clear solutions. This demonstrates that sweet tea extracts and their glycosylated products or MRPs can act as excellent carriers or flavor ingredients. The final products can be in powder or liquid form. This technology can be used to produce water-soluble essential oils and products in powder form. The flavor intensity of the products produced by this technology was significantly intensified. There was synergy between the flavor ingredient and carrier. This technology can be used for any type of oils or soluble ingredients. The resulting products, including the soluble flavor ingredients, can enhance the retronasal flavor when added to foods and beverages.

### Example 122. GRU90-MRP-FTA Improves Taste Profile of Commercial Lemon Water

Commercial Suntory lemon water, available from Suntory (China) Co., Ltd.

Ingredients: Water, sugar, food additives (carbon dioxide, citric acid), food flavor, honey, and lemon concentrated juice.

Process: A GRU90-MRP-FTA (121-01 in Ex. 121) powder sample was dissolved in the base as described in Table 122-1.

TABLE 122-1
Sample compositions.

| | Weight of | | |
|---|---|---|---|
| | GRU90- | Volume of | |
| | MRP-FTA | base | Concentration |
| Sample | (mg) | (ml) | (ppm) |
| Base | — | 100 | |
| 121-01 | 5 | 100 | 50 |

Experiment: Each sample was evaluated according to the sensory evaluation method in Ex. 5. Average scores from the test panel for each sensory criterion were recorded as the evaluation test results. The resulting taste profile of the mixture is shown in Table 122-2.

TABLE 122-2
Sensory evaluation results

| | Overall | | | Sweet |
|---|---|---|---|---|
| | likability | Flavor | Refreshing | lingering |
| Base | 2.5 | 2 | 2 | 4 |
| 121-01 | 4.5 | 4.5 | 3.5 | 1.5 |

Conclusion: GRU90-MRP-FTA (127-01 in Ex. 121) can significantly reduce sweet lingering in commercial Suntory lemon water. In addition, GRU90-MRP-FTA (121-01 in Ex. 121) provided an enhanced lemon flavor compared to the base. The results show that the taste profile of commercial Suntory lemon water can be improved by GRU90-MRP-FTA (121-01 in Ex. 121). This effect can be extended to fruity soft drinks as further described below.

### Example 123. GRU90-MRP-FTA Improves the Taste Profile of Commercial Peach Water

Commercial Suntory peach water, available from Suntory (China) Co., Ltd.

Ingredients: Water, sugar, food additives (carbon dioxide, citric acid), food flavor, honey, peach concentrated juice.

Process: GRU90-MRP-FTA (121-02 in Ex. 121) was powder was dissolved in base as set forth in Table 123-1 and compared to the base in the sensory evaluation test below.

TABLE 123-1
Sample compositions.

| | Weight of | | |
|---|---|---|---|
| | GRU90-MRP- | Volume of | Concentration |
| Sample | FTA (mg) | base (ml) | (ppm) |
| Base | — | 100 | |
| 121-02 | 5 | 100 | 50 |

Experiment: Each sample was evaluated according to the sensory evaluation method in Ex. 5. Average scores from the test panel for each sensory criterion were recorded as the evaluation test results. The resulting taste profiles of the mixture and the base are set forth in Table 123-2.

TABLE 123-2
Sensory evaluation results.

| | Overall | | | Sweet |
|---|---|---|---|---|
| Sample | likability | Flavor | Refreshing | lingering |
| Base | 2 | 2.5 | 2.5 | 4 |
| 121-02 | 4.5 | 4.5 | 4 | 1.5 |

Conclusion: GRU90-MRP-FTA (121-02 in Ex. 121) significantly reduced sweet lingering in commercial Suntory peach water. In addition, GRU90-MRP-FTA (121-02 in Ex. 121) provided an enhanced peach flavor compared to itself. The results showed that the taste profile of commercial Suntory peach water can be improved with GRU90-MRP-FTA. This effect can be extended to all fruity soft drinks.

### Example 124. GRU90-MRP-FTA and Thaumatin Synergistically Improves the Taste Profile of Commercial Peach Water

Commercial Suntory peach water, available from Suntory (China) Co., Ltd.

Ingredients: Water, sugar, food additives (carbon dioxide, citric acid), food flavor, honey, peach concentrated juice.

Process: GRU90-MRP-FTA (39-10 in Ex. 39) powder and thaumatin were dissolved in the base as set forth in Table 130-1.

TABLE 124-1
Sample compositions.

| | Weight of | | | GRU90- | |
|---|---|---|---|---|---|
| | GRU90- | Weight of | Volume of | MRP-FTA | Thaumatin |
| | MRP-FTA | Thaumatin | base | Concentration | Concentration |
| Sample | (mg) | (mg) | (ml) | (ppm) | (ppm) |
| Base | — | | 100 | | |
| 39-10 | 5 | | 100 | 50 | |
| Thaumatin | | 0.05 | 100 | 50 | 0.5 |
| 39-10 and | 5 | 0.05 | 100 | 50 | 0.5 |
| Thaumatin | | | | | |

Experiment: Each sample was evaluated according to the sensory evaluation method in Ex. 5. Average scores from the test panel for each sensory criterion were recorded as the evaluation test results. The resulting taste profiles of the mixture and controls are shown in Table 124-2.

TABLE 124-2
Sensory evaluation results

| | Overall | | | Sweet |
|---|---|---|---|---|
| Sample | likability | Flavor | Refreshing | lingering |
| Base | 2 | 2.5 | 2.5 | 4 |
| 39-10 | 3.8 | 3.5 | 4 | 1.5 |
| Thaumatin | 2.5 | 3 | 2.5 | 4 |
| 39-10 and | 4.5 | 4.5 | 4 | 1.5 |
| Thaumatin | | | | |

Conclusion: GRU90-MRP-FTA significantly reduces sweet lingering and improves flavor and refreshing in peach flavor water. Thaumatin also can improve the flavor. Importantly, GRU90-MRP-FTA and thaumatin can synergistically improve the taste profile of commercial Suntory peach water. This effect can be extended to all fruit soft drinks.

### Example 125. Preparation of GRU90-MRP-FTA Formed from GRU90 Using Concentrated Apple Syrup as a Sugar Donor

Raw materials: GRU90: the product of Ex. 7; concentrated apple syrup: Decolorized and deacidified concentrated apple juice (fructose content: 36.77%), available from China Haisheng Fresh Fruit Juice Co. Ltd, Weinan Branch, Lot #:25191005B01-05.

Process: GRU90, concentrated apple syrup, glutamic acid, and water were weighed, mixed and dissolved. The resulting solution was then heated at about 100° C. for 1.5 hours. When the reaction was completed, the solution was filtered through filter paper and the filtrate was dried with a spray dryer, resulting in product 125-01 as off-white powder.

TABLE 125-1

| | Weight/ | Weight/ | Weight/ | Fructose | Weight of |
|---|---|---|---|---|---|
| Product | GRU90 | glutamic | concentrated | solid equiv. | water |
| No. | (g) | acid (g) | apple syrup (g) | (g) | (g) |
| 125-01 | 18 | 1 | 15.82 | 5.82 | 4 |

### Example 126. GRU90-MRP-FTA Improves the Taste Profile of Artificial Sweeteners

Raw materials: 1) GRU90-MRP-FTA (from Ex. 125, 125-01); 2) Artificial sweeteners: sucralose, available from Anhui Jinhe Industrial Co., Ltd and Lot # is 201810013; and acesulfame-K, available from JINGDA PERFUME.

Process: GRU90-MRP-FTA (product of Ex. 125), sucralose and acesulfame-k were weighed, mixed, and dissolved in 100 mL pure water as set forth in Table 126-1.

TABLE 126-1
Preparation of mixtures of GRU90-MRP-FTA (product of
Ex. 125) in solution with sucralose and acesulfame-K.

| | Sucralose- | | | | |
|---|---|---|---|---|---|
| | acesulfame-K | | | | |
| | mixture to | | | Weight of | |
| Sample | GRU90- | Weight of | Weight of | GRU90- | Volume of |
| mixture | MRP-FTA | acesulfame-K | sucralose | MRP-FTA | pure water |
| No. | ratio | (mg) | (mg) | (mg) | (mL) |
| 126-01 | 10/0 | 4 | 6 | 0 | 100 |
| 126-02 | 100/1 | 4 | 6 | 0.1 | 100 |
| 126-03 | 100/10 | 4 | 6 | 1 | 100 |
| 126-04 | 100/50 | 4 | 6 | 5 | 100 |
| 126-05 | 100/100 | 4 | 6 | 10 | 100 |
| 126-06 | 100/150 | 4 | 6 | 15 | 100 |
| 126-07 | 100/200 | 4 | 6 | 20 | 100 |
| 126-08 | 100/300 | 4 | 6 | 30 | 100 |

*check for accuracy

Experiments: Several solution mixtures of GRU90-MRP with sucralose and acesulfame-K were prepared and evaluated according to the sensory evaluation methods in Ex. 5. Average scores from the test panel for each sensory criterion were recorded as the evaluation test results to produce the taste profiles depicted in Tables 126-2 and Table 126-3. Time-intensity curves were additionally recorded. In the sensory evaluations, the concentration of sucralose or the mixture solution (sucralose and acesulfame-K) in the sample solution were the same.

TABLE 126-2
Sensory evaluation results.

| Sample | Sweet | Metallic | | Overall |
|---|---|---|---|---|
| mixture no. | lingering | aftertaste | Bitterness | likability |
| 126-00 | 4 | 3 | 2.5 | 2.5 |
| 126-01 | 4 | 2.5 | 2 | 3 |
| 126-02 | 3 | 1.5 | 1.5 | 3.5 |
| 126-03 | 2 | 1 | 1 | 4.5 |
| 126-04 | 1.5 | 1 | 1 | 5 |
| 126-05 | 1.5 | 1 | 2 | 4.5 |
| 126-06 | 2 | 1.5 | 2 | 3 |
| 126-07 | 2.5 | 2 | 2 | 2.8 |

TABLE 126-3
Time-intensity results.

| | | | LINGERING | LINGERING |
|---|---|---|---|---|
| Product | ONSET | MAX | ON | OFF |
| No. | [sec] | [sec] | [sec] | [sec] |
| 126-00 | 1.8 | 3.5 | 6 | 17 |
| 126-01 | 1.5 | 3 | 5 | 14 |
| 126-02 | 1 | 2 | 5 | 12 |
| 126-03 | 0.5 | 1.1 | 5 | 10 |
| 126-04 | 0.3 | 1 | 4 | 9 |
| 126-05 | 0 | 1 | 4 | 9 |
| 126-06 | 0 | 1 | 4 | 9 |
| 126-07 | 0 | 1 | 4 | 9 |

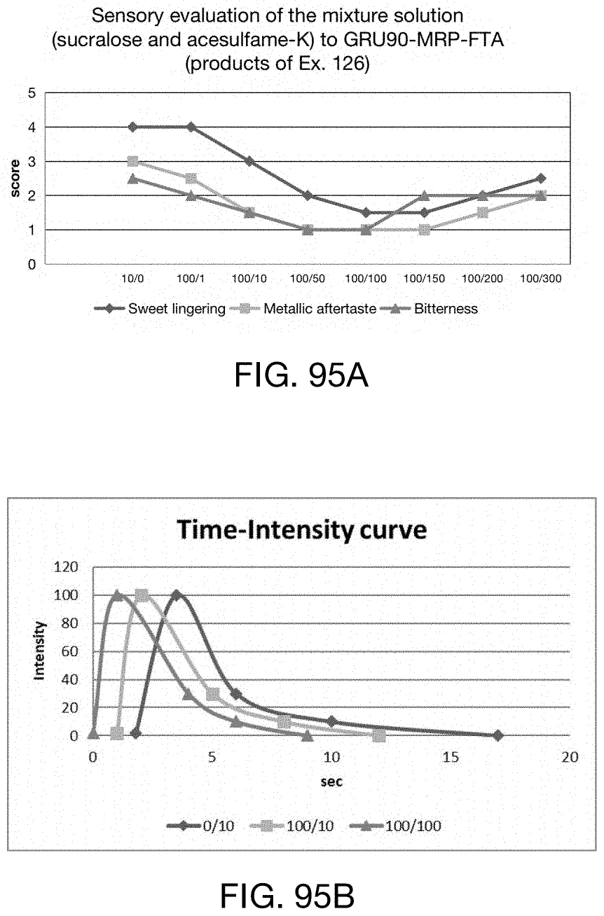

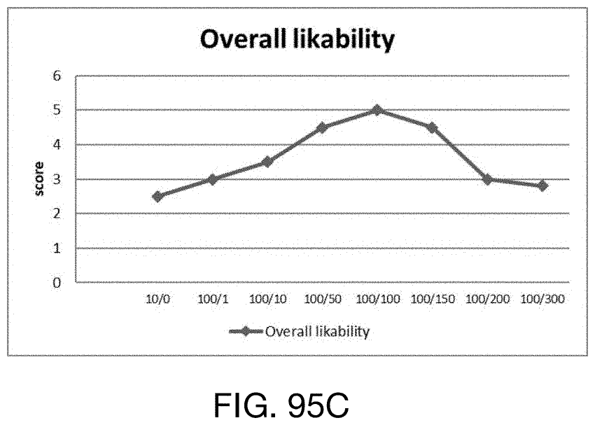

FIG. 95A shows the relationship between the sensory evaluation results as a function of the weight ratio of mixture solution (sucralose and acesulfame-K) to GRU90-MRP-FTA. FIG. 95B shows the time-sweet intensity curves of the mixture solution (sucralose and acesulfame-k) to GRU90-MRP-FTA as a function of its weight ratio. FIG. 95C shows the overall likability of the mixture solution (sucralose and acesulfame-K) to GRU90-MRP-FTA as a function of its weight ratio.

Conclusion: The results showed that GRU90-MRP-FTA can significantly reduce the sweet linger and quicken sweetness onset of mixture solution of sucralose and acesulfame-K. These effects were observed at all the tested artificial sweeteners-to-GRU90-MRP-FTA ratios mentioned in the tables above. These effects can be extended to the artificial sweetener(s)-to-GRU90-MRP-FTA ratio range of 99:1 to 1:99. This example demonstrates that GRU90-MRP-FTA can improve taste profile and reduce the sweet linger of the artificial sweetener solutions.

### Example 127. Preparation of GSG-MRP-TN from GSGs, Concentrated Apple Syrup as Sugar Donor, and Glutamic Acid

Raw materials: Glycosylated stevia glycosides, available from Sweet Green Fields. Lot #: 3080191; concentrated apple syrup: decolorized and deacidified concentrated apple juice (fructose content: 36.77%), available from China Haisheng Fresh Fruit Juice Co. Ltd, Weinan Branch, lot #:25191005B01-05.

Process: GSG, concentrated apple syrup, glutamic acid, water were weighed as described in Table 127-1. All the ingredients were mixed and fully dissolved in the water. The solution was then heated at about 100° C. for 2 hours. When the reaction was completed, the solution was filtered through filter paper and the filtrate was dried with a spray dryer, resulting in product 127-01 as an off-white powder.

TABLE 127-1

| | Weight of | Weight of | Weight of | Fructose | Weight of |
|---|---|---|---|---|---|
| Product | GSG | glutamic | concentrated | solid equiv. | water |
| No. | (g) | acid (g) | apple syrup (g) | (g) | (g) |
| 127-01 | 18 | 0.5 | 4.08 | 1.5 | 7.42 |

### Example 128. GSG-MRP-TN Improves the Taste Profile of a Commercial Carbonated Beverage

Commercial carbonated beverage: Fanta 0 Calorie orange flavored carbonated beverage, available from CocaCola Beijing Co., Ltd, Lot #:2020821.

Ingredients: water, food additives (carbon dioxide, citric acid, aspartame (contains phenylalanine), sodium benzoate, acesulfame-K, sucralose, Sunset Yellow, tartrazine), food flavoring.

Process: GSG-MRP-TN (product 127-01 in Ex. 127) powder was dissolved in the Fanta 0 Calorie carbonated beverage as described in Table 128-1.

TABLE 134-1
Sample compositions.

| | Weight of | | |
|---|---|---|---|
| | GSG-MRP- | Volume of | Concentration |
| Sample | TN(mg) | Fanta (ml) | (ppm) |
| Base | — | 100 | |
| 127-01 | 5.0 | 100 | 50 |

Experiment: Each sample was evaluated according to the sensory evaluation method in Ex. 5. The taste profiles of the mixture and base are shown in Table 128-2.

TABLE 128-2
Sensory evaluation results.

| | Overall | | Mouth | Metallic | Sweet |
|---|---|---|---|---|---|
| Sample | likability | Flavor | feel | aftertaste | lingering |
| Base | 3 | 2.5 | 1.5 | 2 | 3.0 |
| 127-01 | 4.5 | 3.5 | 2 | 1 | 1.0 |

Conclusion: GSG-MRP-TN (product 127-01 in Ex. 127) can significantly reduce the unpleasant sweet linger and metallic aftertaste that the 0 calorie Fanta possesses, while enhancing its original orange flavor and mouth feel, resulting in an improved overall likability of the beverage. The results show that GSG-MRP-TN can improve the taste profile of low-sugar carbonated drinks.

### Example 129. Preparation of GRU90-MRPs from GRU90 in Combination with Cysteine as an Amino Acid Donor and Either Galactose, Fructose, Glucose or Xylose as the Sugar Donor

Raw material: GRU90, product of Ex. 7.

Process: GRU90, reducing sugars, cysteine, and water were weighed as described in Table 135-1. All the ingredients were mixed and fully dissolved in the water. The solution was then heated at about 100° C. for 2 hours. When the reaction was completed, the solution was filtered through filter paper and the filtrate was dried with a spray dryer, resulting in products 129-01 to 129-05 as powders.

TABLE 129-1
Sample compositions.

| | | | Reducing sugar | | | | |
|---|---|---|---|---|---|---|---|
| | | Amino acid | Type of | Weight of | | | |
| Product | Weight/ | Weight of | reducing | reducing | Weight/ | | |
| No. | GRU90 (g) | cysteine (g) | sugar | sugar (g) | water (mL) | Odor | Taste profile |
| 129-01 | 18 | 0.09 | Galactose | 1.91 | 10 | Beef broth | Very light beef |
| | | | | | | scent | flavor, umami taste |
| 129-02 | | | Fructose | | | Beef broth | Salty, umami taste, |
| | | | | | | scent | slight beef flavor |
| 129-03 | | | Glucose | | | Less intense | Strong beef flavor, |
| | | | | | | beef broth | strong umami taste |
| | | | | | | scent | |
| 129-04 | | | Xylose | | | Intense beef | Very intense beef |
| | | | | | | broth scent | flavor and umami |
| | | | | | | | taste |

### Example 130. GRU90-MRPs Improve the Taste Profile of a Concentrated Beef Soup Base

Beef soup base: Jiale Beef Soup Base, available from Unilever food (China) Co., Ltd.

Ingredients: water, edible salt, edible butter (beef butter, vitamin E), beef flavored compound paste (beef bone broth seasoning (beef bone, water, edible salt, beef), edible salt, granulated sugar, water, yeast extract, food flavoring, beef butter, edible corn starch, maltose, edible glucose, spices), food flavoring, maltose, yeast extract, granulated sugar, onion powder, garlic powder, white pepper powder, star anise powder, disodium 5′-ribonucleotide, lactic acid, xanthan gum, locust bean gum, caramel color.

Process: GRU90-MRP (Ex. 129 products) powders were dissolved in beef broth prepared with Jiale Beef Soup Base and water according to the instructions of the Jiale Beef Soup Base. The details are shown in Table 130-1.

TABLE 130-1

| | Weight of | | |
|---|---|---|---|
| | GRU90- | Volume of | |
| | MRPs | prepared beef | Concentration |
| Sample | (mg) | soup (ml) | (ppm) |
| Base | — | 100 | |
| 129-01 | 5.0 | 100 | 50 |
| 129-02 | 5.0 | 100 | 50 |
| 129-03 | 5.0 | 100 | 50 |
| 129-04 | 5.0 | 100 | 50 |

Experiment: Each sample was evaluated according to the sensory evaluation method in Ex. 5. Average scores from the test panel for each sensory criterion were recorded as the evaluation test results. The resulting taste profiles of the mixtures are shown in Table 130-2.

TABLE 130-2
Sensory evaluation results.

| | Overall | | Mouth | |
|---|---|---|---|---|
| Sample | likability | Flavor | feel | Bitterness |
| Base | 2.5 | 3 | 1.5 | 2.0 |
| 129-01 | 4.0 | 3.8 | 2.5 | 1.5 |
| 129-02 | 3 | 3.5 | 2 | 2 |
| 129-03 | 4.5 | 4 | 3.5 | 1.0 |
| 129-04 | 4.2 | 4.5 | 3 | 1.0 |

Conclusion: GRU90-MRPs (products in Ex. 129) can significantly reduce the unpleasant bitterness and can improve the flavor and mouth feel of concentrated beef soup base, resulting in an improved overall likability of the soup. The results show that GRU90-MRPs can improve the taste profile of concentrated beef soup base.

### Example 131. Preparation of RU90-MRPs Formed from RU90 in Combination with Different Reducing Sugars and Amino Acids and Evaluation of Taste Profiles and Aromas Therefrom

Raw material: RU90: available from LAYN, China; content of RU is 92.57%.

Process: RU90, reducing sugars, amino acids, and water were weighed as described in Table 131-1. The ingredients were mixed and fully dissolved in water, resulting in solutions that were then then heated at about 100° C. for 2 hours. When the reactions were completed, the solutions were filtered through filter paper and the filtrates were dried with a spray dryer, resulting in products 131-01 to 131-11 as powders.

TABLE 131-1

| | | Sugar donor | | Amino acid | | | | |
|---|---|---|---|---|---|---|---|---|
| | | Type of | Weight/ | | Weight of | | | |
| Product | Weight of | reducing | reducing | Type of | amino | Weight of | | Taste |
| No. | RU90 (g) | sugar | sugar (g) | amino acid | acid (g) | water (mL) | Odor | profile |
| 131-01 | 25 | Fructose | 5 | Trp | 2.5 | 12.5 | Fruity | Fruity |
| 131-02 | | Fructose | | Pro | | | Egg yolk | Caramel |
| 131-03 | | Fructose | | Gly | | | Slight | Caramel |
| | | | | | | | caramel | |
| 131-04 | | Fructose | | Ala | | | Herbal | Date |
| 131-05 | | Fructose | | Phe | | | Intensive | Fruity |
| | | | | | | | honey | |
| 131-06 | | Xylose | | Ala | | | Caramel | Tangerine |
| 131-07 | | Xylose | | Gly | | | Date | Herbal |
| 131-08 | | Xylose | | Trp | | | Herbal | Herbal |
| 131-09 | | Xylose | | Pro | | | Roasted | Popcorn |
| | | | | | | | potatoes | |
| 131-10 | | Galactose | | Pro | | | Intense | Fruity |
| | | | | | | | honey | |
| 131-11 | | Galactose | | Gly | | | Date | Herbal |

### Example 132. GSG-MRP-FTA and GRU90-MRP-FTA Improve the Taste Profile of Citrus Flavor Compounds

Raw Materials:

100% lemon juice from concentrate, 20.04.2021 23:32/4A1, Rauch Fruchtsäfte GmbH

GSG-MRP-FTA (39-05 in Ex. 39), Lot #EPC-308-59-01, EPC

GRU90-MRP-FTA (39-10 in Ex. 39), Lot #EPC-307-80-02, EPC

(R)-(+)-Limonene, CAS: 5989-27-5

Citral nat., CAS: 5392-40-5

Lemon Juice Volatiles Conc. Extract, Ref. 25598, Capua

Orange Juice Volatiles Conc. Extract, Ref 25597, Capua

Process: Fresh lemonade was prepared by mixing water with lemon juice concentrate in a ratio 1:5. Sugar was added to this mixture at a concentration of 5%. From this base, the following samples were prepared:
1. Lemonade+5% sugar
2. Lemonade+5% sugar+100 ppm GSG-MRP-FTA (39-05 in Ex. 39)
3. Lemonade+5% sugar+100 ppm GSG-MRP-FTA+5 ppm limonene
4. Lemonade+5% sugar+100 ppm GSG-MRP-FTA+5 ppm citral
5. Lemonade+5% sugar+100 ppm GSG-MRP-FTA+5 ppm Capua Lemon Juice concentrate
6. Lemonade+5% sugar+100 ppm GSG-MRP-FTA+5 ppm Capua Orange Juice concentrate
7. Lemonade+5% sugar+100 ppm GRU90-MRP-FTA (39-10 in Ex. 39)
8. Lemonade+5% sugar+100 ppm GRU90-MRP-FTA+5 ppm limonene
9. Lemonade+5% sugar+100 ppm GRU90-MRP-FTA+5 ppm citral
10. Lemonade+5% sugar+100 ppm GRU90-MRP-FTA+5 ppm Capua Lemon Juice concentrate.
11. Lemonade+5% sugar+100 ppm GRU90-MRP-FTA+5 ppm Capua Orange Juice concentrate

Experiment: The samples were subjected to sensory evaluations immediately after preparation and after storage for 24 h at room temperature or 5° C. as set forth in Table 132-1. The sensory evaluations were carried out by tasters employing the triangle tests as described in Ex. 88A.

TABLE 132-1
Sensory evaluation results.

| | Sensory evaluation | | |
|---|---|---|---|
| | | After storage for | After storage for |
| Sample | After preparation | 24 h at 5° C. | 24 h at RT* |
| Lemonade + 5 g | Odor: lemon, acidic, | Odor: No changes, | Odor: Less lemon |
| sugar | not very intensive | lemon, acidic, not | aroma |
| | Taste: Lack of | very intensive | Taste: Old, less fresh, |
| | sweetness, very acidic | Taste: No changes, | less lemon flavor |
| | | lack of sweetness, | |
| | | very acidic | |

GSG-MRPs

| | | | |
|---|---|---|---|
| +100 ppm | Odor: Slightly fresher | Odor: Slightly less | Odor: Slightly less |
| GSG-MRP- | Taste: Sweeter, less | lemon flavor, but | lemon flavor, but still |
| FTA (39-05 in | acidic, pleasant, | still fresher than | fresher than control |
| Ex. 39) | fresher and smoother | control | Taste: Pleasant sweet, |
| | taste | Taste: Pleasant | less acidic, fresh and |
| | | sweet, less acidic, | smooth |
| | | fresh and smooth | |
| +100 ppm | Odor: Slightly fresher, | Odor: less limonene | Odor: less limonene |
| GSG-MRP- | limonene aroma | aroma, but still | aroma, but still |
| FTA + | Taste: unnatural taste, | noticeable, fresh | noticeable, fresh |
| 5 ppm | limonene aftertaste, | Taste: unnatural | Taste: unnatural taste, |
| limonene | like perfume | taste, more | more intensive |
| | | intensive limonene | limonene aftertaste, like |
| | | aftertaste, like | perfume |
| | | perfume | |
| +100 ppm | Odor: Very fresh, | Odor: Less lemon | Odor: Less lemon |
| GSG-MRP- | more lemon flavor, | aroma, but still | aroma, but still |
| FTA + | pleasant | intensive, pleasant | intensive, pleasant |
| 5 ppm citral | Taste: Sweeter, less | Taste: Enhanced | Taste: Enhanced |
| | acidic, pleasant, fresh | sweetness, pleasant, | sweetness, pleasant, |
| | | more lemon taste | more lemon taste |
| +100 ppm | Odor: Fresher, | Odor: Slightly less | Odor: Slightly less |
| GSG-MRP- | enhanced, pleasant, | lemon flavor, but | lemon flavor, but still |
| FTA + | well-balanced, like | still fresh and | fresh and pleasant, like |
| 5 ppm Capua | fresh lemons | pleasant, like fresh | fresh lemons |
| Lemon Juice | Taste: Very pleasant, | lemons | Taste: Enhanced |
| concentrate | enhanced sweetness, | Taste: Enhanced | sweetness, more lemon |
| | more lemon taste, | sweetness, more | taste, fresher, well- |
| | well-balanced, best | lemon taste, fresher, | balanced, best taste |
| | taste | well-balanced, best | |
| | | taste | |
| +100 ppm | Odor: strong orange | Odor: Less orange | Odor: Less orange |
| GSG-MRP- | aroma (like orange | flavor, but still | flavor, but still intensive |
| FTA + | peels), less lemon | intensive | Taste: enhanced |
| 5 ppm Capua | flavor | Taste: enhanced | sweetness, orange |
| Orange Juice | Taste: enhanced | sweetness, orange | aftertaste |
| concentrate | sweetness, orange | aftertaste | |
| | aftertaste | | |

GRU90-MRPs

| | | | |
|---|---|---|---|
| +100 ppm | Odor: Slightly fresher | Odor: No changes, | Odor: No changes, |
| GRU90-MRP- | Taste: Enhanced | slightly fresher than | slightly fresher than |
| FTA (39-10 in | sweetness, fresher, | control | control |
| Ex. 39) | less acidic | Taste: Enhanced | Taste: Enhanced |
| | | sweetness, fresher, | sweetness, fresher, less |
| | | less acidic | acidic |
| +100 ppm | Odor: Slightly fresher, | Odor: less limonene | Odor: less limonene |
| GRU90-MRP- | limonene aroma | aroma, but still | aroma, but still |
| FTA + 5 ppm | Taste: unnatural taste, | noticeable, fresh | noticeable, fresh |
| limonene | limonene aftertaste, | Taste: unnatural | Taste: unnatural taste, |
| | like perfume | taste, more | more intensive |
| | | intensive | limonene aftertaste, like |
| | | limonene aftertaste, | perfume |
| | | like perfume | |
| +100 ppm | Odor: fresher, | Odor: Less lemon | Odor: Less lemon |
| GRU90-MRP- | enhanced lemon | aroma, but still | aroma, but still |
| FTA + 5 ppm | flavor, pleasant | intensive, pleasant | intensive, pleasant |
| citral | Taste: Enhanced | Taste: Enhanced | Taste: Enhanced |
| | sweetness, pleasant, | sweetness, pleasant, | sweetness, pleasant, |
| | more lemon taste | more lemon taste | more lemon taste |
| +100 ppm | Odor: Fresher, | Odor: Slightly less | Odor: Slightly less |
| GRU90-MRP- | pleasant, enhanced, | lemon flavor, but | lemon flavor, but still |
| FTA + 5 ppm | well-balanced, like | still fresh and | fresh and pleasant, like |
| Capua Lemon | fresh lemons | pleasant, like fresh | fresh lemons |
| Juice | Taste: Enhanced | lemons | Taste: Enhanced |
| concentrate | sweetness, more | Taste: Enhanced | sweetness, more lemon |
| | lemon taste, fresher, | sweetness, more | taste, fresher, well- |
| | well-balanced, best | lemon taste, | balanced, best taste |
| | taste | fresher, well- | |
| | | balanced, best taste | |
| +100 ppm | Odor: strong orange | Odor: Less orange | Odor: Less orange |
| GRU90-MRP- | aroma (like orange | flavor, but still | flavor, but still intensive |
| FTA + 5 ppm | peels), less lemon | intensive | Taste: enhanced |
| Capua Orange | flavor | Taste: enhanced | sweetness, orange |
| Juice | Taste: enhanced | sweetness, orange | aftertaste |
| concentrate | sweetness, orange | aftertaste | |
| | aftertaste | | |

*RT—room temperature

### Example 133. Stability Tests of GSG-MRP-FTA in Sugar Free Lemon Iced Tea

Raw materials: GSG-MRP-FTA (39-05 in Ex. 39), Lot #EPC-308-59-01; Iced tea Zero Lemon, 03.04.2021 04:21/2A5, Rauch Fruchtsäfte GmbH & Co.

Process: Commercial carbonized, sugar free lemon flavored iced tea (0.5 l bottles, Brand: Rauch, sweetener: Ace-K, aspartame) was selected to perform a stability test of GSG-MRP-FTA. The bottled iced tea was cooled to 2° C., opened and 100 ppm of GSG-MRP-FTA was added to each bottle (test sample). The bottles were then closed and brought to room temperature to dissolve GSG-MRP-FTA completely. Iced tea Zero without the addition of GSG-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 133-1.

TABLE 133-1
Stability test results for GSG-MRP-FTA (39-05
in Ex. 39) in sugar free lemon iced tea.

| | Duration of | |
|---|---|---|
| Sample | storage | Sensory evaluation |
| Control | 0 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 0 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 2 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 2 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 4 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 4 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 6 weeks, | Artificial, void taste, less lemon flavor and less |
| | 2-4° C. | mouth-feeling compared to week 4 |
| Test | | Sweeter than control, pleasant sweet, less lemon |
| | | flavor and less mouth-feeling compared to week |
| | | 4, reduced lingering |
| Control | 6 weeks, | Artificial, void taste, lack of sweetness, lemon |
| | 20-22° C. | flavor, lingering aftertaste |
| Test | | Sweeter than control, pleasant sweet, less lemon |
| | | flavor and less mouth-feeling compared to week |
| | | 4, reduced lingering |
| Control | 8 weeks, | Artificial, void taste, similar flavor perception |
| | 2-4° C. | and mouth-feeling compared to 6 weeks of |
| | | storage |
| Test | | Sweeter than control, pleasant sweet, similar |
| | | flavor perception and mouth-feeling compared to |
| | | 6 weeks of storage |
| Control | 8 weeks, | Artificial, void taste, similar flavor perception |
| | 20-22° C. | and mouth-feeling compared to 6 weeks of |
| | | storage |
| Test | | Sweeter than control, pleasant sweet, similar |
| | | flavor perception and mouth-feeling compared to |
| | | 6 weeks of storage |

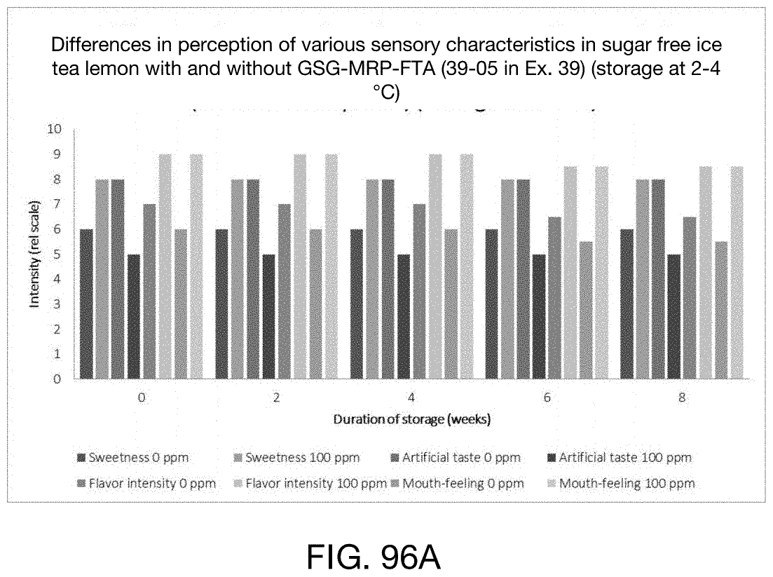

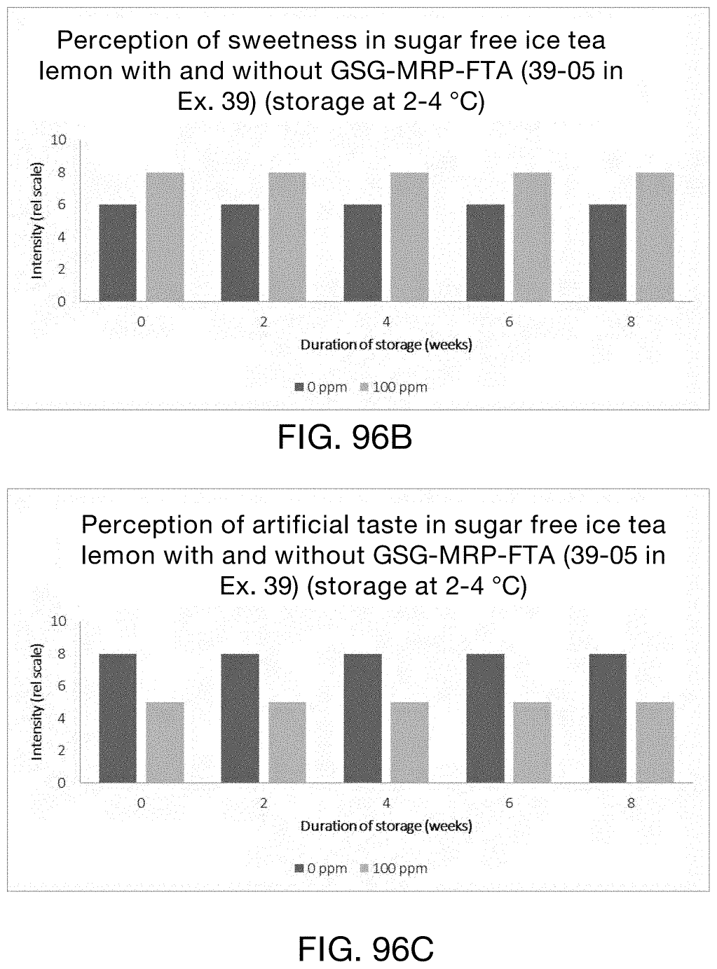

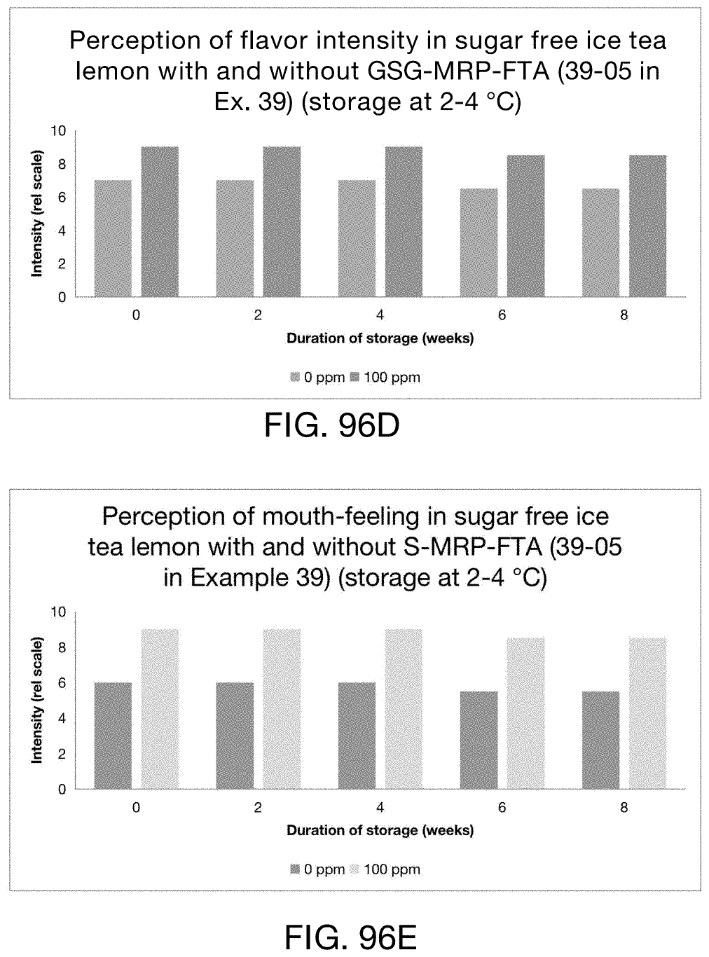

FIG. 96A is a graphical depiction showing differences in perception of various sensory characteristics in sugar free lemon iced tea with and without GSG-MRP-FTA (39-05 in Ex. 39) following storage at 2-4° C.

FIG. 96B is a graphical depiction showing the perception of sweetness in sugar free lemon iced tea with and without GSG-MRP-FTA (39-05 in Ex. 39) following storage at 2-4° C.

FIG. 96C is a graphical depiction showing the perception of artificial taste in sugar free lemon iced tea with and without GSG-MRP-FTA (39-05 in Ex. 39) following storage at 2-4° C.

FIG. 96D is a graphical depiction showing the perception of flavor intensity in sugar free lemon iced tea with and without GSG-MRP-FTA (39-05 in Ex. 39) following storage at 2-4° C.

FIG. 96E is a graphical depiction showing the perception of mouth-feeling in sugar free lemon iced tea with and without GSG-MRP-FTA (39-05 in Ex. 39) following storage at 2-4° C.

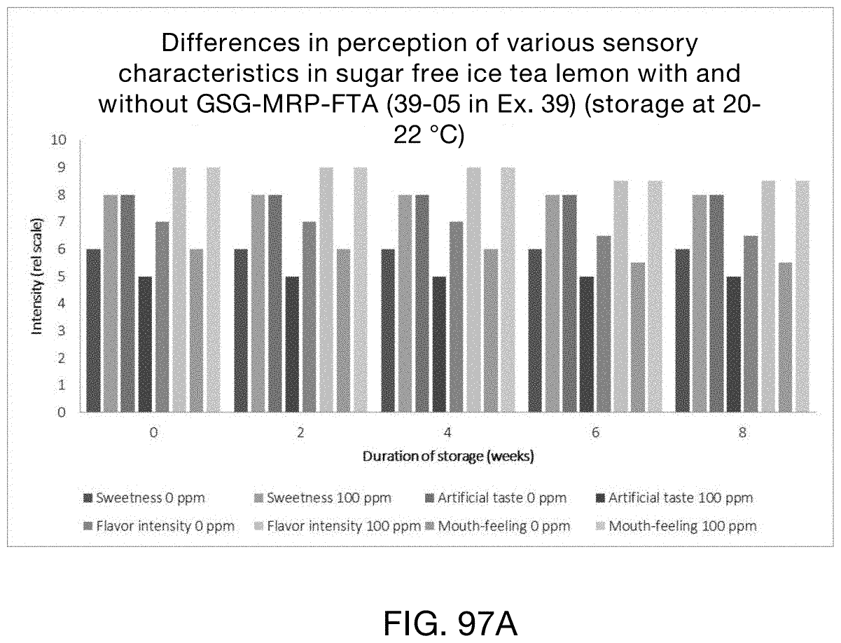

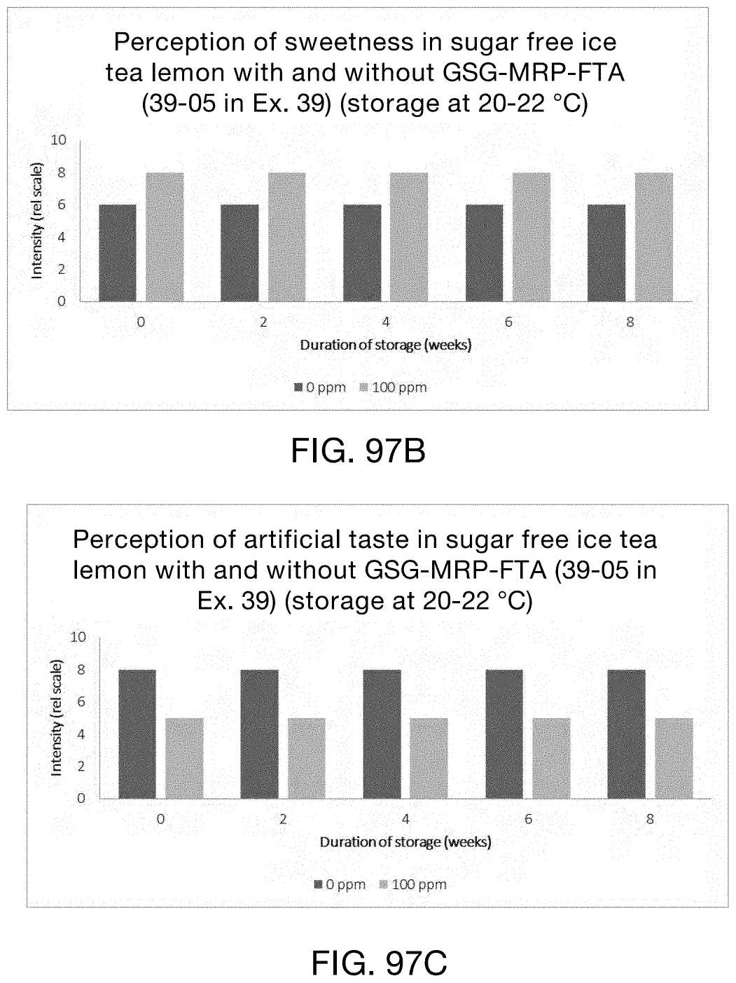

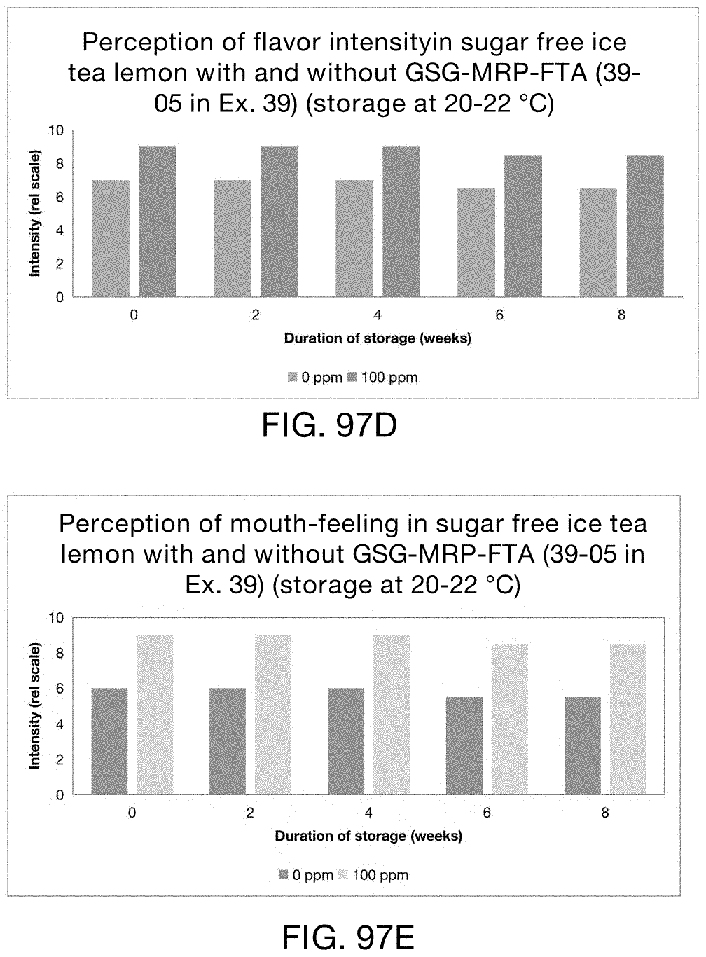

FIG. 97A is a graphical depiction showing differences in perception of various sensory characteristics in sugar free lemon iced tea with and without GSG-MRP-FTA (39-05 in Ex. 39) following storage at 20-22° C.

FIG. 97B is a graphical depiction showing the perception of sweetness in sugar free lemon iced tea with and without GSG-MRP-FTA (39-05 in Ex. 39) following storage at 20-22° C.

FIG. 97C is a graphical depiction showing the perception of artificial taste in sugar free lemon iced tea with and without GSG-MRP-FTA (39-05 in Ex. 39) following storage at 20-22° C.

FIG. 97D is a graphical depiction showing the perception of flavor intensity in sugar free lemon iced tea with and without GSG-MRP-FTA (39-05 in Ex. 39) following storage at 20-22° C.

FIG. 97E is a graphical depiction showing the perception of mouth-feeling in sugar free lemon iced tea with and without GSG-MRP-FTA (39-05 in Ex. 39) following storage at 20-22° C.

### Example 134. Stability Tests of GRU90-MRP-FTA in Sugar Free Lemon Iced Tea

Raw materials: GRU90-MRP-FTA (39-10 in Ex. 39), Lot #EPC-307-80-02; Iced tea Zero Lemon, 03.04.2021 04:21/2A5, Rauch Fruchtsäfte GmbH & Co.

Process: Commercial carbonized, sugar free lemon flavored iced tea (0.5 l bottles, Brand: Rauch, sweetener: Ace-K, aspartame) was selected to perform a stability test of GRU90-MRP-FTA (39-10 in Ex. 39). The bottled iced tea was cooled to 2° C., opened and 100 ppm of GRU90-MRP-FTA was added to each bottle (test sample). The bottles were then closed and brought to room temperature to dissolve GRU90-MRP-FTA completely. Iced tea Zero without the addition of GRU90-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 140-1.

TABLE 134-1
Stability test results for GRU90-MRP-FTA (39-10
in Ex. 39) in sugar free lemon iced tea.

| | Duration of | |
|---|---|---|
| Sample | storage | Sensory evaluation |
| Control | 0 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 0 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 2 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 2 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 4 weeks, | Artificial, void taste, lack of sweetness, lemon |
| | 2-4° C. | flavor, lingering aftertaste |
| Test | | Sweeter than control, pleasant sweet, enhanced |
| | | lemon flavor, reduced lingering, smooth mouth- |
| | | feeling |
| Control | 4 weeks, | Artificial, void taste, lack of sweetness, lemon |
| | 20-22° C. | flavor, lingering aftertaste |
| Test | | Sweeter than control, pleasant sweet, enhanced |
| | | lemon flavor, reduced lingering, smooth mouth- |
| | | feeling |
| Control | 6 weeks, | Artificial, void taste, less lemon flavor and less |
| | 2-4° C. | mouth-feeling compared to week 4 |
| Test | | Sweeter than control, pleasant sweet, less lemon |
| | | flavor and less mouth-feeling compared to week |
| | | 4, reduced lingering |
| Control | 6 weeks, | Artificial, void taste, less lemon flavor and less |
| | 20-22° C. | mouth-feeling compared to week 4 |
| Test | | Sweeter than control, pleasant sweet, less lemon |
| | | flavor and less mouth-feeling compared to week |
| | | 4, reduced lingering |
| Control | 8 weeks, | Artificial, void taste, similar flavor perception |
| | 2-4° C. | and mouth-feeling compared to 6 weeks of |
| | | storage |
| Test | | Sweeter than control, pleasant sweet, similar |
| | | flavor perception and mouth-feeling compared |
| | | to 6 weeks of storage |
| Control | 8 weeks, | Artificial, void taste, similar flavor perception |
| | 20-22° C. | and mouth-feeling compared to 6 weeks of |
| | | storage |
| Test | | Sweeter than control, pleasant sweet, similar |
| | | flavor perception and mouth-feeling compared |
| | | to 6 weeks of storage |

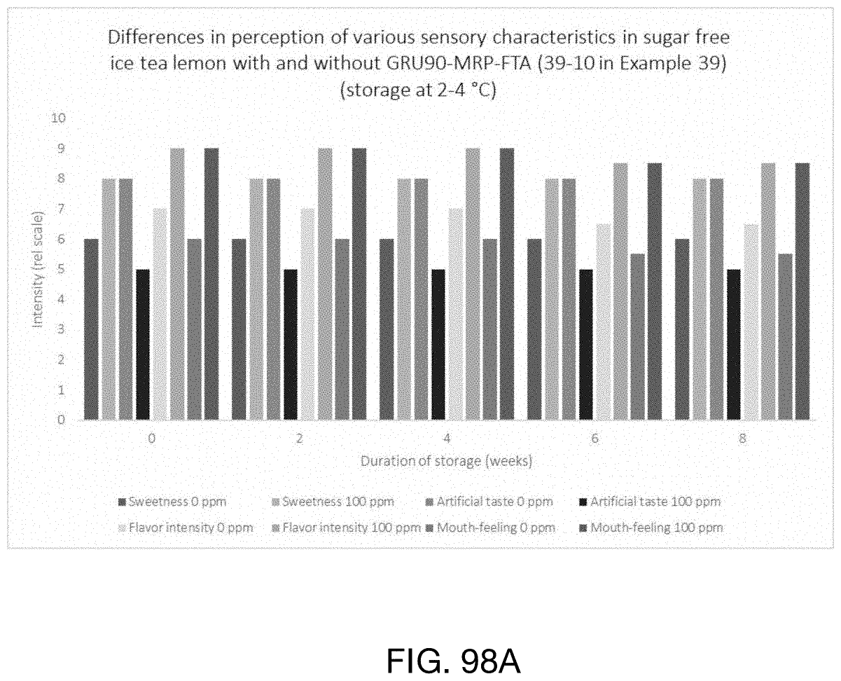

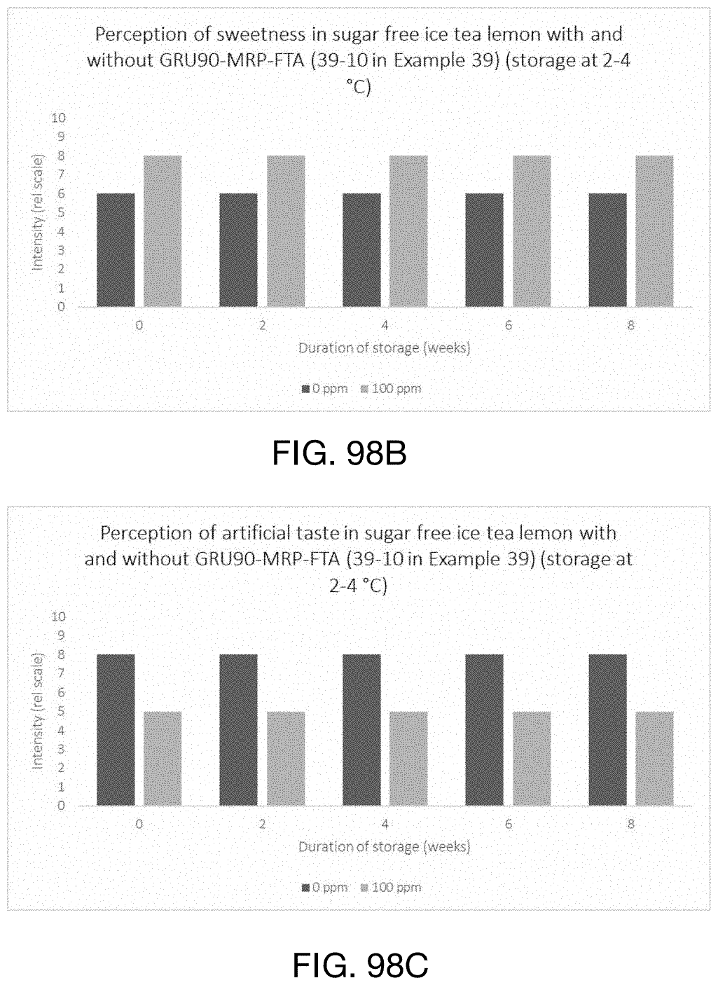

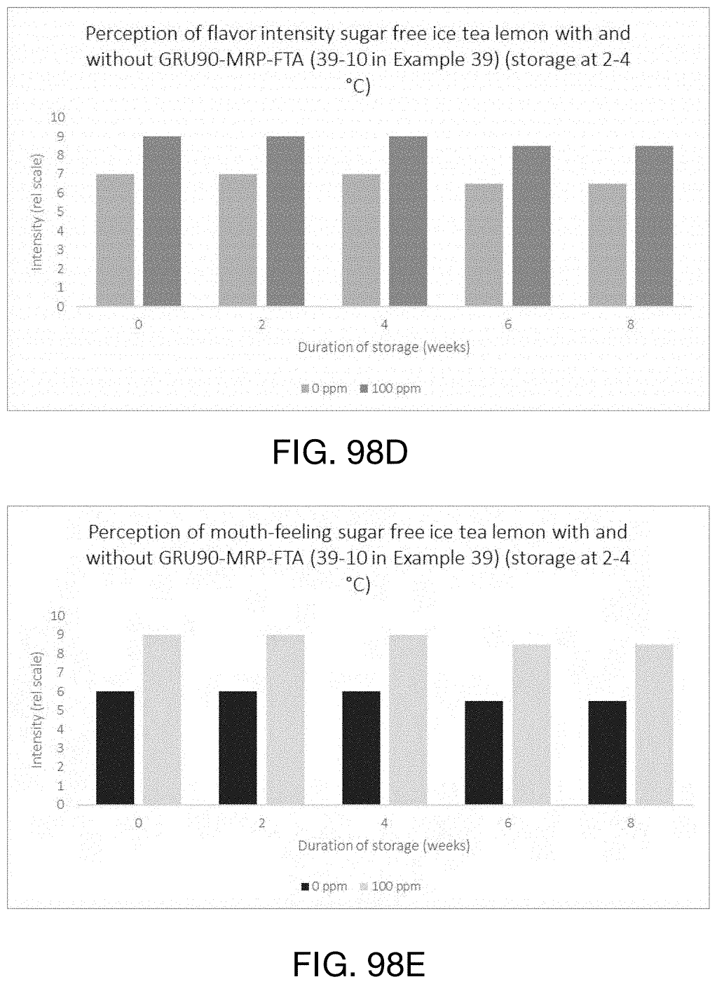

FIG. 98A is a graphical depiction showing differences in perception of various sensory characteristics in sugar free lemon iced tea with and without GRU90-MRP-FTA (39-10 in Ex. 39) following storage at 2-4° C.

FIG. 98B is a graphical depiction showing the perception of sweetness in sugar free lemon iced tea with and without GRU90-MRP-FTA (39-10 in Ex. 39) following storage at 2-4° C.

FIG. 98C is a graphical depiction showing the perception of artificial taste in sugar free lemon iced tea with and without GRU90-MRP-FTA (39-10 in Ex. 39) following storage at 2-4° C.

FIG. 98D is a graphical depiction showing the perception of flavor intensity in sugar free lemon iced tea with and without GRU90-MRP-FTA (39-10 in Ex. 39) following storage at 2-4° C.

FIG. 98E is a graphical depiction showing the perception of mouth-feeling in sugar free lemon iced tea with and without GRU90-MRP-FTA (39-10 in Ex. 39) following storage at 2-4° C.

FIG. 99A is a graphical depiction showing differences in perception of various sensory characteristics in sugar free lemon iced tea with and without GRU90-MRP-FTA (39-10 in Ex. 39) following storage at 20-22° C.

FIG. 99B is a graphical depiction showing the perception of sweetness in sugar free lemon iced tea with and without GRU90-MRP-FTA (39-10 in Ex. 39) following storage at 20-22° C.

FIG. 99C is a graphical depiction showing the perception of artificial taste in sugar free lemon iced tea with and without GRU90-MRP-FTA (39-10 in Ex. 39) following storage at 20-22° C.

FIG. 99D is a graphical depiction showing the perception of flavor intensity in sugar free lemon iced tea with and without GRU90-MRP-FTA (39-10 in Ex. 39) following storage at 20-22° C.

FIG. 99E is a graphical depiction showing the perception of mouth-feeling in sugar free lemon iced tea with and without GRU90-MRP-FTA (39-10 in Ex. 39) following storage at 20-22° C.

### Example 135. Stability Tests of GSG-MRP-FTA in a Sugar Free Orange Soft Drink

Raw materials: GSG-MRP-FTA (39-05 in Ex. 39), Lot #EPC-308-59-01; Fanta Orange Zero added sugar, 28.08.2020 L 278 01:24R.

Process: Commercial carbonized, sugar free orange soft drink (0.5 l bottles, Brand: Fanta, sweetener: cyclamate, Ace-K, sucralose, steviol glycoside, NHDC) was selected to perform a stability test of GSG-MRP-FTA (39-05 in Ex. 39). The bottled Fanta Orange Zero soft drink was cooled to 2° C., opened and 100 ppm of GSG-MRP-FTA was added to each bottle (test sample). The bottles were then closed and brought to room temperature to dissolve GSG-MRP-FTA completely. Fanta Orange Zero without the addition of GSG-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 135-1.

TABLE 135-1
Stability test results for GSG-MRP-FTA (39-05
in Ex. 39) in sugar free orange soft drink.

| | Duration of | |
|---|---|---|
| Sample | storage | Sensory evaluation |
| Control | 0 weeks, | Very sweet, orange flavor, artificial, over |
| | 2-4° C. | flavored, |
| Test | | Improved sweetness, masked artificial |
| | | aftertaste, well-balanced orange flavor |
| Control | 0 weeks, | Very sweet, orange flavor, artificial, over |
| | 20-22° C. | flavored |
| Test | | Improved sweetness, masked artificial |
| | | aftertaste, well-balanced orange flavor |
| Control | 2 weeks, | Very sweet, orange flavor, artificial, over |
| | 2-4° C. | flavored, |
| Test | | Improved sweetness, masked artificial |
| | | aftertaste, well-balanced orange flavor |
| Control | 2 weeks, | Very sweet, orange flavor, artificial, over |
| | 20-22° C. | flavored |
| Test | | Improved sweetness, masked artificial |
| | | aftertaste, well-balanced orange flavor |
| Control | 4 weeks, | Very sweet, orange flavor, artificial, over |
| | 2-4° C. | flavored, |
| Test | | Improved sweetness, masked artificial |
| | | aftertaste, well-balanced orange flavor |
| Control | 4 weeks, | Very sweet, orange flavor, artificial, over |
| | 20-22° C. | flavored |
| Test | | Improved sweetness, masked artificial |
| | | aftertaste, well-balanced orange flavor |
| Control | 6 weeks, | Very sweet, artificial taste, less orange |
| | 2-4° C. | flavor and less mouth-feeling compared to |
| | | week 4 |
| Test | | Improved sweetness, masked artificial |
| | | aftertaste, less orange flavor and less |
| | | mouth-feeling compared to week 4, |
| | | reduced lingering |
| Control | 6 weeks, | Very sweet, artificial taste, less orange |
| | 20-22° C. | flavor and less mouth-feeling compared to |
| | | week 4 |
| Test | | Improved sweetness, masked artificial |
| | | aftertaste, less orange flavor and less |
| | | mouth-feeling compared to week 4, |
| | | reduced lingering |
| Control | 8 weeks, | Very sweet, artificial taste, similar flavor |
| | 2-4° C. | perception and mouth-feeling compared to |
| | | 6 weeks of storage |
| Test | | Improved sweetness, masked artificial |
| | | aftertaste, similar flavor perception and |
| | | mouth-feeling compared to 6 weeks of |
| | | storage |
| Control | 8 weeks, | Very sweet, artificial taste, similar flavor |
| | 20-22° C. | perception and mouth-feeling compared to |
| | | 6 weeks of storage |
| Test | | Improved sweetness, masked artificial |
| | | aftertaste, similar flavor perception and |
| | | mouth-feeling compared to 6 weeks of |
| | | storage |

FIG. 100A is a graphical depiction showing differences in perception of various sensory characteristics in a sugar free orange soft drink with and without GSG-MRP-FTA (39-05 in Ex. 39) following storage at 2-4° C.

FIG. 100B is a graphical depiction showing the perception of sweetness in a sugar free orange soft drink with and without GSG-MRP-FTA (39-05 in Ex. 39) following storage at 2-4° C.

FIG. 100C is a graphical depiction showing the perception of artificial taste in a sugar free lemon iced tea with and without GSG-MRP-FTA (39-05 in Ex. 39) following storage at 2-4° C.

FIG. 100D is a graphical depiction showing the perception of flavor intensity in a sugar free orange soft drink with and without GSG-MRP-FTA (39-05 in Ex. 39) following storage at 2-4° C.

FIG. 100E is a graphical depiction showing the perception of mouth-feeling in a sugar free orange soft drink with and without GSG-MRP-FTA (39-05 in Ex. 39) following storage at 2-4° C.

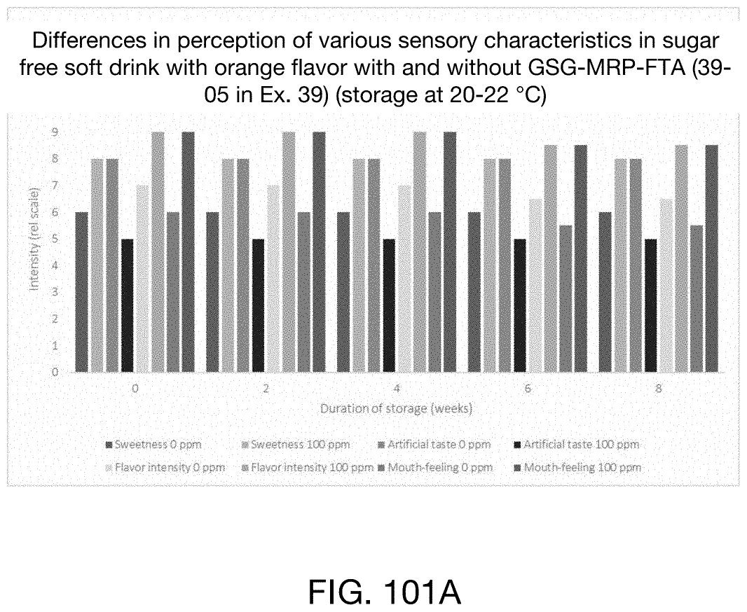

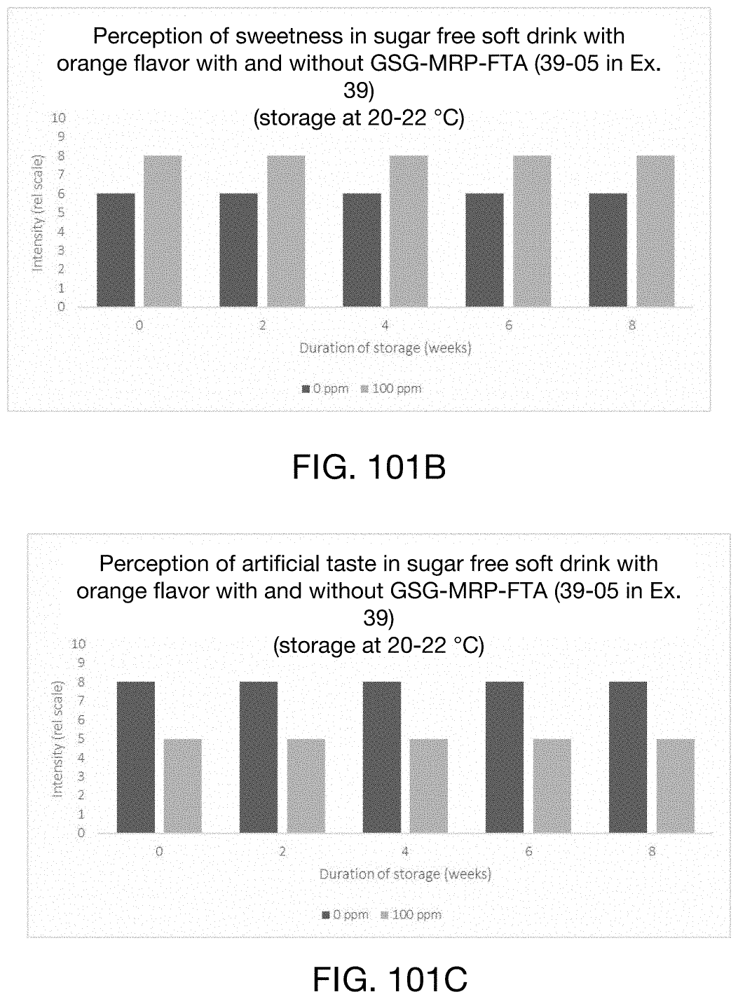

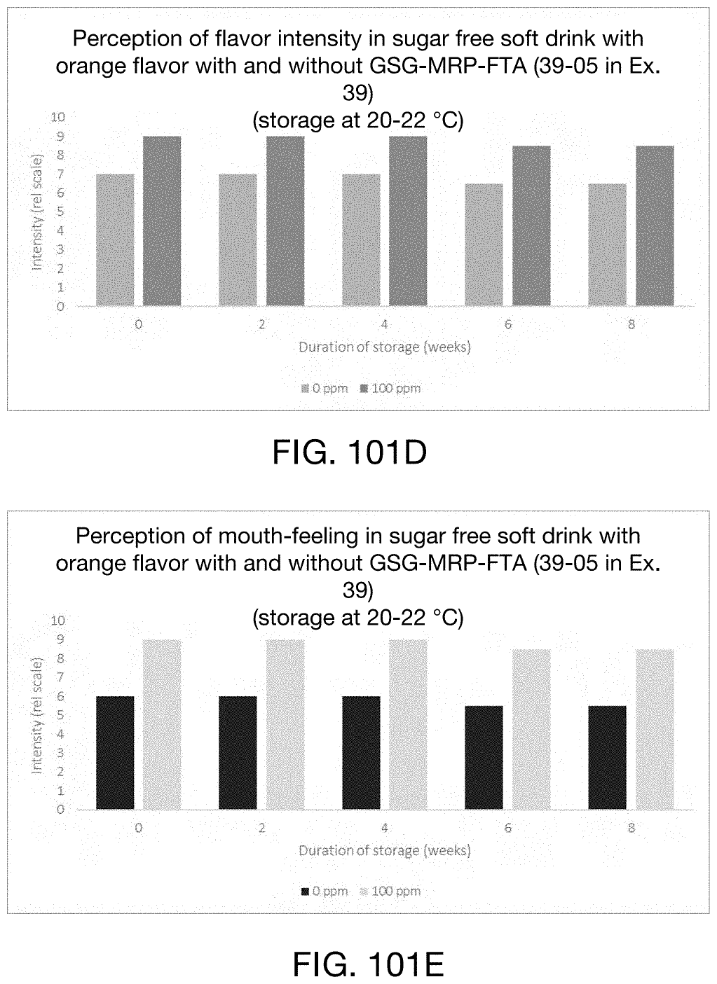

FIG. 101A is a graphical depiction showing differences in perception of various sensory characteristics in a sugar free orange soft drink with and without GSG-MRP-FTA (39-05 in Ex. 39) following storage at 20-22° C.

FIG. 101B is a graphical depiction showing the perception of sweetness in a sugar free orange soft drink with and without GSG-MRP-FTA (39-05 in Ex. 39) following storage at 20-22° C.

FIG. 101C is a graphical depiction showing the perception of artificial taste in a sugar free orange soft drink with and without GSG-MRP-FTA (39-05 in Ex. 39) following storage at 20-22° C.

FIG. 101D is a graphical depiction showing the perception of flavor intensity in a sugar free orange soft drink with and without GSG-MRP-FTA (39-05 in Ex. 39) following storage at 20-22° C.

FIG. 101E is a graphical depiction showing the perception of mouth-feeling in a sugar free orange soft drink with and without GSG-MRP-FTA (39-05 in Ex. 39) following storage at 20-22° C.

### Example 136. Stability Tests of GRU90-MRP-FTA in a Sugar Free Orange Soft Drink

Raw materials: GRU90-MRP-FTA (39-10 in Ex. 39), Lot #EPC-307-80-02; Fanta Orange Zero added sugar, 28.08.2020 L 278 01:24R.

Process: Commercial carbonized, sugar free flavored iced tea (0.5 l bottles, Brand: Rauch, sweetener: Ace-K, aspartame) was selected to perform a stability test of GRU90-MRP-FTA (39-10 in Ex. 39). The bottled Fanta Orange Zero soft drink was cooled to 2° C., opened and 100 ppm of GRU90-MRP-FTA was added to each bottle (test sample). The bottles were then closed and brought to room temperature to dissolve GRU90-MRP-FTA completely. Fanta Orange Zero without the addition of GRU90-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 136-1.

TABLE 136-1
Stability test results for GRU90-MRP-FTA (39-10
in Ex. 39) in a sugar free orange soft drink.

| | Duration of | |
|---|---|---|
| Sample | storage | Sensory evaluation |
| Control | 0 weeks, | Very sweet, orange flavor, artificial, over |
| | 2-4° C. | flavored |
| Test | | Improved sweetness, masked artificial |
| | | aftertaste, well-balanced orange flavor |
| Control | 0 weeks, | Very sweet, orange flavor, artificial, over |
| | 20-22° C. | flavored |
| Test | | Improved sweetness, masked artificial |
| | | aftertaste, well-balanced orange flavor |
| Control | 2 weeks, | Very sweet, orange flavor, artificial, over |
| | 2-4° C. | flavored |
| Test | | Improved sweetness, masked artificial |
| | | aftertaste, well-balanced orange flavor |
| Control | 2 weeks, | Very sweet, orange flavor, artificial, over |
| | 20-22° C. | flavored |
| Test | | Improved sweetness, masked artificial |
| | | aftertaste, well-balanced orange flavor |
| Control | 4 weeks, | Very sweet, orange flavor, artificial, over |
| | 2-4° C. | flavored |
| Test | | Improved sweetness, masked artificial |
| | | aftertaste, well-balanced orange flavor |
| Control | 4 weeks, | Very sweet, orange flavor, artificial, over |
| | 20-22° C. | flavored |
| Test | | Improved sweetness, masked artificial |
| | | aftertaste, well-balanced orange flavor |
| Control | 6 weeks, | Very sweet, artificial taste, less orange |
| | 2-4° C. | flavor and less mouth-feeling compared to |
| | | week 4 |
| Test | | Improved sweetness, masked artificial |
| | | aftertaste, less orange flavor and less |
| | | mouth-feeling compared to week 4, |
| | | reduced lingering |
| Control | 6 weeks, | Very sweet, artificial taste, less orange |
| | 20-22° C. | flavor and less mouth-feeling compared to |
| | | week 4 |
| Test | | Improved sweetness, masked artificial |
| | | aftertaste, less orange flavor and less |
| | | mouth-feeling compared to week 4, |
| | | reduced lingering |
| Control | 8 weeks, | Very sweet, artificial taste, similar flavor |
| | 2-4° C. | perception and mouth-feeling compared to |
| | | 6 weeks of storage |
| Test | | Improved sweetness, masked artificial |
| | | aftertaste, similar flavor perception and |
| | | mouth-feeling compared to 6 weeks of |
| | | storage |
| Control | 8 weeks, | Very sweet, artificial taste, similar flavor |
| | 20-22° C. | perception and mouth-feeling compared to |
| | | 6 weeks of storage |
| Test | | Improved sweetness, masked artificial |
| | | aftertaste, similar flavor perception and |
| | | mouth-feeling compared to 6 weeks of |
| | | storage |

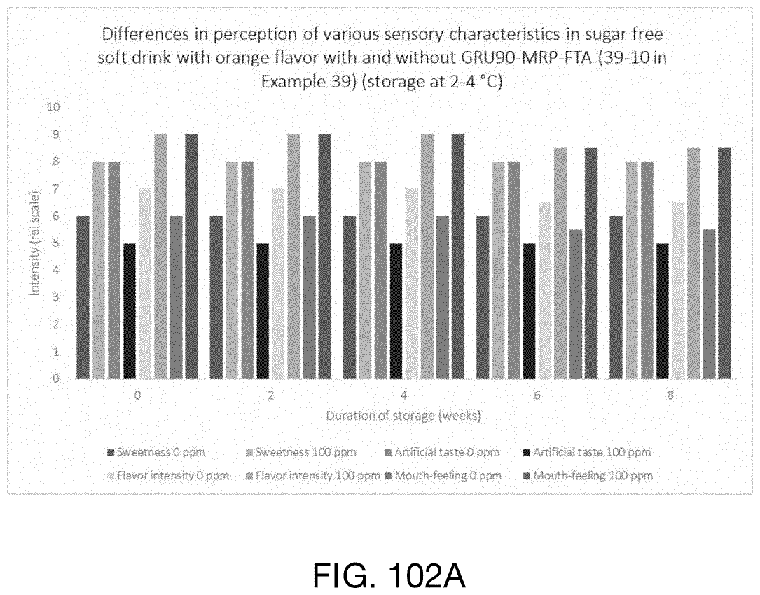

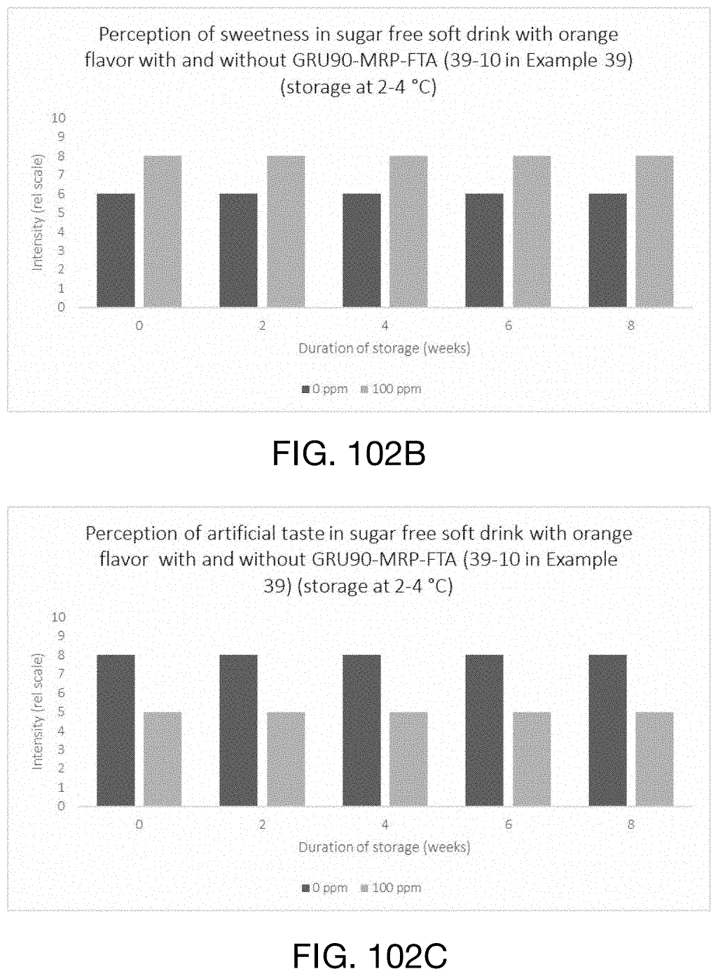

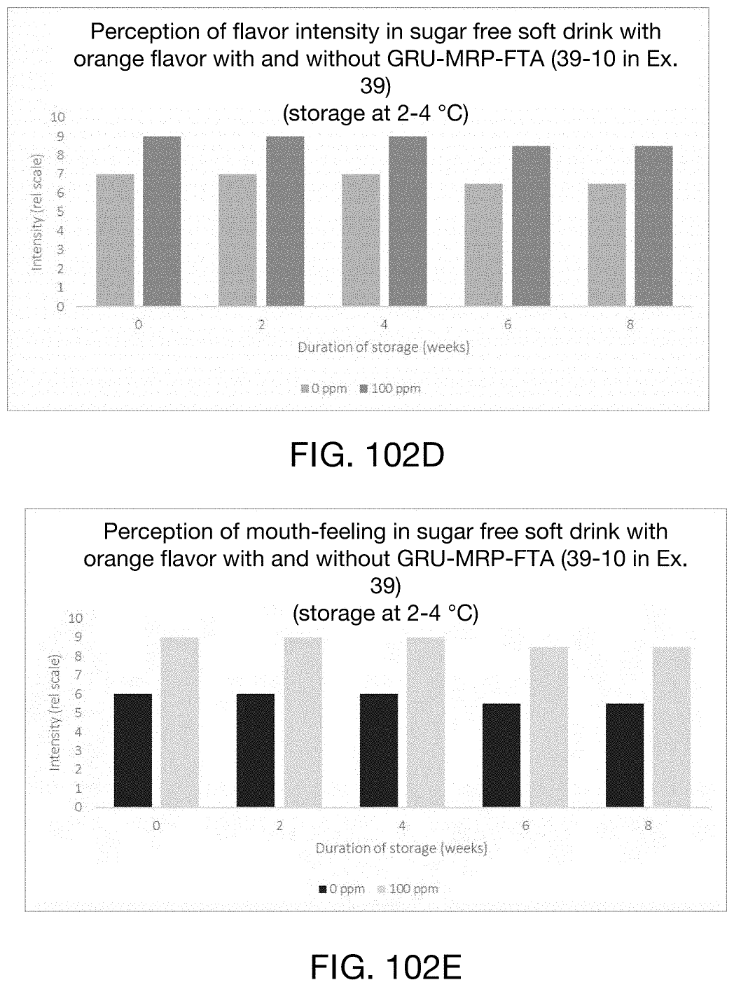

FIG. 102A is a graphical depiction showing differences in perception of various sensory characteristics in a sugar free orange soft drink with and without GRU90-MRP-FTA (39-10 in Ex. 39) following storage at 2-4° C.

FIG. 102B is a graphical depiction showing the perception of sweetness in a sugar free orange soft drink with and without GRU90-MRP-FTA (39-10 in Ex. 39) following storage at 2-4° C.

FIG. 102C is a graphical depiction showing the perception of artificial taste in a sugar free orange soft drink with and without GRU90-MRP-FTA (39-10 in Ex. 39) following storage at 2-4° C.

FIG. 102D is a graphical depiction showing the perception of flavor intensity in a sugar free orange soft drink with and without GRU90-MRP-FTA (39-10 in Ex. 39) following storage at 2-4° C.

FIG. 102E is a graphical depiction showing the perception of mouth-feeling in a sugar free orange soft drink with and without GRU90-MRP-FTA (39-10 in Ex. 39) following storage at 2-4° C.

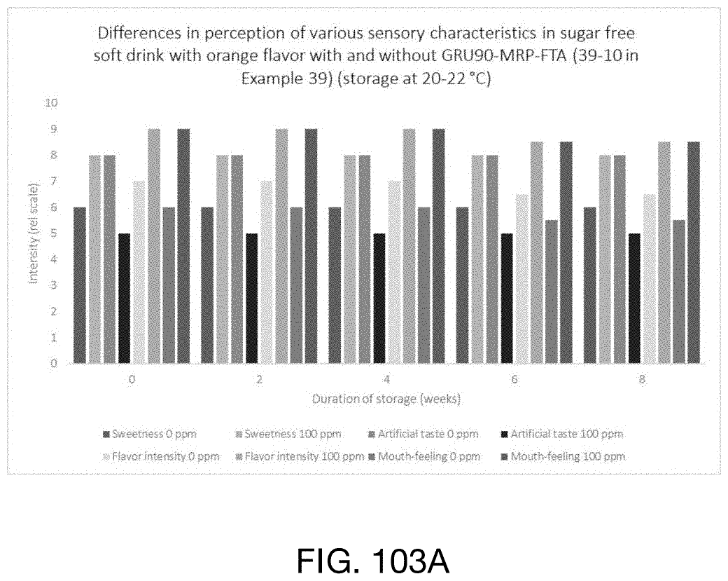

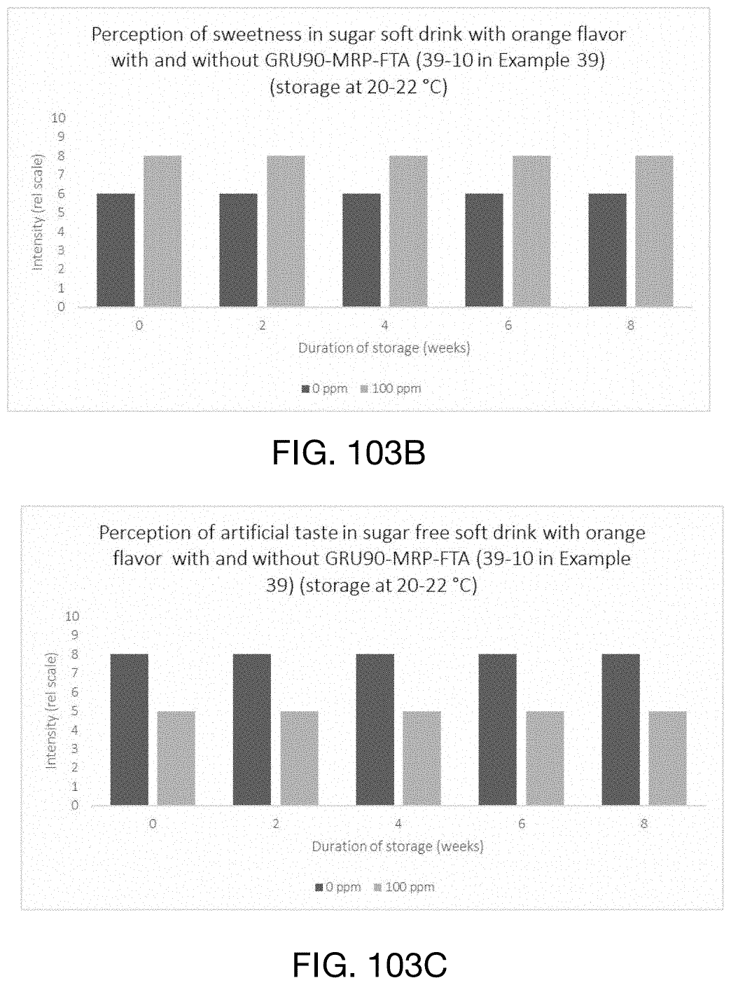

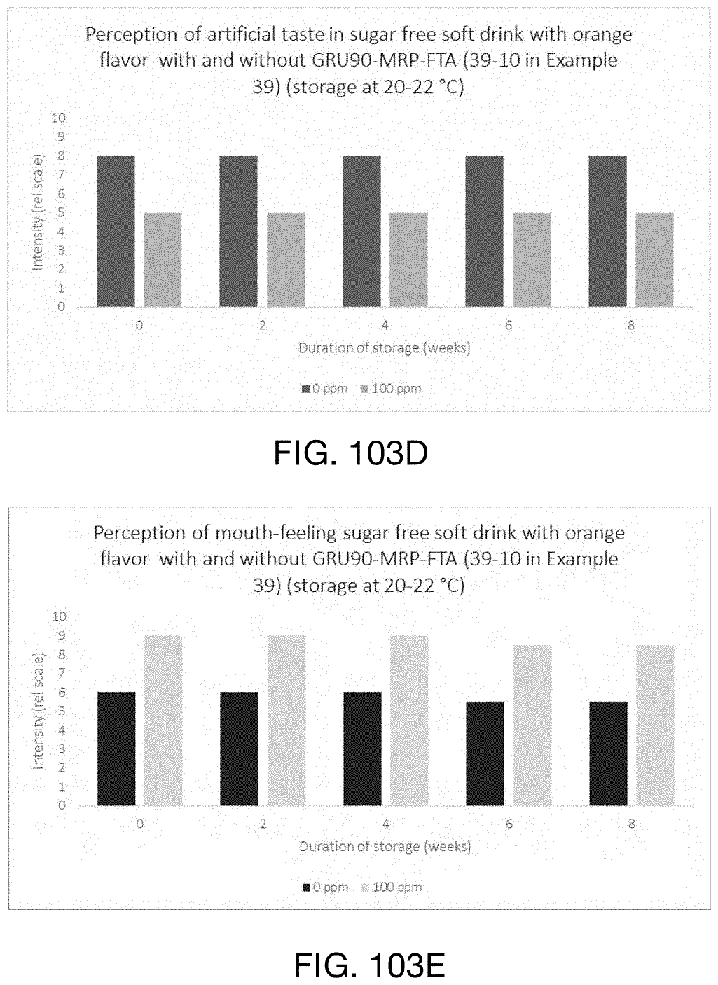

FIG. 103A is a graphical depiction showing differences in perception of various sensory characteristics in a sugar free orange soft drink with and without GRU90-MRP-FTA (39-10 in Ex. 39) following storage at 20-22° C.

FIG. 103B is a graphical depiction showing the perception of sweetness in a sugar free orange soft drink with and without GRU90-MRP-FTA (39-10 in Ex. 39) following storage at 20-22° C.

FIG. 103C is a graphical depiction showing the perception of artificial taste in a sugar free orange soft drink with and without GRU90-MRP-FTA (39-10 in Ex. 39) following storage at 20-22° C.

FIG. 103D is a graphical depiction showing the perception of flavor intensity in a sugar free orange soft drink with and without GRU90-MRP-FTA (39-10 in Ex. 39) following storage at 20-22° C.

FIG. 103E is a graphical depiction showing the perception of mouth-feeling in a sugar free orange soft drink with and without GRU90-MRP-FTA (39-10 in Ex. 39) following storage at 20-22° C.

### Example 137. Stability Test of GSG-MRP-FTA in a Reduced Sugar Raspberry-Elderflower Flavored Soft Drink

Raw materials: GSG-MRP-FTA (39-05 in Ex. 39), Lot #EPC-308-59-01; Raspberry-elderflower flavored soft drink, 27.11.20 C 2113 0401.

Process: Commercial carbonized, reduced sugar raspberry-elderflower flavored soft drink (11 bottles, Brand: Billa, sweetened with sugar, 4 g/100 ml) was selected to perform a stability test of GSG-MRP-FTA (39-05 in Ex. 39). The bottled raspberry-elderberry soft drink was cooled to 2° C., opened and 100 ppm of GSG-MRP-FTA was added to each bottle (test sample). The bottles were then closed and brought to room temperature to dissolve GSG-MRP-FTA completely. The Billa raspberry-elderflower flavored soft drink without the addition of GSG-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 137-1.

TABLE 137-1
Stability test results for GSG-MRP-FTA (39-05 in Ex. 39) in
a reduced sugar raspberry-elderflower flavored soft drink.

| | Duration of | |
|---|---|---|
| Sample | storage | Sensory evaluation |
| Control | 0 weeks, | Lack of sweetness, void taste, intensive |
| | 2-4° C. | raspberry flavor |
| Test | | Sweeter than control, pleasant sweet, smoother |
| | | mouth-feeling, enhanced and well-balanced |
| | | raspberry flavor with lemon notes |
| Control | 0 weeks, | Lack of sweetness, void taste, intensive |
| | 20-22° C. | raspberry flavor |
| Test | | Sweeter than control, pleasant sweet, smoother |
| | | mouth-feeling, enhanced and well-balanced |
| | | raspberry flavor with lemon notes |
| Control | 2 weeks, | Lack of sweetness, void taste, intensive |
| | 2-4° C. | raspberry flavor |
| Test | | Sweeter than control, pleasant sweet, smoother |
| | | mouth-feeling, enhanced and well-balanced |
| | | raspberry flavor with lemon notes |
| Control | 2 weeks, | Lack of sweetness, void taste, intensive |
| | 20-22° C. | raspberry flavor |
| Test | | Sweeter than control, pleasant sweet, smoother |
| | | mouth-feeling, enhanced and well-balanced |
| | | raspberry flavor with lemon notes |
| Control | 4 weeks, | Lack of sweetness, void taste, intensive |
| | 2-4° C. | raspberry flavor |
| Test | | Sweeter than control, pleasant sweet, smoother |
| | | mouth-feeling, enhanced and well-balanced |
| | | raspberry flavor with lemon notes |
| Control | 4 weeks, | Lack of sweetness, void taste, intensive |
| | 20-22° C. | raspberry flavor |
| Test | | Sweeter than control, pleasant sweet, smoother |
| | | mouth-feeling, enhanced and well-balanced |
| | | raspberry flavor with lemon notes |
| Control | 6 weeks, | Lack of sweetness, void taste, less raspberry |
| | 2-4° C. | flavor and less mouth-feeling compared to |
| | | week 4 |
| Test | | Sweeter than control, pleasant sweet, less |
| | | raspberry flavor and less mouth-feeling |
| | | compared to week 4, reduced lingering |
| Control | 6 weeks, | Lack of sweetness, void taste, less raspberry |
| | 20-22° C. | flavor and less mouth-feeling compared to |
| | | week 4 |
| Test | | Sweeter than control, pleasant sweet, less |
| | | raspberry flavor and less mouth-feeling |
| | | compared to week 4, reduced lingering |
| Control | 8 weeks, | Lack of sweetness, void taste, similar flavor |
| | 2-4° C. | perception and mouth-feeling compared to 6 |
| | | weeks of storage |
| Test | | Sweeter than control, pleasant sweet, similar |
| | | flavor perception and mouth-feeling compared |
| | | to 6 weeks of storage |
| Control | 8 weeks, | Lack of sweetness, void taste, similar flavor |
| | 20-22° C. | perception and mouth-feeling compared to 6 |
| | | weeks of storage |
| Test | | Sweeter than control, pleasant sweet, similar |
| | | flavor perception and mouth-feeling compared |
| | | to 6 weeks of storage |

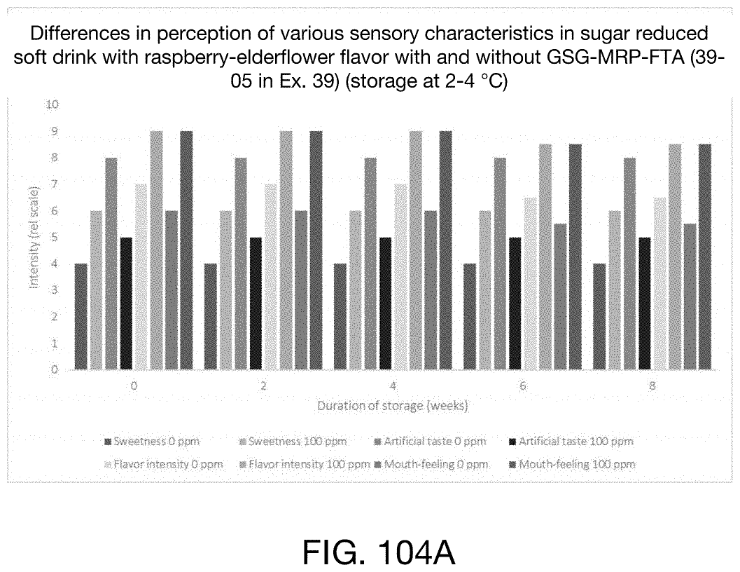

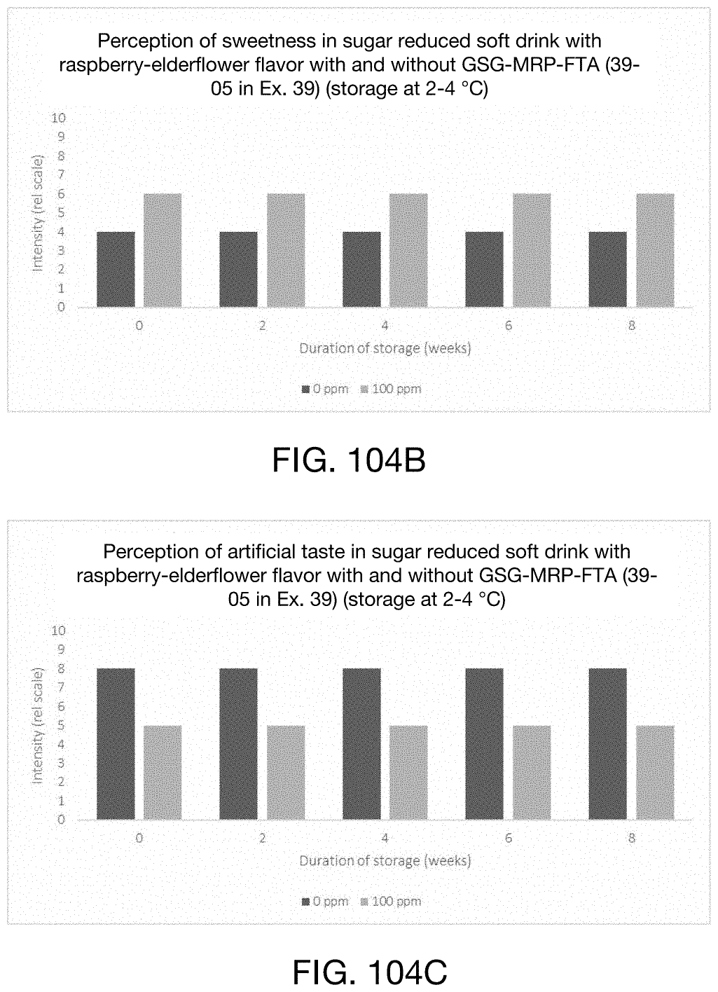

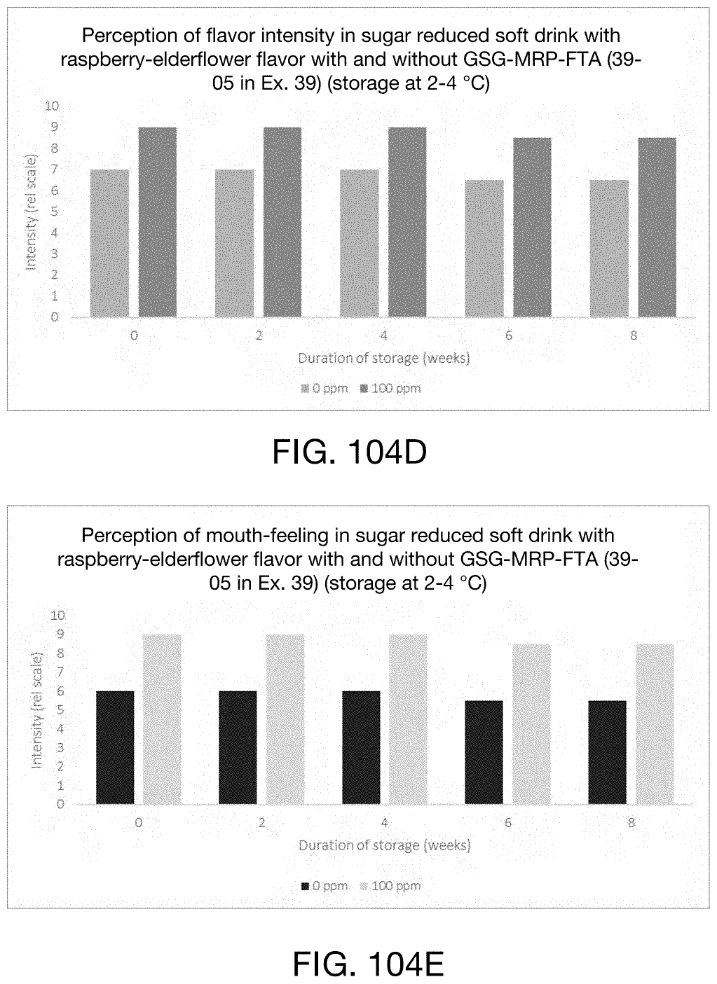

FIG. 104A is a graphical depiction showing differences in perception of various sensory characteristics in a reduced sugar raspberry-elderflower flavored soft drink with and without GSG-MRP-FTA (39-05 in Ex. 39) following storage at 2-4° C.

FIG. 104B is a graphical depiction showing the perception of sweetness in a reduced sugar raspberry-elderflower flavored soft drink with and without GSG-MRP-FTA (39-05 in Ex. 39) following storage at 2-4° C.

FIG. 104C is a graphical depiction showing the perception of artificial taste in a sugar free lemon iced tea with and without GSG-MRP-FTA (39-05 in Ex. 39) following storage at 2-4° C.

FIG. 104D is a graphical depiction showing the perception of flavor intensity in a reduced sugar raspberry-elderflower flavored soft drink with and without GSG-MRP-FTA (39-05 in Ex. 39) following storage at 2-4° C.

FIG. 104E is a graphical depiction showing the perception of mouth-feeling in a reduced sugar raspberry-elderflower flavored soft drink with and without GSG-MRP-FTA (39-05 in Ex. 39) following storage at 2-4° C.

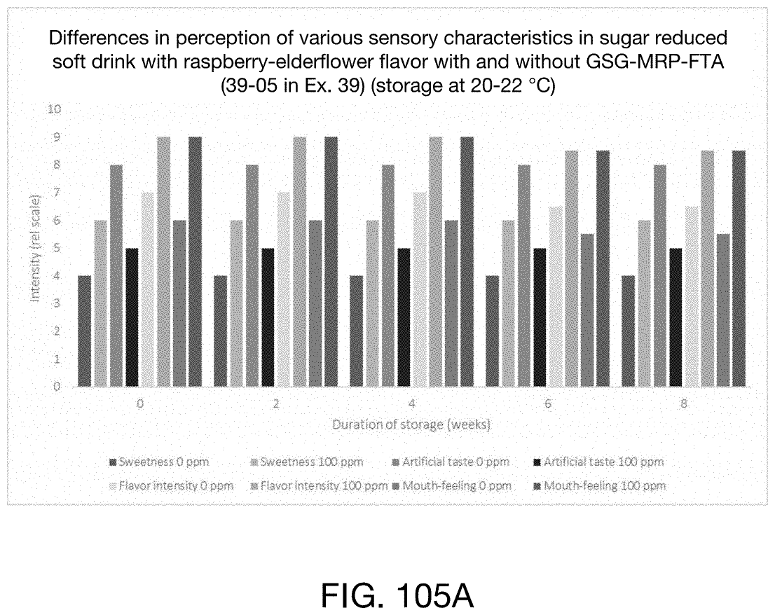

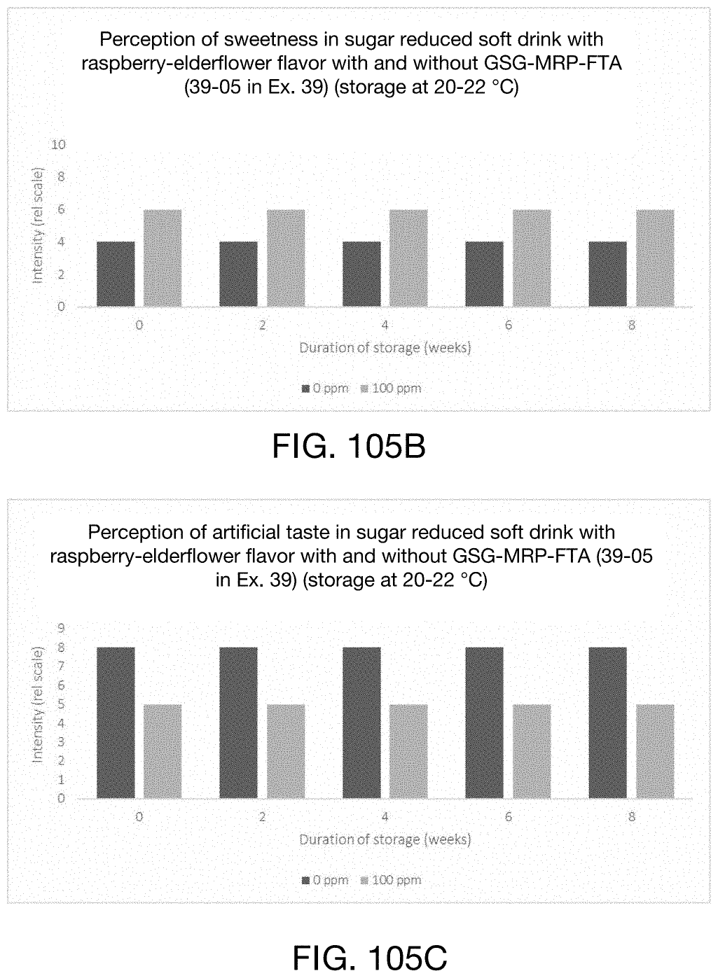

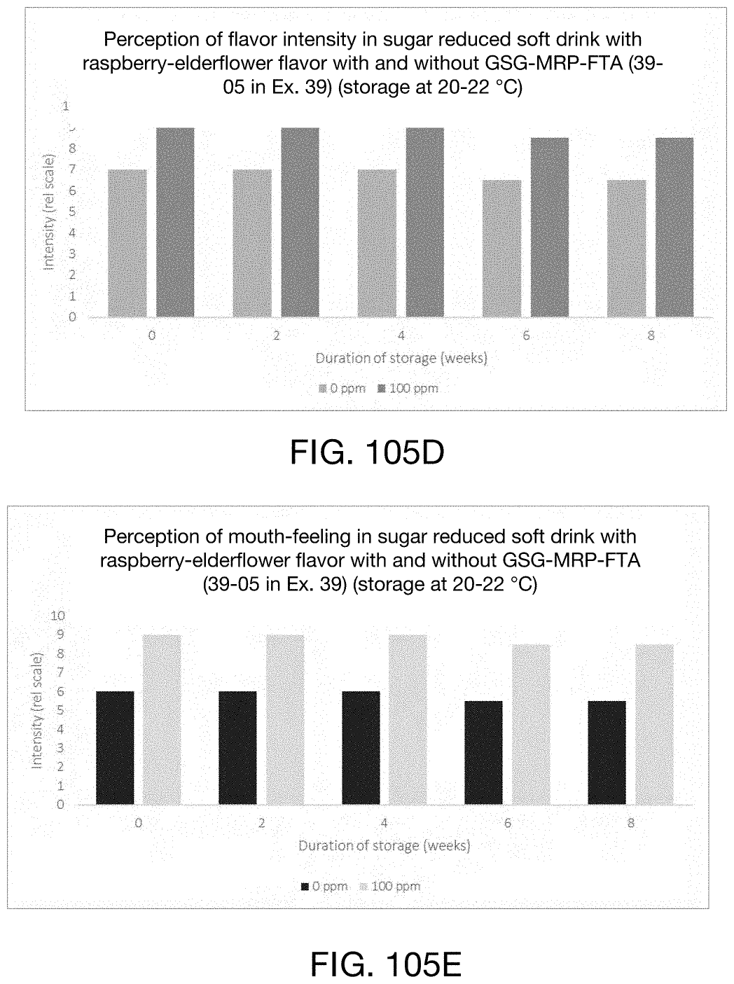

FIG. 105A is a graphical depiction showing differences in perception of various sensory characteristics in a reduced sugar raspberry-elderflower flavored soft drink with and without GSG-MRP-FTA (39-05 in Ex. 39) following storage at 20-22° C.

FIG. 105B is a graphical depiction showing the perception of sweetness in a reduced sugar raspberry-elderflower flavored soft drink with and without GSG-MRP-FTA (39-05 in Ex. 39) following storage at 20-22° C.

FIG. 105C is a graphical depiction showing the perception of artificial taste in a reduced sugar raspberry-elderflower flavored soft drink with and without GSG-MRP-FTA (39-05 in Ex. 39) following storage at 20-22° C.

FIG. 105D is a graphical depiction showing the perception of flavor intensity in a reduced sugar raspberry-elderflower flavored soft drink with and without GSG-MRP-FTA (39-05 in Ex. 39) following storage at 20-22° C.

FIG. 105E is a graphical depiction showing the perception of mouth-feeling in a reduced sugar raspberry-elderflower flavored soft drink with and without GSG-MRP-FTA (39-05 in Ex. 39) following storage at 20-22° C.

### Example 138. Stability Test of GRU90-MRP-FTA in a Reduced Sugar Raspberry-Elderflower Flavored Soft Drink

Raw materials: GRU90-MRP-FTA (39-10 in Ex. 39), Lot #EPC-307-80-02; Raspberry-elderflower flavored soft drink, 27.11.20 C 2113 0401.

Process: A commercial carbonized, sugar reduced raspberry-elderflower flavored soft drink (11 bottles, Brand: Billa, sweetened with sugar, 4 g/100 ml) was selected to perform a stability test of GRU90-MRP-FTA (39-10 in Ex. 39). The bottled sugar reduced raspberry-elderflower flavored soft drink was cooled to 2° C., opened and 100 ppm of GRU90-MRP-FTA was added to each bottle (test sample). The bottles were then closed and brought to room temperature to dissolve GRU90-MRP-FTA completely. The Billa raspberry-elderflower flavored soft drink without the addition of GRU90-MRP-FTA was used as a control.

Experiment: The control and test samples were stored for 16 weeks at 2-4° C. or 20-22° C. The test parameters (appearance, flavor, overall taste) were evaluated every 2 weeks after beginning the tests. The room temperature samples were cooled to 2-4° C. before sensory evaluations. Recognizable differences between control and test samples were noted in the sensory evaluations as described in Table 138-1.

TABLE 138-1
Stability test results for GRU90-MRP-FTA (39-10 in Ex. 39) in
a sugar reduced raspberry-elderflower flavored soft drink.

| | Duration of | |
|---|---|---|
| Sample | storage | Sensory evaluation |
| Control | 0 weeks, | Lack of sweetness, void taste, intensive |
| | 2-4° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 0 weeks, | Lack of sweetness, void taste, intensive |
| | 20-22° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 2 weeks, | Lack of sweetness, void taste, intensive |
| | 2-4° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 2 weeks, | Lack of sweetness, void taste, intensive |
| | 20-22° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 4 weeks, | Lack of sweetness, void taste, intensive |
| | 2-4° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 4 weeks, | Lack of sweetness, void taste, intensive |
| | 20-22° C. | raspberry flavor |
| Test | | Sweeter than control, pleasant sweet, |
| | | smoother mouth-feeling, enhanced and |
| | | well-balanced raspberry flavor with lemon |
| | | notes |
| Control | 6 weeks, | Lack of sweetness, void taste, less |
| | 2-4° C. | raspberry flavor and less mouth-feeling |
| | | compared to week 4 |
| Test | | Sweeter than control, pleasant sweet, less |
| | | raspberry flavor and less mouth-feeling |
| | | compared to week 4, reduced lingering |
| Control | 6 weeks, | Lack of sweetness, void taste, less |
| | 20-22° C. | raspberry flavor and less mouth-feeling |
| | | compared to week 4 |
| Test | | Sweeter than control, pleasant sweet, less |
| | | raspberry flavor and less mouth-feeling |
| | | compared to week 4, reduced lingering |
| Control | 8 weeks, | Lack of sweetness, void taste, similar |
| | 2-4° C. | flavor perception and mouth-feeling |
| | | compared to 6 weeks of storage |
| Test | | Sweeter than control, pleasant sweet, |
| | | similar flavor perception and mouth- |
| | | feeling compared to 6 weeks of storage |
| Control | 8 weeks, | Lack of sweetness, void taste, similar |
| | 20-22° C. | flavor perception and mouth-feeling |
| | | compared to 6 weeks of storage |
| Test | | Sweeter than control, pleasant sweet, |
| | | similar flavor perception and mouth- |
| | | feeling compared to 6 weeks of storage |

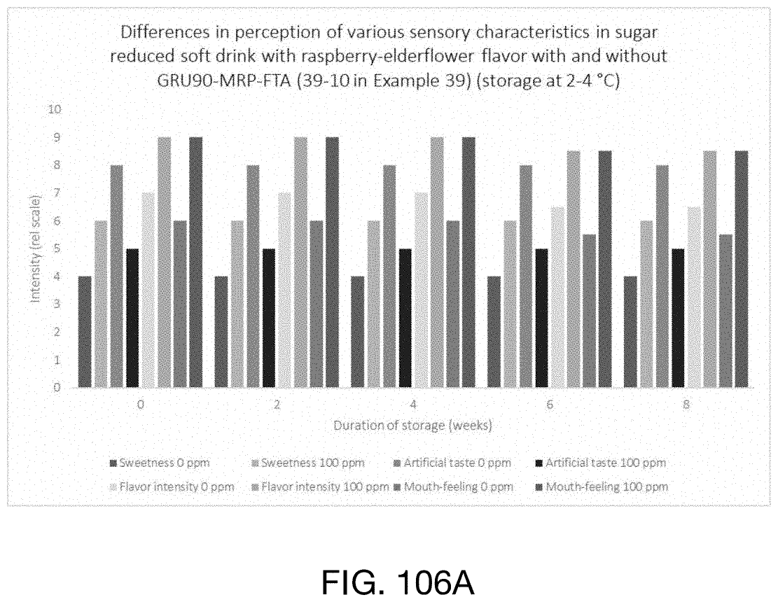

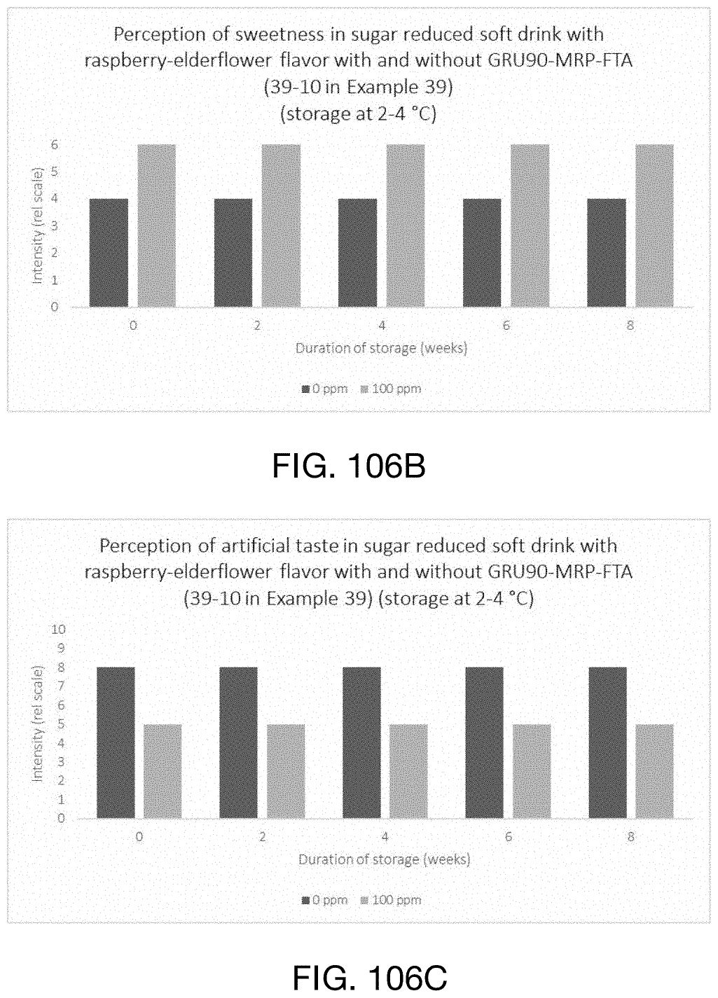

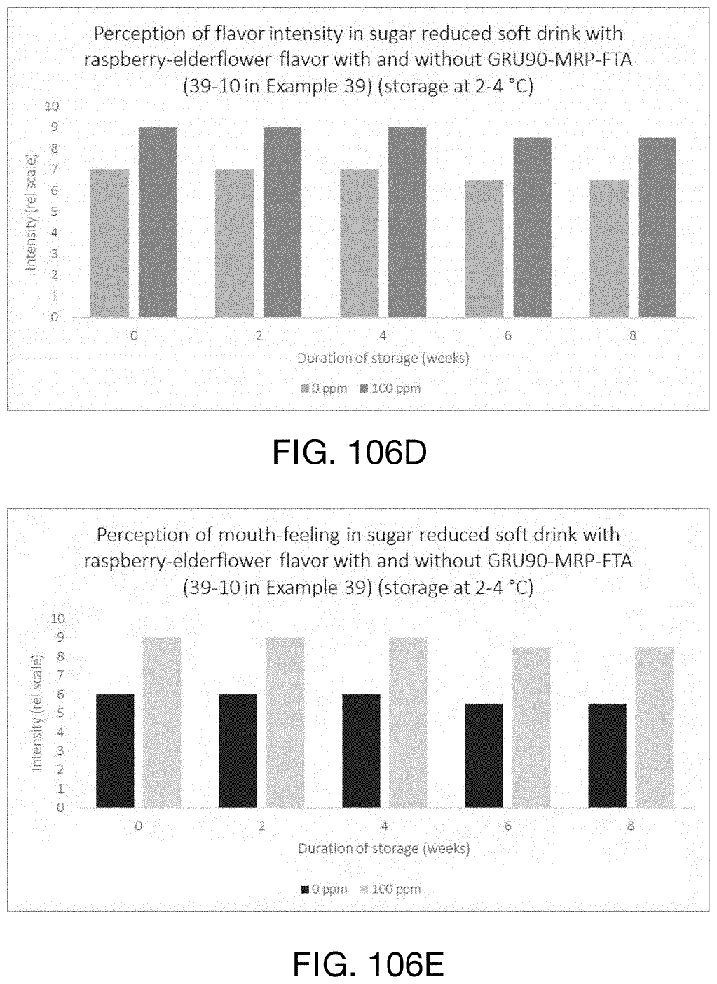

FIG. 106A is a graphical depiction showing differences in perception of various sensory characteristics in a reduced sugar raspberry-elderflower flavored soft drink with and without GRU90-MRP-FTA (39-10 in Ex. 39) following storage at 2-4° C.

FIG. 106B is a graphical depiction showing the perception of sweetness in a reduced sugar raspberry-elderflower flavored soft drink with and without GRU90-MRP-FTA (39-10 in Ex. 39) following storage at 2-4° C.

FIG. 106C is a graphical depiction showing the perception of artificial taste in a reduced sugar raspberry-elderflower flavored soft drink with and without GRU90-MRP-FTA (39-10 in Ex. 39) following storage at 2-4° C.

FIG. 106D is a graphical depiction showing the perception of flavor intensity in a reduced sugar raspberry-elderflower flavored soft drink with and without GRU90-MRP-FTA (39-10 in Ex. 39) following storage at 2-4° C.

FIG. 106E is a graphical depiction showing the perception of mouth-feeling in a reduced sugar raspberry-elderflower flavored soft drink with and without GRU90-MRP-FTA (39-10 in Ex. 39) following storage at 2-4° C.

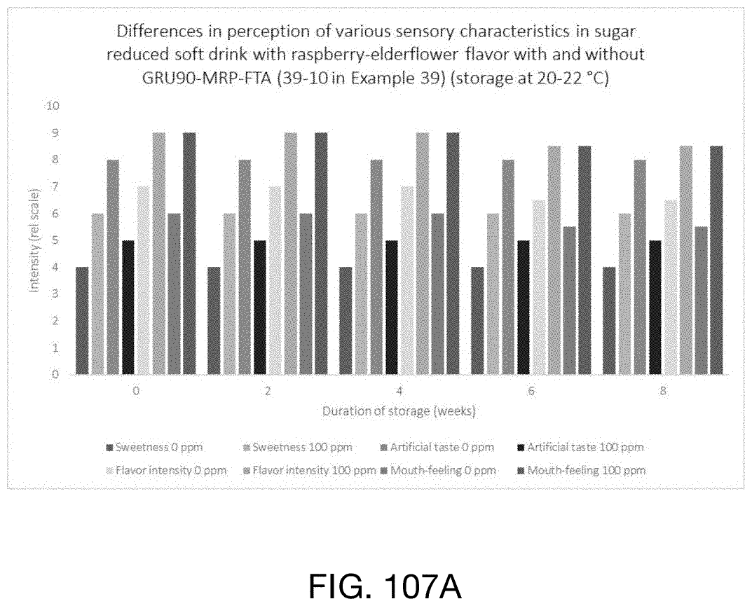

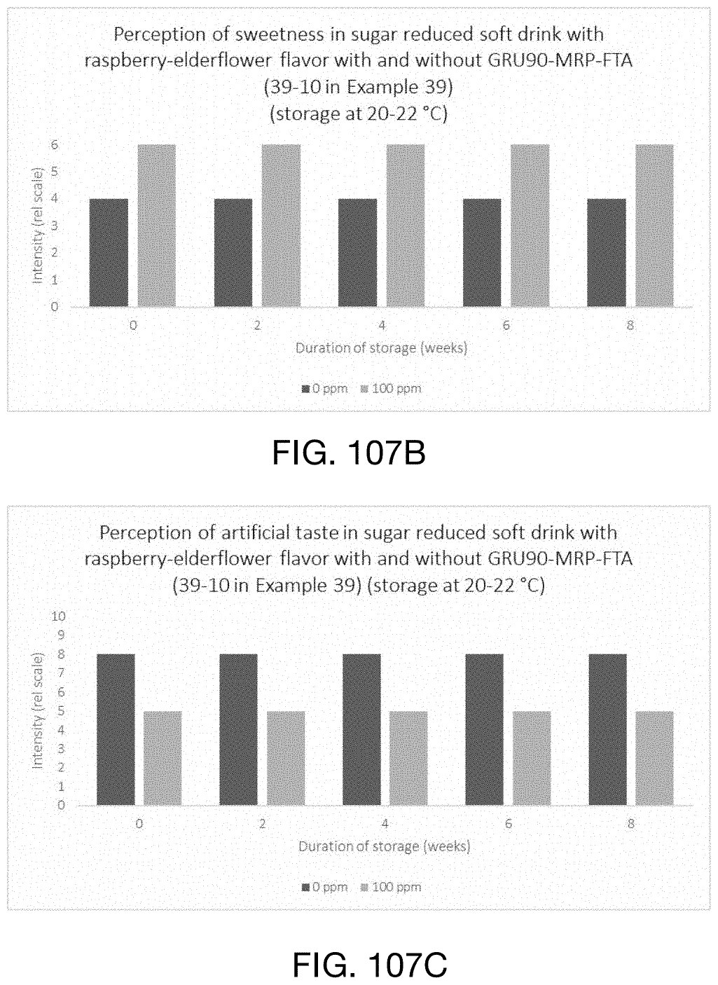

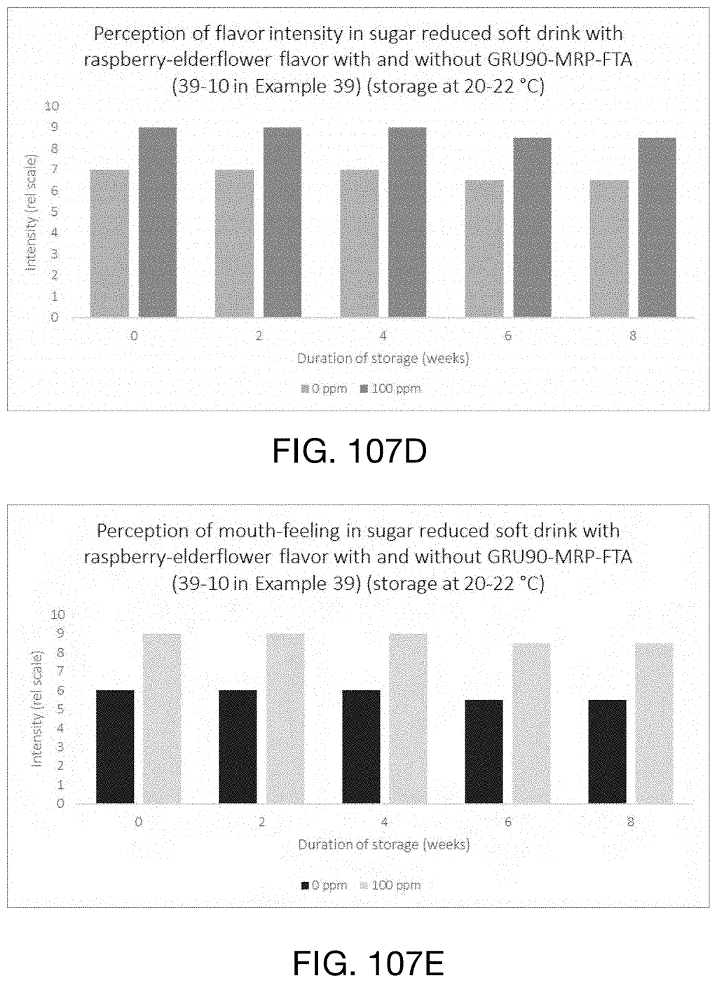

FIG. 107A is a graphical depiction showing differences in perception of various sensory characteristics in a reduced sugar raspberry-elderflower flavored soft drink with and without GRU90-MRP-FTA (39-10 in Ex. 39) following storage at 20-22° C.

FIG. 107B is a graphical depiction showing the perception of sweetness in a reduced sugar raspberry-elderflower flavored soft drink with and without GRU90-MRP-FTA (39-10 in Ex. 39) following storage at 20-22° C.

FIG. 107C is a graphical depiction showing the perception of artificial taste in a reduced sugar raspberry-elderflower flavored soft drink with and without GRU90-MRP-FTA (39-10 in Ex. 39) following storage at 20-22° C.

FIG. 107D is a graphical depiction showing the perception of flavor intensity in a reduced sugar raspberry-elderflower flavored soft drink with and without GRU90-MRP-FTA (39-10 in Ex. 39) following storage at 20-22° C.

FIG. 107E is a graphical depiction showing the perception of mouth-feeling in a reduced sugar raspberry-elderflower flavored soft drink with and without GRU90-MRP-FTA (39-10 in Ex. 39) following storage at 20-22° C.

### Example 139. Evaluation of Taste Intensity of GSG-MRP-CA, GSG-MRP-PO and GRU90-MRP-FTA

Raw materials: GRU90-MRP-FTA (Ex. 39, 39-10), Lot #EPC-307-80-02, EPC; GSG-MRP-CA, available from EPC Lab, Part Number 14041-01, Lot #20190801; GSG-MRP-PO, available from EPC Lab, Part Number 14041-03, Lot #20190703; Alpha-Lactose monohydrate, Lot 31K01021, Sigma Aldrich.

Experiment: Sensory evaluations were carried out using GSG-MRP-CA, GSG-MRP-PO, and GRU90-MRP samples that were mixed 1:10 with lactose. 10 mg of each sample/lactose mixture was placed on a taster's tongue and held thereon for 10 seconds. Then, the tongue was pressed on the palate and slow breathing through the nose commenced. Differences in taste intensity perception between these two points were recorded in Table 139-1. GSG-MRP-CA was coded as sample 1, GSG-MRP-P0 as sample 2 and GRU90-MRP-FTA (39-10 in Ex. 39) as sample 3.

TABLE 139-1
Evaluation of taste intensity.

| | | |
|---|---|---|
| Sample | After placing sample on tongue | After pressing tongue on palate |

Taster 1

| | | |
|---|---|---|
| 1 | slightly sweet, at the beginning no | sweeter, more intensive caramel/ |
| | recognizable flavor, then slight | burnt sugar/cotton candy flavor |
| | caramel (burnt sugar) flavor | |
| 2 | slightly sweet taste and slightly | sweeter taste, more intensive |
| | sweet flavor (sweet popcorn) | honey, sweet popcorn flavor |
| 3 | slightly sweet, fruity, immediately | sweeter, more citrus (lemon) |
| | recognizable citrus (lemon) flavor | flavor, slight bitter |

Taster 2

| | | |
|---|---|---|
| 1 | slightly sweet, slightly burnt, no | sweet, slightly burnt, coffee flavor, |
| | flavor recognizable | burnt sugar |
| 2 | slightly sweet, slightly burnt, no | sweet, slightly burnt, honey flavor |
| | flavor recognizable | |
| 3 | bitter, not sweet, immediately | slightly sweet, bitter, very intensive |
| | recognizable citrus flavor | citrus flavor |

Taster 3

| | | |
|---|---|---|
| 1 | sweet, no recognizable flavor | sweet mouth-feeling, some flavor is |
| | | present, but not recognizable, |
| | | intensive |
| 2 | sweet, slight recognizable flavor | sweet mouth-feeling, intensive sweet |
| | | flavor is present, but not |
| | | recognizable |
| 3 | slightly sweet, immediately | sweeter, more citrus flavor |
| | recognizable citrus flavor | |

### Example 140. Concentrations of GRU90, GRU90-MRP, Steviol Glycosides and Thaumatin to Reach the Sweetness of Raspberry-Apple Juice (˜33% Sugar Replacement)

Raw materials: GRU90 (Ex. 7 product); GRU90-MRP-FTA (39-10 in Ex. 39); Thaumatin 93%, Part Number T93001, Lot #20190601; Vanilla Flavor, 60297, Select alimenta; Steviol glycosides RA20/SG95, Lot #20180413; Raspberry-apple concentrate, 211115 Ratio Drink.

Reference sample: 50 ml of raspberry-apple juice concentrate (nutritional value 223 kcal/100 ml, sugar content 46 g/100 ml) was mixed with 450 ml of deionized water to make raspberry-apple juice (4.6 g sugar/100 ml) base sample composition. To this base composition, 11.5 g of sugar was added to achieve a sweetness of 6.9 g/100 ml.

Each test sample was prepared by adding to the base composition the flavor/sweetener compositions to achieve a sugar equivalence of 6.9 g/100 ml as described in Table 140-1. Sweetness and flavor/taste perception of the test samples were compared to the reference sample and recorded in Table 140-1. Each test sample had a nutritional value of 22.3 kcal/100 ml (slightly above the classification of “Light” with a 30% sugar reduction.

TABLE 140-1
Sample preparation and sensory evaluation results.

| | Sample No. and Component Concentrations (ppm) | | | | |
|---|---|---|---|---|---|
| | 1 | | | | |
| | (Reference | | | | |
| Component | Sample) | 2 | 3 | 4 | 5 |
| GRU90 | — | 200 | 140 | 200 | 140 |
| GRU90- | — | 20 | — | 20 | — |
| MRP-FTA | | | | | |
| RA20/SG95 | — | — | 60 | — | 60 |
| Vanilla | — | 10 | 10 | 10 | 10 |
| Flavor | | | | | |
| Thaumatin | — | — | — | 1 | 1 |
| 93% | | | | | |
| Sensory | Raspberry | Sweetness: | Sweetness: | Enhanced | Enhanced |
| evaluation | flavor, | comparable | good; | raspberry- | raspberry |
| | sour, | to reference | comparable | apple flavor, | flavor, |
| | watery, | sample, | to reference | enhanced | enhanced |
| | not sweet | pleasant | sample, | mouth- | mouth- |
| | enough | sweet, | pleasant | feeling, | feeling, |
| | | enhanced | sweet, | pleasant | pleasant |
| | | mouth- | enhanced | sweet, no | sweet, no |
| | | feeling, no | mouth- | lingering | lingering |
| | | lingering, | feeling, | | |
| | | well- | enhanced | | |
| | | balanced | raspberry | | |
| | | raspberry- | flavor, no | | |
| | | apple flavor | lingering | | |

### Example 141. Concentrations of GRU90, GRU90-MRP, Steviol Glycoside and Thaumatin to Reach the Sweetness of Raspberry-Apple Juice (˜41% Sugar Replacement)

Raw materials: GRU90 (product of Ex. 7); GRU90-MRP-FTA (Ex. 39, 39-10); Thaumatin 93%, Part Number T93001, Lot #20190601; Vanilla Flavor, 60297, Select alimenta; Steviol glycosides RA20/SG95, Lot #20180413; Raspberry-apple concentrate, 211115 Ratio Drink.

Reference sample: 44 ml of raspberry-apple juice concentrate (nutritional value 223 kcal/100 ml, sugar content 46 g/100 ml) was mixed with 450 ml of deionized water to make raspberry-apple juice base composition. To this base composition, 14.26 g of sugar was added to achieve a sweetness of 6.9 g/100 ml.

Each test sample was prepared by adding to the base composition the flavor/sweetener compositions to achieve a sugar equivalence of 4.048 g/100 ml as described in Table 141-1. Sweetness and flavor/taste perception of the test samples were compared to the reference sample and recorded in Table 141-1. Each test sample had a nutritional value of <20 kcal/100 ml (classification “Light”).

TABLE 141-1
Sample preparation and sensory evaluation results.

| | Sample No. and Component Concentrations (ppm) | | | | |
|---|---|---|---|---|---|
| | 1 | | | | |
| | (Reference | | | | |
| Component | Sample) | 2 | 3 | 4 | 5 |
| GRU90 | — | 300 | 160 | 300 | 160 |
| GRU90- | — | 20 | — | 20 | — |
| MRP-FTA | | | | | |
| RA20/SG95 | — | — | 80 | — | 80 |
| Vanilla | — | 10 | 10 | 10 | 10 |
| Flavor | | | | | |
| Thaumatin | — | — | — | 1 | 1 |
| 93% | | | | | |
| Sensory | Raspberry | Sweetness: | Sweetness: | Enhanced | Enhanced |
| evaluation | flavor, | good; | good; | raspberry- | raspberry |
| | sour, | comparable | comparable | lemon flavor, | flavor, |
| | void taste, | to reference | to reference | enhanced | enhanced |
| | not sweet | sample, | sample, | mouth- | mouth- |
| | enough | pleasant | pleasant | feeling, | feeling, |
| | | sweet, | sweet, | pleasant | pleasant |
| | | enhanced | enhanced | sweet, no | sweet, no |
| | | mouth- | mouth- | lingering | lingering |
| | | feeling, no | feeling, | | |
| | | lingering, | enhanced | | |
| | | well- | raspberry | | |
| | | balanced | flavor, no | | |
| | | raspberry- | lingering | | |
| | | lemon flavor | | | |

### Example 142. Taste/Sweetness Evaluations of RUs, GRUB, and GRU90-MRPs

Steviol Glycosides:

RU20, available from Guilin Layin Natural Ingredients Corp. The conc. of RU is 20.68% Lot #STL02-151005

GRU20, Lot #EPC-303-89-03, EPC Lab

GRU20-MRP-CA, Lot #EPC-303-56-01, EPC Lab

GRU20-MRP-TA, Lot #EPC-303-56-02, EPC Lab

TRU20, Lot #EPC-303-74-01, EPC Lab

GTRU20, Lot #EPC-303-73-01, EPC Lab

GTRU20-MRP-CA, Lot #EPC-303-59-01, EPC Lab

GTRU20-MRP-HO, Lot #EPC-303-59-02, EPC Lab

RU90, Lot #EPC-238-34-03, EPC Lab

GRU90, Lot #EPC-303-89-03, EPC Lab

GRU90-MRP-CA, Lot #EPC-303-91-01, EPC Lab

GRU90-MRP-HO, Lot #EPC-303-91-01, EPC Lab

GRU90-MRP-TA, Lot #EPC-303-91-03, EPC Lab

GSG-RA50, Lot #S150311

GSG-RA60, Lot #EPC171-34-01

GSG-RA70, Lot #EPC171-36-01

GSG-RA80, Lot #14118

GSG-RA90, Lot #EPC171-38-01

GSG-RA95, Lot #15207

GSG-(RA50+RC5), Lot #EPC174-73-02

GSG-(RA30+RC15), Lot #EPC174-73-01

Experiment: 50 ppm solutions of the above-described steviol glycoside compositions were prepared and evaluated for sweetness and recorded in Table 142-1. In addition, the 50 ppm steviol glycoside solutions were and mixed with sucrose to form 3% sucrose solutions. Changes in sweetness of the sucrose solution after addition of the steviol glycosides were evaluated and recorded as described in Table 142-2.

TABLE 142-1
Sweetness of different RU-, GRU-, and GRU90-MRP compositions.

| Steviol glycoside | [ppm] | Aroma | Taste/Sweetness |
|---|---|---|---|
| RU20 | 50 | sweet, herbal | Not sweet, herbal, slight lingering aftertaste |
| GRU20 | 50 | neutral | Not sweet, slight herbal, no lingering |
| GRU20-MRP-CA | 50 | neutral | Not sweet, neutral, no lingering |
| GRU20-MRP-TA | 50 | neutral | Not sweet, neutral, no lingering |
| TRU20 | 50 | herbal | Not sweet, herbal, slight lingering aftertaste |
| GTRU20 | 50 | neutral | Not sweet, neutral, no lingering |
| GTRU20-MRP-CA | 50 | neutral | Not sweet, neutral, no lingering |
| GTRU20-MRP-HO | 50 | neutral | Not sweet, flowery aftertaste, no lingering |
| RU90 | 50 | neutral | Very slightly sweet, neutral, no lingering |
| GRU90 | 50 | neutral | Very slightly sweet, neutral, no lingering |
| GRU90-MRP-CA | 50 | neutral | Very slightly sweet, neutral, no lingering |
| GRU90-MRP-HO | 50 | neutral | Slightly sweet, neutral, slight lingering |
| GRU90-MRP-TA | 50 | neutral | Slightly sweet, slight flowery, slight lingering |
| GSG-RA50 | 50 | neutral | Very slightly sweet, neutral, no lingering |
| GSG-RA60 | 50 | neutral | Slightly sweet, neutral, very slight lingering |
| | | | aftertaste |
| GSG-RA70 | 50 | neutral | Slightly sweet, neutral, very slight lingering |
| | | | aftertaste |
| GSG-RA80 | 50 | neutral | Slightly sweet, neutral, slight lingering |
| | | | aftertaste |
| GSG-RA90 | 50 | neutral | Slightly sweet, neutral, slight lingering |
| | | | aftertaste |
| GSG-RA95 | 50 | neutral | Slightly sweet, neutral, slight lingering |
| | | | aftertaste |
| GSG (RA50 + | 50 | neutral | Slightly sweet, neutral, slight lingering |
| RC5) | | | aftertaste |
| GSG (RA30 + | 50 | neutral | Slightly sweet, neutral, slight lingering |
| RC15) | | | aftertaste |

TABLE 142-2
Sweetness of 3% sucrose solutions with different
RU-, GRU-, and GRU90-MRP compositions.

| | Steviol glycoside | Sensory evaluation |
|---|---|---|
| 3% | — | Slightly sweet, neutral taste |
| sucrose | | |
| 3% | 50 ppm RU20 | Sweeter, slight herbal aftertaste, no lingering |
| sucrose + | 50 ppm GRU20 | Sweeter, slight herbal aftertaste, no lingering |
| | 50 ppm GRU20-MRP-CA | Sweeter, slight herbal aftertaste, no lingering |
| | 50 ppm GRU20-MRP-TA | Sweeter, very slight herbal aftertaste, no |
| | | lingering |
| | 50 ppm TRU20 | Same sweet, herbal, aftertaste, no lingering |
| | 50 ppm GTRU20 | Slightly sweeter, neutral, no lingering |
| | 50 ppm GTRU20-MRP-CA | Slightly sweeter, neutral, no lingering |
| | 50 ppm GTRU20-MRP-HO | Slightly sweeter, flowery aftertaste, no lingering |
| | 50 ppm RU90 | Sweeter, neutral, no lingering |
| | 50 ppm GRU90 | Sweeter, neutral, no lingering |
| | 50 ppm GRU90-MRP-CA | Sweeter, neutral, no lingering |
| | 50 ppm GRU90-MRP-HO | Sweeter, flowery aftertaste, no lingering |
| | 50 ppm GRU90-MRP-TA | Sweeter, neutral, no lingering |
| | 50 ppm GSG-RA50 | Slightly sweeter, neutral, no lingering |
| | 50 ppm GSG-RA60 | Sweeter, neutral, no lingering |
| | 50 ppm GSG-RA70 | Sweeter, neutral, no lingering |
| | 50 ppm GSG-RA80 | Sweeter, neutral, very slight lingering |
| | 50 ppm GSG-RA90 | Sweeter, neutral, very slight lingering |
| | 50 ppm GSG-RA95 | Sweeter, neutral, very slight lingering |
| | 50 ppm GSG(RA50 + RC5) | Slightly sweeter, neutral, no lingering |
| | 50 ppm GSG(RA30 + RC15) | Slightly sweeter, neutral, no lingering |

### Example 143. Retro-Nasal Effects of GSG-MRP-CA, GSG-MRP-PO and GRU90-MRP-FTA

Raw materials: GSG-MRP-CA, available from Sweet Green Field, Part Number 14041-01, Lot #20190801; GSG-MRP-PO, available from Sweet Green Field, Part Number 14041-03, Lot #20190703; GRU90-MRP-FTA (39-10 in Ex. 39), Lot #EPC-307-80-02; lactose monohydrate, Lot 31K01021, Sigma Aldrich.

Experiment: Each sample was mixed with lactose in a sample:lactose ratio of 1:10. The ratio was chosen to obtain samples with slight sweetness on the tongue. Alternate fillers can be used without influencing the test results. 10 mg samples were transferred on the front past tongue and kept there for 10 seconds with an opened mouth and normal breathing (Period 1). Then, the tongue was pressed on the palate while breathing in through the opened mouth and slowly out through the nose (Period 2). The sensory attributes were recorded as a joint description by 3 tasters in Table 143-1 for periods 1 and 2.

TABLE 143-1
Sensory attributes of GSG-MRP-CA, GSG-MRP-PO
and GRU90-MRP-FTA (39-10 in Ex. 39).

| Sample | Period 1 | Period 2 |
|---|---|---|
| GSG-MRP-CA | slight sweet, slightly | sweet, burnt sugar, |
| | burnt sugar | caramel and cotton |
| | | candy flavor |
| GSG-MRP-PO | slight sweet, slightly | sweet, burnt sugar, |
| | burnt sugar | honey and sweet |
| | | popcorn flavor |
| GRU90-MRP-FTA | slight sweet, citrus | sweet, intense citrus |
| (39-10 in Ex. 39) | flavor | flavor, slightly bitter |

Conclusion: The sensory descriptions for Period 1 differed substantially from Period 2. After pressing the sample with the tongue on the palate and breathing out through the nose, all samples tested yielded a more intensive sweet taste together with a substantially increased flavor perception.

### Example 144. Presence of Alapyridaine Enantiomers in MRPs Prepared from Alanine and Glucose

The presence of alapyridaine was evaluated in MRP samples prepared from alanine and glucose. The structure of alapyridaine is as follows:

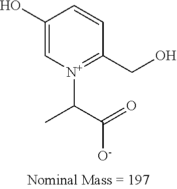

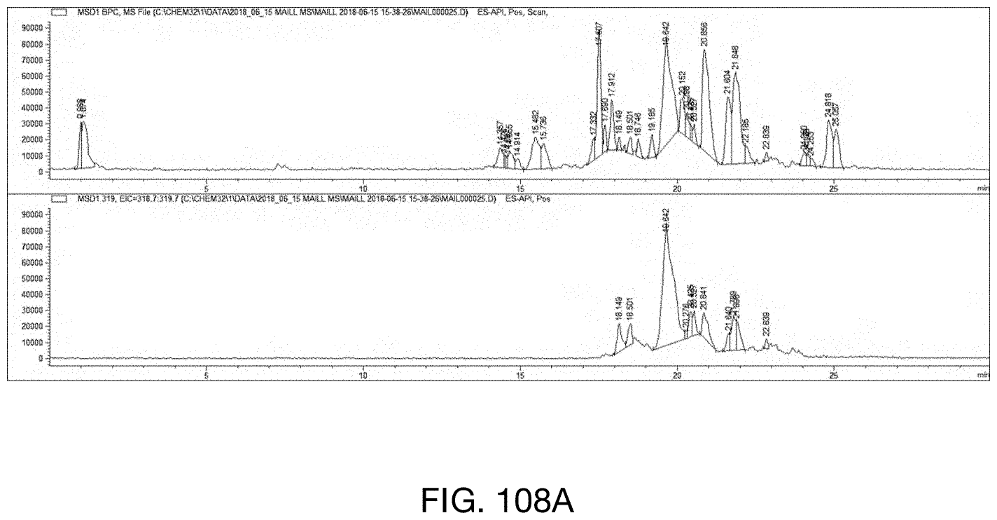

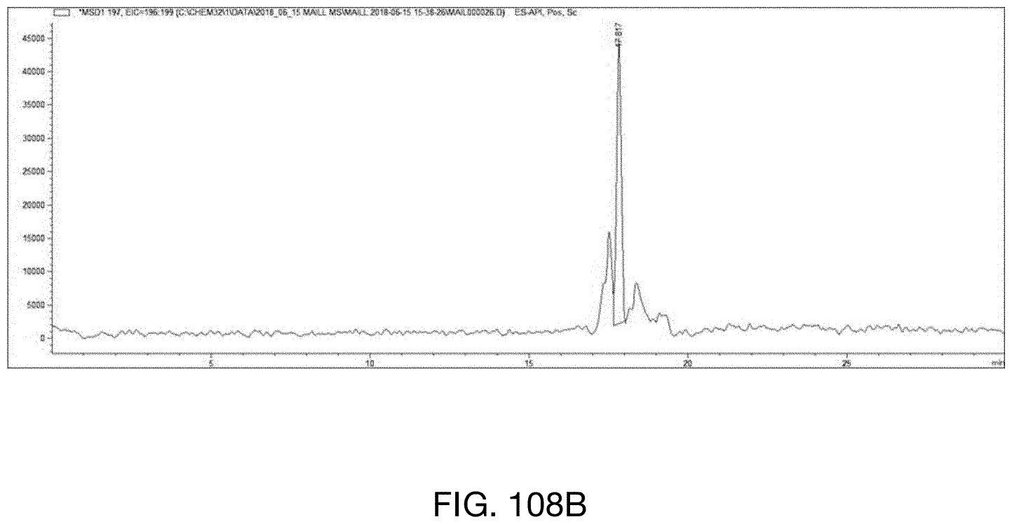

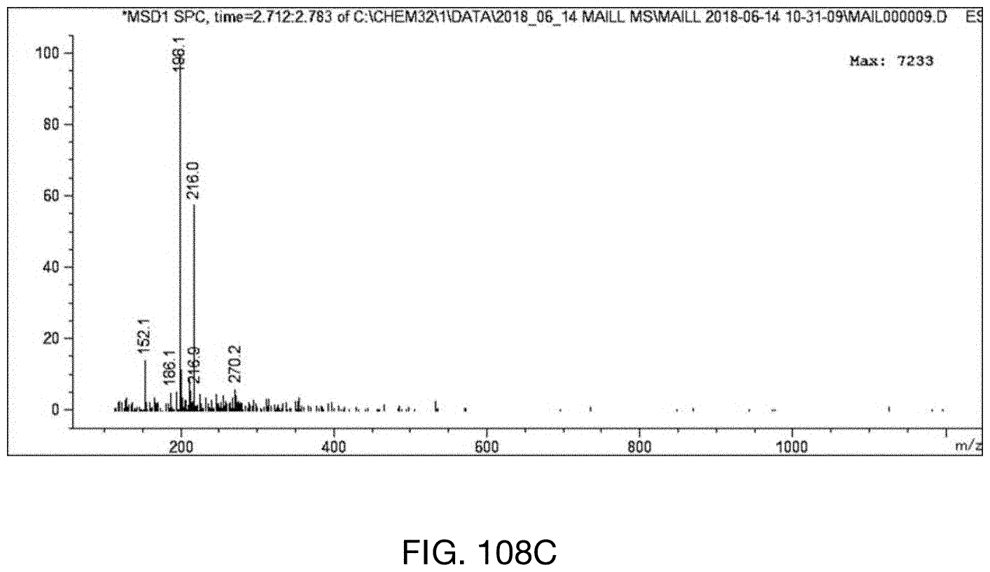

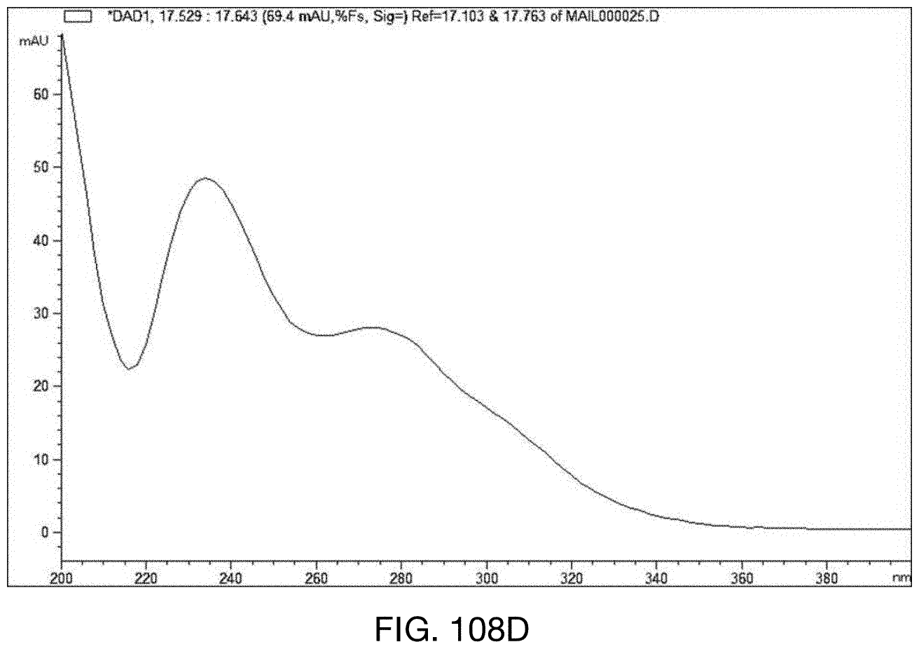

FIG. 108A show exemplary chromatograms from an MRP prepared with alanine, glucose and Stevia extract sample 1-4 in phosphate buffer pH=7.8 heated for 2.5 hours at 120° C. In the chromatogram in top panel, the upper portion shows MS-TIC; the lower portion is selective for steviol glycosides (SGs) with m/z=319. The results in FIG. 108A were interpreted to show: at 7.7 min: MRI (Ala+Glu); at 15-17 min: products related to heated sugar; at 17-25 min: SGs of ML and MRIs (Ala+SG). The steviol glycosides identified in Stevia extract samples 1-4 are shown in Table 144-9.

The chromatogram in FIG. 108B exhibits an SIM with an extracted m/z=198, which is indicative of alapyridaine ([M+H+]+). In addition, the chromatogram in FIG. 108B confirms the suggestion from FIG. 108A that the peaks at 15-17 min are related to heated sugar.

FIG. 108C shows a UV spectrum of the peak in the MS spectrum at 17.8 minutes as a peak at 17.5 minutes, where m/z 198=[M+H+]+, m/z 216=[M+H₂O+H+]+, and m/z 152=[M-46 [CO₂H₂]+H+]+. UV-spectrum of the peak at 17.5 minutes.

FIG. 108D further confirms that the MRP sample exhibited a UV-VIS spectrum similar to the published UV-VIS spectrum for alapyridaine.

The following additional samples were prepared and evaluated in accordance with Tables 144-1 and 144-2. Table 144-1 describes the reaction conditions for samples previously prepared (blue samples retrieved from an analytical archive and evaluated. Table 144-2 shows sensory evaluations of samples previously prepared at the indicated dates.

TABLE 144-1
Reaction conditions.

| Reaction partners | Conditions |
|---|---|
| 8.91 mg Ala + 18 mg Glucose | Glycerin/water = 9/1, 100° C., |
| | 45 minutes |
| 8.91 mg Ala + 96.5 mg Reb-A | Glycerin/water = 9/1, 100° C., |
| | 45 minutes |
| 4.45 mg Ala + 40.2 mg Reb-B + | Glycerin/water = 9/1, 100° C., |
| 9 mg Glu | 45 minutes |
| 8.91 mg Ala + 96.5 mg Stevia | 10 ml 0.1M KH₂PO₄ buffer, pH 7.8, |
| extract sample 1-2 | 120° C. 2.5 hours |
| 8.91 mg Ala + 96.5 mg Stevia | 10 ml 0.1M KH₂PO₄ buffer, pH 7.8, |
| extract sample 1-3 | 120° C. 2.5 hours |
| 8.91 mg Ala + 96.5 mg Stevia | 10 ml 0.1M KH₂PO₄ buffer, pH 7.8, |
| extract sample 1-8 | 120° C. 2.5 hours |
| 8.91 mg Ala + 96.5 mg Stevia | 10 ml 0.1M KH₂PO₄ buffer, pH 7.8, |
| extract sample 2-2 | 120° C. 2.5 hours |
| 8.91 mg Ala + 96.5 mg Reb-A | 10 ml 0.2M KH₂PO₄ buffer, pH 6.0, |
| | 2 hours refluxing |
| 4.45 mg Ala + 40.2 mg Reb-B | 10 ml 0.2M KH₂PO₄ buffer, pH 8.0, |
| | 4 hours refluxing |
| 8.91 mg Ala + 80.4 mg Reb-B | 10 ml 0.2M KH₂PO₄ buffer, pH 8.0, |
| | 2 hours refluxing |
| 4.45 mg Ala + 40.2 mg Reb-B | 10 ml 0.2M KH₂PO₄ buffer, pH 6.0, |
| | 4 hours refluxing |
| 8.91 mg Ala + 80.4 mg Reb-B | 10 ml 0.2M KH₂PO₄ buffer, pH 6.0, |
| | 2 hours refluxing |

TABLE 144-2
Reaction conditions and sensory evaluations.

| | | |
|---|---|---|
| | | Sensory |
| Reaction partners | Conditions | evaluation |

2018:

| | | |
|---|---|---|
| 10 mM Ala + 10 mM | 10 ml 0.1M KH₂PO₄ buffer, | fresh, flowery |
| Glucose | pH 7.8, 100° C., 2 hours | |
| 10 mM Ala + 10 mM | 10 ml 0.1M KH₂PO₄ buffer, | fresh, flowery |
| RebA | pH 7.8, 100° C., 2 hours | |
| 0.1 M Ala + 0.1 MGlc | 300 μl dH₂O (bevor heating); | caramel-like |
| | 5 ml EtOH (after heating), | |
| | 120° C., 20 min | |
| 10 mM Ala + 10 mM | 300 μl 0.1M KH₂PO₄ buffer, | fruity |
| Glucose | 170° C., 20, 30, 40 min | |
| 10 mM Ala + 9.65 g/L | 300 μl 0.1M KH₂PO₄ buffer, | fruity, grape |
| Stevia extract sample 1 | 170° C., 40 min | |
| 10 mM Ala + 9.65 g/L | 300 μl 0.1M KH₂PO₄ buffer, | fruity, grape |
| Stevia extract sample | 170° C., 40 min | |

2020:

| | | |
|---|---|---|
| 5 mg Ala + 10 mg Fru | 225 μl dH₂O, 100° C., 1 h | slightly fruity |
| 5 mg Ala + 10 mg Fru + | 225 μl dH₂O, 100° C., 1 h | enhanced |
| 50 mg RU90 | | fruitiness with |
| | | honey notes, |
| | | pleasant |
| 5 mg Ala + 10 mg Fru + | 225 μl dH₂O, 100° C., 1 h | fruity with |
| 50 mg GRU90 | | honey notes, |
| | | slight oily |

The reaction partners in Table 144-1 include Stevia extract samples 1-2, 1-3, 1-8, and 2-2. Tables 144-3, 144-4, 144-5 and 144-6 describe the steviol glycosides identified in these Stevia extract samples.

Table 144-2 describes two stevia extract samples, Stevia extract sample 1 (Lot #20180122-2-1; 163.4 mg/10 ml) and Stevia extract sample 2 (Lot #20180156-2; 172.1 mg/10 ml). Table 144-7 shows the steviol glycoside composition of Stevia extract sample 1. Table 144-8 shows the steviol glycoside composition of Stevia extract sample 2.

TABLE 144-3
Steviol glycosides identified in Stevia extract sample 1-2.

| | | | | % m/m |
|---|---|---|---|---|
| | | [M − | % m/m | other peaks |
| SG-group | Name | H]− | identified | with m/z |
| SG-1G | Steviolmonoside | 479 | | 0.71 |
| | Steviolmonoside A | 479 | | |
| SG-1G1R | Dulcoside A1 | 625 | | 0.35 |
| | Dulcoside A1 | 625 | | |
| SG-1G1X | SG-4 | 611 | <0.01 | |
| SG-2G | Reb-G1 | 641 | 0.29 | |
| | Rubusoside | 641 | 1.80 | |
| | Steviolbioside | 641 | 1.24 | |
| SG-2G1R | Dulcoside A | 787 | 1.16 | |
| | Dulcoside B | 787 | 0.31 | |
| | (JECFA C) | | | |
| | SG-3 | 787 | | 0.49 |
| | Stevioside D | 787 | | |
| SG-2G1X | Reb-F1 | 773 | 0.25 | 2.46 |
| | Reb-R1 | 773 | | |
| | Stevioside F (SG-1) | 773 | | |
| | SG-Unk1 | 773 | | |
| SG-3G | Reb B | 803 | 1.59 | |
| | Stevioside | 803 | 16.45 | |
| | Reb-KA | 803 | 0.26 | 2.17 |
| | Reb G | 803 | | |
| | Stevioside B (SG-15) | 803 | | |
| SG-3G1Fru | Reb A3 (SG-8) | 965 | <0.01 | |
| SG-3G1R | RebC | 949 | 9.57 | |
| | Reb C2/Reb S | 949 | 1.53 | |
| | Stevioside E (SG-9) | 949 | | 1.98 |
| | Stevioside E2 | 949 | | |
| | SG-10 | 949 | | |
| | Reb L1 | 949 | | |
| | SG-2 | 949 | | |
| SG-3G1X | Reb F | 935 | 3.14 | |
| | Reb R | 935 | 0.62 | |
| | SG-Unk2 | 935 | | 1.65 |
| | SG-Unk3 | 935 | | |
| | Reb F3 (SG-11) | 935 | | |
| | Reb F2 (SG-14) | 935 | | |
| SG-4G | Reb A | 965 | 22.09 | |
| | Reb A2 (SG-7) | 965 | <0.01 | |
| | Reb E | 965 | 0.31 | |
| | Reb H1 | 965 | 0.15 | |
| SG-4G1Gal | Reb T1 | 1127 | 0.53 | |
| SG-4G1R | Reb H | 1111 | 0.18 | |
| | Reb J | 1111 | 0.22 | |
| | Reb K | 1111 | 4.47 | |
| | Reb K2 | 1111 | 0.31 | |
| | SG-12 | 1111 | | 2.09 |
| | SG-Unk4 | 1111 | | |
| | SG-Unk5 | 1111 | | |
| SG-4G1X | Reb U2 | 1097 | 0.47 | |
| | Reb W2 | 1097 | 0.20 | |
| | Reb W | 1097 | 0.37 | |
| | Reb T | 1097 | 0.86 | |
| | Reb W3 | 1097 | | 1.24 |
| | Reb U | 1097 | | |
| SG-5G | Reb D | 1127 | 7.71 | |
| | Reb I | 1127 | 0.15 | |
| | Reb L | 1127 | | 2.48 |
| | Reb I3 | 1127 | | |
| | SG-Unk6 | 1127 | | |
| | Reb Q (SG-5) | 1127 | | |
| | Reb I2 (SG-6) | 1127 | | |
| | Reb Q2 | 1127 | | |
| | Reb Q3 | 1127 | | |
| SG-5G1R | Reb N | 1273 | 0.20 | |
| SG-5G1X | Reb V2 | 1259 | 0.31 | |
| | Reb V | 1259 | 0.54 | |
| | Reb Y | 1259 | 0.15 | |
| SG-6G | Reb M | 1289 | 0.25 | |
| SG-6G1R | Reb O | 1435 | 1.27 | |
| | Reb O2 | 1435 | <0.01 | |
| SG-Rel | Related SvGn#1 | 457 | 0.27 | |
| SG-Rel | Related SvGn#2 | 981 | 0.21 | |
| SG-Rel | Related SvGn#3 | 675 | <0.01 | |
| SG-Rel | Related SvGn#4 | 1127 | see above | |
| SG-Rel | Related SvGn#5 | 981 | 0.31 | |
| — | Iso-Steviolbioside | 641 | 0.57 | |
| — | Iso-Reb B | 803 | see above | |
| — | Iso-Stevioside | 803 | see above | |
| — | Iso-Reb A | 965 | n.d. | |
| — | SG-13 | 803 | see above | |
| — | 15α-OH Reb M | 1305 | <0.01 | |

| | |
|---|---|
| Total sum (% m/m) | 95.91 |

TABLE 144-4
Steviol glycosides identified in Stevia extract sample 1-3.

| | | | | % m/m |
|---|---|---|---|---|
| | | [M − | % m/m | other peaks |
| SG-group | Name | H]− | identified | with m/z |
| SG-1G | Steviolmonoside | 479 | | 0.76 |
| | Steviolmonoside A | 479 | | |
| SG-1G1R | Dulcoside A1 | 625 | | 0.49 |
| | Dulcoside A1 | 625 | | |
| SG-1G1X | SG-4 | 611 | <0.01 | |
| SG-2G | Reb-G1 | 641 | 0.27 | |
| | Rubusoside | 641 | 1.98 | |
| | Steviolbioside | 641 | 1.60 | |
| SG-2G1R | Dulcoside A | 787 | 1.31 | |
| | Dulcoside B (JECFA C) | 787 | 0.43 | |
| | SG-3 | 787 | | 1.05 |
| | Stevioside D | 787 | | |
| SG-2G1X | Reb-F1 | 773 | 0.21 | 2.49 |
| | Reb-R1 | 773 | | |
| | Stevioside F (SG-1) | 773 | | |
| | SG-Unk1 | 773 | | |
| SG-3G | Reb B | 803 | 1.90 | |
| | Stevioside | 803 | 17.07 | |
| | Reb-KA | 803 | 0.34 | 1.45 |
| | Reb G | 803 | | |
| | Stevioside B (SG-15) | 803 | | |
| SG-3G1Fru | Reb A3 (SG-8) | 965 | <0.01 | |
| SG-3G1R | Reb C | 949 | 9.86 | |
| | Reb C2/Reb S | 949 | 1.48 | |
| | Stevioside E (SG-9) | 949 | | 2.06 |
| | Stevioside E2 | 949 | | |
| | SG-10 | 949 | | |
| | Reb L1 | 949 | | |
| | SG-2 | 949 | | |
| SG-3G1X | Reb F | 935 | 3.18 | |
| | Reb R | 935 | <0.01 | |
| | SG-Unk2 | 935 | | 1.49 |
| | SG-Unk3 | 935 | | |
| | Reb F3 (SG-11) | 935 | | |
| | Reb F2 (SG-14) | 935 | | |
| SG-4G | Reb A | 965 | 20.99 | |
| | Reb A2 (SG-7) | 965 | <0.01 | |
| | Reb E | 965 | <0.01 | |
| | Reb H1 | 965 | 0.25 | |
| SG-4G1Gal | Reb T1 | 1127 | 0.24 | |
| SG-4G1R | Reb H | 1111 | <0.01 | |
| | Reb J | 1111 | 0.17 | |
| | Reb K | 1111 | 3.98 | |
| | Reb K2 | 1111 | 0.22 | |
| | SG-12 | 1111 | | 1.81 |
| | SG-Unk4 | 1111 | | |
| | SG-Unk5 | 1111 | | |
| SG-4G1X | Reb U2 | 1097 | 0.50 | |
| | Reb W2 | 1097 | 0.20 | |
| | Reb W | 1097 | 0.36 | |
| | Reb T | 1097 | 0.98 | |
| | Reb W3 | 1097 | | 1.34 |
| | Reb U | 1097 | | |
| SG-5G | Reb D | 1127 | 7.83 | |
| | Reb I | 1127 | 0.24 | |
| | Reb L | 1127 | | 2.42 |
| | Reb I3 | 1127 | | |
| | SG-Unk6 | 1127 | | |
| | Reb Q (SG-5) | 1127 | | |
| | Reb I2 (SG-6) | 1127 | | |
| | Reb Q2 | 1127 | | |
| | Reb Q3 | 1127 | | |
| SG-5G1R | Reb N | 1273 | 0.25 | |
| SG-5G1X | Reb V2 | 1259 | 0.27 | |
| | Reb V | 1259 | 0.59 | |
| | Reb Y | 1259 | 0.13 | |
| SG-6G | Reb M | 1289 | 0.27 | |
| SG-6G1R | Reb O | 1435 | 1.08 | |
| | Reb O2 | 1435 | <0.01 | |
| SG-Rel | Related SvGn#1 | 457 | 0.30 | |
| SG-Rel | Related SvGn#2 | 981 | 0.22 | |
| SG-Rel | Related SvGn#3 | 675 | <0.01 | |
| SG-Rel | Related SvGn#4 | 1127 | see above | |
| SG-Rel | Related SvGn#5 | 981 | 0.35 | |
| — | Iso-Steviolbioside | 641 | 0.61 | |
| — | Iso-Reb B | 803 | see above | |
| — | Iso-Stevioside | 803 | see above | |
| — | Iso-Reb A | 965 | n.d. | |
| — | SG-13 | 803 | see above | |
| — | 15α-OH Reb M | 1305 | <0.01 | |

| | |
|---|---|
| Total sum (% m/m) | 95.03 |

TABLE 144-5
Steviol glycosides identified in Stevia extract sample 1-8.

| | | | | % m/m |
|---|---|---|---|---|
| | | [M − | % m/m | other peaks |
| SG-group | Name | H]− | identified | with m/z |
| SG-1G | Steviolmonoside | 479 | | 0.48 |
| | Steviolmonoside A | 479 | | |
| SG-1G1R | Dulcoside A1 | 625 | | 0.51 |
| | Dulcoside A1 | 625 | | |
| SG-1G1X | SG-4 | 611 | <0.01 | |
| SG-2G | Reb-G1 | 641 | 0.17 | |
| | Rubusoside | 641 | 1.86 | |
| | Steviolbioside | 641 | 1.32 | |
| SG-2G1R | Dulcoside A | 787 | 1.88 | |
| | Dulcoside B (JECFA C) | 787 | 0.51 | |
| | SG-3 | 787 | | 0.32 |
| | Stevioside D | 787 | | |
| SG-2G1X | Reb-F1 | 773 | 0.20 | 1.24 |
| | Reb-R1 | 773 | | |
| | Stevioside F (SG-1) | 773 | | |
| | SG-Unk1 | 773 | | |
| SG-3G | Reb B | 803 | 0.78 | |
| | Stevioside | 803 | 28.02 | |
| | Reb-KA | 803 | 0.12 | 0.78 |
| | Reb G | 803 | | |
| | Stevioside B (SG-15) | 803 | | |
| SG-3G1Fru | Reb A3 (SG-8) | 965 | <0.01 | |
| SG-3G1R | Reb C | 949 | 7.07 | |
| | Reb C2/Reb S | 949 | 1.28 | |
| | Stevioside E (SG-9) | 949 | | 2.04 |
| | Stevioside E2 | 949 | | |
| | SG-10 | 949 | | |
| | Reb L1 | 949 | | |
| | SG-2 | 949 | | |
| SG-3G1X | Reb F | 935 | 3.11 | |
| | Reb R | 935 | 0.43 | |
| | SG-Unk2 | 935 | | 1.28 |
| | SG-Unk3 | 935 | | |
| | Reb F3 (SG-11) | 935 | | |
| | Reb F2 (SG-14) | 935 | | |
| SG-4G | Reb A | 965 | 26.53 | |
| | Reb A2 (SG-7) | 965 | <0.01 | |
| | Reb E | 965 | <0.01 | |
| | Reb H1 | 965 | <0.01 | |
| SG-4G1Gal | Reb T1 | 1127 | <0.01 | |
| SG-4G1R | Reb H | 1111 | 0.25 | |
| | Reb J | 1111 | 0.18 | |
| | Reb K | 1111 | 2.25 | |
| | Reb K2 | 1111 | 0.33 | |
| | SG-12 | 1111 | | 1.59 |
| | SG-Unk4 | 1111 | | |
| | SG-Unk5 | 1111 | | |
| SG-4G1X | Reb U2 | 1097 | 0.24 | |
| | Reb W2 | 1097 | 0.12 | |
| | Reb W | 1097 | <0.01 | |
| | Reb T | 1097 | 0.59 | |
| | Reb W3 | 1097 | | 1.64 |
| | Reb U | 1097 | | |
| SG-5G | Reb D | 1127 | 4.28 | |
| | Reb I | 1127 | 0.12 | |
| | Reb L | 1127 | | 1.48 |
| | Reb I3 | 1127 | | |
| | SG-Unk6 | 1127 | | |
| | Reb Q (SG-5) | 1127 | | |
| | Reb I2 (SG-6) | 1127 | | |
| | Reb Q2 | 1127 | | |
| | Reb Q3 | 1127 | | |
| SG-5G1R | Reb N | 1273 | 0.22 | |
| SG-5G1X | Reb V2 | 1259 | 0.19 | |
| | Reb V | 1259 | 0.40 | |
| | Reb Y | 1259 | 0.12 | |
| SG-6G | Reb M | 1289 | 0.16 | |
| SG-6G1R | Reb O | 1435 | 1.09 | |
| | Reb O2 | 1435 | <0.01 | |
| SG-Rel | Related SvGn#1 | 457 | 0.19 | |
| SG-Rel | Related SvGn#2 | 981 | 0.23 | |
| SG-Rel | Related SvGn#3 | 675 | 0.16 | |
| SG-Rel | Related SvGn#4 | 1127 | see above | |
| SG-Rel | Related SvGn#5 | 981 | 0.22 | |
| — | Iso-Steviolbioside | 641 | 0.38 | |
| — | Iso-Reb B | 803 | see above | |
| — | Iso-Stevioside | 803 | see above | |
| — | Iso-Reb A | 965 | n.d. | |
| — | SG-13 | 803 | see above | |
| — | 15α-OH Reb M | 1305 | <0.01 | |

| | |
|---|---|
| Total sum (% m/m) | 96.36 |

TABLE 144-6
Steviol glycosides identified in Stevia extract sample 2-2

| | | | | % m/m |
|---|---|---|---|---|
| | | [M − | % m/m | other peaks |
| SG-group | Name | H]− | identified | with m/z |
| SG-1G | steviolmonoside | 479 | | 0.49 |
| | steviolmonoside A | 479 | | |
| SG-1G1R | Dulcoside A1 | 625 | | 0.43 |
| | Dulcoside A1 | 625 | | |
| SG-1G1X | SG-4 | 611 | <0.01 | |
| SG-2G | Reb-Gl | 641 | 0.16 | |
| | rubusoside | 641 | 3.75 | |
| | steviolbioside | 641 | 2.66 | |
| SG-2G1R | dulcoside A | 787 | 2.61 | |
| | dulcoside B (JECFA C) | 787 | 0.63 | |
| | SG-3 | 787 | | 0.33 |
| | Stevioside D | 787 | | |
| SG-2G1X | Reb-F1 | 773 | 0.17 | 1.08 |
| | Reb-R1 | 773 | | |
| | Stevioside F (SG-1) | 773 | | |
| | SG-Unkl | 773 | | |
| SG-3G | Reb B | 803 | 2.05 | |
| | Stevioside | 803 | 30.43 | |
| | Reb-KA | 803 | 0.37 | 0.67 |
| | Reb G | 803 | | |
| | SteviosideB (SG-15) | 803 | | |
| SG-3G1Fru | Reb A3 (SG-8) | 965 | <0.01 | |
| SG-3G1R | Reb C | 949 | 7.29 | |
| | Reb C2/Reb S | 949 | 0.43 | |
| | Stevioside E (SG-9) | 949 | | 1.13 |
| | Stevioside E2 | 949 | | |
| | SG-10 | 949 | | |
| | Reb L1 | 949 | | |
| | SG-2 | 949 | | |
| SG-3G1X | Reb F | 935 | 4.40 | |
| | Reb R | 935 | 0.44 | |
| | SG-Unk2 | 935 | | 0.95 |
| | SG-Unk3 | 935 | | |
| | Reb F3 (SG-11) | 935 | | |
| | Reb F2 (SG-14) | 935 | | |
| SG-4G | Reb A | 965 | 25.46 | |
| | Reb A2 (SG-7) | 965 | <0.01 | |
| | Reb E | 965 | <0.01 | |
| | Reb H1 | 965 | 0.12 | |
| SG-4G1Gal | Reb T1 | 1127 | <0.01 | |
| SG-4G1R | Reb H | 1111 | 0.25 | |
| | Reb J | 1111 | <0.01 | |
| | Reb K | 1111 | 1.38 | |
| | Reb K2 | 1111 | 0.20 | |
| | SG-12 | 1111 | | 1.24 |
| | SG-Unk4 | 1111 | | |
| | SG-Unk5 | 1111 | | |
| SG-4G1X | Reb U2 | 1097 | 0.27 | |
| | Reb W2 | 1097 | 0.15 | |
| | Reb W | 1097 | <0.01 | |
| | Reb T | 1097 | <0.01 | |
| | Reb W3 | 1097 | | 0.97 |
| | Reb U | 1097 | | |
| SG-5G | Reb D | 1127 | 2.31 | |
| | Reb I | 1127 | 0.24 | |
| | Reb L | 1127 | | 1.03 |
| | Reb I3 | 1127 | | |
| | SG-Unk6 | 1127 | | |
| | Reb Q (SG-5) | 1127 | | |
| | Reb I2 (SG-6) | 1127 | | |
| | Reb Q2 | 1127 | | |
| | Reb Q3 | 1127 | | |
| SG-5G1R | Reb N | 1273 | <0.01 | |
| SG-5G1X | Reb V2 | 1259 | 0.48 | |
| | Reb V | 1259 | <0.01 | |
| | Reb Y | 1259 | 0.13 | |
| SG-6G | Reb M | 1289 | 0.14 | |
| SG-6G1R | Reb O | 1435 | 0.52 | |
| | Reb O2 | 1435 | <0.01 | |
| SG-Rel | Related SvGn#1 | 457 | 0.12 | |
| SG-Rel | Related SvGn#2 | 981 | 0.13 | |
| SG-Rel | Related SvGn#3 | 675 | 0.25 | |
| SG-Rel | Related SvGn#4 | 1127 | see above | |
| SG-Rel | Related SvGn#5 | 981 | 0.11 | |
| — | Iso-Steviolbioside | 641 | 0.16 | |
| — | Iso-Reb B | 803 | see above | |
| — | Iso-Stevioside | 803 | see above | |
| — | Iso-Reb A | 965 | n.d. | |
| — | SG-13 | 803 | see above | |
| — | 15α-OH Reb M | 1305 | <0.01 | |

| | |
|---|---|
| Total sum (% m/m) | 96.12 |

TABLE 144-7
Steviol glycoside composition of Stevia extract sample 1.

| Name | m/z [M − H]⁻ | mg/10 ml | % m/m |
|---|---|---|---|
| Related steviol glycoside #1 | 517 or 427 | 0.27 | 0.17 |
| Related steviol glycoside #2 | 981 | 0.14 | 0.09 |
| Related steviol glycoside #3 | 427 or 735 | 1.42 | 0.87 |
| Related steviol glycoside #4 | 675 or 1127 | <0.01 | <0.01 |
| Related steviol glycoside #5 | 981 | 0.30 | 0.18 |
| Reb-V | 1259 | 0.09 | 0.06 |
| Reb-T | 1127 | 0.29 | 0.18 |
| Reb-E | 965 | 0.52 | 0.32 |
| Reb-O | 1435 | 1.85 | 1.13 |
| Reb-D | 1127 | 1.17 | 0.71 |
| Reb-K | 1111 | 0.14 | 0.08 |
| Reb-N | 1273 | 0.41 | 0.25 |
| Reb-M | 1289 | 0.06 | 0.04 |
| Reb-S | 949 | 0.02 | 0.01 |
| Reb-J | 1111 | 0.02 | 0.01 |
| Reb-W | 1097 | 0.06 | 0.04 |
| Reb-U2 | 1097 | 0.07 | 0.05 |
| Reb-W2/3 | 1097 | 0.14 | 0.08 |
| Reb-O2 | 965 | 0.02 | 0.01 |
| Reb-Y | 1259 | 0.22 | 0.13 |
| Reb-I | 1127 | 0.06 | 0.04 |
| Reb-V2 | 1259 | 0.35 | 0.22 |
| Reb-K2 | 1111 | 0.11 | 0.07 |
| Reb-H | 1111 | 0.34 | 0.21 |
| Reb-A | 965 | 81.06 | 49.61 |
| Stevioside | 803 | 40.79 | 24.96 |
| Reb-F | 935 | 3.57 | 2.18 |
| Reb-C | 949 | 15.72 | 9.62 |
| Dulcoside-A | 787 | 3.13 | 1.92 |
| Rubusoside | 641 | 1.99 | 1.22 |
| Reb-B | 803 | 1.26 | 0.77 |
| Dulcoside B | 787 | 0.65 | 0.40 |
| Steviolbioside | 641 | 1.38 | 0.84 |
| Reb-R | 935 | 1.49 | 0.91 |
| Reb-G | 803 | 0.46 | 0.28 |
| Stevioside-B | 787 | <0.01 | <0.01 |
| Reb-G1 | 641 | <0.01 | <0.01 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 159.57 | 97.65 |

TABLE 144-8
Steviol glycoside composition of Stevia extract sample 2.

| Name | m/z [M − H]⁻ | mg/10 ml | % m/m |
|---|---|---|---|
| Related steviol glycoside #1 | 517 or 427 | <0.01 | <0.01 |
| Related steviol glycoside #2 | 981 | 1.92 | 1.12 |
| Related steviol glycoside #3 | 427 or 735 | <0.01 | <0.01 |
| Related steviol glycoside #4 | 675 or 1127 | <0.01 | <0.01 |
| Related steviol glycoside #5 | 981 | 1.21 | 0.70 |
| Reb-V | 1259 | 0.45 | 0.26 |
| Reb-T | 1127 | 1.20 | 0.70 |
| Reb-E | 965 | 0.56 | 0.33 |
| Reb-O2 | 1435 | 1.23 | 0.71 |
| Reb-D | 1127 | 2.18 | 1.27 |
| Reb-K | 1111 | 0.05 | 0.03 |
| Reb-N | 1273 | 0.11 | 0.06 |
| Reb-M | 1289 | 0.11 | 0.06 |
| Reb-S | 949 | 0.52 | 0.30 |
| Reb-J | 1111 | 0.04 | 0.02 |
| Reb-W | 1097 | <0.01 | <0.01 |
| Reb-U2 | 1097 | 0.09 | 0.05 |
| Reb-W2/3 | 1097 | 0.10 | 0.06 |
| Reb-O2 | 965 | <0.01 | <0.01 |
| Reb-Y | 1259 | 1.02 | 0.59 |
| Reb-I | 1127 | 0.21 | 0.12 |
| Reb-V2 | 1259 | 0.08 | 0.05 |
| Reb-K2 | 1111 | 0.06 | 0.03 |
| Reb-H | 1111 | 0.10 | 0.06 |
| Reb-A | 965 | 73.88 | 42.93 |
| Stevioside | 803 | 51.67 | 30.03 |
| Reb-F | 935 | 3.94 | 2.29 |
| Reb-C | 949 | 14.62 | 8.49 |
| Dulcoside-A | 787 | 2.89 | 1.68 |
| Rubusoside | 641 | 3.21 | 1.87 |
| Reb-B | 803 | 0.02 | 0.01 |
| Dulcoside B | 787 | 0.44 | 0.26 |
| Steviolbioside | 641 | 0.38 | 0.22 |
| Reb-R | 935 | 1.66 | 0.97 |
| Reb-G | 803 | 0.19 | 0.11 |
| Stevioside-B | 787 | 2.06 | 1.20 |
| Reb-G1 | 641 | 2.67 | 1.55 |
| Reb-R1 | 773 | <0.01 | <0.01 |
| Reb-F1 | 773 | <0.01 | <0.01 |
| Iso-Steviolbioside | 641 | <0.01 | <0.01 |
| | Sum | 168.87 | 98.12 |

TABLE144-9
Steviol glycoside composition of Stevia extract sample 1-4.

| | | | | % m/m |
|---|---|---|---|---|
| | | [M − | % m/m | other peaks |
| SG-group | Name | H]− | identified | with m/z |
| SG-1G | steviolmonoside | 479 | | 0.68 |
| | steviolmonoside A | 479 | | |
| SG-1G1R | Dulcoside A1 | 625 | | 0.41 |
| | Dulcoside A1 | 625 | | |
| SG-1G1X | SG-4 | 611 | <0.01 | |
| SG-2G | Reb-Gl | 641 | 0.31 | |
| | rubusoside | 641 | 2.08 | |
| | steviolbioside | 641 | 1.54 | |
| SG-2G1R | dulcoside A | 787 | 1.59 | |
| | dulcoside B (JECFA C) | 787 | 0.51 | |
| | SG-3 | 787 | | 0.57 |
| | Stevioside D | 787 | | |
| SG-2G1X | Reb-F1 | 773 | | 2.25 |
| | Reb-R1 | 773 | | |
| | Stevioside F (SG-1) | 773 | | |
| | SG-Unk1 | 773 | | |
| SG-3G | Reb B | 803 | 1.36 | |
| | Stevioside | 803 | 18.79 | |
| | Reb-KA | 803 | <0.01 | 2.34 |
| | Reb G | 803 | | |
| | Stevioside B (SG-15) | 803 | | |
| SG-3G1Fru | Reb A3 (SG-8) | 965 | <0.01 | |
| SG-3G1R | RebC | 949 | 9.09 | |
| | Reb C2/Reb S | 949 | 1.22 | |
| | Stevioside E (SG-9) | 949 | | 1.93 |
| | Stevioside E2 | 949 | | |
| | SG-10 | 949 | | |
| | Reb L1 | 949 | | |
| | SG-2 | 949 | | |
| SG-3G1X | Reb F | 935 | 3.07 | |
| | Reb R | 935 | 0.38 | |
| | SG-Unk2 | 935 | | 1.76 |
| | SG-Unk3 | 935 | | |
| | Reb F3 (SG-11) | 935 | | |
| | Reb F2 (SG-14) | 935 | | |
| SG-4G | Reb A | 965 | 21.76 | |
| | Reb A2 (SG-7) | 965 | <0.01 | |
| | Reb E | 965 | 0.20 | |
| | Reb H1 | 965 | 0.14 | |
| SG-4G1Gal | Reb T1 | 1127 | 0.62 | |
| SG-4G1R | Reb H | 1111 | 0.47 | |
| | Reb J | 1111 | 0.18 | |
| | Reb K | 1111 | 3.29 | |
| | Reb K2 | 1111 | 0.26 | |
| | SG-12 | 1111 | | |
| | SG-Unk4 | 1111 | | 1.97 |
| | SG-Unk5 | 1111 | | |
| SG-4G1X | Reb U2 | 1097 | 0.49 | |
| | Reb W2 | 1097 | 0.28 | |
| | Reb W | 1097 | 0.37 | |
| | Reb T | 1097 | 0.77 | |
| | Reb W3 | 1097 | | 1.07 |
| | Reb U | 1097 | | |
| SG-5G | Reb D | 1127 | 6.17 | |
| | Reb I | 1127 | 0.56 | |
| | Reb L | 1127 | | |
| | Reb I3 | 1127 | | |
| | SG-Unk6 | 1127 | | |
| | Reb Q (SG-5) | 1127 | | 2.16 |
| | Reb I2 (SG-6) | 1127 | | |
| | Reb Q2 | 1127 | | |
| | Reb Q3 | 1127 | | |
| SG-5G1R | Reb N | 1273 | 0.43 | |
| SG-5G1X | Reb V2 | 1259 | 0.44 | |
| | Reb V | 1259 | 0.47 | |
| | Reb Y | 1259 | 0.31 | |
| SG-6G | Reb M | 1289 | 0.29 | |
| SG-6G1R | Reb O | 1435 | 0.92 | |
| | Reb O2 | 1435 | <0.01 | |
| SG-Rel | Related SvGn#1 | 457 | 0.31 | |
| SG-Rel | Related SvGn#2 | 981 | 0.19 | |
| SG-Rel | Related SvGn#3 | 675 | 0.11 | |
| SG-Rel | Related SvGn#4 | 1127 | see above | |
| SG-Rel | Related SvGn#5 | 981 | 0.27 | |
| — | Iso-Steviolbioside | 641 | 0.68 | |
| — | Iso-Reb B | 803 | see above | |
| — | Iso-Stevioside | 803 | see above | |
| — | Iso-Reb A | 965 | n.d. | |
| — | SG-13 | 803 | see above | |
| — | 15α-OH Reb M | 1305 | <0.01 | |

| | |
|---|---|
| Total sum (% m/m) | 95.04 |

### Example 145. Preparation of RU90-MRPs and GRU90-MRPs Prepared from Xylose and Either Arginine, Valine or Tyrosine and HPLC Analysis of Amadori Products Therefrom

Raw materials: L-Arginine, ≥98%, Batch #MKBC7640, Sigma Aldrich; DL-Tyrosine, Lot #49H0632, Sigma Aldrich; D-Valine, 98%, Lot 20H0295, Sigma Aldrich; D-(+)-Xylose, ≥99.5%, Lot 024K00312, Sigma Aldrich; RU90, Lot #EPC-238-34-03, EPC Lab; and

GRU90, Lot #EPC-303-89-03, EPC Lab.

Reaction conditions: A series of experiments were performed in sealed 10 ml Pyrex vials. The following conditions were employed: (1) reaction solvent: 0.1 M phosphate buffer; (2) heating temperature: 100° C. in a drying oven; (3) heating time: 1 hr.

The reaction partners (5 mg of amino acid, 10 mg of reducing sugar, 50 mg of RU90 or GRU90) were dissolved/suspended in 225 μl of reaction solvent. The prepared samples were transferred into a glass beaker filled with sand pre-heated for at least 30 minutes at the reaction temperature in a drying oven. After the designated reaction time, the vials were transferred into ice water. After cooling to room temperature, sensory analyses were performed.

The following combinations were tested and analyzed by HPLC:

(1) RU90+xylose and either arginine, valine or tyrosine;

(2) GRU90+xylose and either arginine, valine or tyrosine

Analytical system: The HPLC system consisted of an Agilent 1100 system (autosampler, ternary gradient pump, column thermostat, VWD-UV/VIS detector, DAD-UV/VIS detector) connected in-line to an Agilent mass spectrometer (ESI-MS quadrupole G1956A VL). For HPLC analysis, the reacted samples were injected after filtration (2 μm syringe filters). The samples were separated on a Phenomenex Synergi Hydro-RP 80 A, 150×3 mm, 4μ, serial number: 344012-1, followed by a Knauer Nucleosil 100-7 C18, 250×4.6 mm, batch number 21408033 at 45° C. by gradient elution. The injection volume was set to 20 μl. The detectors were set to 205, to 210 and to 254 nm (DAD with spectra collection between 200-600 nm) and to ESI negative mode TIC m/z 120-1100, Fragmentor 150, Gain 2 (MS, 300° C., nitrogen 12 l/min, nebulizer setting 50 psig. Capillary voltage 4500 V).

Mobile Phase A consisted of a 10 mM ammonia acetate (native pH), 0.1% acetic acid, 0.05% triethylamine and 0.001% dichloromethane in deionized water. Mobile Phase B consisted of 10 mM ammonia acetate (native pH), 0.1% acetic acid, 0.05% triethylamine and 0.001% dichloromethane in 90% acetonitrile. Injection volume was set to 10 flow rate 0.8 ml/min.

The gradient for elution is set forth in Table 145-1:

TABLE 145-1

| Time [min] | % A | % B |
|---|---|---|
| 0.00 | 77.8 | 22.2 |
| 20.00 | 55.6 | 44.4 |
| 34.00 | 55.6 | 44.4 |
| 34.10 | 77.8 | 22.2 |
| 39.10 | 77.8 | 22.2 |

Stop time: 40 min

The detectors were set to 205, to 210 and to 254 nm (DAD with spectra collection between 200-600 nm) and to ESI negative mode TIC m/z 120-1100, Fragmentor 150, Gain 2 (MS, 300° C., nitrogen 12 l/min, nebulizer setting 50 psig. Capillary voltage 4500 V).

The expected Amadori products are shown in Table 145-2.

| | Sugar/ | Mass | | |
|---|---|---|---|---|
| Amino Acid | Glycoside | Amadori | m/z [m − H⁺]⁻ | m/z [m + Cl]⁻ |
| Arginine | Xylose | 306.3 | 305.3 | 341.3 |
| Arginine | Rubusoside | 798.2 | 797.2 | 833.2 |
| Arginine | Rub + 1* | 960.2 | 959.2 | 995.2 |
| Valine | Xylose | 249.2 | 248.2 | 284.2 |
| Valine | Rubusoside | 741.1 | 740.1 | 776.1 |
| Valine | Rub + 1 | 903.1 | 902.1 | 938.1 |
| Tyrosine | Xylose | 313.3 | 312.3 | 348.3 |
| Tyrosine | Rubusoside | 805.2 | 804.2 | 840.2 |
| Tyrosine | Rub + 1 | 967.2 | 966.2 | 1002.2 |

*indicates Rubusoside plus one glucose

Compounds observed by HPLC are shown in Table 145-3.

TABLE 145-3

| | | |
|---|---|---|
| Reactants | Amadori products of | Observed |

| | | | |
|---|---|---|---|
| Arg-Xyl RU90 | Arginine | Xylose | yes |
| | Arginine | Rubusoside | yes |
| Arg-Xyl GRU90 | Arginine | Xylose | yes |
| | Arginine | Rub + 1 | yes |
| Val-Xyl RU90 | Valine | Xylose | yes |
| | Valine | Rubusoside | yes |
| Val-Xyl GRU90 | Valine | Xylose | yes |
| | Valine | Rubusoside | yes |
| | Valine | Rub + 1 | yes |
| Tyr-Xyl RU90 | Tyrosine | Xylose | yes |
| Tyr-Xyl GRU90 | Tyrosine | Xylose | yes |

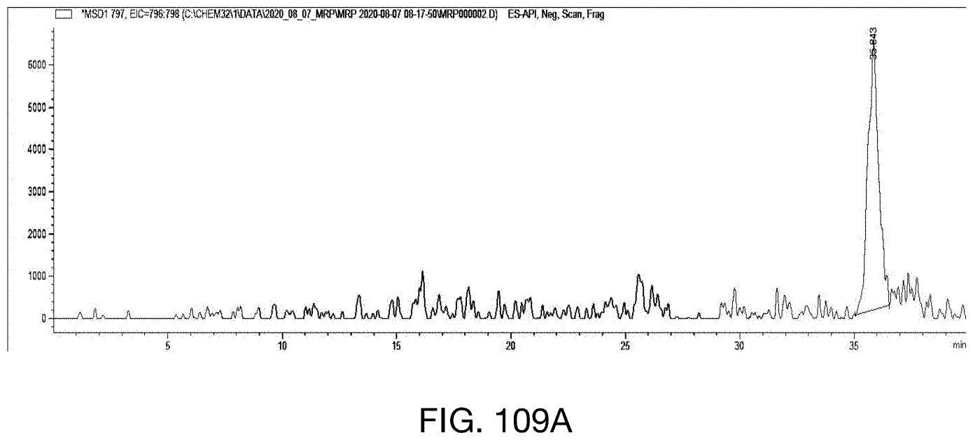

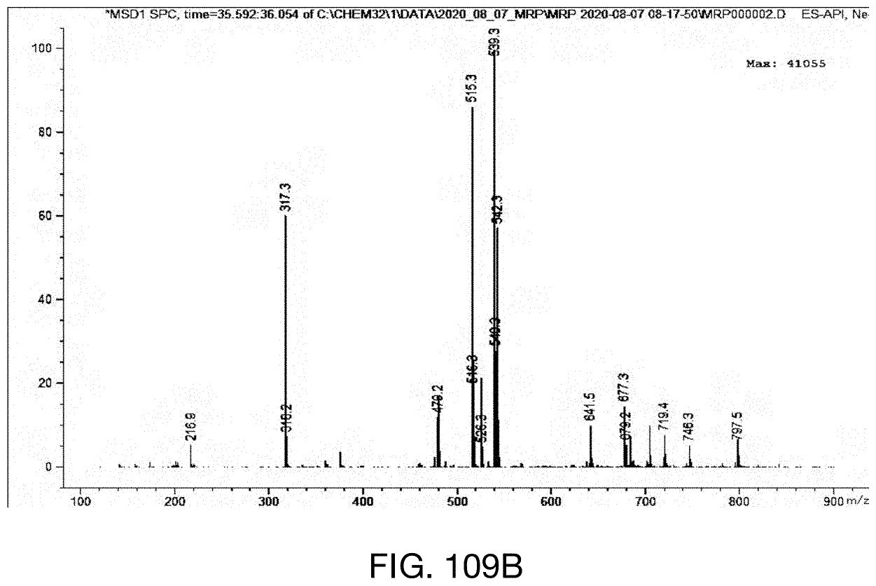

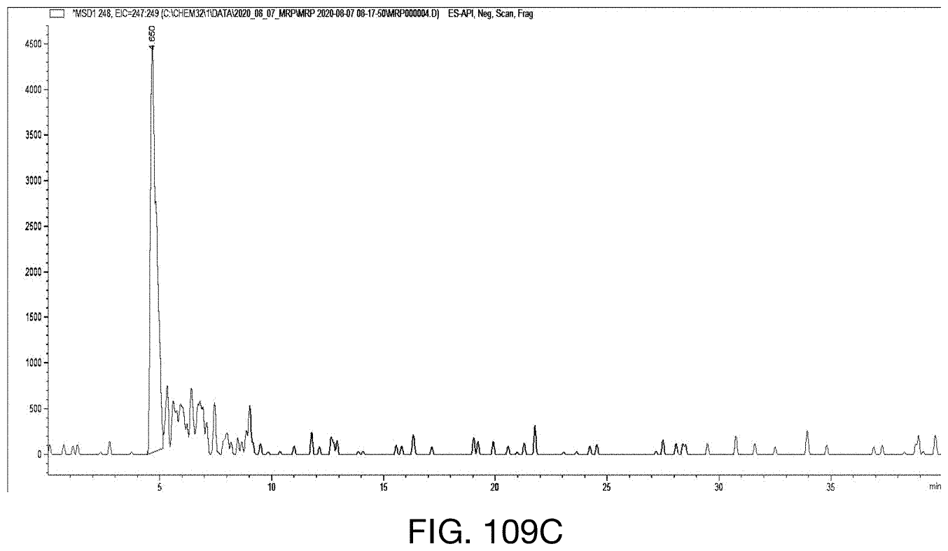

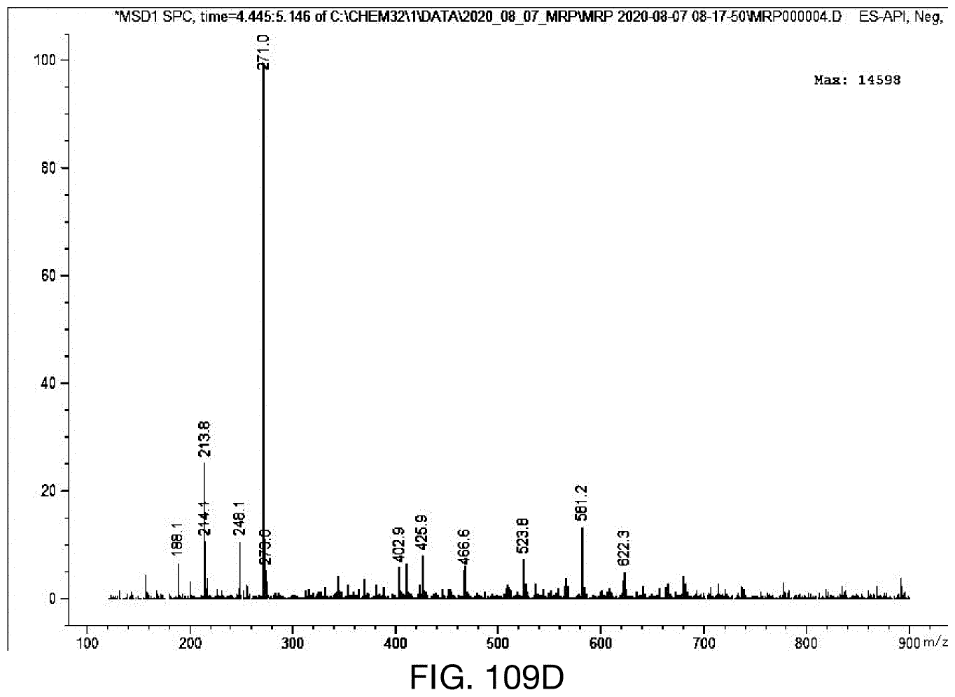

FIG. 109A shows an exemplary chromatogram with a SIM-Trace of m/z=797 indicative of an Amadori product corresponding to Arginine+Rubusoside.

FIG. 109B shows a corresponding mass spectrum with an m/z=797 and fragments indicative of an Amadori product corresponding to Arginine+Rubusoside.

FIG. 109C shows an exemplary chromatogram with a SIM-Trace of m/z=248 indicative of an Amadori product corresponding to Valine+Xylose.

FIG. 109D shows a corresponding mass spectrum with an m/z=248 and fragments indicative of an Amadori product corresponding to Arginine+Rubusoside.

### Example 146. GSG-MRP-CA Improves the Flavor Profile of Beverages and Essential Oils

Raw materials: Lemon Flavor, AKRAS Prod. No. 01100097 (0.05% m/v water); Coca Cola Zero, 12.11.2020 L13E18:31 WP, Coca Cola HBC Austria GmbH;

Pro 20 vanilla yogurt high protein, Nom, 24.05. 23060113:594; GSG-MRP-CA Lot. No. (200 ppm in-use concentration).

Time intensity profiles: Five tasters were asked to rate the intensity of the flavor perception every 2 seconds on a 10 point scale (0-none, 10-maximum). The time points for rating were indicated by an acoustic signal. Before reaching the effective rating, the tasters were allowed to discuss the intensity of 5 randomly selected samples with the same flavor (i.e. different cola beverages, including dilution with water where applicable) to align the taster's intensity rating.

Flavor recognition times: In a second aspect, flavor recognition times were determined by blindfolding the five tasters. In this case, the tasters were asked to start a stop-watch when ingesting the sample and to stop the time recording once a taster recognizes the flavor. The answers were recorded. After each individual experiment, the identified flavors were assessed. If at least 4 tasters identified the flavor correctly, the experiment was rated as valid; otherwise the test was repeated.

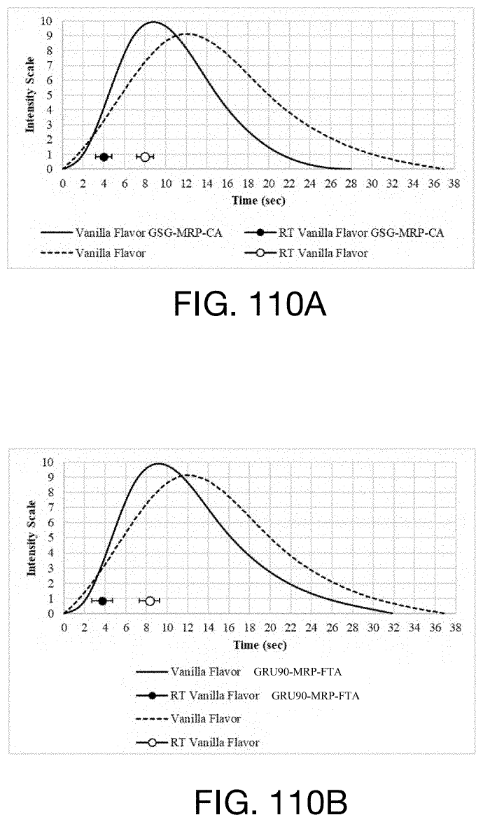

FIG. 110A shows time/intensity (TI) curves for vanilla flavored yogurt (4.5% sugar) with (solid line) or without (broken line) GSG-MRP-CA (200 ppm). The flavor recognition times (RT) [mean±s.d.] were determined for both types of samples as indicated.

FIG. 110B shows time/intensity (TI) curves for a lemon flavored water beverage with (solid line) or without (broken line) GSG-MRP-CA (200 ppm). The flavor recognition times (RT) [mean±s.d.] were determined for both types of samples as indicated.

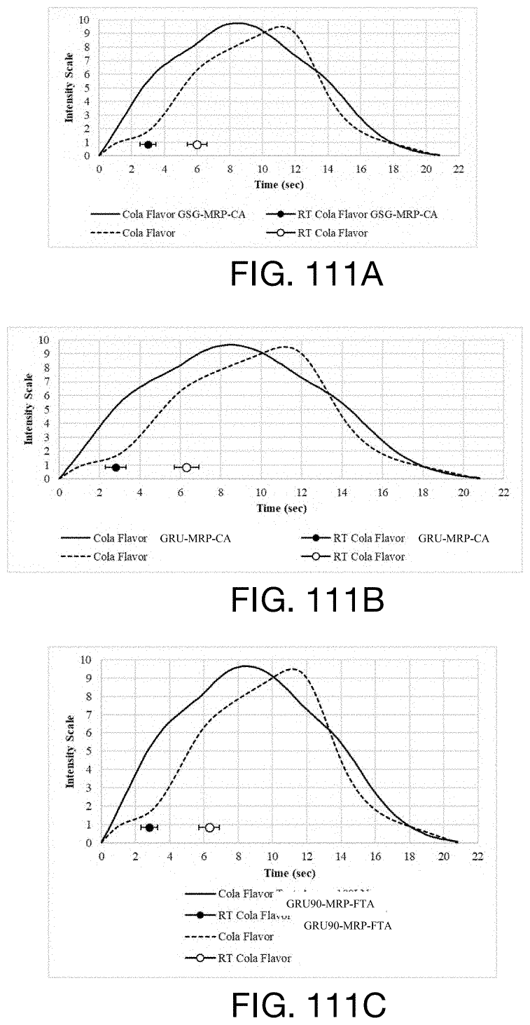

FIG. 111A shows time/intensity (TI) curves for vanilla flavored yogurt (4.5% sugar) with (solid line) or without (broken line) GRU90-MRP-CA (200 ppm). The flavor recognition times (RT) [mean±s.d.] were determined for both types of samples as indicated.

FIG. 111B shows time/intensity (TI) curves for in a sugar-free (containing sucralose) cola flavored beverage with (solid line) or without (broken line) GRU90-MRP-CA (200 ppm). The flavor recognition times (RT) [mean±s.d.] were determined for both types of samples as indicated.

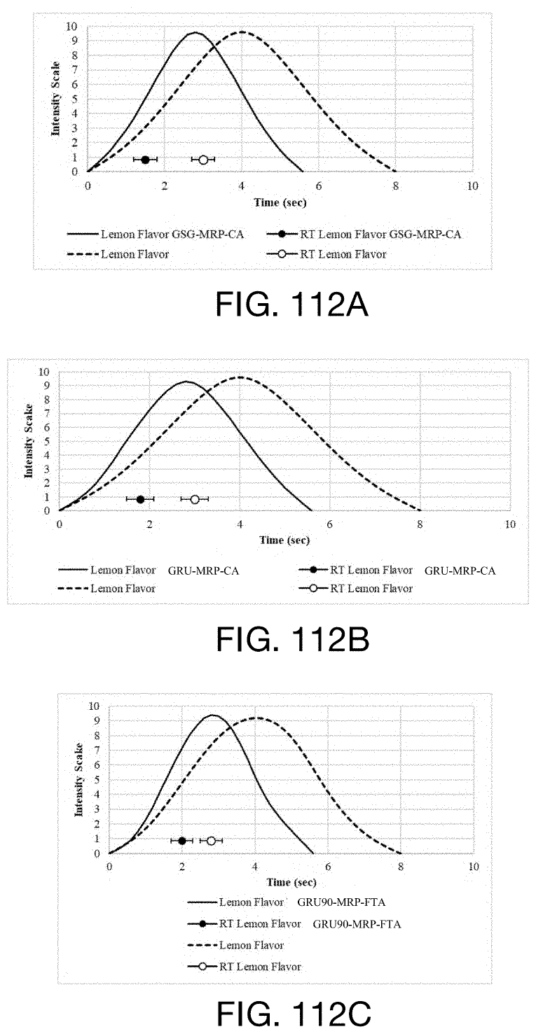

FIG. 112A shows time/intensity (TI) curves for vanilla flavored yogurt (4.5% sugar) with (solid line) or without (broken line) GRU90-MRP-FTA (39-10 in Ex. 39) (200 ppm). The flavor recognition times (RT) [mean±s.d.] were determined for both types of samples as indicated.

FIG. 112B shows time/intensity (TI) curves for in a sugar-free (containing sucralose) cola flavored beverage with (solid line) or without (broken line) GRU90-MRP-FTA (39-10 in Ex. 39) (200 ppm). The flavor recognition times (RT) [mean±s.d.] were determined for both types of samples as indicated.

Conclusion: The GSG-MRP-CA product enhanced the vanilla flavor, cola flavor and lemon flavor in the selected beverages by inducing a shorter flavor recognition time. The results showed that GSG-MRP-CA can enhance the flavor of beverages. These effects can be extended to other beverages with other flavors.

### Example 147. GRU90-MRP-FTA Improves the Taste Profile of RA97

Process: GRU90-MRP-FTA (Ex. 125, 125-01) and RA97 (available from Sweet Green Fields, Lot #3050123; content is 97.15%. The glycosides were weighed, uniformly mixed and dissolved in 100 ml pure water in accordance with Table 153-1.

TABLE 147-1
Preparation of mixtures of GRU90-MRP-FTA and RA97.

| | | RA97 | | |
|---|---|---|---|---|
| | RA97 to GRU90- | weight | GRU90-MRP- | Volume of pure |
| No. | MRP-FTA ratio | (mg) | FTA weight (mg) | water (mL) |
| 147-00 | 10/0 | 20 | 0 | 100 |
| 147-01 | 10/1 | 20 | 2 | 100 |
| 147-02 | 10/3 | 20 | 6 | 100 |
| 147-03 | 10/5 | 20 | 10 | 100 |
| 147-04 | 10/7 | 20 | 14 | 100 |
| 147-05 | 10/9 | 20 | 18 | 100 |
| 147-06 | 10/10 | 20 | 20 | 100 |
| 147-07 | 10/40 | 20 | 80 | 100 |
| 147-08 | 10/70 | 20 | 140 | 100 |
| 147-09 | 10/100 | 20 | 200 | 100 |

Experiment: Several mixtures of RA97 and GRU90-MRP-FTA were prepared. Each sample was evaluated according to the sensory evaluation method in Ex. 5. Average scores from the test panel for each sensory criterion were recorded as the evaluation test results. The resulting taste profiles of the mixtures are shown in Table 147-2 and FIGS. 123A and 123B. It is noted that concentration of RA97 was the same (200 ppm) in each sample solution.

TABLE 147-2
Sensory evaluation results.

| | Mouth | Sweet | | Overall |
|---|---|---|---|---|
| No. | feel | lingering | Bitterness | likability |
| 147-00 | 1 | 3 | 3 | 2 |
| 147-01 | 1.5 | 2.5 | 2.8 | 2.4 |
| 147-02 | 2 | 2 | 2.3 | 3 |
| 147-03 | 3 | 1.5 | 2 | 3.75 |
| 147-04 | 4 | 1 | 1 | 4.5 |
| 147-05 | 4 | 1.5 | 1 | 4.3 |
| 147-06 | 4 | 2 | 1.5 | 4 |
| 147-07 | 4.5 | 2.5 | 2 | 3.5 |
| 147-08 | 4.5 | 2.5 | 2.5 | 3 |
| 147-09 | 5 | 2.5 | 2.7 | 3 |

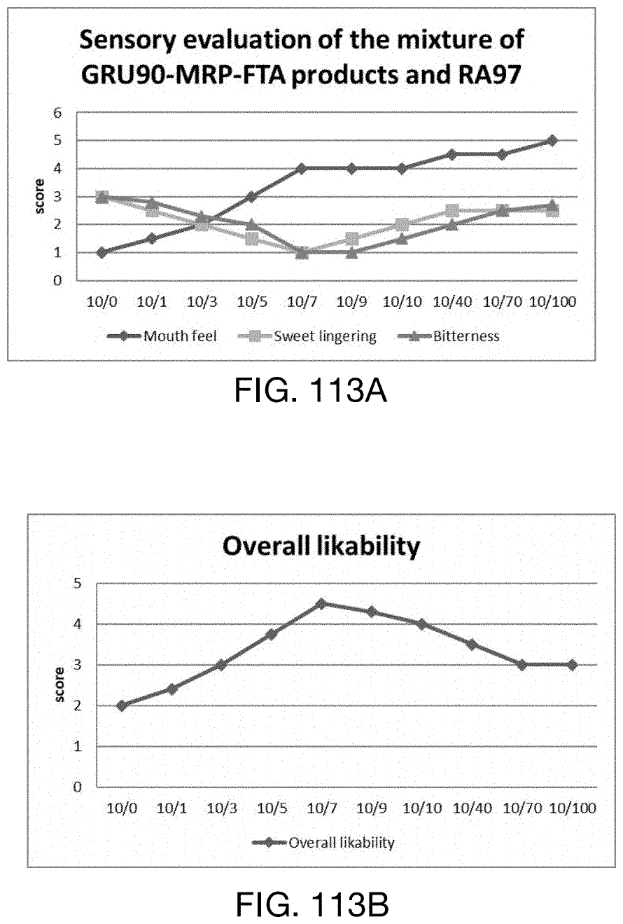

The relationship between the sensory evaluation results to the ratio of RA97 to GRU90-MRP-FTA is shown in FIG. 113A. The relationship between the overall likability results to the ratio of RA97 to GRU90-MRP-FTA is shown in FIG. 113B.

### Example 148. GRU90-MRP-FTA Improves the Taste Profile of a Carbonated Sugar-Free Peach-Flavored Beverage

Two samples of a carbonated sugar-free peach-flavored beverage with GRU90-MRP-FTA (Ex. 125, 125-01) or without GRU90-MRP-FTA (i.e. base) were prepared according to the compositions shown in Table 148-1. The sweetness of the beverage was provided by natural sweeteners, including erythritol, steviol glycosides and glycosylated steviol glycosides. Fruit flavoring (white peach flavor): available from Givaudan China Ltd, Lot #: BJS006; GSG-MRP-CA: available from EPC Lab, Lot #: 20200101.

TABLE 148-1
Beverage compositions.

Concentration (ppm)

| | | Base plus GRU- |
|---|---|---|
| Ingredient | Base | MRP-FTA |
| Erythritol | 38000 | 38000 |
| Steviol glycosides | 280 | 280 |
| Citric acid | 500 | 500 |
| Food flavoring | 3000 | 3000 |
| GSG-MRP-CA | 150 | 150 |
| GRU90-MRP-FTA | 0 | 100 |

Experiment: Each of the two samples were evaluated according to the sensory evaluation method in Ex. 5. Average scores from the test panel for each sensory criterion were recorded as the evaluation test results depicted in Table 148-02.

TABLE 148-02
Sensory evaluation results

| | Overall | | | | Sweet |
|---|---|---|---|---|---|
| Sample | likability | Flavor | Mouthfeel | Bitterness | lingering |
| Base | 3 | 3 | 3 | 2.5 | 3.5 |
| 125-01 | 4.5 | 4.5 | 4.5 | 1.5 | 2 |

Conclusion: GRU90-MRP-FTA (Ex. 125, 125-01) can significantly improve the mouthfeel, enhance the peach flavor and cut the bitterness of the sugar-free peach-flavored beverage. Thus, the overall likability of the peach-flavored beverage sweetened with natural sweeteners, including erythritol, steviol glycosides, etc. was improved. These results show that GRU90-MRP-FTA can improve the taste profile of beverages sweetened with sugar alcohols, steviol glycosides and other natural sweeteners.

### Example 149. Conversion of Rubusoside from Steviol Glycoside (STV95)

Materials: steviol glycosides, available from Sweet Green Fields, Lot #: STV95-YCJ20200618. The content of steviol glycosides is as follows.

TABLE 149-1
Contents of steviol glycosides (m/m %)

| Lot# | RD | RA | STV | RF | RC | Dulc A | RU | RB | STB | TSG(9)* |
|---|---|---|---|---|---|---|---|---|---|---|
| STV95-YCJ20200618 | 0.02 | 2.13 | 95.7 | 0.01 | 0.17 | 0.07 | 0.33 | 0.01 | 0.36 | 98.82 |

Note: TSG refers to the content of total Steviol glycosides (TSG(9)), which includes Rebaudioside A, Rebaudioside B, Rebaudioside C, Rebaudioside D, Rebaudioside F, stevioside, steviolbioside, rubusoside, and dulcoside A.

Process:

A 1-L steviol glycoside (Lot #STV95-YCJ20200618) solution (100 g/L) was mixed with 1.5 g β-galactosidase (0.8 kU/g stevioside), and stirred at 60.0 for 12 h. The reaction mixture was then boiled for 3 min to deactivate the enzyme and the precipitated enzyme was removed by centrifugation. The resulting glycoside solution was then passed through an 800 mL T-28 macroporous resin (Sunrise) column and washed with 1600 mL of water. The column was then washed with 1600 mL ethanol, and the solution was collected and vacuum concentrated. The ethanol was removed and the solution was spray-dried, resulting in a RU product composition (Product No. 149-01) as a powder. Table 149-2 shows the contents of steviol glycosides in the resulting powder obtained following conversion.

TABLE 149-2
Contents of steviol glycosides (m/m %) after conversion

| Product | | | | | | | | | | | |
|---|---|---|---|---|---|---|---|---|---|---|---|
| No. | Sample | RD | RA | STV | RF | RC | Dulc A | RU | RB | STB | TSG (9) |
| 149-01 | RU | / | 1.74 | 0.58 | / | / | / | 90.05 | / | / | 92.37 |

Conclusion: Stevioside can be converted to rubusoside with β-galactosidase. Under certain conditions, the conversion rate can be close to 100%.

### Example 150. Conversion of Rubusoside from Steviol Glycosides (STV85)

Materials: Steviol glycosides, available from Sweet Green Fields, Lot #: STV85-20170802. The steviol glycoside contents are shown in Table 150-1.

TABLE 150-1
Steviol glycoside contents (m/m %)

| Lot# | RD | RA | STV | RC | RB | Others | TSG(9) |
|---|---|---|---|---|---|---|---|
| STV85-20170802 | 0.34 | 10.88 | 85.67 | 0.32 | 0.08 | 1.48 | 98.77 |

Note:
TSG(9) refers to the total steviol glycoside contents pertaining to the following 9 species: Rebaudioside A, Rebaudioside B, Rebaudioside C, Rebaudioside D, Rebaudioside F, stevioside, steviolbioside, rubusoside, and dulcoside A.

Process:

A 1-L steviol glycosides (Lot #STV85-201-70802) solution (100 g/L) was mixed with 1.5 g β-galactosidase (0.8 kU/g stevioside) and stirred at 60° C. for 5 h. The reaction mixture was then boiled for 3 min to deactivate the enzyme and the precipitated enzyme was removed by centrifugation. The resulting glycoside solution was then passed through an 800 mL T-28 macroporous resin (Sunrise) column and washed with 2 column volumes of water (1600 mL water). The column was then washed with 1600 mL ethanol, and the solution was collected and vacuum concentrated. The ethanol was removed and the solution was spray-dried, resulting in a RU product composition (Product No. 150-01) as a powder with steviol glycoside contents as shown in Table 150-2.

TABLE 150-2
Contents of steviol glycosides (m/m %)
following conversion (5 hr enzymatic reaction)
Product No. 150-01

| Steviol glycoside | m/m % |
|---|---|
| 9-OH Suav J | 0.276 |
| Suavioside A | 0.0899 |
| Suavioside B | 1.24 |
| Suavioside E | 0.150 |
| Suavioside F | 0.435 |
| Suavioside H | 3.11 |
| Suavioside K | 2.81 |
| Suavioside L | 0.230 |
| Suavioside O | 0.611 |
| Steviol-MS | 0.0220 |
| Reb-A | 12.3 |
| Rubusoside | 73.8 |
| Total steviol glycosides (TSM(9)) | 95.1 |

The above-described conversion process was repeated, except that the length of the enzymatic reaction was increased to 8 hours (from 5 hours in the preceding experiment). The resulting RU product composition (Product No. 150-02) was obtained as a powder containing steviol glycoside contents as shown in Table 150-3.

TABLE 150-3
Steviol glycoside contents (m/m %) following conversion.
Product No. 150-02

| Steviol glycoside | m/m % |
|---|---|
| 9-OH Suav J | 0.163 |
| Suavioside A | 0.232 |
| Suavioside B | 1.78 |
| Suavioside E | 0.0992 |
| Suavioside F | 0.296 |
| Suavioside H | 0.146 |
| Suavioside K | 1.71 |
| Suavioside L | 0.122 |
| Suavioside O | 0.201 |
| Steviol-MS | 0.0171 |
| Reb-A | 8.98 |
| Rubusoside | 81.5 |
| Total steviol glycosides (TSM(9)) | 95.2 |

Conclusion: Stevioside can be converted to rubusoside in the presence of β-galactosidase. Increasing the time of the enzymatic conversion reaction can increase the conversion of rubusoside from stevioside. Under certain conditions, the conversion rate can be close to 100%. Surprisingly, certain amounts of suaviosides are produced during this conversion process. An embodiment of stevia glycosides composition originated from stevia comprises suaviosides.

### Example 151. Conversion of Rubusoside from Steviol Glycosides (STV60)

Materials: Steviol glycosides (RA20/TSG(9)90), available from Sweet Green Fields, Lot #: 20191122-23. The steviol glycoside contents are shown in Table 151-1.

TABLE 151-1
Steviol glycoside contents (m/m %).

| Lot# | RD | RA | STV | RC | RB | Others | TSG(9) |
|---|---|---|---|---|---|---|---|
| 20191122-23 | 0.83 | 27.82 | 60.22 | 2.42 | 0.51 | 1.38 | 93.18 |

Process: A 1 L steviol glycosides (Lot #20191122-23) solution (100 g/L) and 2.4 g β-galactosidase (0.8 kU/g stevioside) were mixed, stirred at 60° C. for 8 h. The reaction mixture was then boiled for 3 min to deactivate the enzyme and the precipitated enzyme was removed by centrifugation. The resulting glycoside solution was then passed through an 800 mL T-28 macroporous resin (Sunrise) column and washed with 2 column volumes of water (1600 mL water). The column was then washed with 1600 mL ethanol, and the solution was collected, decompressed and concentrated. The ethanol was later removed and the solution was spray-dried, resulting in a RU product composition (Product 151-01) as a powder with steviol glycoside contents as shown in Table 151-2.

### Example 152. Preparation of Glycosylated Rubusoside Derived from Steviol Glycosides Conversion

A glycosylated reaction product composition was prepared by a steviol glycoside conversion process using the rubusoside Product Nos. (149-01, 150-01 and 150-02 from Examples 149 and 150) according to the following method:

(i) 15 g maltodextrin (BAOLINGBAO BIOLOGY Co., Ltd) was dissolved in 45 mL deionized water

(ii) 15 g rubusoside derived from steviol glycosides conversion (149-01, 150-01 and 150-02 Product Nos. from Examples 149 and 150) was added to the dissolved dextrin solution to form a mixture.

(iii) 0.75 mL CGTase enzyme (Amano Enzyme, Inc.) and 15 mL deionized water were added to the mixture and incubated at 69° C. for 20 hours to glycosylate the rubusoside from the steviol glycosides conversion with glucose molecules derived from maltodextrin.

(iv) The reaction mixture of (iii) was heated to 85° C. for 10 min to inactivate the CGTase, which was then removed by filtration.

(v) The resulting solution of glycosylated rubusoside (GRU), residual RU and dextrin were decolored and spray dried, thereby yielding 25 g glycosylated rubusoside derived from steviol glycosides (GRUds) product compositions shown in Table 152-1, each in the form of a white powder. An analysis of the glycosylated products formed is shown in Table 152-2.

TABLE 152-1
GRUds Product Nos and their raw material product numbers.

| GRUds Product No. | Raw material Product No. |
|---|---|
| 152-01 | 150-01 |
| 152-02 | 151-01 |
| 152-03 | 151-02 |

TABLE 152-2
Summary of glycosylated rubusoside derived from steviol glycosides (GRUds) contents.

| | Individual SG | SG-{ }-Added | | 158-01 | 158-02 | 158-03 |
|---|---|---|---|---|---|---|
| SG-group | (unreacted part) | Glucose (reacted part) | [Mr] | % (m/m) | % (m/m) | % (m/m) |
| SG-1G | Steviol-Monos | — | 480 | 1.20 | 1.64 | 1.39 |
| | | SG-1G-1 | 642 | 1.59 | 1.79 | 1.13 |
| SG-2G | Rubusoside | — | 642 | 12.31 | 10.10 | 11.81 |
| | Stev-Bios | — | 642 | 0.99 | 2.09 | 2.16 |
| | | SG-2G-1 | 804 | 17.37 | 17.714 | 18.48 |
| | | SG-2G-2 | 965 | 16.23 | 15.414 | 17.26 |
| | | SG-2G-3 | 1128 | 9.17 | 9.173 | 9.76 |
| | | SG-2G-4 | 1290 | 5.66 | 5.662 | 5.66 |
| | | SG-2G-5 | 1452 | 4.28 | 4.323 | 4.00 |
| SG-3G | Reb-B | — | 804 | 0.25 | 0.51 | 0.41 |
| | Reb-G | — | 804 | 0.37 | 0.26 | 0.11 |
| | Stevioside | — | 804 | <0.05 | 0.13 | <0.05 |
| | Re-KA | — | 804 | <0.05 | <0.05 | <0.05 |
| | Stevioside B | — | 804 | <0.05 | <0.05 | <0.05 |
| SG-4G | Reb-A | — | 966 | 0.44 | 1.76 | 0.75 |
| | Reb-E | — | 966 | 0.61 | 0.73 | 0.72 |
| | Reb-A2 | — | 966 | <0.05 | <0.05 | <0.05 |
| | Reb-H1 | — | 966 | <0.05 | <0.05 | <0.05 |
| | | SG-4G-1 | 1128 | 2.09 | 2.81 | 1.24 |
| SG-5G | Reb-D | — | 1128 | <0.05 | <0.05 | <0.05 |
| | Reb I | — | 1128 | <0.05 | <0.05 | <0.05 |
| | Reb L | — | 1128 | <0.05 | <0.05 | <0.05 |
| | Reb Q | — | 1128 | <0.05 | <0.05 | <0.05 |
| | Reb I2 | — | 1128 | <0.05 | <0.05 | <0.05 |
| SG-6G | Reb-M | — | 1290 | <0.05 | <0.05 | <0.05 |
| SG-2G1R | Dulcoside A | — | 788 | <0.05 | <0.05 | <0.05 |
| | Dulcoside B | — | 788 | <0.05 | <0.05 | <0.05 |
| SG-3G1R | Reb-C | — | 950 | 0.23 | 0.24 | 0.18 |
| | Reb-S | — | 950 | 0.19 | 0.21 | 0.14 |
| | Reb-H | — | 950 | <0.05 | <0.05 | <0.05 |
| SG-4G1R | Reb J | — | 1112 | <0.05 | <0.05 | <0.05 |
| | Reb K | — | 1112 | <0.05 | <0.05 | <0.05 |
| | Reb K2 | — | 1112 | <0.05 | <0.05 | <0.05 |
| SG-5G1R | Reb-N | — | 1274 | 0.16 | 0.07 | 0.15 |
| SG-5G1R | Reb-O | — | 1436 | <0.05 | <0.05 | <0.05 |
| SG-3G1X | Reb-F | — | 936 | 0.19 | 0.31 | 0.22 |
| | Reb-R | — | 936 | <0.05 | <0.05 | <0.05 |
| SG-4G1X | Reb U | — | 1098 | <0.05 | <0.05 | <0.05 |
| | Reb T | — | 1098 | <0.05 | <0.05 | <0.05 |
| | Reb W | — | 1098 | <0.05 | <0.05 | <0.05 |
| | Reb W2 | — | 1098 | <0.05 | <0.05 | <0.05 |
| SG-5G-1X | Reb V | — | 1260 | <0.05 | <0.05 | <0.05 |
| — | Suavioside B | — | 658 | 0.67 | 0.39 | 0.61 |
| | Suavioside H | — | 656 | 1.43 | 0.56 | 0.94 |
| | 9-OH Suav J | — | 658 | 0.98 | 0.62 | 0.70 |
| | Suavioside K | — | 660 | 0.56 | 0.19 | 0.51 |
| | Suavioside E | — | 498 | <0.05 | <0.05 | <0.05 |
| | Suavioside L | — | 676 | <0.05 | <0.05 | <0.05 |
| | Suavioside F | — | 498 | <0.05 | <0.05 | <0.05 |
| | Suavioside O | — | 644 | <0.05 | <0.05 | <0.05 |
| | Suavioside A | — | 484 | <0.05 | <0.05 | <0.05 |

TABLE 152-3
Statistical Summary of glycosylated rubusoside derived
from stevio glycosides (GRUds) contents.

| | 152-01 | 152-02 | 152-03 |
|---|---|---|---|
| | % (m/m) | % (m/m) | % (m/m) |
| Sum of contents: | 95.00 | 96.52 | 95.99 |
| Total RU and GRU | 73.33 | 74.94 | 75.56 |
| Total RU | 19.04 | 20.86 | 19.28 |
| Total GRU | 56.39 | 56.89 | 57.52 |
| Total suaviosides | 3.64 | 1.76 | 2.76 |
| Maltodextrins | 15.94 | 17.01 | 16.43 |

Conclusion: Glycosylated rubusoside derived from steviol glycosides originating in stevia leaves comprises mono-glucose, di-glucose, tri-glucose, tetra-glucose and penta-glucose added rubusoside. The products can be used as flavors or sweeteners. An embodiment of a sweetener or flavor composition comprises one or more substances selected from mono-glucose, di-glucose, tri-glucose, tetra-glucose and penta-glucose added rubusoside.

### Example 153. Preparation of Glycosylated Stevioside 85% (GSTV85)

Material: Stevioside 85% (STV85), available from Sweet Green Fields (Lot #: STV85-20170802). The steviol glycoside contents in this composition are shown in Table 153-1.

TABLE 153-1
Contents of stevioside 85% (m/m %)

| Lot# | RD | RA | STV | RC | RB | Others | TSG(9) |
|---|---|---|---|---|---|---|---|
| STV85-20170802 | 0.34 | 10.88 | 85.67 | 0.32 | 0.08 | 1.48 | 98.77 |

Experiment: Several mixtures of GRU90 and GSTV85 were prepared and evaluated according to the aforementioned sensory evaluation method, where average scores for each evaluation criteria were determined and recorded in the sensory results shown in Table 153-3. It should be noted that in these evaluations, the concentration of GRU90 in each product sample solution was the same (i.e. 200 ppm).

TABLE 153-2
Glycosylated product compositions.

| | Ratio of | | | |
|---|---|---|---|---|
| Product | GRU90 to | Weight of | Weight of | Volume of pure |
| No. | GSTV85 | GRU90 (mg) | GSTV85 (mg) | water (mL) |
| 153-00 | 10/0 | 20 | 0 | 100 |
| 153-01 | 10/1 | 20 | 2 | 100 |
| 153-02 | 10/3 | 20 | 6 | 100 |
| 153-03 | 10/5 | 20 | 10 | 100 |
| 153-04 | 10/7 | 20 | 9 | 100 |
| 153-05 | 10/9 | 20 | 20 | 100 |
| 153-06 | 10/10 | 20 | 20 | 100 |
| 153-07 | 10/40 | 20 | 80 | 100 |
| 153-08 | 10/70 | 20 | 140 | 100 |
| 153-09 | 10/100 | 20 | 200 | 100 |

TABLE 153-3
Sensory evaluation results.

| Product | Mouth | Metallic | | Overall |
|---|---|---|---|---|
| No. | feel | aftertaste | Bitterness | likability |
| 153-00 | 1.00 | 3.00 | 3.00 | 2.00 |
| 153-01 | 1.50 | 2.50 | 2.50 | 2.40 |
| 153-02 | 2.00 | 2.00 | 2.00 | 3.00 |
| 153-03 | 2.50 | 1.50 | 2.00 | 3.75 |
| 153-04 | 3.00 | 1.50 | 1.50 | 4.20 |
| 153-05 | 3.50 | 1.50 | 1.50 | 4.30 |
| 153-06 | 3.50 | 1.50 | 1.60 | 4.20 |
| 153-07 | 3.50 | 2.5 | 2.00 | 3.50 |
| 153-08 | 3.50 | 3.50 | 2.50 | 3.00 |
| 153-09 | 3.00 | 4.00 | 2.70 | 3.00 |

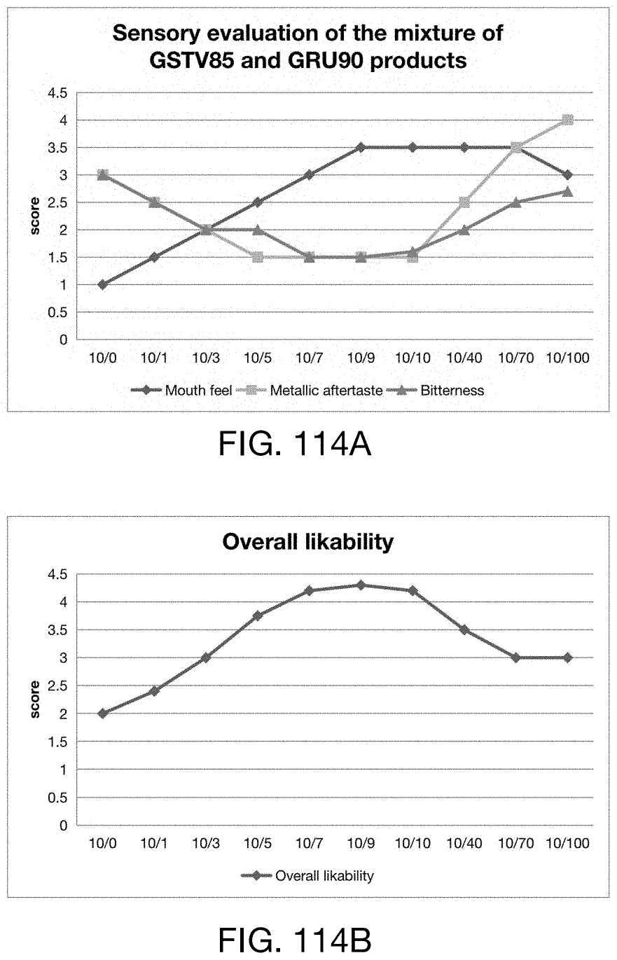

Data analysis: The relationship between the sensory evaluation results to the ratio of GRU90 to GSTV85 in this Example is shown in FIG. 114A. The relationship between the overall likability results to the ratio of GRU90 to GSTV85 in this Example is shown in FIG. 114B.

Conclusion: The results show that GSTV85 significantly improves the mouth feel and decreases the bitterness and metallic aftertaste of GRU90. This effect was observed in all the tested GRU90-to-GSTV85 ratios (from 10:1 to 10:100). This effect can be further extended to GRU90-to-GTRU20 ratio ranges of 99:1 to 1:99. This example demonstrates that GSTV85 can improve taste and mouth feel of natural sweeteners, such as GRU90. Such effects can be extended to all natural sweeteners.

### Example 154. Preparation of GSG-MRP-FTA and GRU90-MRP-FTAs from GRU90, GSGs, Concentrated Apple Juice and Fruit/Berry Aroma Concentrate

Raw Materials:

GRU90: product of Ex. 7.

GSG (glycosylated stevia extract comprises unreacted stevia glycosides), available from Sweet Green Fields. Lot #: 3080191. Preparation procedure is similar with Ex. 7, except that RU90 was replaced with stevia extract.

Fresh Fruit Juice Co. Ltd, Weinan Branch, lot #:25191005B01-05.

Aroma concentrate FTNF is available as follows:

TABLE 154-1
Aroma concentrate FTN.

| Product Name | Flavor Type | Company | Lot# |
|---|---|---|---|
| Apple aroma concentrate | Apple | Austria | 17.387 |
| FTNF | | Juice GmbH | |
| Strawberry aroma | Strawberry | | 121.593 |
| concentrate FTNF 1.500 fold | | | |
| Blueberry aroma concentrate | Blueberry | | 220.279 |
| FTNF | | | |

Process: GRU90, GSG, apple juice, glutamic acid, alanine, aroma concentrate FTNF, water were weighed as follows. The solution was then heated at about 100° C. for 1.5 hours. When the reaction was completed, the solution was filtered through filter paper and the filtrate was dried with a spray dryer, thereby resulting in products 154-01 to 154-04 as off white powders.

TABLE 154-2
Sample compositions.

| | | | | Apple | | | | Aroma |
|---|---|---|---|---|---|---|---|---|
| Product | Product | GSGs | | juice | Alanine | Glutamic | Water | concentrate |
| Name | No. | (g) | GRU90(g) | (g) | (g) | acid (g) | (mL) | FTNF (mL) |
| GSG- | 154-01 | 18 | — | 4.08 | 0.5 | 0.5 | | Strawberry/ |
| MRP- | | | | | | | | 0.45 mL |
| FTA | | | | | | | | |
| GRU90- | 154-02 | — | 18 | | | | | Apple/ |
| MRP- | | | | | | | | 0.45 mL |
| FTA | | | | | | | | |
| | 154-03 | | | | | | | Strawberry/ |
| | | | | | | | | 0.45 mL |
| | 154-04 | | | | | | | Blueberry/ |
| | | | | | | | | 0.45 mL |

Conclusion: All products obtained from above process were clear solutions. It demonstrates that sweet tea extract, its glycosylated product or MRPs, stevia extract, its glycosylated product or MRPs can act as excellent carrier to flavor ingredient. The final product can be in powder or liquid form. This technology can be used to produce water-soluble or dispersible essential oil, and products in powder form. The flavor intensity of the products produced by this technology was significantly intensified. There was synergy between the flavor ingredient and carrier. This technology can be used for any type of oils or soluble ingredients. The resulting products, such as water soluble or dispersible flavor ingredients, can enhance the retro-nasal flavor when added into food and beverage. An embodiment of the present application comprises (1) one or more of GSG, GSG-MRPs, GST and GST-MRPs; and (2) one or more plant aroma concentrates selected from fruit aroma concentrate, berry aroma concentrate and vegetable aroma concentrate.

### Example 155. GRU90-MRP-FTAs and GSG-MRP-FTAs Improve the Taste Profile of Natural High Intensity Sweeteners

Raw materials: (1) Selected natural high intensity sweetener: RA75/RB15, available from Sweet Green Fields, Lot #3070364 The content of RA is 78.73%, RB is 15.05%, and TSG (9) is 96.02%. (2) GRU90-MRP-FTAs: product 154-02 to 154-04, (3) GSG-MRP-FTA: product 154-01 of Ex. 154.

Process: (1) A 400 ppm RA75/RB15 solution was prepared by dissolving 0.4 g RA75/RB15 and 0.75 g of citric acid in 1000 mL of deionized water. Then the solution was sonicated for 15 min, resulting in a fully dissolved solution. (2) The selected GSG-MRP-FTA and GRU90-MRP-FTAs were weighed, mixed and dissolved in 100 mL RA75/RB15 solutions as set forth in Table 155-1.

TABLE 155-1
Sample compositions.

| Sample | | Weight GSG-MRP- | Volume of | Concen- |
|---|---|---|---|---|
| Mixture | Product | FTA/GRU90-MRP- | RA75/RB15 | tration |
| No. | No. | FTAs (mg) | solution (mL) | (ppm) |
| 155-00 | — | — | 100 | — |
| (Base) | | | | |
| 155-01 | 154-01 | 12 | | 120 |
| 155-02 | 154-02 | | | |
| 155-03 | 154-03 | | | |
| 155-04 | 154-04 | | | |

Experiment: Each sample was evaluated according to the sensory evaluation method in Ex. 5. The average scores from the test panel for each sensory criterions were recorded as the evaluation test results. The resulting taste profiles of the mixtures are shown in Table 155-2.

TABLE 155-2
Sensory evaluation results.

| | Overall | Sweetness | | Sweet | |
|---|---|---|---|---|---|
| Sample No. | likability | onset | Mouthfeel | lingering | Aftertaste |
| Base | 2 | 2 | 2 | 4 | 4 |
| 155-01 | 3 | 2.5 | 3 | 4 | 3.5 |
| 155-02 | 3.5 | 3 | 2.5 | 3.5 | 3 |
| 155-03 | 4 | 4 | 4 | 2.5 | 2 |
| 155-04 | 3 | 2.5 | 3 | 3.5 | 3.5 |

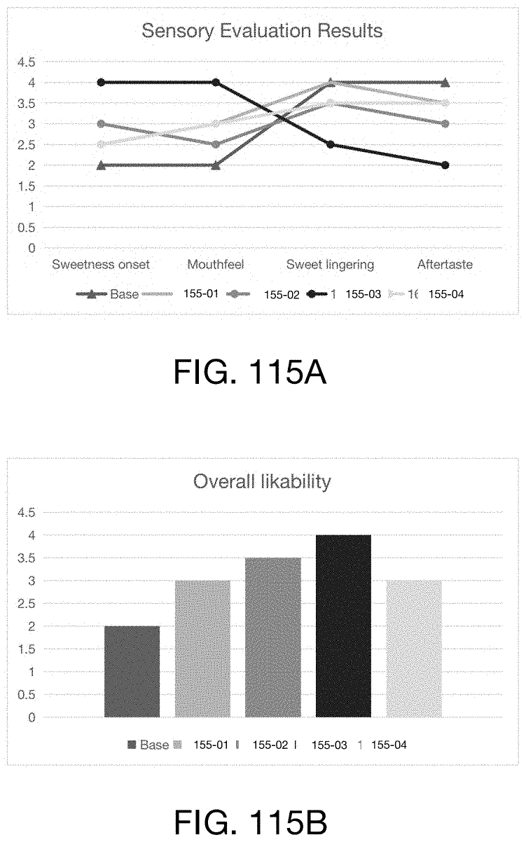

FIG. 115A is a chart showing the sensory evaluation results of GSG-MRP-FTA/GRU90-MRP-FTAs (154-01 to 154-04 in Ex. 154) in 400 ppm RA75/RB15 solution (155-01 to 155-04 in Ex. 155). FIG. 115B is a bar graph showing the overall likability of GSG-MRP-FTA/GRU90-MRP-FTAs (products 154-01 to 155-04 from Ex. 154) in 400 ppm RA75/RB15 solution (155-01 to 155-04 in Ex. 155).

Conclusion: All GSG-MRP-FTA and GRU90-MRP-FTAs (154-01 to 154-04 in Ex. 154) can reduce the sweet lingering and aftertaste, while quickening the sweetness onset and improving the mouthfeel of the RA75/RB15 solution. Product 155-03 (sample 154-03 was prepared from Ex. 154) showed the most significant improvement in terms of sweetness onset, reducing sweet lingering and aftertaste, which in turn resulted in a most improved overall likability of the product. The results show that the taste profile of RA75/RB15 can be improved by GSG-MRP-FTA and GRU90-MRP-FTAs (154-01 to 154-04 in Ex. 154). This effect can be extended to other natural high intensity sweeteners derived from stevia glycosides or stevia extract, monk fruit, licorice extract, sweet tea extract and monk fruit extract.

### Example 156. GRU90-MRP-FTA Improves the Taste Profile of a Carbonated Sugar-Free Peach Flavored Beverage

Two samples of a carbonated sugar-free peach-flavored beverage, one with the addition GRU90-MRP-FTA (product 154-03 from Ex. 154) and the other without the addition of GRU90-MRP-FTA were prepared according to the compositions shown in Table 156-1. The sweetness of the beverage was provided by natural sweeteners including erythritol, steviol glycosides and glycosylated steviol glycosides. Fruit flavoring (peach flavor, available from Givaudan China Ltd, Lot #: BJS003) was used to provide the peach favor to the beverage. GSG-MRP-CA (available from EPC Lab, Lot #20200101).

Preparation procedure: 14 g GSG was dissolved together with 1.5 g alanine and 4.5 g xylose in 120 mL deionized water. The mixture was stirred and heated to about 95-100° C. for about 2 hours. When the reaction was completed, the solution was spray dried to provide about 95 g of products as off white powder.

TABLE 156-1
Beverage compositions.

| | |
|---|---|
| Base | 156-01 |

| | |
|---|---|
| Ingredients | Concentration (ppm) |

| | | |
|---|---|---|
| Erythritol | 38000 | 38000 |
| Steviol glycosides | 200 | 200 |
| Citric acid | 500 | 500 |
| Food flavoring | 200 | 200 |
| GSG-MRP-CA | 150 | 150 |
| NaHCO₃ | 300000 | 300000 |
| GRU90-MRP-FTA | 0 | 100 |

Experiment: Each of the two samples were evaluated according to the sensory evaluation method in Ex. 5. Average scores from the test panel for each sensory criterions were recorded as the evaluation test results depicted in Table 156-02.

TABLE 156-2
Sensory evaluation results.

| | Overall | Sweetness | | Sweet | | |
|---|---|---|---|---|---|---|
| Sample | likability | onset | Mouthfeel | lingering | Aftertaste | Flavor |
| Base | 2.5 | 3 | 3 | 4 | 3 | 3 |
| 156-01 | 4.5 | 4.5 | 4.5 | 1.5 | 2 | 3.5 |

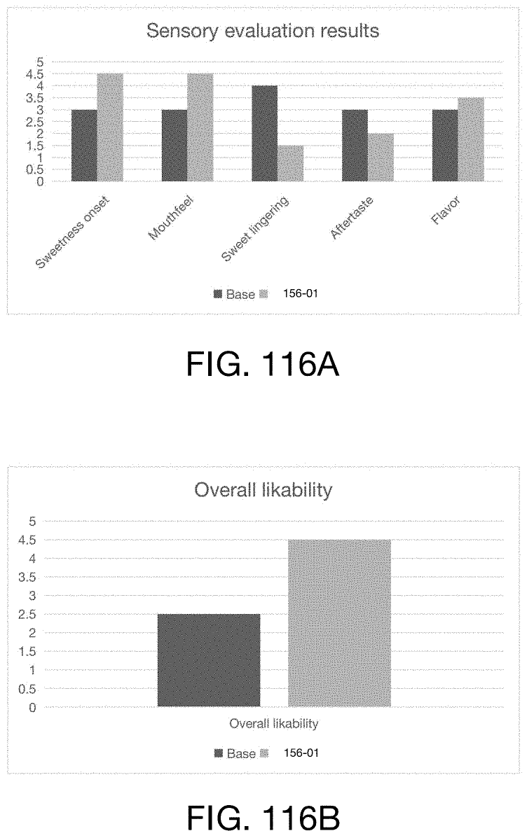

FIG. 116A is a bar graph showing the sensory evaluation results in Table 156-2. FIG. 116B is a bar graph showing the overall likability of the results in Table 156-2.

Conclusion: GRU90-MRP-FTA (product 154-03 from Ex. 154) can significantly improve the mouthfeel, quicken the sweetness onset and reduce the sweet lingering and aftertaste of the sugar-free peach-flavored beverage. In addition, the peach flavor of the beverage is also improved with the addition of GRU90-MRP-FTA (product 154-03 from Ex. 154). Thus, the overall likability of the peach-flavored beverage sweetened with natural sweeteners, including erythritol, steviol glycosides, etc. was improved. These results show that GRU90-MRP-FTA can improve the taste profile of beverages sweetened with polyols, steviol glycosides and other natural sweeteners.

### Example 157. Preparation of GRU90-MRP-FTAs from GRU90, Glutamic Acid, Concentrated Fruit Juice and Honey

Raw Materials:

GRU90: product of Ex. 7.

Concentrated fruit juice and honey are available as follows:

TABLE 157-1
Concentrated fruit juices and honey.

| | | Date of |
|---|---|---|
| Product Name | Company | production |
| Concentrated Green plum | Haitong food Xuzhou | 2021 Mar. 14 |
| juice (45 Brix) | Co., Ltd | |
| Concentrated orange juice | COFCO Group | 2021 Mar. 12 |
| NFC peach juice-C003 | Haitong food Xuzhou | 2021 Mar. 14 |
| | Co., Ltd | |
| Acerola cherry and aronia | COFCO Group | 2021 Mar. 10 |
| jam (Brix 27.5 ± 2.5) | | |
| White grape juice | COFCO Group | 2021 Mar. 12 |
| Concentrated carrot | Haitong food Xuzhou | 2021 Mar. 14 |
| juice (70 Brix) | Co., Ltd | |
| Robinia honey | Shanghai Guanshengyuan | 2020 Dec. 24 |
| | Bee Products Co., Ltd | |

Process: GRU90, glutamic acid, concentrated fruit juice/honey, water were weighed as follows. The solution was then heated at about 100° C. for 1.5 hours. When the reaction was completed, the solution was filtered through filter paper and the filtrate was dried with a spray dryer, thereby resulting in products 157-01 to 157-07 as off white powders.

TABLE 157-2
Sample compositions.

| | | | Weight of | | |
|---|---|---|---|---|---|
| Product | Product | Weight of | glutamic | Weight of | Weight of Concentrated |
| name | No. | GRU90(g) | acid(g) | water (mL) | fruit juice and honey (mL) |
| GRU90- | 157-01 | 18 | 0.5 | 10 | Concentrated green plum juice/ |
| MRP-FTA | | | | | 4.17 mL |
| | 157-02 | | | | Concentrated orange juice/ |
| | | | | | 4.17 mL |
| | 157-03 | | | | NFC peach juice |
| | 157-04 | | | | Acerola cherry and aronia jam/ |
| | | | | | 4.17 mL |
| | 157-05 | | | | White grape juice/4.17 mL |
| | 157-06 | | | | Concentrated carrot juice/ |
| | | | | | 4.17 mL |
| | 157-07 | | | | Honey/4.17 mL |

### Example 158. GRU90-MRP-FTAs Improve the Taste Profile of Natural Intensity Sweeteners

Raw materials: (1) Selected natural intensity sweetener: RA75/RB15, available from Sweet Green Fields, Lot #3070364. The content of RA is 78.73%, RB is 15.05%, and TSG (9) is 96.02%. (2) GRU90-MRP-FTAs: products 163-01 to 163-05.

Process: (1) A 400 ppm RA75/RB15 solution was prepared by dissolving 0.4 g RA75/RB15 and 0.75 g of citric acid in 1000 mL of deionized water. Then the solution was sonicated for 15 min, resulting in a fully dissolved solution. (2) The selected GRU90-MRP-FTAs were weighed, mixed and dissolved in 100 mL RA75/RB15 solutions as set forth in Table 164-1.

TABLE 164-1
Sample compositions.

| Sample | Product No. of | | Volume of | Concen- |
|---|---|---|---|---|
| mixture | GRU90-MRP- | Weight GRU90- | RA75/RB15 | tration |
| No. | FTAs | MRP-FTAs (mg) | solution (mL) | (ppm) |
| 158-00 | — | — | 100 | — |
| (Base) | | | | |
| 158-01 | 157-01 | 10 | | 100 |
| 158-02 | 157-02 | | | |
| 158-03 | 157-03 | | | |
| 158-04 | 157-04 | | | |
| 158-05 | 157-05 | | | |

Experiment: Each sample was evaluated according to the sensory evaluation method in Ex. 5. The average scores from the test panel for each sensory criterions were recorded as the evaluation test results. The resulting taste profiles of the mixtures are described in Table 158-2.

TABLE 158-2
Sensory evaluation results.

| Sample | | | | | |
|---|---|---|---|---|---|
| Mixture | Overall | Sweetness | Sweet | | Metallic |
| No. | likability | onset | lingering | Mouthfeel | aftertaste |
| 158-00 | 2 | 2 | 4 | 2 | 4 |
| (Base) | | | | | |
| 158-01 | 3 | 2.5 | 2 | 2.5 | 2 |
| 158-02 | 4 | 3 | 1.5 | 3 | 1.5 |
| 158-03 | 3 | 2.5 | 2.5 | 2.5 | 1.5 |
| 158-04 | 4.2 | 3.2 | 1.5 | 3 | 1.5 |
| 158-05 | 2.5 | 2.2 | 3 | 2.5 | 2.5 |

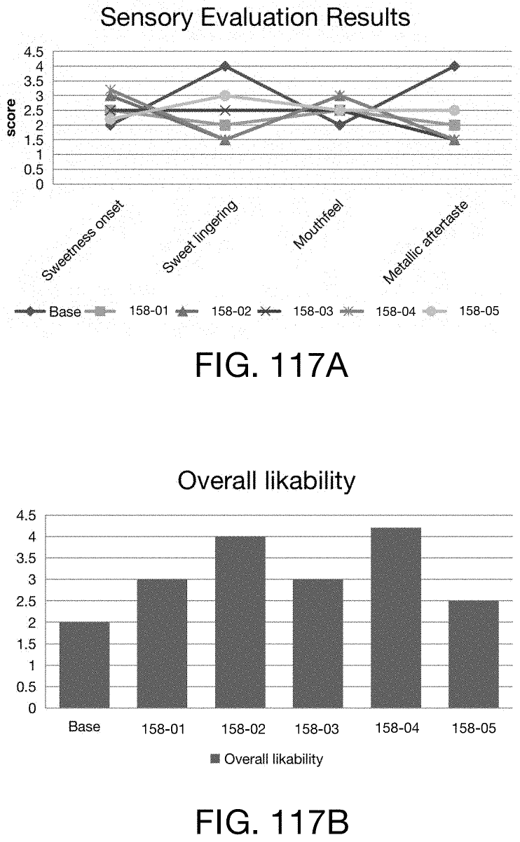

FIG. 117A is a chart showing the sensory evaluation results of GRU90-MRP-FTA (157-01 to 157-05 in Ex. 157) in 400 ppm RA75/RB15 solution (158-00 to 158-05). FIG. 117B is a bar graph showing the overall likability of GRU90-MRP-FTA (157-01 to 157-05 in Ex. 157) in 400 ppm RA75/RB15 solution (158-00 to 158-05).

Conclusion: GRU90-MRP-FTAs (157-01 to 157-05 in Ex. 157) all can reduce the sweet lingering and aftertaste, while quicken the sweetness onset and improving the mouthfeel of the RA75/RB15 solution. Product 158-02 (with product 157-02 prepared from Ex. 157) showed the most significant improvement in terms of sweetness onset, reducing sweet lingering and aftertaste, which in turn resulted in an most improved overall likability of the product. The results show that the taste profile of RA75/RB15 can be improved by GRU90-MRP-FTAs (157-01 to 157-05 in Ex. 157). This effect can be extended to other natural intensity sweeteners derived from sweet tea extract, sweet tea extract, licorice extract, monk fruit extract, and the like.

### Example 159. GRU90-MRP-FTAs (157-06 to 157-07 in Ex. 157) Improves the Taste Profile of Artificial Sweeteners Sucralose

Process: GRU90-MRP-FTA (157-06 to 157-07 in Ex. 157) and sucralose (available from Anhui Jinhe Industrial Co., Ltd and Lot # is 201810013) were weighed and uniformly mixed according to the weight shown in Table 159-1 dissolved in 100 mL pure water, and subjected to a sensory evaluation test.

TABLE 159-1
Sample compositions.

| | | | | Concentration | |
|---|---|---|---|---|---|
| | Weight of | | | of GRU90- | Concentration |
| | GRU90-MRP- | Weight of | Volume of | MRP-FTA | of sucralose |
| Components | FTA (mg) | sucralose (mg) | water (mL) | (PPm) | (PPm) |
| Base | | 12 | 100 | | 120 |
| 159-01 | 9 (product | 12 | 100 | 90 | 120 |
| | of 157-06) | | | | |
| 159-02 | 9(product | 12 | 100 | 90 | 120 |
| | of 157-07) | | | | |

Experiment: Each sample was evaluated according to the aforementioned sensory evaluation method in Ex. 5, and the average score of the panel was taken as the evaluation result data. The taste profiles of the mixtures are shown in Table 159-2.

Table 159-2 is a pictorial view showing the sensory evaluation results of GRU90-MRP-FTA (157-06 to 157-07 in Ex. 157) in 120 ppm sucralose

| | Overall | Sweetness | Sweet | | Metallic |
|---|---|---|---|---|---|
| Sample | likability | onset | lingering | Mouthfeel | aftertaste |
| Base | 2.5 | 2 | 4 | 2 | 4 |
| 159-01 | 4 | 3.5 | 2 | 3 | 1 |
| 159-02 | 4.5 | 4 | 2 | 4 | 1 |

Conclusion: GRU90-MRP-FTA (157-06 to 157-07 in Ex. 157) significantly reduced the metallic aftertaste and Sweet lingering of sucralose. In addition, GRU90-MRP-FTA (157-06 to 157-07 in Ex. 157) provided significantly improved sweetness onset and mouthfeel of the sucralose. These effects can be extended to all artificial sweeteners.

### Example 160. GRU90-MRP-FTAs (157-06 to 157-07 in Ex. 157) Improves the Taste Profile of Natural Sweeteners Rebaudioside M (RM)

Process: GRU90-MRP-FTA (163-06 to 163-07 in Ex. 163) and RM (available from Sichuan Ingia Biosynthetic Co., Ltd, China, the content of RM was 93.03% Lot #:20180915) were weighed and uniformly mixed according to the weight shown in Table 166-1, and dissolved in 100 mL pure water, and subjected to a sensory evaluation test.

TABLE 160-1
Sample compositions.

| | | | | Concentration | |
|---|---|---|---|---|---|
| | Weight of | | | of GRU90- | |
| | GRU90-MRP- | Weight of | Volume of | MRP-FTA | Concentration |
| Components | FTA (mg) | RM (mg) | water (mL) | (ppm) | of RM (ppm) |
| Base | | 40 | 100 | | 400 |
| 160-01 | 9 (product | 40 | 100 | 90 | 400 |
| | 163-06) | | | | |
| 160-02 | 9(product | 40 | 100 | 90 | 400 |
| | 163-07) | | | | |

Experiment: Each sample was evaluated according to the aforementioned sensory evaluation method in Ex. 5, and the average score of the panel was taken as the evaluation result data. The resulting taste profiles of the mixtures are shown in Table 160-2.

Table 160-2 shows the sensory evaluation results of GRU90-MRP-FTAs (157-06 to 157-07 in Ex. 157) in 400 ppm RM.

TABLE 160-2
Sensory evaluation profiles.

| | Overall | Sweetness | Sweet | | Metallic |
|---|---|---|---|---|---|
| Sample | likability | onset | lingering | Mouthfeel | aftertaste |
| Base | 3 | 2 | 3.5 | 2 | 3 |
| 160-01 | 4.2 | 3 | 2 | 3 | 1.5 |
| 160-02 | 4.5 | 4 | 2 | 4 | 1 |

Conclusion: GRU90-MRP-FTAs (157-06 to 157-07 in Ex. 157) significantly reduced the metallic aftertaste and sweet lingering of RM. In addition, GRU90-MRP-FTA (157-06 to 157-07 in Ex. 157) provided significantly improved sweetness onset and mouthfeel of the RM. These effects can be extended to all natural sweeteners.

### Example 161. GRU90-MRP-FTAs Improves the Taste Profile of a Carbonated Sugar-Free Peach Flavored Beverage

Two samples of a carbonated sugar-free peach-flavored beverage with the addition GRU90-MRP-FTAs (157-06 to 157-07 in Ex. 157) and without the addition of GRU90-MRP-FTAs were prepared according to the compositions shown in Table 161-1. The sweetness of the beverage was provided by natural sweeteners, including erythritol, steviol glycosides and glycosylated steviol glycosides. Fruit flavoring (peach flavor, available from Givaudan China Ltd, Lot #: BJS003) was used to provide a peach flavor to the beverage. GSG-MRP-CA was obtained from EPC Lab, Lot #20200101.

Preparation procedure: 14 g GSG was dissolved together with 1.5 g alanine and 4.5 g xylose in 120 mL deionized water. The mixtures were stirred and heated to about 95-100° C. for about 2 hours. When the reaction was complete, the solutions were spray dried to provide about 95 g of an off white powder.

TABLE 161-1
Beverage compositions.

| | Base | 157-06 | 157-07 |
|---|---|---|---|
| Ingredient | Concentration (ppm) | | |
| Erythritol | 38000 | 38000 | 38000 |
| Steviol glycosides | 200 | 200 | 200 |
| Citric acid | 500 | 500 | 500 |
| Food flavoring | 200 | 200 | 200 |
| GSG-MRP-CA | 150 | 150 | 150 |
| NaHCO₃ | 300000 | 300000 | 300000 |
| GRU90-MRP-FTA | 0 | 100 | 100 |

Experiment: Each of the two samples were evaluated according to the sensory evaluation method in Ex. 5. Average scores from the test panel for each sensory criterions were recorded as the evaluation test results depicted in Table 161-02.

TABLE 161-2
Sensory evaluation results.

| | Overall | Sweetness | | Sweet | |
|---|---|---|---|---|---|
| Sample | likability | onset | Mouthfeel | lingering | Flavor |
| Base | 2.5 | 3 | 3 | 4 | 3 |
| 157-06 | 4.5 | 4.2 | 3.5 | 1 | 4 |
| 157-07 | 4 | 4.5 | 4.5 | 1.5 | 3.5 |

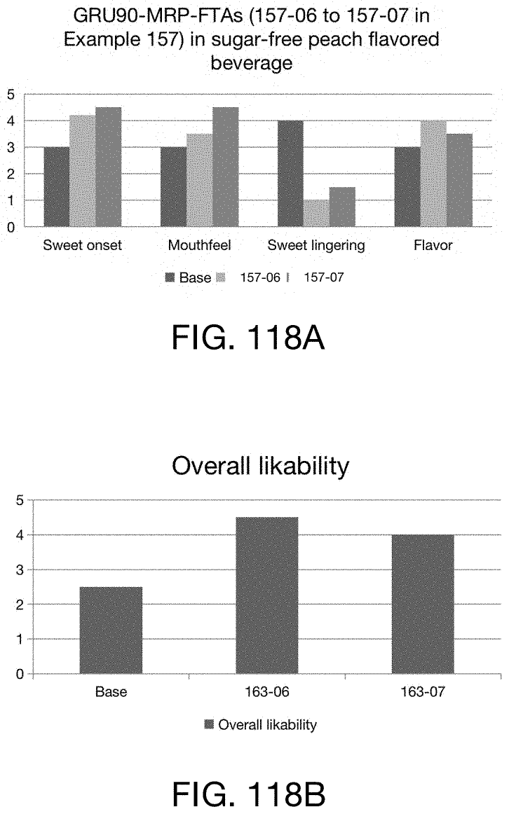

FIG. 118A is a bar graph showing the sensory evaluation results in Table 161-2. FIG. 118B is a bar graph showing the overall likability of the samples in Table 161-2.

Conclusion: GRU90-MRP-FTAs (157-06 to 157-07 in Ex. 157) can significantly improve the mouthfeel, quicken the sweetness onset and reduce the sweet lingering of the sugar-free peach-flavored beverage. In addition, the peach flavor of the beverage is also improved with the addition of GRU90-MRP-FTAs (157-06 to 157-07 in Ex. 157). Thus, the overall likability of the peach-flavored beverage sweetened with natural sweeteners, including erythritol, steviol glycosides, etc. was improved. These results show that GRU90-MRP-FTA can improve the taste profile of beverages sweetened with polyols, steviol glycosides and other natural sweeteners.

### Example 162. Conversion of Rubusoside from Steviol Glycosides Comprising Reb a and Stevioside

Materials: steviol glycosides, available from Sweet Green Fields, Lot # and contents of steviol glycosides are as follows.

TABLE 168-1
Lot# and contents of steviol glycosides (m/m %).

| Lot# | RA | STV | RU | TSG (9) |
|---|---|---|---|---|
| 121002 | 29.37% | 41.04% | 0.24% | 82.74% |
| 20160106 | 24.05% | 28.03% | 1.38% | 73.38% |
| 20161114 | 49.68% | 22.77% | 0% | 82.64% |

In Table 162-1, “TSG” refers to the content of total steviol glycosides (TSG(9)), which includes Rebaudioside A, Rebaudioside B, Rebaudioside C, Rebaudioside D, Rebaudioside F, stevioside, steviolbioside, rubusoside, and dulcoside A.

Conversion process: A 1 L steviol glycoside solution (100 g/L) was mixed with 3 g β-galactosidase (0.8 kU/g stevioside). The pH was adjusted to 4.5 and stirred at 55° C. for 5-8 h. The reaction mixture was then boiled for 3 min to deactivate the enzyme and the precipitated enzyme was removed by centrifugation. The resulting glycoside solution was then passed through an 800 mL T-28 macroporous resin (Sunrise) column and washed with 1600 mL of water. The column was then washed with 1600 mL ethanol, and the solution was collected and vacuum concentrated. The ethanol was removed and the solution was spray-dried, resulting in a RU product composition (Product No. 162-01 to 162-03) as powder. Table 162-2 shows the contents of steviol glycosides in the resulting powders obtained from the conversion process mentioned above.

TABLE 162-2
Contents of steviol glycosides (m/m %) after conversion.

| | Original | | | | |
|---|---|---|---|---|---|
| Product No. | Lot# | RA | STV | RU | TSG(9) |
| 162-01 | 121002 | 17.34% | 0.10% | 54.55% | 80.83% |
| 162-02 | 20160106 | 19.99% | 0.36% | 41.27% | 75.71% |
| 162-03 | 20161114 | 44.69% | 0% | 29.09% | 84.93% |

Process: Products 162-01 and 162-02 were recrystallized with methanol and dried obtaining the recrystallized products 162-04 and 162-05. Product 162-03 was recrystallized with ethanol and dried to obtain the recrystallized product 162006. Table 162-3 shows the contents of steviol glycosides (m/m %) after recrystallization.

TABLE 162-3
Contents of steviol glycosides (m/m %) after recrystallization.

| | Original | | | | |
|---|---|---|---|---|---|
| Product No. | product No. | RA | STV | RU | TSG(9) |
| 162-04 | 162-01 | 8.23% | 0.01% | 79.74% | 89.79% |
| 162-05 | 162-02 | 31.34% | 0.12% | 54.97% | 93.68% |
| 162-06 | 162-03 | 88.26% | 0.00% | 1.15% | 94.78% |

Conclusion: stevioside can be converted to rubusoside with β-galactosidase. Under certain conditions, the conversion rate can be close to 100%.

### Example 163. Preparation of GRU90-MRP-FTA and GRUds-MRP-FTA Using GRU/GRUds, Concentrated Apple Juice and Glutamic Acid

Raw Materials:

GRU90: product of Ex. 7.

GRUds: product of Ex. 80.

Concentrated apple juice: (fructose content: 36.77%) available from China Haisheng Fresh Fruit Juice Co., Ltd, Weinan Branch, lot #: 25191005B01-05.

Process: GRU90/GRUds, apple juice, glutamic acid, water were weighed as follows. The solution was then heated at about 100° C. for 1.5 hours. When the reaction was completed, the solution was filtered through filter paper and the filtrate was dried with a spray dryer, thereby resulting in products 163-01 and 163-02 as off white powders.

TABLE 169-1
Sample compositions.

| | | | Weight of | Weight of | |
|---|---|---|---|---|---|
| Product | Weight of | Weight of | apple | glutamic | Weight of |
| No. | GRUds (g) | GRU90(g) | juice (g) | acid(g) | water(mL) |
| 163-01 | — | 18 | 8.16 | 1 | 7.82 |
| 163-02 | 18 | — | 8.16 | 1 | 7.82 |

### Example 164. Analysis of Residual Amino Acid in GRU90-MRP-FTAs and GRUds-MRP-FTA

Materials:

GRU90-MRP-FTAs: product 34-01, 34-02, 163-01 from Examples 34 and 163.

GRUds-MRP-FTA: product 163-02 from Ex. 163.

Methods:

The residual amino acid analyzed is glutamic acid. The experiment is carried out with the following procedure:

HPLC Method for Glutamic Acid Content Determination:

Mobile phase A: heptafluorobutyric acid: trifluoroacetic acid:water=2:1:1000; mobile phase B: methanol.

Analytical system: The HPLC system consisted of an Agilent 1260 system (autosampler, ternary gradient pump, column thermostat, DAD-UV/VIS detector) connected in-line to a SEDEX75 Evaporative Light-Scattering Detector (ELSD). For HPLC analysis, the system used a SHISEIDO Capcell Pak C18MGII S5 (5 μm, 4.6 mm×250 mm) column, flow rate 0.8 mL·min-1, the reacted samples were injected after filtration (2 μm syringe filters), the injection volume was set to 10 μl. For ELSD analysis, the gain 2, the pressure 3.0 pa, and the draft temperature 40° C. The gradient for elution is set forth in Table 164-1.

TABLE 164-1
Gradient for elution.

| Time [min] | % A | % B |
|---|---|---|
| 0 | 100 | 0 |
| 8 | 100 | 0 |
| 11 | 78 | 22 |
| 21 | 73 | 27 |
| 30 | 45 | 55 |
| 40 | 45 | 55 |

Results: The content of residual sugars including fructose and glucose and the amino acid (glutamic acid) is shown in Table 164-2.

TABLE 164-2
Content of residual glutamic acid.

| | Glutamic acid |
|---|---|
| Product. | content (%) |
| 34-01 | 4.124 |
| 34-02 | 1.011 |
| 163-01 | 2.484 |
| 163-02 | 3.852 |

Conclusion: Depending on the reaction condition, the final products of GRU-MRP can contain unreacted amino acids, and also sugar donors.

### Example 165. Salt Synergistic Effect of GRU90-MRP-FTA (Product 39-01 in Ex. 39) to Edible Salt

Materials:

GRU90-MRP-FTA: product of 39-01 in Ex. 39.

Edible salt: Natural sea salt, available from CNSIC Beijing Salt Company, lot #20100320.

Method:

Several of 0.05% edible salt solutions were prepared, and an appropriate amount of GRU90-MRP-FTA (product 39-01 in Ex. 39) was added to prepare salt solutions containing different concentrations of GRU90-MRP-FTA (product 39-01 in Ex. 39). The data from each test sample is shown in Table 165-1. Members of a panel tasted each test solution and compared it with different concentrations of standard saline solution to determine the sensory saltiness of each test sample. The results of this evaluation are shown in Table 165-2.

TABLE 165-1
Weight and concentrations of GRU90-MRP-FTA (product
39-01 in Ex. 39) in 0.05% edible salt solutions.

| | 0.05% edible salt | GRU90-MRP- | GRU90-MRP- |
|---|---|---|---|
| Sample # | solution (ml) | FTA (mg) | FTA (PPm) |
| 165-01 | 50 | 1.5 | 30 |
| 165-02 | 50 | 2.5 | 50 |
| 165-03 | 50 | 4 | 80 |
| 165-04 | 50 | 5 | 100 |
| 165-05 | 50 | 6 | 120 |
| 165-06 | 50 | 7.5 | 150 |

The results of the sensory evaluation are shown in Table 171-2.

TABLE 171-2
Salt reduction synergic effect of GRU90-MRP-
FTA (product 39-01 in Ex. 39) to edible salt.

| | GRU90-MRP- | Concentration of | Sensory | Saltiness |
|---|---|---|---|---|
| Sample # | FTA (ppm) | edible salt | saltiness | increasing* |
| 165-01 | 30 | 0.05% | 0.050% | 0 |
| 165-02 | 50 | 0.05% | 0.053% | 6% |
| 165-03 | 80 | 0.05% | 0.055% | 10% |
| 165-04 | 100 | 0.05% | 0.060% | 20% |
| 165-05 | 120 | 0.05% | 0.068% | 36% |
| 165-06 | 150 | 0.05% | 0.075% | 50% |

*Saltiness increasing = (Sensory saltiness − Concentration of edible salt)/Concentration of edible salt × 100%

Conclusion: The results showed that GRU-MRPs can produce salt synergistic effects with edible salt. For a 0.05% solution of edible salt, adding 50 ppm to 150 ppm of GRU90-MRP-FTA (product 39-01 in Ex. 39) can increase the saltiness by 6% to 50%. Depending on the salt reduction level requirements, the content of GRU-MRPs in the final salt products can be in range of 0.599%.

### Example 166. Umami Synergistic Effect of GRU90-MRP-FTA (Product 39-01 in Ex. 39) to Monosodium Glutamate

Materials: GRU90-MRP-FTA: product of 39-01 in Ex. 39; Monosodium glutamate: available from MEIHUA HOLDINGS GROUP CO., LTD., Lot #20200520.

Method:

Several 0.05% monosodium glutamate solutions were prepared, and an appropriate amount of GRU90-MRP-FTA (product 39-01 in Ex. 39) was added to prepare monosodium glutamate solutions containing different concentrations of GRU90-MRP-FTA. The composition of each test sample is shown in Table 166-1. Members of a panel tasted each test solution and compared it with different concentrations of standard monosodium glutamate solution to determine the sensory umami of each test sample. The results of this evaluation are shown in Table 166-2

TABLE 166-1
Weight and concentration of GRU90-MRP-FTA (product 39-01
in Ex. 39) in 0.05% monosodium glutamate solutions.

| | 0.05% monosodium | GRU90-MRP- | GRU90-MRP- |
|---|---|---|---|
| Sample # | glutamate solution (ml) | FTA (mg) | FTA (PPm) |
| 166-01 | 50 | 1.5 | 30 |
| 166-02 | 50 | 2.5 | 50 |
| 166-03 | 50 | 4 | 80 |
| 166-04 | 50 | 5 | 100 |
| 166-05 | 50 | 6 | 120 |
| 166-06 | 50 | 7.5 | 150 |

Table 166-2 shows an umami synergistic effect of GRU90-MRP-FTA (product 39-01 in Ex. 39) to monosodium glutamate.

TABLE 166-2
Sensory evaluation results.

| | | Concentration of | | |
|---|---|---|---|---|
| | Concentration of | monosodium | | |
| | GRU90-MRP- | glutamate | Sensory | Umami |
| # | FTA (ppm) | (%) | Umami | increasing* |
| 166-01 | 30 | 0.05% | 0.055% | 10% |
| 166-02 | 50 | 0.05% | 0.060% | 20% |
| 166-03 | 80 | 0.05% | 0.065% | 30% |
| 166-04 | 100 | 0.05% | 0.070% | 40% |
| 166-05 | 120 | 0.05% | 0.08% | 60% |
| 166-06 | 150 | 0.05% | 0.085% | 70% |

*Umami increasing = (Sensory Umami − Concentration of monosodium glutamate)/Concentration of monosodium glutamate × 100%

Conclusion:

The results showed that GRU-MRPs can produce umami synergistic effects with monosodium glutamate. For a 0.05% solution of monosodium glutamate, adding 30 ppm to 150 ppm of GRU90-MRP-FTA (product 39-01 in Ex. 39) can increase the umami taste by 10% to 70%. The content of GRU-MRPs used in savory or Umami products could be in range of 0.1-99%.

### Example 167. GRU90-MRP-FTAs (Product 39-01 in Ex. 39) Improve the Taste Profile of Salad

Process: GRU90-MRP-FTA (product 39-01 in Ex. 39) and salad (contains endive, bitter gourd, purple cabbage, tomato, cucumber, egg, radish, lettuce, salad dressing) were weighed and uniformly mixed according to the weights shown in Table 167-1 and subjected to a sensory evaluation test.

TABLE 167-1
Sample composition.

| | Weight of GRU90- | Weight of salad |
|---|---|---|
| Components | MRP-FTA (g) | (g) |
| Base | 0 | 100 |
| 167-01 | 0.1 | 100 |

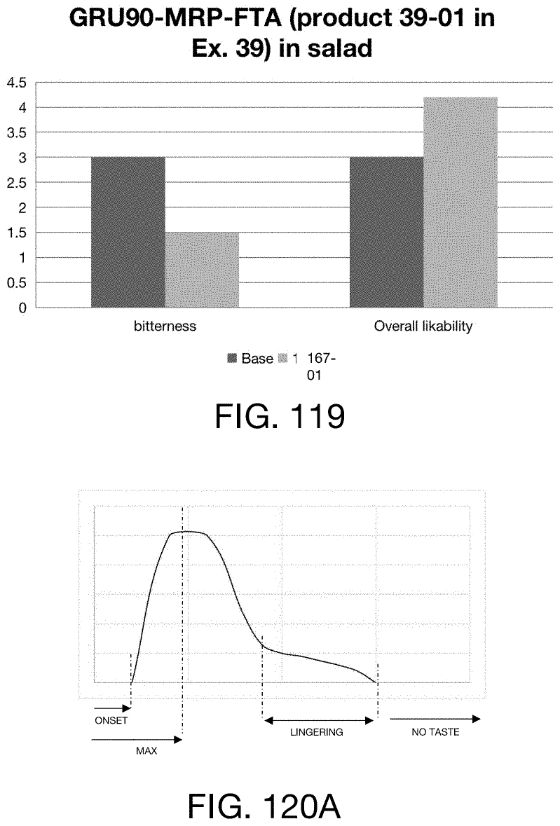

Experiment: Each sample was evaluated according to the aforementioned sensory evaluation method in Ex. 5, and the average score of the panel was taken as the evaluation result data. The resulting taste profile of the mixture is shown in Table 167-2 and FIG. 119.

TABLE 167-2
Sensory evaluation GRU90-MRP-FTAs
(product 39-01 in Ex. 39) in salad.

| | Overall | |
|---|---|---|
| Sample | likability | Bitterness |
| Base | 3 | 3 |
| 167-01 | 4.2 | 1.5 |

Conclusion: GRU90-MRP-FTAs (product 39-01 in Ex. 39) can significantly reduce the bitterness of salad and improve its overall likability. These effects can be extended to all salads. GRU-MRPs can be added to the dressing, sauce and/or salad products to improve the overall taste profile.

### Example 168. Preparation of GSG-MRP-PLTA and GRU90-MRP-PLTA from GRU90, GSGs, Fructose, Glutamic Acid and Piper longum Extract

Raw Materials:

GRU90: the product of Ex. 7.

GSGs (glycosylated stevia extract comprises unreacted stevia glycosides) available from Sweet Green Fields, Lot #3080191. The GSGs were prepared essentially as described in Ex. 7 with the exception that RU90 was replaced with Stevia extract. The content of residual dextrin in the preparation is 14.3%; total steviol glycoside content is 85.7%, including unreacted and glycosylated steviol glycosides, among them Rebaudioside A (9.11%) and stevioside (4.45%).

Piper longum extract: 100 g Piper longum was broken into small 0.3-0.5 cm pieces and mixed with 250 ml ethanol. The mixture was then extracted at 45 C for 6 h using a Soxhlet extractor. When the extraction was completed, the solution was concentrated into a paste.

Process: GRU90, GSGs, fructose, glutamic acid, Piper longum extract, and water were weighed and combined as described in Table 174. The resulting solutions were then heated at about 95-100° C. for 1.5 hours. When the MRP reactions were completed, the solutions were filtered through filter paper and the filtrates were dried with a spray dryer, thereby resulting in products 168-01 to 168-02 as off white powders.

TABLE 168
Test sample compositions.

| Product | Product | GSGs | | Fructose | Glutamic | Water | Piper longum |
|---|---|---|---|---|---|---|---|
| name | No. | (g) | GRU90(g) | (g) | acid (g) | (mL) | extract (g) |
| GRU90- | 168-01 | 20 | | 1.5 | 0.5 | 11 | 0.4 |
| MRP- | | | | | | | |
| PLTA | | | | | | | |
| GSG- | 168-02 | | 20 | | | | |
| MRP- | | | | | | | |
| PLTA | | | | | | | |

### Example 169. Evaluation of the Sweetness and Spiciness of Different Concentrations of GRU90-MRP-PLTA and GSG-MRP-PLTA Compared to Solutions of Sucrose

Evaluation Method:

Principles of sensory tasting and description of sensory attributes

Before any tasting session, panelists discussed the upcoming series of samples openly tasted samples related to the session to reach a consensus for the descriptions. Where the flavors are to be described, samples are tasted at in-use concentrations to reach a consensus on how to describe the flavors with respect to e.g., taste, smell, and intensity.

During any tasting session, the panelists independently perform blind taste testing of all samples in a series. Panelists are allowed to re-taste samples and record notes concerning the sensory attributes perceived. In the last step, the perceived attributes are openly discussed to reach a consensus description. In the event that more than one panelist disagrees with the consensus, the tasting is repeated.

Scaling Tests.

Scaling tests were carried out in which panelists record the intensity of a sensory attribute in a 5-point scale. Prior to sample tasting, the panelists are trained to have a common understanding for the intensity ratings associated with any sensory attribute that is evaluated. In a typical setting, one or more of the following attributes are scaled:

Lingering (prior to sample tasting established with ascending concentrations of 0-10 ppm Thaumatin);

Off taste (prior to sample tasting established with ascending concentrations of 0-50 ppm Saccharin);

Mouth feeling (prior to sample tasting established with ascending concentrations of 0-1000 ppm Xanthan);

Flavor intensity (prior to sample tasting established with ascending concentrations of the flavor of interest);

Sweetness intensity (prior to sample tasting established with ascending concentrations of 0-10% sugar).

The scaled values recorded are statistically evaluated using the Wilcoxon signed rank test.

Two-alternative forced choice (2-AFC) tests.

2-AFC tests were performed in which pairs of samples were provided to each of 12 panelists in a blinded manner randomly in 3 replicates. For each pair of provided samples, each panelist generates an intensity related rating for the sensory attribute in a sample. Thus, a total of 36 ratings were obtained from the 12 panelists from the 3 replicates. Based on published tables, a minimum number of ≥24 ratings provides statistical significance at α=0.05 for a total of 36 tests.

In a typical setting, trained panelists taste one or more test samples and compare them pair-wise with reference samples prepared with ascending concentrations of the sensory attribute(s) of interest. Re-tasting is allowed. The reference sample fitting best to the test sample is recorded.

Materials:

GRU90-MRP-PLTA: product 168-01 in Ex. 168.

GSG-MRP-PLTA: product 168-02 in Ex. 168.

Test Design:

Different solutions of GRU90-MRP-PLTA and GSG-MRP-PLTA were prepared. The solutions were compared to sucrose solutions in concentrations from 1% to 5% in steps of 0.5%. The objective was to assess the sugar equivalence (same maximum sweetness) relative to the reference solutions. All samples were prepared in distilled water. The results are summarized in Table 169-01.

TABLE 169-01

| | Concentration [ppm] | | | | | | |
|---|---|---|---|---|---|---|---|
| Sample | 50 | 75 | 100 | 125 | 150 | 175 | 200 |
| GRU90- | neutral | neutral | neutral | neutral | neutral | neutral | neutral |
| MRP- | flavor, | flavor, | flavor, | flavor, | flavor, | flavor, | flavor, |
| PLTA | neutral | neutral | slight | slight | slight | slight | slight |
| | taste, | taste, | sweet | sweet | sweet | sweet | sweet |
| | no | no | taste, | taste, | taste, | taste, | taste, |
| | lingering | lingering | no | no | no | no | very |
| | | | lingering | lingering | lingering | lingering | weak |
| | | | | | | | lingering, |
| | | | | | | | very |
| | | | | | | | weak |
| | | | | | | | spicy |
| | | | | | | | aftertaste |
| SugarE | <1.0 | <1.0 | <1.0 | 1.5 | 1.5 | 2.0 | 2.5 |
| (%) | | | | | | | |
| Spiciness* | 0 | 0 | 0 | 0 | 0 | 0 | 1 |
| GSG- | neutral | neutral | neutral | neutral | neutral | neutral | neutral |
| MRP- | flavor, | flavor, | flavor, | flavor, | flavor, | flavor, | flavor, |
| PLTA | neutral | neutral | neutral | neutral | neutral | neutral | neutral |
| | taste, | taste, | taste, | taste, | taste, | taste, | taste, |
| | no | no | no | no | no | no | no |
| | lingering | lingering | lingering | lingering | lingering | lingering | lingering, |
| | | | | | | | very |
| | | | | | | | weak |
| | | | | | | | spicy |
| | | | | | | | aftertaste |
| SugarE | <1.0 | <1.0 | 1 | 1.5 | 2.0 | 2.5 | 2.5 |
| Spicy | 0 | 0 | 0 | 0 | 0 | 0 | 1 |
| aftertaste* | | | | | | | |
| | | Concentration [ppm] | | | | | |
| | Sample | 250 | 300 | 350 | 400 | 450 | 500 |
| | GRU90- | neutral | slightly | slightly | slightly | slightly | slightly |
| | MRP- | flavor, | sweet | sweet | sweet | sweet | sweet |
| | PLTA | moderate | flavor, | flavor, | flavor, | flavor, | flavor, |
| | | sweet | moderate | moderate | slightly | slightly | slightly |
| | | taste, | sweet | sweet | strong | strong | strong |
| | | very | taste, | taste, | sweet | sweet | sweet |
| | | weak | very | very | taste, | taste, | taste, |
| | | lingering, | weak | weak | slightly | slightly | slightly |
| | | very | lingering, | lingering, | weak | weak | weak |
| | | weak | slightly | slightly | lingering, | lingering, | lingering, |
| | | spicy | weak | weak | moderate | moderate | moderate |
| | | aftertaste | spicy | spicy | spicy | spicy | spicy |
| | | | aftertaste | aftertaste | aftertaste | aftertaste | aftertaste |
| | SugarE | 3.0 | 3.0 | 3.5 | 4.0 | 4.5 | 5.0 |
| | (%) | | | | | | |
| | Spiciness* | 1 | 2 | 3 | 3 | 4 | 4 |
| | GSG- | neutral | neutral | neutral | neutral | neutral | neutral |
| | MRP- | flavor, | flavor, | flavor, | flavor, | flavor, | flavor, |
| | PLTA | neutral | neutral | neutral | neutral | neutral | neutral |
| | | taste, | taste, | taste, | taste, | taste, | taste, |
| | | no | no | no | slightly | slightly | slightly |
| | | lingering, | lingering, | lingering, | weak | weak | weak |
| | | very | very | slightly | lingering, | lingering, | lingering, |
| | | weak | weak | weak | slightly | moderate | moderate |
| | | spicy | spicy | spicy | weak | spicy | spicy |
| | | aftertaste | aftertaste | aftertaste | spicy | aftertaste | aftertaste |
| | | | | | aftertaste | | |
| | SugarE | 3.0 | 3.5 | 4.0 | 4.5 | 5.0 | >5.0 |
| | Spicy | 1 | 1 | 2 | 2 | 3 | 3 |
| | aftertaste* | | | | | | |

*5-point scale established with capsaicin (0 = null, 1 = very weak, 2 = slightly weak, 3 = moderate, 4 = slightly strong, 5 = strong)

Conclusion: The results of this evaluation surprisingly show that the addition of pepper from e.g., Piper longum can significantly improve the taste profile of GSG-MRPs, GRU-MRPs such that little or no bitterness, lingering or spicy aftertaste is present even at a higher sucrose equivalent (SugarE). In particular, GSG-MRP-PLTA and GRU-MRP-PLTA were found to reduce the bitterness and lingering of GSG-MRP and GRU-MRPs. GRU90-MRP-PLTA is less sweet, but more spicy than GSG-MRP-PLTA. GSG-MRP-PLTA is more sweet, but less spicy than GRU90-MRP-PLTA.

### Example 170. Sweetness Profiles of GRU90-MRP-PLTA and GSG-MRP-PLTA at Different Concentrations and Evaluation of Onset, Time to Maximum Sweetness and Lingering

Test Design:

Each person in a test panel evaluated GRU90-MRP-PLTA and GSG-MRP-PLTA solutions at different concentrations. In the test, each panelist recorded the appearance-time for five specific points in a sweetness profile (onset, maximum sweetness, lingering on, lingering off). During these tests the “time to no taste” was evaluated to describe the phase with essentially spicy flavor. The appearance times were recorded in seconds (read out of stop watches for time recording) in the following exemplary chart set forth in Table 170-1.

TABLE 170-1
Evaluation taste test chart.

| | | | | |
|---|---|---|---|---|
| | | | | NO |
| ONSET | MAX | LINGERING | LINGERING | TASTE |
| [sec] | [sec] | ON [sec] | OFF [sec] | [sec] |

GRU90-
MRP-PLTA
GSG-MRP-
PLTA

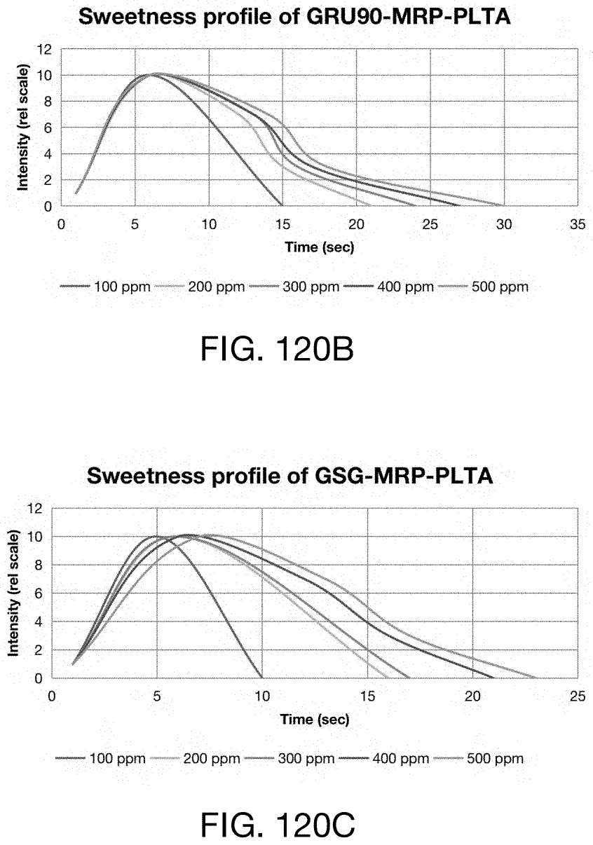

FIG. 120A shows an exemplary sweetness profile that illustrates a representative time course showing the appearance-times for the five specific points in the above described sweetness and lingering test:

Materials:

GRU90-MRP-PLTA: product 168-01 in Ex. 168

GSG-MRP-PLTA: product 168-02 in Ex. 168

Results:

From the taste evaluations of panelists, mean values for each attribute were determined and recorded for GRU90-MRP-PLTA in Table 170-2 and for GSG-MRP-PLTA in Table 170-3. FIG. 120B shows the sweetness profile of GRU90-MRP-PLTA. FIG. 120C shows the sweetness profile of GSG-MRP-PLTA.

TABLE 170-2

| | | | | | NO |
|---|---|---|---|---|---|
| GRU90- | ONSET | MAX | LINGERING | LINGERING | TASTE |
| MRP-PLTA | [sec] | [sec] | [sec] | OFF [sec] | [sec] |
| 100 ppm | 1 | 6 | — | — | 15 |
| 200 ppm | 1 | 6 | 12 | 15 | 21 |
| 300 ppm | 1 | 6 | 13 | 16 | 24 |
| 400 ppm | 1 | 6 | 13 | 17 | 27 |
| 500 ppm | 1 | 6 | 14 | 18 | 30 |

TABLE 170-3

| | | | | | NO |
|---|---|---|---|---|---|
| GSG-MRP- | ONSET | MAX | LINGERING | LINGERING | TASTE |
| PLTA | [sec] | [sec] | [sec] | OFF [sec] | [sec] |
| 100 ppm | 1 | 5 | — | — | 10 |
| 200 ppm | 1 | 6 | — | — | 16 |
| 300 ppm | 1 | 6 | — | — | 17 |
| 400 ppm | 1 | 6 | 12 | 16 | 21 |
| 500 ppm | 1 | 7 | 13 | 17 | 23 |

Conclusion: Both samples were found to be equivalent in onset and time to maximum sweetness. While GSG-MRP-PLTA had less lingering compared to GRU90-MRP-PLTA, the duration between lingering off and no taste is longer for GSG-MRP-PLTA when compared to GRU90-MRP-PLTA.

### Example 171. Measurement of Bitterness of GRU90-MRP-PLTA and GSG-MRP-PLTA

Test Design:

To evaluate bitterness in the GRU90-MRP-PLTA (168-01 in Ex. 168) and GSG-MRP-PLTA (168-01 in Ex. 168) samples, reference samples with increasing concentrations of caffeine were prepared in which the highest bitter scaling of 5 is equivalent to 0.13 g caffeine/L. 100 ppm, 200 ppm, 300 ppm, 400 ppm and 500 ppm of GRU90-MRP-PLTA and GSG-MRP-PLTA were prepared. The samples were tested and compared to the reference sample. The results of this analysis are shown in Table 171.

TABLE 171

| | |
|---|---|
| Concentration | Bitterness intensity* |

GRU90-MRP-PLTA

| | |
|---|---|
| 100 ppm | 1 |
| 200 ppm | 1 |
| 300 ppm | 2 |
| 400 ppm | 3 |
| 500 ppm | 3 |

GSG-MRP-PLTA

| | |
|---|---|
| 100 ppm | 1 |
| 200 ppm | 1 |
| 300 ppm | 2 |
| 400 ppm | 3 |
| 500 ppm | 3 |

*Bitterness intensity: The evaluation method is according to the sensory evaluation method in Ex. 5. Average scores from the panel were determined and recorded in Table 171.

Conclusion: Both samples exhibited no bitterness up to 200-250 ppm in-use concentration, and weak bitterness even at 500 ppm.

### Example 172. Effect of GRU90-MRP-PLTA and GSG-MRP-PLTA on Acidity and Freshness

Materials:

100% lemon juice, Alnatura, 09.09.2021 03:56 83692

GRU90-MRP-PLTA: product 168-01 in Ex. 168

GSG-MRP-PLTA: product 168-02 in Ex. 168

Test Design:

For these taste tests, a self-prepared lemon beverage was used in which 100% direct lemon juice “Alnatura” was diluted 1:5 with water and combined with 6% sugar (control sample). For the test samples, 100 ppm of GRU90-MRP-PLTA or 100 ppm GSG-MRP-PLTA were added to the lemon beverage. The objective was to evaluate the development of freshness in samples after adding GRU90-MRP-PLTA or GSG-MRP-PLTA. The sensory evaluation results are shown in Table 172.

TABLE 172

| 6% lemon beverage plus: | Sensory evaluation |
|---|---|
| No addition | Medium, quickly disappearing Lemon |
| (control) | Flavor |
| | High, early peaking acidity |
| | Low Sweetness |
| | Medium Astringency |
| | Low Flavor/Taste balance |
| 100 ppm GRU90-MRP-PLTA | High, quickly disappearing Lemon |
| | Flavor |
| | High acidity (no peaking) |
| | Low Sweetness |
| | Low Astringency |
| | Medium Flavor/Taste balance |
| +100 ppm GSG-MRP-PLTA | High Lemon Flavor (not disappearing) |
| | High acidity (no peaking) |
| | Medium Sweetness |
| | Low Astringency |
| | Medium Flavor/Taste balance |

Conclusion: GSG-MRP-PLTA and GRU-MRP-PLTA can improve the taste of a flavored beverage and make it palatable.

The above description is for the purpose of teaching a person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

1.-187. (canceled)

188. A composition comprising a Maillard reaction product (MRP) composition formed from a reaction mixture comprising:
(1) one or more sweet tea-related components selected from the group consisting of sweet tea extracts (STEs), glycosylated sweet tea extracts (GSTEs), sweet tea components (STCs) and glycosylated sweet tea components (GSTCs); and
(2) one or more amine donors having a free amino group,
wherein components (1) and (2) undergo a Maillard reaction, and wherein the MRP is present in the composition in an amount sufficient to improve a flavor, taste profile and/or mouthfeel of the composition.

189. The composition of claim 188, wherein the sweet tea-related components comprise rubusoside and/or glycosylated rubusoside.

190. The composition of claim 188, wherein the one or more amine donor comprise an amino acid selected from the group consisting of alanine, arginine, asparagine, aspartic acid, cysteine, glutamic acid, glutamine, glycine, histidine, isoleucine, leucine, lysine, methionine, phenylalanine, proline, serine, tyrosine, tryptophan, threonine and valine.

191. The composition of claim 188, wherein the reaction mixture further comprises a sugar donor.

192. The composition of claim 191, wherein the sugar donor comprises a reducing sugar selected from the group consisting of monosaccharides, disaccharides, oligosaccharides, and polysaccharides.

193. The composition of claim 191, wherein the sugar donor comprises a fruit juice, a vegetable juice or honey.

194. The composition of claim 188, wherein components (1) and (2) undergo a Maillard reaction at temperature in the range of 50-250° C.

195. The composition of claim 188, further comprising one or more additional ingredients selected from the group consisting of STEs, STCs, SEs, SE-MRPs, GSEs, GSE-MRPs, SGs, SG-MRPs, GSGs, GSG-MRPs and C-MRPs.

196. The composition of claim 188, wherein the composition further comprises a sweetener selected from the group consisting of sorbitol, xylitol, mannitol, sucralose, aspartame, acesulfame-K, neotame, erythritol, trehalose, raffinose, cellobiose, tagatose, allulose, inulin, N—[N-[3-(3-hydroxy-4-methoxyphenyl)propyl]-alpha-aspartyl]-L-phenylalanine 1-methyl ester, glycyrrhizin, sodium cyclamate, brazzein, miraculin, curculin, pentadin, mabinlin, thaumatin, NHDC, naringin dihydrochalcone, maltol, ethyl maltol, advantame, saccharine, monk fruit extract, mogrosides and licorice extract.

197. The composition of claim 188, further comprising a thickener.

198. The composition of claim 197, wherein the thickener is selected from the group consisting of allulose, carbomers, cellulose base materials, gums, inulin, algin, agar, pectins, carrageenan, gelatin, mineral thickeners, modified mineral thickeners, modified starch, polydextrose, polyethylene glycols, polyalcohols and polyacrylamides.

199. The composition of claim 188, further comprising one or more substances selected from the group consisting of limonene, linalool, citronellol, citral, geraniol, bergaptene, terpeneol, decanal, linalyl acetate, caryophyllene, neryl acetate, perillaldehyde, thymol, methyl N-methylanthranilate, alpha-sinensal, gamma-terpenene, and octanal.

200. The composition of claim 188, wherein the composition is a beverage.

201. The composition of claim 188, wherein the composition is a food product.

202. The composition of claim 188, wherein the composition is a dough or bakery product.

203. The composition of claim 188, wherein the composition is a dairy product.

204. The composition of claim 188, wherein the composition is a sweetening agent or flavoring agent.

205. The composition of claim 188, wherein the GSTEs or GSTCs comprise:
(1) unreacted STEs or unreacted STCs; and
(2) unreacted sugar donors from glycosylation reaction.

206. The composition of claim 205, wherein the unreacted sugar donors from glycosylation reaction comprise dextrins.

207. A method for to improve a flavor, taste profile and/or mouthfeel of a composition, comprising the step of
adding to the composition a sufficient amount of a Maillard reaction product (MRP) composition formed from a reaction mixture comprising:
(1) one or more sweet tea-related components selected from the group consisting of sweet tea extracts (STEs), glycosylated sweet tea extracts (GSTEs), sweet tea components (STCs) and glycosylated sweet tea components (GSTCs); and
(2) one or more amine donors having a free amino group,
wherein components (1) and (2) undergo a Maillard reaction.
